(19) United States
(12) Patent Application Publication
(10) Pub. No.: US 2011/0218104 A1
(43) Pub. Date: Sep. 8, 2011

(54) Biodiesel Solvents in Pesticide Compositions

(75) Inventors: R. Rodriguez-Kabana, Auburn, AL (US); Lee J. Simmons, Tallassee, AL (US); C. Robert Taylor, Opelika, AL (US)

(73) Assignee: AUBURN UNIVERSITY, Auburn, AL (US)

(21) Appl. No.: 12/716,348

(22) Filed: Mar. 3, 2010

(51) Int. Cl. A01N 43/72; A01N 47/28; A01N 47/40; A01N 37/36; A01P 13/00; A01P 15/00

(52) U.S. Cl. 504/131; 504/149; 514/588; 514/223.8; 504/141; 514/162

(57) ABSTRACT

Disclosed are pesticide compositions that utilize biodiesel as a solvent. The disclosed compositions may be utilized for controlling pests, such as nematodes and weeds, and for enhancing growth of plants.

### BACKGROUND

The field of the invention relates to pesticide compositions. In particular, the field of the invention related to pesticide compositions that comprise biodiesel.

Biodiesel fuels (BDF) are important sustainable energy sources. They are available commercially for use as alternatives for replacement of fuels derived from coal, petroleum, and other fast dwindling and non-renewable fossil energy sources. The production of fatty acids for BDF manufacture may be based on a transesterification reaction of sodium methylate with animal or vegetable fats, which are esters of acids with glycerin (1,2,3-propanetriol). This is followed by separation of glycerin and other impurities from the methylated fatty acids, usually based on the fact that glycerin has a higher density than methylated fatty acids and sinks to the bottom of a batch reaction mixture. As such, BDF usually are esters of long-chain fatty acids with simple alcohols, principally methanol. BDF commonly refers to mono-alkyl esters. One common BDF is methyl linoleate, which is a methyl ester produced from soybean oil (or canola oil) and methanol. Ethyl stearate is another type of BDF produced from soybean oil (or canola oil) and ethanol.

BDF commonly is utilized as a fuel for diesel engines, and may be used alone or blended with petrodiesel fuel. BDF has a calorific value of about 37.27 MJ/L which is significantly lower than petrodiesel. However, BDF, unlike petrodiesel fuel, has virtually no sulfur content and has been asserted to give better lubricity and more complete combustion in an engine, thereby compensating for its lower calorific value than petrodiesel.

Biodiesel also possesses physical properties that may make it a better solvent than petroleum based solvents. First, biodiesel is immiscible in water, unlike many petroleum products. Further, the flash point of biodiesel is >130° C., which is significantly higher than petroleum products, for example, petroleum diesel which has a flash point of about 64° C. and gasoline which has a flash point of −45° C. Of course, biodiesel also is widely recognized as safe for the environment, unlike petroleum products, and is produced from components that are renewable. Therefore, the present inventors have explored the use of biodiesel as a solvent in various compositions, such as pesticide compositions and soil-amendment compositions. In particular, the present inventors have explored the use of biodiesel as a solvent in compositions where traditionally petroleum-based solvents have been utilized.

### SUMMARY

Disclosed are compositions that comprise a pesticide, biodiesel, and optionally a nitrogen source. The disclosed compositions may be useful as soil-amendments for controlling pests, controlling weeds, or enhancing growth of crops as a fertilizer. The disclosed composition may be utilized as soil-amendments either alone or in combination with additional components.

In some embodiments, the disclosed compositions are utilized for controlling or eliminating soil-bourne pests, weeds, or both, and comprise: (a) an effective amount of a pesticide for controlling a pest; (b) biodiesel; and optionally (c) an effective amount of a nitrogen source. Suitable pesticide actives include nematicides (e.g., a nematicide that is effective for controlling a nematode selected from a group consisting of Rotylenchulus reniformis, Dorylaimida spp., Meloidogyne incognita, Hoploaimus galeatus, Paratrichodorus minor, and combinations thereof), an herbicide (e.g., an herbicide that is effective for controlling a weed selected from a group consisting of Ipomoea spp., Digitaria sanguinalis, Senna obtusifolia, Datura stramonium, Setaria glauca, Amaranthus retroflexus, and combinations thereof), a fungicide (e.g., a fungicide that is effective for controlling a fungus selected from a group consisting of Rhizoctonia solani, Pythium spp., and Fusarium spp., and a combination thereof), and combinations thereof (e.g., an active that is a nematicide and a fungicide).

In some embodiments, the disclosed nematicide compositions are effective for reducing a nematode population in a soil sample by at least about 50% when applied at an application rate of about 1 ml/kg soil. Preferably, the disclosed nematicide compositions do not reduce a microbivorous nematode population by more than about 50% when applied at an application rate of about 1 ml/kg soil.

In some embodiments, the disclosed herbicide compositions are effective for reducing a weed population by at least about 50% or are effective for reducing the growth rate of weeds by at least about 50% when applied at an application rate of about 1 ml/kg soil. Preferably, the disclosed herbicide compositions do not reduce an agricultural crop population by more than about 50% or do not affect the growth rate of an agricultural crop population by more than about 50% when applied at an application rate of about 1 ml/kg soil.

In some embodiments, the disclosed fungicide compositions are effective for reducing a fungus population by at least about 50% or are effective for reducing the growth rate of a fungus by at least about 50% when applied at an application rate of about 1 ml/kg soil.

The disclosed compositions typically include a pesticide compound as an active ingredient. Pesticide compounds may include, but are not limited to, a menthol compound, an alkyl cyanamide compound, a 3,5-alkyltetrahydro-1,3,5-thiadiazine-2-thione compound, an aldehyde compound comprising a cyclic aromatic substituent, an isothiocyanate compound, a capsaicinoid compound, an unsaturated aldehyde compound, a phenol compound optionally substituted with alkyl, a halogenated propene, a diazirine compound, and combinations thereof.

The disclosed pesticide compositions typically include biodiesel. Typically, the biodiesel is produced from reacting a mixture comprising: (a) animal fat, vegetable oil, or a mixture thereof; (b) a base, wherein the reaction mixture has a pH of at least about 11; and (c) an alcohol selected from a group consisting of methanol, ethanol, propanol, and a mixture thereof. The biodiesel typically comprises an alkyl ester.

The disclosed compositions may include a nitrogen source. Suitable nitrogen sources include organic nitrogen sources (e.g., urea or casein). In some embodiments, the composition has a molar ratio of total carbon to total nitrogen (C:N) of about (22.4-5.6):1, and preferably has a molar ratio of total carbon to total nitrogen (C:N) of about (16.8-11.2):1.

The disclosed compositions may be prepared by combining: (a) an effective amount of a pesticide for controlling a pest; (b) biodiesel which is prepared as disclosed herein; and optionally (c) an effective amount of an organic nitrogen source. For example, an organic nitrogen source may be added to a pesticide composition in order to achieve a molar ratio of total carbon to total nitrogen (C:N) of about (22.4-5.6):1 (preferably 16.8-11.2:1).

The disclosed compositions may be used in methods for controlling, eliminating, or killing pests. For example, the disclosed compositions may include liquid soil-amendment compositions to control, eliminate, or kill pests such as nematodes, fungi, and weeds. The methods may include applying the disclosed compositions as a liquid soil-amendment composition at an application rate of at least about 1 ml/kg soil (optionally at an application rate of at least about 2 ml/kg soil, 3 ml/kg soil, or 4 ml/kg soil). The selected application rates may achieve an effective concentration of pesticide in soil for controlling pests (e.g., at least about 25 mg pesticide/kg soil, 50 mg pesticide/kg soil, 100 mg pesticide/kg soil, 200 mg pesticide/kg soil, or 300 mg pesticide/kg soil).

### BRIEF DESCRIPTION OF THE FIGURES

FIG. 1 illustrates the number of nematodes per 100 mls of a pre-plant sample of soil treated with methyl isothiocyanate in biodiesel.

FIG. 2 illustrates the number of nematodes per 100 mls of a pre-plant sample of soil treated with methyl isothiocyanate in biodiesel.

FIG. 3 illustrates the number of nematodes per 100 mls of a pre-plant sample of soil treated with methyl isothiocyanate in biodiesel.

FIG. 4 illustrates the number of nematodes per 100 mls of a pre-plant sample of soil treated with methyl isothiocyanate in biodiesel.

FIG. 5 illustrates the number of nematodes per 100 mls of a pre-plant sample of soil treated with methyl isothiocyanate in biodiesel.

FIG. 6 illustrates the number of cucumber seedlings per pot of soil treated with methyl isothiocyanate in biodiesel.

FIG. 7 illustrates the number of cucumber seedlings per pot of soil treated with methyl isothiocyanate in biodiesel.

FIG. 8 illustrates the number of cucumber seedlings per pot of soil treated with methyl isothiocyanate in biodiesel.

FIG. 9 illustrates the final shoot height for cucumber seedlings grown in soil treated with methyl isothiocyanate in biodiesel.

FIG. 10 illustrates the final shoot weight for cucumber seedlings grown in soil treated with methyl isothiocyanate in biodiesel.

FIG. 11 illustrates the final root weight for cucumber seedlings grown in soil treated with methyl isothiocyanate in biodiesel.

FIG. 12 illustrates the number of nematodes per 100 mls of a final sample of soil treated with methyl isothiocyanate in biodiesel.

FIG. 13 illustrates the number of nematodes per 100 mls of a final sample of soil treated with methyl isothiocyanate in biodiesel upon termination of the test.

FIG. 14 illustrates the number of nematodes per 100 mls of a final sample of soil treated with methyl isothiocyanate in biodiesel upon termination of the test.

FIG. 15 illustrates the number of nematodes in the root system of cucumber seedlings grown in soil treated with methyl isothiocyanate in biodiesel upon termination of the test.

FIG. 16 illustrates the number of nematodes in the root system of cucumber seedlings grown in soil treated with methyl isothiocyanate in biodiesel upon termination of the test.

FIG. 17 illustrates the number of nematodes per 100 mls of a pre-plant sample of soil treated with methyl isothiocyanate in biodiesel.

FIG. 18 illustrates the number of nematodes per 100 mls of a pre-plant sample of soil treated with methyl isothiocyanate in biodiesel.

FIG. 19 illustrates the number of nematodes per 100 mls of a pre-plant sample of soil treated with methyl isothiocyanate in biodiesel.

FIG. 20 illustrates the number of nematodes per 100 mls of a pre-plant sample of soil treated with methyl isothiocyanate in biodiesel.

FIG. 21 illustrates the number of nematodes per 100 mls of a pre-plant sample of soil treated with methyl isothiocyanate in biodiesel.

FIG. 22 illustrates the number of cucumber seedlings per pot of soil treated with methyl isothiocyanate in biodiesel.

FIG. 23 illustrates the number of cucumber seedlings per pot of soil treated with methyl isothiocyanate in biodiesel.

FIG. 24 illustrates the number of cucumber seedlings per pot of soil treated with methyl isothiocyanate in biodiesel.

FIG. 25 illustrates the final shoot height for cucumber seedlings grown in soil treated with methyl isothiocyanate in biodiesel.

FIG. 26 illustrates the final shoot weight for cucumber seedlings grown in soil treated with methyl isothiocyanate in biodiesel.

FIG. 27 illustrates the final root weight for cucumber seedlings grown in soil treated with methyl isothiocyanate in biodiesel.

FIG. 28 illustrates the root condition index for cucumber seedlings grown in soil treated with methyl isothiocyanate in biodiesel.

FIG. 29 illustrates the root-knot index for cucumber seedlings grown in soil treated with methyl isothiocyanate in biodiesel.

FIG. 30 illustrates the number of galls per gram of root for cucumber seedlings grown in soil treated with methyl isothiocyanate in biodiesel.

FIG. 31 illustrates the number of nematodes per 100 mls of a final sample of soil treated with methyl isothiocyanate in biodiesel upon termination of the test.

FIG. 32 illustrates the number of nematodes per 100 mls of a final sample of soil treated with methyl isothiocyanate in biodiesel upon termination of the test.

FIG. 33 illustrates the number of nematodes per 100 mls of a final sample of soil treated with methyl isothiocyanate in biodiesel upon termination of the test.

FIG. 34 illustrates the number of nematodes in the root system of cucumber seedlings grown in soil treated with methyl isothiocyanate in biodiesel upon termination of the test.

FIG. 35 illustrates the number of nematodes in the root system of cucumber seedlings grown in soil treated with methyl isothiocyanate in biodiesel upon termination of the test.

FIG. 36 illustrates the number of nematodes per 100 mls of a pre-plant sample of soil treated with dazomet in biodiesel.

FIG. 37 illustrates the number of nematodes per 100 mls of a pre-plant sample of soil treated with dazomet in biodiesel.

FIG. 38 illustrates the number of cucumber seedlings per pot of soil treated with dazomet in biodiesel.

FIG. 39 illustrates the number of cucumber seedlings per pot of soil treated with dazomet in biodiesel.

FIG. 40 illustrates the number of cucumber seedlings per pot of soil treated with dazomet in biodiesel.

FIG. 41 illustrates the final shoot height for cucumber seedlings grown in soil treated with dazomet in biodiesel.

FIG. 42 illustrates the final shoot weight for cucumber seedlings grown in soil treated with dazomet in biodiesel.

FIG. 43 illustrates the final root weight for cucumber seedlings grown in soil treated with dazomet in biodiesel.

FIG. 44 illustrates the root condition index for cucumber seedlings grown in soil treated with dazomet in biodiesel.

FIG. 45 illustrates the number of nematodes per 100 mls of a final sample of soil treated with dazomet in biodiesel upon termination of the test.

FIG. 46 illustrates the number of nematodes per 100 mls of a final sample of soil treated with dazomet in biodiesel upon termination of the test.

FIG. 47 illustrates the number of nematodes per 100 mls of a final sample of soil treated with dazomet in biodiesel upon termination of the test.

FIG. 48 illustrates the number of nematodes in the root system of cucumber seedlings grown in soil treated with dazomet in biodiesel upon termination of the test.

FIG. 49 illustrates the number of nematodes in the root system of cucumber seedlings grown in soil treated with dazomet in biodiesel upon termination of the test.

FIG. 50 illustrates the number of nematodes per 100 mls of a pre-plant sample of soil treated with dazomet in biodiesel.

FIG. 51 illustrates the number of nematodes per 100 mls of a pre-plant sample of soil treated with dazomet in biodiesel.

FIG. 52 illustrates the number of nematodes per 100 mls of a pre-plant sample of soil treated with dazomet in biodiesel.

FIG. 53 illustrates the number of cucumber seedlings per pot of soil treated with dazomet in biodiesel.

FIG. 54 illustrates the number of cucumber seedlings per pot of soil treated with dazomet in biodiesel.

FIG. 55 illustrates the number of cucumber seedlings per pot of soil treated with dazomet in biodiesel.

FIG. 56 illustrates the final shoot height for cucumber seedlings grown in soil treated with dazomet in biodiesel.

FIG. 57 illustrates the final shoot weight for cucumber seedlings grown in soil treated with dazomet in biodiesel.

FIG. 58 illustrates the final root weight for cucumber seedlings grown in soil treated with dazomet in biodiesel.

FIG. 59 illustrates the root condition index for cucumber seedlings grown in soil treated with dazomet in biodiesel.

FIG. 60 illustrates the root-knot index for cucumber seedlings grown in soil treated with dazomet in biodiesel.

FIG. 61 illustrates the number of galls per gram of root for cucumber seedlings grown in soil treated with dazomet in biodiesel.

FIG. 62 illustrates the number of nematodes per 100 mls of a final sample of soil treated with dazomet in biodiesel upon termination of the test.

FIG. 63 illustrates the number of nematodes per 100 mls of a final sample of soil treated with dazomet in biodiesel upon termination of the test.

FIG. 64 illustrates the number of nematodes per 100 mls of a final sample of soil treated with dazomet in biodiesel upon termination of the test.

FIG. 65 illustrates the number of nematodes per 100 mls of a final sample of soil treated with dazomet in biodiesel upon termination of the test.

FIG. 66 illustrates the number of nematodes in the root system of cucumber seedlings grown in soil treated with dazomet in biodiesel upon termination of the test.

FIG. 67 illustrates the number of nematodes in the root system of cucumber seedlings grown in soil treated with dazomet in biodiesel upon termination of the test.

FIG. 68 illustrates the number of nematodes in the root system of cucumber seedlings grown in soil treated with dazomet in biodiesel upon termination of the test.

FIG. 69 illustrates the number of nematodes in the root system of cucumber seedlings grown in soil treated with dazomet in biodiesel upon termination of the test.

FIG. 70 illustrates the number of nematodes per 100 mls of a pre-plant sample of soil treated with citral in biodiesel.

FIG. 71 illustrates the number of nematodes per 100 mls of a pre-plant sample of soil treated with citral in biodiesel.

FIG. 72 illustrates the number of nematodes per 100 mls of a pre-plant sample of soil treated with citral in biodiesel.

FIG. 73 illustrates the number of cucumber seedlings per pot of soil treated with citral in biodiesel.

FIG. 74 illustrates the number of nematodes per 100 mls of a pre-plant sample of soil treated with dimethyl cyanamide in biodiesel.

FIG. 75 illustrates the number of nematodes per 100 mls of a pre-plant sample of soil treated with dimethyl cyanamide in biodiesel.

FIG. 76 illustrates the number of nematodes per 100 mls of a pre-plant sample of soil treated with dimethyl cyanamide in biodiesel.

FIG. 77 illustrates the number of nematodes per 100 mls of a pre-plant sample of soil treated with dimethyl cyanamide in biodiesel.

FIG. 78 illustrates the number of cucumber seedlings per pot of soil treated with dimethyl cyanamide in biodiesel.

FIG. 79 illustrates the final shoot height for cucumber seedlings grown in soil treated with dimethyl cyanamide in biodiesel.

FIG. 80 illustrates the final shoot weight for cucumber seedlings grown in soil treated with dimethyl cyanamide in biodiesel.

FIG. 81 illustrates the final root weight for cucumber seedlings grown in soil treated with dimethyl cyanamide in biodiesel.

FIG. 82 illustrates the root condition index for cucumber seedlings grown in soil treated with dimethyl cyanamide in biodiesel.

FIG. 83 illustrates the gall rate for cucumber seedlings grown in soil treated with dimethyl cyanamide in biodiesel.

FIG. 84 illustrates the number of galls per gram of root for cucumber seedlings grown in soil treated with dimethyl cyanamide in biodiesel.

FIG. 85 illustrates the number of nematodes per 100 mls of a final sample of soil treated with dimethyl cyanamide in biodiesel upon termination of the test.

FIG. 86 illustrates the number of nematodes per 100 mls of a final sample of soil treated with dimethyl cyanamide in biodiesel upon termination of the test.

FIG. 87 illustrates the number of nematodes per 100 mls of a final sample of soil treated with dimethyl cyanamide in biodiesel upon termination of the test.

FIG. 88 illustrates the number of nematodes per 100 mls of a final sample of soil treated with dimethyl cyanamide in biodiesel upon termination of the test.

FIG. 89 illustrates the number of nematodes in the root system of cucumber seedlings grown in soil treated with dimethyl cyanamide in biodiesel upon termination of the test.

FIG. 90 illustrates the number of nematodes in the root system of cucumber seedlings grown in soil treated with dimethyl cyanamide in biodiesel upon termination of the test.

FIG. 91 illustrates the number of nematodes in the root system of cucumber seedlings grown in soil treated with dimethyl cyanamide in biodiesel upon termination of the test.

FIG. 92 illustrates the number of nematodes in the root system of cucumber seedlings grown in soil treated with dimethyl cyanamide in biodiesel upon termination of the test.

FIG. 93 illustrates the number of nematodes per gram of root of cucumber seedlings grown in soil treated with dimethyl cyanamide in biodiesel upon termination of the test.

FIG. 94 illustrates the number of nematodes per gram of root of cucumber seedlings grown in soil treated with dimethyl cyanamide in biodiesel upon termination of the test.

FIG. 95 illustrates the number of nematodes per gram of root of cucumber seedlings grown in soil treated with dimethyl cyanamide in biodiesel upon termination of the test.

FIG. 96 illustrates the number of nematodes per gram of root of cucumber seedlings grown in soil treated with dimethyl cyanamide in biodiesel upon termination of the test.

FIG. 97 illustrates the number of nematodes per 100 mls of a pre-plant sample of soil treated with a hot pepper extract in biodiesel.

FIG. 98 illustrates the number of cucumber seedlings per pot of soil treated with a hot pepper extract in biodiesel.

FIG. 99 illustrates the final shoot weight for cucumber seedlings grown in soil treated with a hot pepper extract in biodiesel.

FIG. 100 illustrates the root condition index for cucumber seedlings grown in soil treated with a hot pepper extract in biodiesel.

FIG. 101 illustrates the root knot index for cucumber seedlings grown in soil treated with a hot pepper extract in biodiesel.

FIG. 102 illustrates the number of nematodes per 100 mls of a final sample of soil treated with a hot pepper extract in biodiesel upon termination of the test.

FIG. 103 illustrates the number of nematodes in the root system of cucumber seedlings grown in soil treated with a hot pepper extract in biodiesel upon termination of the test.

FIG. 104 illustrates the number of nematodes per 100 mls of a pre-plant sample of soil treated with a formulation of methyl isothiocyanate in biodiesel.

FIG. 105 illustrates the number of nematodes per 100 mls of a pre-plant sample of soil treated with a formulation of methyl isothiocyanate in biodiesel.

FIG. 106 illustrates the number of nematodes per 100 mls of a pre-plant sample of soil treated with a formulation of methyl isothiocyanate in biodiesel.

FIG. 107 illustrates the number of cucumber seedlings per pot of soil treated with a formulation of methyl isothiocyanate in biodiesel.

FIG. 108 illustrates the final shoot weight for cucumber seedlings grown in soil treated with a formulation of methyl isothiocyanate in biodiesel.

FIG. 109 illustrates the final root weight for cucumber seedlings grown in soil treated with a formulation of methyl isothiocyanate in biodiesel.

FIG. 110 illustrates the root condition index for cucumber seedlings grown in soil treated with a formulation of methyl isothiocyanate in biodiesel.

FIG. 111 illustrates the number of nematodes per 100 mls of a final sample of soil treated with a formulation of methyl isothiocyanate in biodiesel upon termination of the test.

FIG. 112 illustrates the number of nematodes per 100 mls of a final sample of soil treated with a formulation of methyl isothiocyanate in biodiesel upon termination of the test.

FIG. 113 illustrates the number of nematodes per 100 mls of a final sample of soil treated with a formulation of methyl isothiocyanate in biodiesel upon termination of the test.

FIG. 114 illustrates the number of nematodes in the root system of cucumber seedlings grown in soil treated with a formulation of methyl isothiocyanate in biodiesel upon termination of the test.

FIG. 115 illustrates the number of nematodes in the root system of cucumber seedlings grown in soil treated with a formulation of methyl isothiocyanate in biodiesel upon termination of the test.

FIG. 116 illustrates the number of nematodes in the root system of cucumber seedlings grown in soil treated with a formulation of methyl isothiocyanate in biodiesel upon termination of the test.

FIG. 117 illustrates the number of nematodes per 100 mls of a pre-plant sample of soil treated with of dimethyl formamide in biodiesel.

FIG. 118 illustrates the number of nematodes per 100 mls of a pre-plant sample of soil treated with of dimethyl formamide in biodiesel.

FIG. 119 illustrates the number of nematodes per 100 mls of a pre-plant sample of soil treated with of dimethyl formamide in biodiesel.

FIG. 120 illustrates the number of cucumber seedlings per pot of soil treated with of dimethyl formamide in biodiesel.

FIG. 121 illustrates the final shoot height for cucumber seedlings grown in soil treated with of dimethyl formamide in biodiesel.

FIG. 122 illustrates the final shoot weight for cucumber seedlings grown in soil treated with of dimethyl formamide in biodiesel.

FIG. 123 illustrates the final root weight for cucumber seedlings grown in soil treated with of dimethyl formamide in biodiesel.

FIG. 124 illustrates the root condition index for cucumber seedlings grown in soil treated with of dimethyl formamide in biodiesel.

FIG. 125 illustrates the number of nematodes per 100 mls of a final sample of soil treated with of dimethyl formamide in biodiesel upon termination of the test.

FIG. 126 illustrates the number of nematodes per 100 mls of a final sample of soil treated with of dimethyl formamide in biodiesel upon termination of the test.

FIG. 127 illustrates the number of nematodes per 100 mls of a final sample of soil treated with of dimethyl formamide in biodiesel upon termination of the test.

FIG. 128 illustrates the number of nematodes in the root system of cucumber seedlings grown in soil treated with of dimethyl formamide in biodiesel upon termination of the test.

FIG. 129 illustrates the number of nematodes in the root system of cucumber seedlings grown in soil treated with of dimethyl formamide in biodiesel upon termination of the test.

FIG. 130 illustrates the number of nematodes in the root system of cucumber seedlings grown in soil treated with of dimethyl formamide in biodiesel upon termination of the test.

FIG. 131 illustrates the number of nematodes per gram of root of cucumber seedlings grown in soil treated with dimethyl formamide in biodiesel upon termination of the test.

FIG. 132 illustrates the number of nematodes in the root system of cucumber seedlings grown in soil treated with dimethyl formamide in biodiesel upon termination of the test.

FIG. 133 illustrates the number of nematodes per gram of root of cucumber seedlings grown in soil treated with dimethyl formamide in biodiesel upon termination of the test.

FIG. 134 illustrates the number of nematodes per 100 mls of a pre-plant sample of soil treated with acrolein in biodiesel.

FIG. 135 illustrates the number of nematodes per 100 mls of a pre-plant sample of soil treated with acrolein in biodiesel.

FIG. 136 illustrates the number of nematodes per 100 mls of a pre-plant sample of soil treated with acrolein in biodiesel.

FIG. 137 illustrates the number of nematodes per 100 mls of a pre-plant sample of soil treated with acrolein in biodiesel.

FIG. 138 illustrates the number of cucumber seedlings per pot of soil treated with acrolein in biodiesel.

FIG. 139 illustrates the final shoot height for cucumber seedlings grown in soil treated with acrolein in biodiesel.

FIG. 140 illustrates the final shoot weight for cucumber seedlings grown in soil treated with acrolein in biodiesel.

FIG. 141 illustrates the final root weight for cucumber seedlings grown in soil treated with acrolein in biodiesel.

FIG. 142 illustrates the root condition index for cucumber seedlings grown in soil treated with acrolein in biodiesel.

FIG. 143 illustrates the number of nematodes per 100 mls of a final sample of soil treated with acrolein in biodiesel upon termination of the test.

FIG. 144 illustrates the number of nematodes per 100 mls of a final sample of soil treated with acrolein in biodiesel upon termination of the test.

FIG. 145 illustrates the number of nematodes per 100 mls of a final sample of soil treated with acrolein in biodiesel upon termination of the test.

FIG. 146 illustrates the number of nematodes in the root system of cucumber seedlings grown in soil treated with acrolein in biodiesel upon termination of the test.

FIG. 147 illustrates the number of nematodes in the root system of cucumber seedlings grown in soil treated with acrolein in biodiesel upon termination of the test.

FIG. 148 illustrates the number of nematodes in the root system of cucumber seedlings grown in soil treated with acrolein in biodiesel upon termination of the test.

FIG. 149 illustrates the number of nematodes per 100 mls of a pre-plant sample of soil treated with a formulation of allyl isothiocyanate in biodiesel.

FIG. 150 illustrates the number of nematodes per 100 mls of a pre-plant sample of soil treated with a formulation of allyl isothiocyanate in biodiesel.

FIG. 151 illustrates the number of nematodes per 100 mls of a pre-plant sample of soil treated with a formulation of allyl isothiocyanate in biodiesel.

FIG. 152 illustrates the number of nematodes per 100 mls of a pre-plant sample of soil treated with a formulation of allyl isothiocyanate in biodiesel.

FIG. 153 illustrates the number of cucumber seedlings per pot of soil treated with a formulation of allyl isothiocyanate in biodiesel.

FIG. 154 illustrates the number of cucumber seedlings per pot of soil treated with a formulation of allyl isothiocyanate in biodiesel.

FIG. 155 illustrates the final shoot height for cucumber seedlings grown in soil treated with a formulation of allyl isothiocyanate in biodiesel.

FIG. 156 illustrates the final shoot weight for cucumber seedlings grown in soil treated with a formulation of allyl isothiocyanate in biodiesel.

FIG. 157 illustrates the final root weight for cucumber seedlings grown in soil treated with a formulation of allyl isothiocyanate in biodiesel.

FIG. 158 illustrates the root condition index for cucumber seedlings grown in soil treated with a formulation of allyl isothiocyanate in biodiesel.

FIG. 159 illustrates the number of nematodes per 100 mls of a final sample of soil treated with a formulation of allyl isothiocyanate in biodiesel upon termination of the test.

FIG. 160 illustrates the number of nematodes per 100 mls of a final sample of soil treated with a formulation of allyl isothiocyanate in biodiesel upon termination of the test.

FIG. 161 illustrates the number of nematodes per 100 mls of a final sample of soil treated with a formulation of allyl isothiocyanate in biodiesel upon termination of the test.

FIG. 162 illustrates the number of nematodes per 100 mls of a final sample of soil treated with a formulation of allyl isothiocyanate in biodiesel upon termination of the test.

FIG. 163 illustrates the number of nematodes in the root system of cucumber seedlings grown in soil treated with a formulation of allyl isothiocyanate in biodiesel upon termination of the test.

FIG. 164 illustrates the number of nematodes in the root system of cucumber seedlings grown in soil treated with a formulation of allyl isothiocyanate in biodiesel upon termination of the test.

FIG. 165 illustrates the number of nematodes in the root system of cucumber seedlings grown in soil treated with a formulation of allyl isothiocyanate in biodiesel upon termination of the test.

FIG. 166 illustrates the number of nematodes per 100 mls of a pre-plant sample of soil treated with a formulation of phenyl isothiocyanate in biodiesel.

FIG. 167 illustrates the number of nematodes per 100 mls of a pre-plant sample of soil treated with a formulation of phenyl isothiocyanate in biodiesel.

FIG. 168 illustrates the number of nematodes per 100 mls of a pre-plant sample of soil treated with a formulation of phenyl isothiocyanate in biodiesel.

FIG. 169 illustrates the number of cucumber seedlings per pot of soil treated with a formulation of phenyl isothiocyanate in biodiesel.

FIG. 170 illustrates the number of cucumber seedlings per pot of soil treated with a formulation of phenyl isothiocyanate in biodiesel.

FIG. 171 illustrates the final shoot height for cucumber seedlings grown in soil treated with a formulation of phenyl isothiocyanate in biodiesel.

FIG. 172 illustrates the final shoot weight for cucumber seedlings grown in soil treated with a formulation of phenyl isothiocyanate in biodiesel.

FIG. 173 illustrates the final root weight for cucumber seedlings grown in soil treated with a formulation of phenyl isothiocyanate in biodiesel.

FIG. 174 illustrates the root condition index for cucumber seedlings grown in soil treated with a formulation of phenyl isothiocyanate in biodiesel.

FIG. 175 illustrates the number of nematodes per 100 mls of a final sample of soil treated with a formulation of phenyl isothiocyanate in biodiesel upon termination of the test.

FIG. 176 illustrates the number of nematodes per 100 mls of a final sample of soil treated with a formulation of phenyl isothiocyanate in biodiesel upon termination of the test.

FIG. 177 illustrates the number of nematodes per 100 mls of a final sample of soil treated with a formulation of phenyl isothiocyanate in biodiesel upon termination of the test.

FIG. 178 illustrates the number of nematodes in the root system of cucumber seedlings grown in soil treated with a formulation of phenyl isothiocyanate in biodiesel upon termination of the test.

FIG. 179 illustrates the number of nematodes in the root system of cucumber seedlings grown in soil treated with a formulation of phenyl isothiocyanate in biodiesel upon termination of the test.

FIG. 180 illustrates the number of nematodes in the root system of cucumber seedlings grown in soil treated with a formulation of phenyl isothiocyanate in biodiesel upon termination of the test.

FIG. 181 illustrates the number of nematodes per 100 mls of a pre-plant sample of soil treated with a formulation of allyl isothiocyanate and orange terpenes in biodiesel.

FIG. 182 illustrates the number of nematodes per 100 mls of a pre-plant sample of soil treated with a formulation of allyl isothiocyanate and orange terpenes in biodiesel.

FIG. 183 illustrates the number of nematodes per 100 mls of a pre-plant sample of soil treated with a formulation of allyl isothiocyanate and orange terpenes in biodiesel.

FIG. 184 illustrates the number of cucumber seedlings per pot of soil treated with a formulation of allyl isothiocyanate and orange terpenes in biodiesel.

FIG. 185 illustrates the final shoot height for cucumber seedlings grown in soil treated with a formulation of allyl isothiocyanate and orange terpenes in biodiesel.

FIG. 186 illustrates the final shoot weight for cucumber seedlings grown in soil treated with a formulation of allyl isothiocyanate and orange terpenes in biodiesel.

FIG. 187 illustrates the final root weight for cucumber seedlings grown in soil treated with a formulation of allyl isothiocyanate and orange terpenes in biodiesel.

FIG. 188 illustrates the root condition index for cucumber seedlings grown in soil treated with a formulation of allyl isothiocyanate and orange terpenes in biodiesel.

FIG. 189 illustrates the root knot index for cucumber seedlings grown in soil treated with a formulation of allyl isothiocyanate and orange terpenes in biodiesel.

FIG. 190 illustrates the number of galls per gram of root of cucumber seedlings grown in soil treated with a formulation of allyl isothiocyanate and orange terpenes in biodiesel.

FIG. 191 illustrates the number of nematodes per 100 mls of a final sample of soil treated with a formulation of allyl isothiocyanate and orange terpenes in biodiesel upon termination of the test.

FIG. 192 illustrates the number of nematodes per 100 mls of a final sample of soil treated with a formulation of allyl isothiocyanate and orange terpenes in biodiesel upon termination of the test.

FIG. 193 illustrates the number of nematodes per 100 mls of a final sample of soil treated with a formulation of allyl isothiocyanate and orange terpenes in biodiesel upon termination of the test.

FIG. 194 illustrates the number of nematodes in the root system of cucumber seedlings grown in soil treated with a formulation of allyl isothiocyanate and orange terpenes in biodiesel upon termination of the test.

FIG. 195 illustrates the number of nematodes in the root system of cucumber seedlings grown in soil treated with a formulation of allyl isothiocyanate and orange terpenes in biodiesel upon termination of the test.

FIG. 196 illustrates the number of nematodes in the root system of cucumber seedlings grown in soil treated with a formulation of allyl isothiocyanate and orange terpenes in biodiesel upon termination of the test.

FIG. 197 illustrates the number of nematodes in the root system of cucumber seedlings grown in soil treated with a formulation of allyl isothiocyanate and orange terpenes in biodiesel upon termination of the test.

FIG. 198 illustrates the number of nematodes per 100 mls of a pre-plant sample of soil treated with a formulation of crotonaldehyde and orange terpenes in biodiesel.

FIG. 199 illustrates the number of nematodes per 100 mls of a pre-plant sample of soil treated with a formulation of crotonaldehyde and orange terpenes in biodiesel.

FIG. 200 illustrates the number of nematodes per 100 mls of a pre-plant sample of soil treated with a formulation of crotonaldehyde and orange terpenes in biodiesel.

FIG. 201 illustrates the number of nematodes per 100 mls of a pre-plant sample of soil treated with a formulation of crotonaldehyde and orange terpenes in biodiesel.

FIG. 202 illustrates the number of cucumber seedlings per pot of soil treated with a formulation of crotonaldehyde and orange terpenes in biodiesel.

FIG. 203 illustrates the final shoot height for cucumber seedlings grown in soil treated with a formulation of crotonaldehyde and orange terpenes in biodiesel.

FIG. 204 illustrates the final shoot weight for cucumber seedlings grown in soil treated with a formulation of crotonaldehyde and orange terpenes in biodiesel.

FIG. 205 illustrates the final root weight for cucumber seedlings grown in soil treated with a formulation of crotonaldehyde and orange terpenes in biodiesel.

FIG. 206 illustrates the root condition index for cucumber seedlings grown in soil treated with a formulation of crotonaldehyde and orange terpenes in biodiesel.

FIG. 207 illustrates the root knot index for cucumber seedlings grown in soil treated with a formulation of crotonaldehyde and orange terpenes in biodiesel.

FIG. 208 illustrates the number of galls per gram of root of cucumber seedlings grown in soil treated with a formulation of crotonaldehyde and orange terpenes in biodiesel.

FIG. 209 illustrates the number of nematodes per 100 mls of a final sample of soil treated with a formulation of crotonaldehyde and orange terpenes in biodiesel upon termination of the test.

FIG. 210 illustrates the number of nematodes per 100 mls of a final sample of soil treated with a formulation of crotonaldehyde and orange terpenes in biodiesel upon termination of the test.

FIG. 211 illustrates the number of nematodes per 100 mls of a final sample of soil treated with a formulation of crotonaldehyde and orange terpenes in biodiesel upon termination of the test.

FIG. 212 illustrates the number of nematodes per 100 mls of a final sample of soil treated with a formulation of crotonaldehyde and orange terpenes in biodiesel upon termination of the test.

FIG. 213 illustrates the number of nematodes in the root system of cucumber seedlings grown in soil treated with a formulation of crotonaldehyde and orange terpenes in biodiesel upon termination of the test.

FIG. 214 illustrates the number of nematodes in the root system of cucumber seedlings grown in soil treated with a formulation of crotonaldehyde and orange terpenes in biodiesel upon termination of the test.

FIG. 215 illustrates the number of nematodes in the root system of cucumber seedlings grown in soil treated with a formulation of crotonaldehyde and orange terpenes in biodiesel upon termination of the test.

FIG. 216 illustrates the number of nematodes per 100 mls of a pre-plant sample of soil treated with salicylaldehyde or cinnamaldehyde in biodiesel.

FIG. 217 illustrates the number of nematodes per 100 mls of a pre-plant sample of soil treated with salicylaldehyde or cinnamaldehyde in biodiesel.

FIG. 218 illustrates the number of nematodes per 100 mls of a pre-plant sample of soil treated with salicylaldehyde or cinnamaldehyde in biodiesel.

FIG. 219 illustrates the number of cucumber seedlings per pot of soil treated with salicylaldehyde or cinnamaldehyde in biodiesel.

FIG. 220 illustrates the final shoot height for cucumber seedlings grown in soil treated with salicylaldehyde or cinnamaldehyde in biodiesel.

FIG. 221 illustrates the final shoot weight for cucumber seedlings grown in soil treated with salicylaldehyde or cinnamaldehyde in biodiesel.

FIG. 222 illustrates the final root weight for cucumber seedlings grown in soil treated with salicylaldehyde or cinnamaldehyde in biodiesel.

FIG. 223 illustrates the root condition index for cucumber seedlings grown in soil treated with salicylaldehyde or cinnamaldehyde in biodiesel.

FIG. 224 illustrates the number of nematodes per 100 mls of a final sample of soil treated with salicylaldehyde or cinnamaldehyde in biodiesel upon termination of the test.

FIG. 225 illustrates the number of nematodes per 100 mls of a final sample of soil treated with salicylaldehyde or cinnamaldehyde in biodiesel upon termination of the test.

FIG. 226 illustrates the number of nematodes per 100 mls of a final sample of soil treated with salicylaldehyde or cinnamaldehyde in biodiesel upon termination of the test.

FIG. 227 illustrates the number of nematodes per gram of root of cucumber seedlings grown in soil treated with salicylaldehyde or cinnamaldehyde in biodiesel upon termination of the test.

FIG. 228 illustrates the number of nematodes per gram of root of cucumber seedlings grown in soil treated with salicylaldehyde or cinnamaldehyde in biodiesel upon termination of the test.

FIG. 229 illustrates the number of nematodes per 100 mls of a pre-plant sample of soil treated with menthol in biodiesel.

FIG. 230 illustrates the number of nematodes per 100 mls of a pre-plant sample of soil treated with menthol in biodiesel.

FIG. 231 illustrates the number of nematodes per 100 mls of a pre-plant sample of soil treated with menthol in biodiesel.

FIG. 232 illustrates the number of cucumber seedlings per pot of soil treated with menthol in biodiesel.

FIG. 233 illustrates the final shoot height for cucumber seedlings grown in soil treated with menthol in biodiesel.

FIG. 234 illustrates the final shoot weight for cucumber seedlings grown in soil treated with menthol in biodiesel.

FIG. 235 illustrates the final root weight for cucumber seedlings grown in soil treated with menthol in biodiesel.

FIG. 236 illustrates the root condition index for cucumber seedlings grown in soil treated with menthol in biodiesel.

FIG. 237 illustrates the number of nematodes per 100 mls of a final sample of soil treated with menthol in biodiesel upon termination of the test.

FIG. 238 illustrates the number of nematodes per 100 mls of a final sample of soil treated with menthol in biodiesel upon termination of the test.

FIG. 239 illustrates the number of nematodes per 100 mls of a final sample of soil treated with menthol in biodiesel upon termination of the test.

FIG. 240 illustrates the number of nematodes per gram of root of cucumber seedlings grown in soil treated with menthol in biodiesel upon termination of the test.

FIG. 241 illustrates the number of nematodes per gram of root of cucumber seedlings grown in soil treated with menthol in biodiesel upon termination of the test.

FIG. 242 illustrates the number of nematodes per 100 mls of a pre-plant sample of soil treated with salicylaldehyde or cinnamaldehyde in biodiesel.

FIG. 243 illustrates the number of nematodes per 100 mls of a pre-plant sample of soil treated with benzaldehyde or salicylaldehyde in biodiesel.

FIG. 244 illustrates the number of nematodes per 100 mls of a pre-plant sample of soil treated with benzaldehyde or salicylaldehyde in biodiesel.

FIG. 245 illustrates the number of squash seedlings per pot of soil treated with benzaldehyde or salicylaldehyde in biodiesel.

FIG. 246 illustrates the final shoot height for squash seedlings grown in soil treated with benzaldehyde or salicylaldehyde in biodiesel.

FIG. 247 illustrates the final shoot weight for squash seedlings grown in soil treated with benzaldehyde or salicylaldehyde in biodiesel.

FIG. 248 illustrates the final root weight for squash seedlings grown in soil treated with benzaldehyde or salicylaldehyde in biodiesel.

FIG. 249 illustrates the root condition index for squash seedlings grown in soil treated with benzaldehyde or salicylaldehyde in biodiesel.

FIG. 250 illustrates the number of nematodes per 100 mls of a final sample of soil treated with benzaldehyde or salicylaldehyde in biodiesel upon termination of the test.

FIG. 251 illustrates the number of nematodes per 100 mls of a final sample of soil treated with benzaldehyde or salicylaldehyde in biodiesel upon termination of the test.

FIG. 252 illustrates the number of nematodes per 100 mls of a final sample of soil treated with benzaldehyde or salicylaldehyde in biodiesel upon termination of the test.

FIG. 253 illustrates the number of nematodes per gram of root of squash seedlings grown in soil treated with benzaldehyde or salicylaldehyde in biodiesel upon termination of the test.

FIG. 254 illustrates the number of nematodes per gram of root of squash seedlings grown in soil treated with benzaldehyde or salicylaldehyde in biodiesel upon termination of the test.

FIG. 255 illustrates the number of nematodes per 100 mls of a pre-plant sample of soil treated with cinnamaldehyde or citral in biodiesel.

FIG. 256 illustrates the number of nematodes per 100 mls of a pre-plant sample of soil treated with cinnamaldehyde or citral in biodiesel.

FIG. 257 illustrates the number of nematodes per 100 mls of a pre-plant sample of soil treated with cinnamaldehyde or citral in biodiesel.

FIG. 258 illustrates the number of squash seedlings per pot of soil treated with cinnamaldehyde or citral in biodiesel.

FIG. 259 illustrates the final shoot height for squash seedlings grown in soil treated with cinnamaldehyde or citral in biodiesel.

FIG. 260 illustrates the final shoot weight for squash seedlings grown in soil treated with cinnamaldehyde or citral in biodiesel.

FIG. 261 illustrates the final root weight for squash seedlings grown in soil treated with cinnamaldehyde or citral in biodiesel.

FIG. 262 illustrates the root condition index for squash seedlings grown in soil treated with cinnamaldehyde or citral in biodiesel.

FIG. 263 illustrates the number of nematodes per 100 mls of a final sample of soil treated with cinnamaldehyde or citral in biodiesel upon termination of the test.

FIG. 264 illustrates the number of nematodes per 100 mls of a final sample of soil treated with cinnamaldehyde or citral in biodiesel upon termination of the test.

FIG. 265 illustrates the number of nematodes per 100 mls of a final sample of soil treated with cinnamaldehyde or citral in biodiesel upon termination of the test.

FIG. 266 illustrates the number of nematodes per gram of root of squash seedlings grown in soil treated with cinnamaldehyde or citral in biodiesel upon termination of the test.

FIG. 267 illustrates the number of nematodes per gram of root of squash seedlings grown in soil treated with cinnamaldehyde or citral in biodiesel upon termination of the test.

FIG. 268 illustrates the number of nematodes per 100 mls of a pre-plant sample of soil treated with anisaldehyde or thymol in biodiesel.

FIG. 269 illustrates the number of nematodes per 100 mls of a pre-plant sample of soil treated with anisaldehyde or thymol in biodiesel.

FIG. 270 illustrates the number of nematodes per 100 mls of a pre-plant sample of soil treated with anisaldehyde or thymol in biodiesel.

FIG. 271 illustrates the number of cucumber seedlings per pot of soil treated with anisaldehyde or thymol in biodiesel.

FIG. 272 illustrates the final shoot height for cucumber seedlings grown in soil treated with anisaldehyde or thymol in biodiesel.

FIG. 273 illustrates the final shoot weight for cucumber seedlings grown in soil treated with anisaldehyde or thymol in biodiesel.

FIG. 274 illustrates the final root weight for cucumber seedlings grown in soil treated with anisaldehyde or thymol in biodiesel.

FIG. 275 illustrates the root condition index for cucumber seedlings grown in soil treated with anisaldehyde or thymol in biodiesel.

FIG. 276 illustrates the number of nematodes per 100 mls of a final sample of soil treated with anisaldehyde or thymol in biodiesel upon termination of the test.

FIG. 277 illustrates the number of nematodes per 100 mls of a final sample of soil treated with anisaldehyde or thymol in biodiesel upon termination of the test.

FIG. 278 illustrates the number of nematodes per 100 mls of a final sample of soil treated with anisaldehyde or thymol in biodiesel upon termination of the test.

FIG. 279 illustrates the number of nematodes per 100 mls of a final sample of soil treated with anisaldehyde or thymol in biodiesel upon termination of the test.

FIG. 280 illustrates the number of nematodes per gram of root of cucumber seedlings grown in soil treated with anisaldehyde or thymol in biodiesel upon termination of the test.

FIG. 281 illustrates the number of nematodes per 100 mls of a pre-plant sample of soil treated with dry pepper powder extracts in biodiesel (verdisol).

FIG. 282 illustrates the number of nematodes per 100 mls of a pre-plant sample of soil treated with dry pepper powder extracts in biodiesel (verdisol).

FIG. 283 illustrates the number of nematodes per 100 mls of a pre-plant sample of soil treated with dry pepper powder extracts in biodiesel (verdisol).

FIG. 284 illustrates the final shoot height for cucumber seedlings grown in soil treated with dry pepper powder extracts in biodiesel (verdisol).

FIG. 285 illustrates the final shoot weight for cucumber seedlings grown in soil treated with dry pepper powder extracts in biodiesel (verdisol).

FIG. 286 illustrates the final root weight for cucumber seedlings grown in soil treated with dry pepper powder extracts in biodiesel (verdisol).

FIG. 287 illustrates the root condition index for cucumber seedlings grown in soil treated with dry pepper powder extracts in biodiesel (verdisol).

FIG. 288 illustrates the number of nematodes per 100 mls of a final sample of soil treated with dry pepper powder extracts in biodiesel (verdisol) upon termination of the test.

FIG. 289 illustrates the number of nematodes per 100 mls of a final sample of soil treated with dry pepper powder extracts in biodiesel (verdisol) upon termination of the test.

FIG. 290 illustrates the number of nematodes per 100 mls of a final sample of soil treated with dry pepper powder extracts in biodiesel (verdisol) upon termination of the test.

FIG. 291 illustrates the number of nematodes in the root system of cucumber seedlings grown in soil treated with dry pepper powder extracts in biodiesel (verdisol) upon termination of the test.

FIG. 292 illustrates the number of nematodes in the root system of cucumber seedlings grown in soil treated with dry pepper powder extracts in biodiesel (verdisol) upon termination of the test.

FIG. 293 illustrates the total number of weeds per pot of soil treated with benzaldehyde or salicylaldehyde in biodiesel after four days.

FIG. 294 illustrates the number of yellow nutsedge seedlings per pot of soil treated with benzaldehyde or salicylaldehyde in biodiesel after four days.

FIG. 295 illustrates the number of crabgrass seedlings per pot of soil treated with benzaldehyde or salicylaldehyde in biodiesel after four days.

FIG. 296 illustrates the number of teaweed seedlings per pot of soil treated with benzaldehyde or salicylaldehyde in biodiesel after four days.

FIG. 297 illustrates the number of sicklepod seedlings per pot of soil treated with benzaldehyde or salicylaldehyde in biodiesel after four days.

FIG. 298 illustrates the number of morning glory seedlings per pot of soil treated with benzaldehyde or salicylaldehyde in biodiesel after four days.

FIG. 299 illustrates the total number of weeds per pot of soil treated with benzaldehyde or salicylaldehyde in biodiesel after ten days.

FIG. 300 illustrates the number of yellow nutsedge seedlings per pot of soil treated with benzaldehyde or salicylaldehyde in biodiesel after ten days.

FIG. 301 illustrates the number of crabgrass seedlings per pot of soil treated with benzaldehyde or salicylaldehyde in biodiesel after ten days.

FIG. 302 illustrates the number of teaweed seedlings per pot of soil treated with benzaldehyde or salicylaldehyde in biodiesel after ten days.

FIG. 303 illustrates the number of sicklepod seedlings per pot of soil treated with benzaldehyde or salicylaldehyde in biodiesel after ten days.

FIG. 304 illustrates the number of morning glory seedlings per pot of soil treated with benzaldehyde or salicylaldehyde in biodiesel after ten days.

FIG. 305 illustrates the total number of weeds per pot of soil treated with benzaldehyde or salicylaldehyde in biodiesel after eighteen days.

FIG. 306 illustrates the number of yellow nutsedge seedlings per pot of soil treated with benzaldehyde or salicylaldehyde in biodiesel after eighteen days.

FIG. 307 illustrates the number of crabgrass seedlings per pot of soil treated with benzaldehyde or salicylaldehyde in biodiesel after eighteen days.

FIG. 308 illustrates the number of teaweed seedlings per pot of soil treated with benzaldehyde or salicylaldehyde in biodiesel after eighteen days.

FIG. 309 illustrates the number of sicklepod seedlings per pot of soil treated with benzaldehyde or salicylaldehyde in biodiesel after eighteen days.

FIG. 310 illustrates the number of morning glory seedlings per pot of soil treated with benzaldehyde or salicylaldehyde in biodiesel after eighteen days.

FIG. 311 illustrates the total number of weeds per pot of soil treated with basamide or hydrogen cyanamide in biodiesel (verdisol) after seven days.

FIG. 312 illustrates the number of yellow nutsedge seedlings per pot of soil treated with basamide or hydrogen cyanamide in biodiesel (verdisol) after seven days.

FIG. 313 illustrates the number of crabgrass seedlings per pot of soil treated with basamide or hydrogen cyanamide in biodiesel (verdisol) after seven days.

FIG. 314 illustrates the number of teaweed seedlings per pot of soil treated with basamide or hydrogen cyanamide in biodiesel (verdisol) after seven days.

FIG. 315 illustrates the number of sicklepod seedlings per pot of soil treated with basamide or hydrogen cyanamide in biodiesel (verdisol) after seven days.

FIG. 316 illustrates the number of morning glory seedlings per pot of soil treated with basamide or hydrogen cyanamide in biodiesel (verdisol) after seven days.

FIG. 317 illustrates the total number of weeds per pot of soil treated with basamide or hydrogen cyanamide in biodiesel (verdisol) after thirteen days.

FIG. 318 illustrates the number of yellow nutsedge seedlings per pot of soil treated with basamide or hydrogen cyanamide in biodiesel (verdisol) after thirteen days.

FIG. 319 illustrates the number of crabgrass seedlings per pot of soil treated with basamide or hydrogen cyanamide in biodiesel (verdisol) after thirteen days.

FIG. 320 illustrates the number of teaweed seedlings per pot of soil treated with basamide or hydrogen cyanamide in biodiesel (verdisol) after thirteen days.

FIG. 321 illustrates the number of sicklepod seedlings per pot of soil treated with basamide or hydrogen cyanamide in biodiesel (verdisol) after thirteen days.

FIG. 322 illustrates the number of morning glory seedlings per pot of soil treated with basamide or hydrogen cyanamide in biodiesel (verdisol) after thirteen days.

FIG. 323 illustrates the total number of weeds per pot of soil treated with basamide or hydrogen cyanamide in biodiesel (verdisol) after twenty-one days.

FIG. 324 illustrates the number of yellow nutsedge seedlings per pot of soil treated with basamide or hydrogen cyanamide in biodiesel (verdisol) after twenty-one days.

FIG. 325 illustrates the number of crabgrass seedlings per pot of soil treated with basamide or hydrogen cyanamide in biodiesel (verdisol) after twenty-one days.

FIG. 326 illustrates the number of teaweed seedlings per pot of soil treated with basamide or hydrogen cyanamide in biodiesel (verdisol) after twenty-one days.

FIG. 327 illustrates the number of sicklepod seedlings per pot of soil treated with basamide or hydrogen cyanamide in biodiesel (verdisol) after twenty-one days.

FIG. 328 illustrates the number of morning glory seedlings per pot of soil treated with basamide or hydrogen cyanamide in biodiesel (verdisol) after twenty-one days.

FIG. 329 illustrates the total number of weeds per pot of soil treated with basamide in biodiesel (verdisol) after eleven days.

FIG. 330 illustrates the number of yellow nutsedge seedlings per pot of soil treated with basamide in biodiesel (verdisol) after eleven days.

FIG. 331 illustrates the number of crabgrass seedlings per pot of soil treated with basamide in biodiesel (verdisol) after eleven days.

FIG. 332 illustrates the number of teaweed seedlings per pot of soil treated with basamide in biodiesel (verdisol) after eleven days.

FIG. 333 illustrates the number of sicklepod seedlings per pot of soil treated with basamide in biodiesel (verdisol) after eleven days.

FIG. 334 illustrates the total number of weeds per pot of soil treated with basamide in biodiesel (verdisol) after eighteen days.

FIG. 335 illustrates the number of yellow nutsedge seedlings per pot of soil treated with basamide in biodiesel (verdisol) after eighteen days.

FIG. 336 illustrates the number of crabgrass seedlings per pot of soil treated with basamide in biodiesel (verdisol) after eighteen days.

FIG. 337 illustrates the number of teaweed seedlings per pot of soil treated with basamide in biodiesel (verdisol) after eighteen days.

FIG. 338 illustrates the number of sicklepod seedlings per pot of soil treated with basamide in biodiesel (verdisol) after eighteen days.

FIG. 339 illustrates the total number of weeds per pot of soil treated with basamide in biodiesel (verdisol) after twenty-six days.

FIG. 340 illustrates the number of yellow nutsedge seedlings per pot of soil treated with basamide in biodiesel (verdisol) after twenty-six days.

FIG. 341 illustrates the number of crabgrass seedlings per pot of soil treated with basamide in biodiesel (verdisol) after twenty-six days.

FIG. 342 illustrates the number of teaweed seedlings per pot of soil treated with basamide in biodiesel (verdisol) after twenty-six days.

FIG. 343 illustrates the number of sicklepod seedlings per pot of soil treated with basamide in biodiesel (verdisol) after twenty-six days.

FIG. 344 illustrates the number of morning glory seedlings per pot of soil treated with basamide in biodiesel (verdisol) after twenty-six days.

FIG. 345 illustrates the total number of weeds per pot of soil treated with basamide in biodiesel (verdisol) after five days.

FIG. 346 illustrates the number of yellow nutsedge seedlings per pot of soil treated with basamide in biodiesel (verdisol) after live days.

FIG. 347 illustrates the number of crabgrass seedlings per pot of soil treated with basamide in biodiesel (verdisol) after five days.

FIG. 348 illustrates the number of teaweed seedlings per pot of soil treated with basamide in biodiesel (verdisol) after five days.

FIG. 349 illustrates the number of sicklepod seedlings per pot of soil treated with basamide in biodiesel (verdisol) after five days.

FIG. 350 illustrates the number of morning glory seedlings per pot of soil treated with basamide in biodiesel (verdisol) after five days.

FIG. 351 illustrates the total number of weeds per pot of soil treated with basamide in biodiesel (verdisol) after twelve days.

FIG. 352 illustrates the number of yellow nutsedge seedlings per pot of soil treated with basamide in biodiesel (verdisol) after twelve days.

FIG. 353 illustrates the number of crabgrass seedlings per pot of soil treated with basamide in biodiesel (verdisol) after twelve days.

FIG. 354 illustrates the number of teaweed seedlings per pot of soil treated with basamide in biodiesel (verdisol) after twelve days.

FIG. 355 illustrates the number of sicklepod seedlings per pot of soil treated with basamide in biodiesel (verdisol) after twelve days.

FIG. 356 illustrates the number of morning glory seedlings per pot of soil treated with basamide in biodiesel (verdisol) after twelve days.

FIG. 357 illustrates the total number of weeds per pot of soil treated with basamide in biodiesel (verdisol) after twenty-six days.

FIG. 358 illustrates the number of yellow nutsedge seedlings per pot of soil treated with basamide in biodiesel (verdisol) after twenty-six days.

FIG. 359 illustrates the number of crabgrass seedlings per pot of soil treated with basamide in biodiesel (verdisol) after twenty-six days.

FIG. 360 illustrates the number of teaweed seedlings per pot of soil treated with basamide in biodiesel (verdisol) after twenty-six days.

FIG. 361 illustrates the number of sicklepod seedlings per pot of soil treated with basamide in biodiesel (verdisol) after twenty-six days.

FIG. 362 illustrates the number of morning glory seedlings per pot of soil treated with basamide in biodiesel (verdisol) after twenty-six days.

FIG. 363 illustrates the total number of weeds per pot of soil treated with menthol in biodiesel (verdisol) after five days.

FIG. 364 illustrates the number of yellow nutsedge seedlings per pot of soil treated with menthol in biodiesel (verdisol) after five days.

FIG. 365 illustrates the number of crabgrass seedlings per pot of soil treated with menthol in biodiesel (verdisol) after five days.

FIG. 366 illustrates the number of teaweed seedlings per pot of soil treated with menthol in biodiesel (verdisol) after five days.

FIG. 367 illustrates the number of sicklepod seedlings per pot of soil treated with menthol in biodiesel (verdisol) after five days.

FIG. 368 illustrates the number of morning glory seedlings per pot of soil treated with menthol in biodiesel (verdisol) after five days.

FIG. 369 illustrates the total number of weeds per pot of soil treated with menthol in biodiesel (verdisol) after ten days.

FIG. 370 illustrates the number of yellow nutsedge seedlings per pot of soil treated with menthol in biodiesel (verdisol) after ten days.

FIG. 371 illustrates the number of crabgrass seedlings per pot of soil treated with menthol in biodiesel (verdisol) after ten days.

FIG. 372 illustrates the number of teaweed seedlings per pot of soil treated with menthol in biodiesel (verdisol) after ten days.

FIG. 373 illustrates the number of sicklepod seedlings per pot of soil treated with menthol in biodiesel (verdisol) after ten days.

FIG. 374 illustrates the number of morning glory seedlings per pot of soil treated with menthol in biodiesel (verdisol) after ten days.

FIG. 375 illustrates the total number of weeds per pot of soil treated with menthol in biodiesel (verdisol) after twenty-four days.

FIG. 376 illustrates the number of yellow nutsedge seedlings per pot of soil treated with menthol in biodiesel (verdisol) after twenty-four days.

FIG. 377 illustrates the number of crabgrass seedlings per pot of soil treated with menthol in biodiesel (verdisol) after twenty-four days.

FIG. 378 illustrates the number of teaweed seedlings per pot of soil treated with menthol in biodiesel (verdisol) after twenty-four days.

FIG. 379 illustrates the number of sicklepod seedlings per pot of soil treated with menthol in biodiesel (verdisol) after twenty-four days.

FIG. 380 illustrates the number of morning glory seedlings per pot of soil treated with menthol in biodiesel (verdisol) after twenty-four days.

FIG. 381 illustrates the total number of weeds per pot of soil treated with bioglycerin and urea after six days.

FIG. 382 illustrates the number of crabgrass seedlings per pot of soil treated with bioglycerin and urea after six days.

FIG. 383 illustrates the number of teaweed seedlings per pot of soil treated with bioglycerin and urea after six days.

FIG. 384 illustrates the number of sicklepod seedlings per pot of soil treated with bioglycerin and urea after six days.

FIG. 385 illustrates the number of morning glory seedlings per pot of soil treated with bioglycerin and urea after six days.

FIG. 386 illustrates the total number of weeds per pot of soil treated with bioglycerin and urea after eleven days.

FIG. 387 illustrates the number of crabgrass seedlings per pot of soil treated with bioglycerin and urea after eleven days.

FIG. 388 illustrates the number of teaweed seedlings per pot of soil treated with bioglycerin and urea after eleven days.

FIG. 389 illustrates the number of sicklepod seedlings per pot of soil treated with bioglycerin and urea after eleven days.

FIG. 390 illustrates the number of morning glory seedlings per pot of soil treated with bioglycerin and urea after eleven days.

FIG. 391 illustrates the total number of weeds per pot of soil treated with bioglycerin and urea after thirty-nine days.

FIG. 392 illustrates the number of yellow nutsedge seedlings per pot of soil treated with bioglycerin and urea after thirty-nine days.

FIG. 393 illustrates the number of crabgrass seedlings per pot of soil treated with bioglycerin and urea after thirty-nine days.

FIG. 394 illustrates the number of teaweed seedlings per pot of soil treated with bioglycerin and urea after thirty-nine days.

FIG. 395 illustrates the number of sicklepod seedlings per pot of soil treated with bioglycerin and urea after thirty-nine days.

FIG. 396 illustrates the number of morning glory seedlings per pot of soil treated with bioglycerin and urea after thirty-nine days.

### DETAILED DESCRIPTION

The present invention is described herein using several definitions, as set forth below and throughout the application.

Unless otherwise specified, the terms “a” or “an” mean “one or more.”

As used herein, “about” and “substantially” will be understood by persons of ordinary skill in the art and will vary to some extent on the context in which they are used. If there are uses of the term which are not clear to persons of ordinary skill in the art given the context in which it is used, “about” will mean up to plus or minus 10% of the particular term and “substantially” will mean more than plus or minus 10% of the particular term.

The disclosed compositions are pesticide compositions which comprise biodiesel and may be utilized for controlling pests, weeds, or both and further may be used as soil-amendments that exhibit fertilizing activity. The use of treated biodiesel glycerin for controlling pests, weeds, or both and further as a soil amendment is disclosed in U.S. published application number U.S. 2008-0214679, the content of which is incorporated herein by reference in its entirety.

The disclosed compositions may include liquid compositions. Percentage concentrations may refer to percentage on a mass/volume or on a volume/volume basis as indicated.

The disclosed compositions typically include biodiesel. As used herein, “biodiesel” refers to a long-chain alkyl ester formed by reacting vegetable oil or animal fat (e.g., tallow) with an alcohol. The reaction for producing BDF may include a transesterification reaction or alcoholysis reaction that occurs in a basic reaction mixture (e.g., having a pH greater than about 11) comprising triglycerides (e.g., which are present in animal or vegetable fats or oils, such as tallow, soybean oil, or canola oil) and alcohol (e.g., methanol, ethanol, or propanol). The reaction mixture may produce fatty acid alkyl esters (e.g., fatty acid methyl esters) and glycerin. Suitable bases for the transesterification reaction may include, but are not limited to, metal hydroxides (e.g., NaOH and KOH), metal alkoxides (e.g., NaOCH₃ and KOCH₃), and mixtures thereof. In some embodiments, the base is a potassium salt (e.g., KOH, KOCH₃, or mixture thereof). Suitable alcohols may include, but are not limited to, aliphatic alcohols such as methanol, ethanol, propanol, or a mixture thereof. The biodiesel produced thereby typically is an alkyl ester compound having a formula

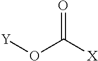

where X is a 12-24 carbon chain which is saturated or unsaturated at one or more positions; and Y is a 1-6 chain alkyl group such as, methyl, ethyl, or propyl. In some embodiments, biodiesel may include methyl laurate, methyl myristate, methyl palmitate, methyl stearate, methyl myristoleate, methyl palmitoleate, methyl oleate, methyl linoleate, ethyl laurate, ethyl myristate, ethyl palmitate, ethyl stearate, ethyl myristoleate, ethyl palmitoleate, ethyl oleate, ethyl linoleate, propyl laurate, propyl myristate, propyl palmitate, propyl stearate, propyl myristoleate, propyl palmitoleate, propyl oleate, or propyl linoleate.

In some embodiments, the pH of the biodiesel is adjusted (e.g., to about 4-6) by adding acid. Suitable acids include, but are not limited to, organic acids such as carboxylic acids (e.g., acetic acid, propionic acid, butyric acid, valeric acid, or mixtures thereof), inorganic acids (e.g., phosphoric acid, sulfuric acid, or mixtures thereof), or mixtures of organic acids and inorganic acids. Suitable acids may include polyhydroxycarboxylic acids (e.g., citric acid). In some embodiments, the acid is a mixture an organic acid and an inorganic acid, such as a mixture of propionic acid and phosphoric acid (preferably at a ratio of about (3-1):1 or at a ratio of about 2:1).

In some embodiments of the disclosed compositions, biodiesel is present in the compositions at a concentration of about 1-50% (or about 2-25%, about 3-10%, or about 4-6%). The disclosed composition may be applied to soil at an application rate that achieves an effective concentration of biodiesel in the soil of at least about 25 mg/kg soil (or at least about 50 mg/kg soil, 100 mg/kg soil, 200 mg/kg soil, 300 mg/kg soil, 400 mg/kg soil, 500 mg/kg soil, 600 mg/kg soil, 700 mg/kg soil, 800 mg/kg soil, 900 mg/kg soil, 1000 mg/kg soil, 1110 mg/kg, or 1200 mg/kg soil).

As used herein, the phrase “effective amount” or “effective rate” shall mean that amount or rate that provides the specific response for which the composition is applied in a significant number of applications. The disclosed compositions may include an effective amount of a pesticide to achieve a pesticidal effect (e.g., a nematicidal, a fungicidal, an herbicidal, or insecticidal effect) when applied at a given application rate. In some embodiments, the disclosed compositions include a pesticide and are applied to soil at an application rate that achieves an effective concentration of pesticide of at least about 25 mg/kg soil (or at least about 50 mg/kg soil, 100 mg/kg soil, 200 mg/kg soil, 300 mg/kg soil, 400 mg/kg soil, 500 mg/kg soil, 600 mg/kg soil, 700 mg/kg soil, 800 mg/kg soil, 900 mg/kg soil, 1000 mg/kg soil, 1100 mg/kg soil, or 1200 mg/kg soil). A “nematicidally effective amount” as used herein refers to an amount of one or more nematicides suitable for having an adverse effect on nematicide growth. A nematicidally effect amount. An “herbicidally effective amount” as used herein refers to an amount of one or more herbicides suitable for having an adverse effect on plant growth.

The disclosed compositions may be utilized to control one or more pests (e.g., parasitic nematodes, fungi, and weeds). As used herein, “controlling pests” means preventing the growth of pests, eliminating pests, or killing pests. Controlling pests may result in reducing the pest population in a soil sample. In some embodiments, the disclosed compositions are applied to soil at a given rate (e.g., about 1 ml/kg soil, about 2 ml/kg soil, about 3 ml/kg soil, or about 4 ml/kg soil) and reduce the pest population in the soil (e.g., parasitic nematodes as measured by number of pests/mls soil) by at least about 50% (or at least about 60%, 70%, 80%, or 90%). In further embodiments, the disclosed compositions do not significantly reduce the population of beneficial nematodes present in the soil (e.g., microbivores), where the disclosed composition are applied to soil at a given rate (e.g., at least about 1 ml/kg soil, about 2 ml/kg soil, about 3 ml/kg soil, or about 4 ml/kg soil) and do not reduce the beneficial nematode population in the soil by more than about 50% (or no more than about 40%, 30%, 20%, or 10%). In some embodiments, the disclosed compositions are applied to soil at a given rate (e.g., at least about 1 ml/kg soil, about 2 ml/kg soil, about 3 ml/kg soil, or about 4 ml/kg soil) and reduce the growth rate of weeds by at least about 50% (or at least about 60%, 70%, 80%, or 90%). In further embodiments, the disclosed compositions do not significantly reduce the growth rate of agricultural crops, for example where the disclosed composition are applied to soil at a given rate (e.g., at least about 1 ml/kg soil, about 2 ml/kg soil, about 3 ml/kg soil, or about 4 ml/kg soil) and do not reduce the growth rate of the agricultural crop population by more than about 50% (or no more than about 40%, 30%, 20%, or 10%).

The disclosed compositions may be utilized for controlling pests, weeds, or both and further may be used as soil-amendments that exhibit fertilizing activity. For example, the disclosed compositions may include one or more of assimilable potassium, phosphorus, and nitrogen. In some embodiments, biodiesel is obtained from a transesterification reaction in which a potassium salt is used as a catalyst or a basifying agent (e.g., KOH or KOCH₃). In further embodiments, the crude biodiesel may then be treated with a phosphorus-containing acid (e.g., phosphoric acid or phosphorous acid) to neutralize the reaction.

The disclosed composition may be utilized as soil-amendments. In some embodiments, the composition includes a pesticide, biodiesel, and further may include a nitrogen source. In some embodiments, the disclosed compositions have a molar ratio of total carbon to total nitrogen (C:N) of about (22.4-5.6):1, and preferably about (16.8-11.2):1. Nitrogen sources may include organic nitrogen sources, inorganic nitrogen sources, or a mixture thereof. Suitable organic nitrogen sources may include, but are not limited to, urea, casein, and mixtures thereof. Addition suitable sources of organic nitrogen may include, but are not limited to, manure (e.g., dairy manure, cage manure including egg layers' manure, or mixtures thereof), hay (e.g., legume hay, grass hay, or mixtures thereof), and meal (e.g., alfalfa meal, soybean meal, blood meal, cottonseed meal, crab meal, fish meal, feather meal, or mixtures thereof). Suitable inorganic nitrogen sources may include, but are not limited to, ammonium salts (e.g., ammonium sulfate), nitrite salts, nitrate salts (e.g., potassium nitrate or ammonium nitrate), and mixtures thereof. Preferably, the nitrogen source may be readily assimilated by plants when the disclosed compositions are utilized as soil-amendments. The nitrogen source may be added to the composition as a solid or as a solution. In further embodiments, the disclosed compositions do not include a nitrogen source and may be added to soil as an amendment in order to achieve in the amended soil a molar ratio of total carbon to total nitrogen (C:N) of about (22.4-5.6):1, and preferably about (16.8-11.2):1, where the soil, prior to amendment, includes a nitrogen source.

Incorporation into soil of organic matter with the appropriate C:N ratio is one of the best methods to suppress plant parasitic nematodes and other soil-borne pests. Stimulation of microbial activities in soil following incorporation of organic amendments has been repeatedly demonstrated to results in control of plant parasitic nematodes, a number of phytopathogenic fungi and even some insects and weeds. (Rodriguez-Kabana, R, and M. H. Pope, Nematropica 11: 175-186 (1986); Rodriguez-Kabana, R, G. Morgan-Jones, and T. Chet. 1987. Plant and Soil 100: 237-247; Stirling, G. K. 1991. Biological control of plant parasitic nematodes: progress, problem and prospects. Wallingford, Oxon, UK, CAB International, pp. 282; incorporated herein by reference in their entireties). Considerable research has been directed to the preparation of organic amendments based on agricultural wastes and other by-products of human activities, e.g., chicken and other manures, sewage and other urban ordures, in order to dispose of these materials in an environmentally acceptable manner (Stirling, 1991). In some embodiments, the disclosed compositions include a nitrogen source which may be an organic nitrogen source or an inorganic nitrogen source. Preferably, the nitrogen source is soluble in biodiesel. The disclosed compositions may have a suitable C:N ratio (e.g., a C:N ration that about (22.4-5.6):1 or about (16.8-11.2):1). As used herein, “an effective amount of a nitrogen source” refers to the amount of nitrogen required to prevent phytotoxic effects (e.g., the amount of nitrogen to result in a C:N ratio of about (22.4-5.6):1, and preferably about (16.8-11.2):1.

Depending on their properties, the pesticide compositions disclosed herein may be used before or after emergence of the plants. For example, the pesticide compositions disclosed herein may be used for pre-treating the seed of the crop plant (seed dressing) or introduced into the seed furrows prior to sowing or used before or after emergence of the plants. Pre-emergence treatment includes not only the treatment of the area under cultivation before sowing, but also the treatment of the sown soil which does not yet sustain vegetation. Preferably, the pesticide compositions or provided as a tank-mix or ready-mix for application.

Suitable possibilities of formulation for the presently disclosed pesticide compositions include, but are not limited to, emulsifiable concentrates (EC), water-soluble concentrates (SL), concentrated emulsions (BW) such as oil-in-water and water-in-oil emulsions, sprayable solutions or emulsions, capsule suspensions (CS), oil- or water-based dispersions, suspension concentrates (SC), dusts (DP), oil-miscible solutions (OL), water-soluble powders (SP), wettable powders (WP), seed-dressing products, granules (GR) in the form of microgranules, spray granules, coated granules and absorption granules, granules for soil application or broadcasting, water-soluble granules (SG), water-dispersible granules (WG), ULV formulations, microcapsules and waxes. These individual formulation types are known in principle and are described, for example, in: Winnacker-Kuchler, “Chemische Technologie” [Chemical engineering], Volume 7, C. Hauser Verlag Munich, 4th Ed., 1986; Wade van Valkenburg, “Pesticide Formulations”, Marcel Dekker N.Y., 1973; K. Martens, “Spray Drying Handbook”, 3rd Ed. 1979, G. Goodwin Ltd. London (incorporated by reference herein in its entirety). The formulation auxiliaries which may be required, such as inert materials, surfactants, solvents and further additives are likewise known and described, for example, in: Watkins, “Handbook of Insecticide Dust Diluents and Carriers”, 2nd Ed., Darland Books, Caldwell N.J., H. v. Olphen, “Introduction to Clay Colloid Chemistry”; 2nd Ed., J. Wiley & Sons, N.Y.; C. Marsden, “Solvents Guide”; 2nd Ed., Interscience, N.Y. 1963; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schonfeldt, “Grenzflachenaktive Athylenoxidaddukte” [Surface-active ethylene oxide adducts], Wiss. Verlagsgesell., Stuttgart 1976; Winnacker-Kuchler, “Chemische Technologie”, Volume 7, C. Hauser Verlag Munich, 4th Ed. 1986 (incorporated by reference herein in their entirities). Based on these formulations, combinations with other crop protectants such as insecticides, acaricides, herbicides, fungicides, fertilizers and/or growth regulators may also be prepared, for example in the form of a ready-mix or a tank-mix.

Emulsifiable concentrates may be prepared for example by adding a surfactant or emulsifier to the pesticide compositions. Suitable surfactants may include ionic and/or nonionic surfactants (i.e., wetters, dispersants), for example polyoxethylated alkylphenols, polyoxethylated fatty alcohols, polyoxethylated fatty amines, fatty alcohol polyglycol ether sulfates, alkanesulfonates, alkylbenzenesulfonates, sodium lignosulfonate, sodium 2,2′-dinaphthylmethane-6,6′-disulfonate, sodium dibutylnaphthalene-sulfonate, or else sodium oleoylmethyltaurinate, in addition to a diluent or inert substance. Suspension concentrates may be water- or oil-based. They can be prepared for example by wet-milling by means of commercially available bead mills, if appropriate with addition of surfactants as, for example, have already been listed above in the case of the other formulation types. Emulsions, for example oil-in-water emulsions (EW), can be prepared for example by means of stirrers, colloid mills and/or static mixers using aqueous organic solvents and, if appropriate, surfactants as, for example, have already been listed above in the case of the other formulation types.

Granules can be produced either by spraying the active compound onto adsorptive granulated inert material or by applying active compound concentrates to the surface of carriers such as sand, kaolinite or of granulated inert material by means of binders, for example polyvinyl alcohol, sodium polyacrylate or else mineral oils. Suitable active compounds may also be granulated in the manner which is conventional for the production of fertilizer granules, if desired as a mixture with fertilizers.

Water-dispersible granules may be prepared by the customary methods such as spray-drying, fluidized-bed granulation, disk granulation, mixing by means of high-speed mixers, and extrusion without solid inert material. To prepare disk, fluidized-bed, extruder and spray granules, see, e.g., methods disclosed in “Spray-Drying Handbook” 3rd ed. 1979, G. Goodwin Ltd., London; J. E. Browning, “Agglomeration”, Chemical and Engineering 1967, pages 147 et seq.; “Perry's Chemical Engineer's Handbook”, 5th Ed., McGraw-Hill, New York 1973, pp. 8-57 (incorporated by reference herein in their entirities). For further details on the formulation of crop protection agents, see, e.g. G. C. Klingman. “Weed Control as a Science”, John Wiley and Sons, Inc., New York, 1961, pages 81-96 and J. D. Freyer, S. A. Evans, “Weed Control Handbook”, 5th Ed., Blackwell Scientific Publications, Oxford, 1968, pages 101-103 (incorporated by reference herein in their entirities). In addition, the active compound formulations mentioned comprise, if appropriate, the adhesives, wetters, dispersants, emulsifiers, penetrants, preservatives, antifreeze agents, solvents, fillers, carriers, colorants, antifoams, evaporation inhibitors, pH regulators and viscosity regulators which are conventional in each case.

The disclosed composition and methods utilize or include pesticide actives. As disclosed herein, a “pesticide active” may include, but is not limited to, aqueous or non-aqueous pesticide liquids or pesticide compounds which optionally are dissolved in aqueous or non-aqueous solvents as a pesticide solution. Pesticides may include, but are not limited to nematicides, herbicides, insecticides, fungicides, and combinations thereof. In some embodiments, the pesticide may be selected from a group consisting of a menthol compound (e.g, (−)-Menthol, (+)-Menthol, (−)-Isomenthol, (+)-Isomenthol, (−)-Neomenthol, (+)-Neomenthol, (−)-Neoisomenthol, (+)-Neoisomenthol), an alkyl cyanamide compound (e.g. dimethyl cyanamide), a 3,5-alkyltetrahydro-1,3,5-thiadiazine-2-thione compound (e.g., 3,5-dimethyltetrahydro-1,3,5-thiadiazine-2-thione (i.e., dazomet sold under the brand name Basomid®) optionally together with furfural (i.e., furan-2-carboxaldehyde)), an aldehyde compound comprising a cyclic aromatic substituent (e.g. benzaldehyde, anisaldehyde, salicylaldehyde, and cinnamaldehyde), an isothiocyanate compound (e.g., methyl isothiocyanate, allyl isothiocyanate, and phenyl isothiocyanate, where optionally the isothiocyanate compound is obtained from mustard seed (i.e., methyl mustard oil) or cabbage), a capsaicinoid compound (e.g., capsaicin, dihydrocapsaicin, nordihydrocagsaicin, homodihydrocapsaicin, homocapsaicin, and nonivamide), an unsaturated aldehyde compound (e.g. propenal (i.e. acrolein) 3,7-dimethyl-2,6-octadienal (i.e. citral or lemonal, and optionally obtained from lemon grass or lemon thyme oil), and crotonaldehyde), a phenol compound optionally substituted with alkyl (e.g., 2-isopropyl-5-methylphenol (i.e., thymol)), a halogenated propene (e.g., dichloropropene), a diazirine compound, an orange terpene compound, and combinations thereof.

In some embodiments, the pesticide compound is an alkyl cyanamide compound having a formula:

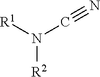

where R¹ and R² are the same or different and are selected from H and C₁₋₆ straight chain or branched alkyl and at least one of R¹ and R² are C₁₋₆ straight chain or branched alkyl. For example, the pesticide compound may include dimethyl cyanamide having a formula:

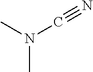

In some embodiments, the pesticide compound is an alkyltetrahydro-1,3,5-thiathazine-2-thione compound has a formula:

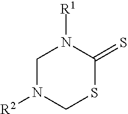

where R¹ and R² are the same or different and are selected from H and C₁₋₆ straight chain or branched alkyl, and at least one of R¹ and R² are C₁₋₆ straight chain or branched alkyl. For example, the pesticide compound may include 3,5-dimethyltetrahydro-1,3,5-thiadiazine-2-thione having a formula:

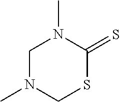

(i.e., dazomet, which optionally may be mixed or dissolved in furfural (i.e., furan-2-carboxaldehyde)).

In some embodiments, the pesticide compound is an aldehyde compound comprising a cyclic aromatic substituent and having a formula:

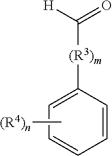

wherein R³ is C₁₋₆ alkyl or alkenyl and m is 0 or 1; and R⁴ is hydroxyl and n is 0, 1, 2, or 3. For example, the pesticide compound may include benzaldehyde having a formula:

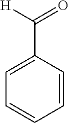

anisaldehyde having a formula:

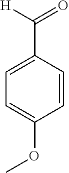

salicylaldehyde having a formula:

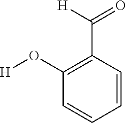

or cinnamaldehyde having a formula:

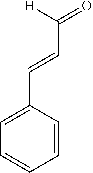

In some embodiments, the pesticide compound is an isothiocyanate compound having a formula:

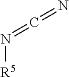

where R⁵ is C₁₋₆ straight chain or branched alkyl; C₁₋₆ straight chain or branched alkenyl; or aryl. For example, the pesticide composition may include methyl isothiocyanate having a formula:

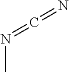

allyl isothiocyanate having a formula:

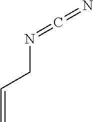

or phenyl isothiocyanate having a formula:

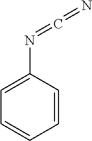

In some embodiments, the pesticide compound is an unsaturated aldehyde compound having a formula:

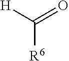

wherein R⁶ is C₃₋₁₂ straight chain or branched alkenyl. For example, the pesticide active may include propenal (i.e., acrolein) having a formula:

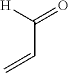

3,7,-dimethyl-2,6-octadienal (i.e., citral or lemonal) having a formula:

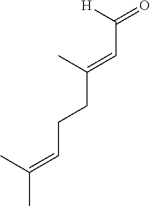

or crotonaldehyde having a formula:

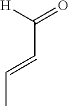

In some embodiments, the pesticide compound is a phenol compound optionally substituted with alkyl and having a formula:

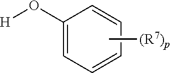

wherein R⁷ is C₁₋₆ straight chain or branched alkyl and p is 0, 1, 2, or 3. For example, the pesticide compound may include 2-isopropyl-5-methylphenol (i.e., thymol) having a formula:

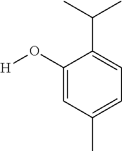

In some embodiments, the pesticide compound is a diazirine compound having a formula:

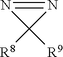

where R⁸ and R⁹ are H or C₁₋₆ straight chain or branched alkyl. For example, the pesticide composition may include diazirine having a formula:

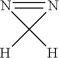

In some embodiments, the pesticide active may include an agent selected from the group consisting of a thiocarbamate (e.g., ethyl dipropylthiocarbamate (EPTC); ethyl N,N-diisobutylthiocarbamate (butylate); S-ethyl N-ethylthiocyclohexanecarbamate (cycloate); S-Ethyl N,N-hexamethylenethiocarbamate (molinate); S-propyl dipropylthiocarbamate (vernolate), and mixtures thereof); a haloacetanilide (e.g., 2-Chloro-2′-methyl-6-ethyl-N-ethoxymethylacetanilide (acetocholor); 2-Ethyl-6-methyl-1-N-(2-methoxy-1-methylethyl)chloroacetanilide (metolachlor); 2-Chloro-2′,6′-diethyl-N-(methoxymethyl)acetanilide (alachlor); 2′,6′-Diethyl-N-butoxymethyl-2-chloroacetanilide (butachlor); 2-Chloro-N-isopropylacetanilide (propachlor); and mixtures thereof); a nitroaniline (e.g., 2,6-Dinitro-N,N-dipropyl-4-trifluoromethylaniline (trifluralin); 2,6-Dichloro-4-nitroaniline (dicloran); and mixtures thereof); an organophosphate (e.g., Diethyl 4-nitrophenyl phosphorothionate (parathion); S-(1,2-Di(ethoxycarbonyl)ethyl)dimethyl phosphorothiolothionate (malathion); O-Ethyl S-phenyl ethylphosphonothiolothionate (fonofos); and mixtures thereof); a pyrethroid (e.g., permethrin, lambda-cyhalothrin, deltamethrin, tralomethrin, cypermethrin, tefluthrin, and mixtures thereof); a strobilurin (e.g., azoxystrobin, kresoxim-methyl, picoxystrobin, fluoxastrobin, oryzastrobin, dimoxystrobin, pyraclostrobin, trifloxystrobin, and mixtures thereof); and mixtures thereof. Classification of compounds as herbicides (i.e., the grouping of herbicides into classes and subclasses) is well-known in the art and includes classifications by HRAC (Herbicide Resistance Action Committee) and WSSA (the Weed Science Society of America) (see also, Retzinger and Mallory-Smith (1997) Weed Technology 11: 384-393, incorporated by reference in its entirety). Compounds classified as herbicides by the HRAC and WSSA are contemplated herein for use the disclosed pesticide compositions.

In some embodiments, the application rates of the disclosed pesticide compositions may vary within a range of about 0.001 to 5 kg (preferably within a range of about 0.005 to 0.5 kg) of active compound per hectare (ha). In some embodiments, the pesticide active or active ingredient (ai) may be applied at a rate of application within a range of about 0.01 kg ai/ha to about 1 kg ai/ha, and preferably within a range of about 0.02 to about 0.5 kg ai/ha.

### Illustrative Embodiments

The following list of embodiments is illustrative and is not intended to limit the scope of the claimed subject matter.

Embodiment 1. A pesticide composition comprising: (a) an effective amount of a pesticide for controlling a pest; (b) biodiesel; and optionally (c) an effective amount of a nitrogen source; wherein the composition has a molar ratio of total carbon to total nitrogen (C:N) of about (22.4-5.6):1.

Embodiment 2. The composition of embodiment 1, wherein the pesticide is a nematicide.

Embodiment 3. The composition of embodiment 2, wherein the nematicide is effective for controlling a nematode selected from a group consisting of Rotylenchulus reniformis, Dorylaimida spp., Meloidogyne incognita, Hoploaimus galeatus, Paratrichodorus minor, and combinations thereof.

Embodiment 4. The composition of embodiment 2 or 3, wherein the composition is effective for reducing nematodes by at least about 50% when applied at an application rate of about 1 ml/kg soil.

Embodiment 5. The composition of any of embodiments 1-4, wherein the composition does not reduce microbivorous nematodes by more than about 50% when applied at an application rate of about 1 ml/kg soil.

Embodiment 6. The composition of any of embodiments 1-5, wherein the pesticide is an herbicide.

Embodiment 7. The composition of embodiment 6, wherein the herbicide is effective for controlling a weed selected from a group consisting of Ipomoea spp., Digitaria sanguinalis, Senna obtusifolia, Datura stramonium, Setaria glauca, Amaranthus retroflexus, and combinations thereof.

Embodiment 8. The composition of embodiment 6 or 7, wherein the composition is effective for reducing weeds by at least about 50% when applied at an application rate of about 1 ml/kg soil.

Embodiment 9. The composition of any of embodiments 1-8, wherein the pesticide is a fungicide.

Embodiment 10. The composition of embodiment 9, wherein the fungicide is effective for controlling a fungus selected from a group consisting of Rhizoctonia solani. Pythium spp., and Fusarium spp., and a combination thereof.

Embodiment 11. The composition of any of embodiments 1-10, wherein the biodiesel is produced from reacting a mixture comprising: (a) animal fat, vegetable oil, or a mixture thereof; (b) a base, wherein the reaction mixture has a pH of at least about 11; and (c) an alcohol selected from a group consisting of methanol, ethanol, and a mixture thereof.

Embodiment 12. The composition of embodiment 11, wherein the base is selected from the group consisting of NaOH, KOH, NaOCH₃ and KOCH₃.

Embodiment 13. The composition of any of embodiments 1-12, wherein the biodiesel comprises an alkyl ester selected from a group consisting of methyl linoleate, methyl stearate, ethyl linoleate, ethyl stearate, or a combination thereof.

Embodiment 14. The composition of any of embodiments 1-13, wherein the pesticide is selected from a group consisting of a menthol compound, an alkyl cyanamide compound, a 3,5-alkyltetrahydro-1,3,5-thiadiazine-2-thione compound, an aldehyde compound comprising a cyclic aromatic substituent, an isothiocyanate compound, a capsaicinoid compound, an unsaturated aldehyde compound, a phenol compound optionally substituted with alkyl, a halogenated propene, and combinations thereof.

Embodiment 15. The composition of embodiment 14, wherein the menthol is selected from a group consisting of (−)-Menthol, (+)-Menthol, (−)-Isomenthol, (+)-Isomenthol, (−)-Neomenthol, (+)-Neomenthol, (−)-Neoisomenthol, (+)-Neoisomenthol, a pure isomer of any of the foregoing compounds, or a mixture thereof.

Embodiment 16. The composition of embodiment 15, wherein the compound is (−)-Menthol.

Embodiment 17. The composition of embodiment 14, wherein the alkyl cyanamide compound has a formula:

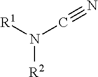

wherein R¹ and R² are the same or different and are selected from H and C₁₋₆ straight chain or branched alkyl and at least one of R¹ and R² are C₁₋₆ straight chain or branched alkyl.

Embodiment 18. The composition of embodiment 17, wherein the alkyl cyanamide is dimethyl cyanamide having a formula:

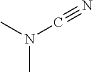

Embodiment 19. The composition of embodiment 14, wherein the an alkyltetrahydro-1,3,5-thiadiazine-2-thione compound has a formula:

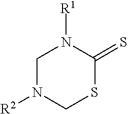

wherein R¹ and R² are the same or different and are selected from H and C₁₋₆ straight chain or branched alkyl and at least one of R¹ and R² are C₁₋₆ straight chain or branched alkyl.

Embodiment 20. The composition of embodiment 19, wherein the alkyltetrahydro-1,3,5-thiadiazine-2-thione compound is 3,5-dimethyltetrahydro-1,3,5-thiadiazine-2-thione having a formula:

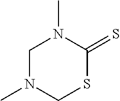

optionally together with furfural (i.e., furan-2-carboxaldehyde).

Embodiment 21. The composition of embodiment 14, wherein the aldehyde compound comprising a cyclic aromatic substituent has a formula:

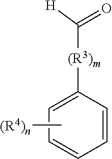

wherein R³ is C₁₋₆ alkyl or alkenyl and m is 0 or 1; and R⁴ is hydroxyl and n is 0, 1, 2, or 3.

Embodiment 22. The composition of embodiment 21, wherein the aldehyde compound comprising a cyclic aromatic substituent is benzaldehyde having a formula:

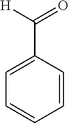

Embodiment 23. The composition of embodiment 21, wherein the aldehyde compound comprising a cyclic aromatic substituent is anisaldehyde having a formula:

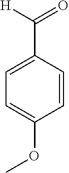

Embodiment 24. The composition of embodiment 21, wherein the aldehyde compound comprising a cyclic aromatic substituent is salicylaldehyde having a formula:

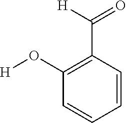

Embodiment 25. The composition of embodiment 21, wherein the aldehyde compound comprising a cyclic aromatic substituent is cinnamaldehyde having a formula:

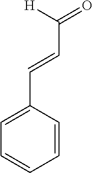

Embodiment 26. The composition of embodiment 14, wherein the isothiocyanate compound has a formula:

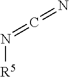

wherein R⁵ is C₁₋₆ straight chain or branched alkyl; C₁₋₆ straight chain or branched alkenyl; or aryl.

Embodiment 27. The composition of embodiment 26, wherein the isothiocyanate compound is methyl isothiocyanate having a formula:

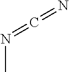

Embodiment 28. The composition of embodiment 26, wherein the isothiocyanate compound is allyl isothiocyanate having a formula:

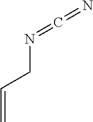

Embodiment 29. The composition of embodiment 26, wherein the isothiocyanate compound is phenyl isothiocyanate having a formula:

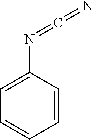

Embodiment 30. The composition of embodiment 14, wherein the capsaicinoid compound is selected from a group consisting of capsaicin, dihydrocapsaicin, nordihydrocagsaicin, homodihydrocapsaicin, homocapsaicin, nonivamide, and combinations thereof.

Embodiment 31. The composition of embodiment 14, wherein the unsaturated aldehyde compound has a formula:

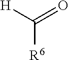

wherein R⁶ is C₃₋₁₂ straight chain or branched alkenyl.

Embodiment 32. The composition of embodiment 31, wherein the unsaturated aldehyde compound is propenal (i.e., acrolein) having a formula:

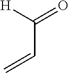

Embodiment 33. The composition of embodiment 31, wherein the unsaturated aldehyde compound is 3,7,-dimethyl-2,6-octadienal (i.e. citral or lemonal) having a formula:

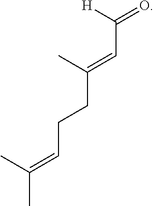

Embodiment 34. The composition of embodiment 14, wherein the phenol compound optionally substituted with alkyl has a formula:

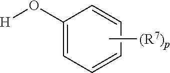

wherein R⁷ is C₁₋₆ straight chain or branched alkyl and p is 0, 1, 2, or 3.

Embodiment 35. The composition of embodiment 34, wherein the phenol compound optionally substituted with alkyl is 2-isopropyl-5-methylphenol (i.e., thymol) having a formula:

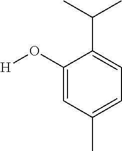

Embodiment 36. The composition of embodiment 14, wherein the halogenated propene is 1,3-dichloropropene.

Embodiment 37. The composition of embodiment 14, wherein the diazarine compound has a formula:

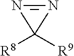

where R⁸ and R⁹ independently are H or C₁₋₆ straight chain or branched alkyl.

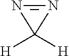

Embodiment 38. The composition of embodiment 37, wherein the diazarine compound is diazirine having a formula:

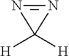

Embodiment 39. The composition of any of embodiments 1-38, wherein the nitrogen source is an organic nitrogen source.

Embodiment 40. The composition of embodiment 39, wherein the organic nitrogen source comprises urea, casein, or both.

Embodiment 41. A pesticide composition comprising: (a) biodiesel; (b) an effective amount of a pesticide for controlling a pest; the pesticide selected from a group consisting of a menthol compound, an alkyl cyanamide compound, a 3,5-alkyltetrahydro-1,3,5-thiadiazine-2-thione compound, an aldehyde compound comprising a cyclic aromatic substituent, an isothiocyanate compound, a capsaicinoid compound, an unsaturated aldehyde compound, a phenol compound optionally substituted with alkyl, a halogenated propene, and combinations thereof.

Embodiment 42. The composition of embodiment 41, wherein the composition is effective for reducing nematodes by at least about 50% when applied at an application rate of about 1 ml/kg soil.

Embodiment 43. The composition of embodiment 41 or 42, wherein the composition does not reduce microbivorous nematodes by more than about 50% when applied at an application rate of about 1 ml/kg soil.

Embodiment 44. A method for preparing a pesticide composition, the method comprising combining: (a) an effective amount of a pesticide for controlling a pest; (b) biodiesel; and optionally (c) an effective amount of an nitrogen source; wherein the composition has a molar ratio of total carbon to total nitrogen (C:N) of about (22.4-5.6):1.

Embodiment 45. A method for controlling soil-bourne pests comprising applying a liquid soil-amendment composition at an application rate of at least about 1 ml/kg soil, the soil-amendment composition comprising: (a) an effective amount of a pesticide for controlling a pest; (b) biodiesel; and optionally (c) an effective amount of an organic nitrogen source; wherein the composition has a molar ratio of total carbon to total nitrogen (C:N) of about (22.4-5.6):1.

Embodiment 46. A method for controlling weeds comprising applying a liquid soil-amendment composition at an application rate of at least about 1 ml/kg soil, the soil-amendment composition comprising: (a) an effective amount of a pesticide for controlling a pest; (b) biodiesel; and optionally (c) an effective amount of an organic nitrogen source; wherein the composition has a molar ratio of total carbon to total nitrogen (C:N) of about (22.4-5.6):1.

Embodiment 47. A method for controlling soil-bourne pests and weeds comprising applying a liquid soil-amendment composition at an application rate of at least about 1 ml/kg soil, the soil-amendment composition comprising: (a) an effective amount of a pesticide for controlling a pest; (b) biodiesel; and optionally (c) an effective amount of an organic nitrogen source; wherein the composition has a molar ratio of total carbon to total nitrogen (C:N) of about (22.4-5.6):1.

Embodiment 48. A method for controlling soil-bourne pests and/or weeds comprising: (a) applying a liquid soil-amendment composition at an application rate of at least about 1 ml/kg soil, the liquid soil-amendment composition comprising (i) an effective amount of a pesticide for controlling a pest; and (ii) biodiesel; the method optionally comprising (c) applying another separate soil amendment comprising an effective amount of a nitrogen source (preferably an organic nitrogen source) inorder to achieve a molar ratio of total carbon to total nitrogen (C:N) of about (22.4-5.6):1 in the soil to which the soil amendment compositions are applied.

### EXAMPLES

The following examples are illustrative and are not intended to limit the scope of the claimed subject matter.

### Example 1

### Assessment of Pesticide Compositions for Controlling or Eliminating Nematodes

Factorial greenhouse experiments may be established to determine the efficacy of testing the presently disclosed pesticide composition for control of the reniform nematode (Rotylenchulus reniformis), and of common damping off and seedling disease fungi (Rhizoctonia solani, and species of Pythium and Fusarium). Soils for these experiments may be naturally infested with the pathogens and obtained from fields known to be infected with nematodes or fungi. In each experiment, the moist soil (60% field capacity) optionally mixed 1:1 with sand, may be apportioned in 1 kg amounts contained in 1 L cylindrical PVC pots with 1 mm mesh non-metal screen bottoms. Pesticide compositions may be delivered by drenching in 100 mls aqueous solutions/pot (equivalent to 1 acre inch water). Immediately after treatment, the pots may be covered with polyethylene bags (2 mm) and placed on a greenhouse bench. The bags may be removed after 2 wks and soil samples may be taken for nematological analyses by the salad bowl incubation technique (Rodriguez-Kabana & Pope, Nematropica 11:175-186 (1987)). Agricultural crop seed, such as cucumber seeds, squash seeds, or “Hutchenson” soybean seed (reniform nematode susceptible) may be planted (e.g., 5 seed/pot) and allowed to grow (e.g., for several weeks), after which the plants may be removed and data collected on: number of surviving plants, phytotoxicity, and plant growth parameters (shoot height and weights of shoots and roots), and nematode populations in soil and root systems (salad bowl incubation).

In experiments with fungal pathogens, 20 annual morning glory seed (mixture of Ipomoea hederacea and I. lacunosa seed) may be uniformly distributed and slightly pressed onto the soil surface of each pot. The seeds may be covered with approx. 5 mm layer of moist fine siliceous sand. The number of emerging morning glory plants may be determined every 5-7 days for one month. Previous studies have shown that the number of emerging plants is inversely related to the level of damping off and seedling disease (unpublished data).

Experiments on herbicidal activity may be performed using a sandy loam soil from a field, characterized as not having a significant nematode or fungal disease problem. The soil, optionally combined 1:1 with sand, may be apportioned in 1 kg amounts and placed in 6 L polyethylene bags (“chicken bags”). Soil in each bag may be thoroughly mixed with a weed seed mixture. The mixture may consist of 5 yellow nutsedge rhizomes and the seed of (number per bag): annual morning glory mix, i.e. Ipomoea hederacea/I. lacunosa, (40); large crabgrass, i.e., Digitaria sanguinalis, (300); sicklepod, i.e., Senna obtusifolia, (60); jimsonweed, i.e., Datura stramonium, (80); yellow foxtail, i.e., Setaria glauca, (100); and redroot pigweed, i.e., Amaranthus retroflexus, (1000). The soil with weeds may be transferred to pots and treated as described for the experiments with nematodes and fungi. The number and species of emerging weeds may be recorded at weekly intervals for several weeks (e.g., 6 wks) after removal of the plastic bags.

Typically, there will be 14 treatments in each experiment arranged in a randomized complete block design with 7 replications (experimental unit=1 pot) per treatment for a total of 98 pots.

### Example 2

### Assessment of Pesticide Composition for Controlling or Eliminating Weeds

The efficacy of the presently disclosed pesticide compositions for controlling or eliminating weeds may be tested against weeds such as crab grass, sickle pod, and morning glory. The pesticide compositions may be applied to soil at suitable rates of application (e.g., rates such as 5 mls/kg soil, 10 mls/kg soil, 11 mls/kg soil, 12 mls/kg soil, 13 mls/kg soil, 14 mls/kg soil, 15 mls/kg soil, 16 mls/kg soil, 17 mls/kg soil, 18 mls/kg soil, 19 mls/kg soil, and 20 mls/kg soil). After a suitable period of time (e.g., after about 1, 2, 3, 4, or 5 weeks), the soil may be mixed with weed seed and emerging seeds may be periodically counted.

### Example 3

### Addition of Nitrogen to Pesticide Compositions

The ideal C:N ratios for to assure decomposition of the pesticide compositions in soil without phytotoxic effects to succeeding crop plants may be determined. Biodiesel contains no nitrogen, so the decomposition of biodiesel in soil is limited by the amount of available nitrogen (N) in soil. Use of the presently disclosed pesticide composition for treating soil may result not only in partial decomposition of biodiesel added but also in a deficiency of available N and “yellowing” of crop plants. Greenhouse experiments may be conducted in order to determine the optimal amount of N needed to optimize microbial decomposition of biodiesel in the presently disclosed pesticide compositions while still retaining pesticidal activity. Factorial experiments may be set up with treatments consisting of pesticide compositions that include an organic N source (e.g. urea, casein). The tested nitrogen sources may include urea and casein, which are both relatively inexpensive, commercially available, and exhibit considerable solubility in glycerin (Merck Index, 1989). The experiments may be set up as described above in order to determine pesticidal activities (including nematocidal, fungicidal, and herbicidal activities) of the pesticide composition that further include urea or casein.

The effect of the presently disclosed pesticide composition, either in the presence or absence of organic nitrogen, may be tested on the growth of agricultural crop plants and parasitic nematodes. Liquid pesticide compositions may be applied at rates of 0, 1, 2, 3, 4, and 5 mls/kg soil either with or without urea (150 mgs/Kg soil of the compound to achieve about 70 mgs N/Kg soil). Applications may be performed by drenching the soil in aqueous solution so that the final application volume per pot was 100 mls (which is equivalent to an acre inch of irrigation). Each pot may contain 1 Kg of soil infested with the reniform nematode Rotylenchulus reniformis and there may be 7 replications (pots)/treatment. Thus, for example, for a 1 ml pesticide application there may be 14 pots, 7 of which receive each water up to 100 mls containing 1 ml pesticide composition; the other 7 pots which receive each 1 ml pesticide composition +150 mgs urea mixed in a final volume of 100 mls. The carbon:nitrogen ratios (C:N) of the combined treatments may range from about 5.6 for the 1 ml pesticide treatment to 28 for the 5 mls pesticide treatment. Preferably, the C:N ratio is within the range of about 11.2≦C:N≦16.8.

Ideally, the pH of the pesticide compositions comprising urea should be adjusted between about 4.0 and about 5.5. Buffers composed of K salts of H₃PO₄ and propionic acid (or other organic acids) may be particularly suitable because they form strong buffers for the required pH range and contain the nutrients P and K. Other N compounds that can be utilized in lieu of urea include, but are not limited to guanidines, dicyandiamide, and oxamide. Standard nitrates (K or NH₄′) or even ammonium sulfate and the like can be utilized for preparing fertilizer mixtures having pesticidal properties. Alternatively, the nitrate or ammonium salts may be added to the pesticide compositions as aqueous solutions.

### Example 4

### Formulation Development

Formulations suitable for field use may be prepared and their performance may be assessed for nematode control and yield response in microplot experiments with common agricultural crops. (e.g. tomatoes) Liquid pesticide formulations suitable for application through irrigation water may be developed as described herein. The formulations may be tested in microplot experiments. A microplot consists of a 1 ft² area delimited by a 2 ft-long square terra cotta chimney flue embedded in soil with 4 inches set above ground. The microplots may be filled with silt-loam soil known to be infested with a variety of plant pathogenic nematodes (including Meloidogyne incognita, Hoplolaimus galeatus, Paratrichodorus minor, and others), and fungi (including, R. solani and species of Pythium and Fusarium). Microplots are fitted with a drip irrigation system in which each plot has a dripper delivering 2 gallons of water per hour.

Microplots may be treated by drenching in 1 inch-acre of water with the appropriate pesticide formulations. Immediately after application of the treatments, the plots may be covered with clear polyethylene (2 mm) mulch. After 3 wks, the mulch may be removed and soil samples for nematological analyses may be collected. Each plot may then be planted with seedlings (2/plot). Typically, a minimum of 3 experiments may be performed, using a variety of agricultural crops (e.g., one with cherry tomatoes and the other two with eggplant and green pepper.) The plants may be irrigated and maintained in good growing conditions following standard recommendations for production of the crops. Each microplot experiment typically may have 8 treatments with 8 replications arranged in a randomized complete block design. As such, there may be 64 plots per experiment and crop.

Data may be collected on plant survival, phytotoxicity, growth parameters and yield. Soil and root samples may be collected at termination of the experiments to determine nematode populations and to estimate damage from fungal pathogens. Yield data may be used in preliminary economic analyses.

Nematode Test 43

A 1% methyl isothiocyanate (MIT) composition was prepared by combining 10 g of MIT, 10 ml of acetone, and 2 mls of Illovo Mix (emulsifier) and bringing the final volume to 1 L with demineralized water. A 5% biodiesel composition was prepared by adding 50 g of biodiesel, 3 mls of Illovo Mix and bringing the final volume to 1 L with demineralized water.

Soil that was naturally infected with nematodes was combined with sand (1:1) to prepare a soil mixture for testing. One kilogram of the soil mixture was added to seven (7) pots for each test. Testing was performed by drenching soil with 100 mls of test compositions as indicated in Table 1.

TABLE 1

| | MIT | | Biodiesel | |
|---|---|---|---|---|
| | (mls 1% emul/ | MIT | (mls 5% sol/kg | Biodiesel |
| Test | kg soil) | (mg/kg soil) | soil) | (mg/kg soil) |
| Control | | | | |
| MIT | 1 | 10 | 0 | 0 |
| “” | 2 | 20 | 0 | 0 |
| “” | 3 | 30 | 0 | 0 |
| “” | 6 | 60 | 0 | 0 |
| “” | 12 | 120 | 0 | 0 |
| MIT + | 1 | 10 | 10 | 500 |
| Biodiesel | | | | |
| “” | 2 | 20 | 10 | 500 |
| “” | 3 | 30 | 10 | 500 |
| “” | 6 | 60 | 10 | 500 |
| “” | 12 | 120 | 10 | 500 |
| Biodiesel | 0 | 0 | 10 | 500 |
| Biodiesel | 0 | 0 | 20 | 1000 |
| Control | | | | |

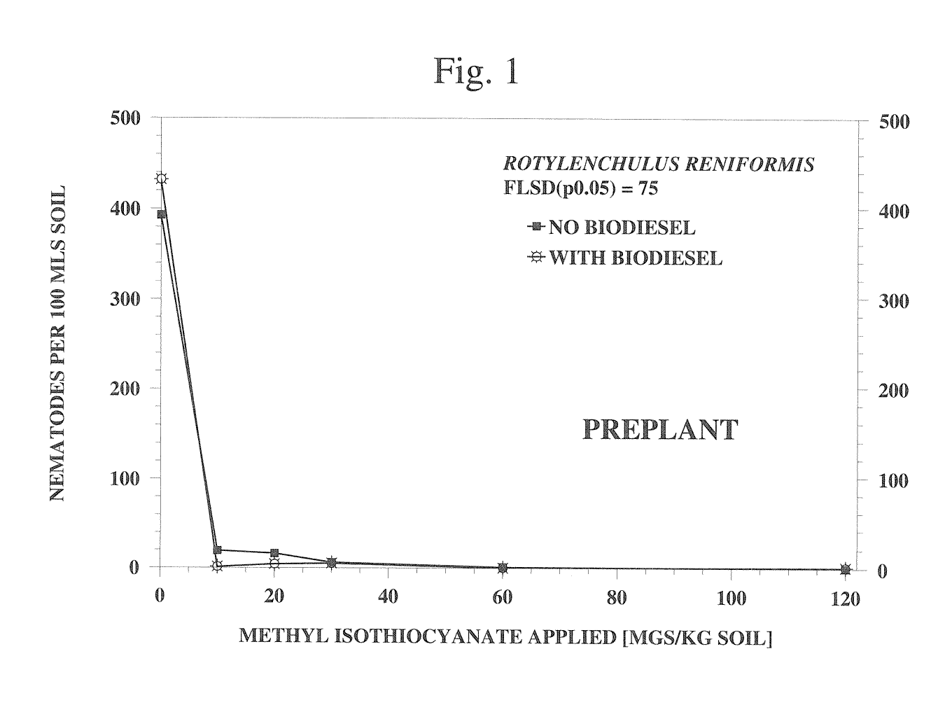

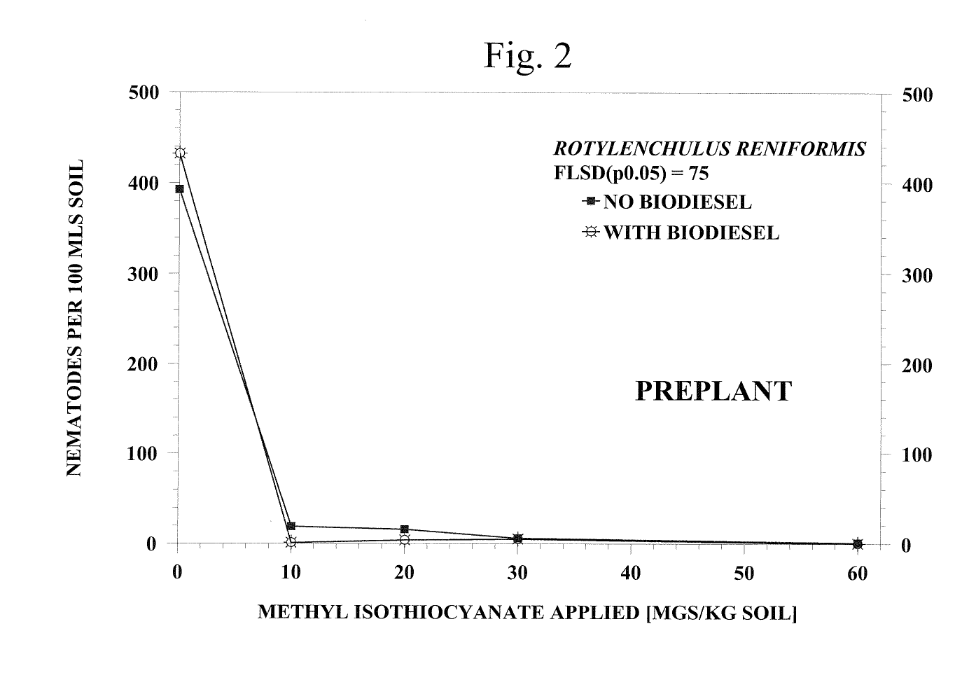

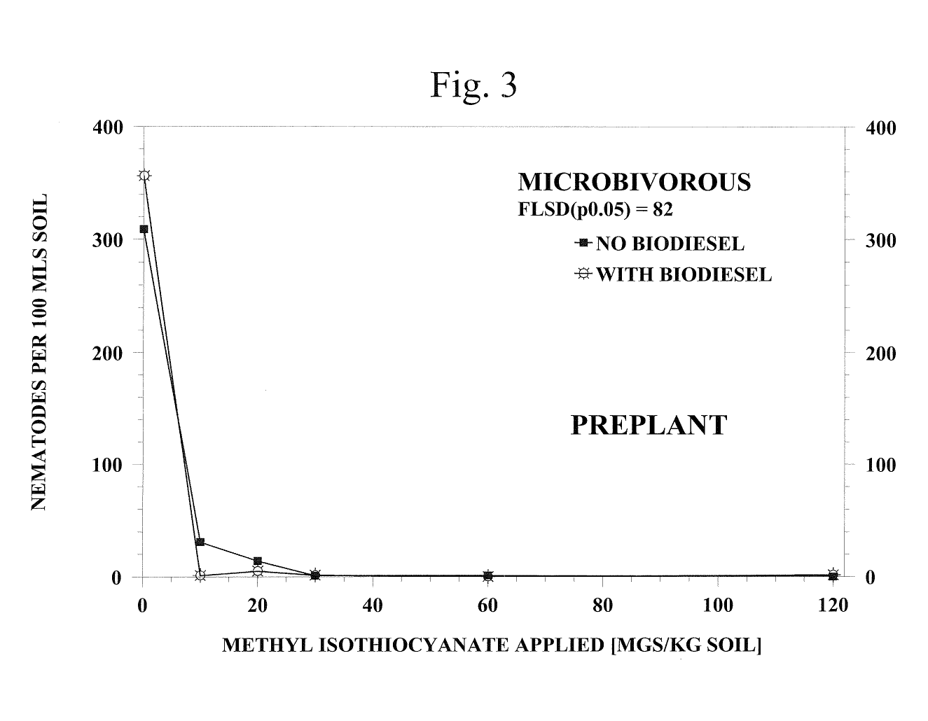

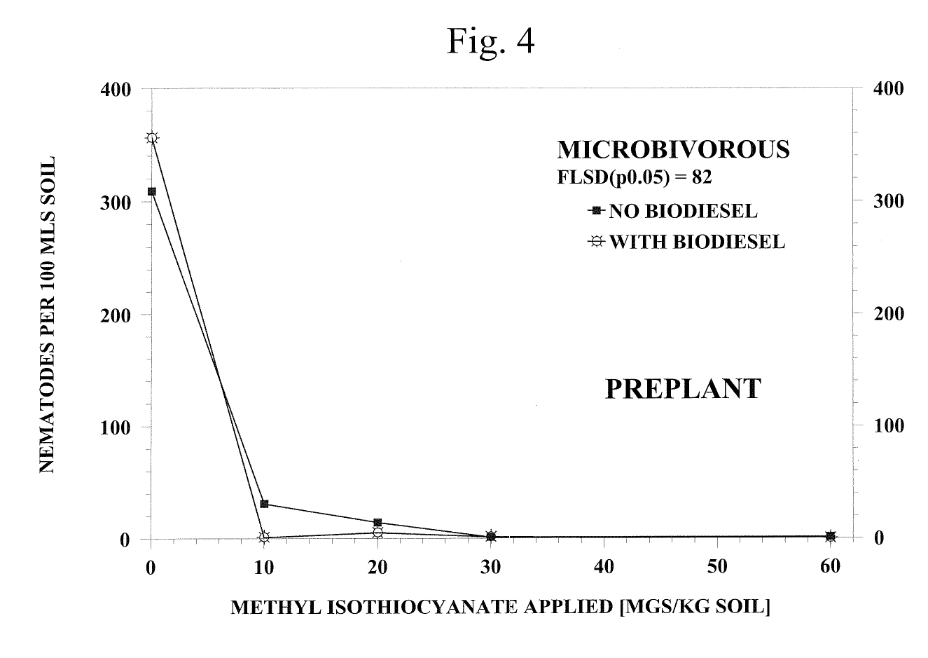

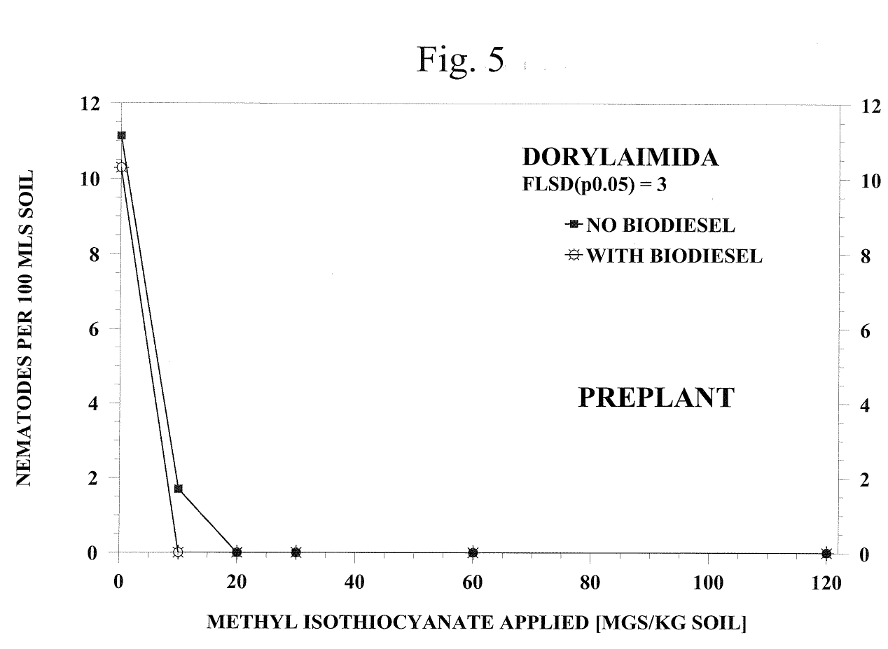

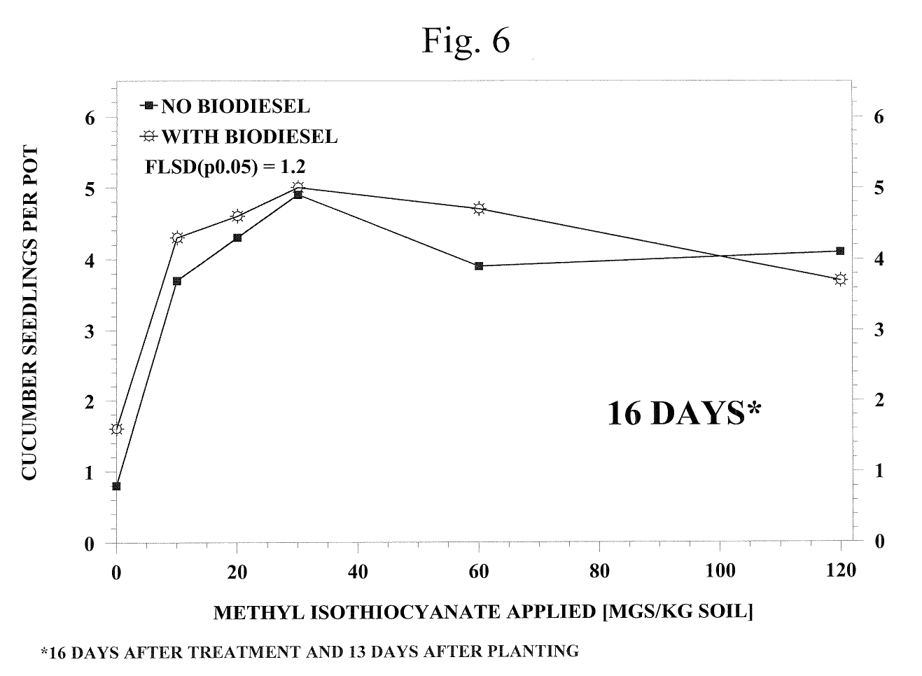

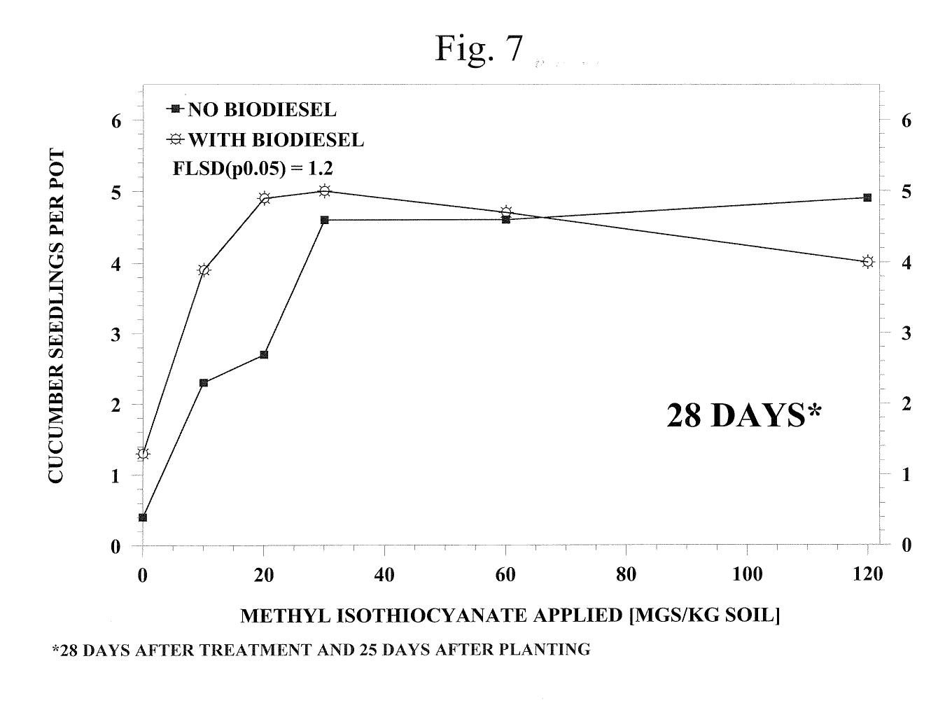

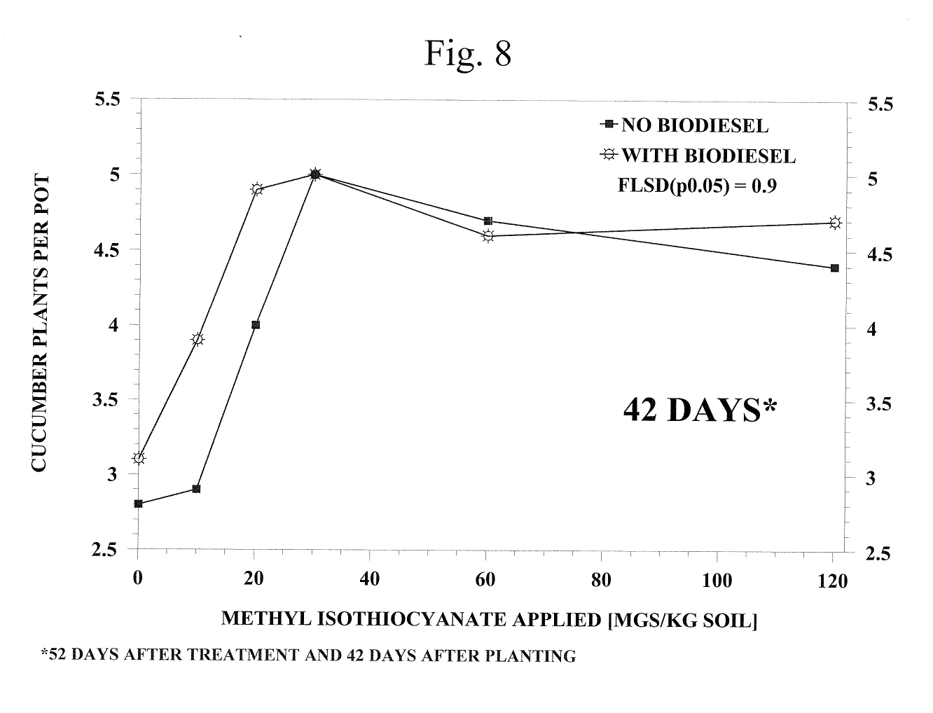

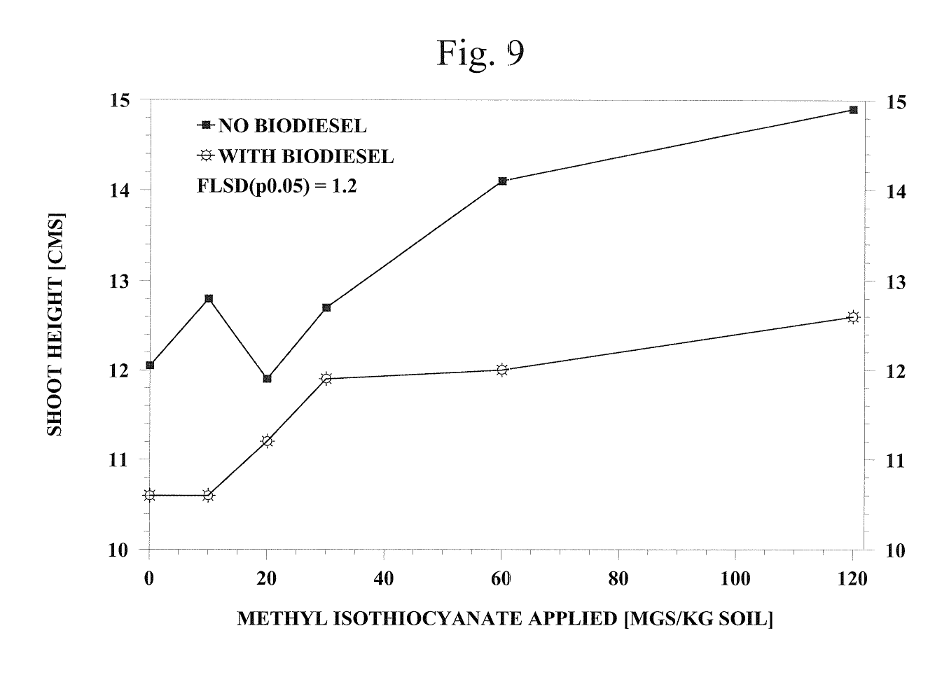

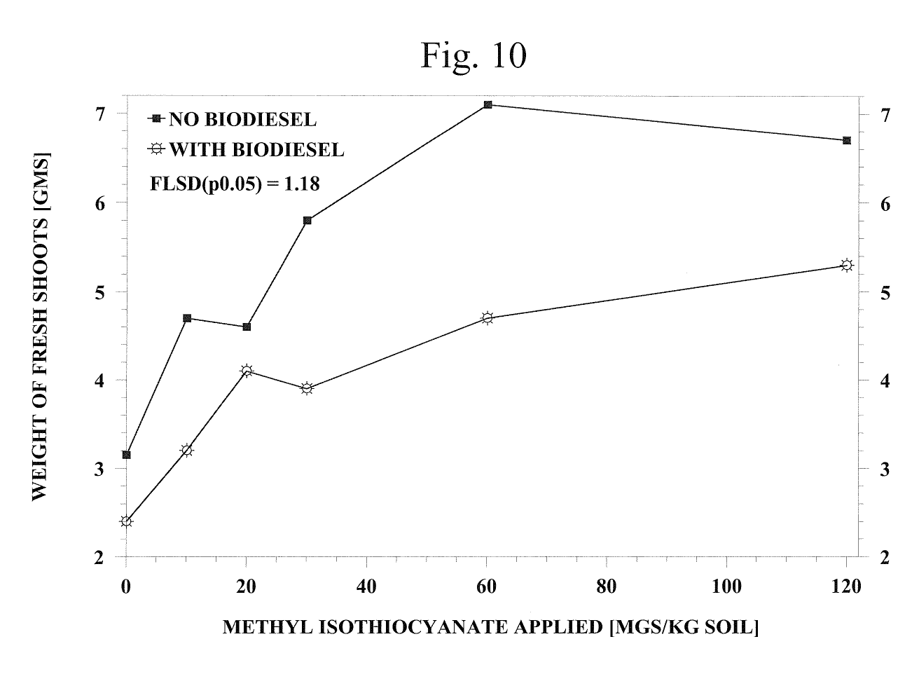

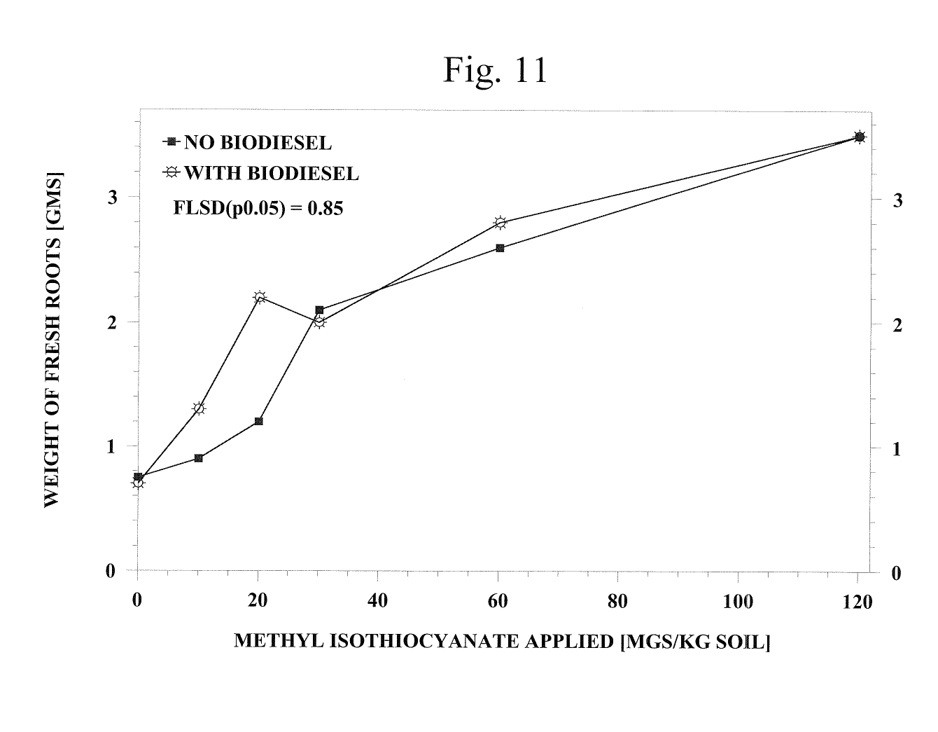

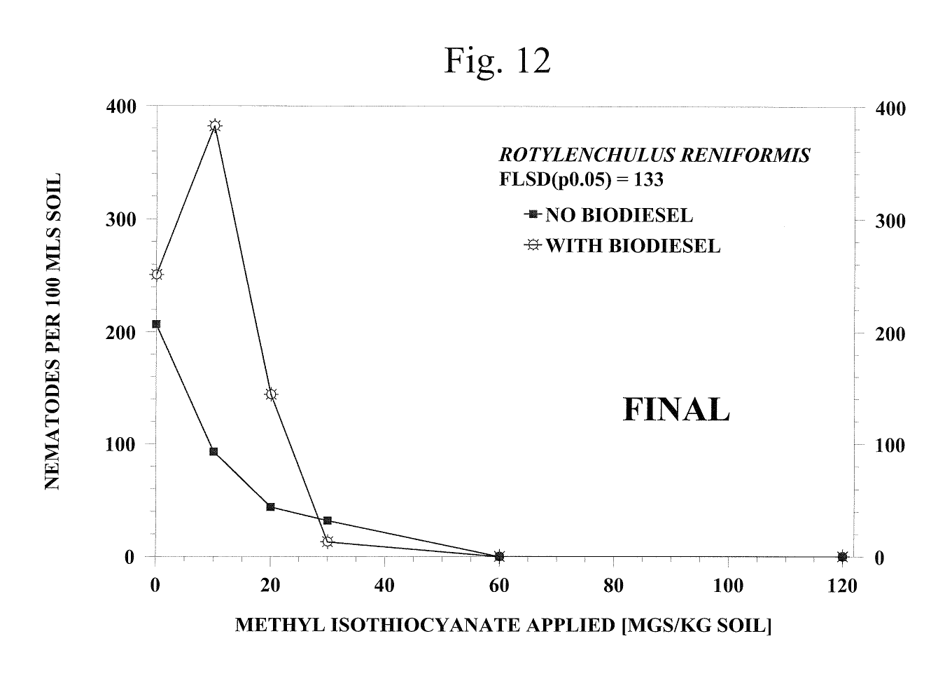

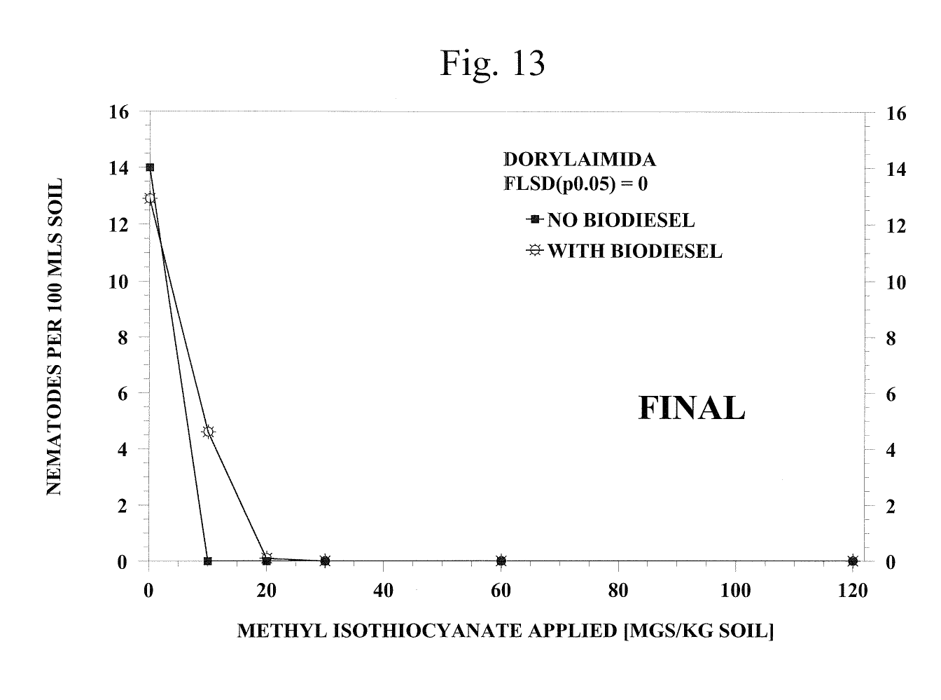

After treatment, a pre-plant sample of soil was taken 3-days pre-planting and nematodes per 100 mls of soil was determined (FIGS. 1-5). Cucumber seeds then were planted in the pots. The number of cucumber seedlings per pot was determined at sixteen (16) days (FIG. 6), twenty-eight (28) days (FIG. 7), and forty-two (42) days (FIG. 8). At fifty-two (52) days, the test was terminated and shoot height (FIG. 9), shoot weight (FIG. 10), and fresh root weight (FIG. 11) were determined. Also at fifty-two days, the number of nematodes per 100 mls of soil was determined (FIGS. 12 and 13).

Nematode Test 44

A 1% methyl isothiocyanate (MIT) composition was prepared by combining 10 g of MIT, 10 ml of acetone, and 2 mls of Illovo Mix (emmulsifer) and bringing the final volume to 1 L with demineralized water. A 5% biodiesel composition was prepared by adding 50 g of biodiesel, 3 mls of Illovo Mix and bringing the final volume to 1 L with demineralized water.

Soil that was naturally infected with nematodes was combined with sand (1:1) to prepare a soil mixture for testing. One kilogram of the soil mixture was added to seven (7) pots for each test mixture. Testing was performed by drenching soil with 100 mls of test compositions as indicated in Table 2.

TABLE 2

| | MIT | | Biodiesel | |
|---|---|---|---|---|
| | (mls 1% emul/ | MIT | (mls 5% sol/kg | Biodiesel |
| Test | kg soil) | (mg/kg soil) | soil) | (mg/kg soil) |
| Control | | | | |
| MIT | 1 | 10 | 0 | 0 |
| “” | 2 | 20 | 0 | 0 |
| “” | 3 | 30 | 0 | 0 |
| “” | 6 | 60 | 0 | 0 |
| MIT + | 1 | 10 | 10 | 500 |
| Biodiesel | | | | |
| “” | 2 | 20 | 10 | 500 |
| “” | 3 | 30 | 10 | 500 |
| “” | 6 | 60 | 10 | 500 |
| “” | 12 | 120 | 10 | 500 |
| Biodiesel | 0 | 0 | 10 | 500 |
| Biodiesel | 0 | 0 | 20 | 1000 |
| Control | | | | |
| Sand | | | | |

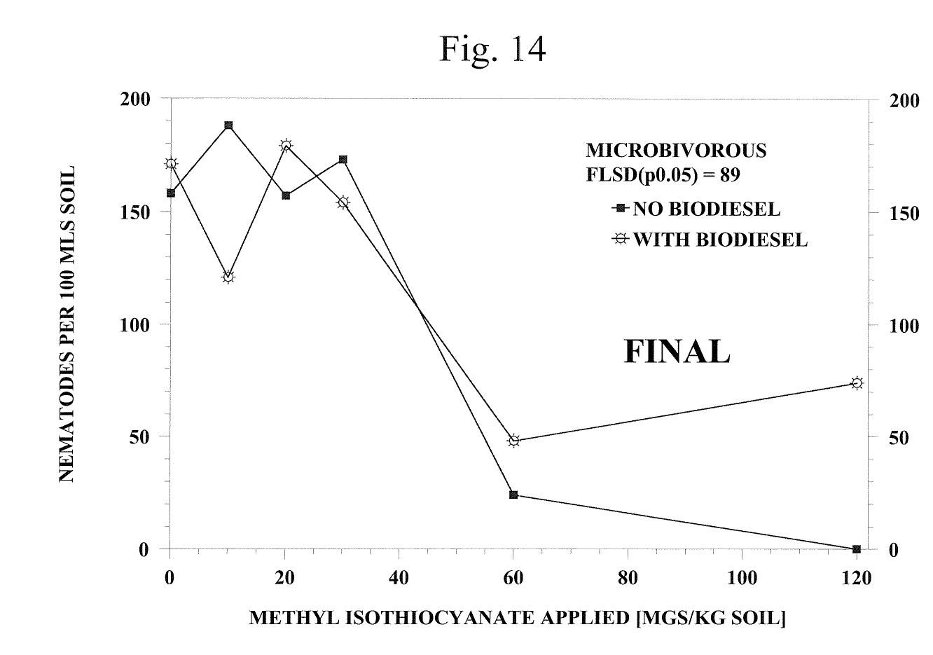

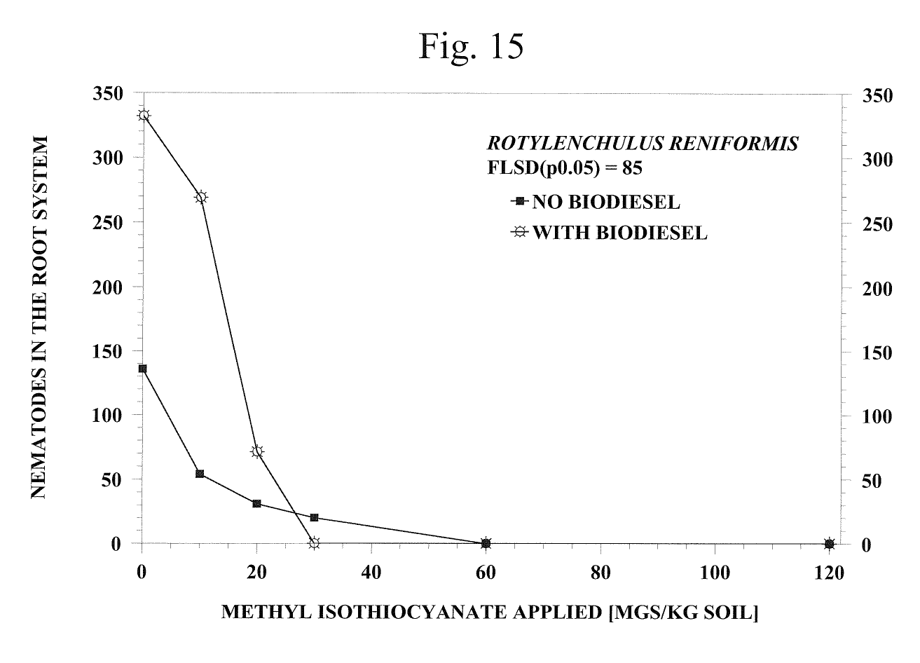

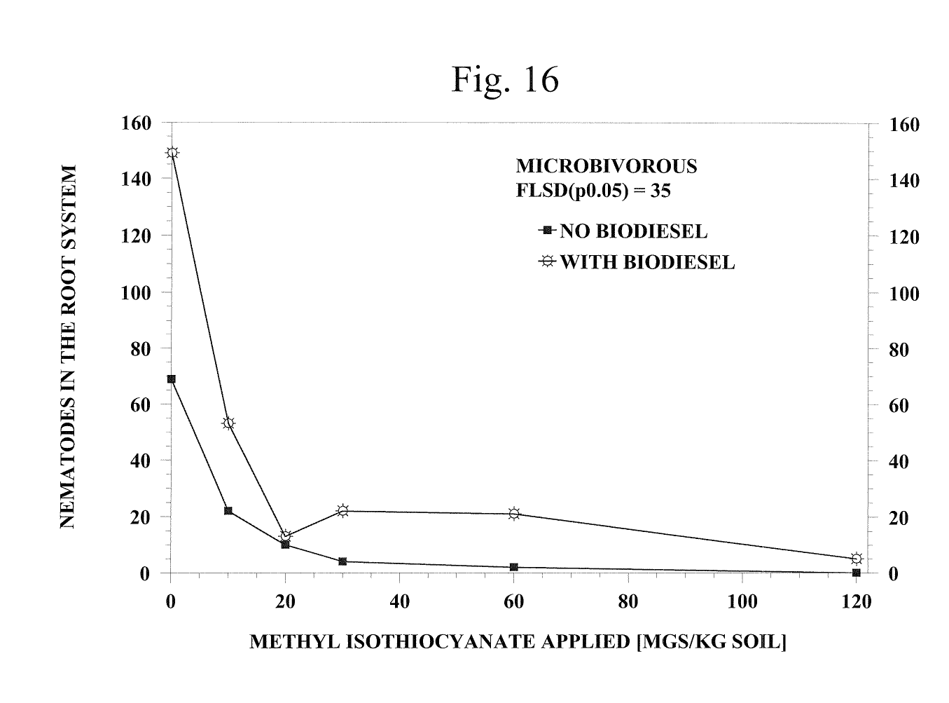

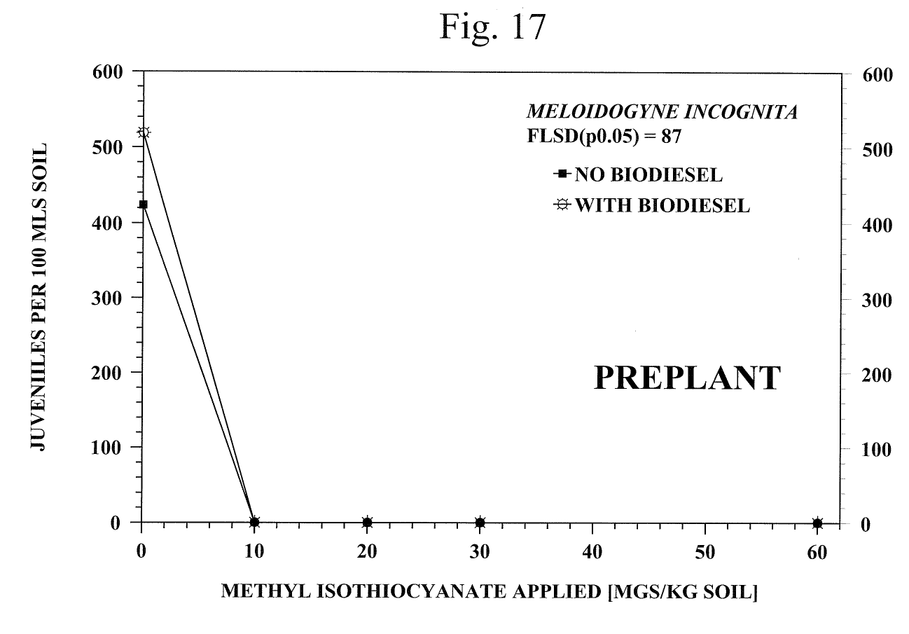

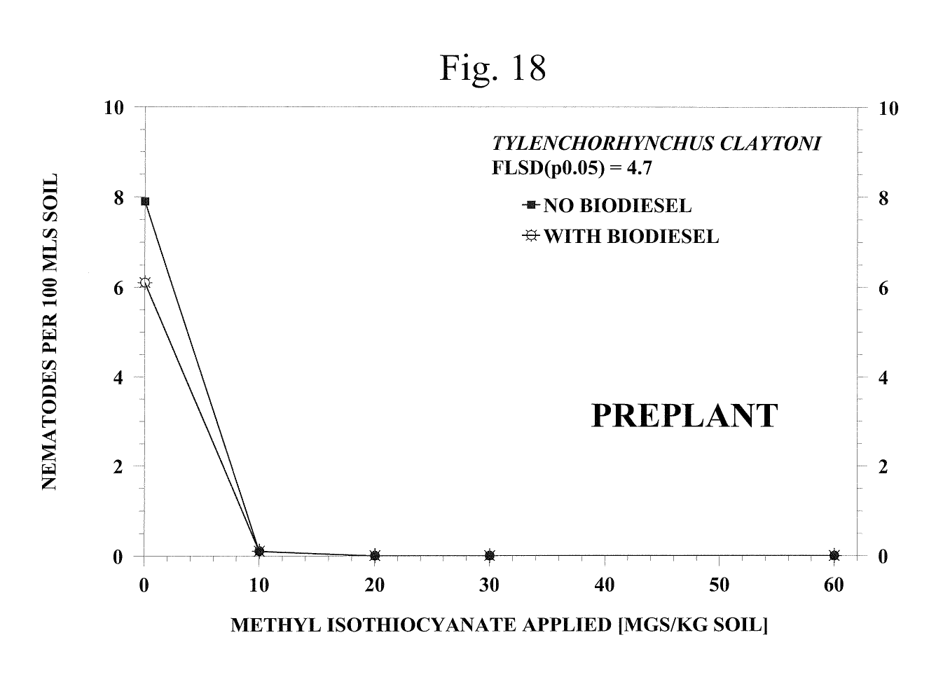

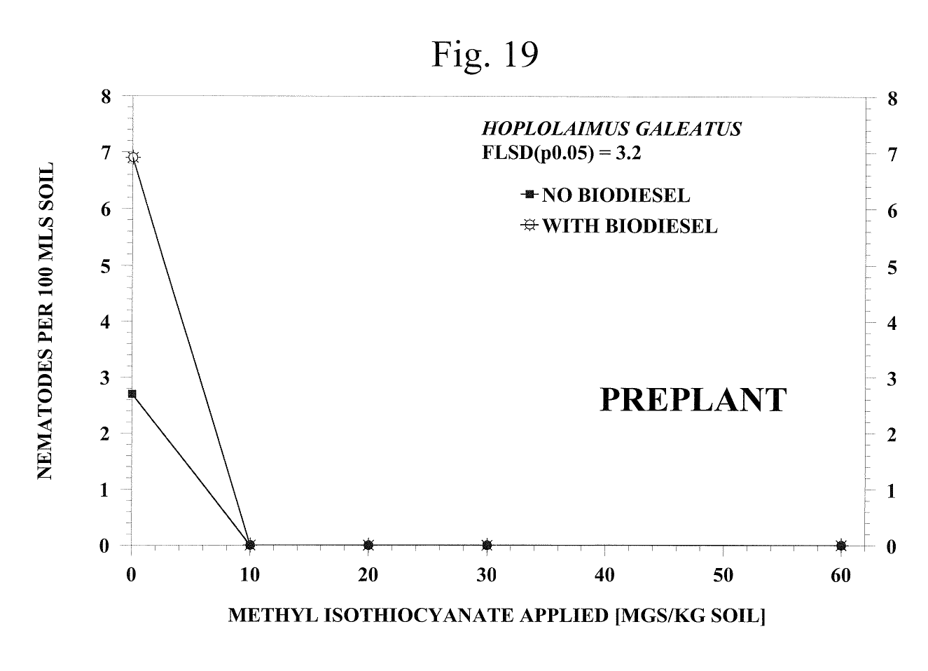

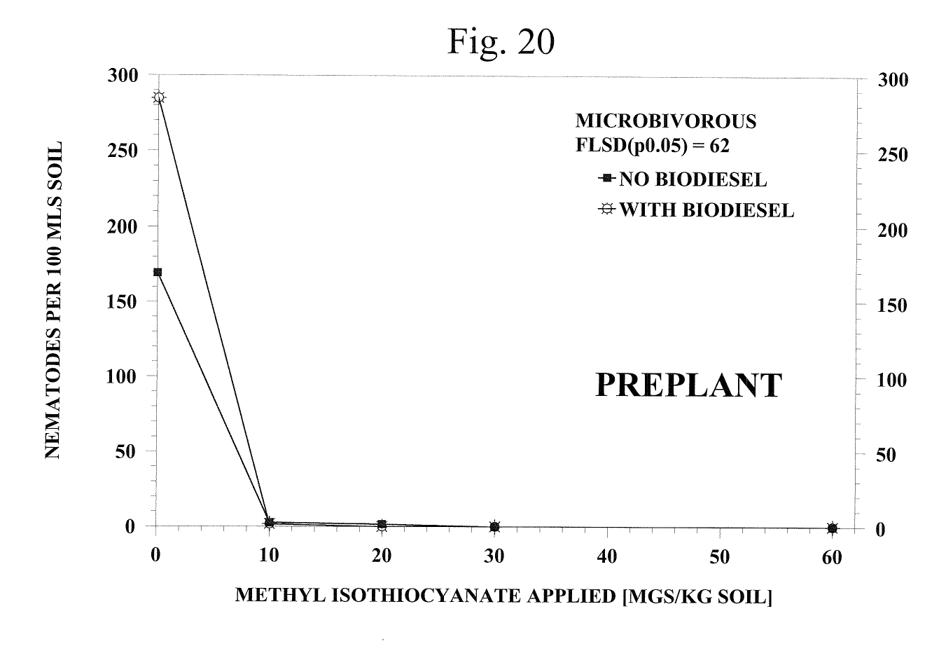

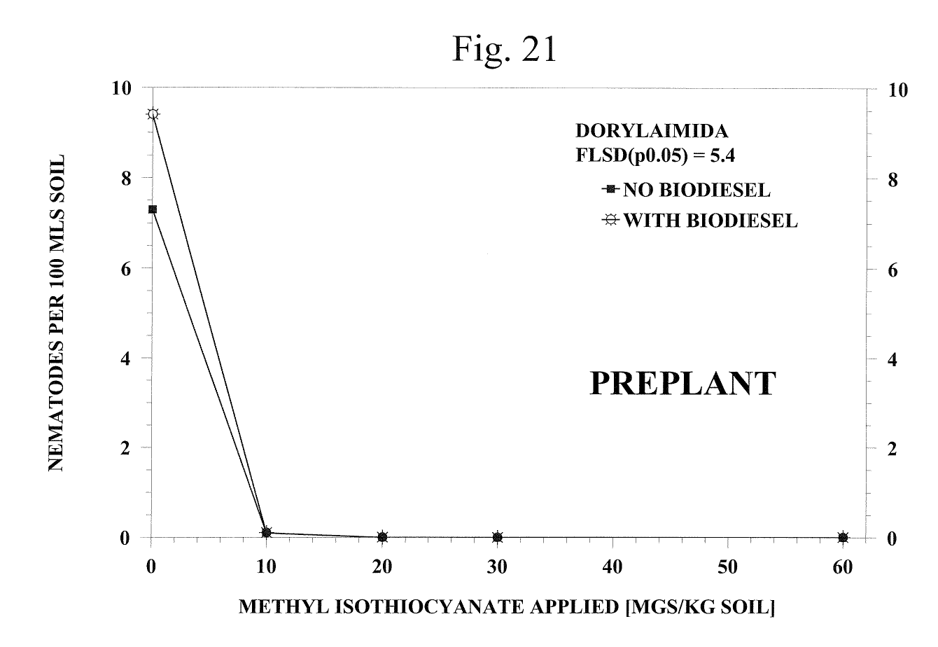

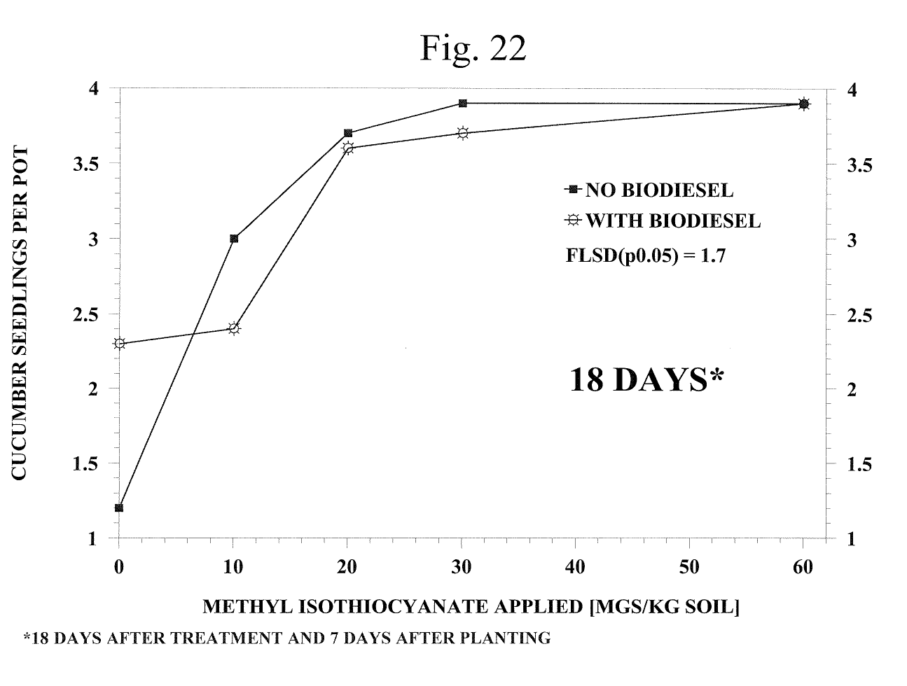

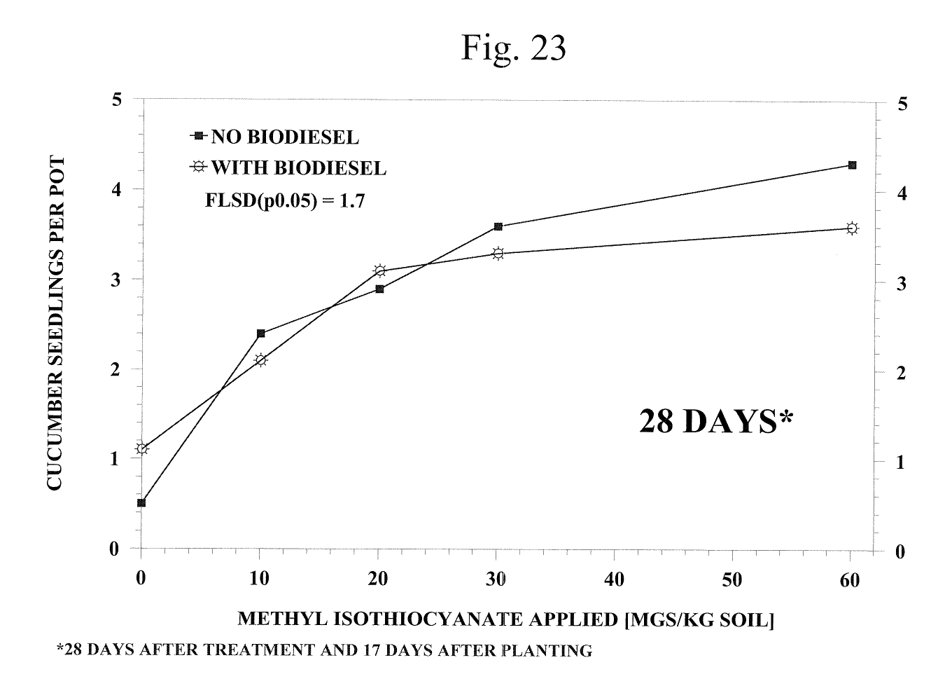

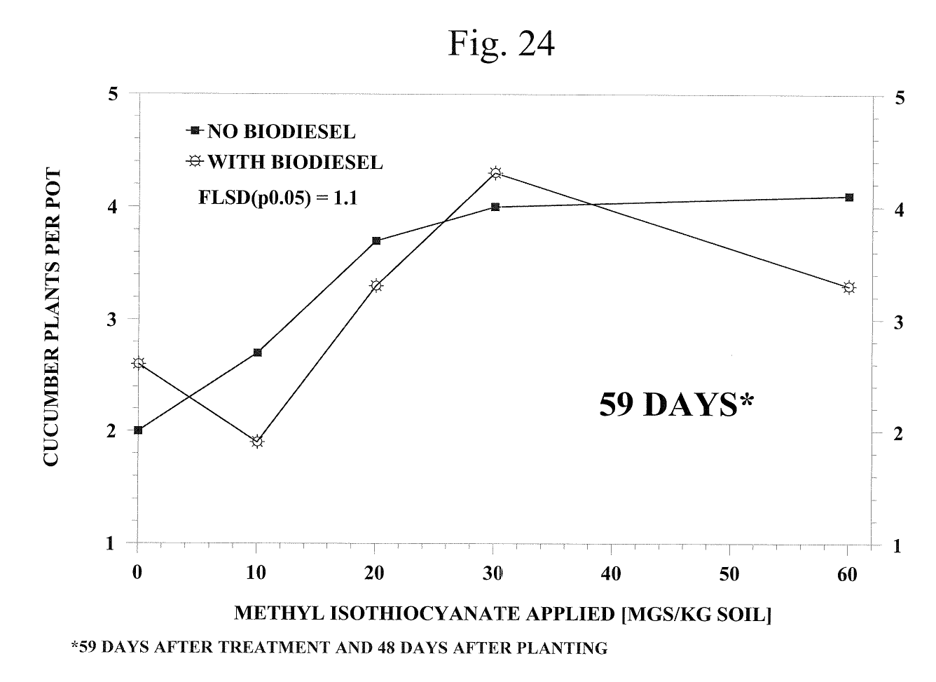

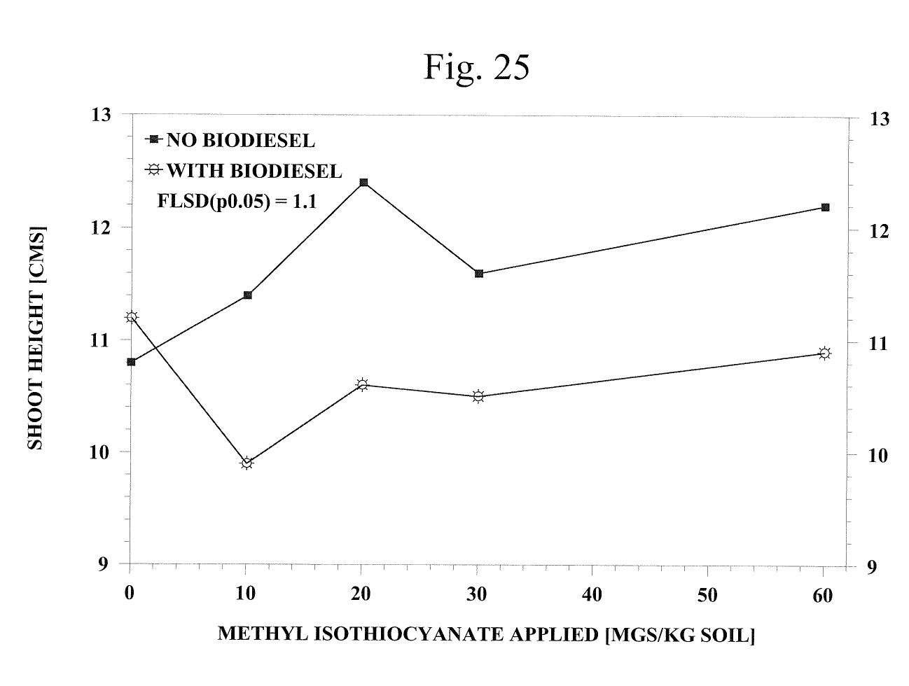

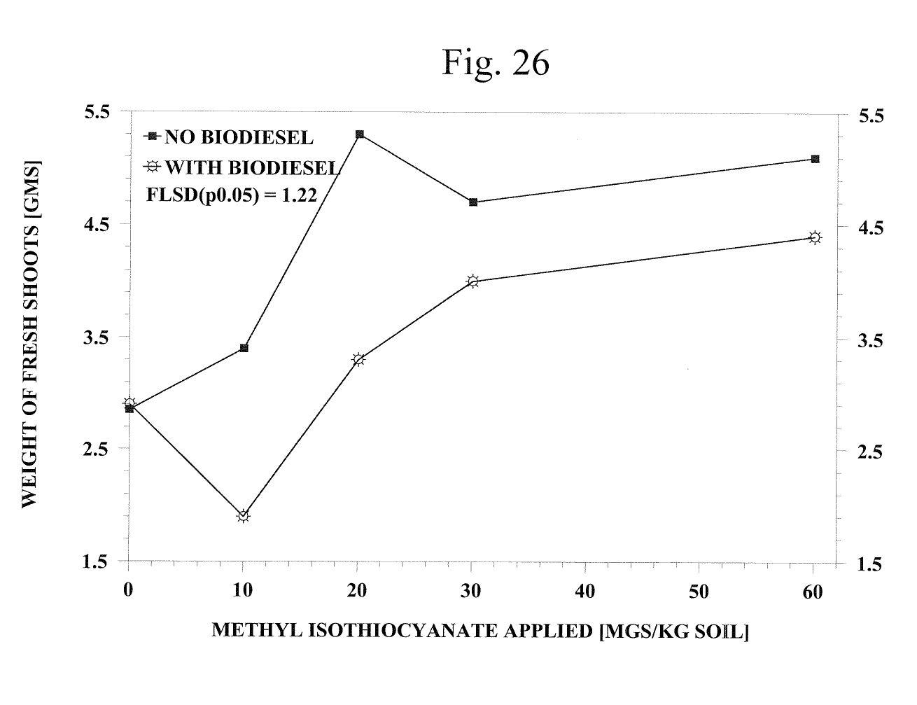

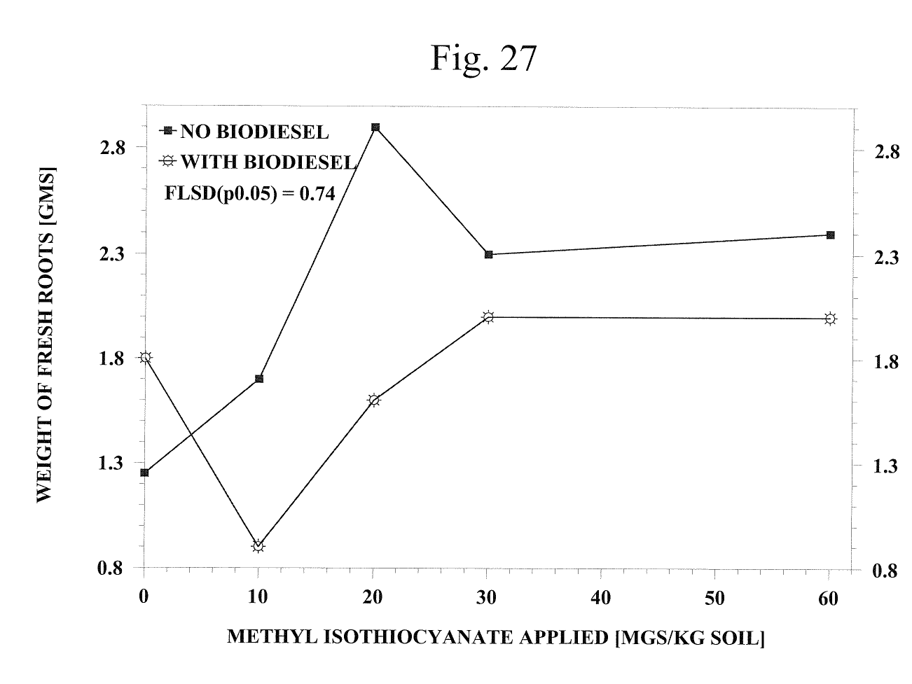

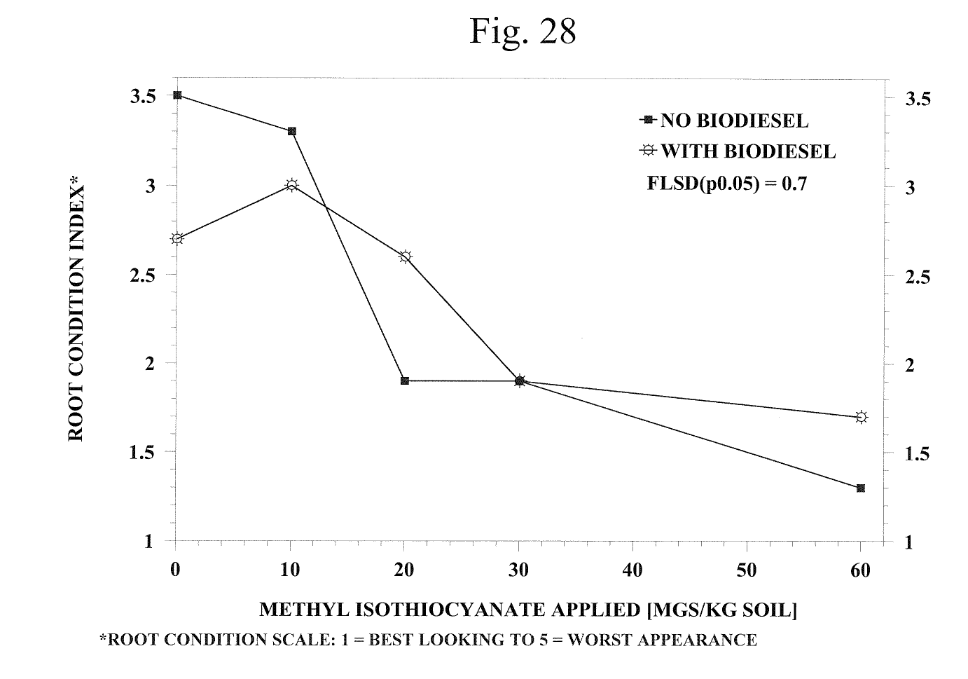

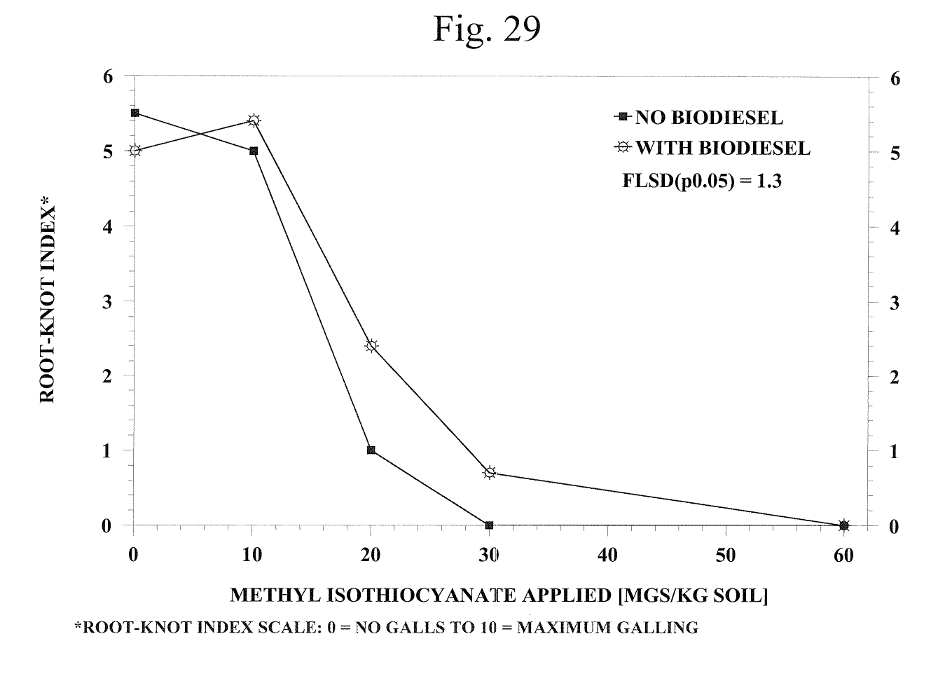

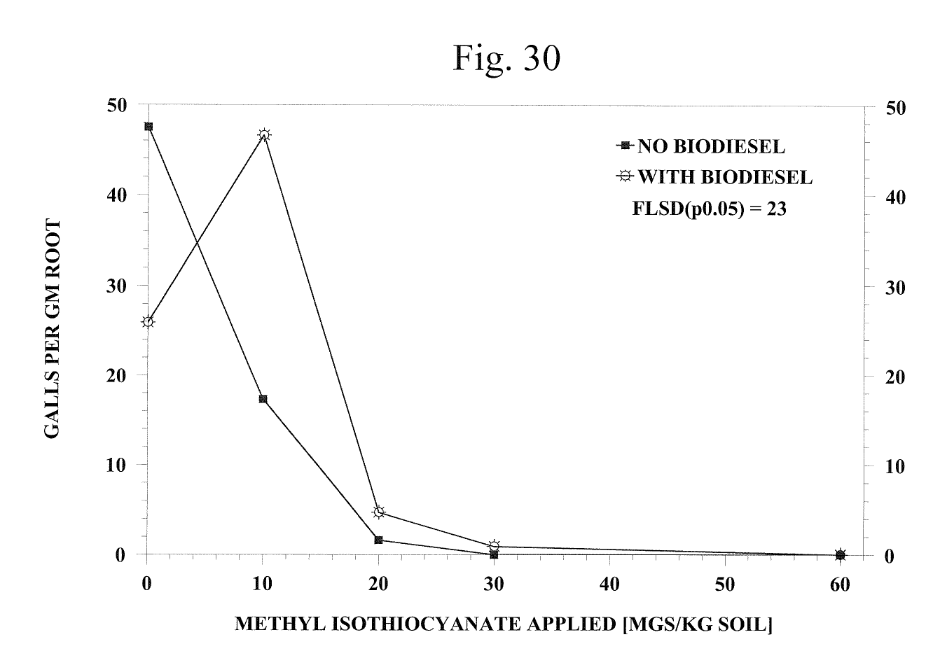

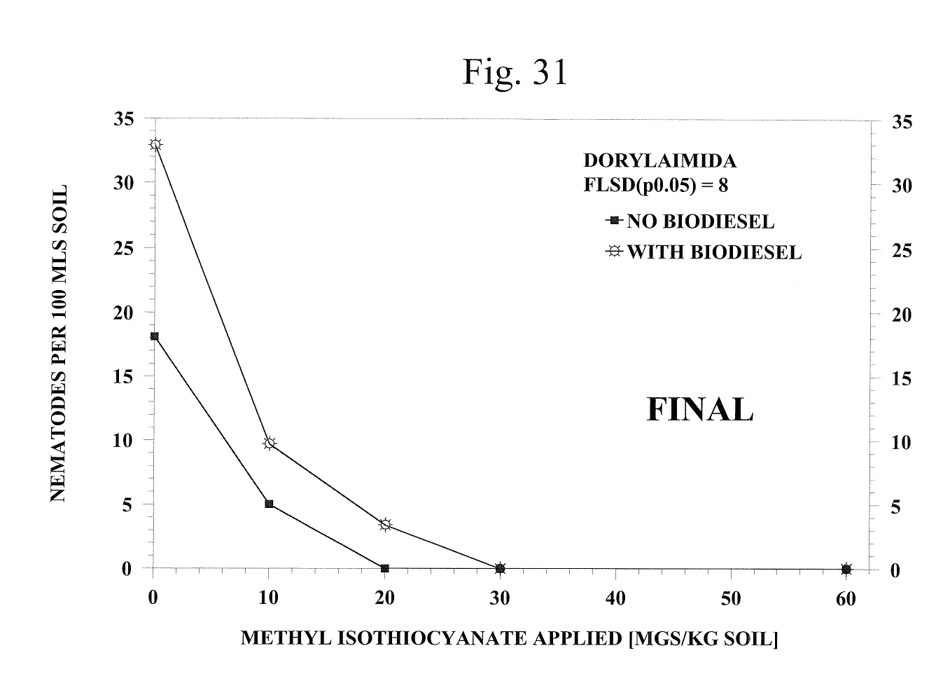

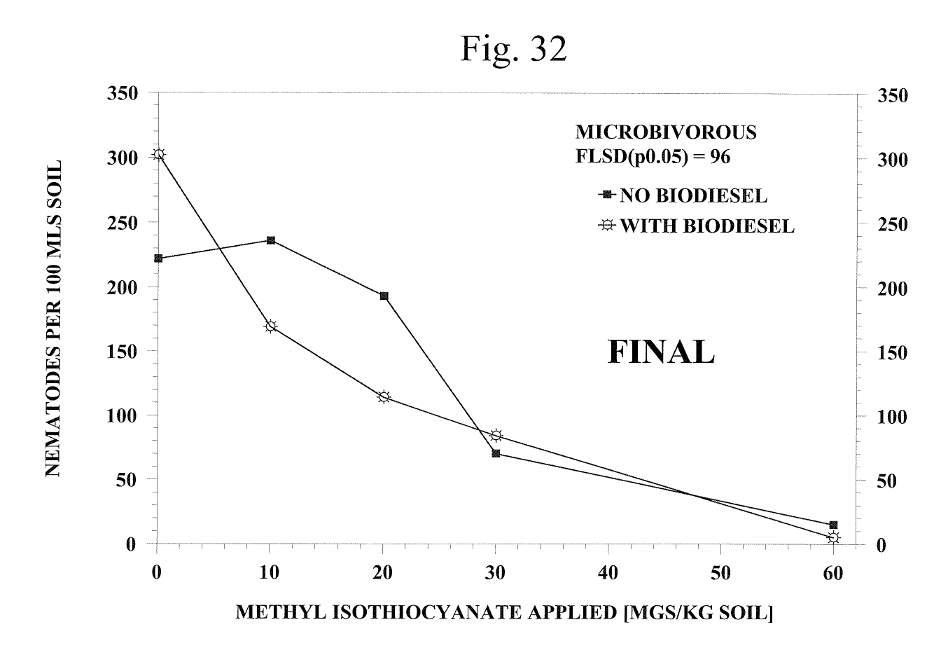

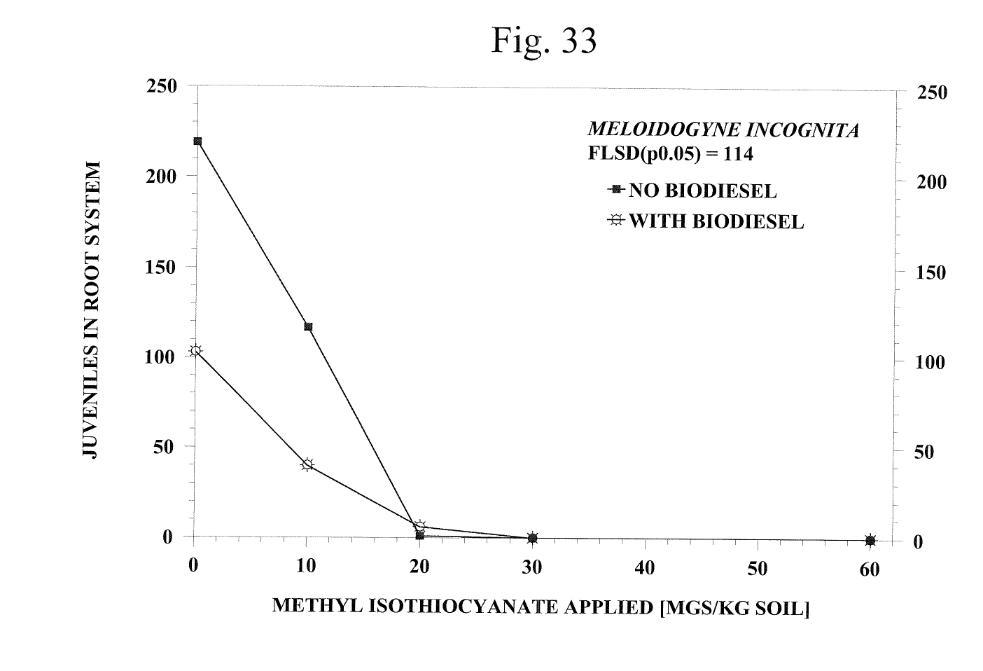

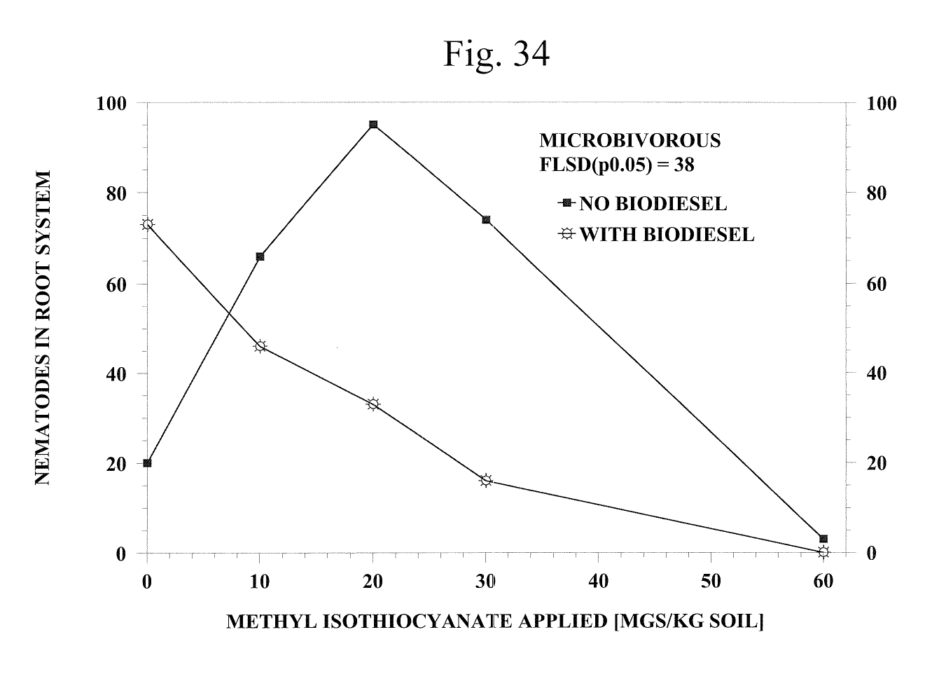

After treatment, a pre-plant sample of soil was taken 7-days pre-planting and nematodes per 100 mls of soil was determined (FIGS. 14-21). Cucumber seeds then were planted in the pots. The number of cucumber seedlings per pot was determined at eighteen (18) days (FIG. 22), twenty-eight days (28) (FIG. 23), and fifty-nine (59) days (FIG. 24). At sixty (60) days, the test was terminated and shoot height (FIG. 25), shoot weight (FIG. 26), root weight (FIG. 27), root condition (FIG. 28), root-knot (FIG. 29), and galls per gm root (FIG. 30) were determined. Also at sixty (60) days, the number of nematodes per 100 mls of soil and in the root system was determined (FIGS. 31-34).

Nematode Test 45

An 0.5% dazomet composition was prepared by combining 30 ml of furfural (Illovo Sugar, Ltd.), 3 mls of Illovo Mix (emulsifier), and 5 g dazomet. The composition was heated in a microwave for 10 seconds and the final volume was brought to 1 L with demineralized water. A 5% biodiesel composition was prepared by adding 30 ml of furfural, 3 mls of Illovo Mix (emulsifier), and 50 g of biodiesel, and bringing the final volume to 1 L with demineralized water.

Soil that was naturally infected with nematodes was combined with sand (1:1) to prepare a soil mixture for testing. One kilogram of the soil mixture was added to seven (7) pots for each test mixture. Testing was performed by drenching soil with 100 mls of test compositions as indicated in Table 3.

TABLE 3

| | Dazomet | | Biodiesel | |
|---|---|---|---|---|
| | (mls 0.5% | Dazomet | (mls 5% sol/kg | Biodiesel |
| Test | emul/kg soil) | (mg/kg soil) | soil) | (mg/kg soil) |
| Control | | | | |
| Dazomet + | 1 | 5 | 0 | 0 |
| Furfural | | | | |
| “” | 2 | 10 | 0 | 0 |
| “” | 3 | 15 | 0 | 0 |
| “” | 6 | 30 | 0 | 0 |
| “” | 12 | 60 | 0 | 0 |
| Dazomet + | 1 | 5 | 10 | 500 |
| Furfural + | | | | |
| Biodiesel | | | | |
| “” | 2 | 10 | 10 | 500 |
| “” | 3 | 15 | 10 | 500 |
| “” | 6 | 30 | 10 | 500 |
| “” | 12 | 60 | 10 | 500 |
| Biodiesel | 0 | 0 | 10 | 500 |
| Biodiesel | 0 | 0 | 20 | 1000 |
| Control | | | | |

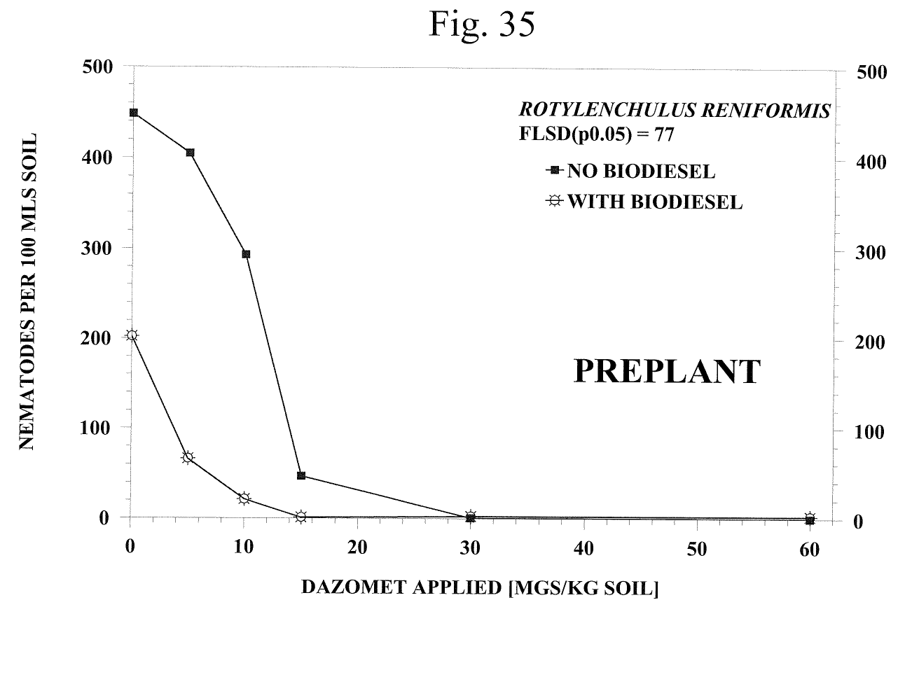

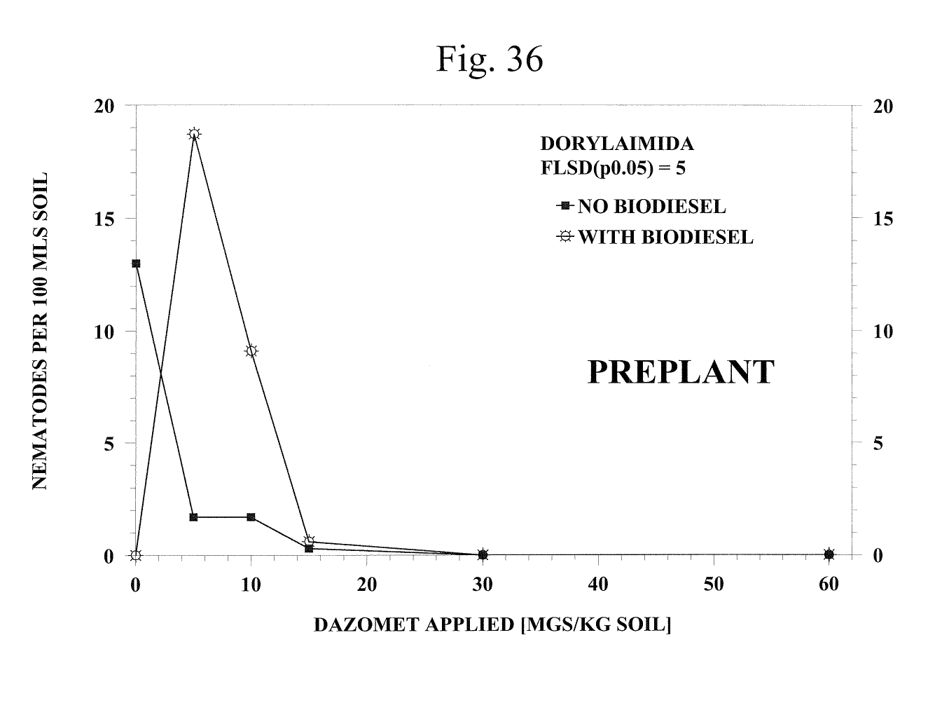

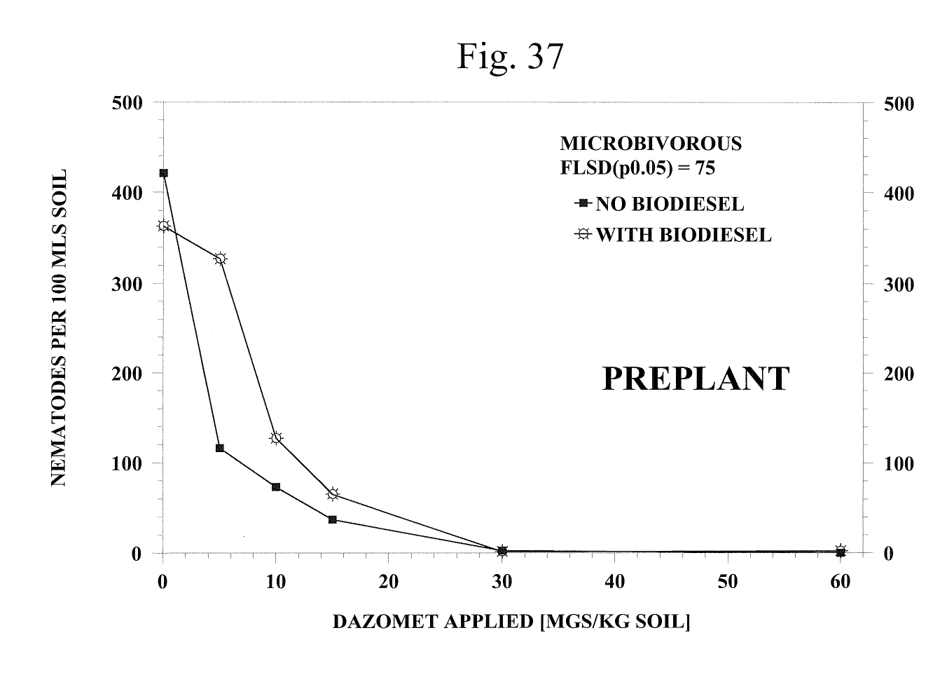

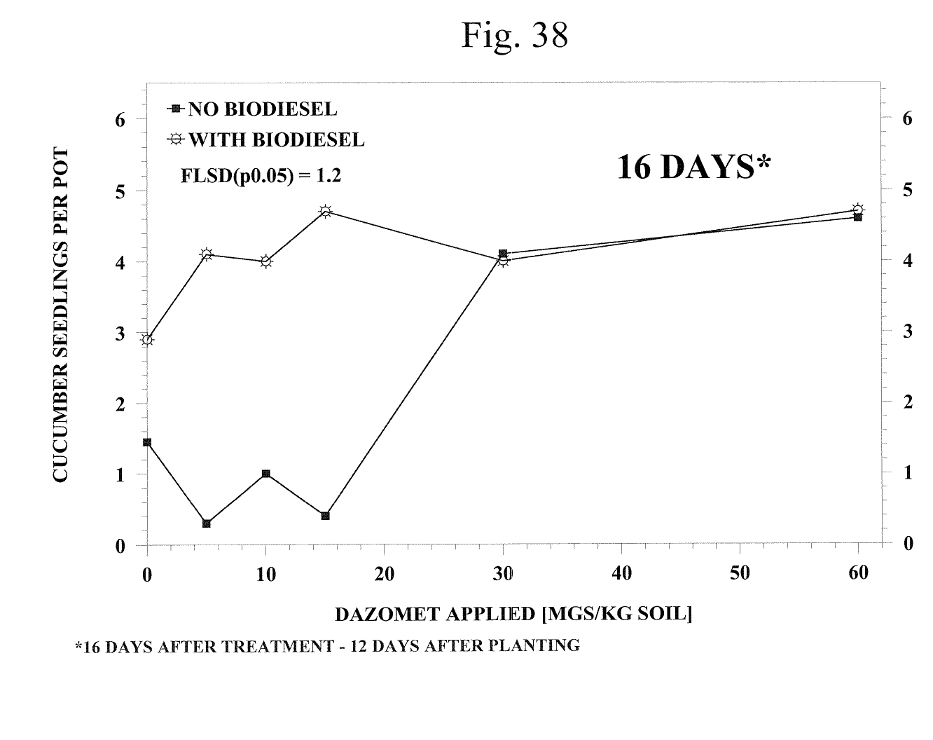

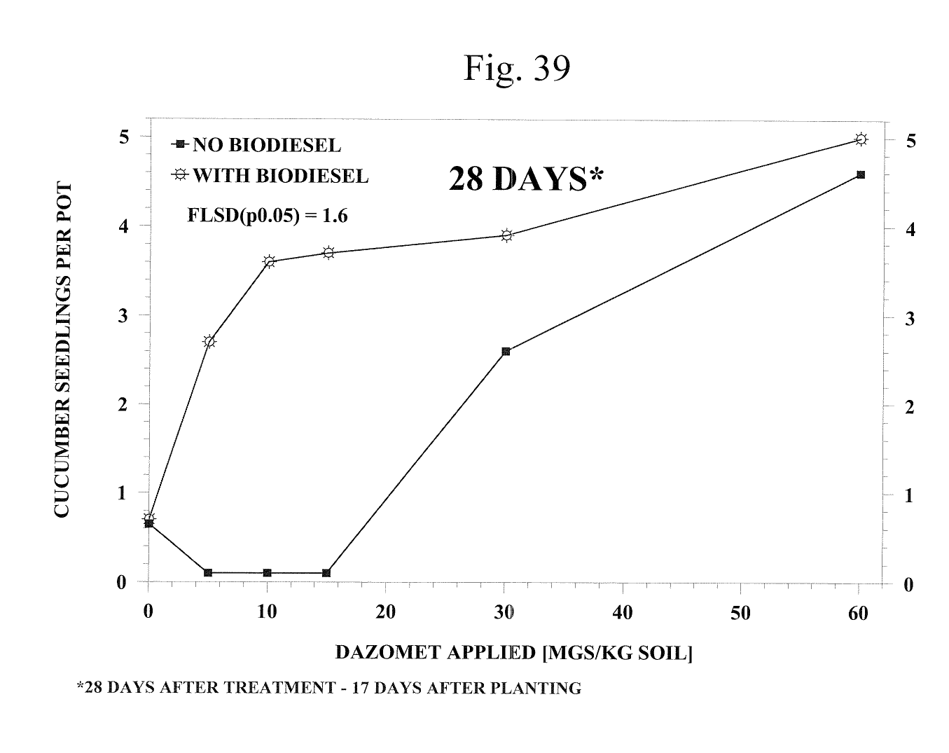

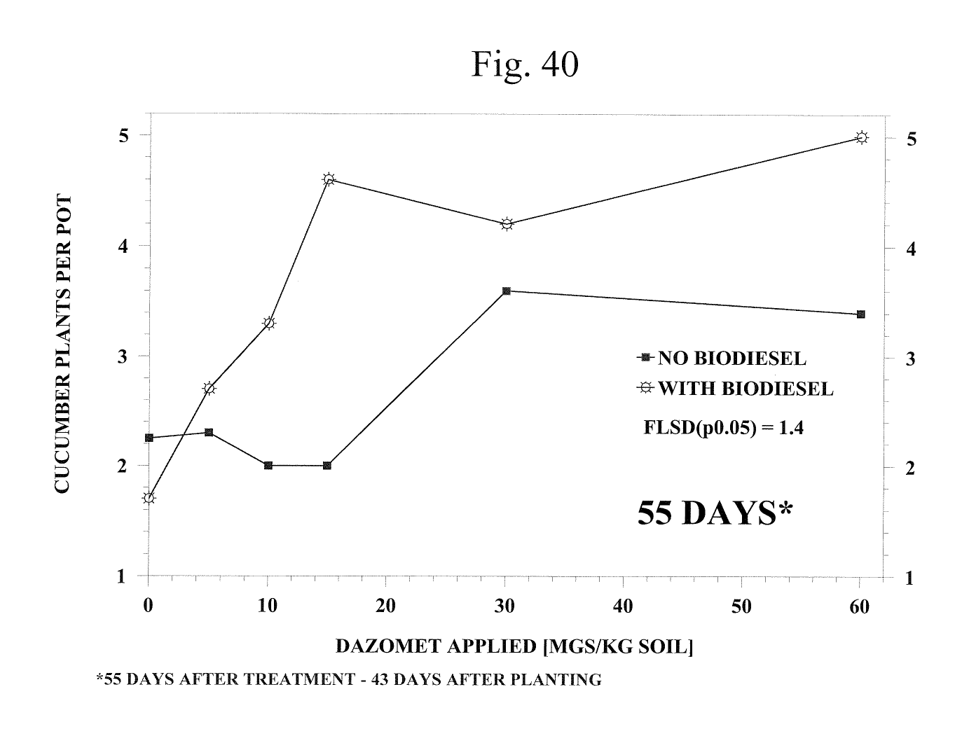

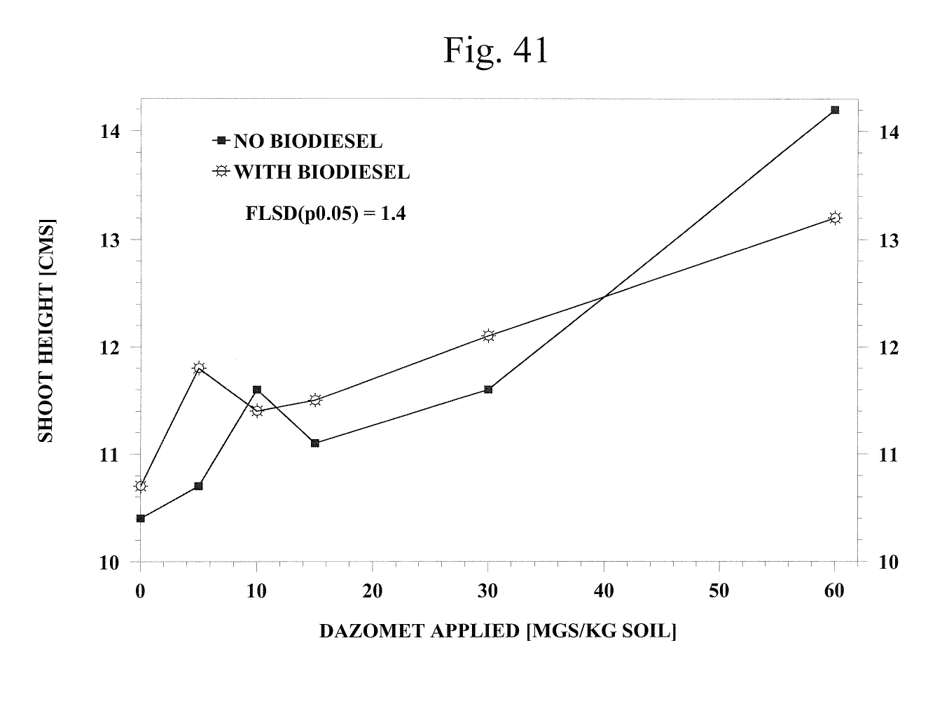

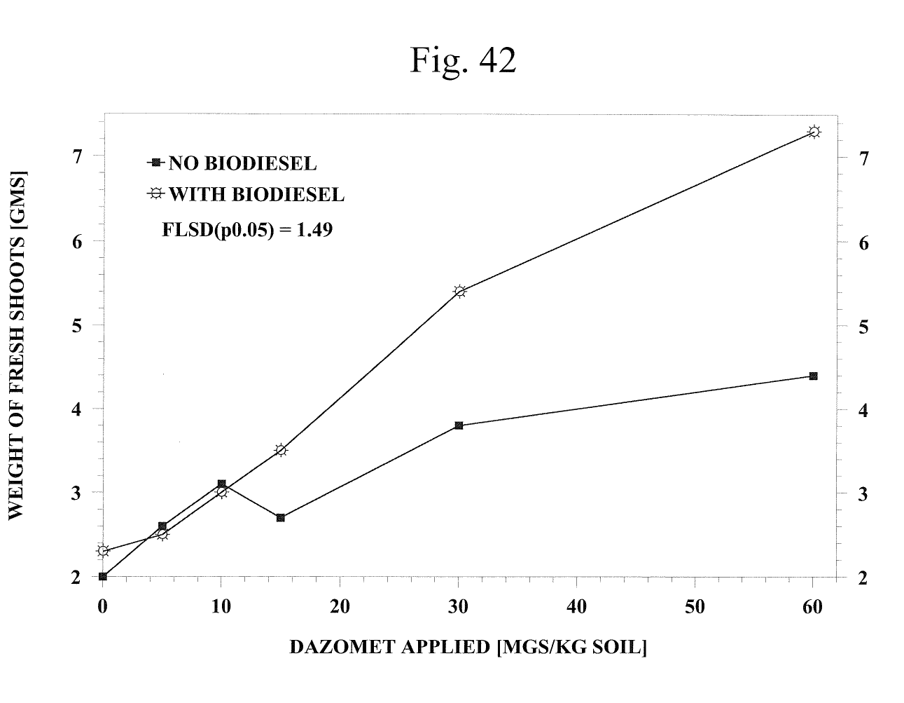

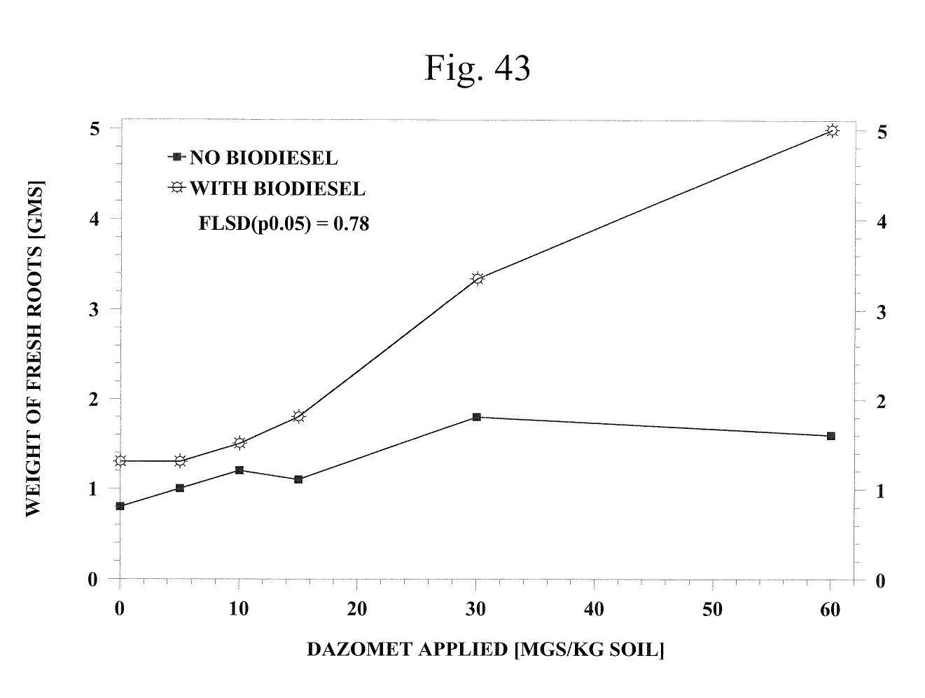

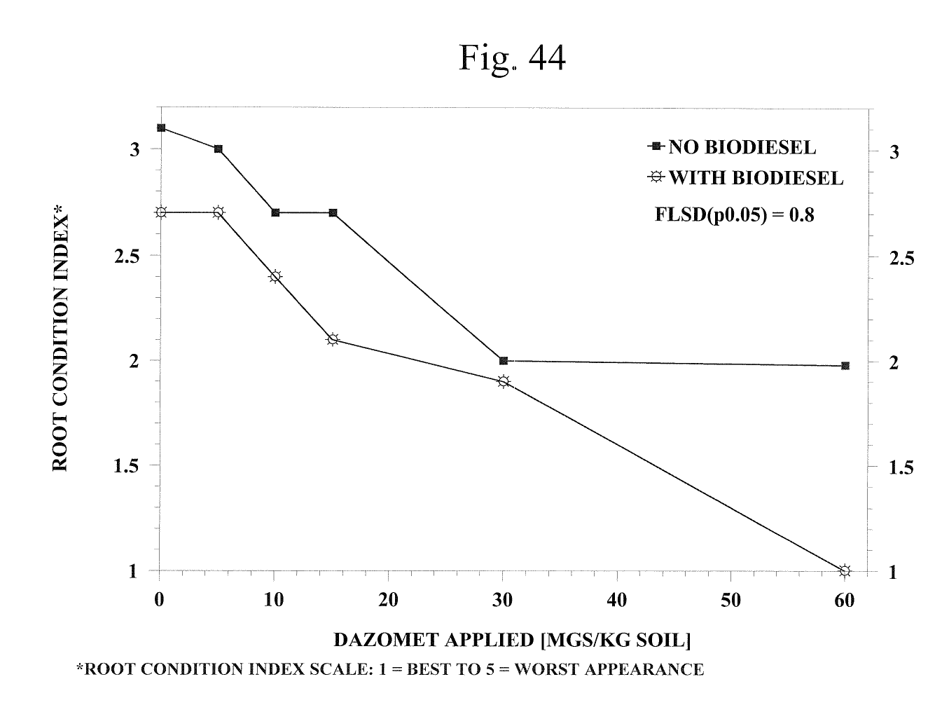

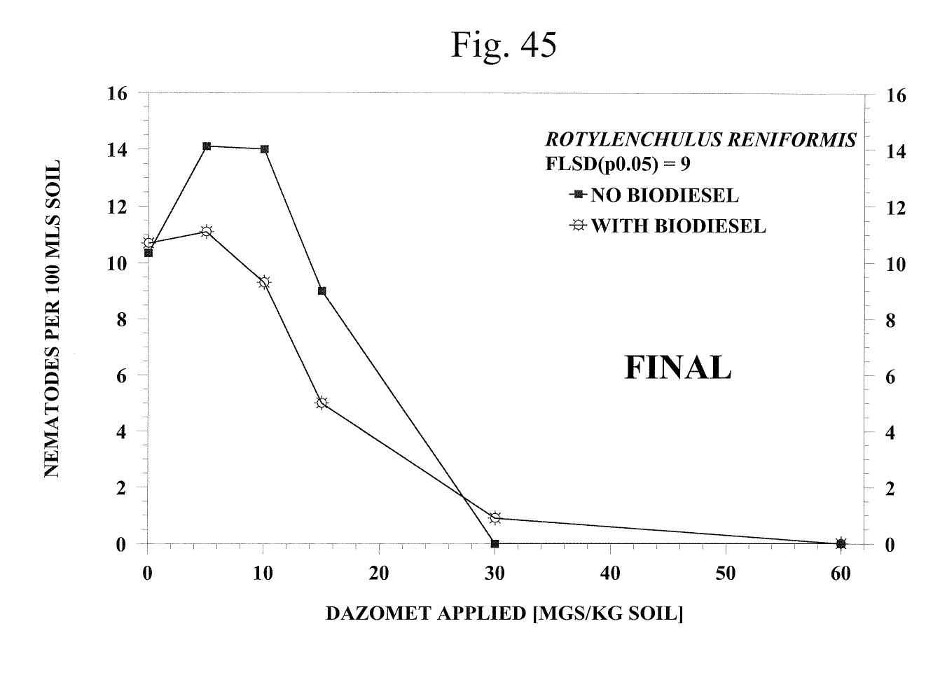

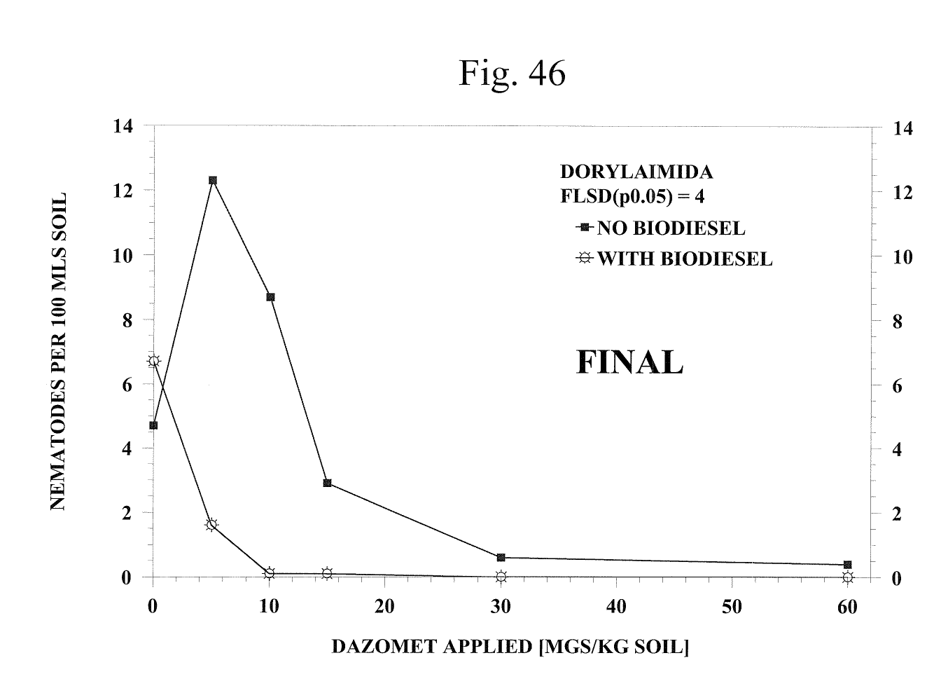

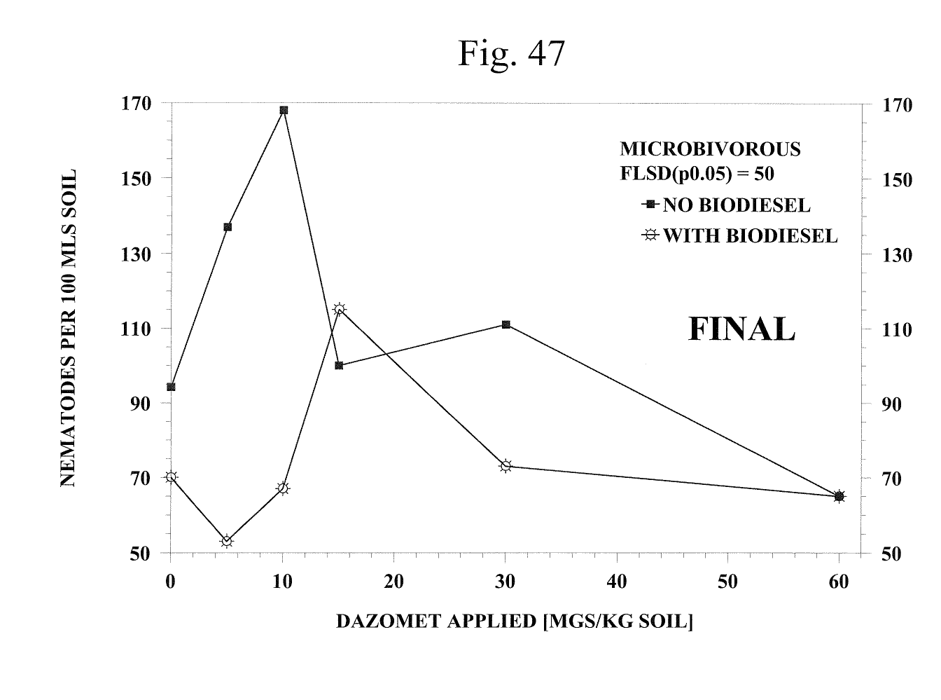

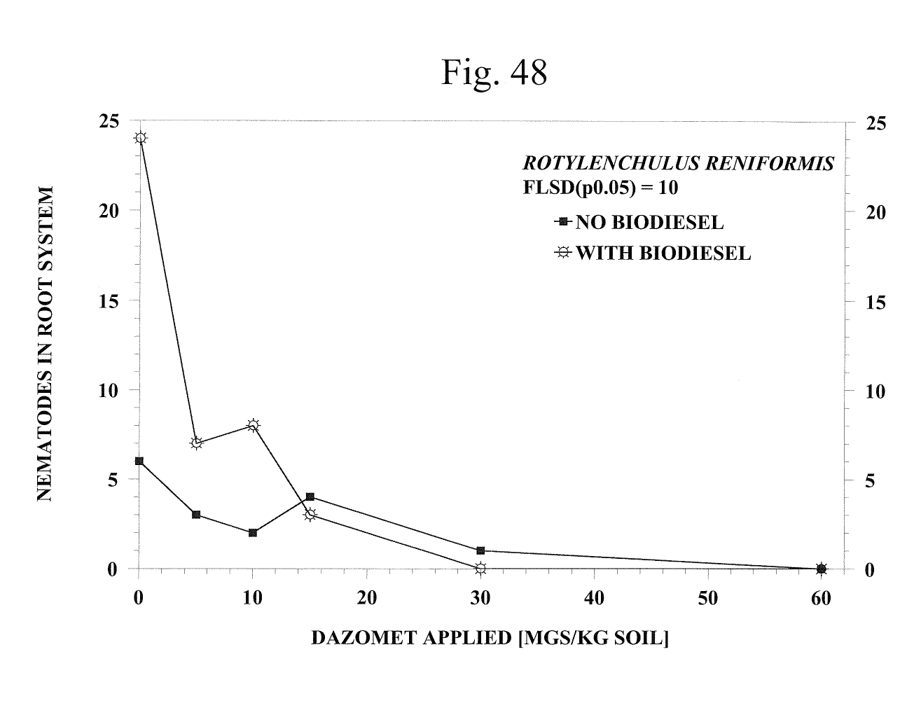

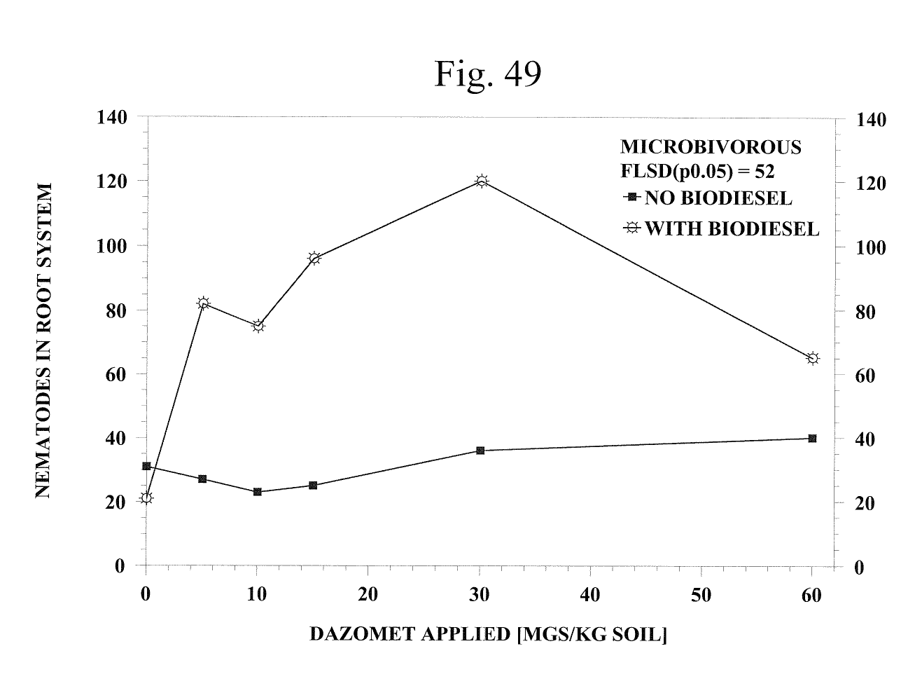

After treatment, a pre-plant sample of soil was taken 4-days pre-planting and nematodes per 100 mls of soil was determined (FIGS. 35-37). Cucumber seeds were planted in the pots, and the number of cucumber seedlings per pot was determined at sixteen (16) days (FIG. 38), twenty-eight (28) days (FIG. 39), and fifty-five (55) days (FIG. 40). At fifty-five (55) days, the test was terminated and shoot height (FIG. 41), shoot weight (FIG. 42), root weight (FIG. 43), and root condition (FIG. 44) were determined. Also at fifty-five (55) days, the number of nematodes per 100 mls of soil and in the root system was determined (FIGS. 45-49).

Nematode Test 46

An 0.5% dazomet composition was prepared by combining 30 ml of furfural (Illovo Sugar, Ltd.), 3 mls of Illovo Mix (emulsifier), and 5 g dazomet. The composition was heated in a microwave for 10 seconds and the final volume was brought to 1 L with demineralized water. A 5% biodiesel composition was prepared by adding 30 ml of furfural, 3 mls of Illovo Mix (emulsifier), and 50 g of biodiesel, and bringing the final volume to 1 L with demineralized water.

Soil that was naturally infected with nematodes was combined with sand (1:1) to prepare a soil mixture for testing. One kilogram of the soil mixture was added to seven (7) pots for each test mixture. Testing was performed by drenching soil with 100 mls of test compositions as indicated in Table 4.

TABLE 4

| | Dazomet | | Biodiesel | |
|---|---|---|---|---|
| | (mls 0.5% | Dazomet | (mls 5% sol/kg | Biodiesel |
| Test | emul/kg soil) | (mg/kg soil) | soil) | (mg/kg soil) |
| Control | | | | |
| Dazomet + | 1 | 5 | 0 | 0 |
| Furfural | | | | |
| “” | 2 | 10 | 0 | 0 |
| “” | 3 | 15 | 0 | 0 |
| “” | 6 | 30 | 0 | 0 |
| “” | 12 | 60 | 0 | 0 |
| Dazomet + | 1 | 5 | 10 | 500 |
| Furfural + | | | | |
| Biodiesel | | | | |
| “” | 2 | 10 | 10 | 500 |
| “” | 3 | 15 | 10 | 500 |
| “” | 6 | 30 | 10 | 500 |
| “” | 12 | 60 | 10 | 500 |
| Biodiesel | 0 | 0 | 10 | 500 |
| Biodiesel | 0 | 0 | 20 | 1000 |
| Control | | | | |
| Sand | | | | |

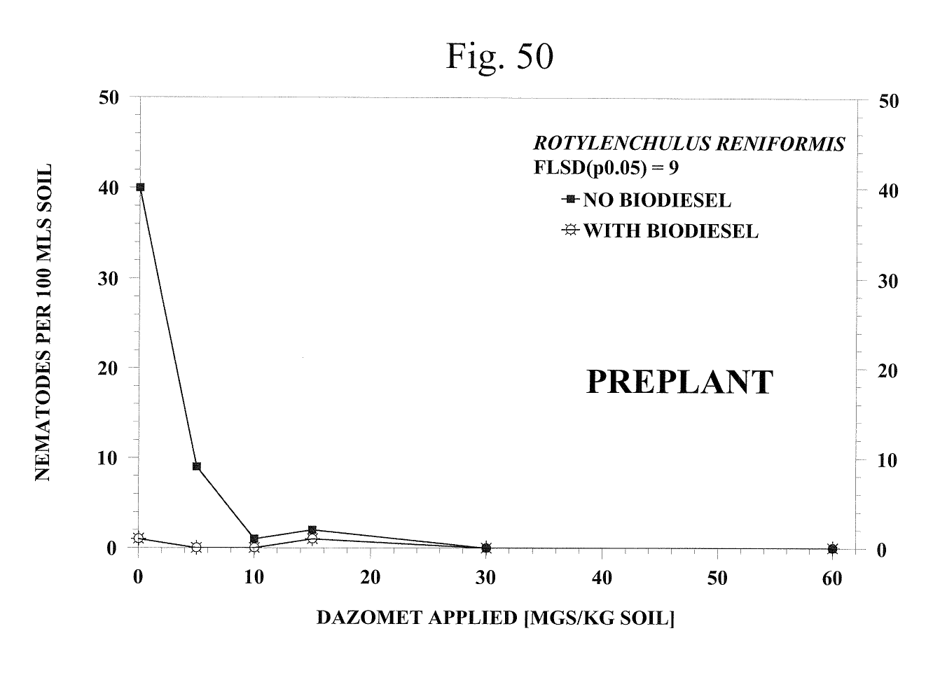

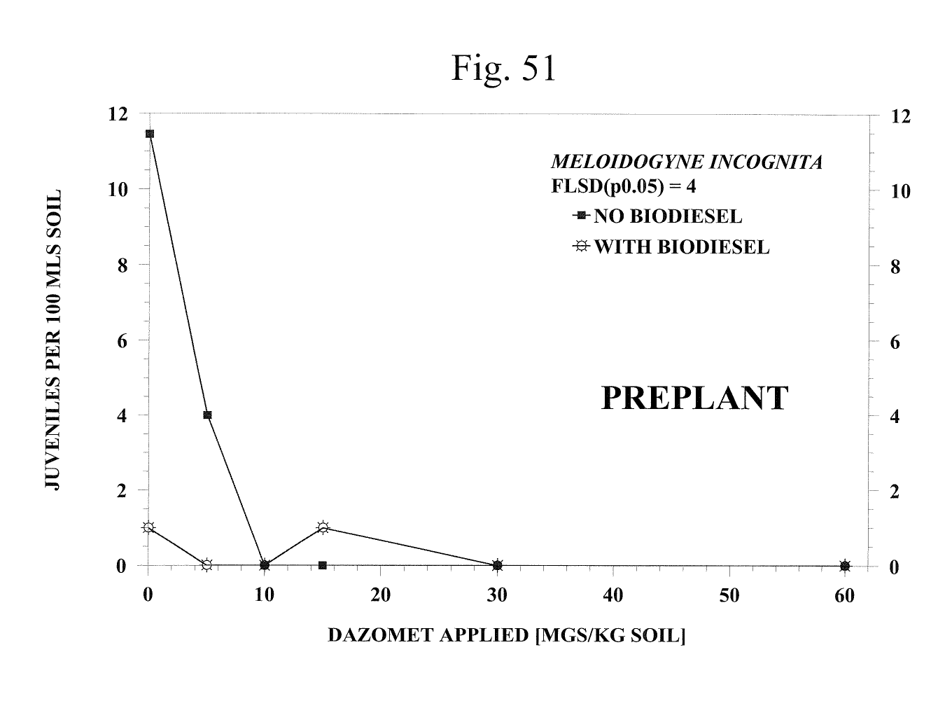

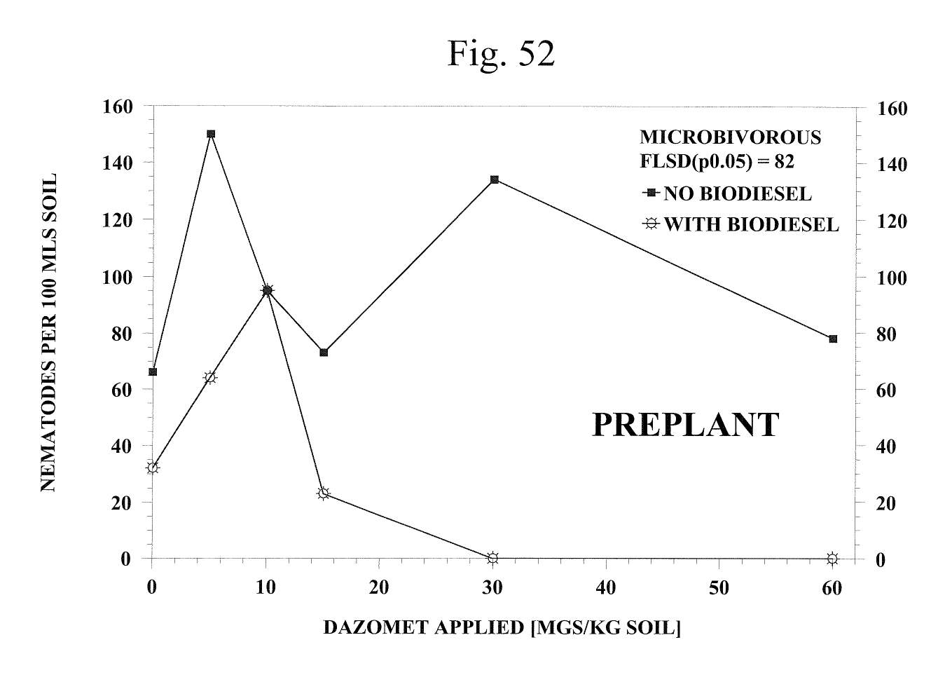

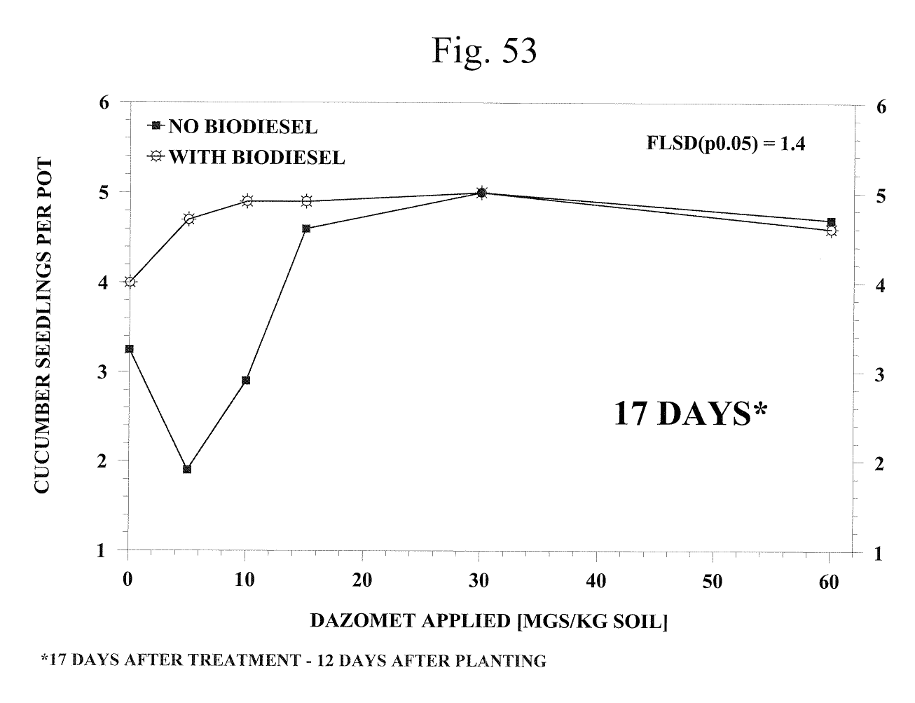

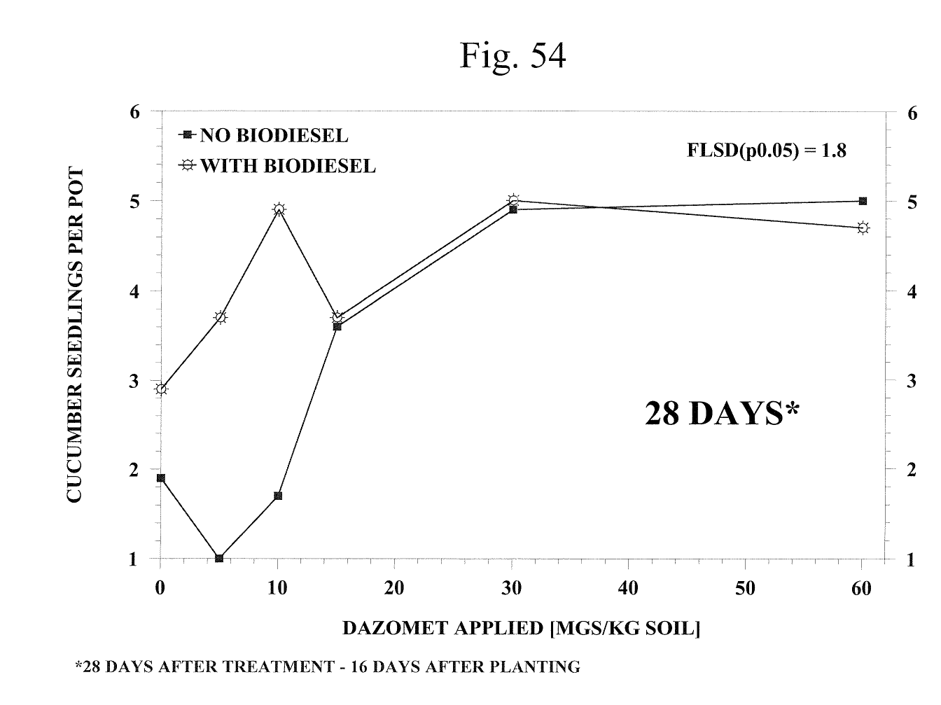

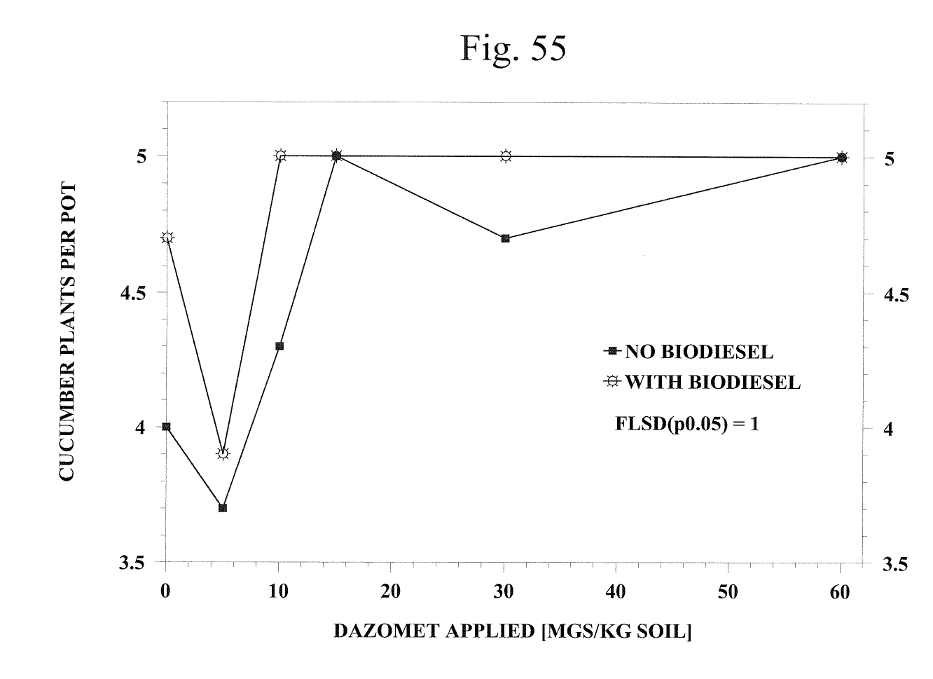

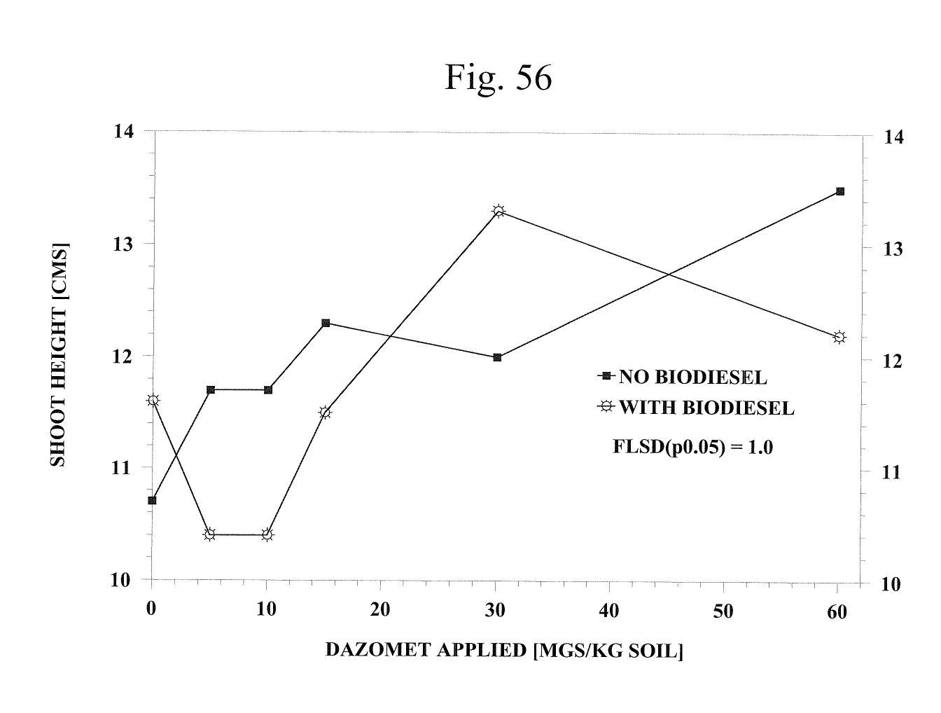

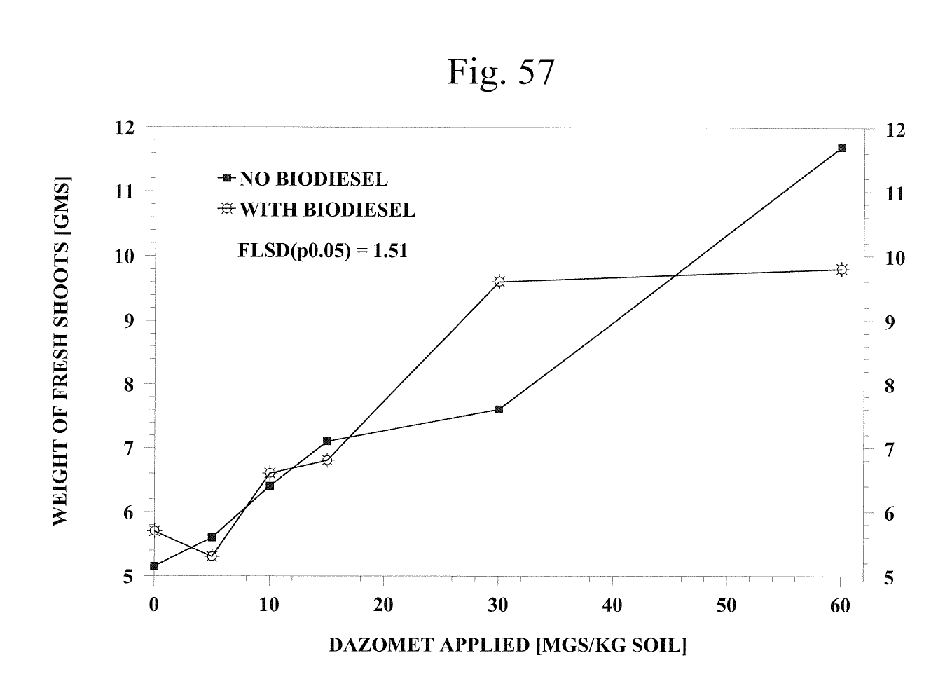

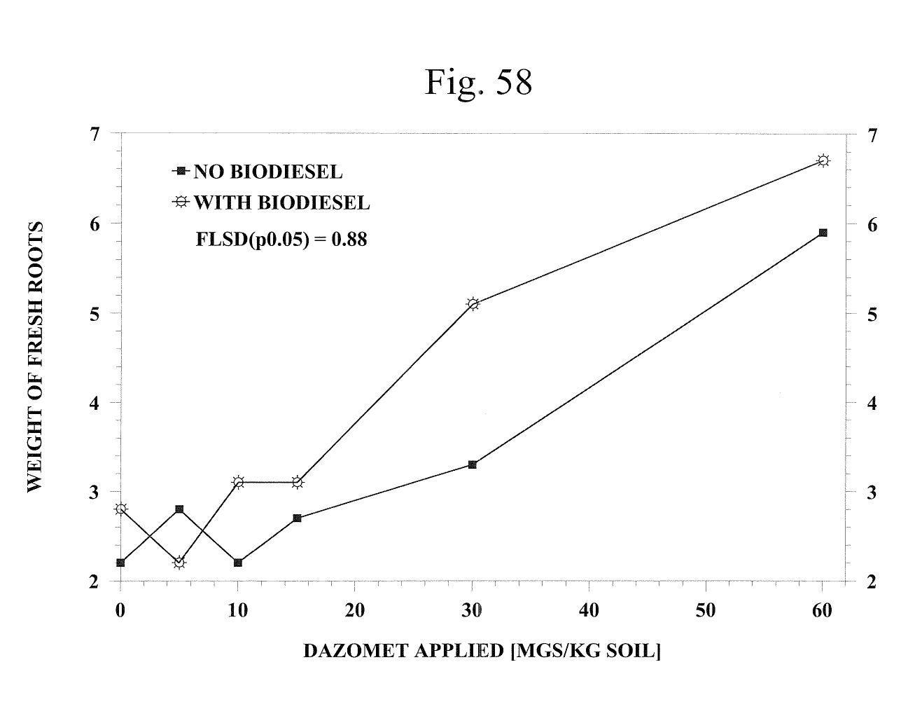

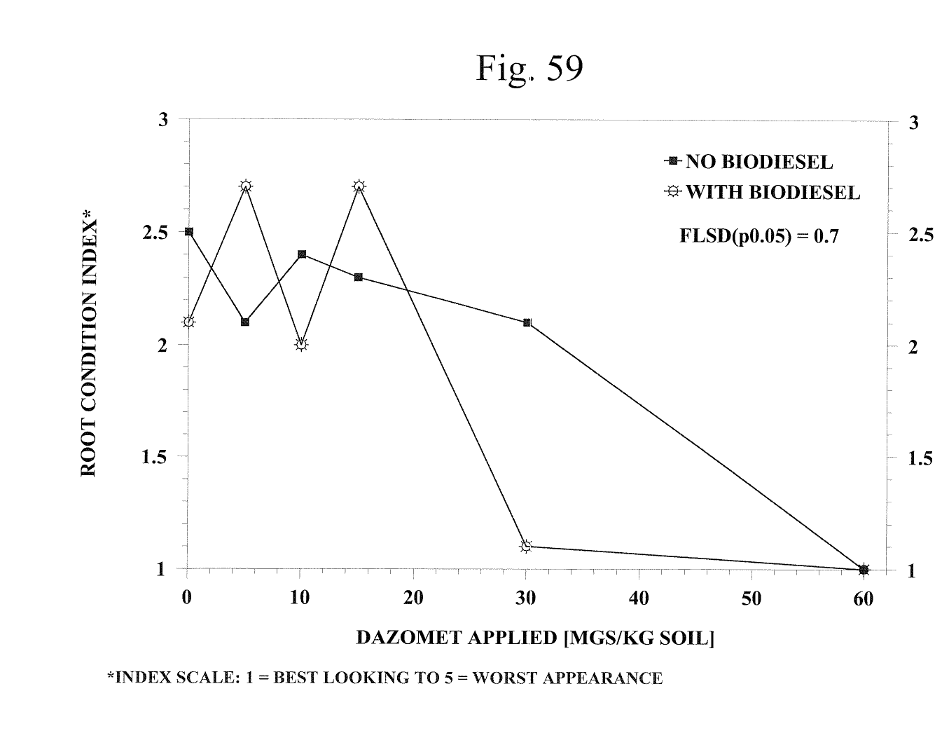

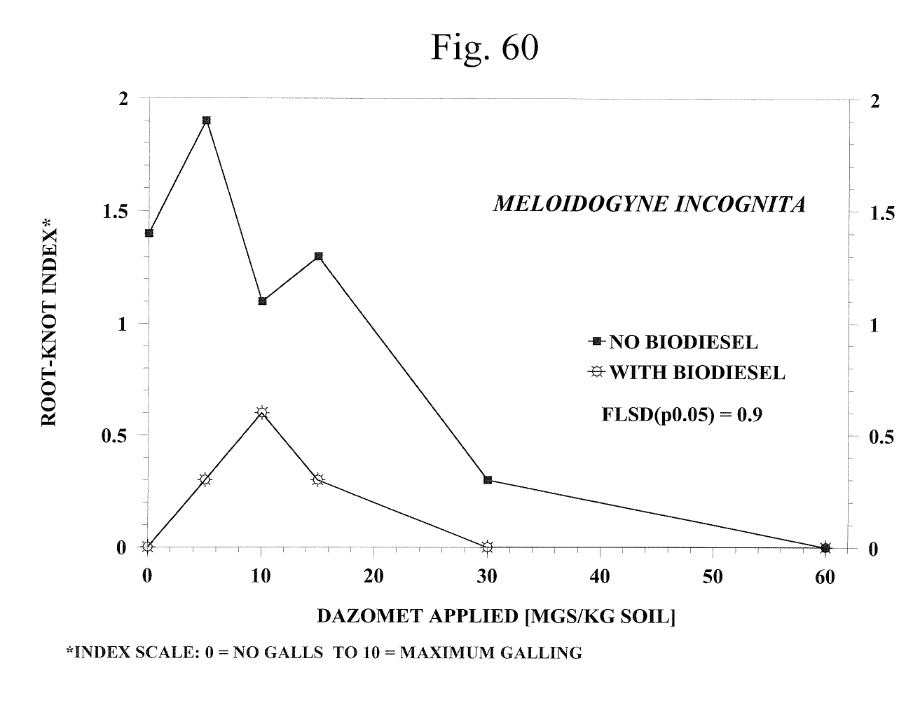

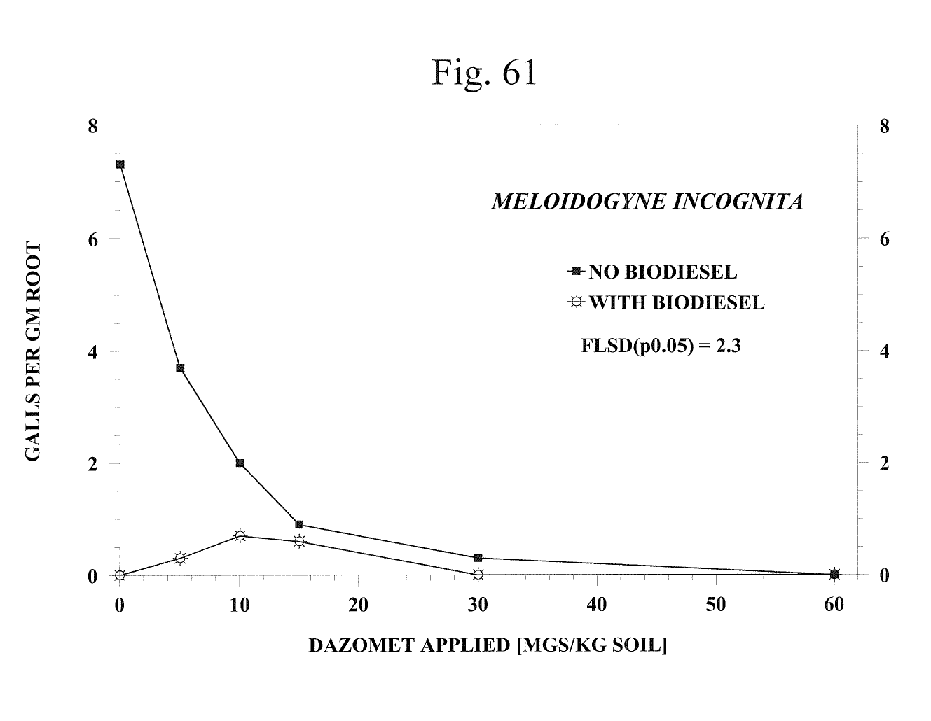

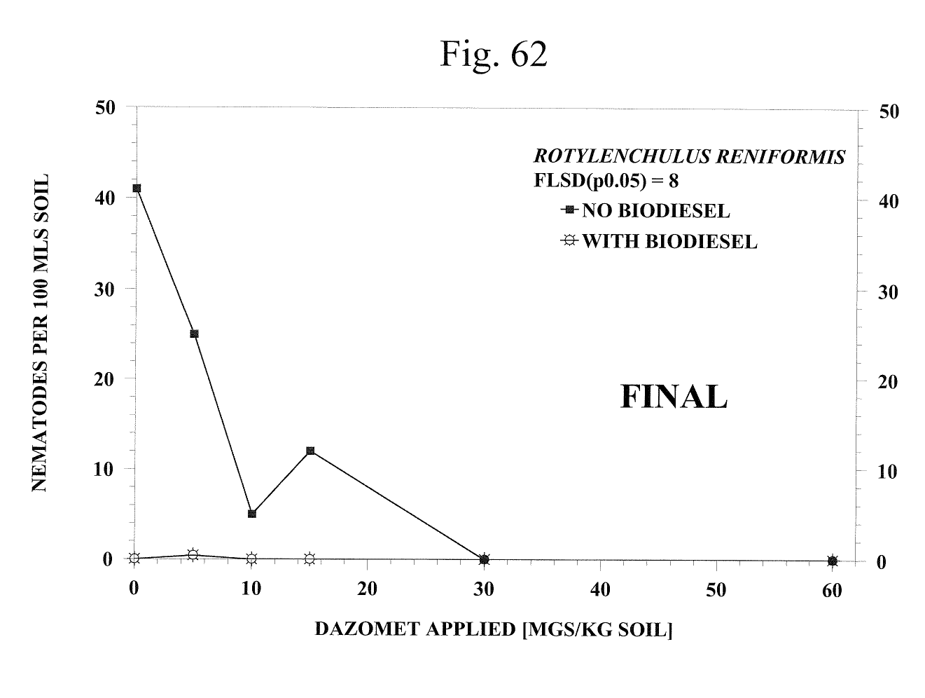

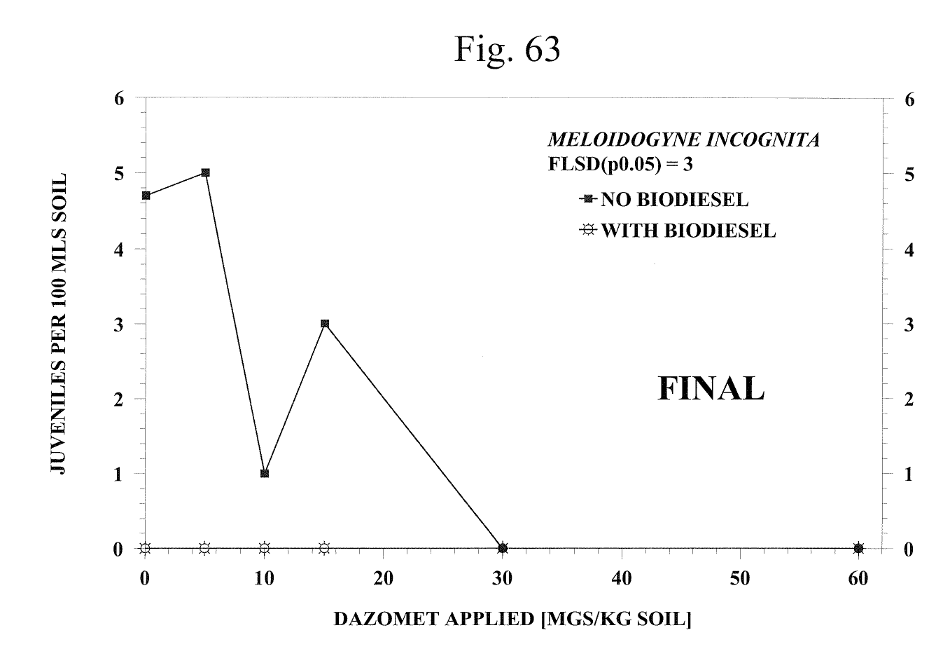

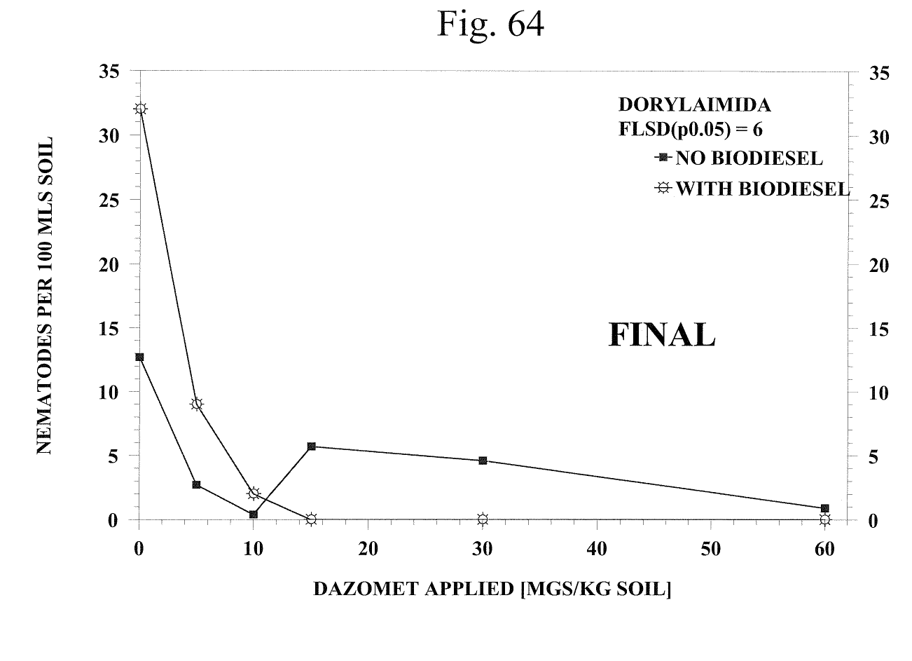

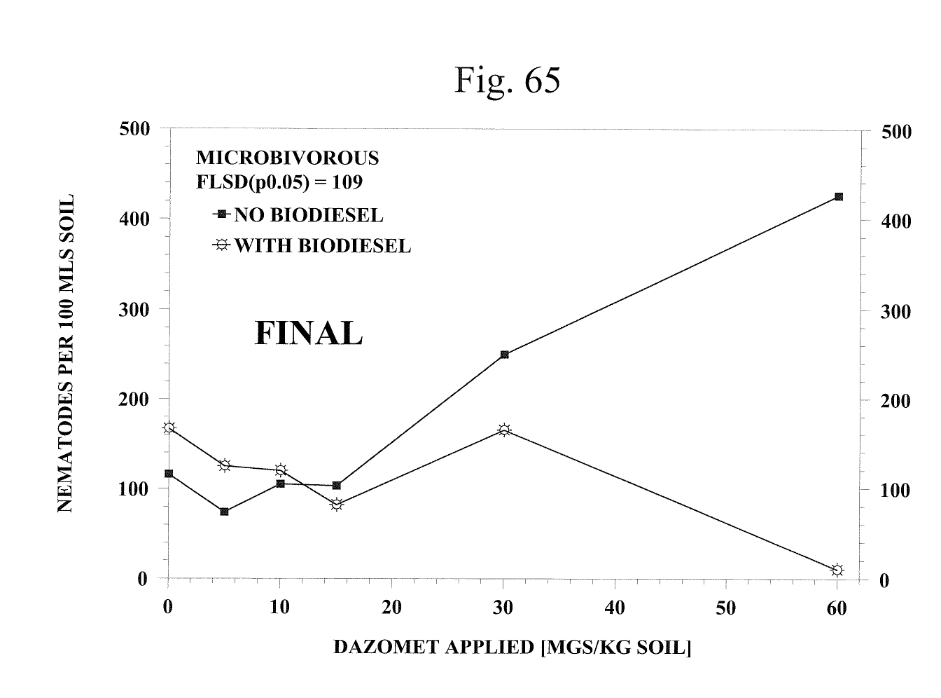

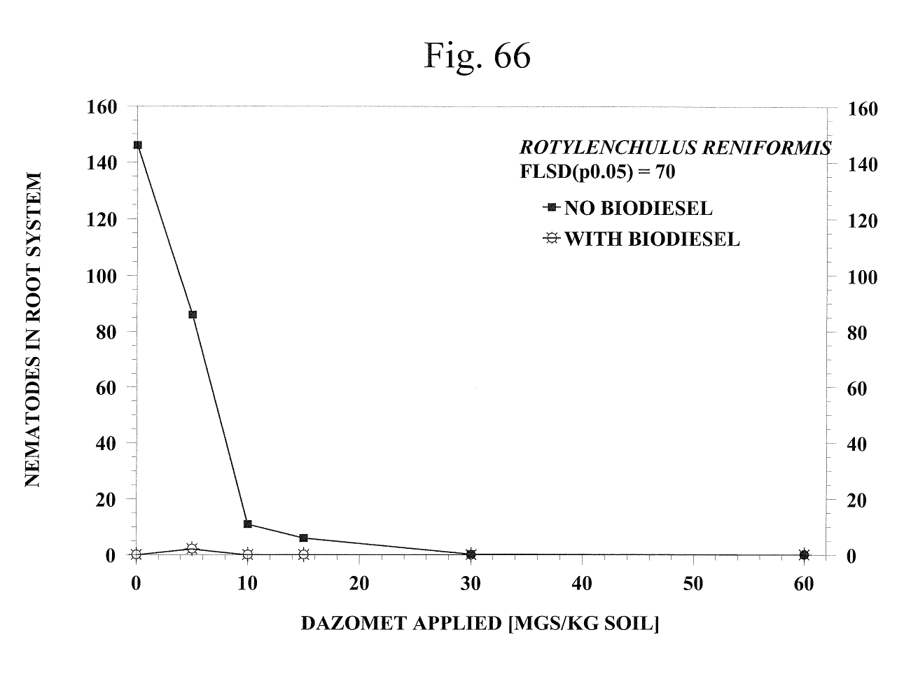

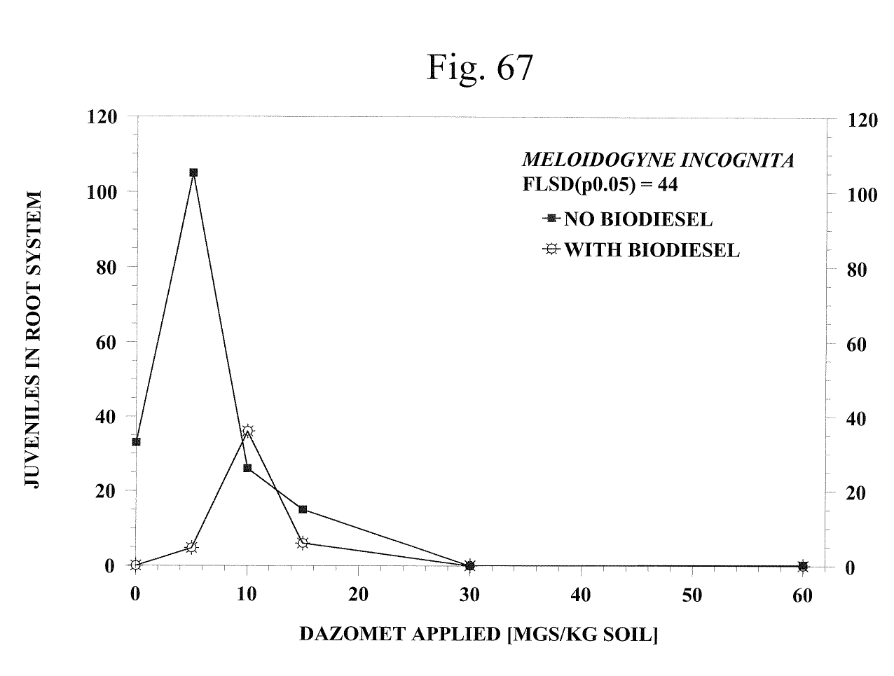

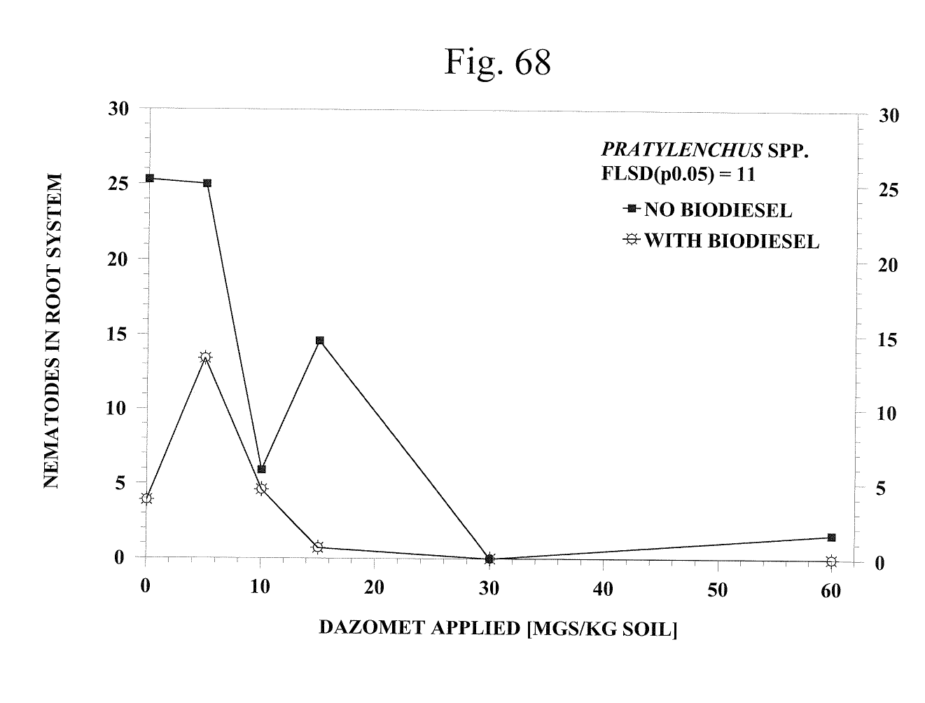

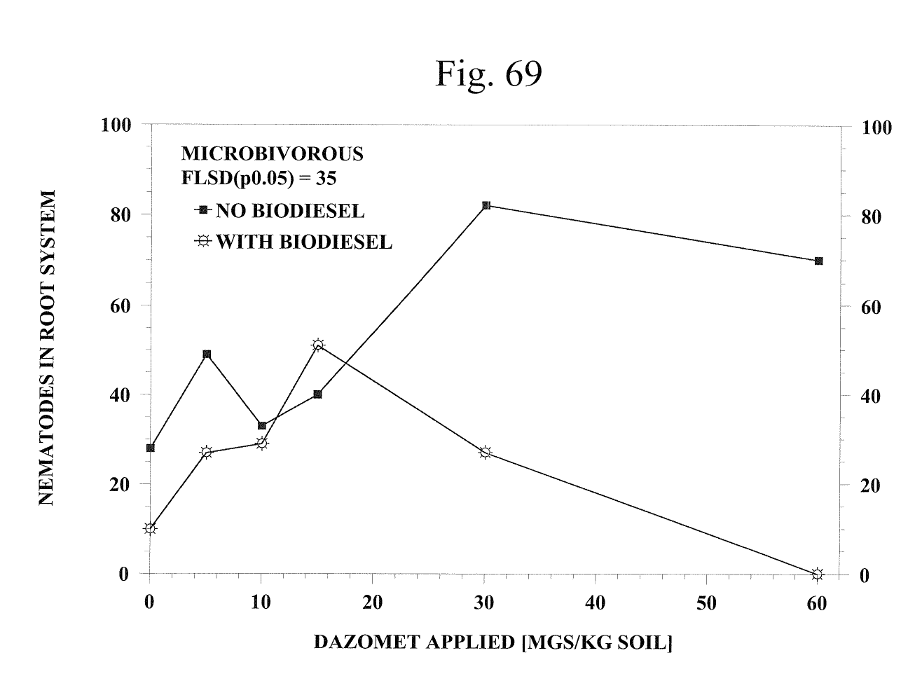

After treatment, a pre-plant sample of soil was taken 5-days pre-planting and nematodes per 100 mls of soil was determined (FIGS. 50-52). Cucumber seeds were planted in the pots, and the number of Cucumber seedlings per pot was determined at seventeen (17) days (FIG. 53), twenty-eight (28) days (FIG. 54), and seventy-five (75) days (FIG. 55). At seventy-five (75) days, the test was terminated and shoot height (FIG. 56), shoot weight (FIG. 57), root weight (FIG. 58), root condition (FIG. 59), root-knot (FIG. 60), and galls per root (FIG. 61) were determined. Also at seventy-five (75) days, the number of nematodes per 100 mls of soil or in the root system was determined (FIGS. 62-69).

Nematode Test 48

A 1% citral composition was prepared by combining 15 g citral, 10 ml acetone, and 3 mls of Illovo Mix (emulsifier), and bringing the final volume to 1.5 L with demineralized water. A 5% biodiesel composition was prepared by adding 100 g biodiesel, 6 mls of Illovo Mix (emulsifier), and bringing the final volume to 2 L with demineralized water.

Soil that was naturally infected with nematodes was combined with sand (1:1) to prepare a soil mixture for testing. One kilogram of the soil mixture was added to seven (7) pots for each test mixture. Testing was performed by drenching soil with 100 mls of test compositions as indicated in Table 5.

TABLE 5

| | Citral | | Biodiesel | |
|---|---|---|---|---|
| | (mls 1% | Citral | (mls 5% sol/ | Biodiesel |
| Test | emul/kg soil) | (mg/kg soil) | kg soil) | (mg/kg soil) |
| Control | | | | |
| Citral | 1 | 10 | 0 | 0 |
| “” | 2 | 20 | 0 | 0 |
| “” | 3 | 30 | 0 | 0 |
| “” | 6 | 60 | 0 | 0 |
| “” | 12 | 120 | 0 | 0 |
| Citral + | 1 | 10 | 10 | 500 |
| Biodiesel | | | | |
| “” | 2 | 20 | 10 | 500 |
| “” | 3 | 30 | 10 | 500 |
| “” | 6 | 60 | 10 | 500 |
| “” | 12 | 120 | 10 | 500 |
| Biodiesel | 0 | 0 | 10 | 500 |
| Biodiesel | 0 | 0 | 20 | 1000 |
| Control | | | | |
| Sand | | | | |

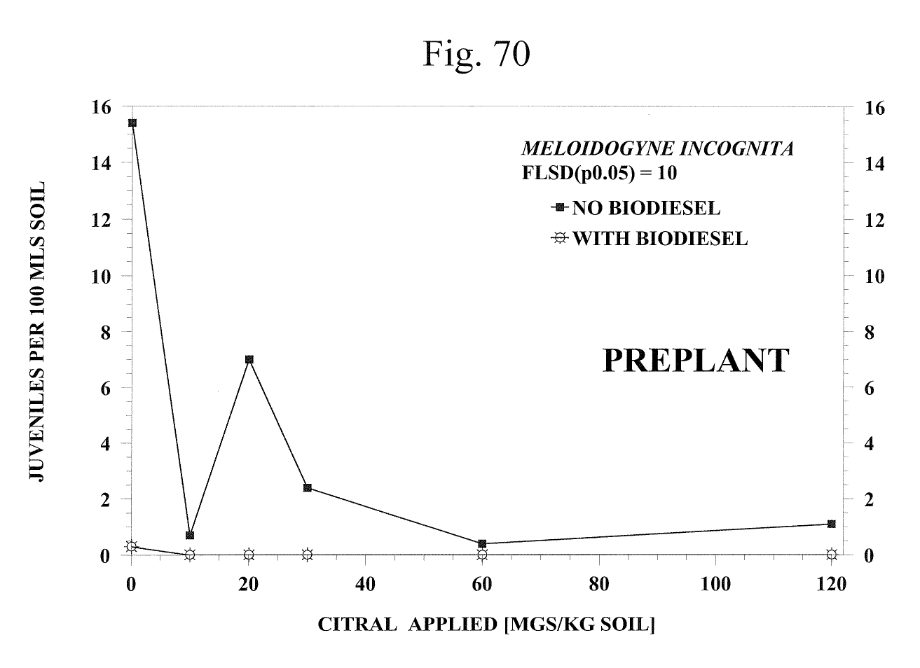

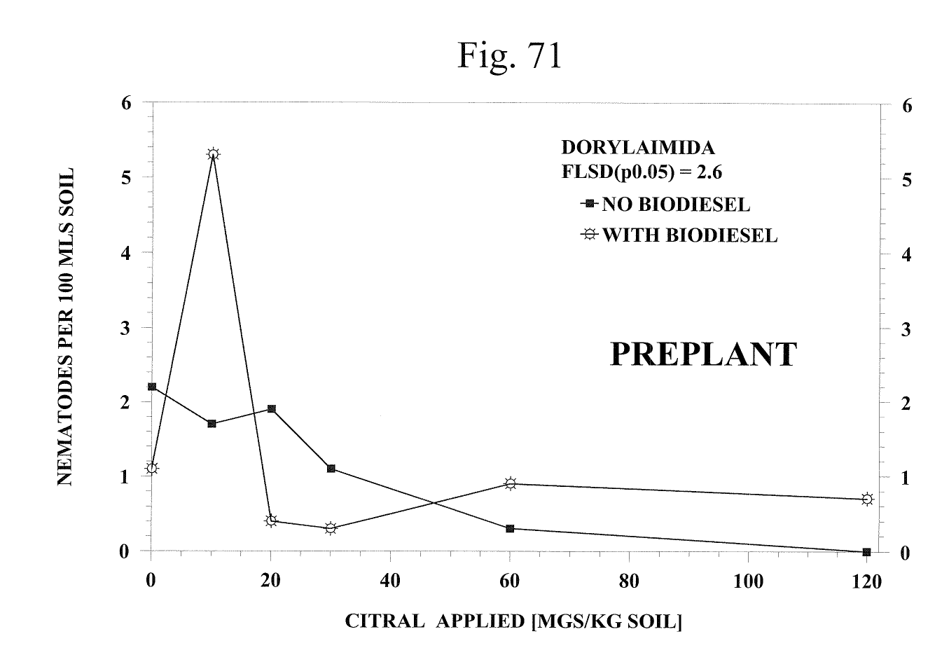

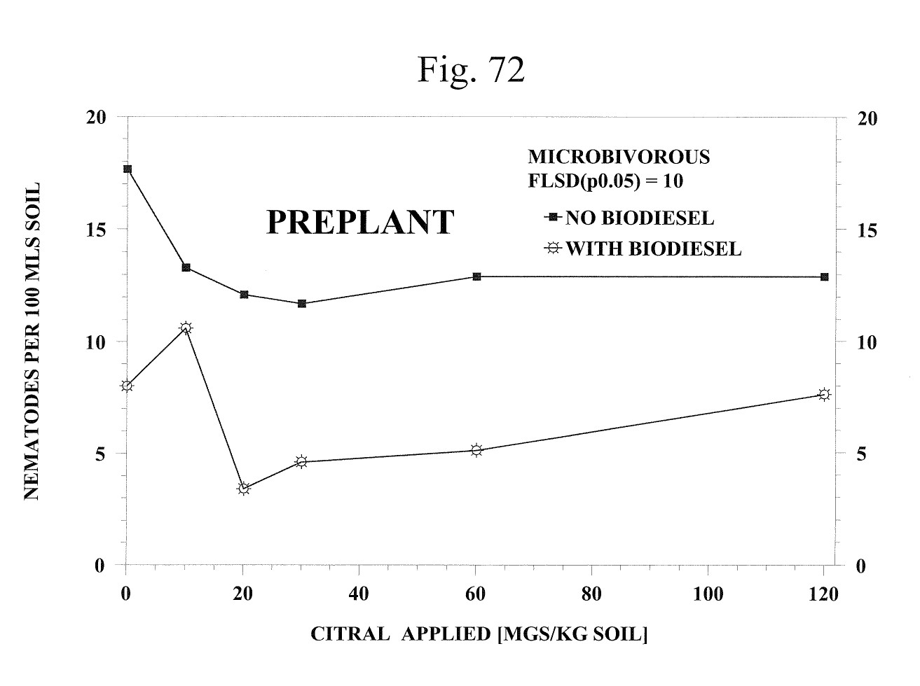

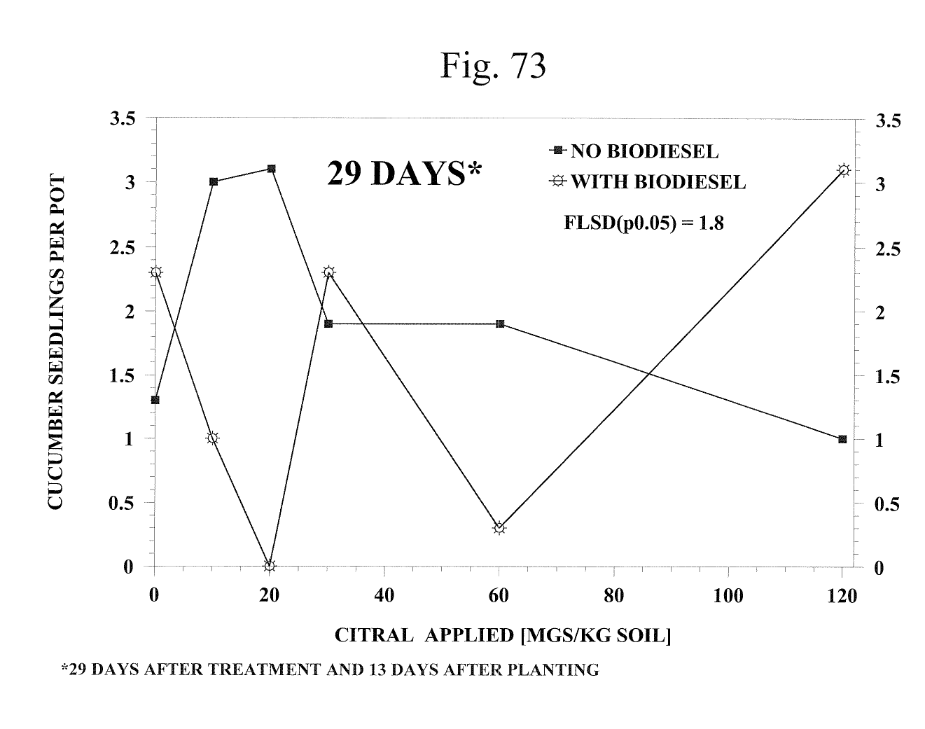

After treatment, a pre-plant sample of soil was taken 16-days pre-planting and nematodes per 100 mls of soil was determined (FIGS. 70-72). Cucumber seeds were planted in the pots. The number of cucumber seedlings per pot was determined at twenty-nine (29) days (FIG. 73).

Nematode Test 54

A 1% dimethyl cyanamide (DMC) composition was prepared by combining 15 g DMC in demineralized water and bringing the final volume to 1.5 L. A 5% biodiesel composition was prepared by adding 100 g biodiesel, 6 mls of Illovo Mix (emulsifier), and bringing the final volume to 2 L with demineralized water.

Soil that was naturally infected with nematodes was combined with sand (1:1) to prepare a soil mixture for testing. One kilogram of the soil mixture was added to seven (7) pots for each test mixture. Testing was performed by drenching soil with 100 mls of test compositions as indicated in Table 6.

TABLE 6

| | DMC | | Biodiesel | |
|---|---|---|---|---|
| | (mls 1% emul/ | DMC | (mls 5% sol/kg | Biodiesel |
| Test | kg soil) | (mg/kg soil) | soil) | (mg/kg soil) |
| Control | | | | |
| DMC | 5 | 50 | 0 | 0 |
| “” | 10 | 100 | 0 | 0 |
| “” | 15 | 150 | 0 | 0 |
| “” | 20 | 200 | 0 | 0 |
| “” | 25 | 250 | 0 | 0 |
| DMC + | 5 | 50 | 5 | 250 |
| Biodiesel | | | | |
| “” | 10 | 100 | 5 | 250 |
| “” | 15 | 150 | 5 | 250 |
| “” | 20 | 200 | 5 | 250 |
| “” | 25 | 250 | 5 | 250 |
| Biodiesel | 0 | 0 | 5 | 250 |
| Biodiesel | 0 | 0 | 10 | 500 |
| Control | | | | |
| Sand | | | | |

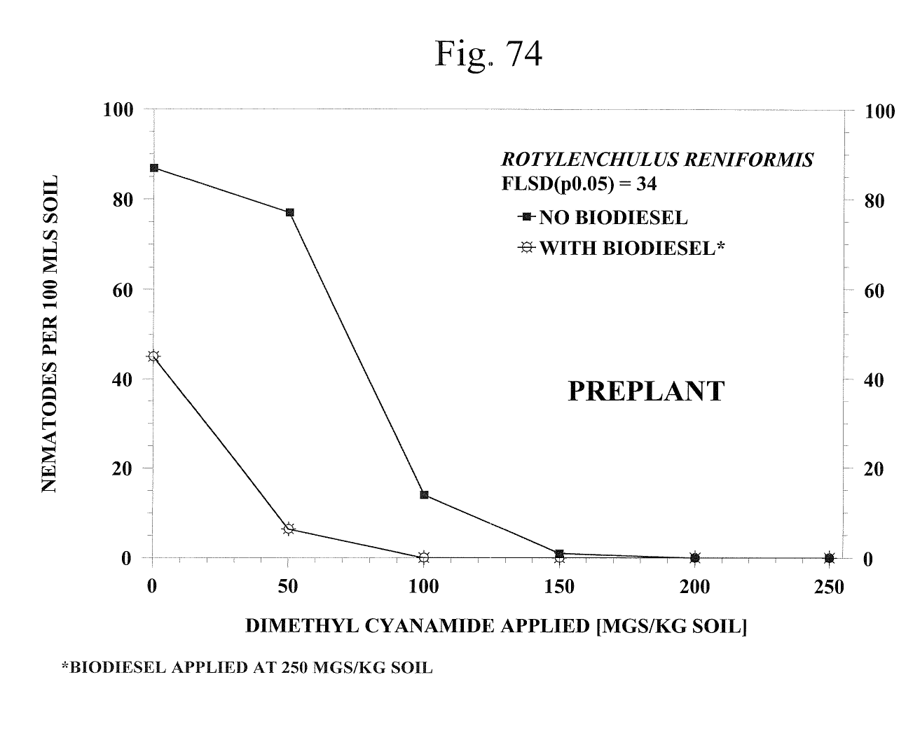

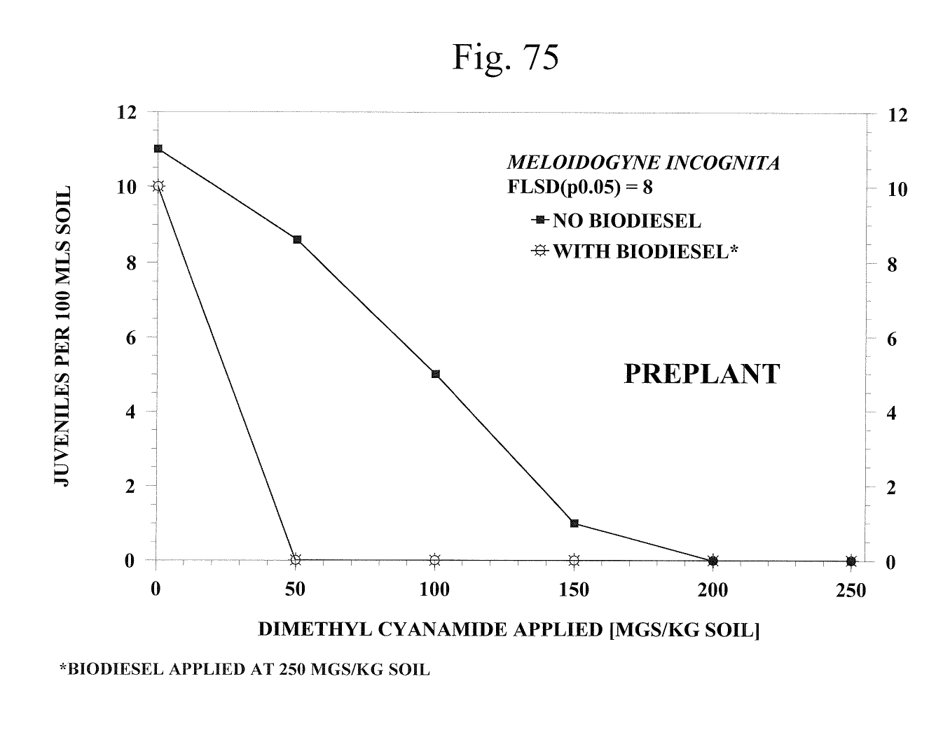

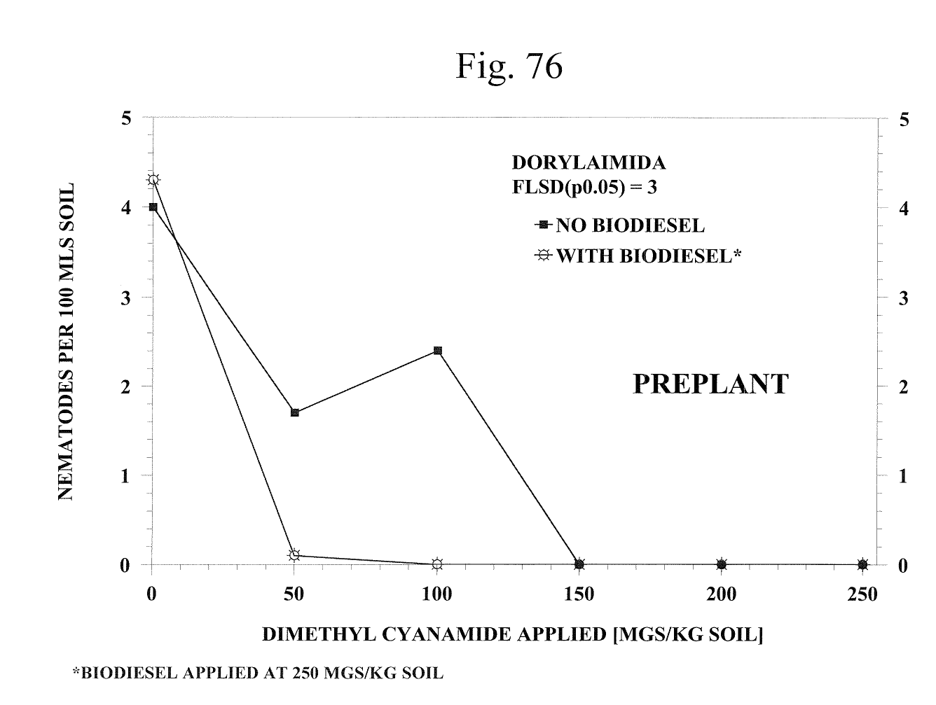

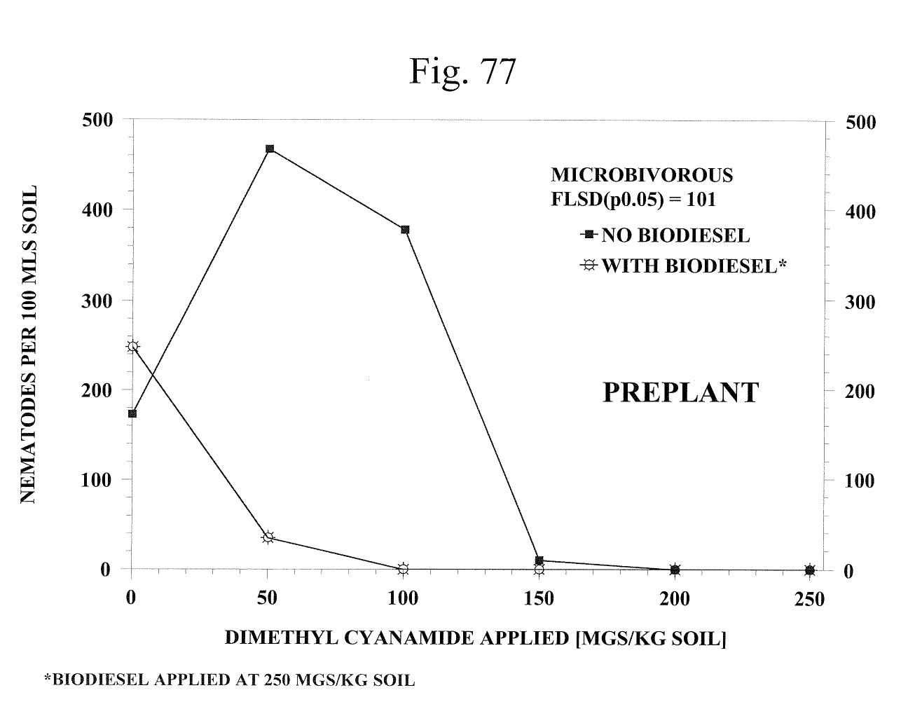

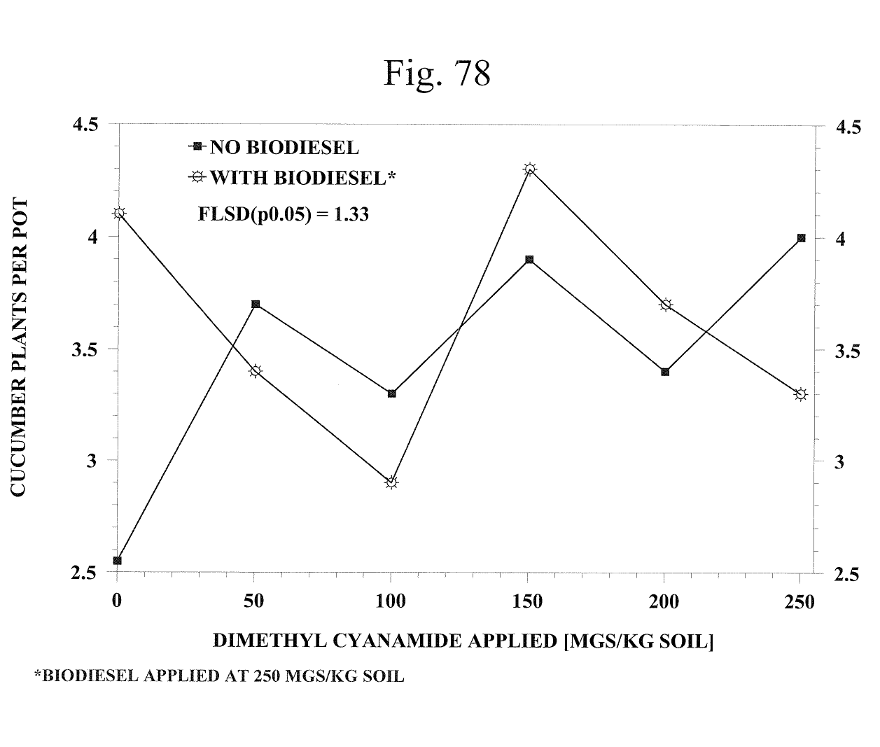

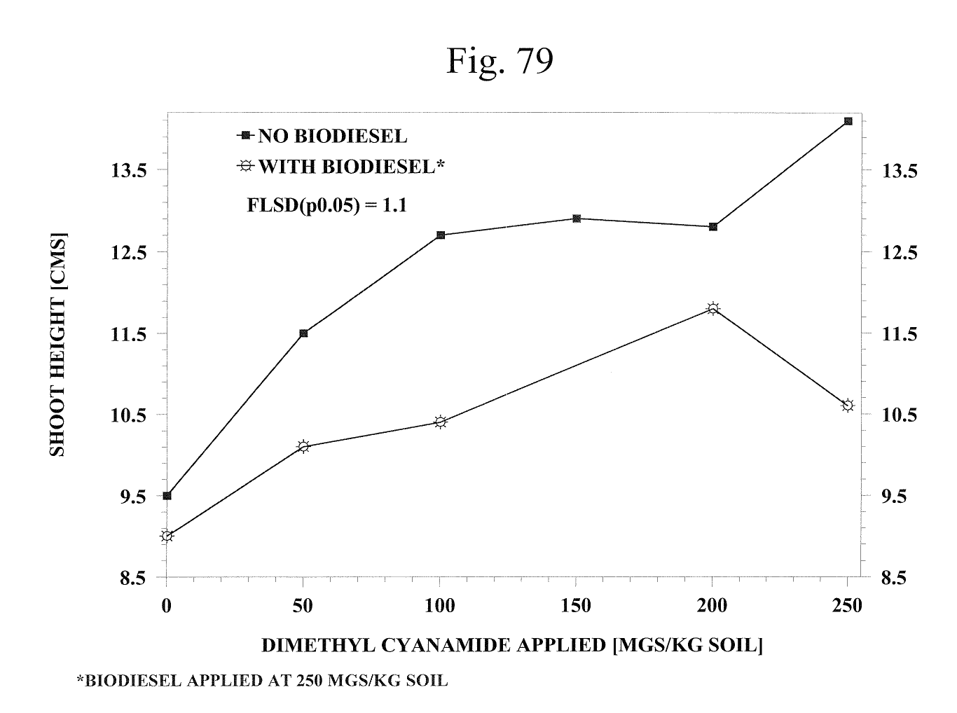

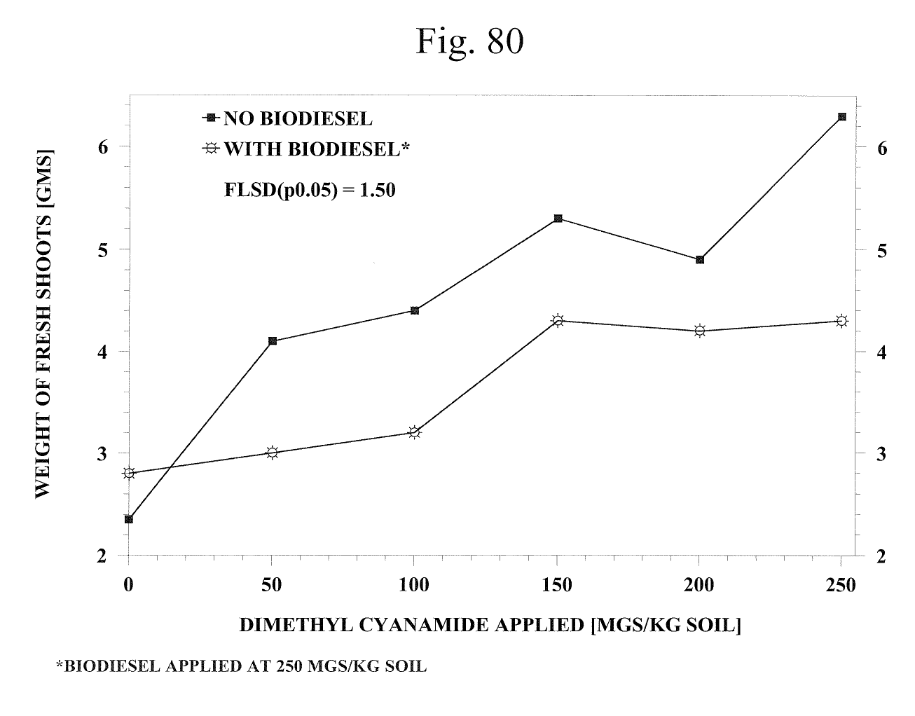

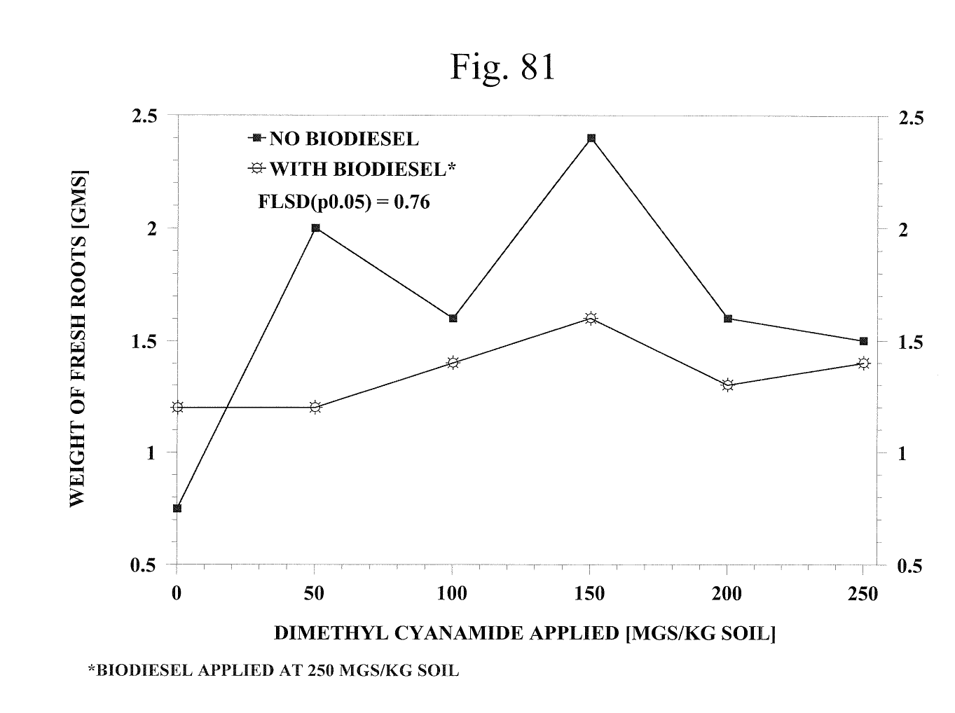

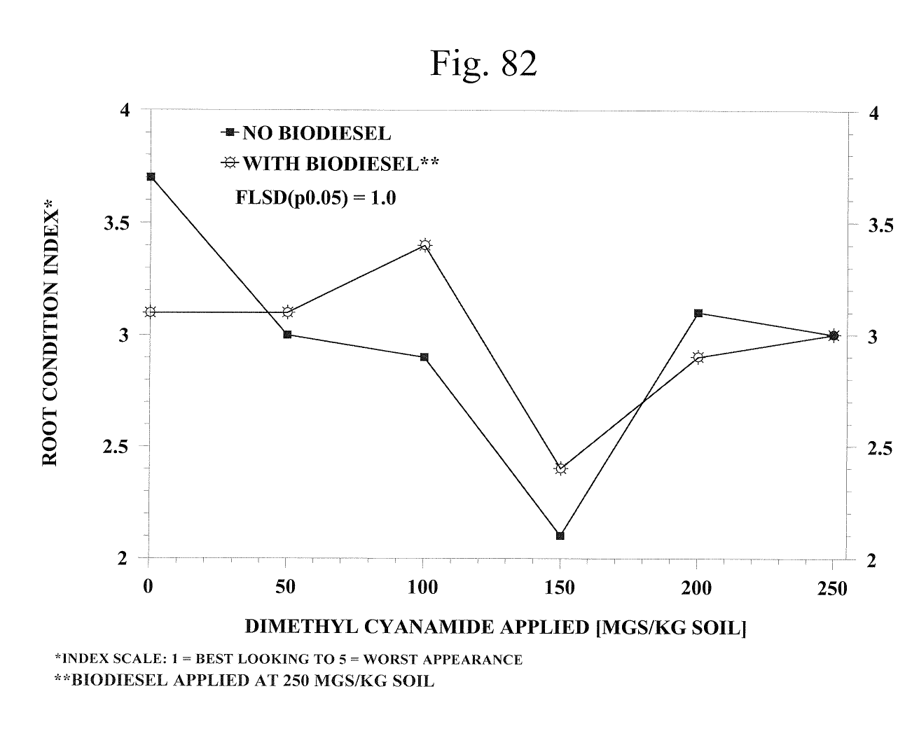

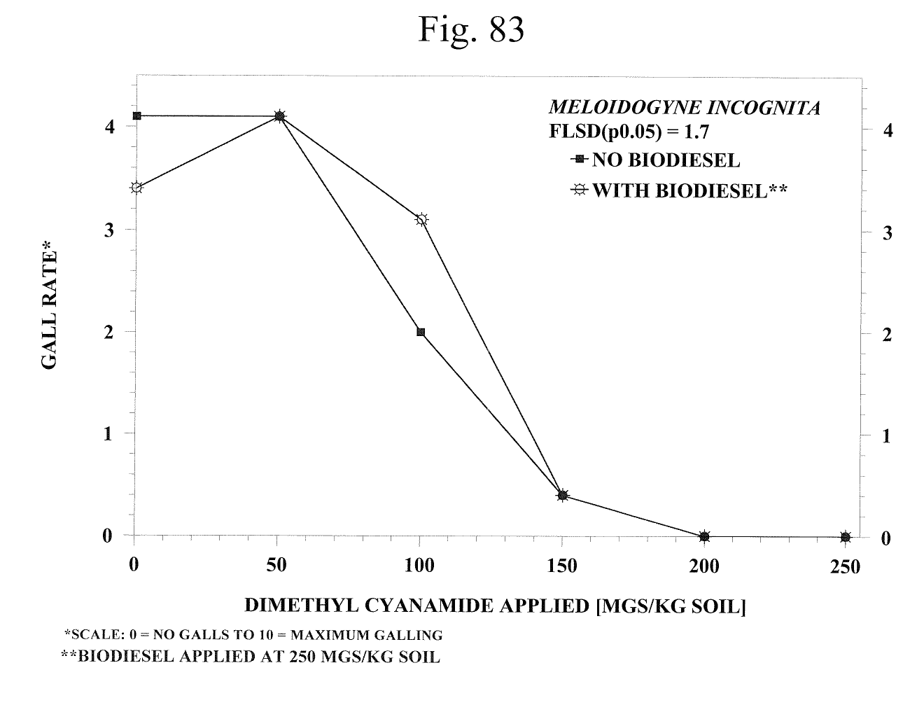

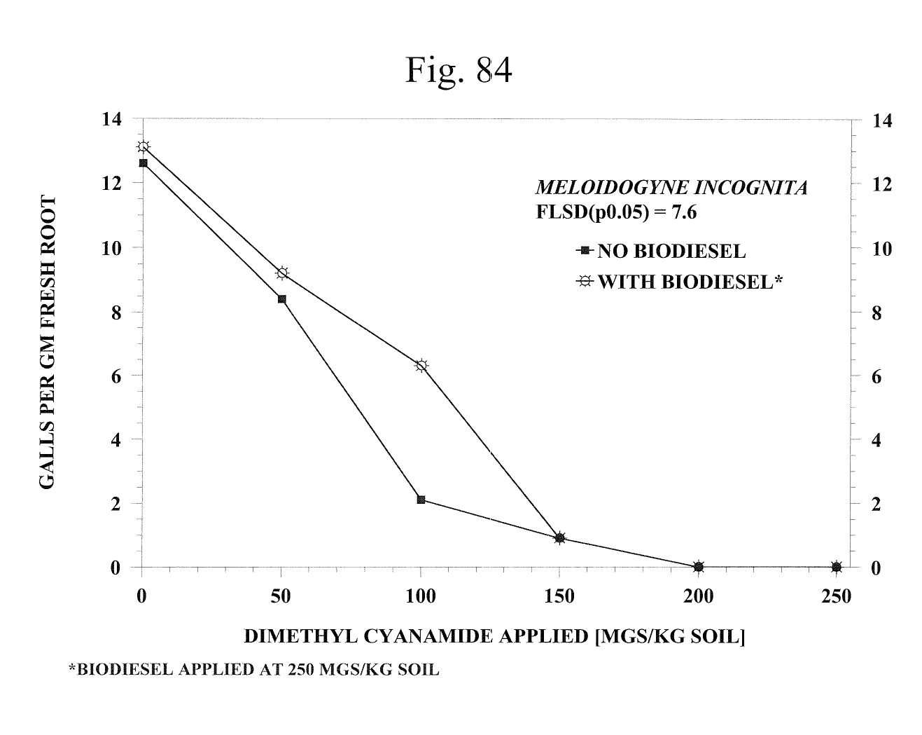

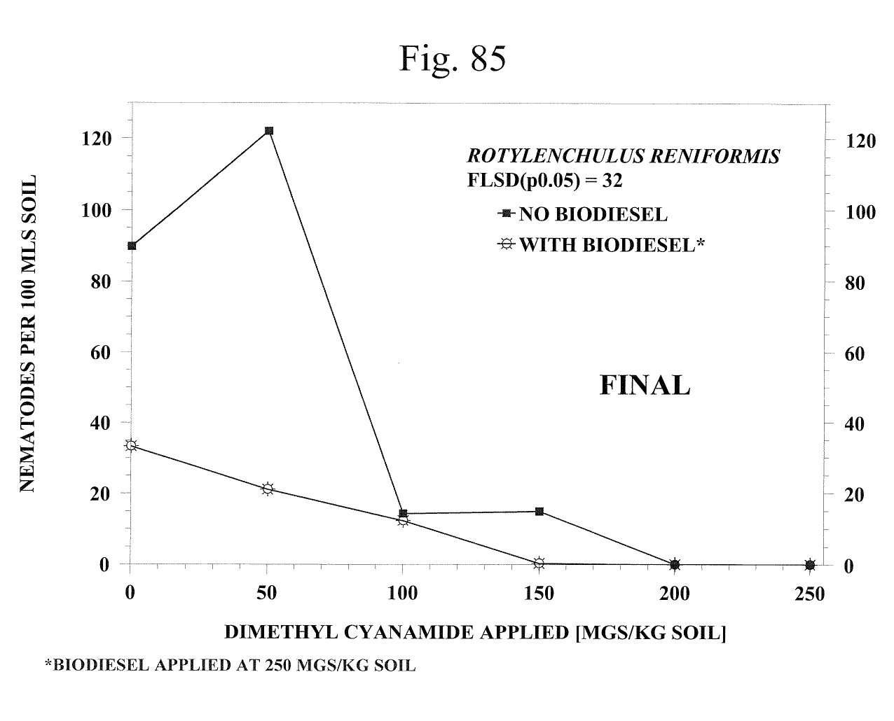

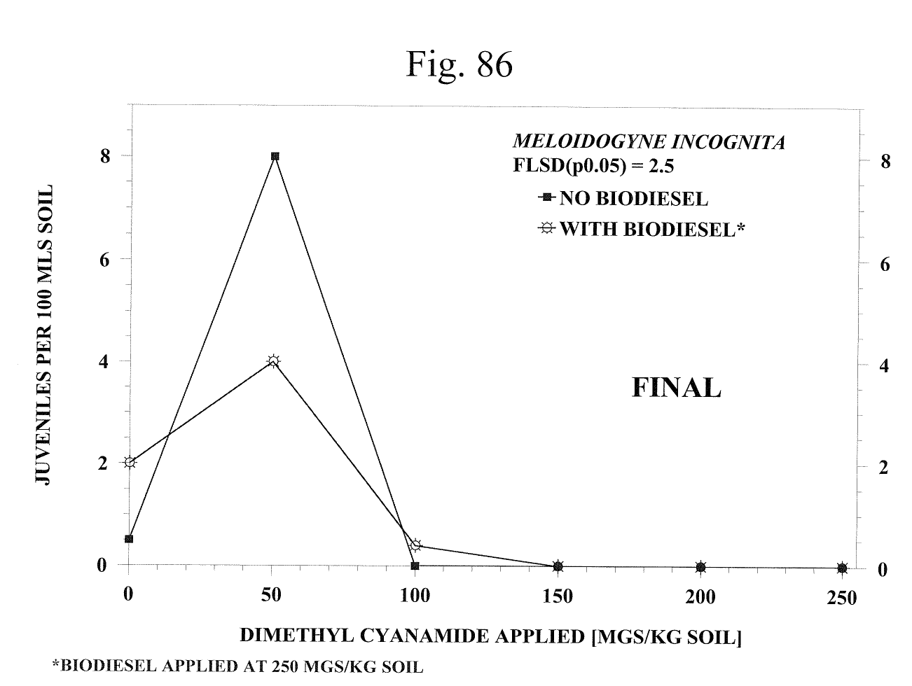

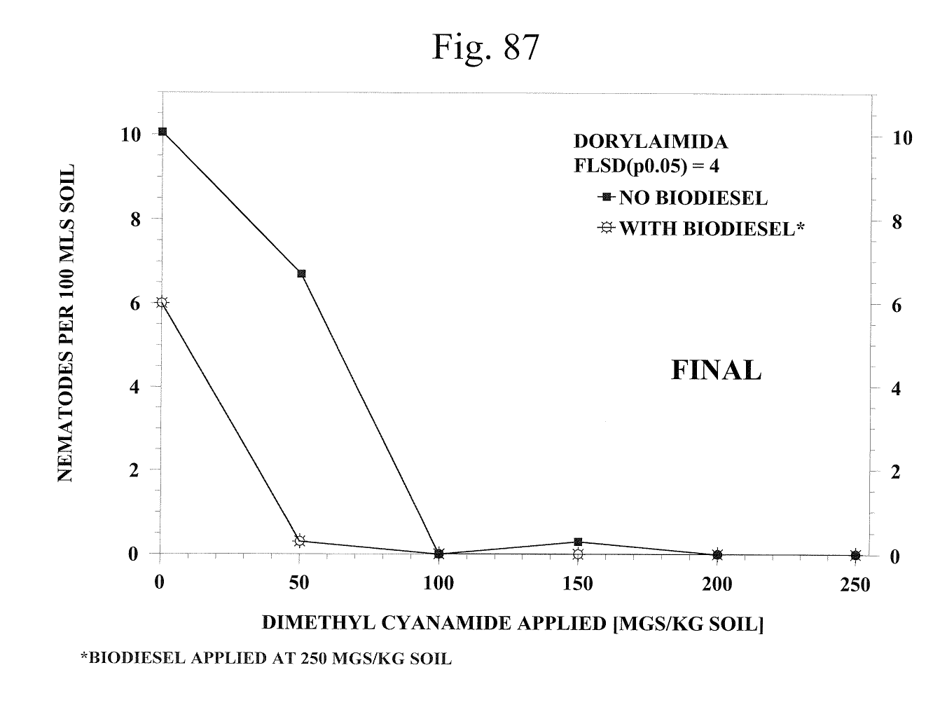

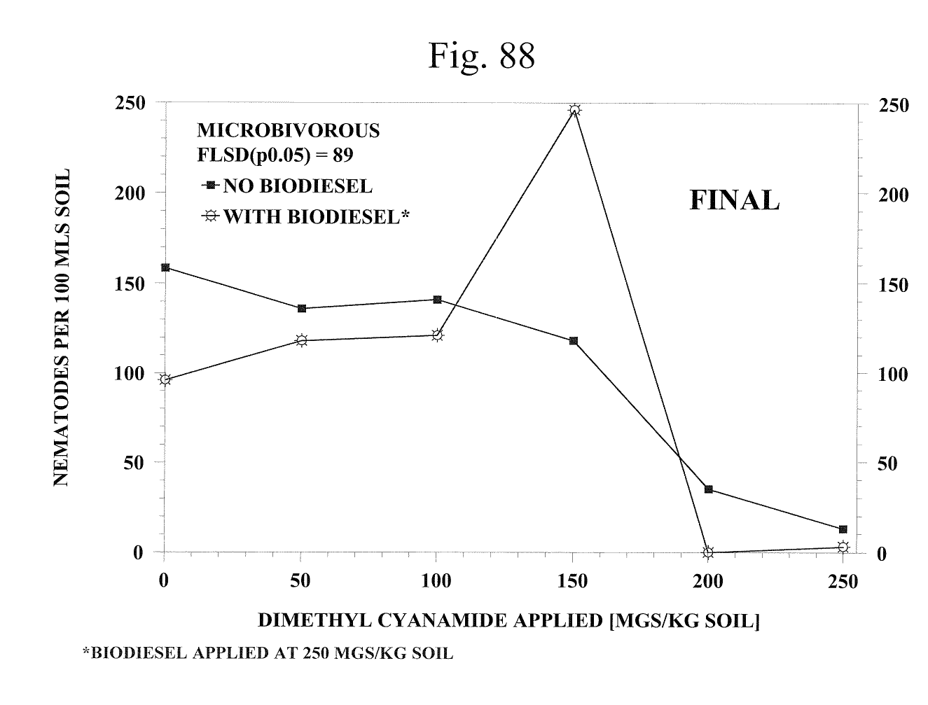

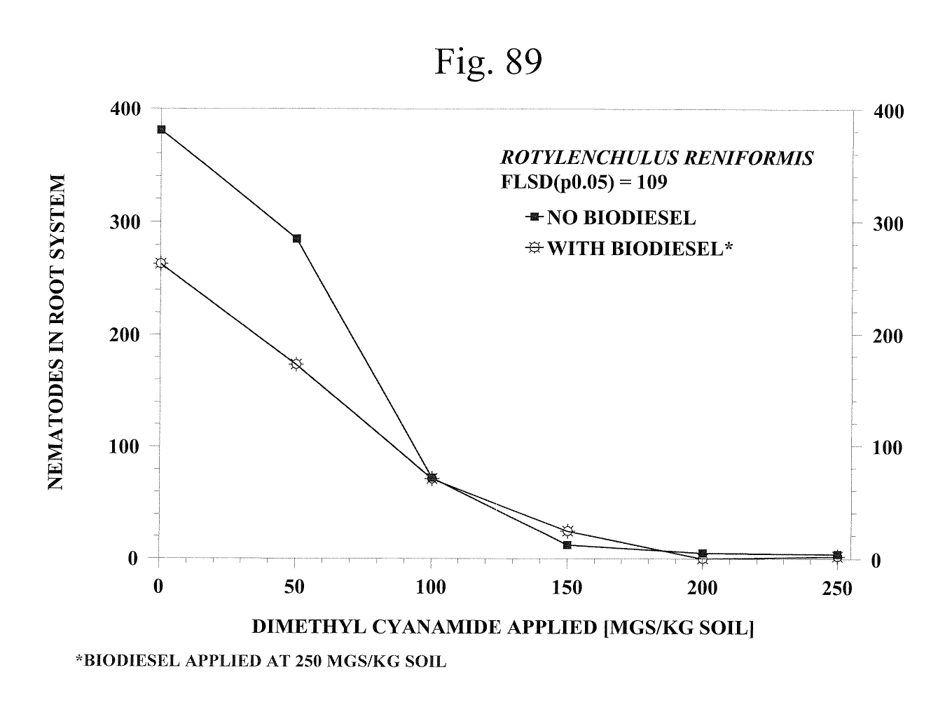

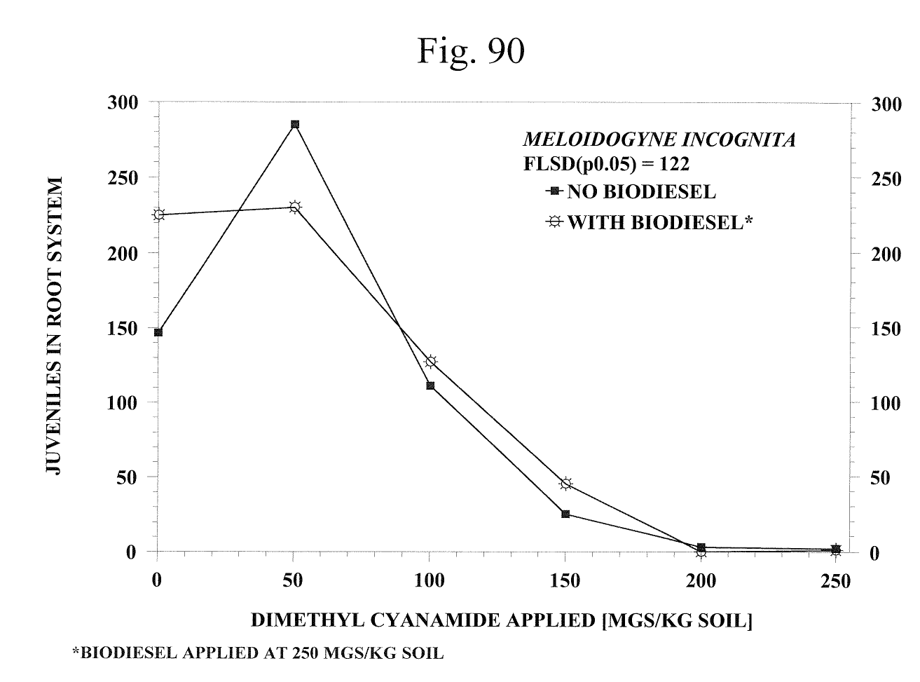

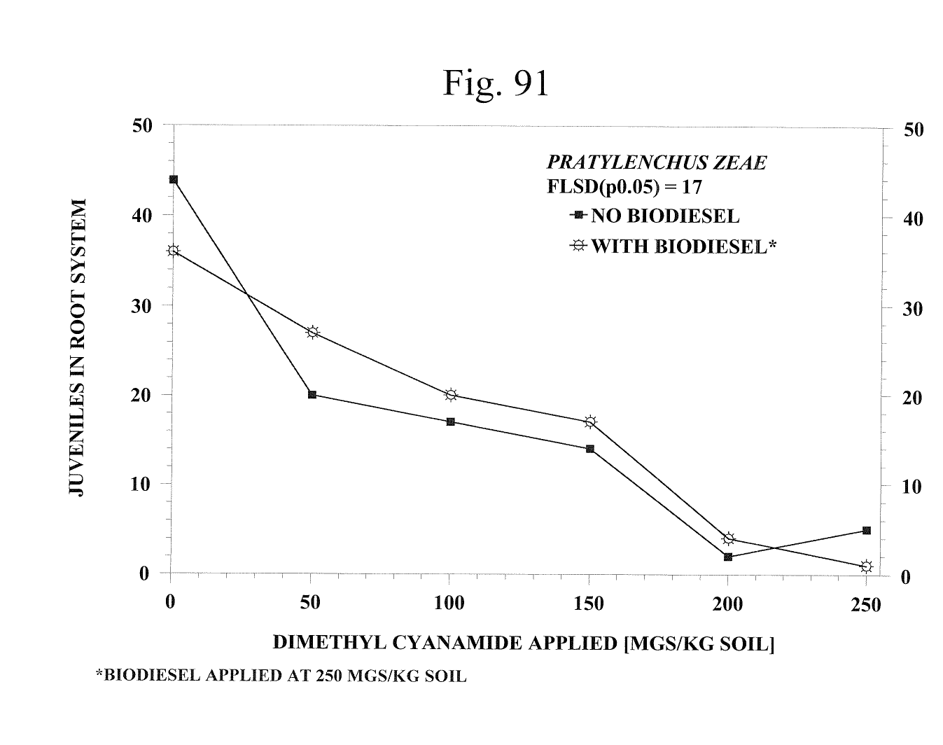

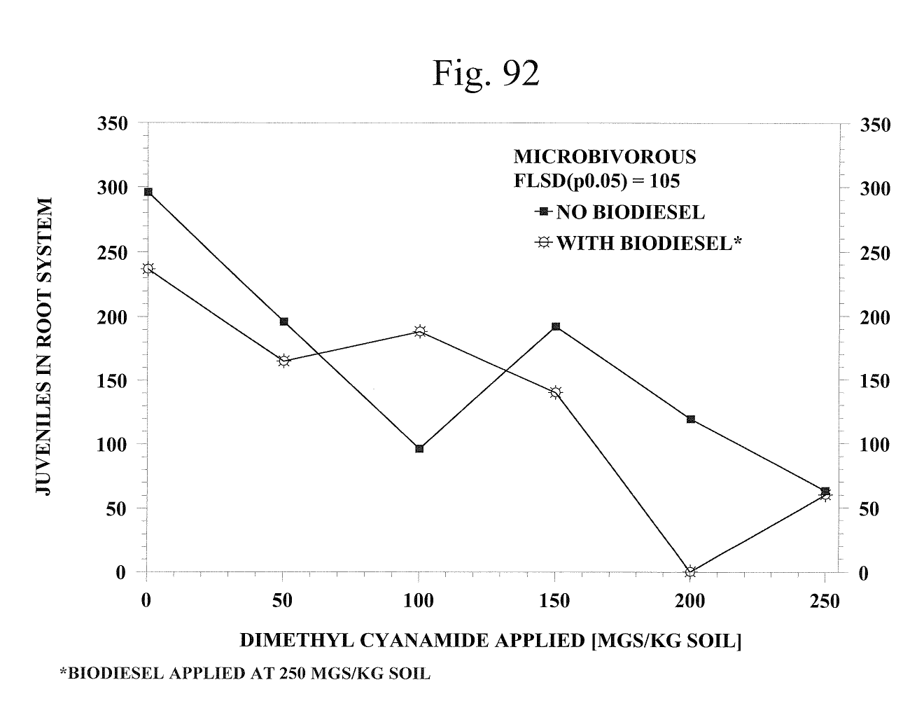

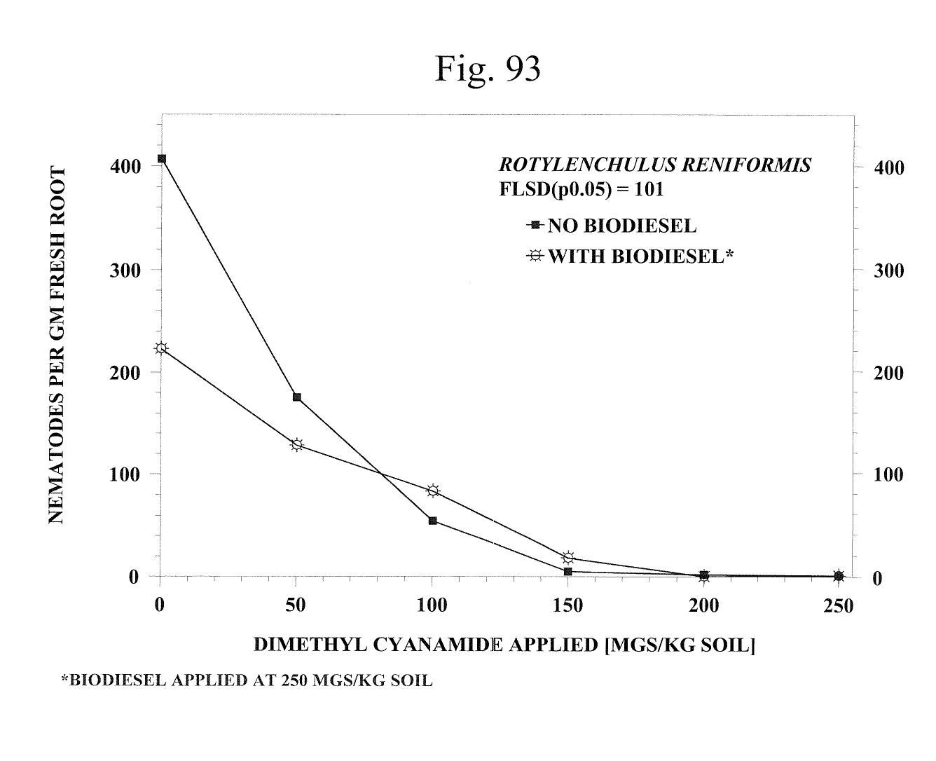

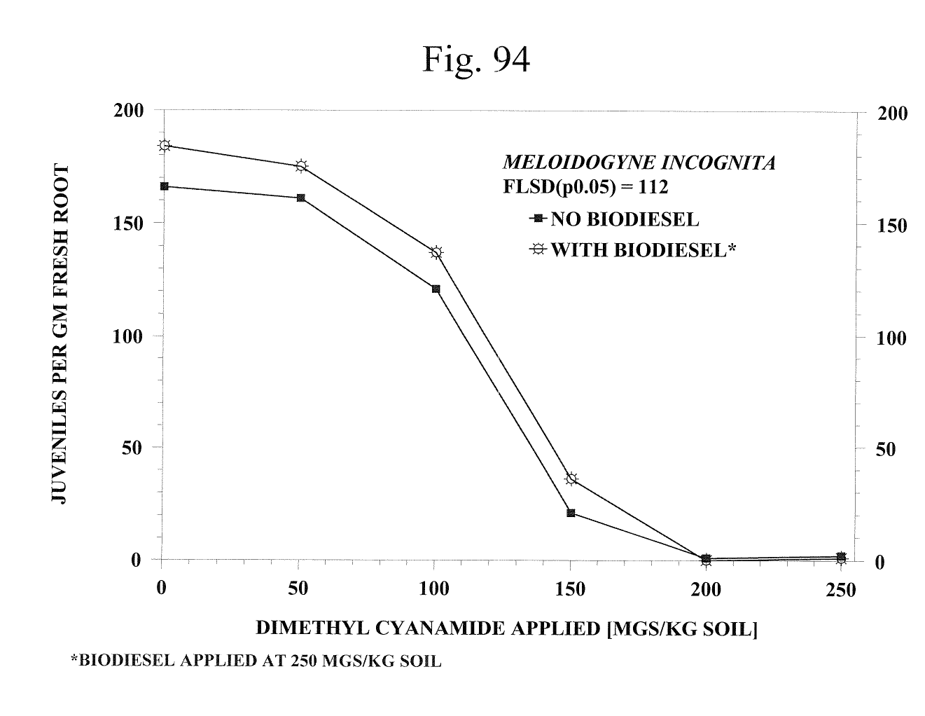

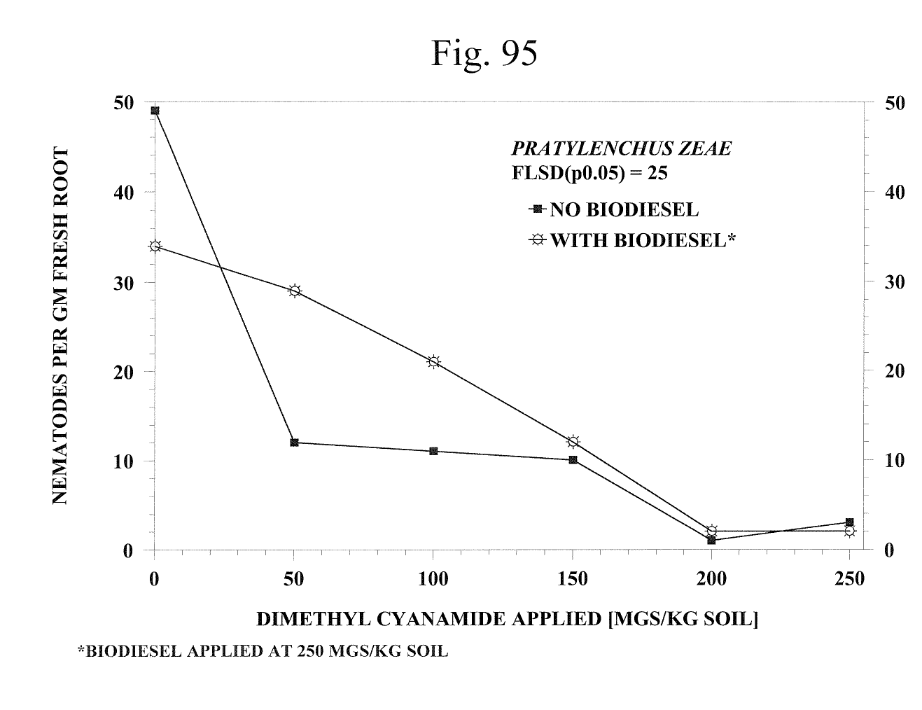

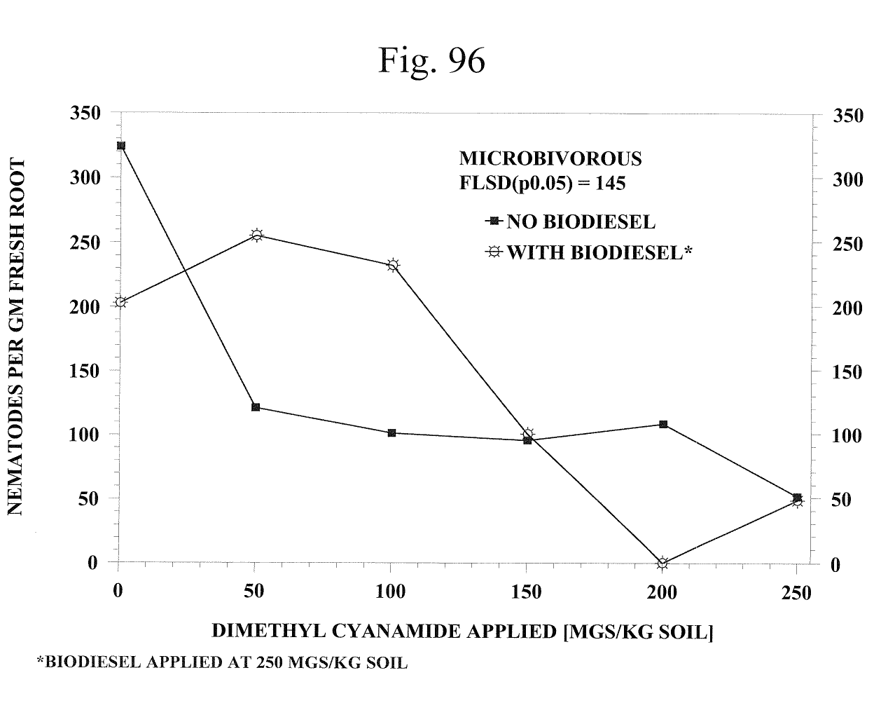

A pre-plant sample of soil was taken and nematodes per 100 mls of soil was determined (FIGS. 74-77). Cucumber seeds were planted in the pots, and the number of cucumber seedlings per pot was determined forty-eight (48) days later (FIG. 78). Shoot height (FIG. 79), shoot weight (FIG. 80), root weight (FIG. 81), root condition (FIG. 82), gall rate (FIG. 83), and galls per root (FIG. 84) also were determined. The number of nematodes per 100 mls of soil and in the root system was determined (FIGS. 85-96).

Nematode Test 55

A hot pepper extract comprising capsaicin was prepared by combining 80-100 ml biodiesel and approximately forty (40) peppers (Capsicum frutescens). The resulting solution was designated “hot pepper extract.” The pepper fruit kept shape and did not break or deliquesce. Extraction was evident based on the extract having a hot pepper smell. A 1% extract emulsion was prepared by combining 10 ml of the extract concentrate and 1 ml of Illovo Mix (emulsifier) in demineralized water with stirring, and bringing the final volume to 1 L.

Soil that was naturally infected with nematodes was combined with sand (1:1) to prepare a soil mixture for testing. One kilogram of the soil mixture was added to seven (7) pots for each test mixture. Testing was performed by drenching soil with 100 mls of test compositions as indicated in Table 6.

TABLE 6

| | Pepper Extract | Biodiesel |
|---|---|---|
| Test | (mls 1% extr/kg soil) | (mg/kg soil) |
| Control | | |
| Pepper | 20 | 200 |
| Extract + | | |
| Biodiesel | | |
| “” | 40 | 400 |
| | 60 | 600 |
| “” | 120 | 1200 |

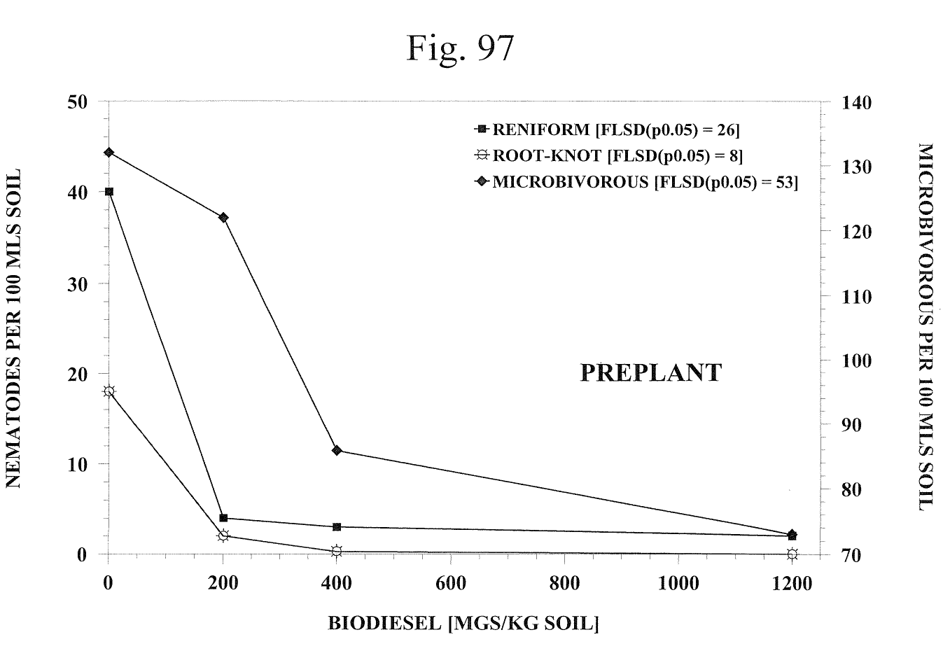

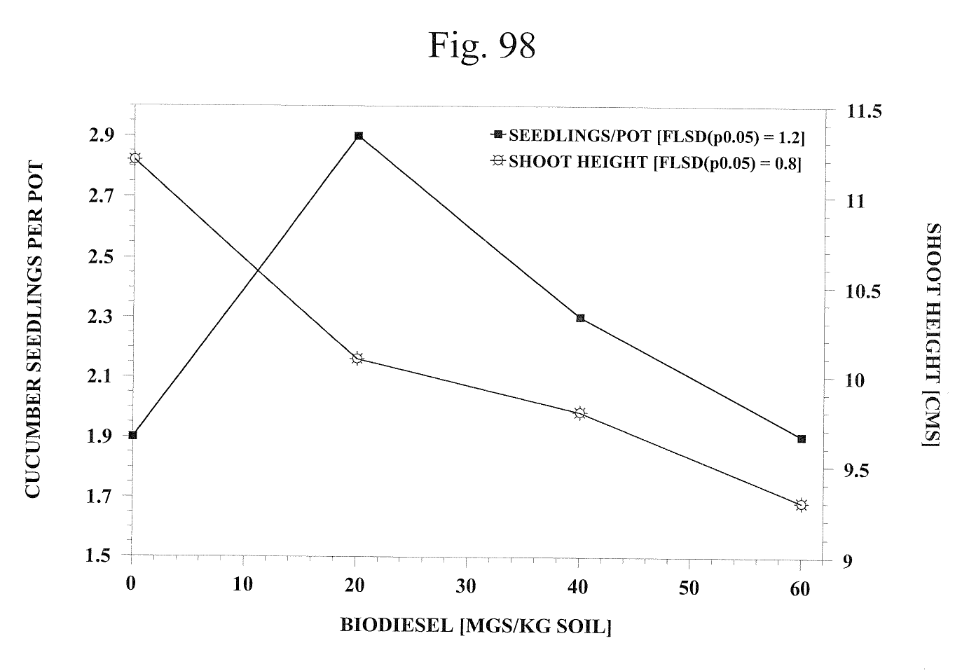

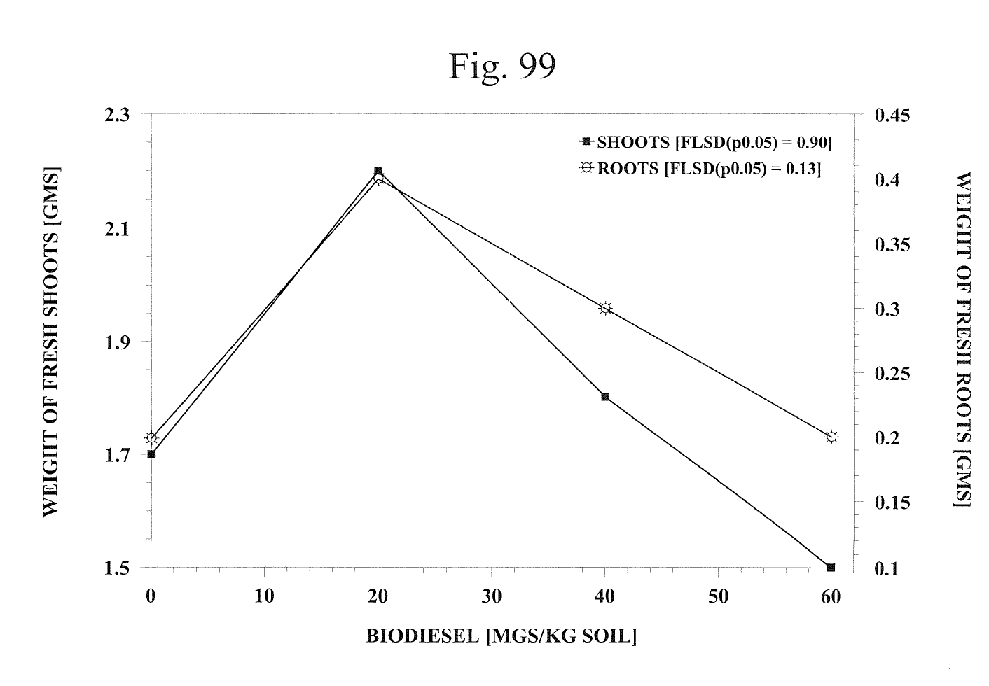

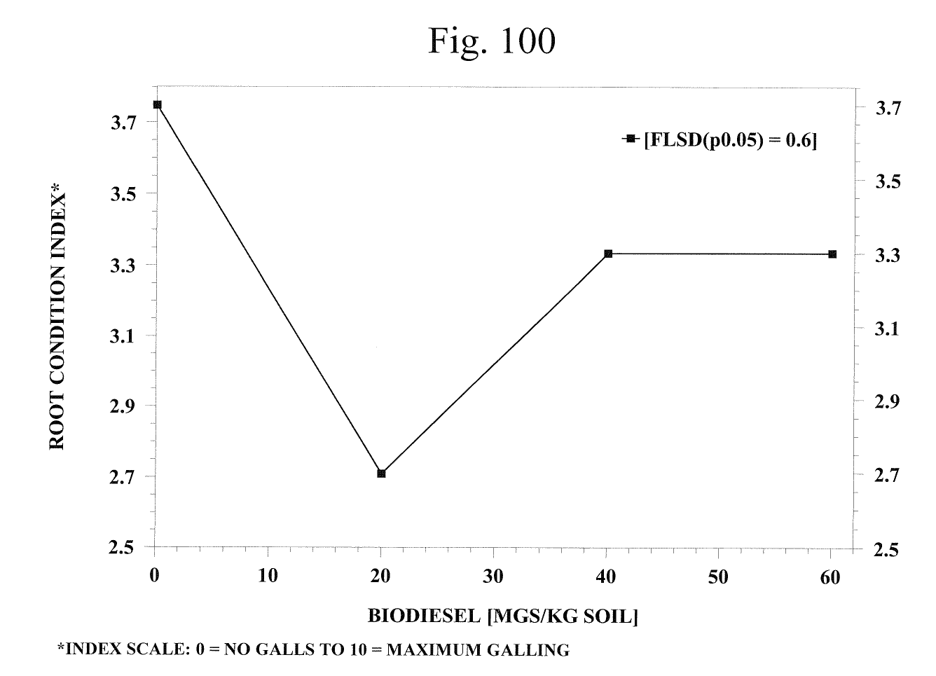

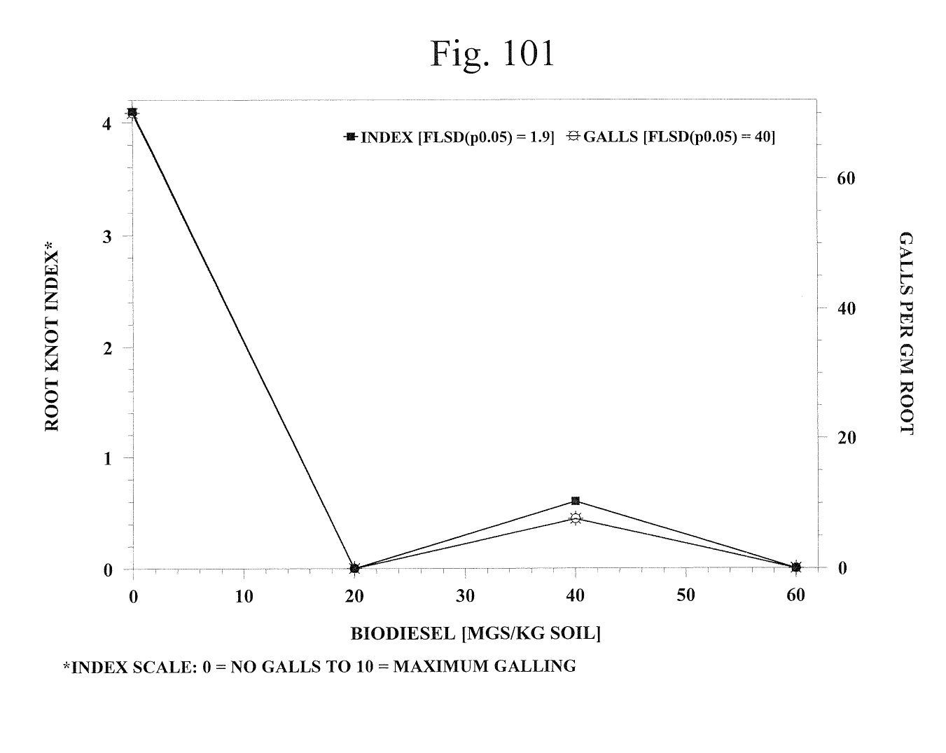

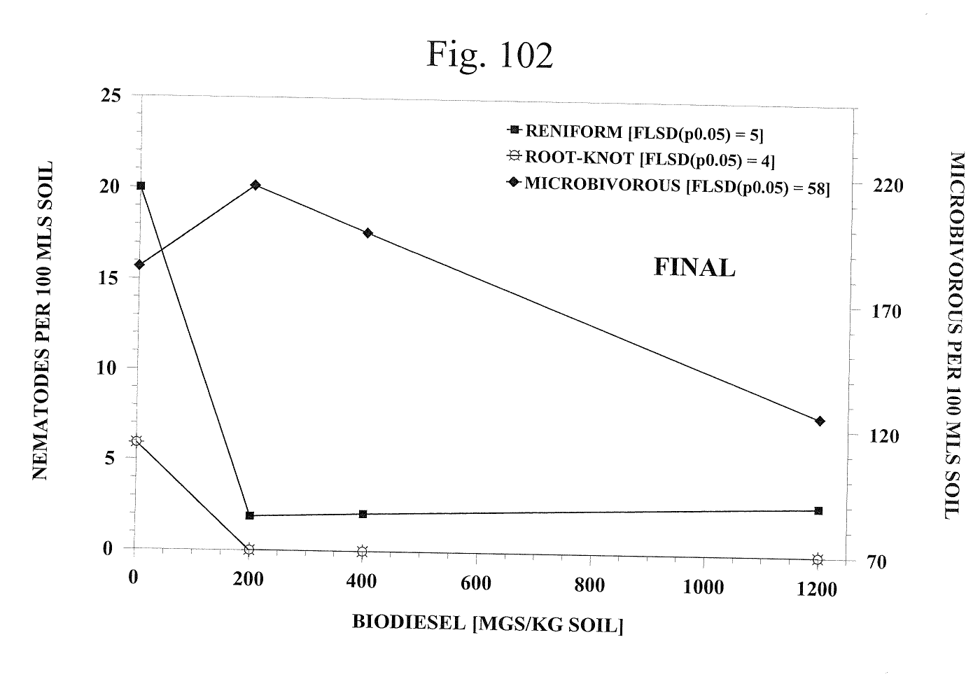

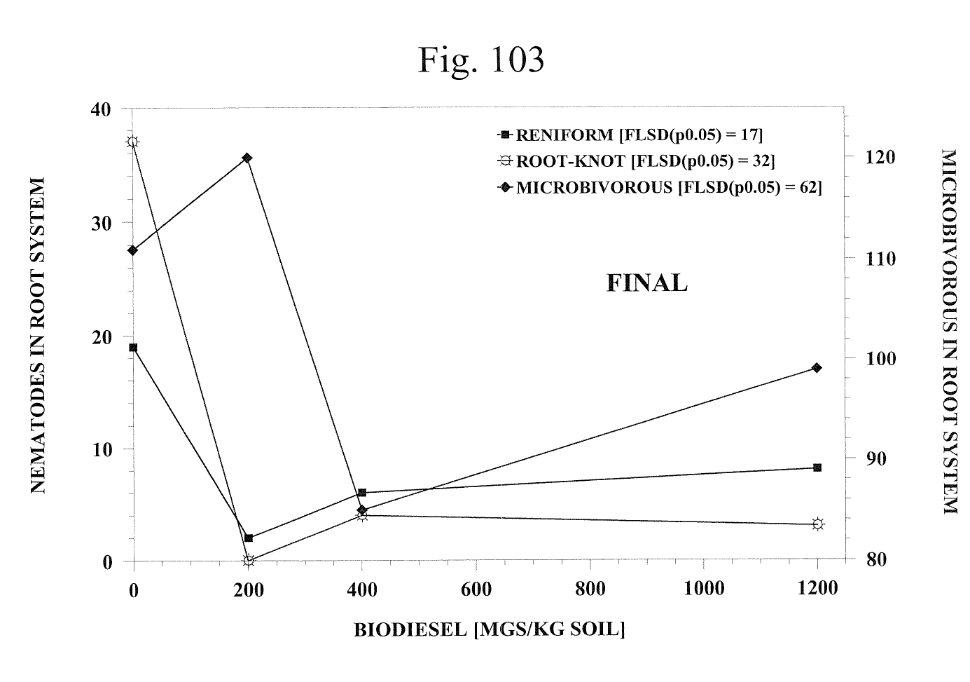

A pre-plant sample of soil was taken and nematodes per 100 mls of soil was determined (FIG. 97). Cucumber seeds were planted in the pots, and the number of cucumber seedlings per pot was determined fifty-four (54) days later (FIG. 98). Shoot weight (FIG. 99), root condition (FIG. 100), root knot index (FIG. 101) also were determined. The number of nematodes per 100 mls of soil and in the root system was determined (FIGS. 102 and 103).

Nematode Test 57

Bomba AAA concentrate is composed of the following components: S-ethyl N,N-dipropylcarbamothioate (EPTC); methyl isothiocyanate (MIT); dimethyl cyanamide (DMC); biodiesel obtained from food-grade soybean oil (BID); and Illovo Mix (emulsifier). Bomba AAA concentrate was prepared by pouring 32.5 g of BID into a 250 ml Erlenmeyer flask followed by 2.5 g emulsifier. After mixing, 12.5 g DMC was added to the Erlenmeyer flask. After further mixing, 5 g of MIT was microwaved until it became molten and was added to the Erlenmeyer flask. The contents of the flask were clear and had a pale yellow color. Next, 0.5 ml of EPTC 7 EC (which is equivalent to 0.420 g of active ingredient (ai) (where 1 ml of EPTC 7 EC=0.840 g ai) was added to the Erlenmeyer flask. Total weight of the Bomba AAA components was 53 g. Weight percentage of the Bomba AAA components was: MIT 9.434%; DMC 23.585%; EPTC 0.792%; emulsifier 4.747%; and BID 61.30%. A 0.5% dilution of Bomba AAA was prepared by diluting 15 ml Bomba AAA concentrate in 3 L demineralized water.

Soil that was naturally infected with nematodes was combined with sand (1:1) to prepare a soil mixture for testing. One kilogram of the soil mixture was added to seven (7) pots for each test mixture. Testing was performed by drenching soil with 100 mls of test compositions as indicated in Table 7.

TABLE 7

| | Bomba AAA | MIT |
|---|---|---|
| Test | (mls 0.5%/kg soil) | (mg/kg soil) |
| Control | | |
| Bomba AAA | 5 | 2.5 |
| “” | 10 | 5 |
| “” | 15 | 7.5 |
| “” | 20 | 10 |
| “” | 25 | 12.5 |
| “” | 30 | 15 |
| “” | 35 | 17.5 |
| “” | 40 | 20 |
| “” | 45 | 22.5 |
| “” | 50 | 25 |
| “” | 55 | 27.5 |
| “” | 60 | 30 |
| Control | | |

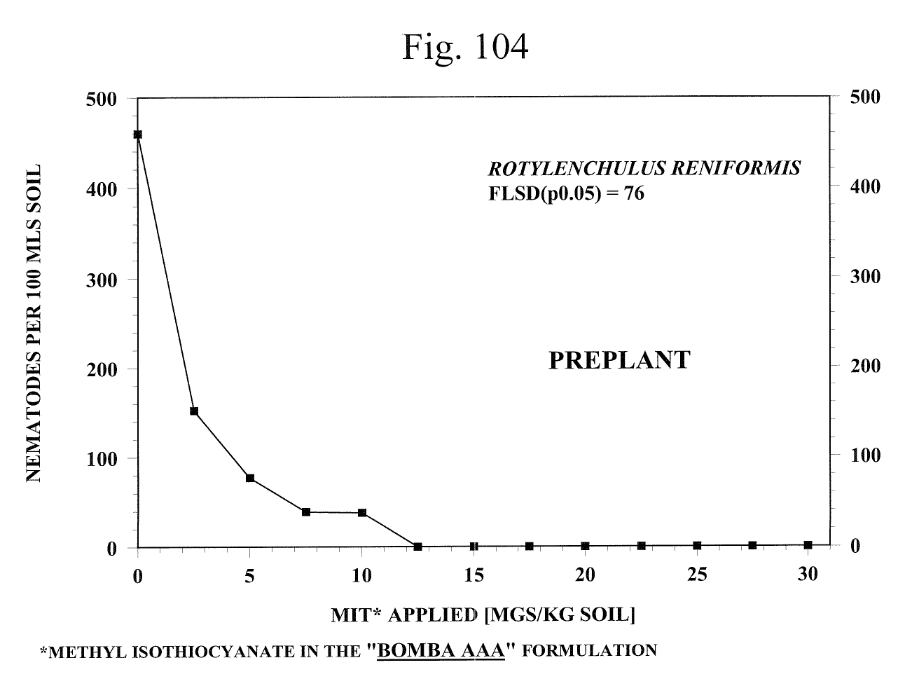

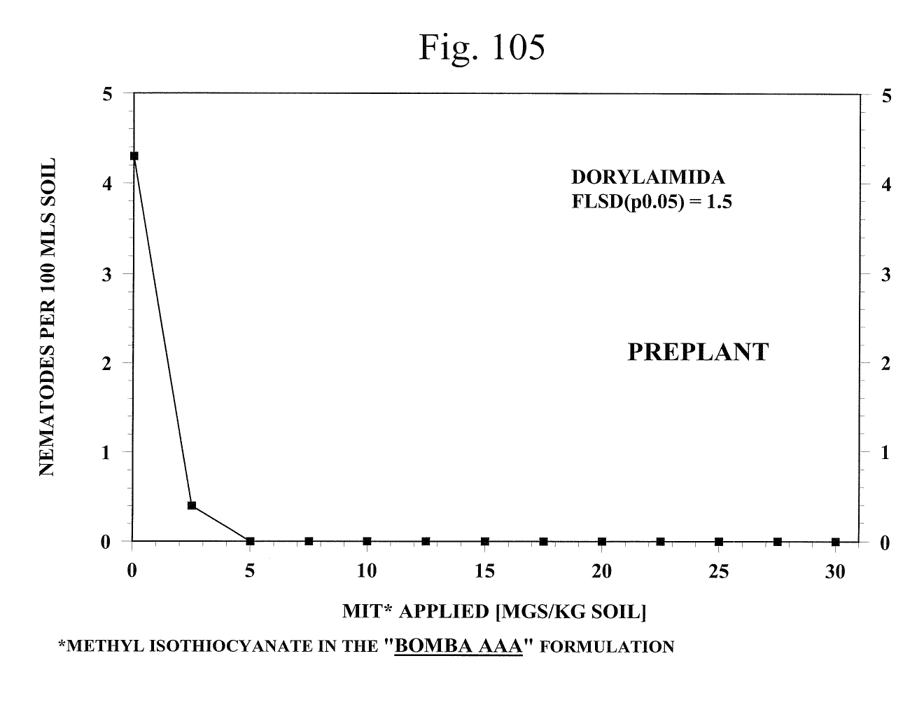

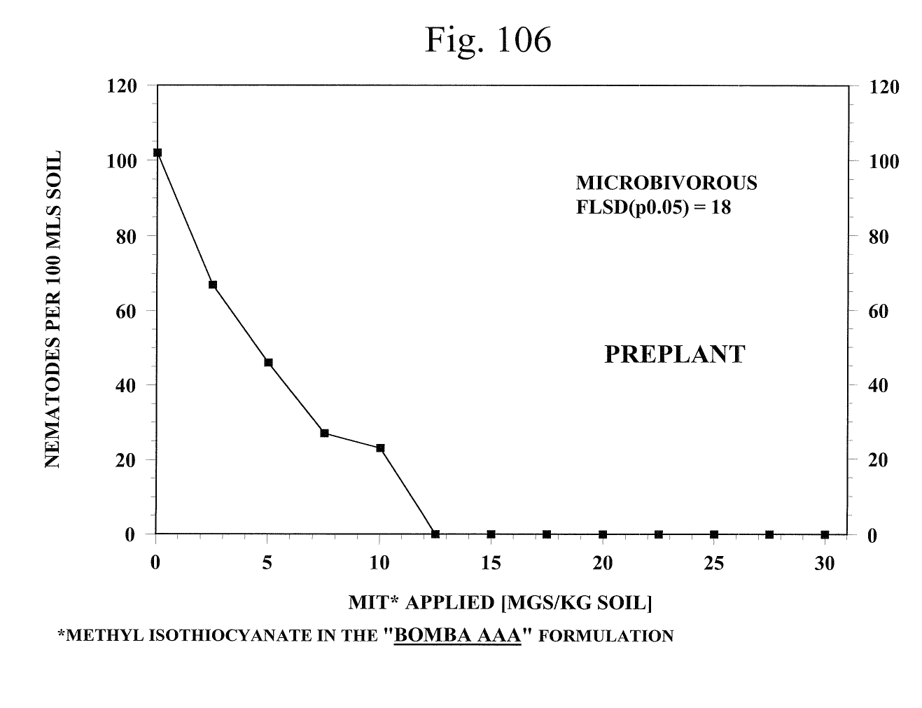

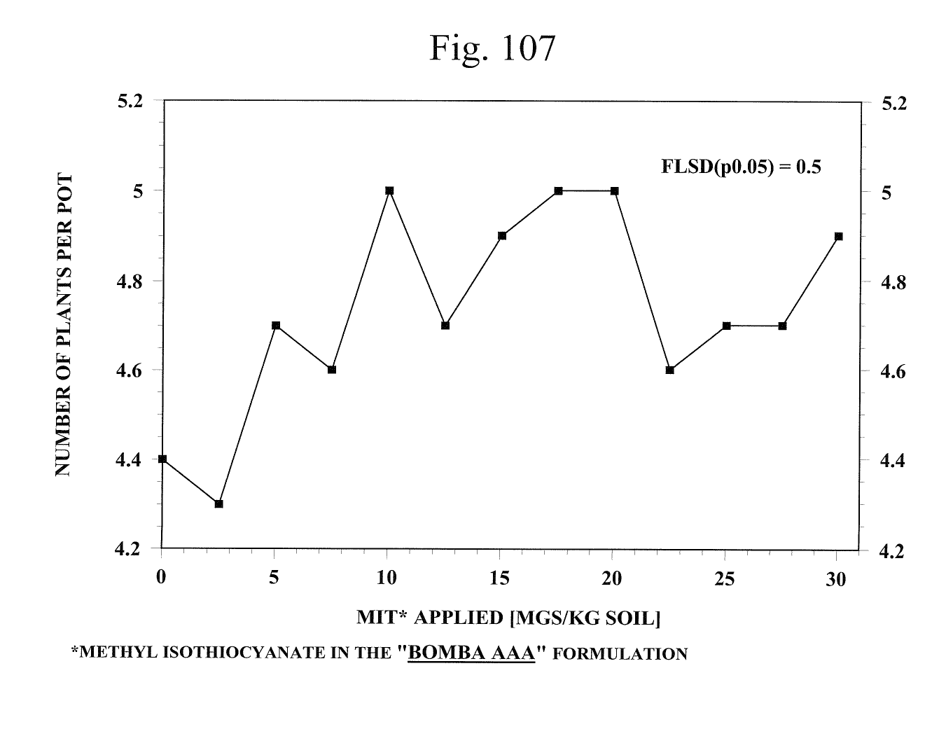

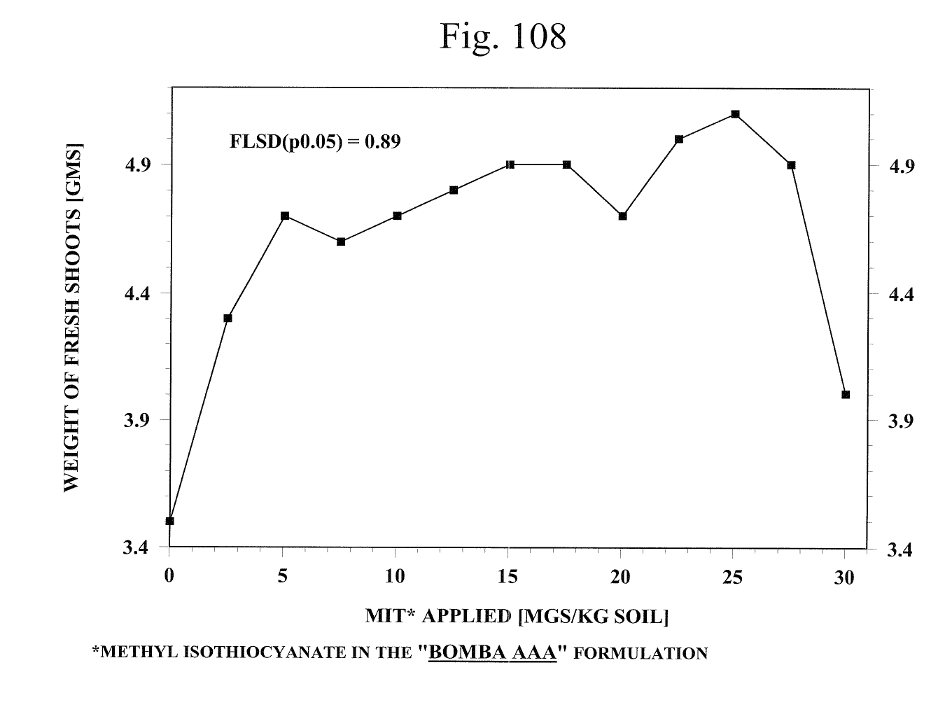

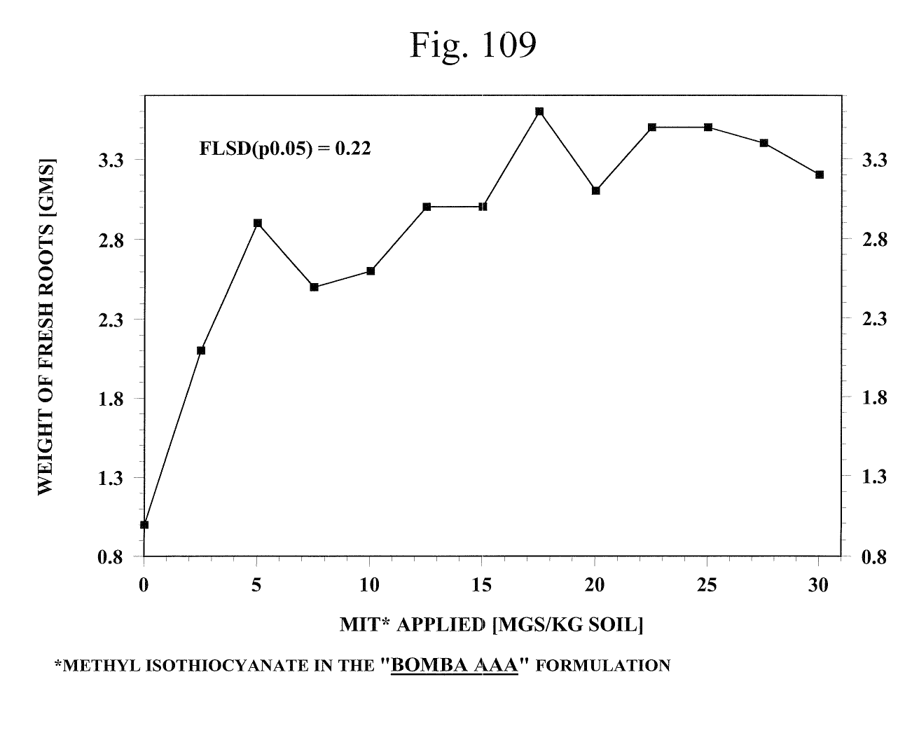

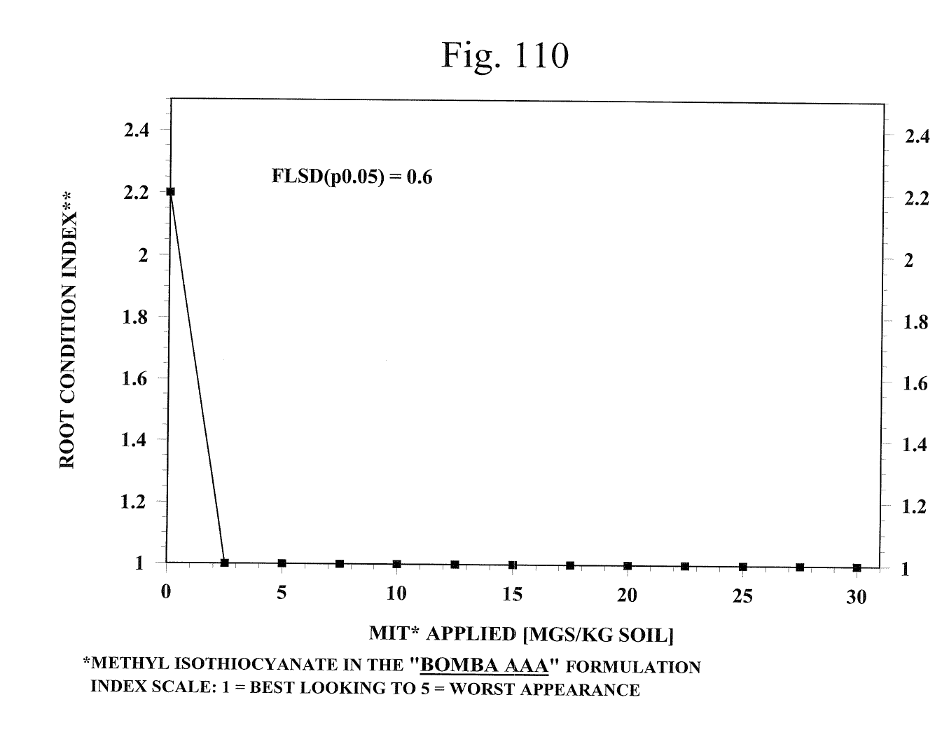

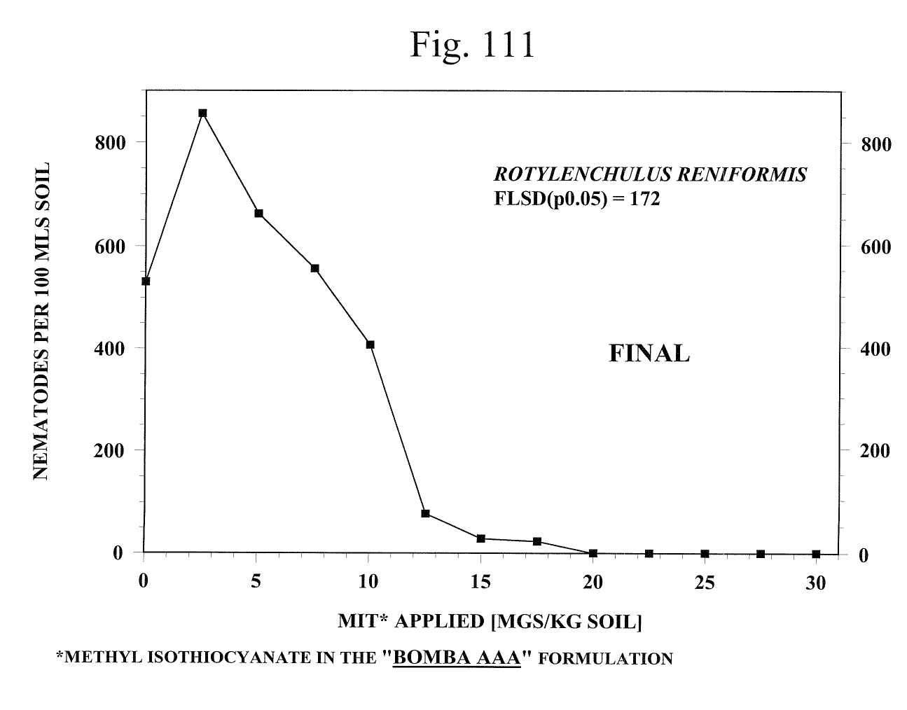

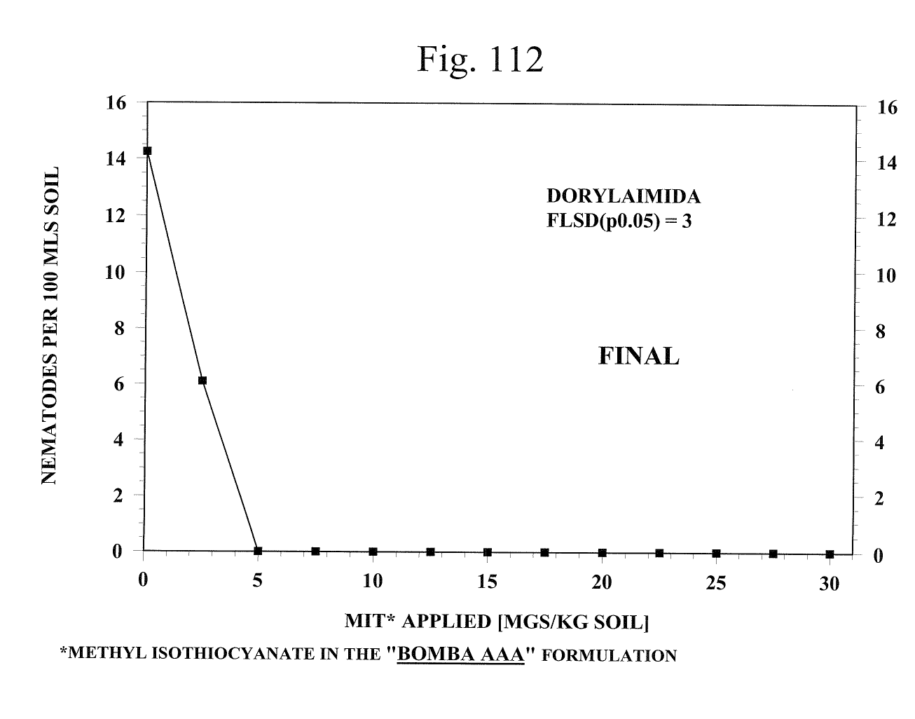

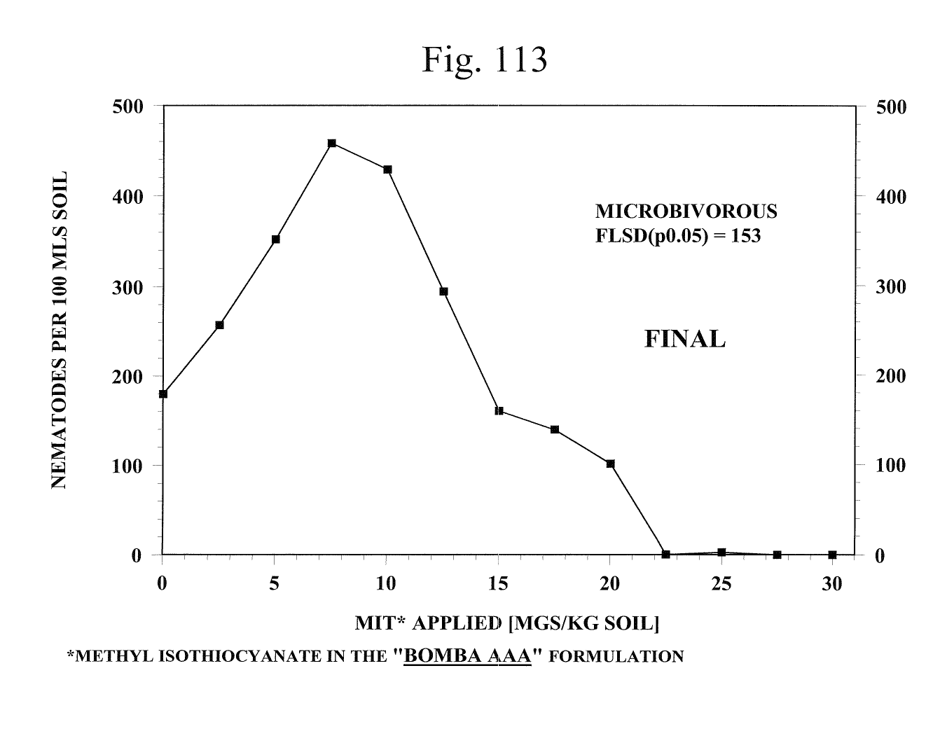

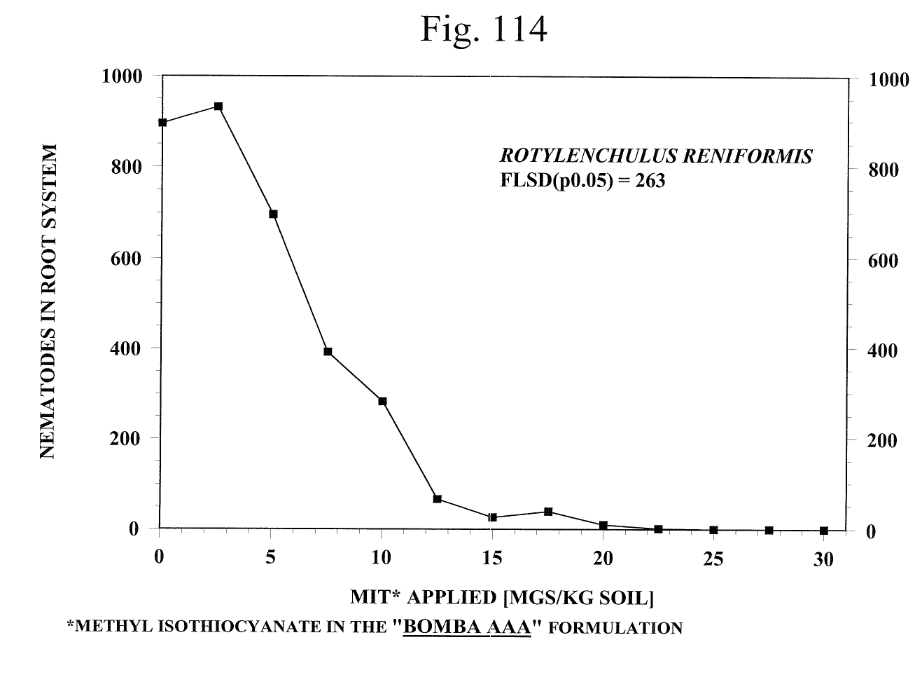

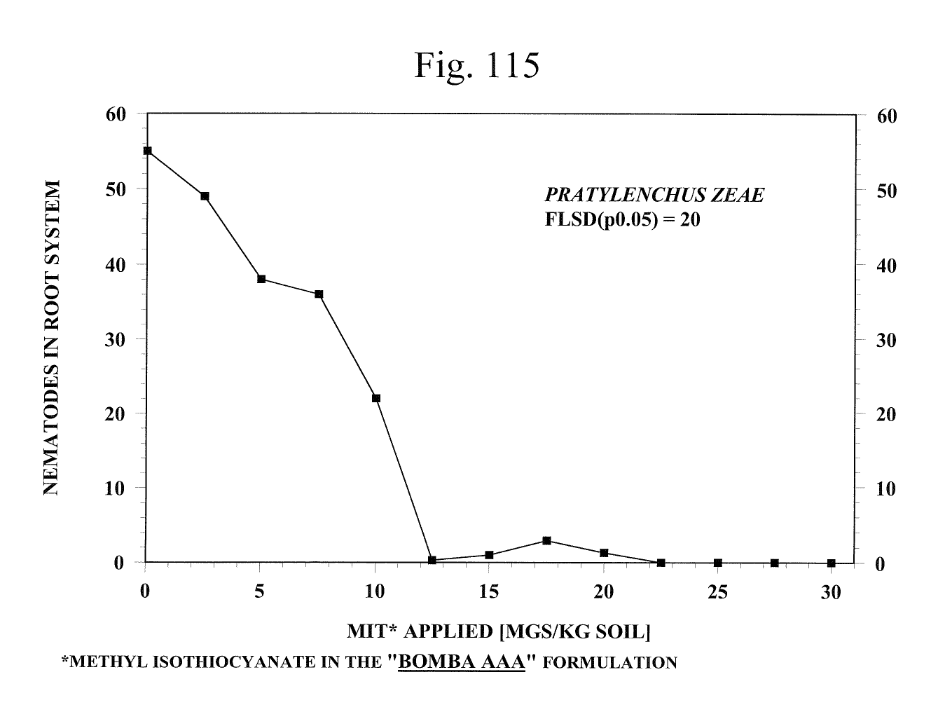

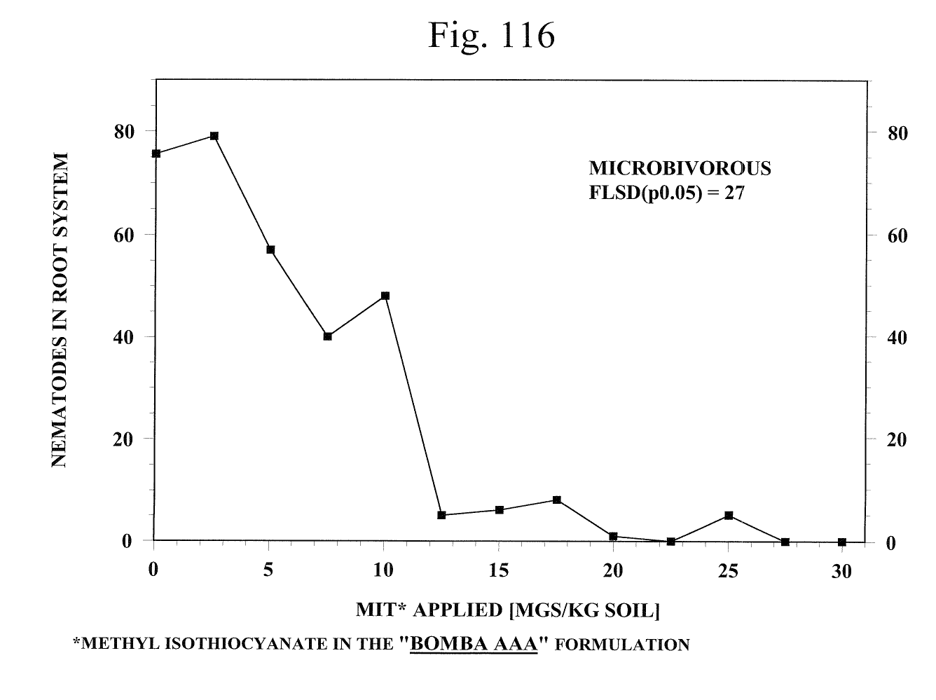

A pre-plant sample of soil was taken and nematodes per 100 mls of soil was determined (FIGS. 104-106). Cucumber seeds were planted in the pots, and the number of cucumber seedlings per pot was determined forty-one (41) days later (FIG. 107). Shoot weight (FIG. 108), root weight (FIG. 109), root condition index (FIG. 110) also were determined. The number of nematodes per 100 mls of soil and in the root system was determined (FIGS. 111-116).

Nematode Test 58

A 2% dimethyl formamide composition was prepared by adding 40 g DMF to demineralized water and bringing the final volume to 2 L. A 5% biodiesel composition was prepared by adding 50 g biodiesel, 3 mls of Illovo Mix (emulsifier), and bringing the final volume to 1 L with demineralized water.

Soil that was naturally infected with nematodes was combined with sand (1:1) to prepare a soil mixture for testing. One kilogram of the soil mixture was added to seven (7) pots for each test mixture. Testing was performed by drenching soil with 100 mls of test compositions as indicated in Table 8.

TABLE 8

| | DMF | | Biodiesel | |
|---|---|---|---|---|
| | (mls 1% emul/ | DMF | (mls 5% sol/kg | Biodiesel |
| Test | kg soil) | (mg/kg soil) | soil) | (mg/kg soil) |
| Control | | | | |
| DMF | 5 | 100 | 0 | 0 |
| “” | 10 | 200 | 0 | 0 |
| “” | 15 | 300 | 0 | 0 |
| “” | 20 | 400 | 0 | 0 |
| “” | 25 | 500 | 0 | 0 |
| DMF + | 5 | 100 | 5 | 250 |
| Biodiesel | | | | |
| “” | 10 | 200 | 5 | 250 |
| “” | 15 | 300 | 5 | 250 |
| “” | 20 | 400 | 5 | 250 |
| “” | 25 | 500 | 5 | 250 |
| Biodiesel | 0 | 0 | 5 | 250 |
| Biodiesel | 0 | 0 | 10 | 500 |
| Control | | | | |
| Sand | | | | |

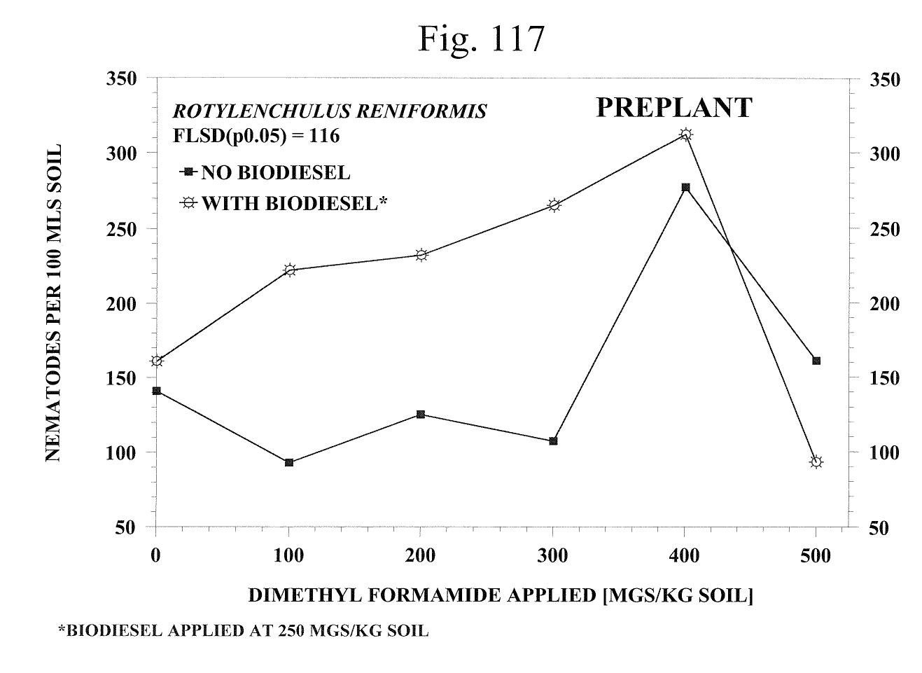

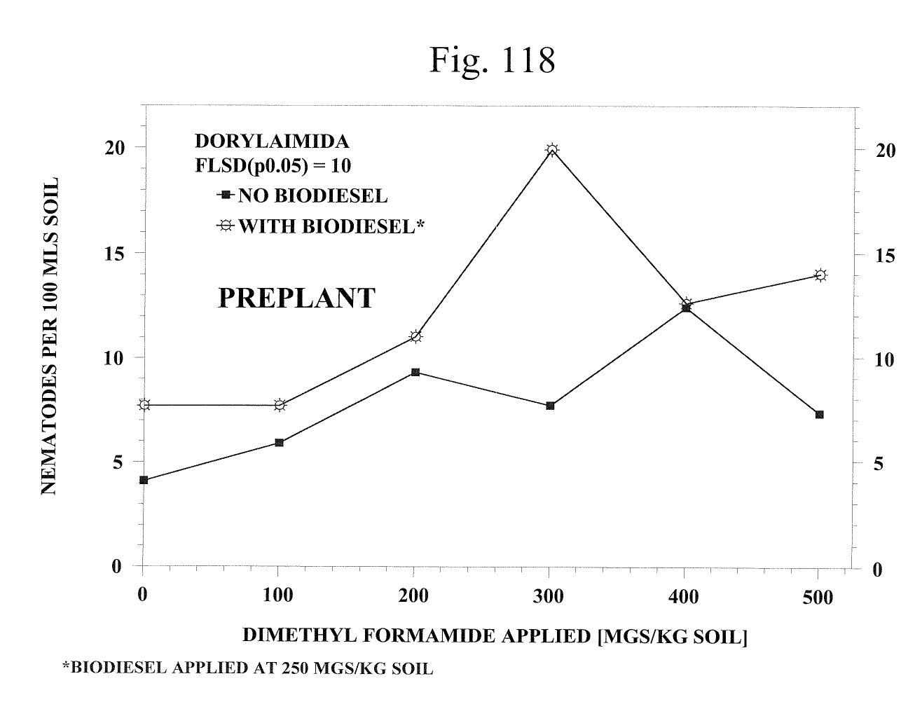

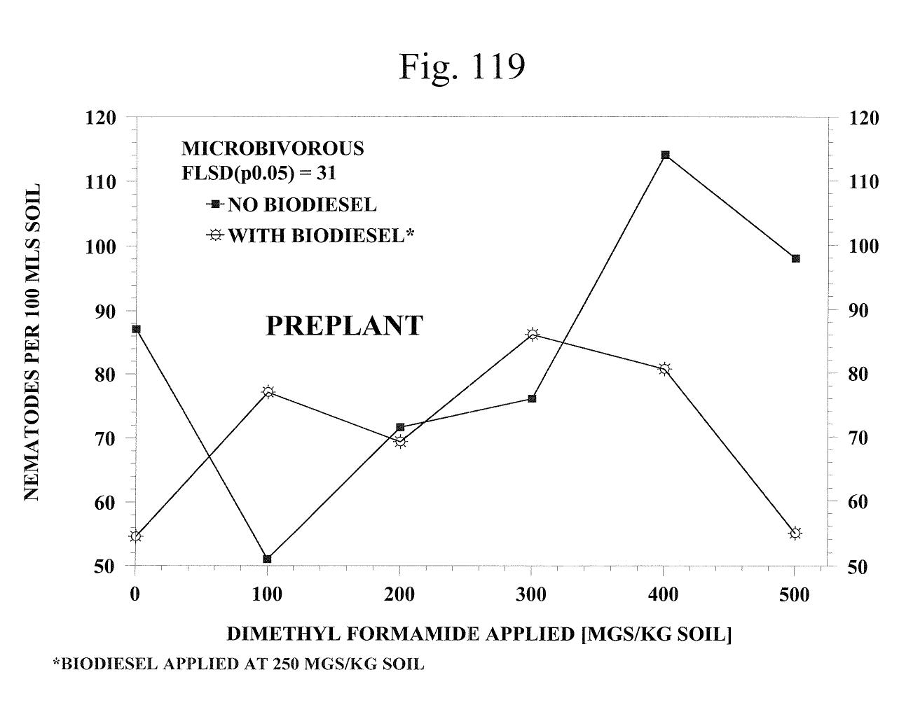

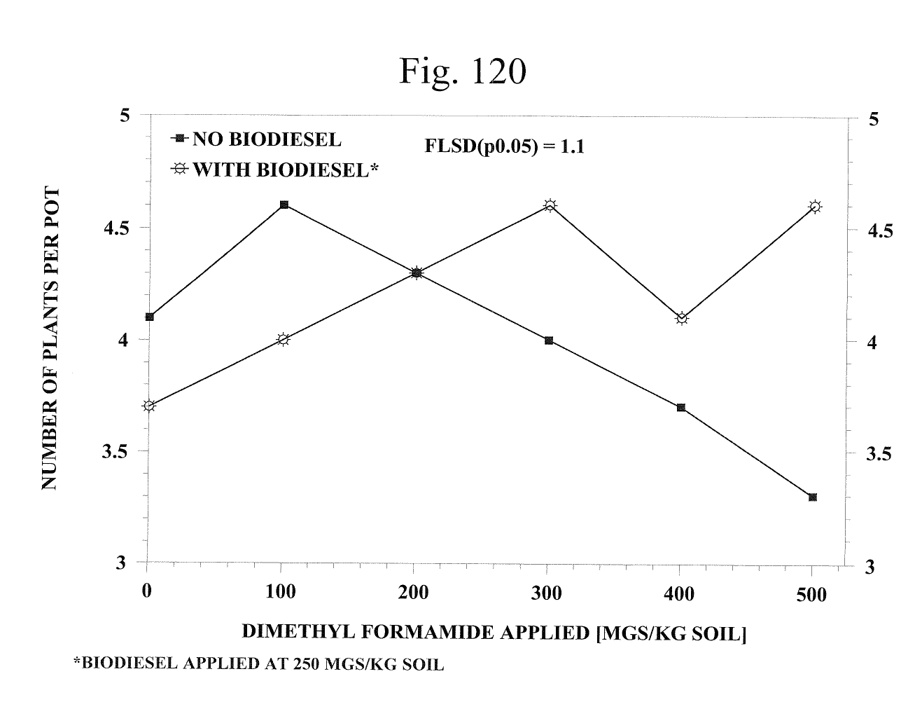

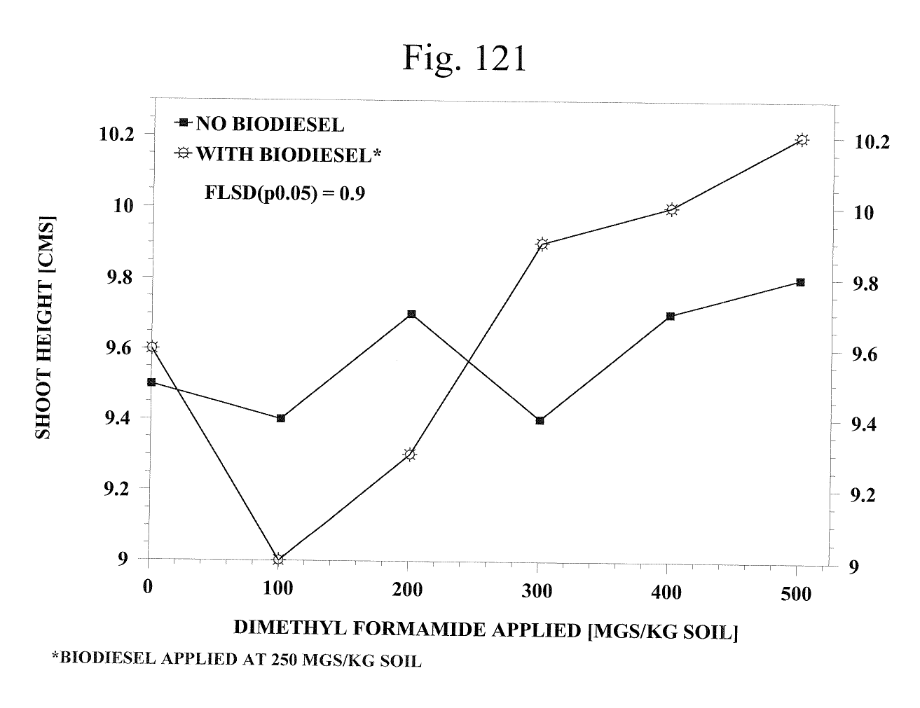

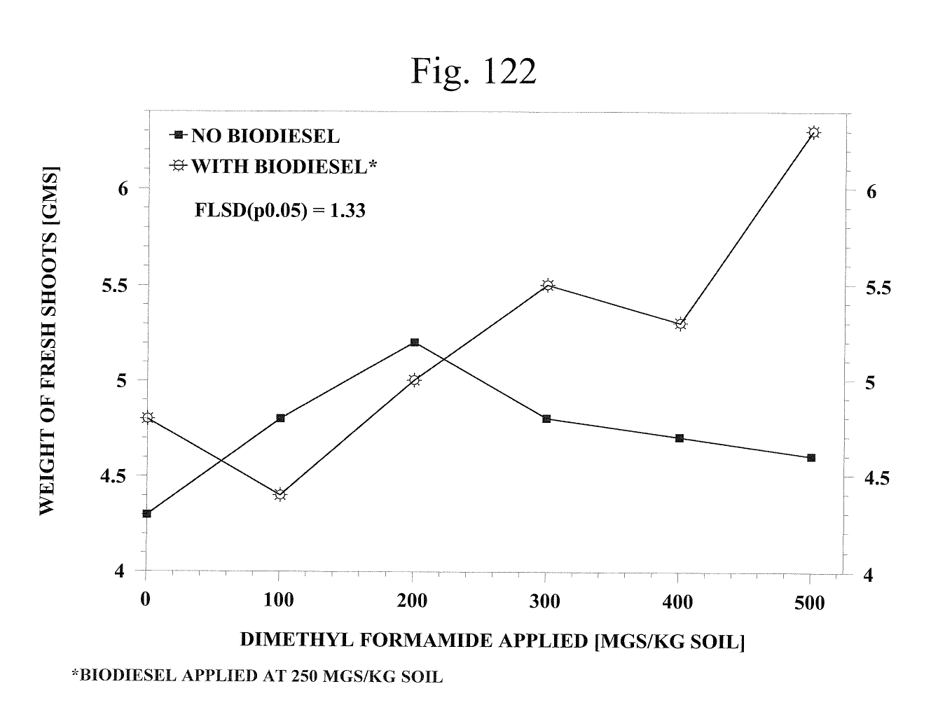

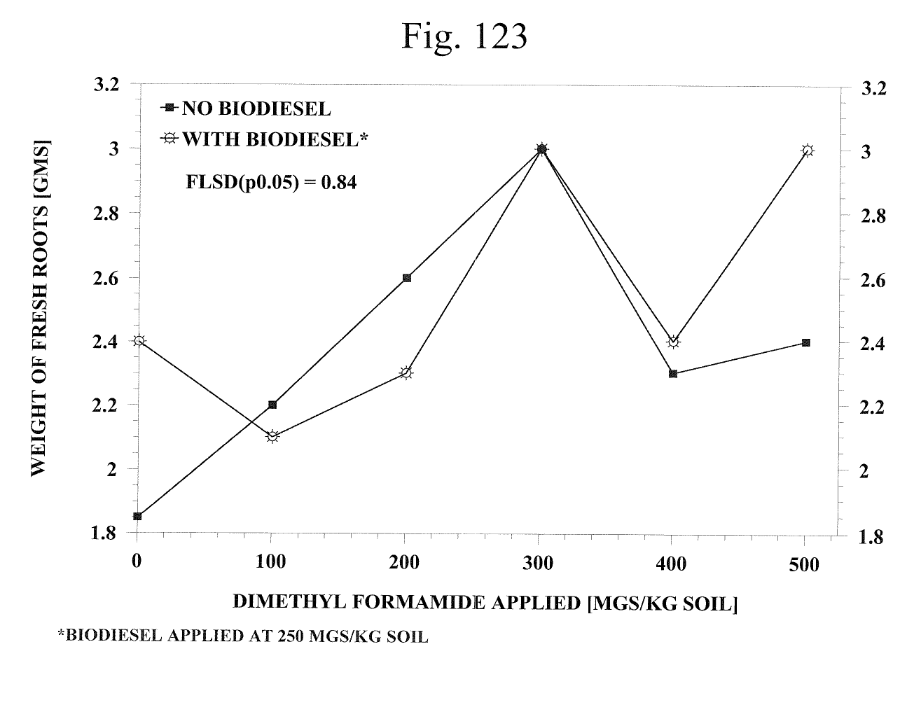

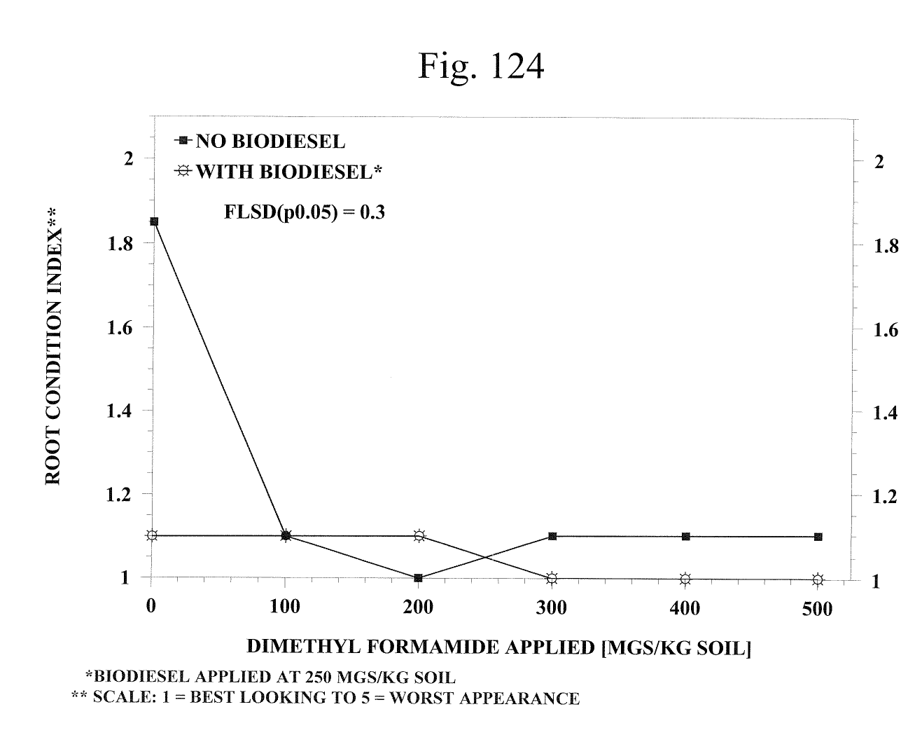

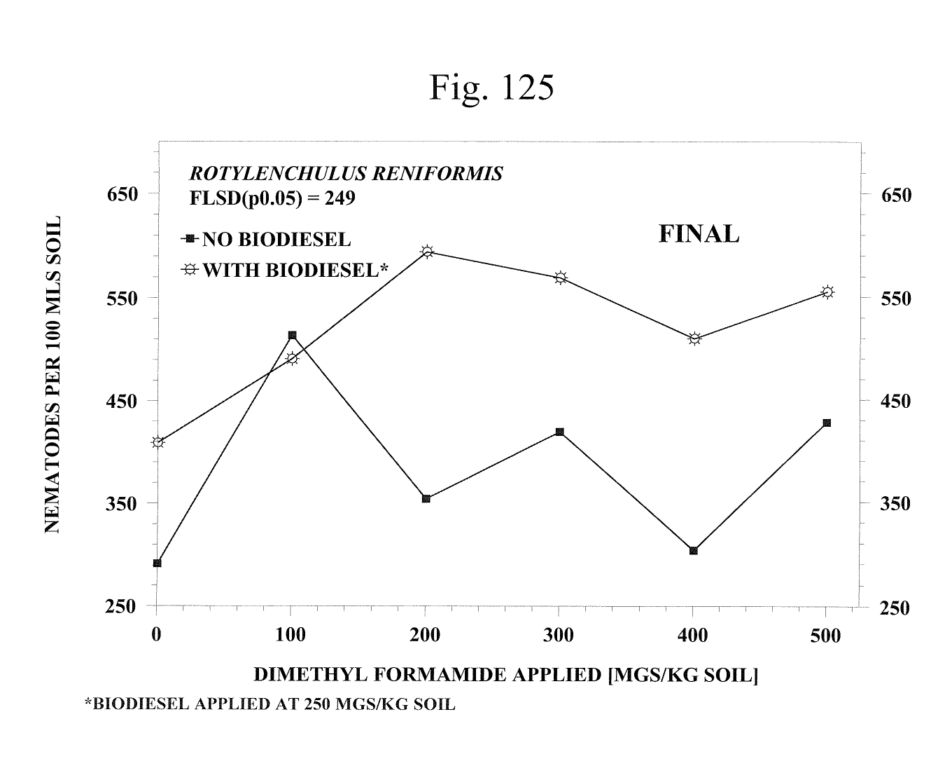

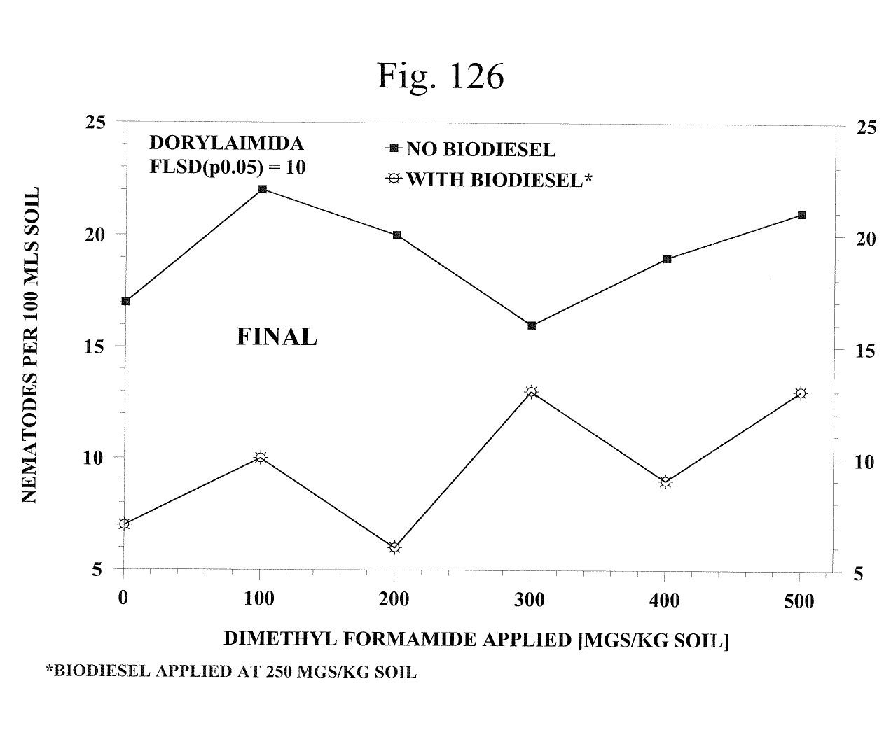

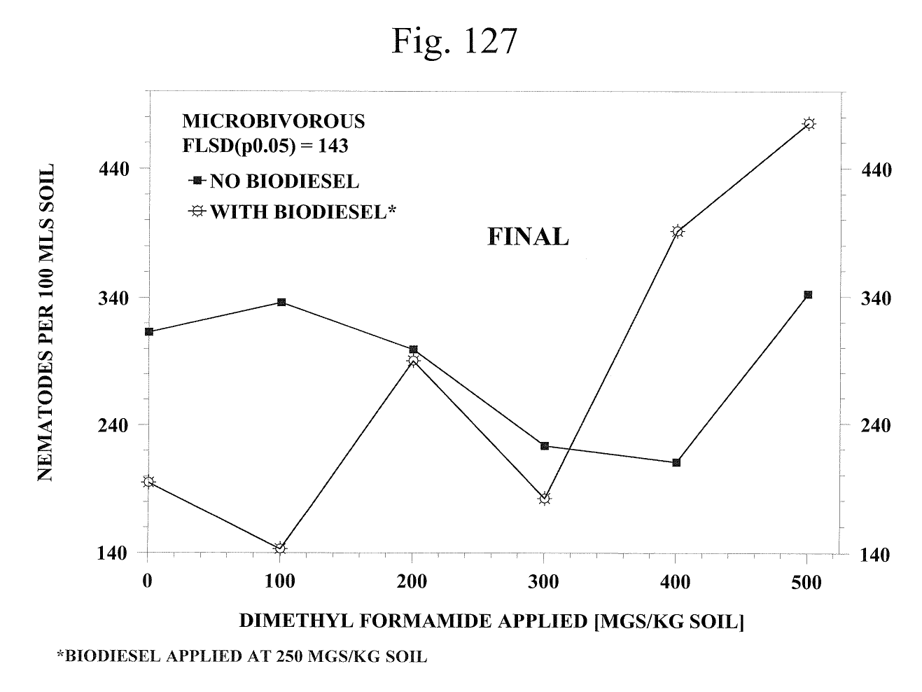

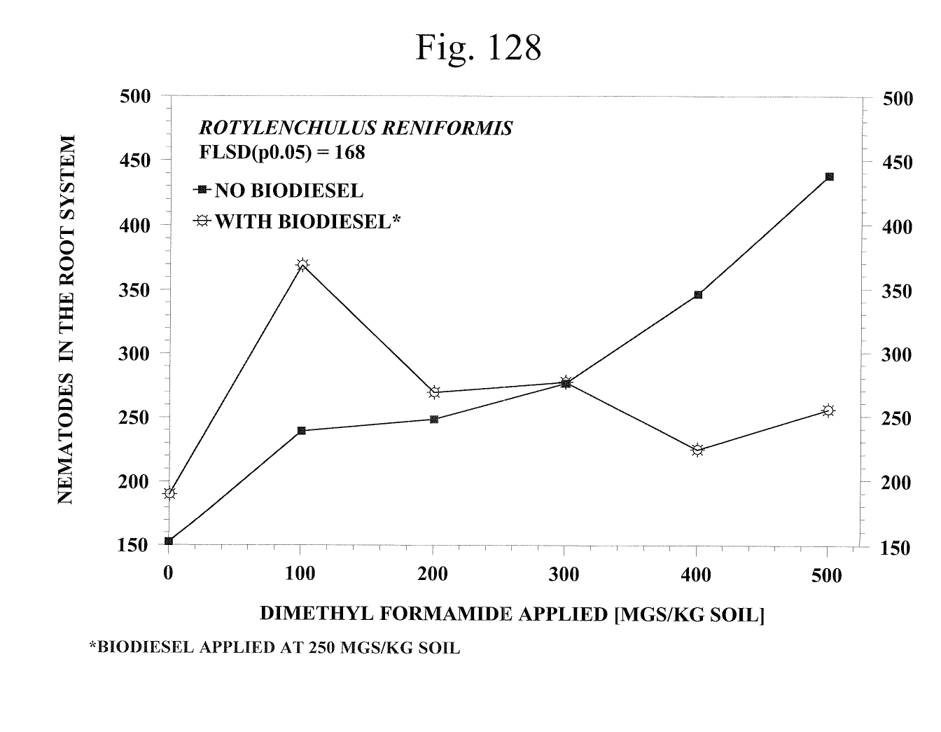

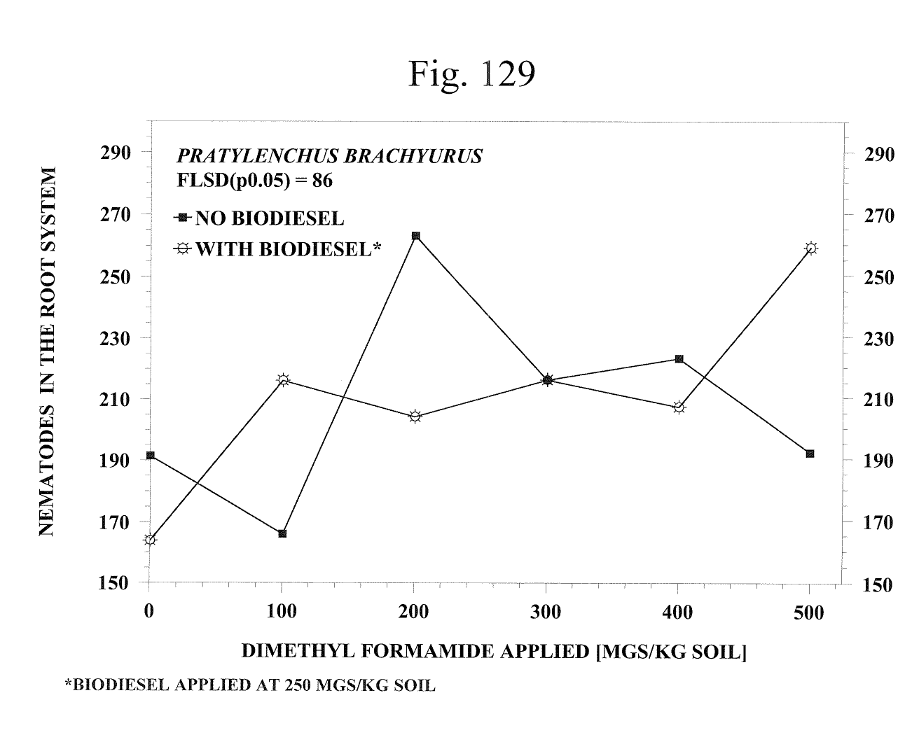

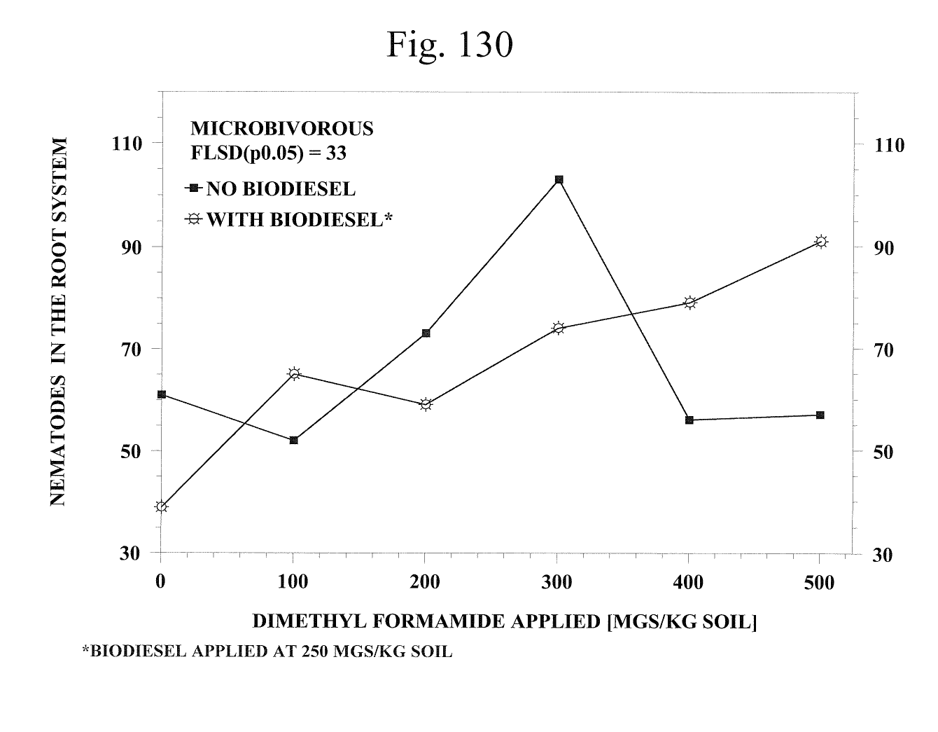

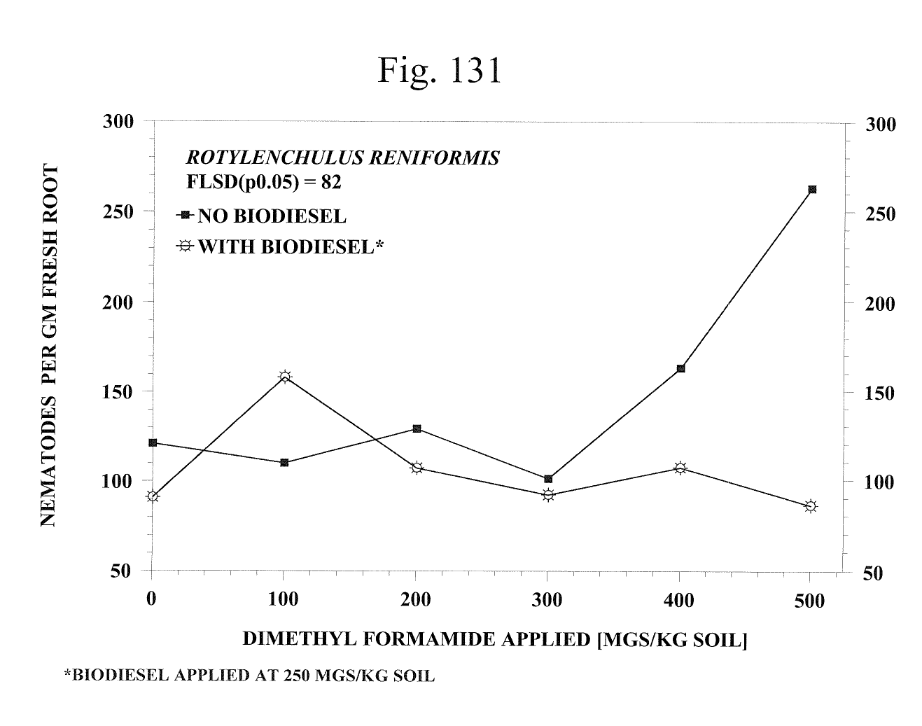

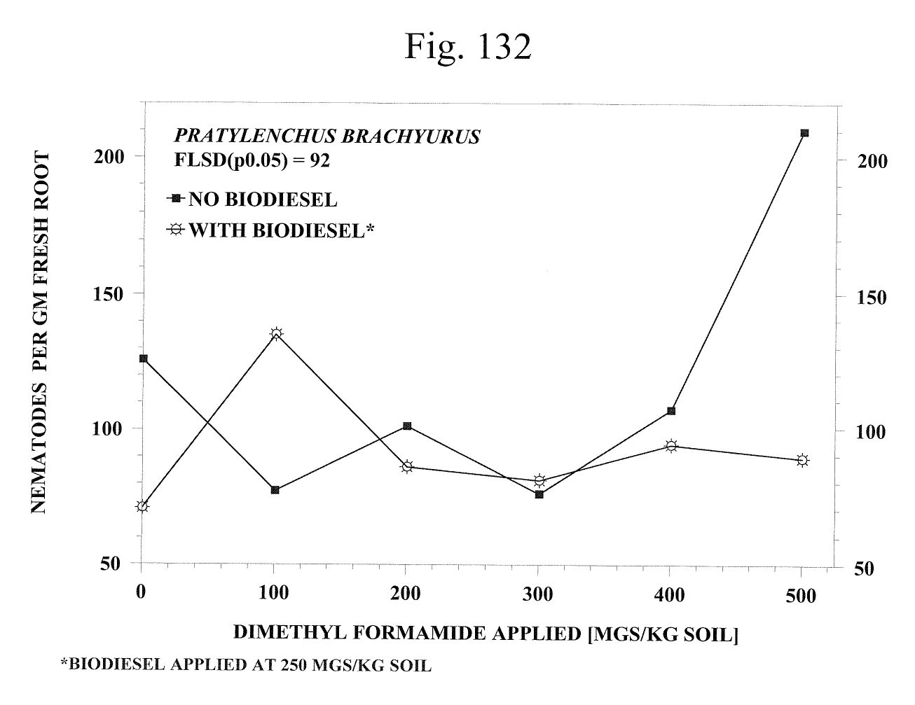

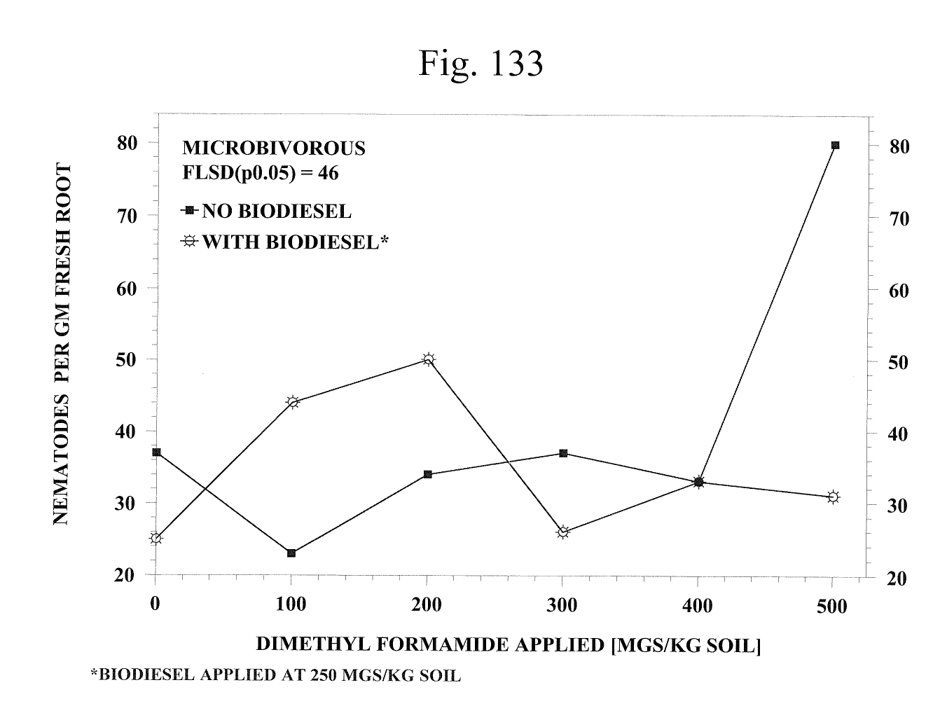

A pre-plant sample of soil was taken and nematodes per 100 mls of soil was determined (FIGS. 117-119). Cucumber seeds were planted in the pots, and the number of cucumber seedlings per pot was determined fifty-five (55) days later (FIG. 120). Shoot height (FIG. 121), shoot weight (FIG. 122), root weight (FIG. 123), root condition index (FIG. 124) also were determined. The number of nematodes per 100 mls of soil and in the root system was determined (FIGS. 125-133).

Nematode Test 62

A 1% acrolein composition was prepared by adding 10 ml of acrolein to demineralized water and bringing the final volume to 1 L with stirring. A biodiesel solution was prepared by adding 20 mls of acrolein to 200 ml of biodiesel with swirling. The mixture was cloudy and was allowed to sit overnight. Next, 10 ml of Illovo Mix (emulsifier) was added and the mixture became clear. Next, 115 mls of the mixture with emulsifier was mixed with 885 mls of demineralized water to obtain a final volume of 1 L having 1% acrolein.

Soil that was naturally infected with nematodes was combined with sand (1:1) to prepare a soil mixture for testing. One kilogram of the soil mixture was added to seven (7) pots for each test mixture. Testing was performed by drenching soil with 100 mls of test compositions as indicated in Table 9.

TABLE 9

| | Acrolein | Acrolein |
|---|---|---|
| Test | (mls 1%/kg soil) | (mg/kg soil) |
| Control | | |
| Acrolein | 1 | 10 |
| “” | 2 | 20 |
| “” | 4 | 40 |
| “” | 6 | 60 |
| “” | 8 | 80 |
| “” | 10 | 100 |
| Acrolein + | 1 | 10 |
| Biodiesel | | |
| “” | 2 | 20 |
| “” | 4 | 40 |
| “” | 6 | 60 |
| “” | 8 | 80 |
| “” | 10 | 100 |
| Control | | |

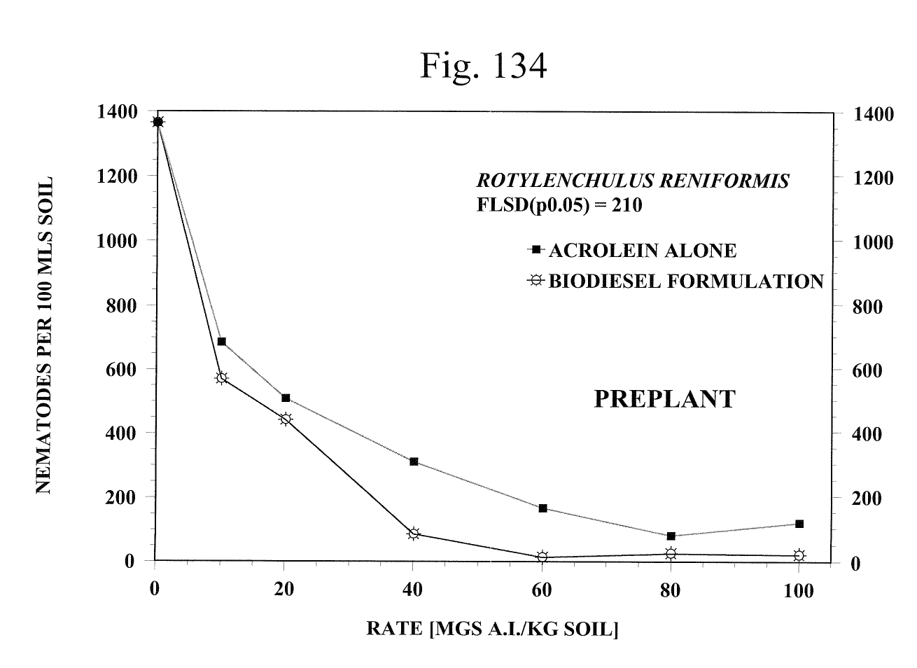

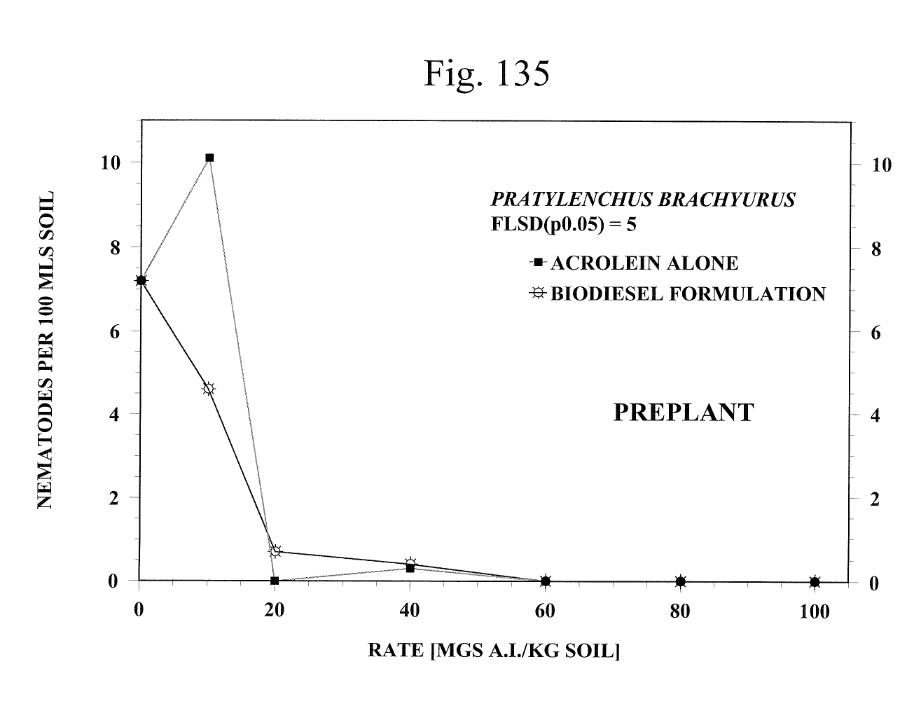

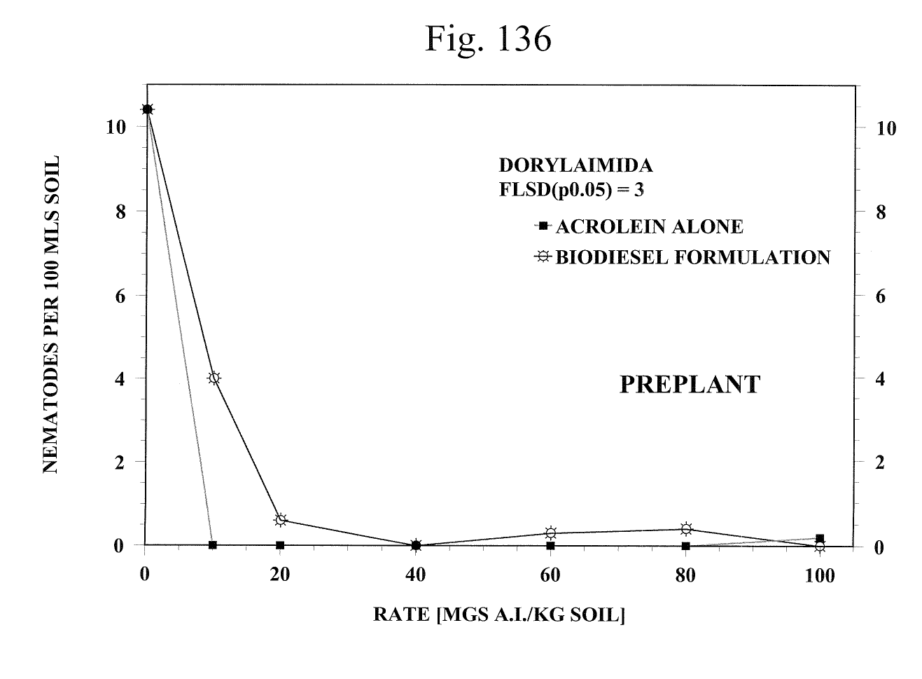

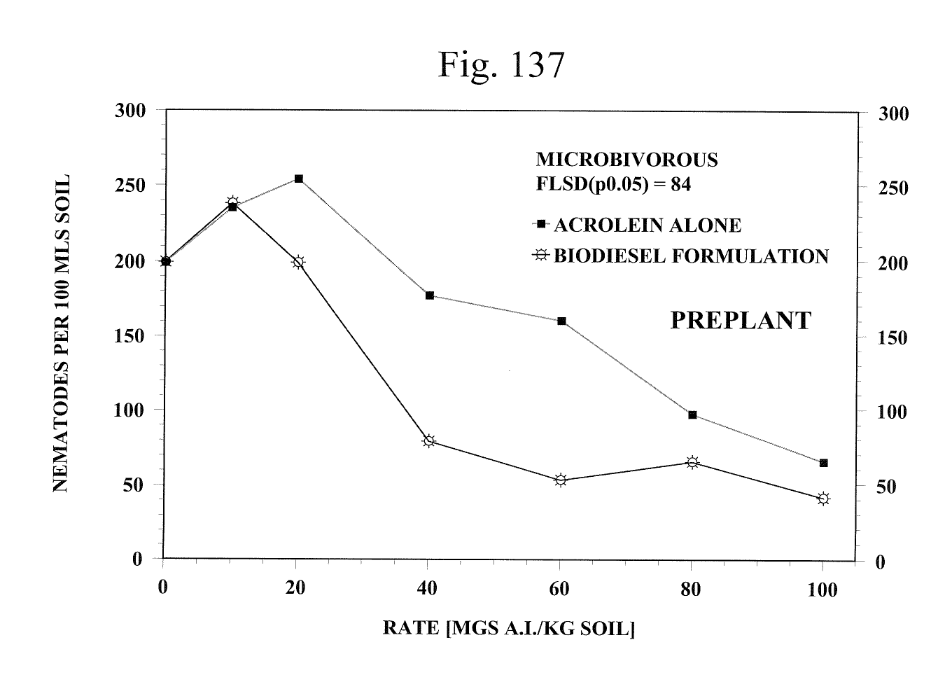

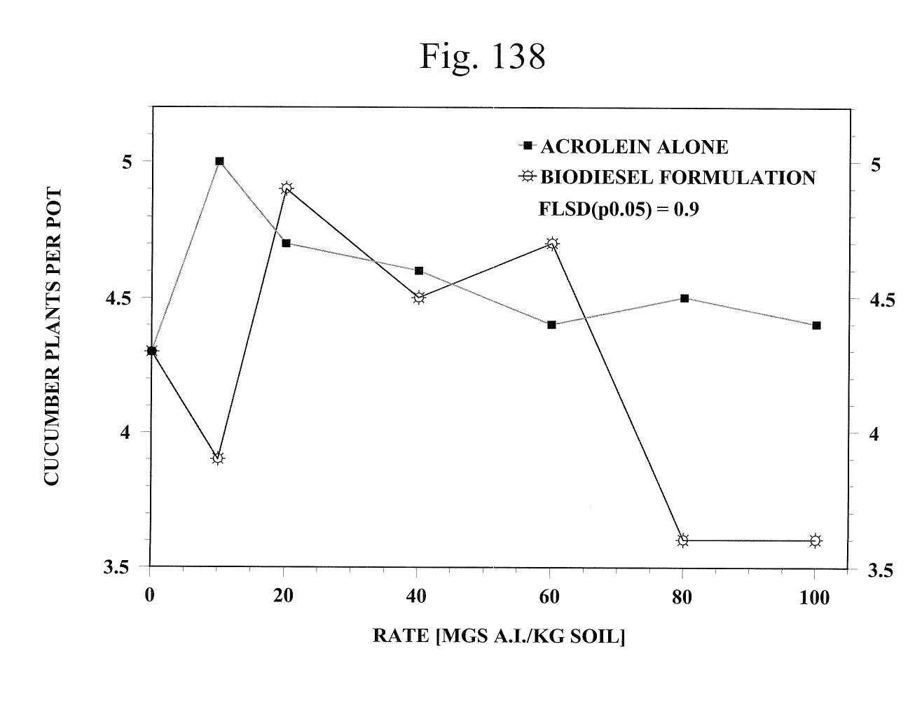

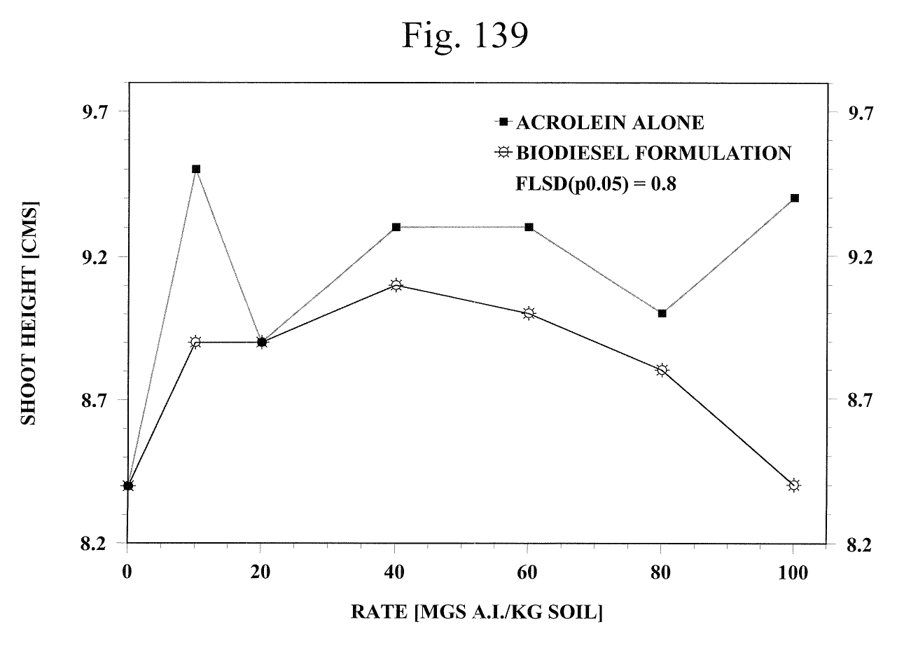

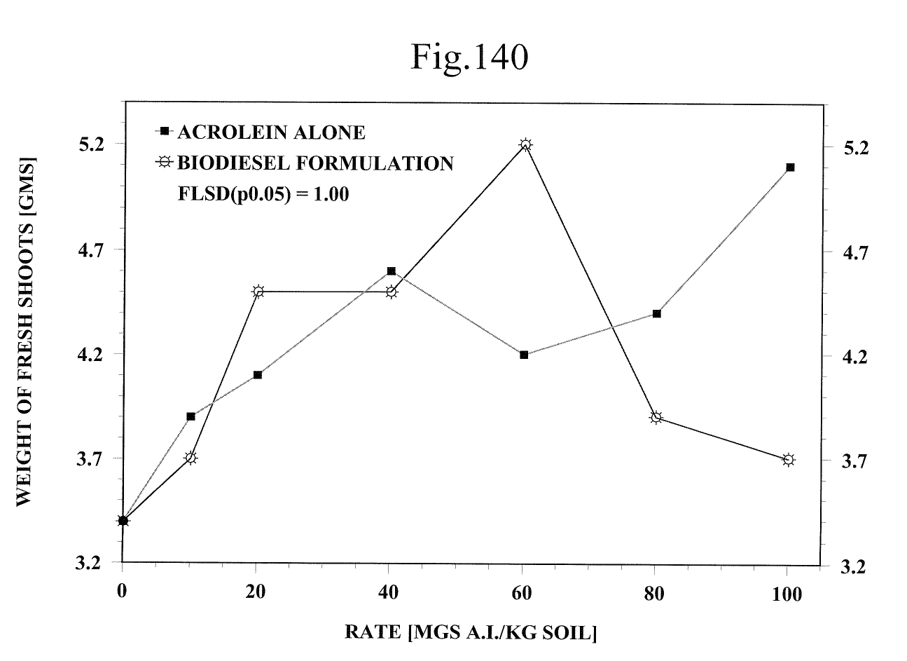

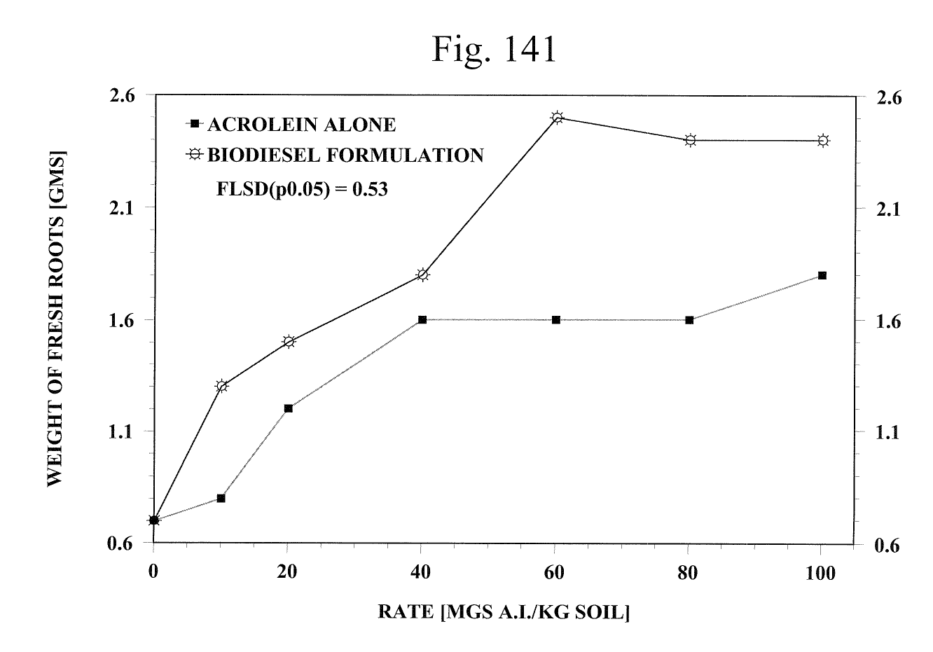

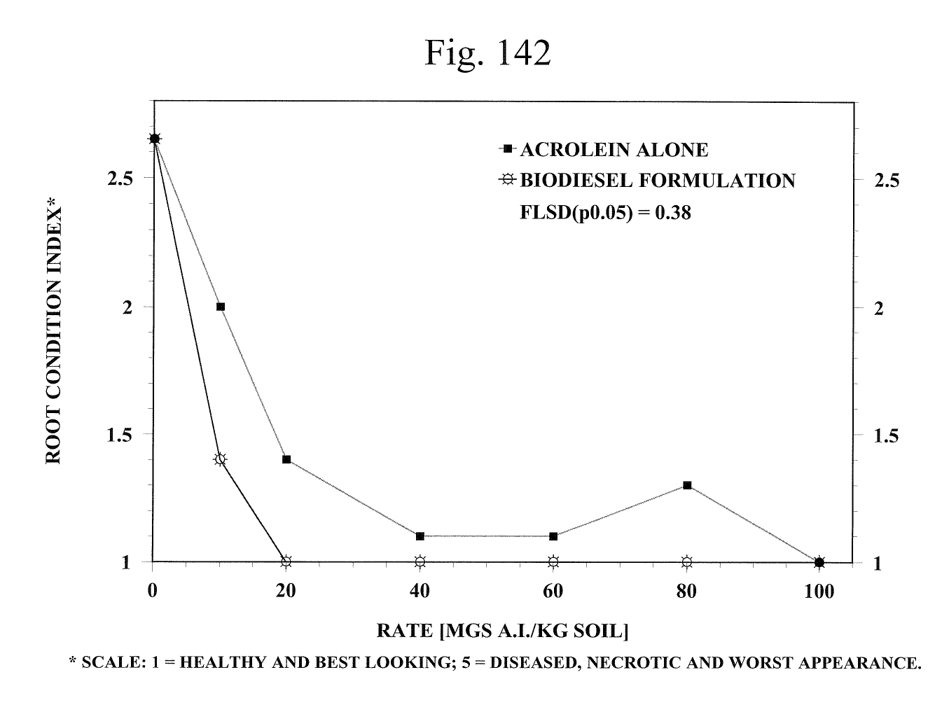

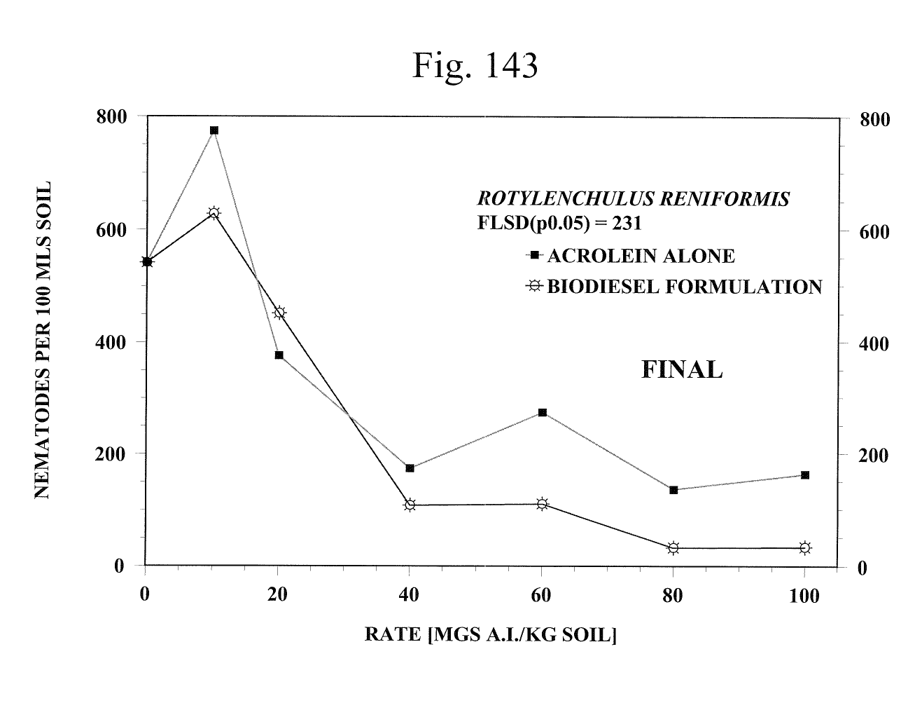

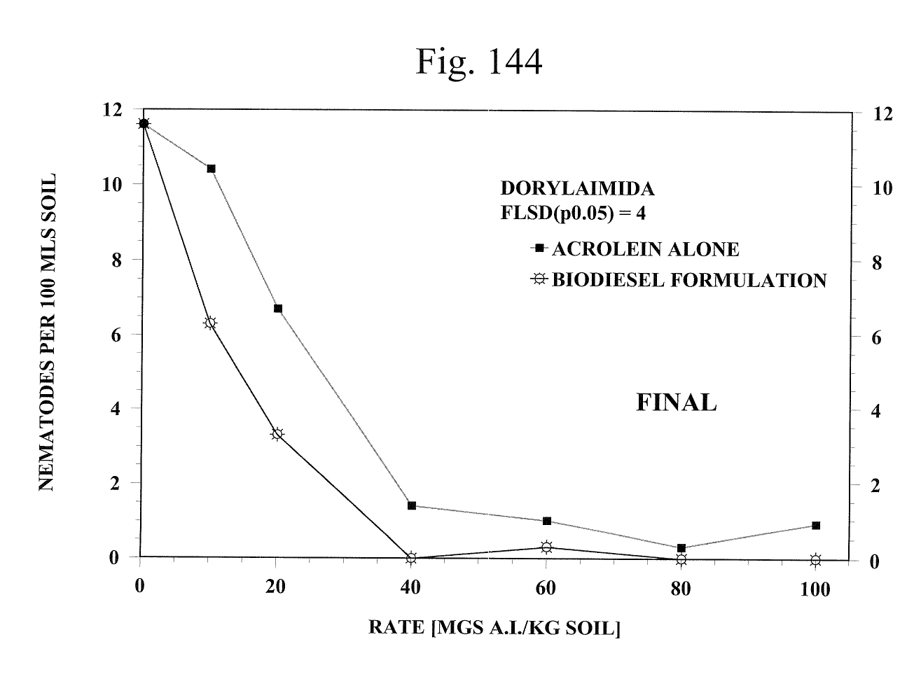

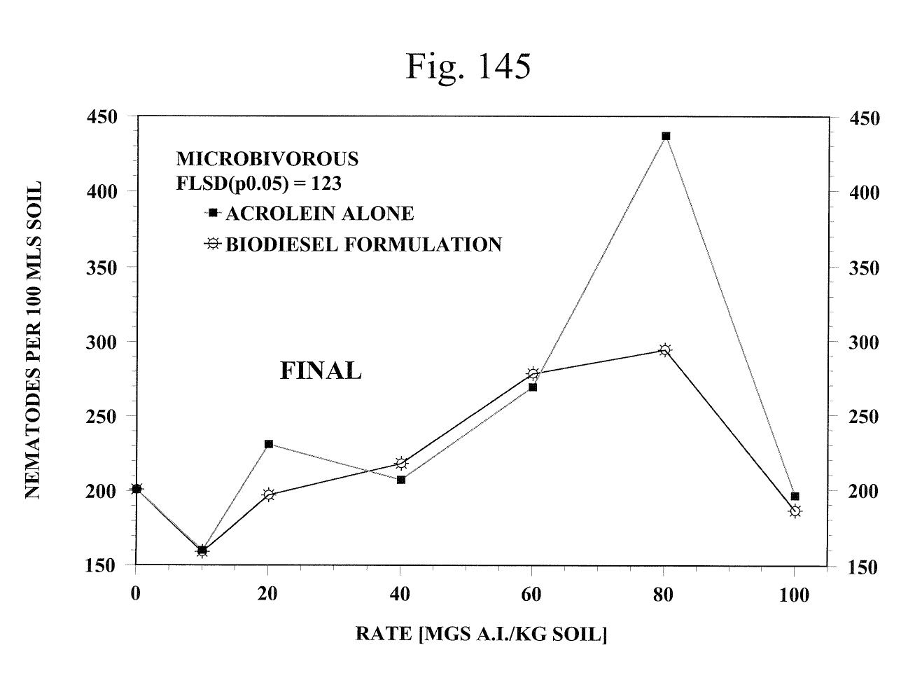

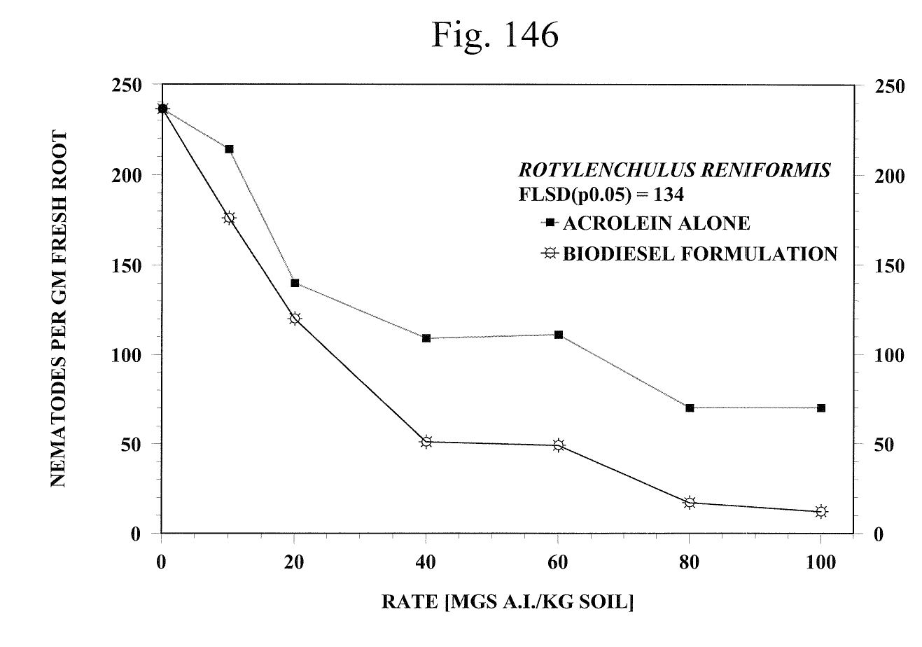

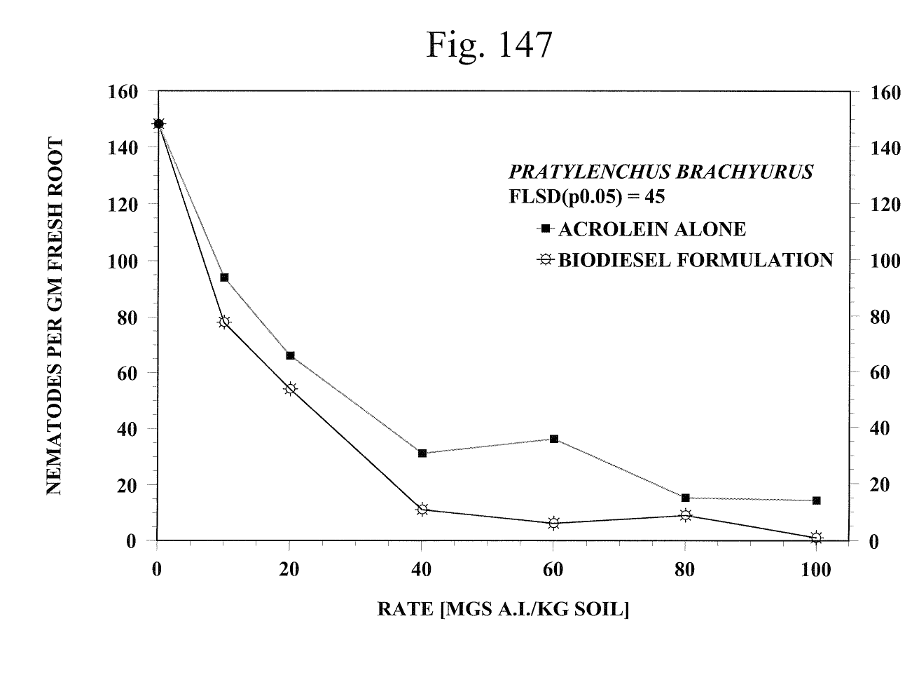

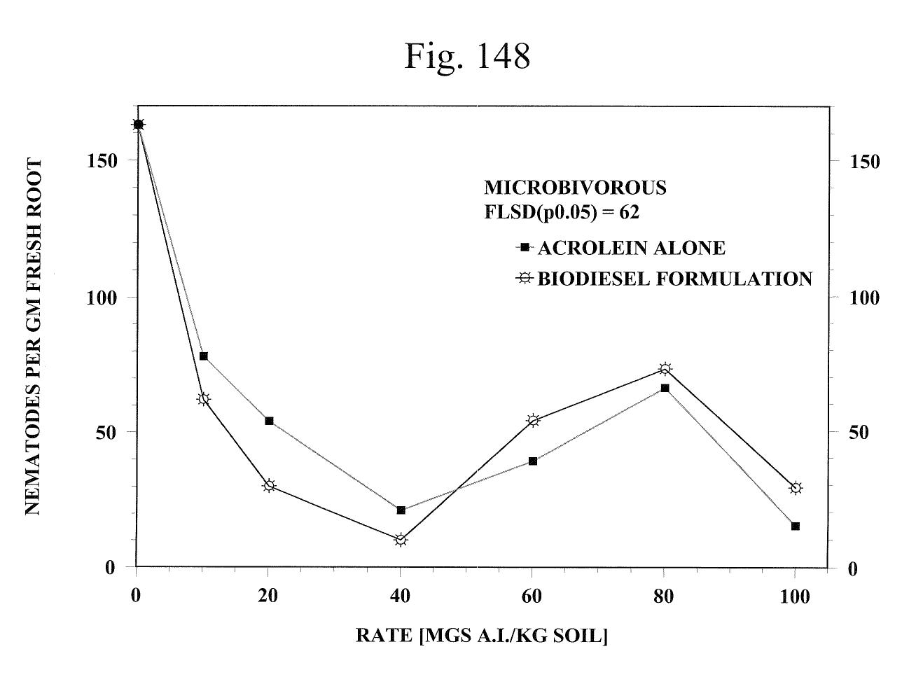

A pre-plant sample of soil was taken and nematodes per 100 mls of soil was determined (FIGS. 134-137). Cucumber seeds were planted in the pots, and the number of cucumber seedlings per pot was determined forty-three (43) days later (FIG. 138). Shoot height (FIG. 139), shoot weight (FIG. 140), root weight (FIG. 141), root condition index (FIG. 142) also were determined. The number of nematodes per 100 mls of soil and in the root system was determined (FIGS. 143-148).

Nematode Test 64

Allyl Bomba AAA concentrate is composed of the following components: S-ethyl N,N-dipropylcarbamothioate (EPTC); allyl isothiocyanate (AIT); dimethyl cyanamide (DMC); biodiesel obtained from food-grade soybean oil (BID); and Illovo Mix (emulsifier). Allyl Bomba AAA concentrate was prepared by pouring 32.5 g of BID into a 250 ml Erlenmeyer flask followed by 2.5 g emulsifier. After mixing, 12.5 g DMC was added to the Erlenmeyer flask. After further mixing, 5 g of MIT was added to the Erlenmeyer flask. The contents of the flask were clear and had a pale yellow color. Next, 0.5 ml of EPIC 7EC (which is equivalent to 0.420 g of active ingredient (ai) (where 1 ml of EPIC 7EC=0.840 g ai) was added to the Erlenmeyer flask. Total weight of the Allyl Bomba AAA components was 53 g. Weight percentage of the Allyl Bomba AAA components was: MIT 9.434%; DMC 23.585%; EPTC 0.792%; emulsifier 4.747%; and BID 61.30%. A 0.5% dilution of Allyl Bomba AAA was prepared by diluting 15 ml Allyl Bomba AAA concentrate in 3 L demineralized water.

Soil that was naturally infected with nematodes was combined with sand (1:1) to prepare a soil mixture for testing. One kilogram of the soil mixture was added to seven (7) pots for each test mixture. Testing was performed by drenching soil with 100 mls of test compositions as indicated in Table 10.

TABLE 10

| | Allyl Bomba AAA | AIT |
|---|---|---|
| Test | (mls 0.5%/kg soil) | (mg/kg soil) |
| Control | | |
| Allyl Bomba | 5 | 2.5 |
| AAA | | |
| “” | 10 | 5 |
| “” | 15 | 7.5 |
| “” | 20 | 10 |
| “” | 25 | 12.5 |
| “” | 30 | 15 |
| “” | 35 | 17.5 |
| “” | 40 | 20 |
| “” | 45 | 22.5 |
| “” | 50 | 25 |
| “” | 55 | 27.5 |
| “” | 60 | 30 |
| Control | | |

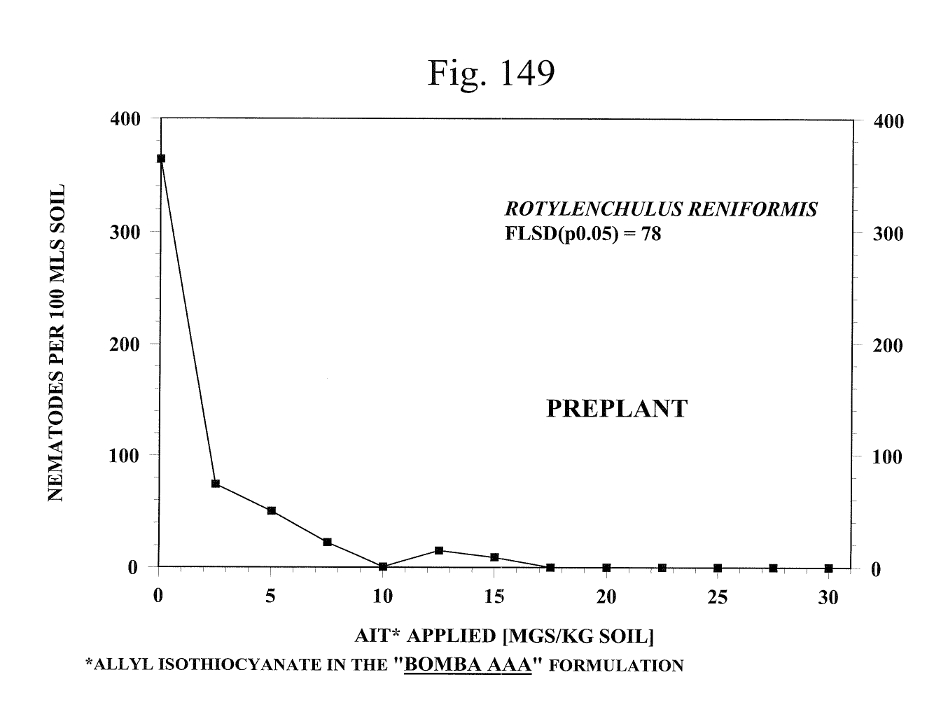

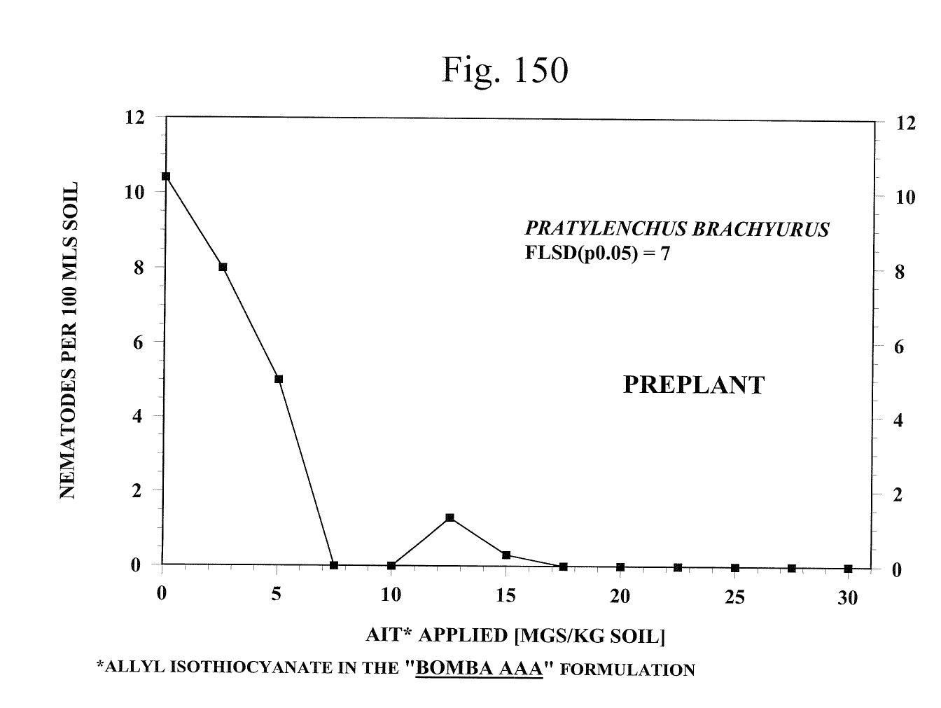

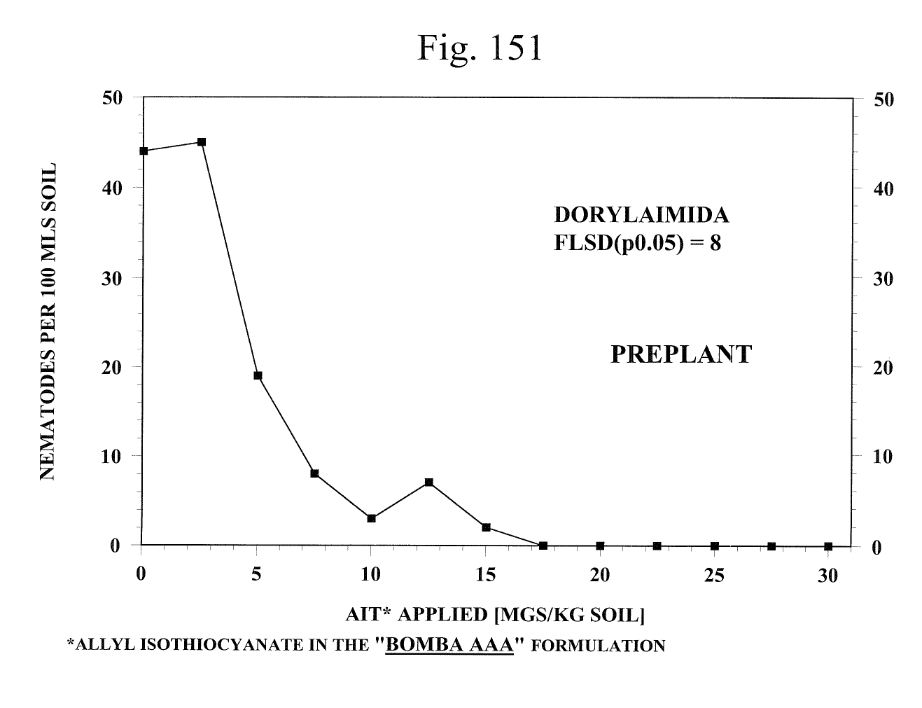

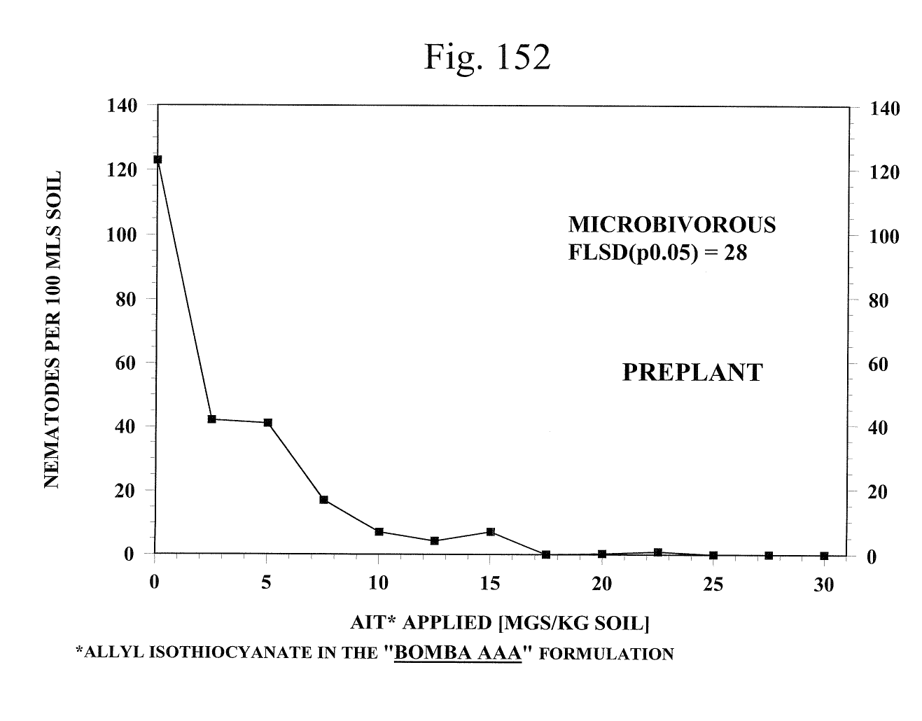

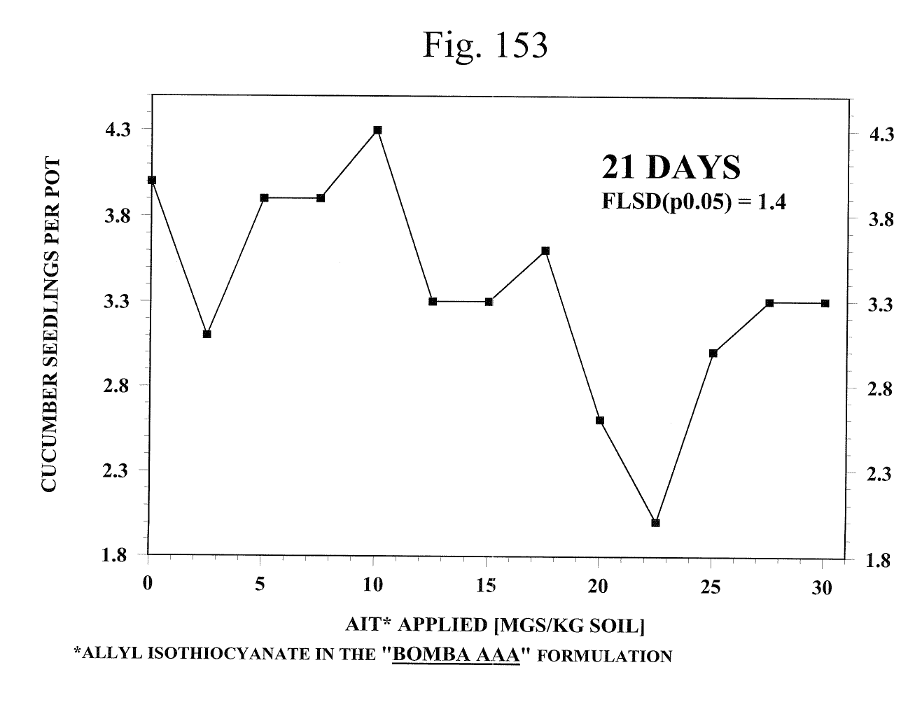

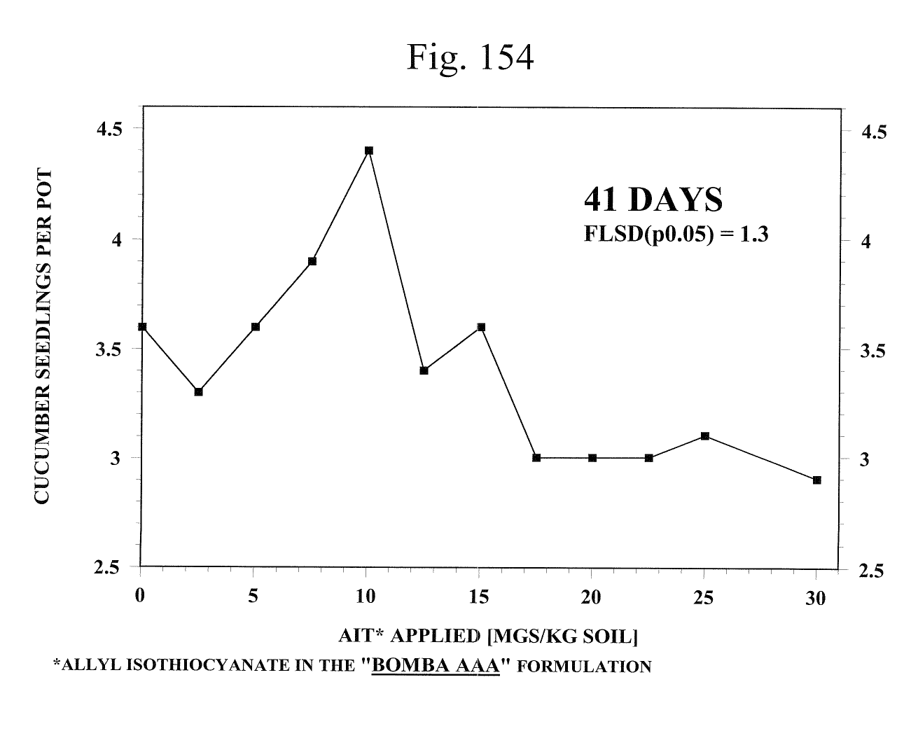

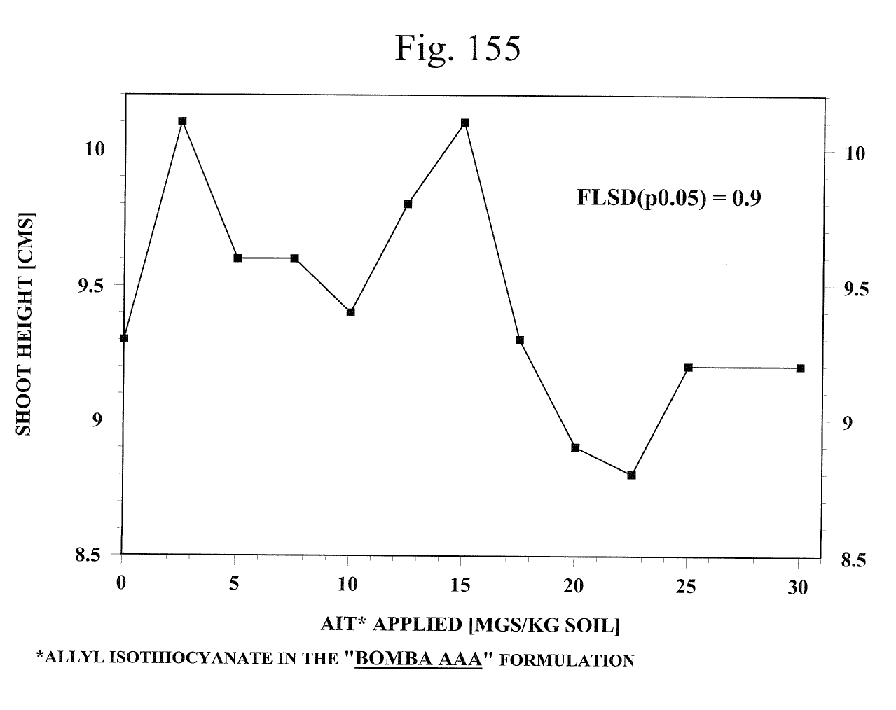

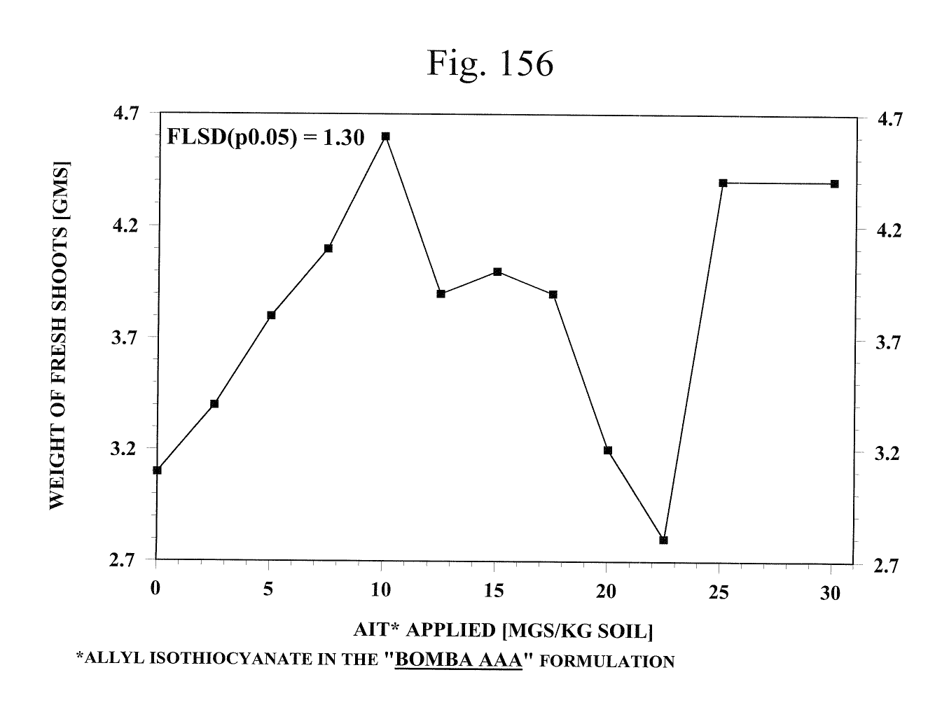

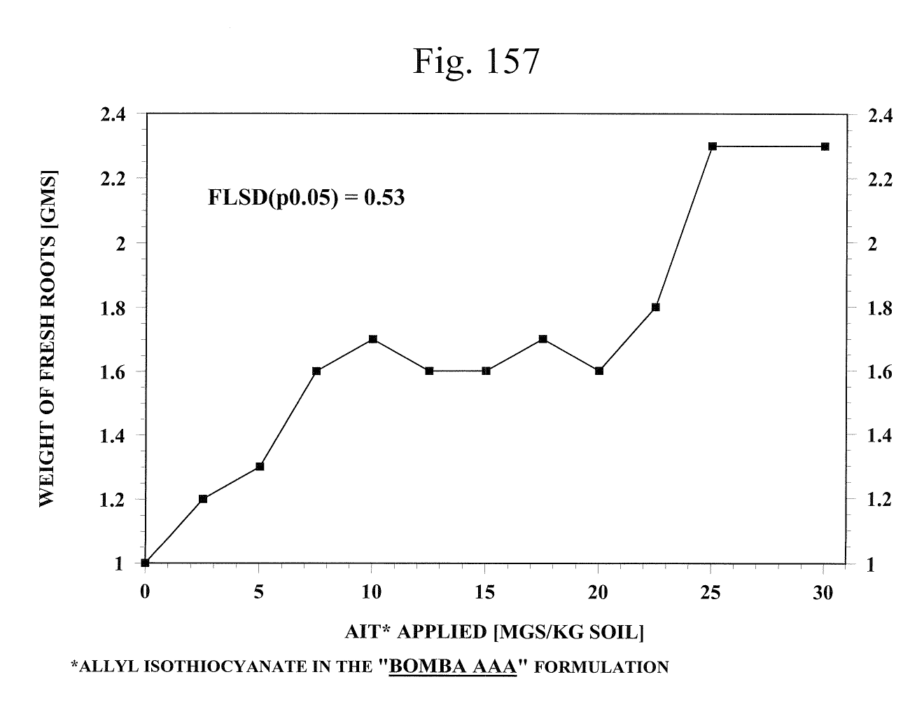

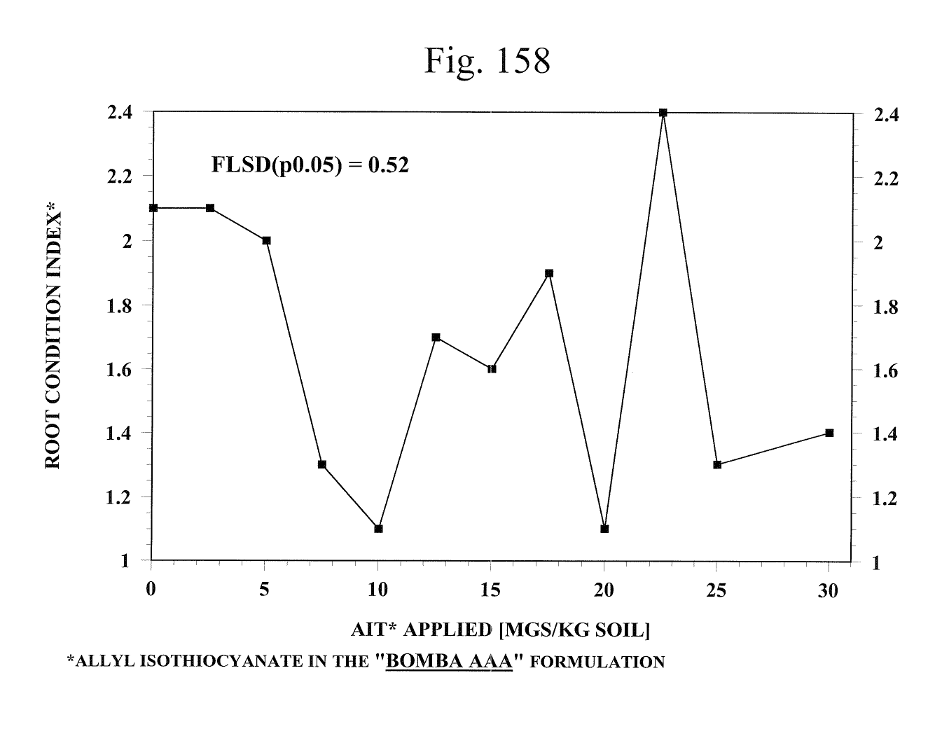

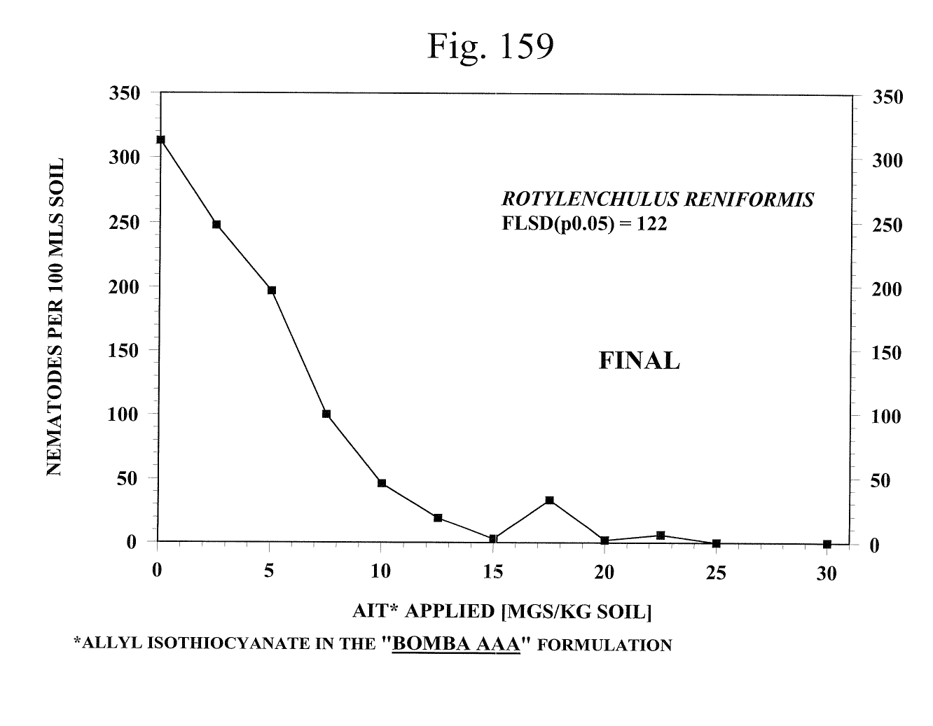

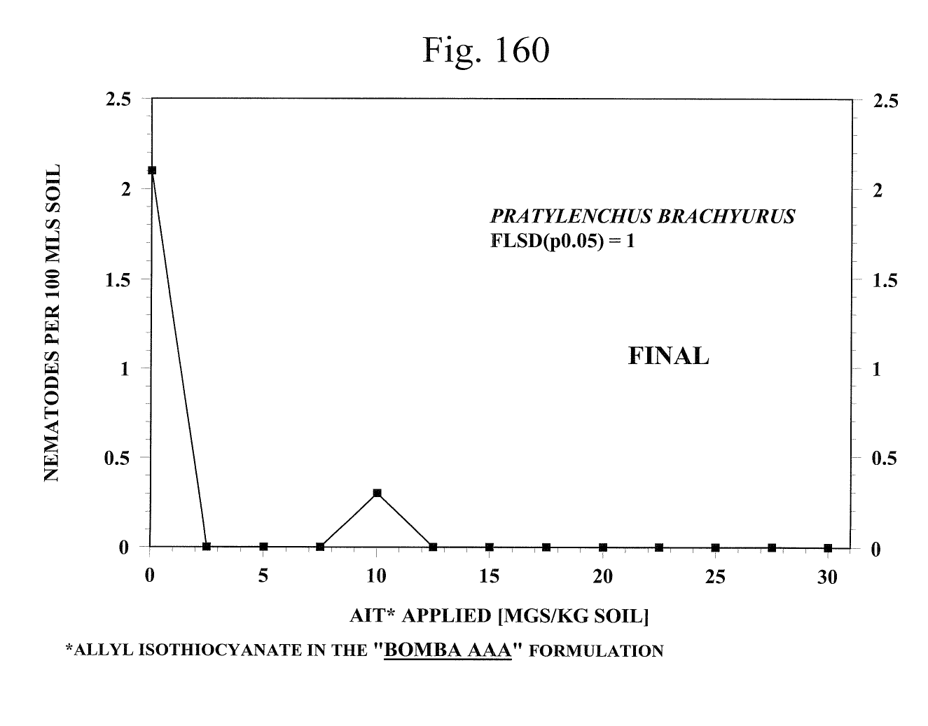

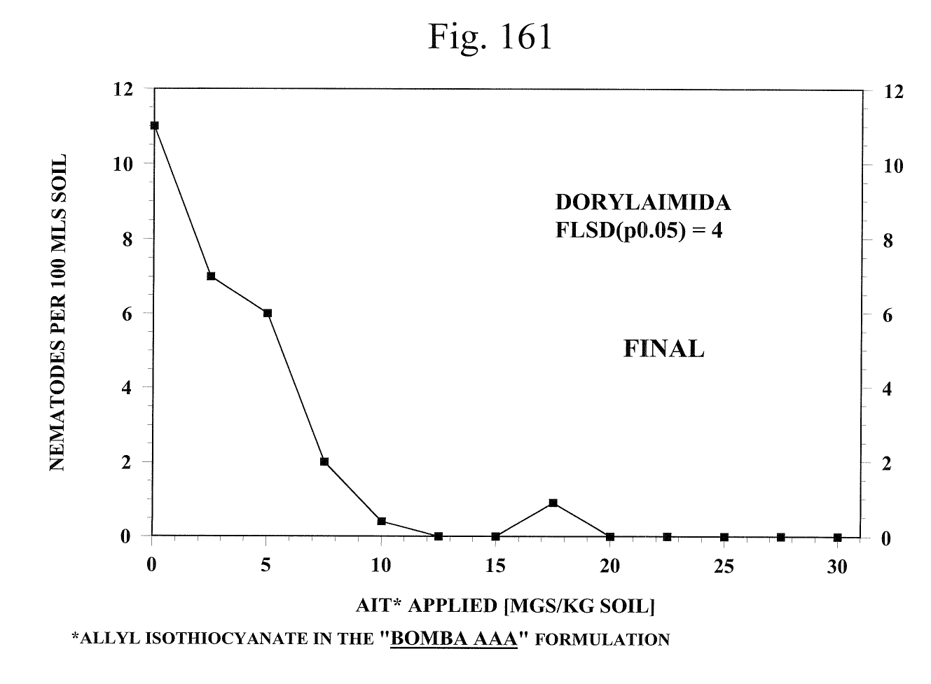

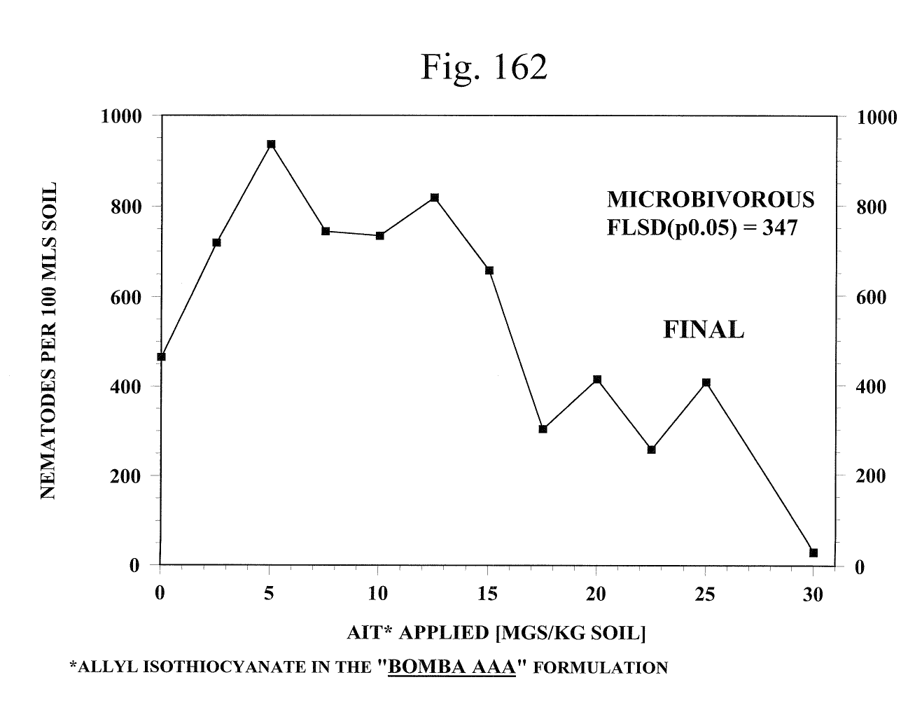

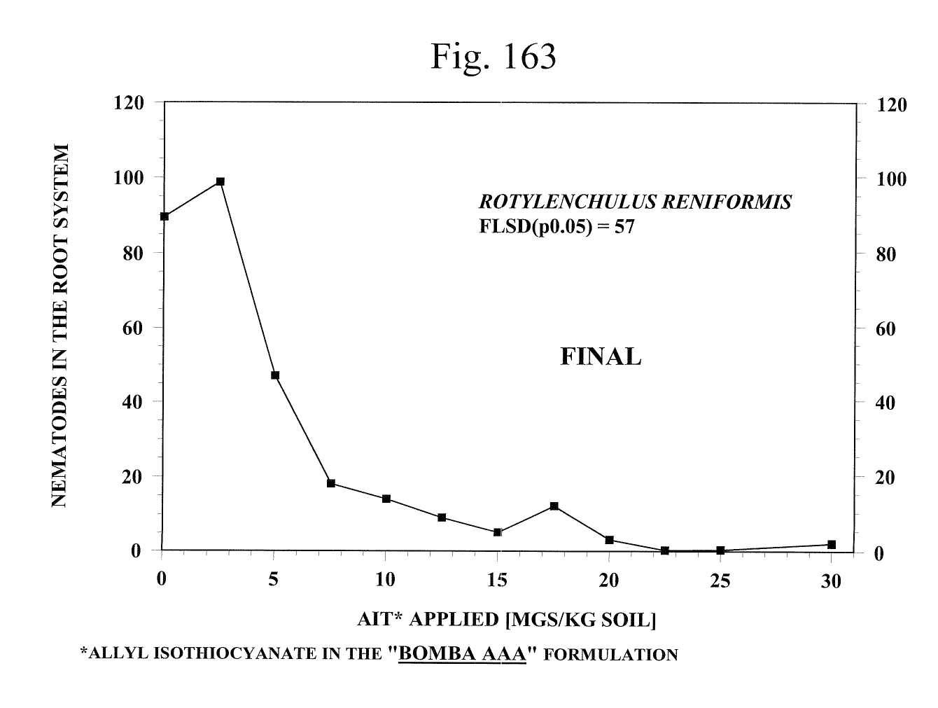

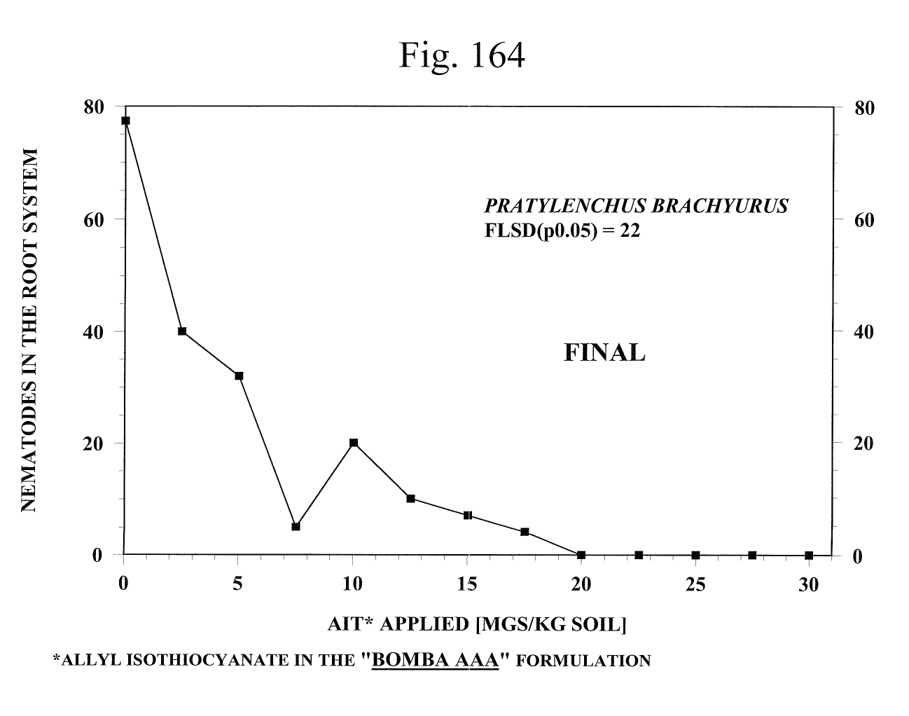

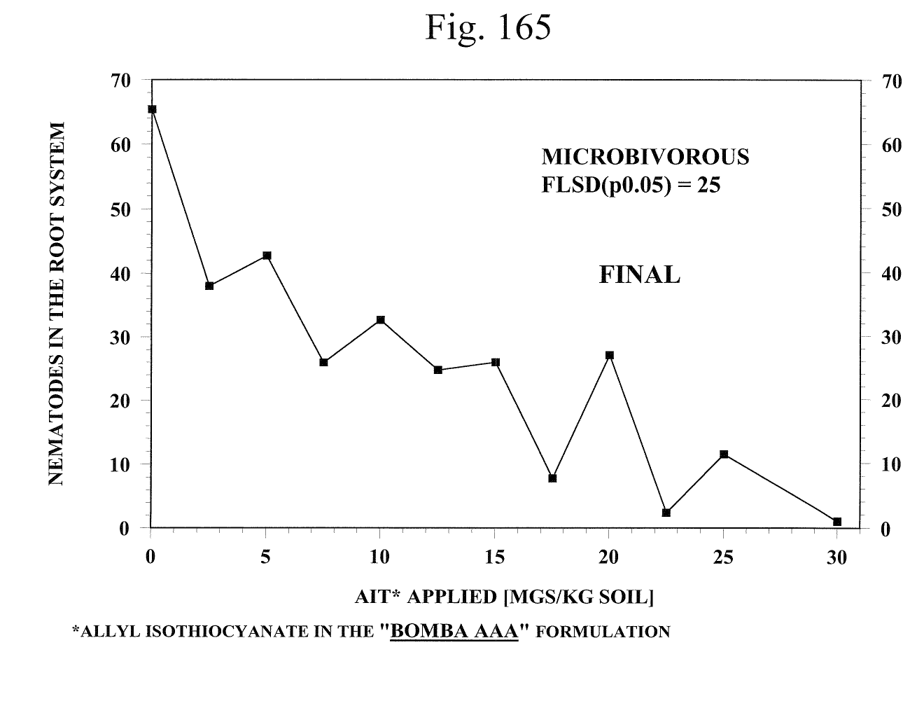

A pre-plant sample of soil was taken and nematodes per 100 mls of soil was determined (FIGS. 149-152). Cucumber seeds were planted in the pots, and the number of cucumber seedlings per pot was determined thirty-two (32) days later (FIG. 153) and forty-one (41) days later (FIG. 154). Shoot height (FIG. 155), shoot weight (FIG. 156), root weight (FIG. 157), and root condition index (FIG. 158) also were determined. The number of nematodes per 100 mls of soil and in the root system was determined (FIGS. 159-165).

Nematode Test 65

Phenyl Bomba AAA concentrate is composed of the following components: S-ethyl N,N-dipropylcarbamothioate (EPTC); phenyl isothiocyanate (DIT); dimethyl cyanamide (DMC); biodiesel obtained from food-grade soybean oil (BID); and Illovo Mix (emulsifier). Phenyl Bomba AAA concentrate was prepared by pouring 32.5 g of BID into a 250 ml Erlenmeyer flask followed by 2.5 g emulsifier. After mixing, 12.5 g DMC was added to the Erlenmeyer flask. After further mixing, 5 g of DIT was added to the Erlenmeyer flask. The contents of the flask were clear and had a pale yellow color. Next, 0.5 ml of EPTC 7EC (which is equivalent to 0.420 g of active ingredient (ai) (where 1 ml of EPTC 7EC=0.840 g ai) was added to the Erlenmeyer flask. Total weight of the Phenyl Bomba AAA components was 53 g. Weight percentage of the Phenyl Bomba AAA components was: ΦIT 9.434%: DMC 23.585%; EPTC 0.792%; emulsifier 4.747%; and BID 61.30%. A 0.5% dilution of Phenyl Bomba AAA was prepared by diluting 15 ml Phenyl Bomba AAA concentrate in 3 L demineralised water.

Soil that was naturally infected with nematodes was combined with sand (1:1) to prepare a soil mixture for testing. One kilogram of the soil mixture was added to seven (7) pots for each test mixture. Testing was performed by drenching soil with 100 mls of test compositions as indicated in Table 11.

TABLE 11

| | Phenyl Bomba AAA | ΦIT |
|---|---|---|
| Test | (mls 0.5%/kg soil) | (mg/kg soil) |
| Control | | |
| Phenyl | 5 | 2.5 |
| Bomba AAA | | |
| “” | 10 | 5 |
| “” | 15 | 7.5 |
| “” | 20 | 10 |
| “” | 25 | 12.5 |
| “” | 30 | 15 |
| “” | 35 | 17.5 |
| “” | 40 | 20 |
| “” | 45 | 22.5 |
| “” | 50 | 25 |
| “” | 55 | 27.5 |
| “” | 60 | 30 |
| Control | | |

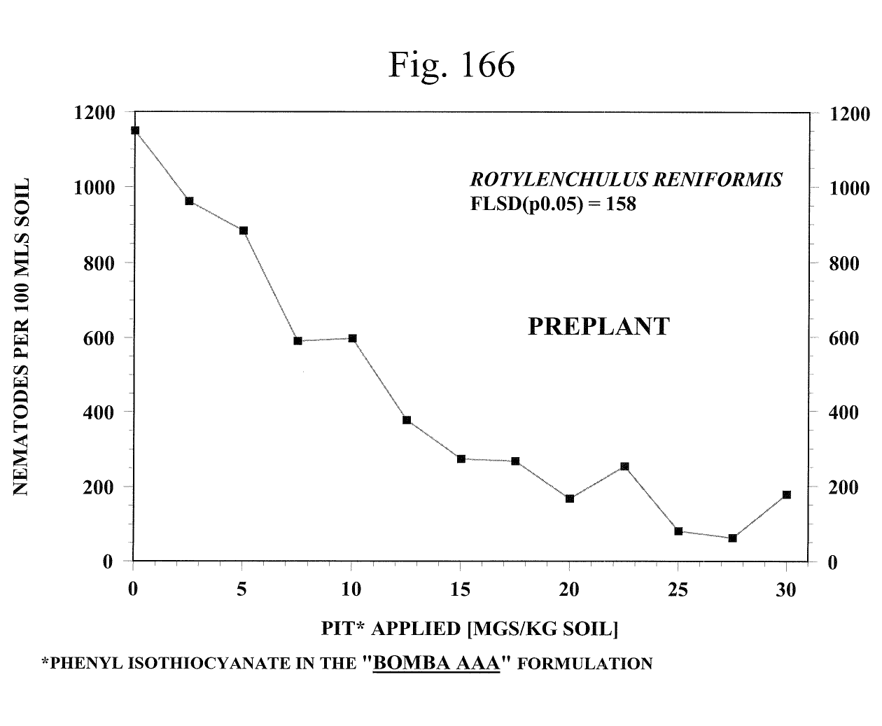

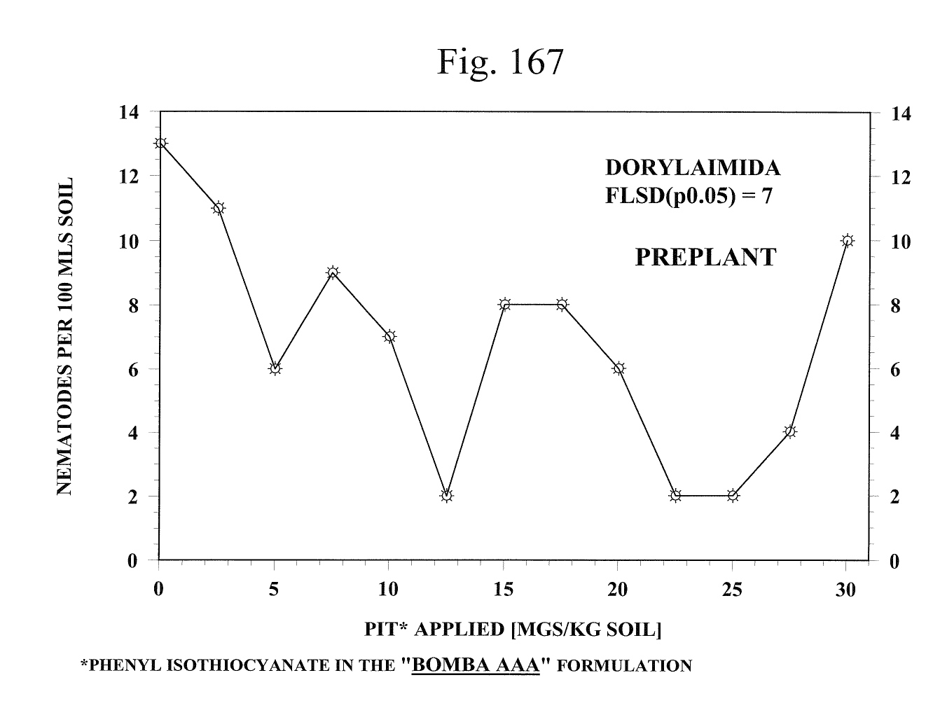

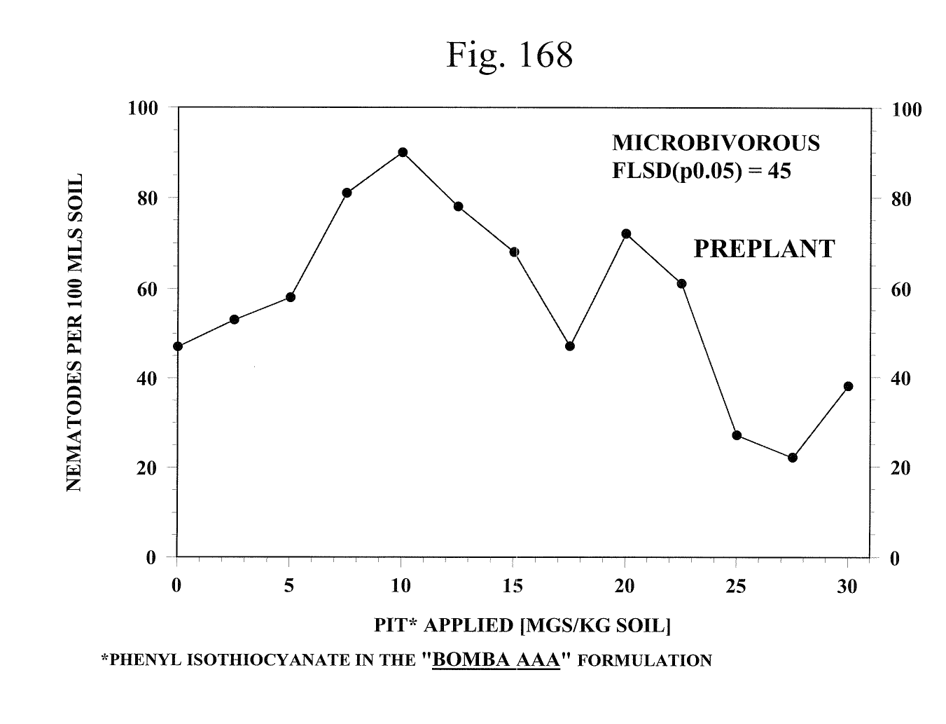

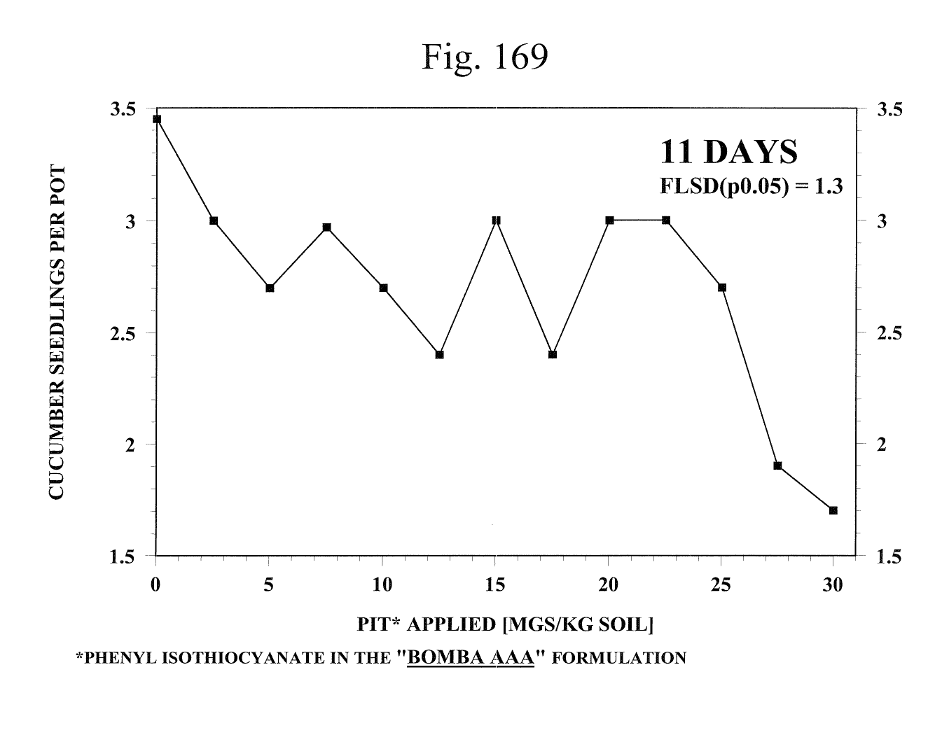

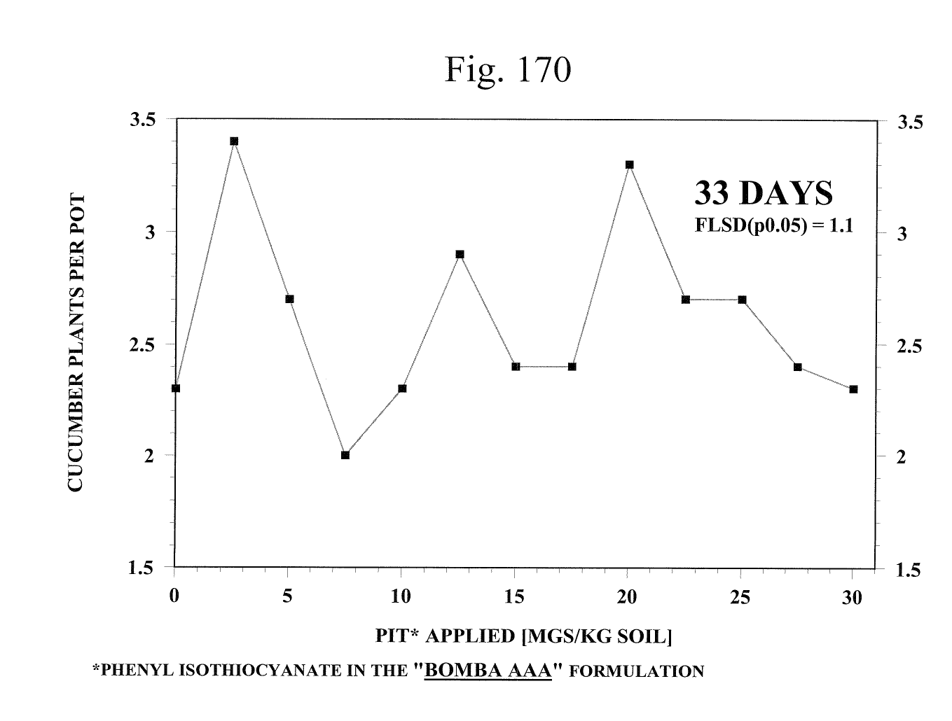

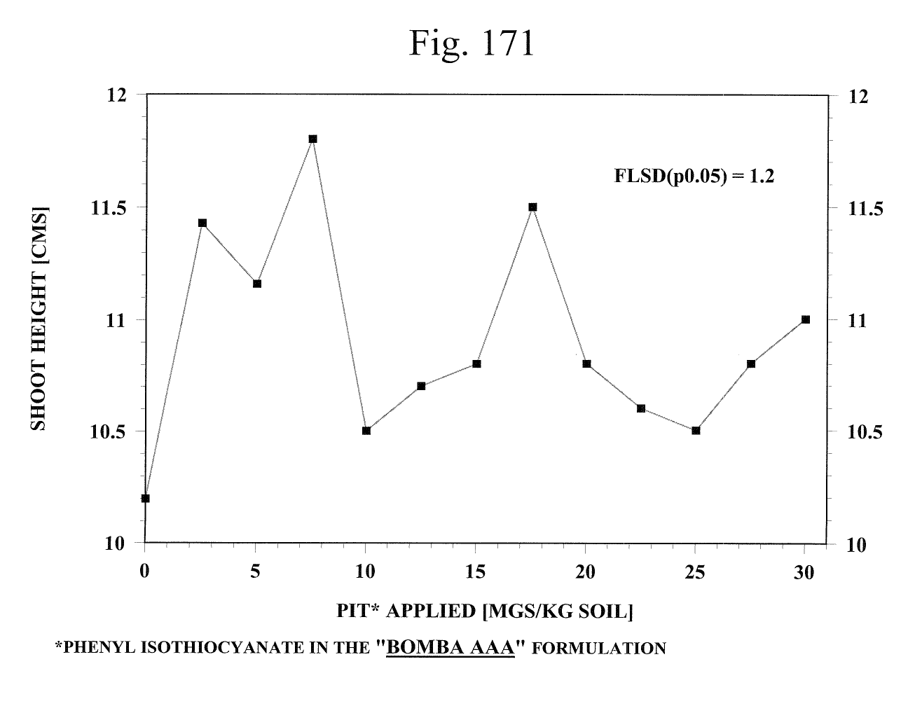

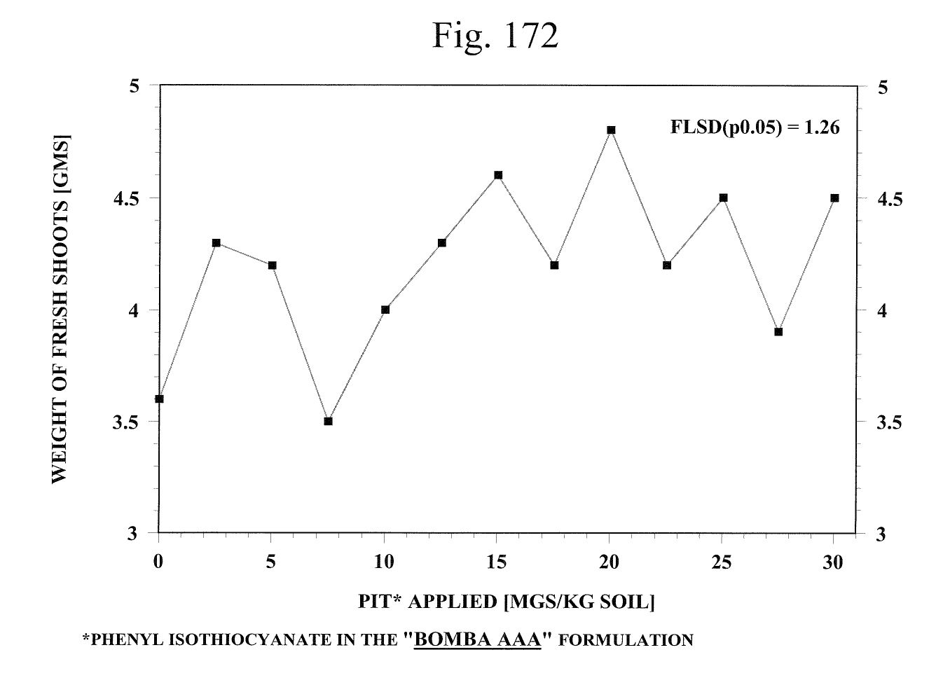

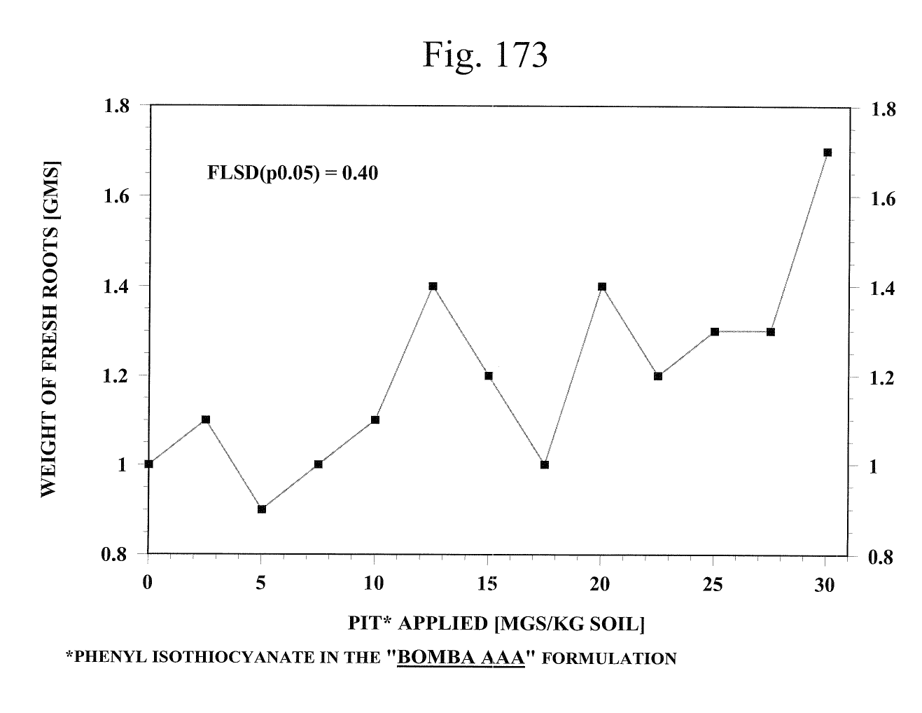

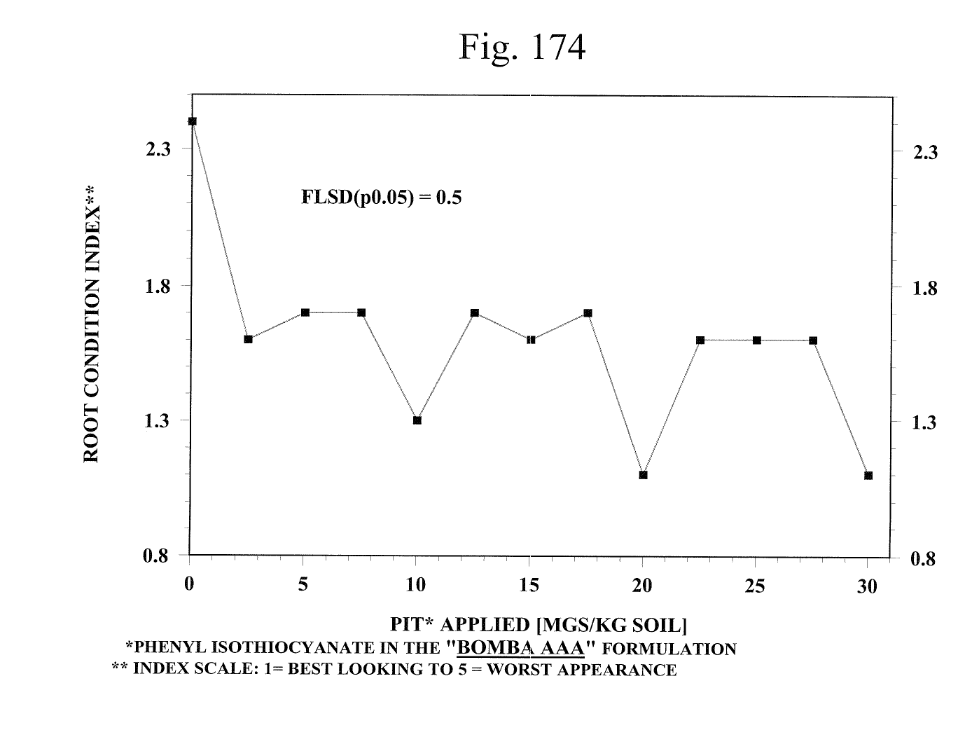

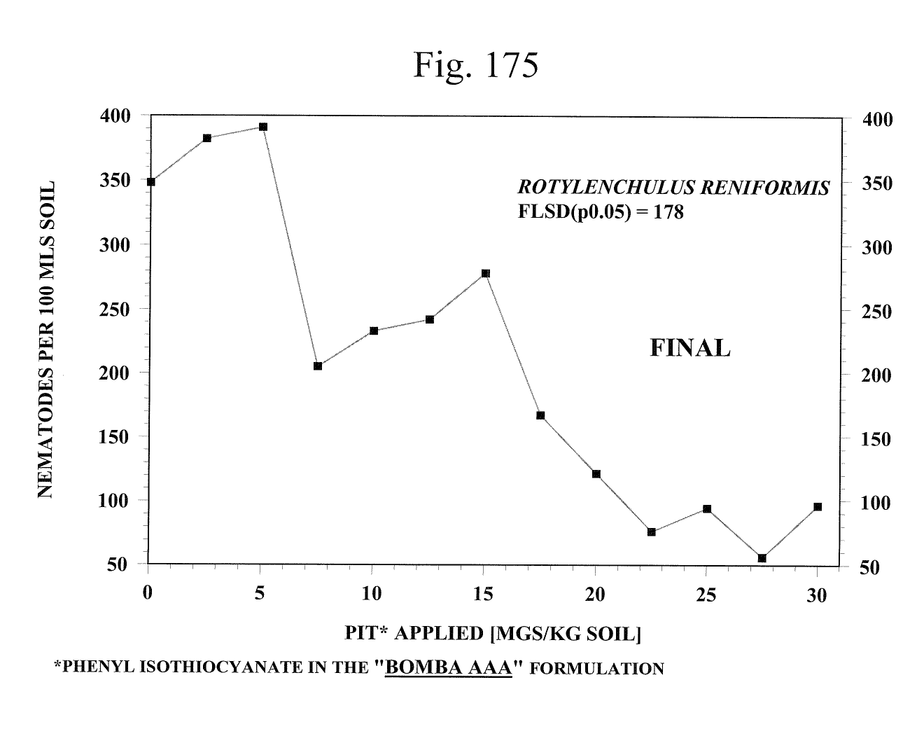

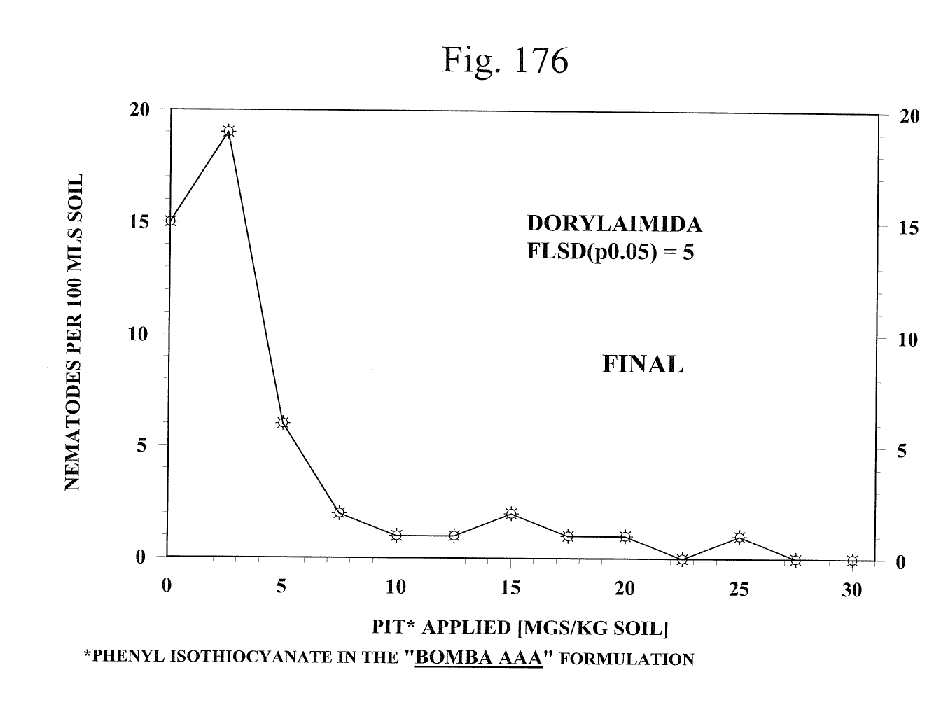

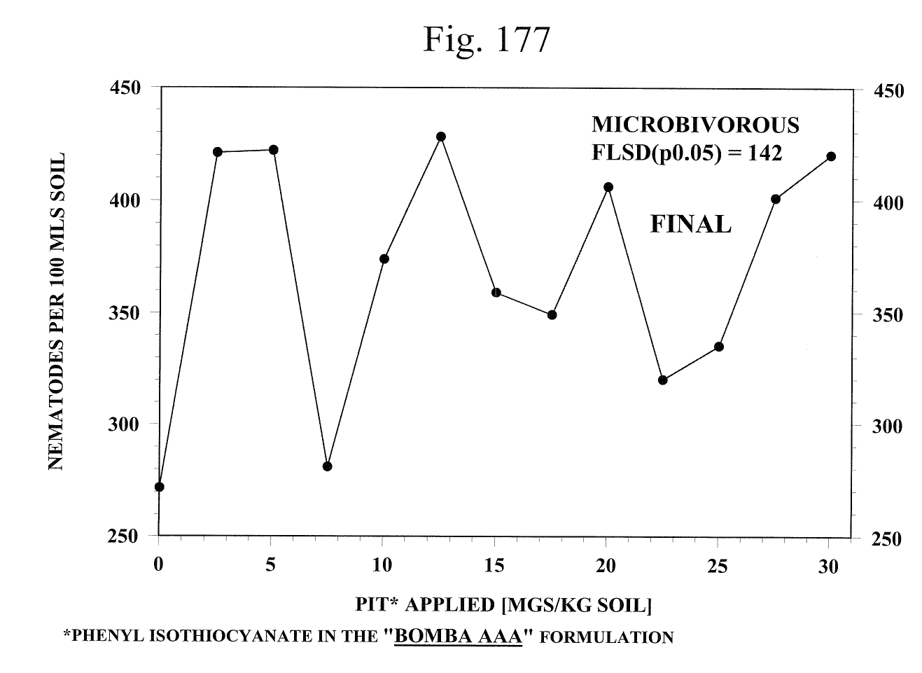

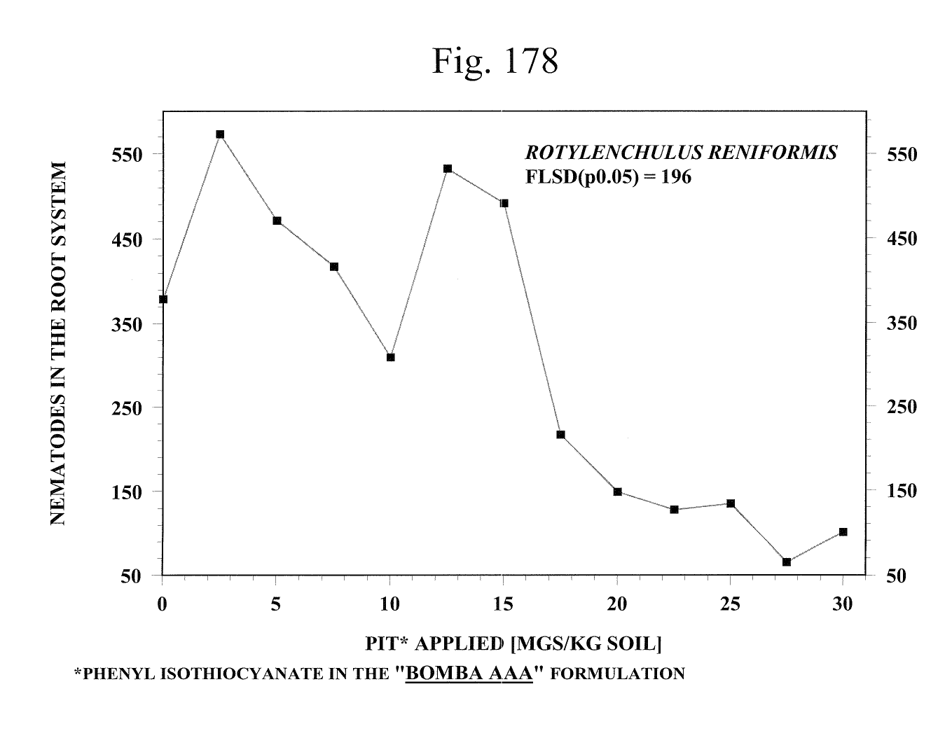

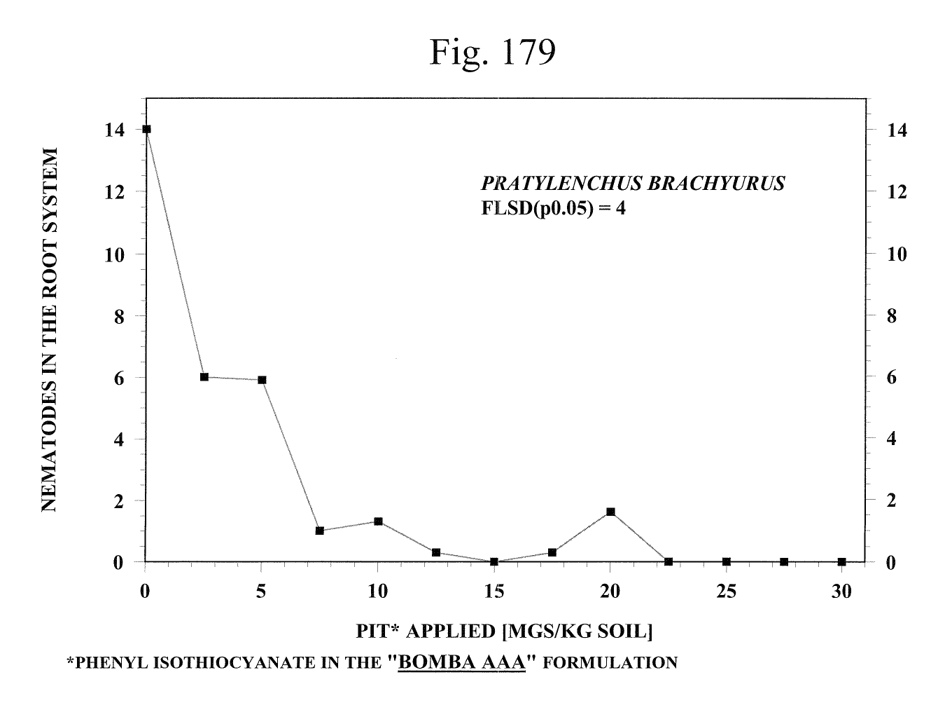

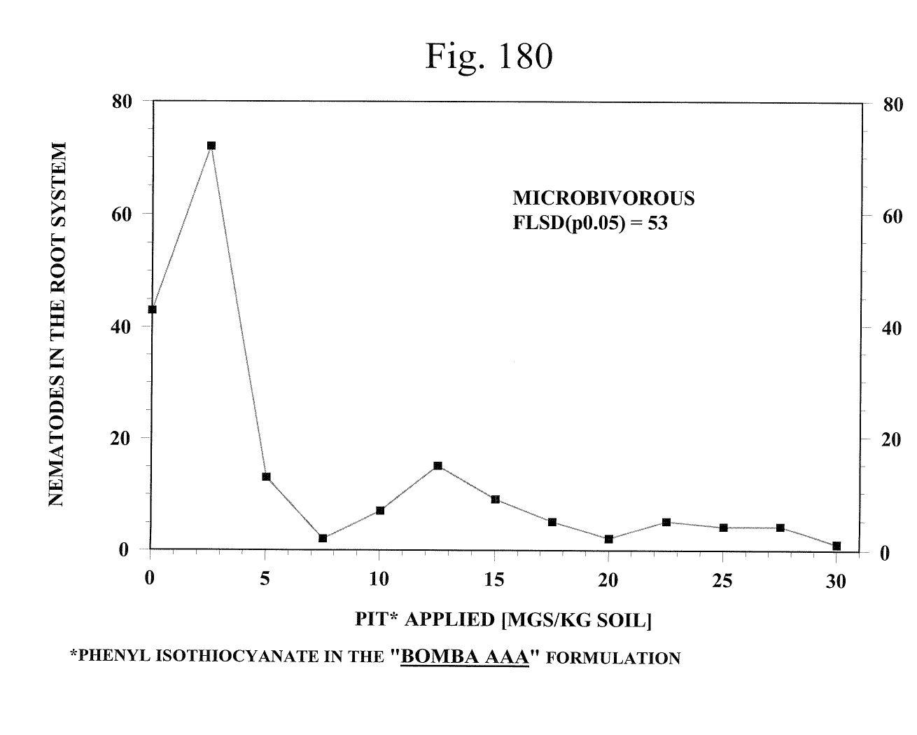

A pre-plant sample of soil was taken and nematodes per 100 mls of soil was determined (FIGS. 166-168). Cucumber seeds were planted in the pots, and the number of cucumber seedlings per pot was determined eleven (11) days later (FIG. 169) and thirty-three (33) days later (FIG. 170). Shoot height (FIG. 171), shoot weight (FIG. 172), root weight (FIG. 173), and root condition index (FIG. 174) also were determined. The number of nematodes per 100 mls of soil and in the root system was determined (FIGS. 175-180).

Nematode Test 66

Compounds: Aqueous emulsions of orange terpenes and allyl isothiocyanate (AIT) (Aldrich Chemical Co.) were prepared by mixing the requisite amounts of the compounds with 10% polysorb 80 and adding to demineralized water to a final volume of 1.5 L while stirring vigorously (magnetic stirring). The orange terpene emulsion contained 5% (w/w) of the compound and the AIT emulsion contained 1% (w/w) of the compound.

Rates: The 1% AIT emulsion was delivered to soil at rates of: 0, 10, 20, 30, 60, and 120 mgs ai/kg soil—equivalent to (1 mg ai/kg soil=2 lbs ai/acre on a broadcast basis): 0, 20, 40, 60, 120, and 240 lbs ai/acre. Each of the AIT treatment rates was represented by 14 replications with 7 replication receiving AIT alone and the remaining replications receiving AIT and orange terpene at 250 mgs/kg soil. Two controls with no treatment and one with 250 mgs/kg soil of orange terpene alone were included. There were a total of 91 pots in the experiment.

Application method and procedure: Each treatment was delivered by drenching in 100 mls aqueous volume onto the soil surface in pots (10 cm diameter, PVC) containing 1 kg soil. The soil was from a cotton field (silty clay loam; pH 6.2; CEC<10 meq/100 gm soil; organic matter <1.0%) infested with the reniform nematode Rotylenchulus reniformis and the root knot nematode Meloidogyne ingognita as the principal pathogenic species. Immediately after treatment the pots were covered by a thick (1.5 mm) clear low density polyethylene bag held tight against the outer wall of the pot by a rubber band. The pots were placed on a greenhouse bench. The bags were removed from the pots after one week. After removal of the bags, soil samples (100 mls) were taken from each pot and 5 seeds of “Marketmore” cucumber (Cucumis sativus) were planted in each pot. Cucumber plants were allowed to grow for 53 days at which time the plants were removed from the soil and soil samples were again collected from each pot. The roots were washed clean of soil, and the height of shoots as well as the weights of shoots and roots were recorded. Pre-plant and final soil samples were used to extract nematodes (soil bowl incubation technique) and the number of nematodes in the roots were determined similarly.

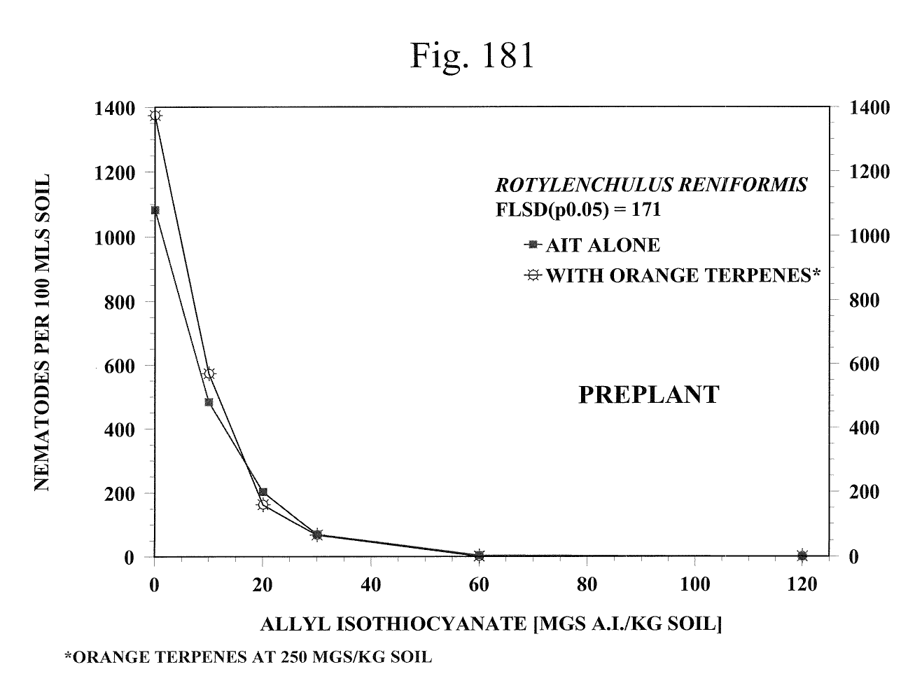

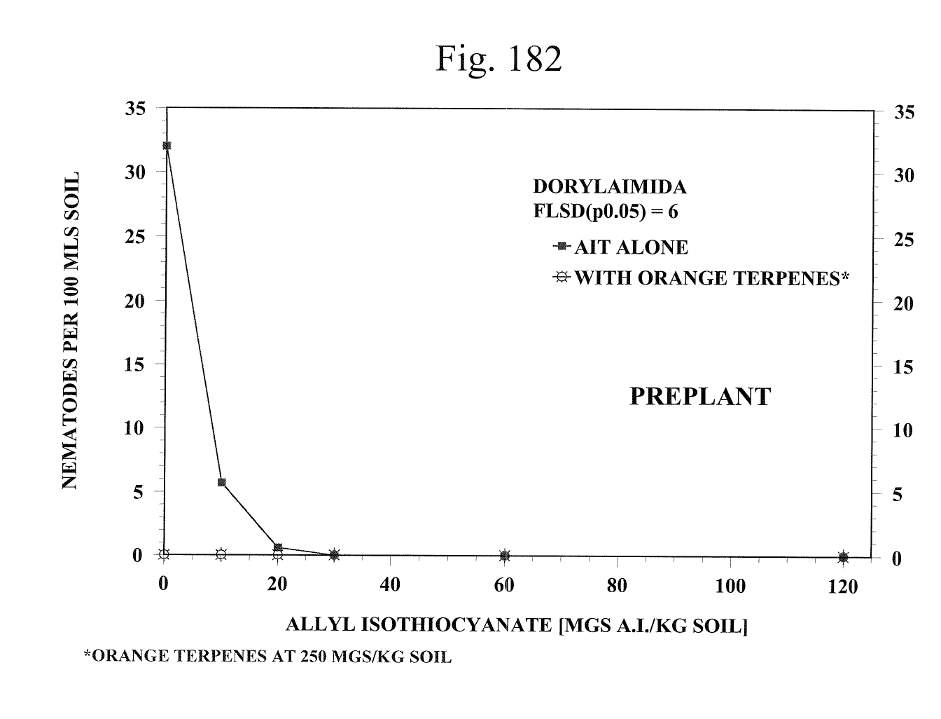

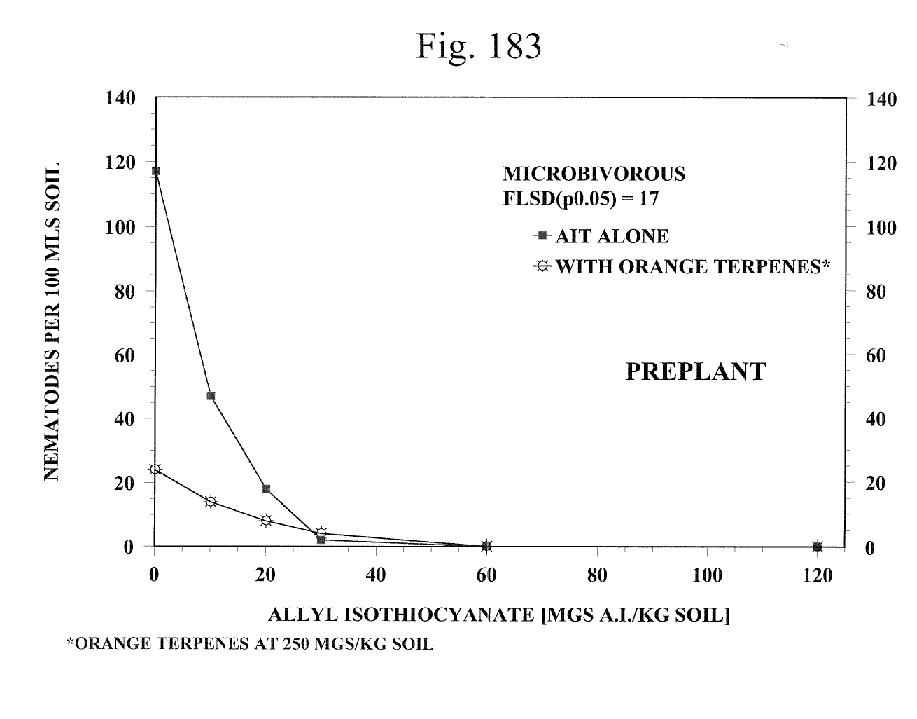

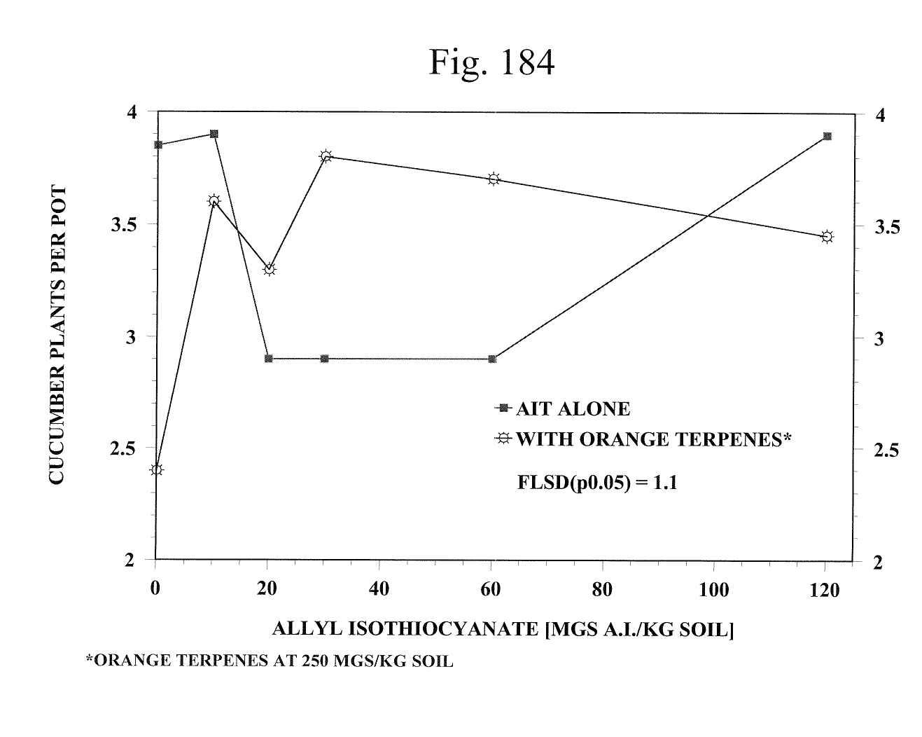

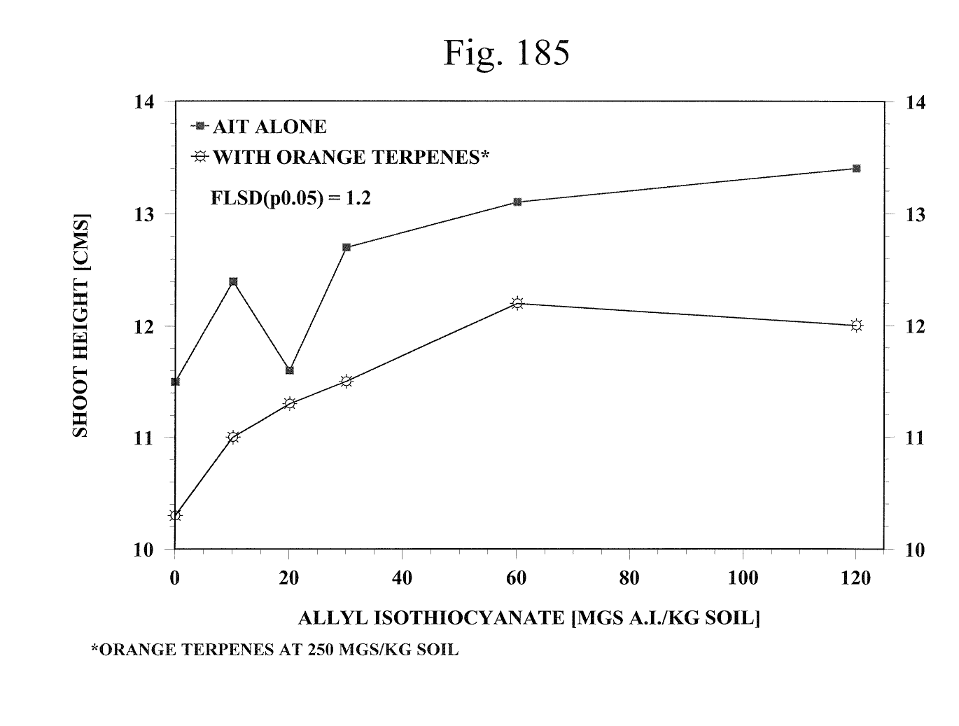

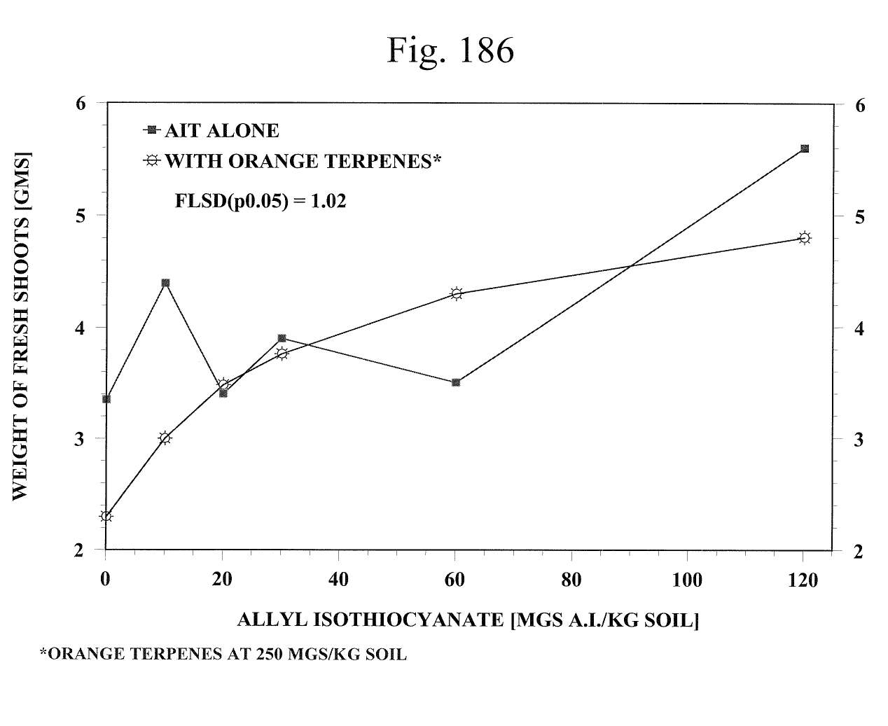

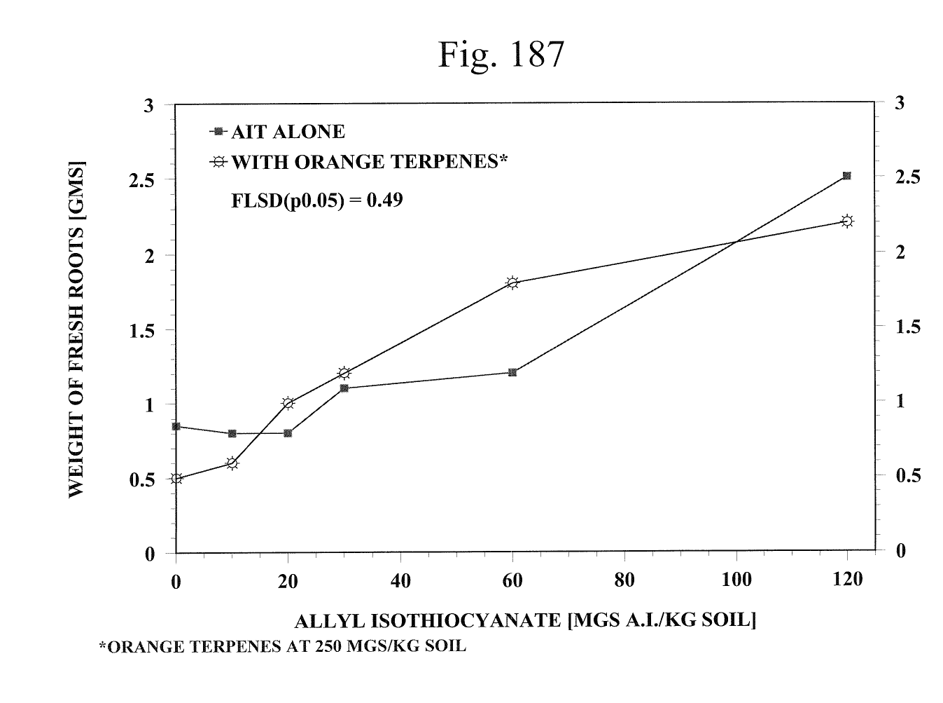

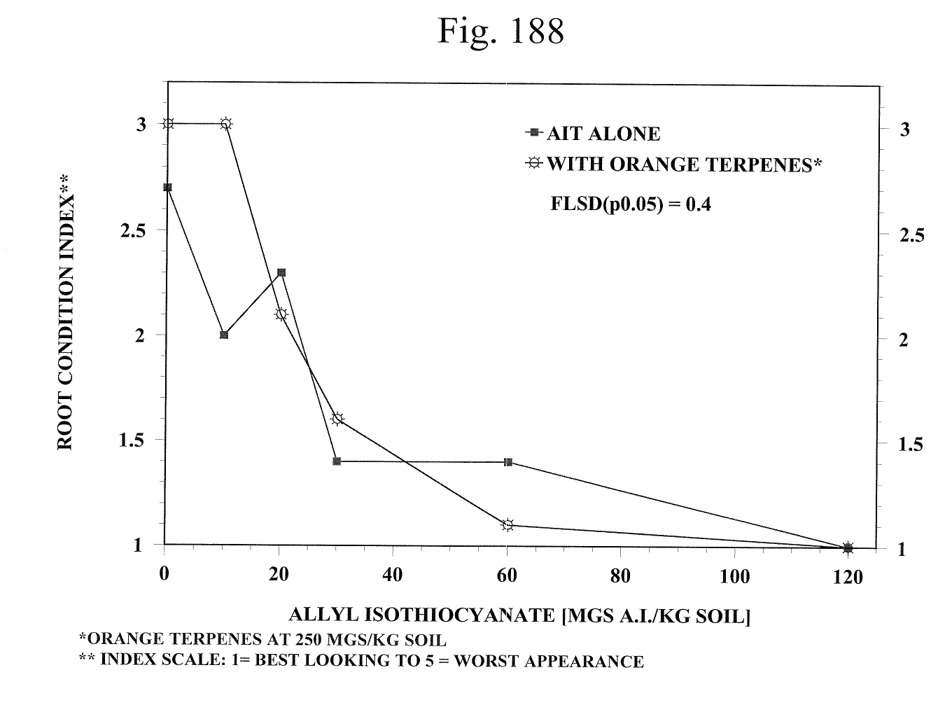

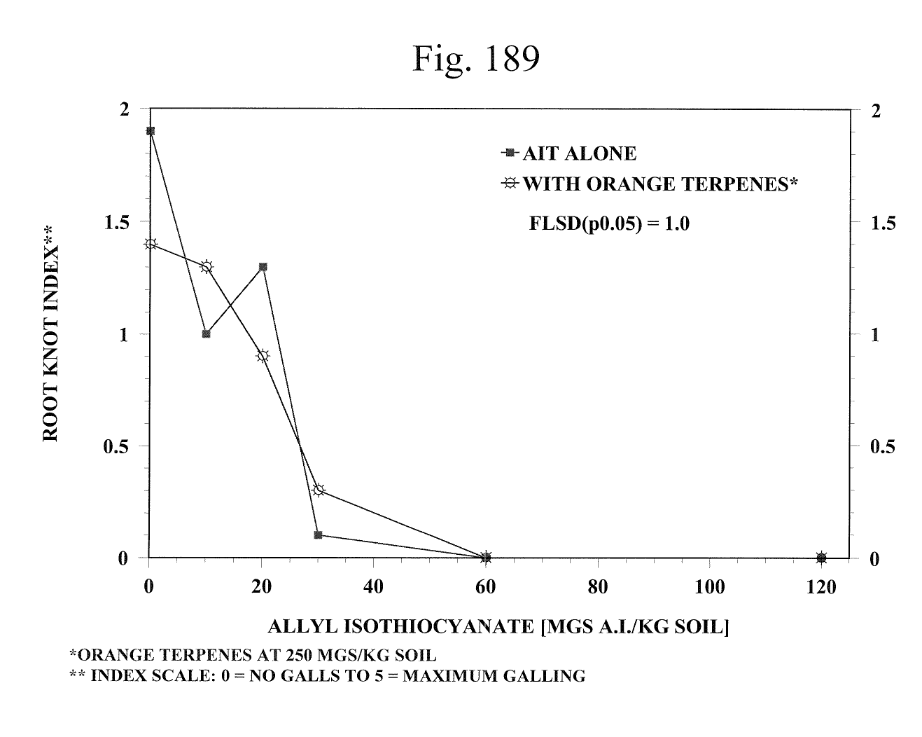

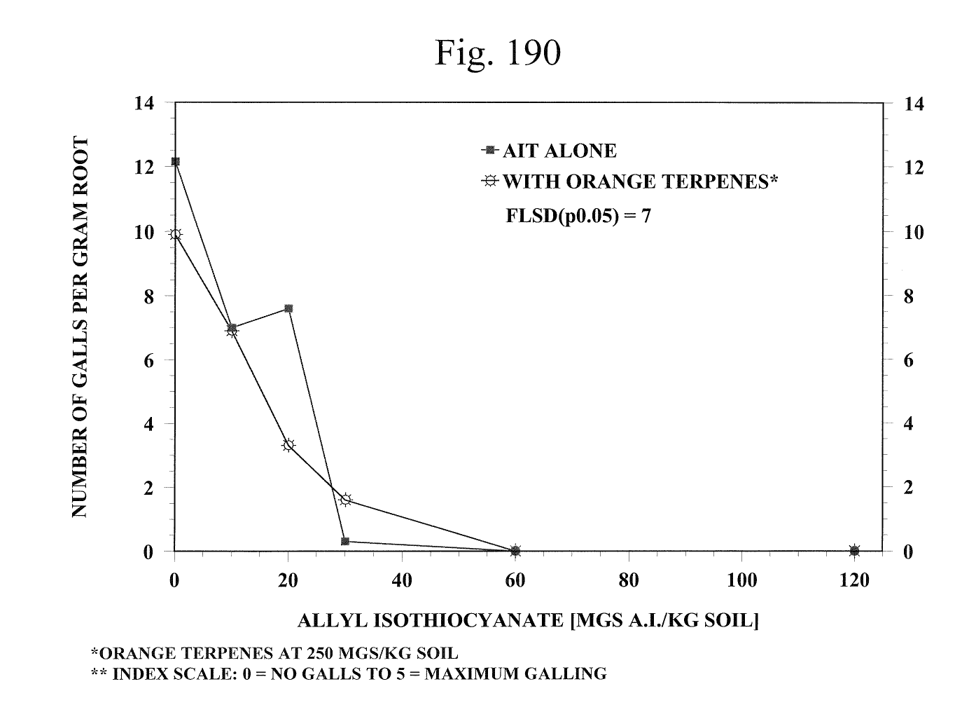

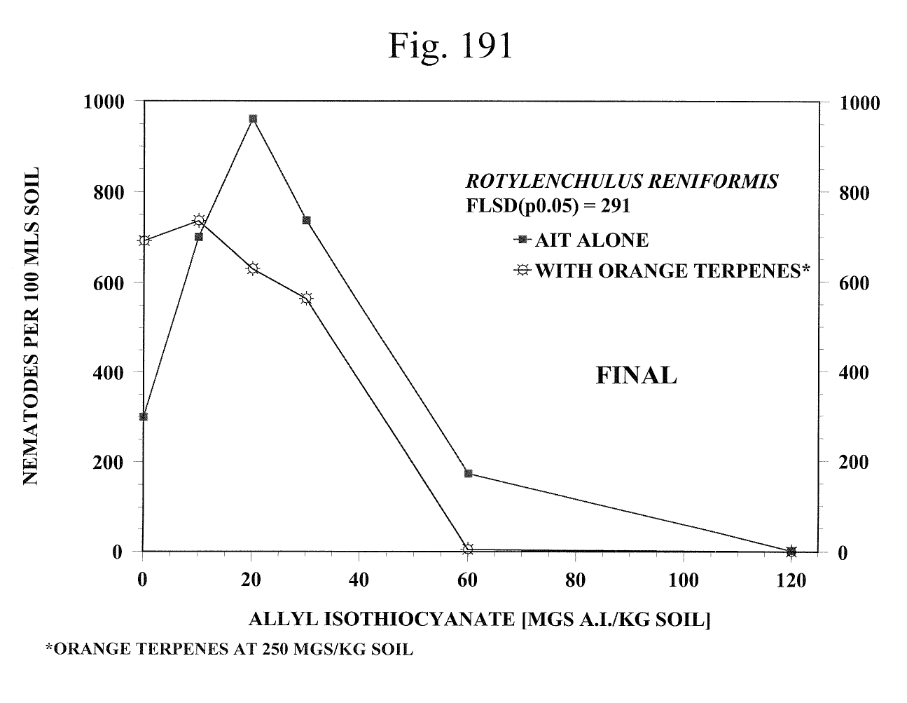

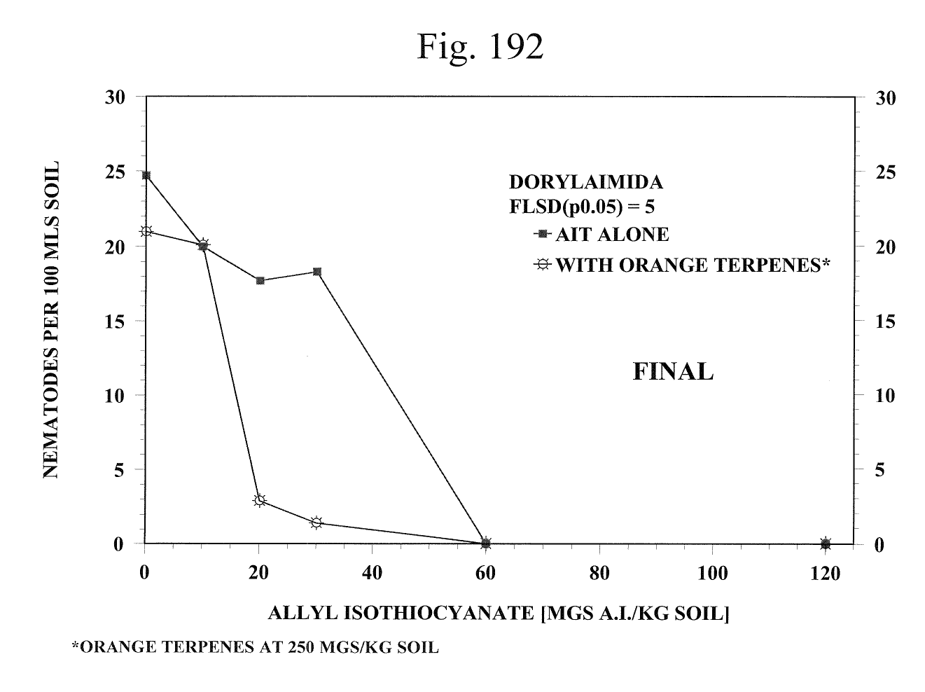

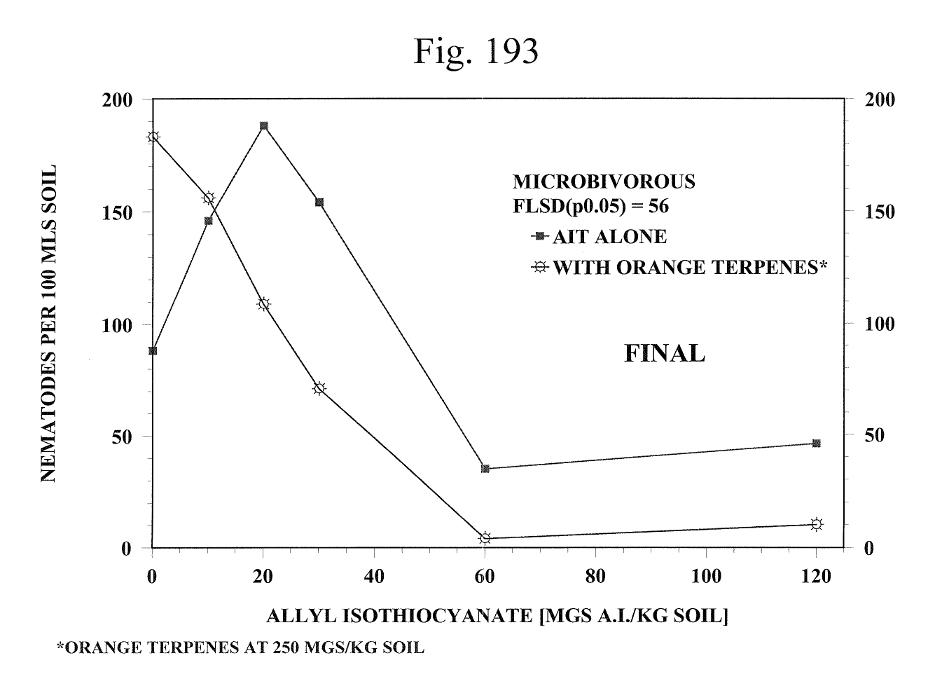

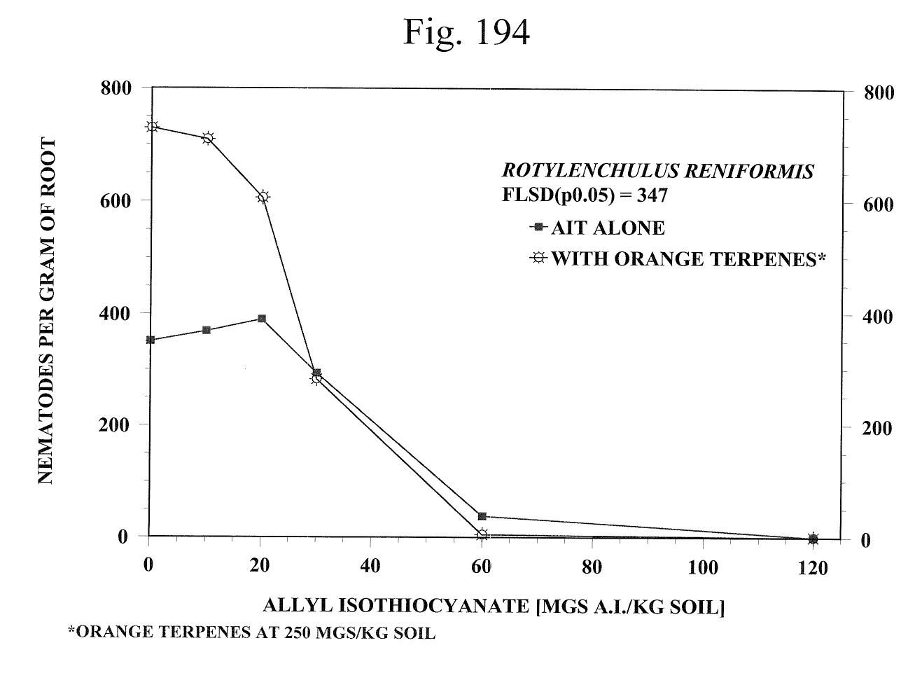

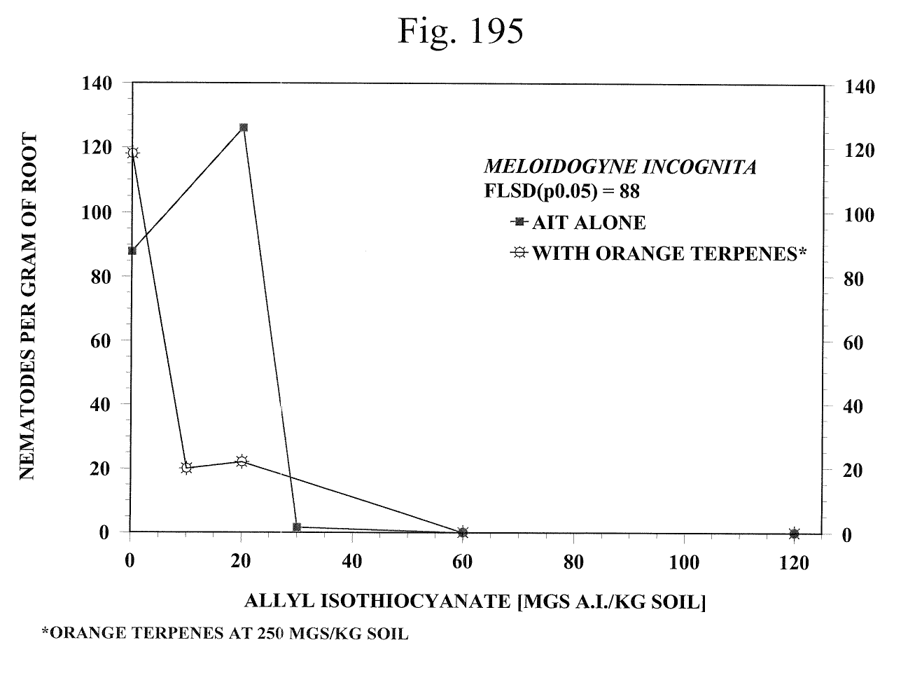

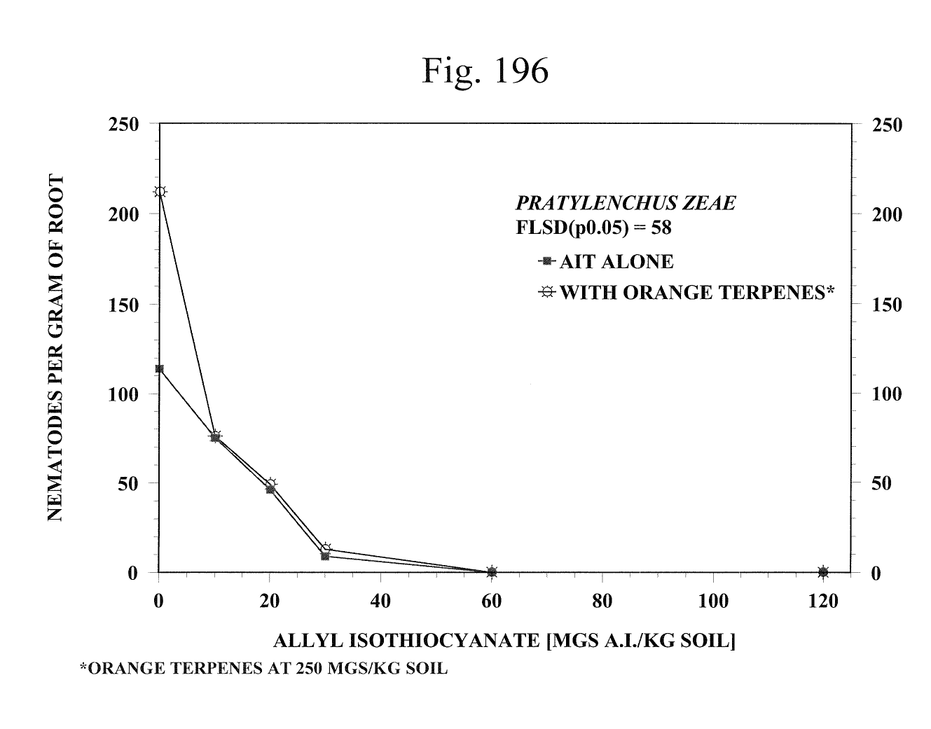

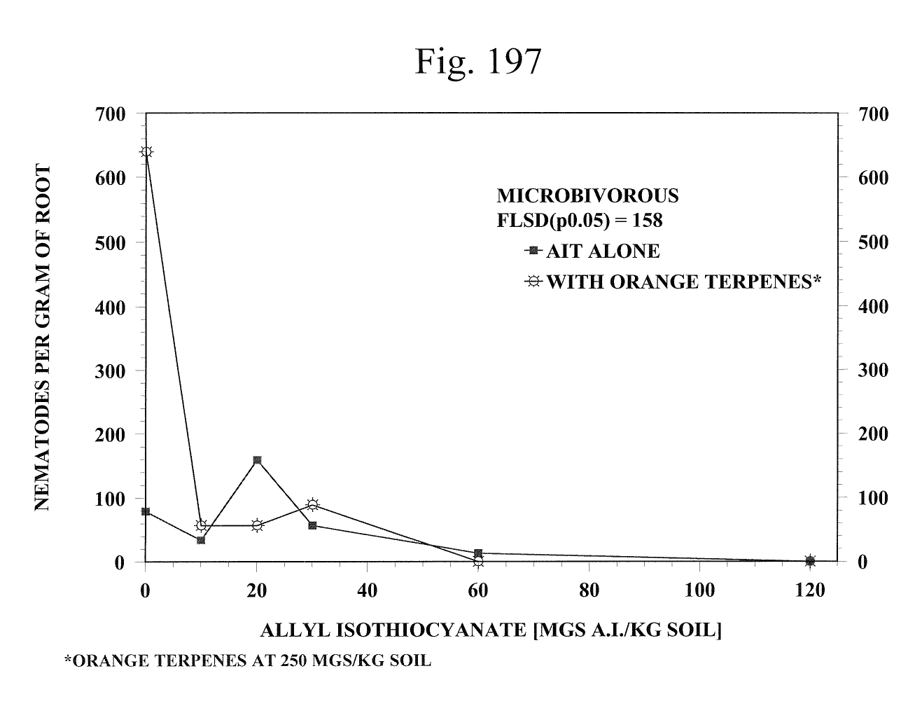

Results: A pre-plant sample of soil was taken and nematodes per 100 mls of soil was determined (FIGS. 181-183). Cucumber seeds were planted in the pots, and the number of cucumber seedlings per pot was determined fifty three (53) days later (FIG. 184). Shoot height (FIG. 185), shoot weight (FIG. 186), root weight (FIG. 187), root condition index (FIG. 188), root knot index (FIG. 189), and number of galls (FIG. 190) also were determined. The number of nematodes per 100 mls of soil and in the root system was determined (FIGS. 191-197).

Nematode Test 67

The compositions disclosed herein typically include biodiesel. However, the present inventors also tested agents other than biodiesel for use in pesticide compositions. These other agents included orange terpenes. A 1% crotonaldehyde composition was prepared by adding 10 g crotonaldehyde (Aldrich Chemical Co.), 1 ml of poly80 emulsifier mix to demineralized water and bringing the final volume to 1 L. A 5% orange terpene composition was prepared by adding 50 g orange terpene, 3 mls of poly80 emulsifier mix to demineralized water and bringing the final volume to 1 L.

Soil that was naturally infected with nematodes was combined with sand (1:1) to prepare a soil mixture for testing. One kilogram of the soil mixture was added to seven (7) pots for each test mixture. Testing was performed by drenching soil with 100 mls of test compositions as indicated in Table 12.

TABLE 12

| | Croton- | | Orange | Orange |
|---|---|---|---|---|
| | aldehyde | Croton- | Terpene | Terpene |
| | (mls 1% emul/ | aldehyde | (mls 5% | (mg/kg |
| Test | kg soil) | (mg/kg soil) | sol/kg soil) | soil) |
| Control | | | | |
| Crotonaldehyde | 5 | 50 | 0 | 0 |
| “” | 10 | 100 | 0 | 0 |
| “” | 15 | 150 | 0 | 0 |
| “” | 20 | 200 | 0 | 0 |
| “” | 25 | 250 | 0 | 0 |
| Crotonaldehyde + | 5 | 50 | 5 | 250 |
| Orange | | | | |
| Terpene | | | | |
| “” | 10 | 100 | 5 | 250 |
| “” | 15 | 150 | 5 | 250 |
| “” | 20 | 200 | 5 | 250 |
| “” | 25 | 250 | 5 | 250 |
| Orange | 0 | 0 | 5 | 250 |
| Terpene | | | | |
| Orange | 0 | 0 | 10 | 500 |
| Terpene | | | | |
| Control | | | | |
| Sand | | | | |

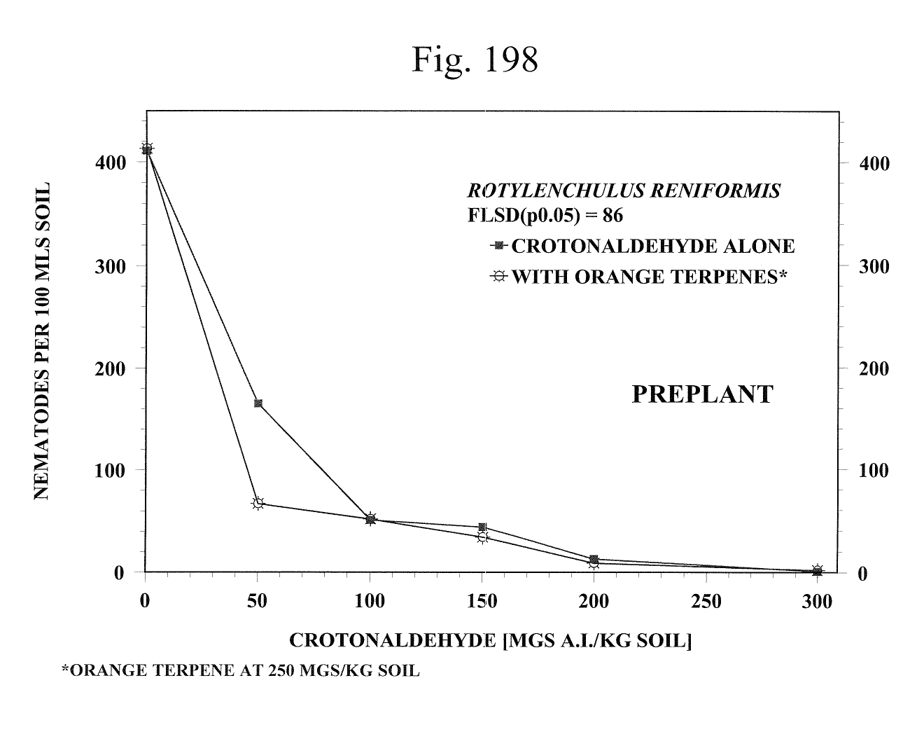

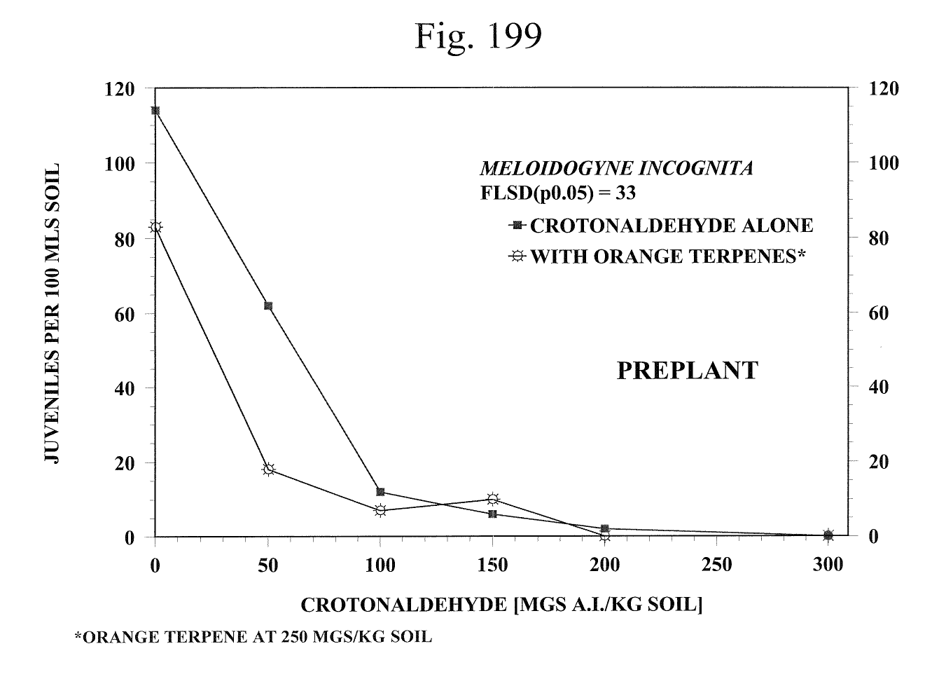

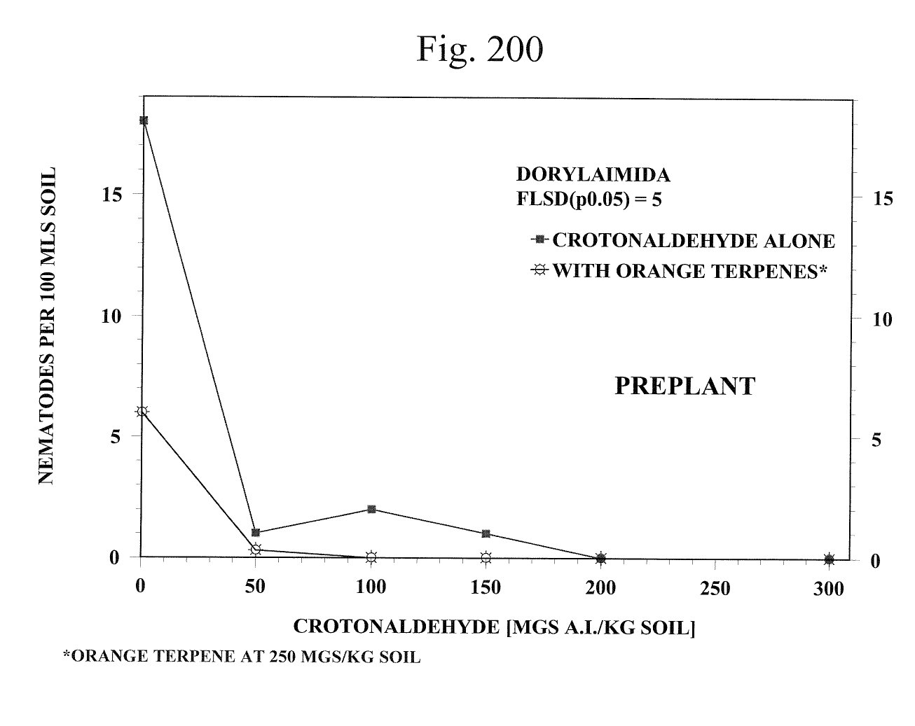

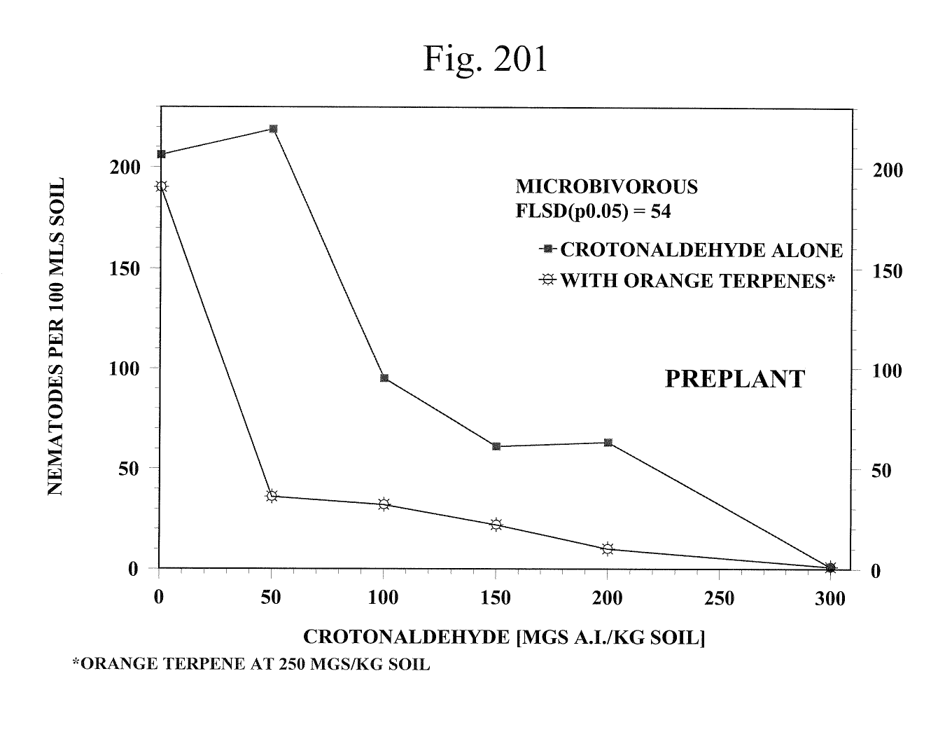

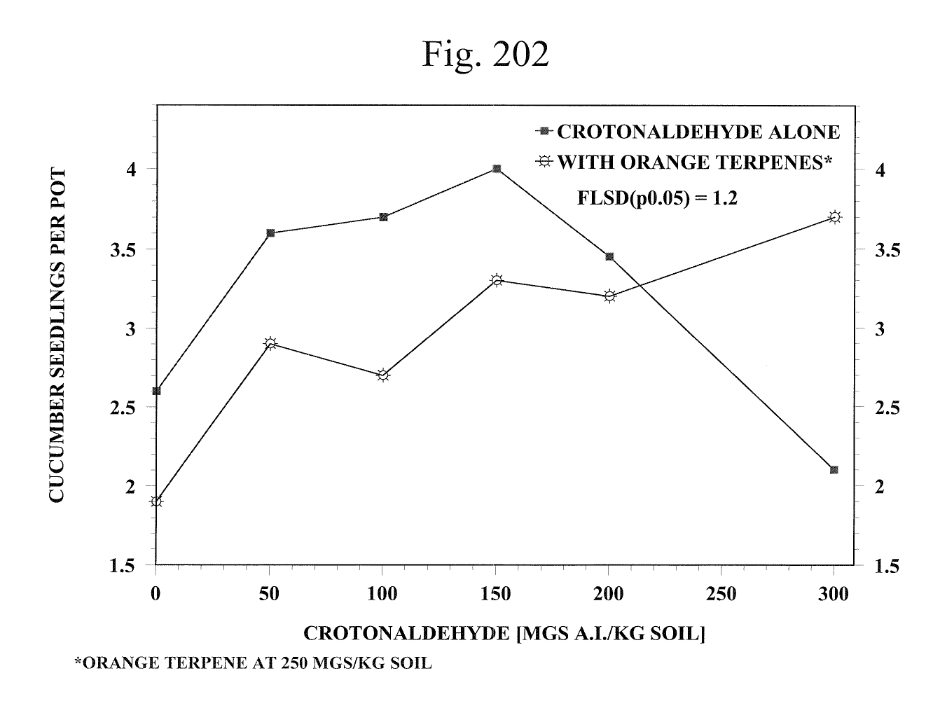

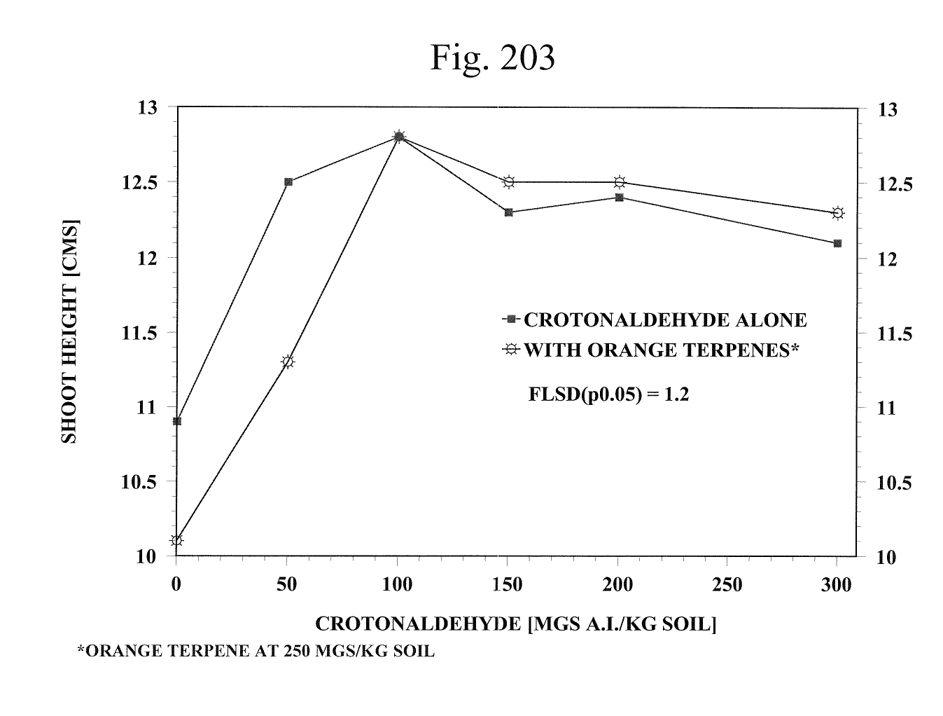

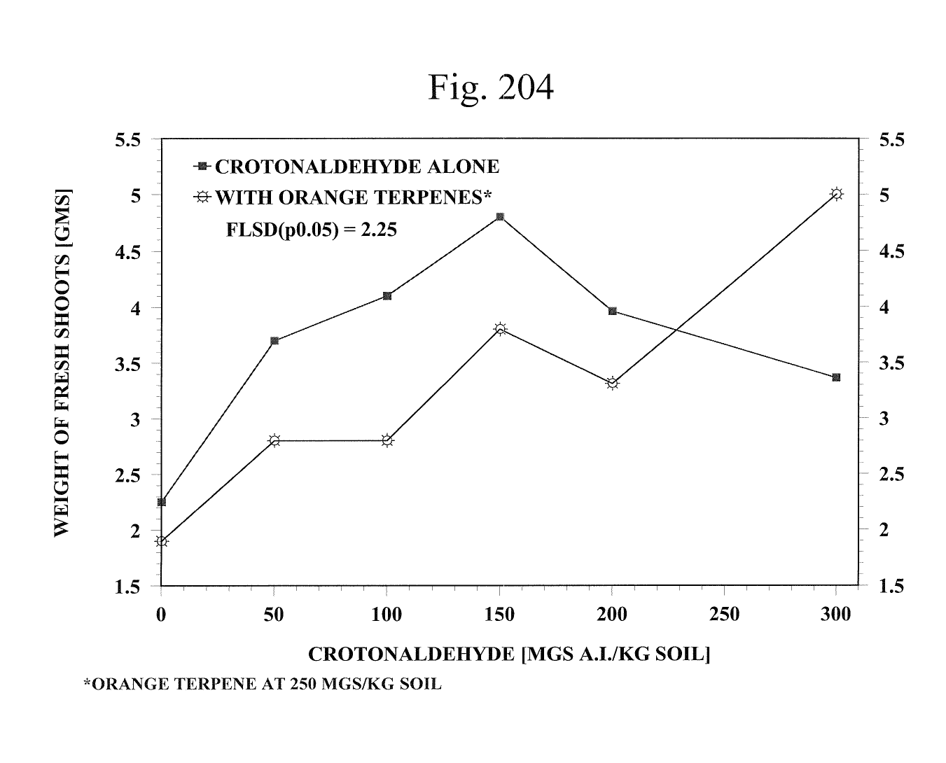

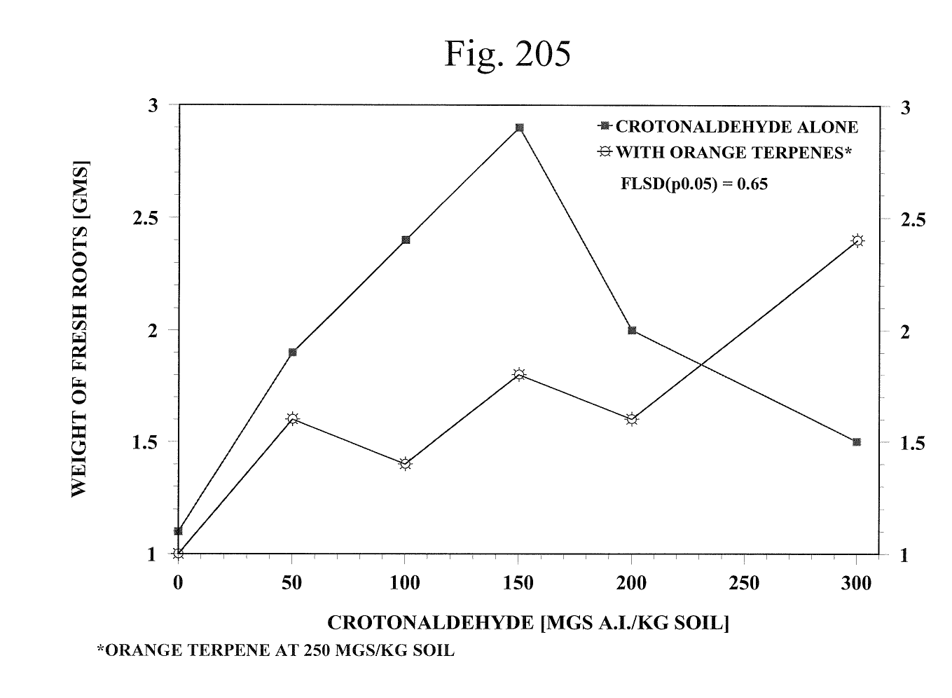

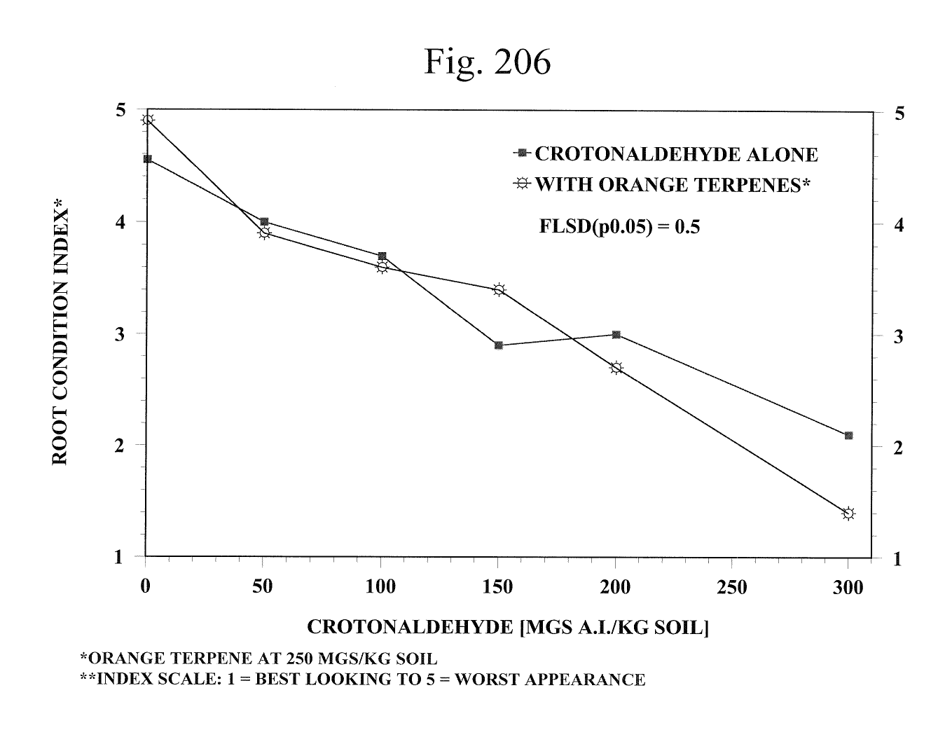

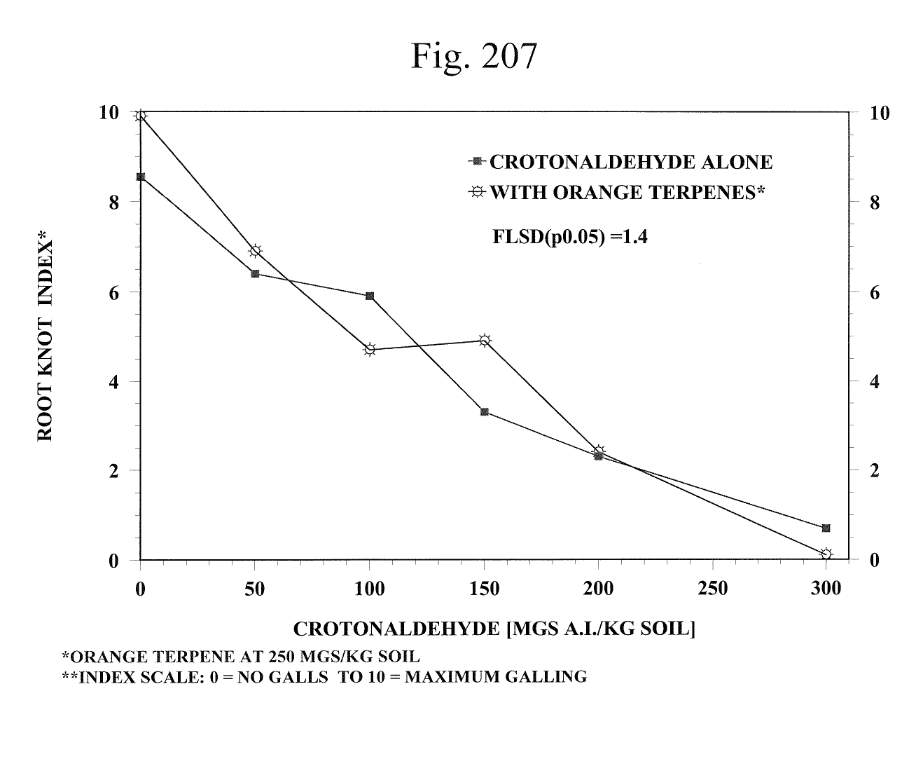

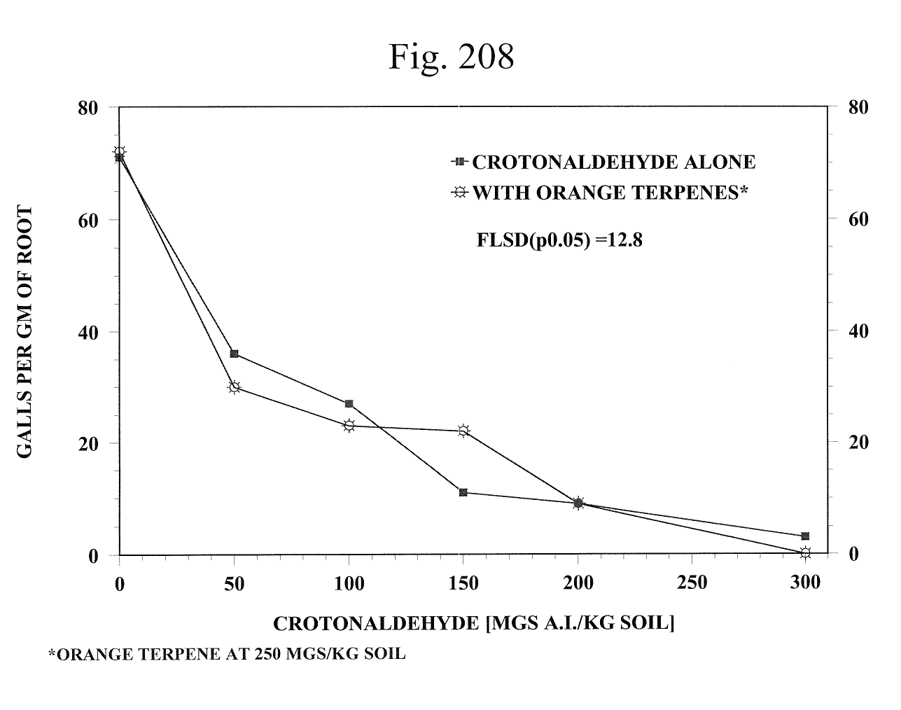

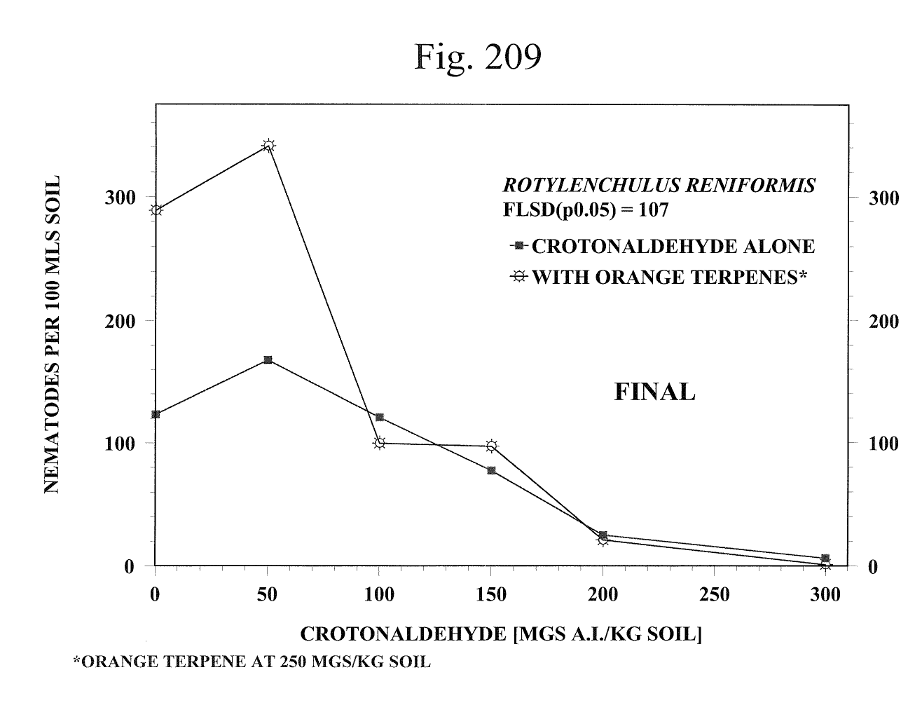

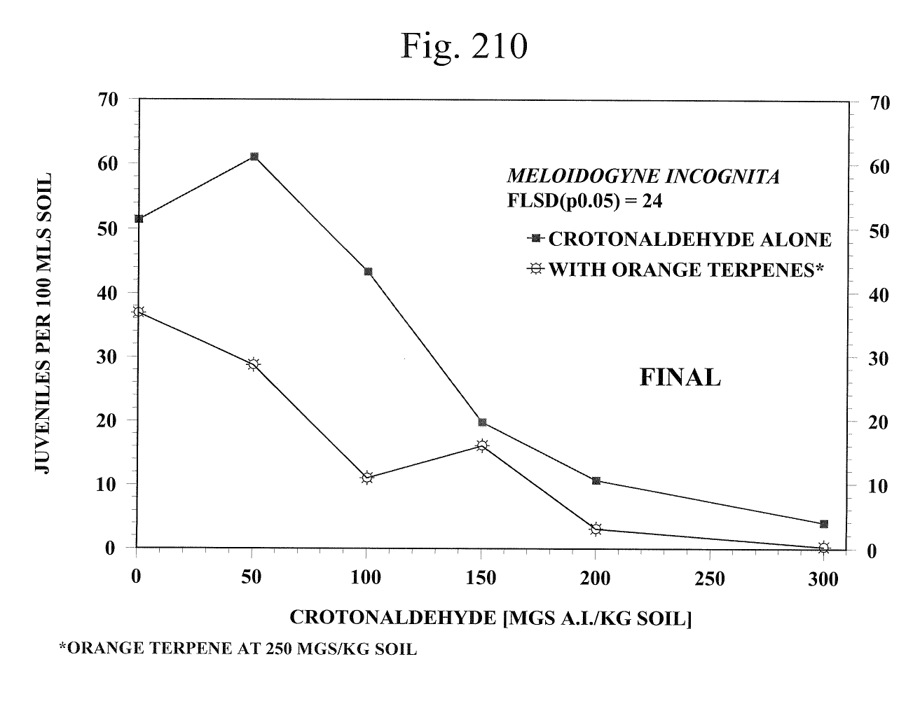

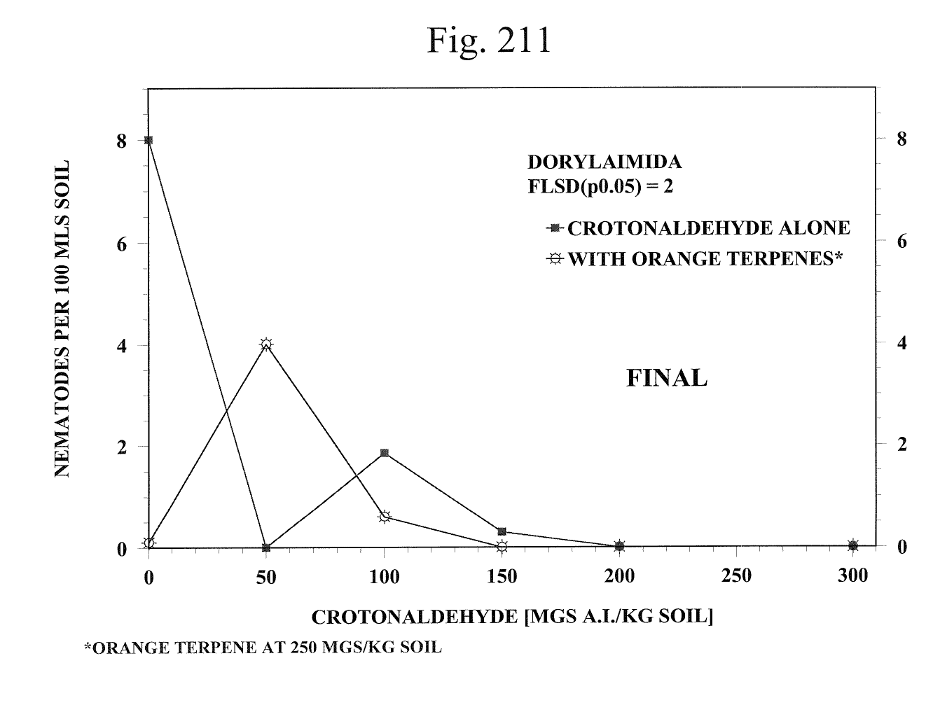

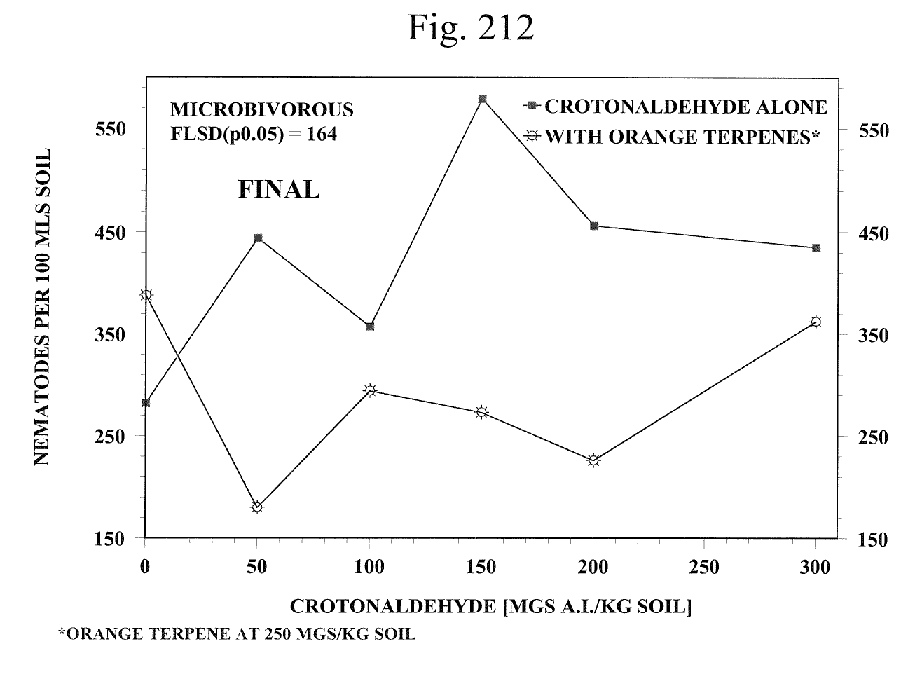

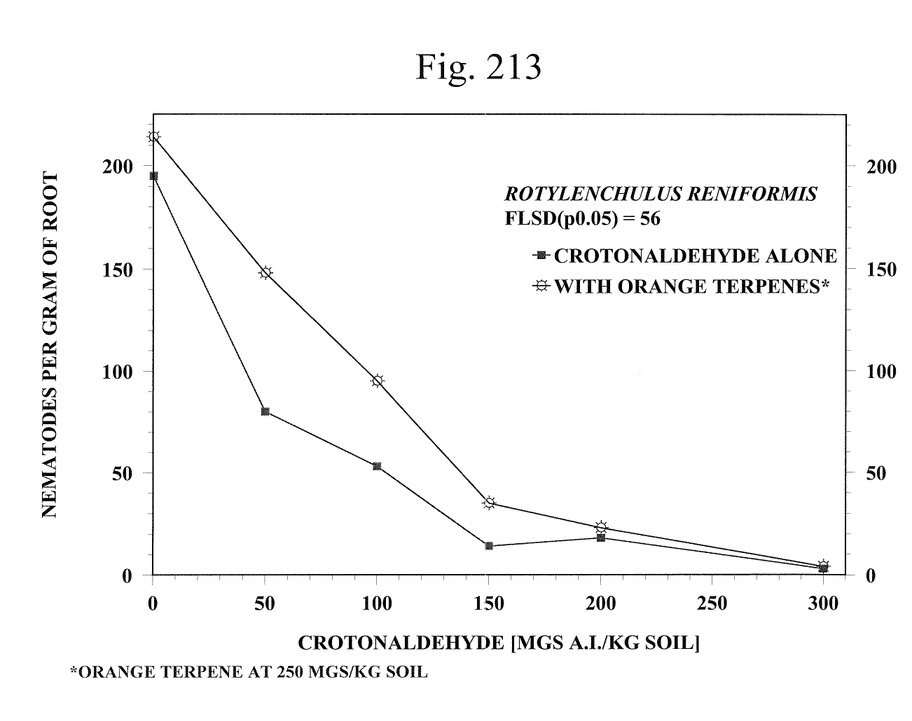

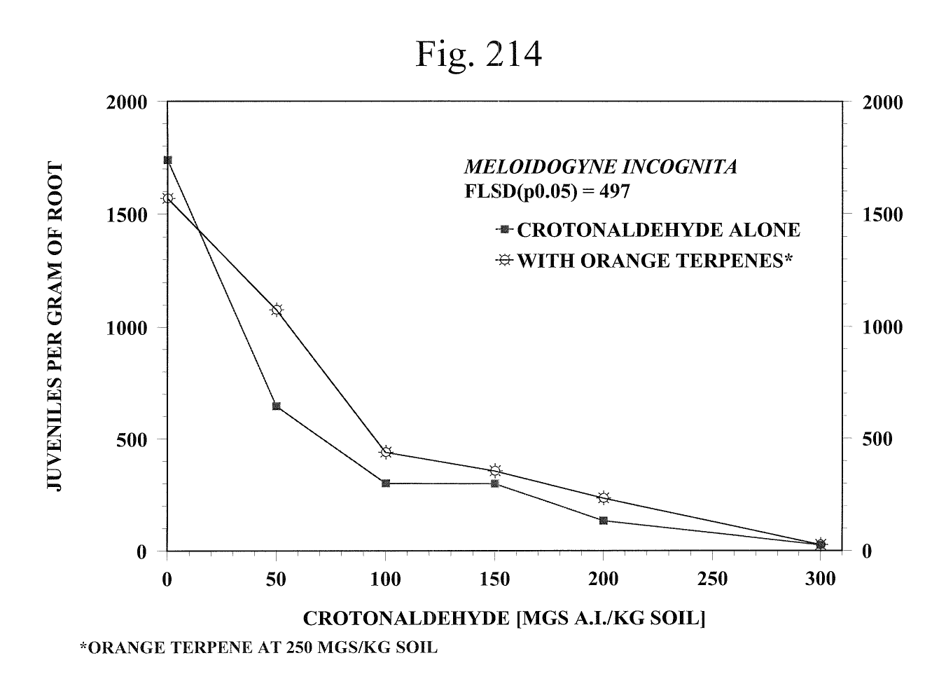

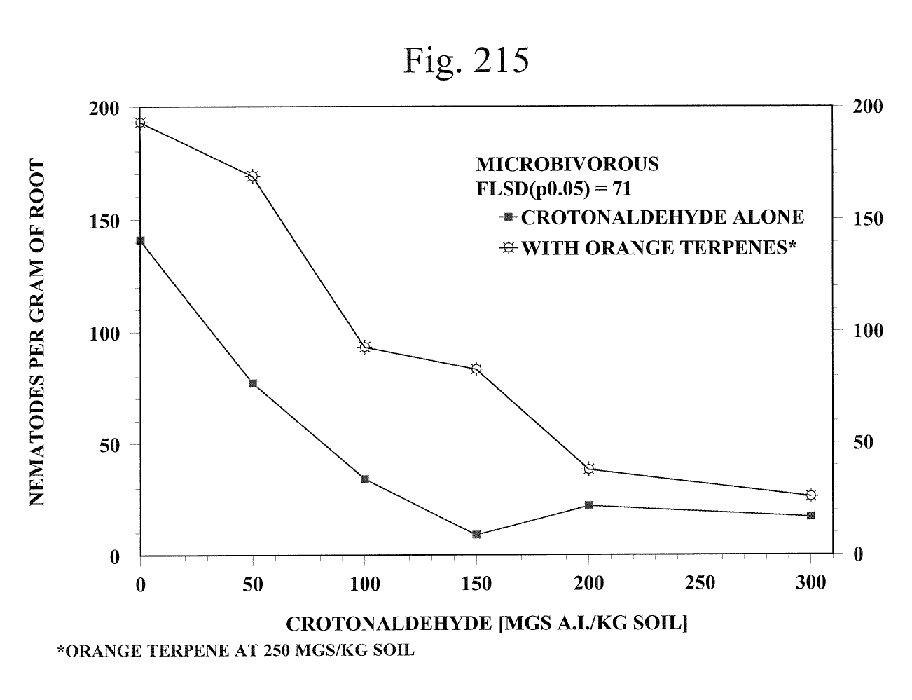

A pre-plant sample of soil was taken and nematodes per 100 mls of soil was determined (FIGS. 198-201). Cucumber seeds were planted in the pots, and the number of cucumber seedlings per pot was determined fifty-six (56) days later (FIG. 202). Shoot height (FIG. 203), shoot weight (FIG. 204), root weight (FIG. 205), root condition index (FIG. 206), root knot index (FIG. 207), and number of galls (FIG. 208) also were determined. The number of nematodes per 100 mls of soil and in the root system was determined (FIGS. 209-215).

Nematode Test 70

Salicylaldehyde and cinnamaldehyde were tested as pesticide actives. A 1% salicylaldehyde composition was prepared by adding 20 g of salicylaldehyde, 5 g Poly80 mix emulsifier to demineralized water and bringing the final volume to 2 L with stirring. A 1% cinnamaldehyde composition was prepared by adding 20 g of cinnamaldehyde, 5 g Poly80 mix emulsifier to demineralized water and bringing the final volume to 2 L with stirring.

Soil that was naturally infected with nematodes was combined with sand (1:1) to prepare a soil mixture for testing. One kilogram of the soil mixture was added to seven (7) pots for each test mixture. Testing was performed by drenching soil with 100 mls of test compositions as indicated in Table 13.

TABLE 13

| | ai | |
|---|---|---|
| | (mls 1% emulsion/ | ai |
| Test | kg soil) | (mg/kg soil) |
| Control | | |
| Salicylaldehyde | 5 | 50 |
| “” | 10 | 100 |
| “” | 20 | 200 |
| “” | 30 | 300 |
| “” | 40 | 400 |
| “” | 50 | 500 |
| Cinnamaldehyde | 5 | 50 |
| “” | 10 | 100 |
| “” | 20 | 200 |
| “” | 30 | 300 |
| “” | 40 | 400 |
| “” | 50 | 500 |
| Control | | |

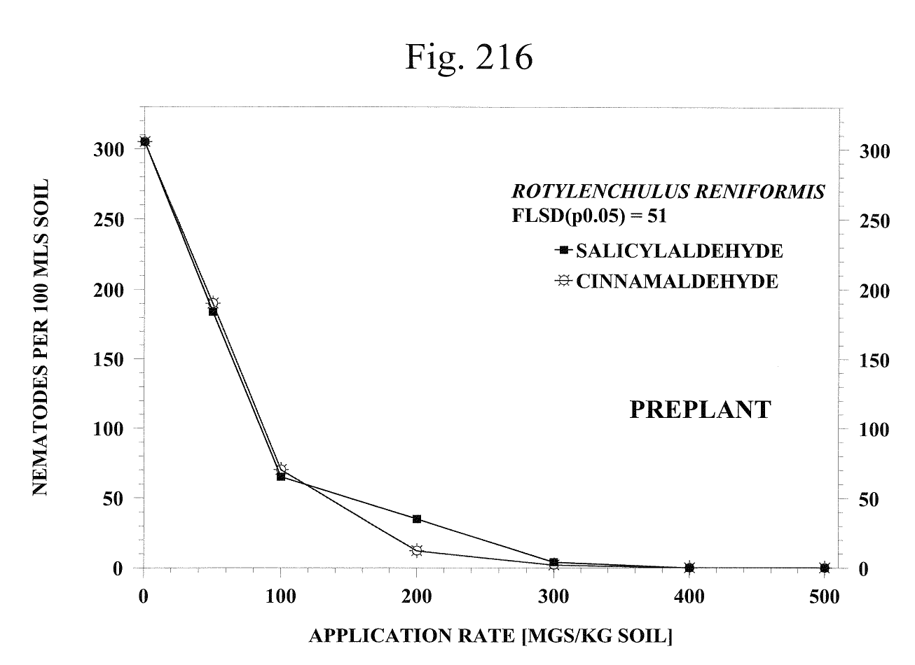

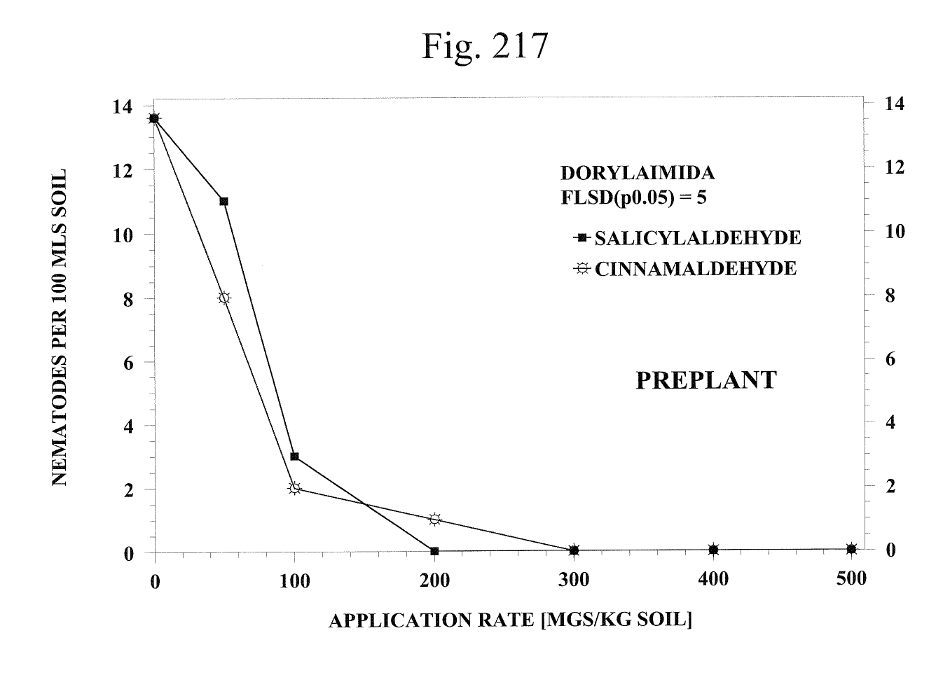

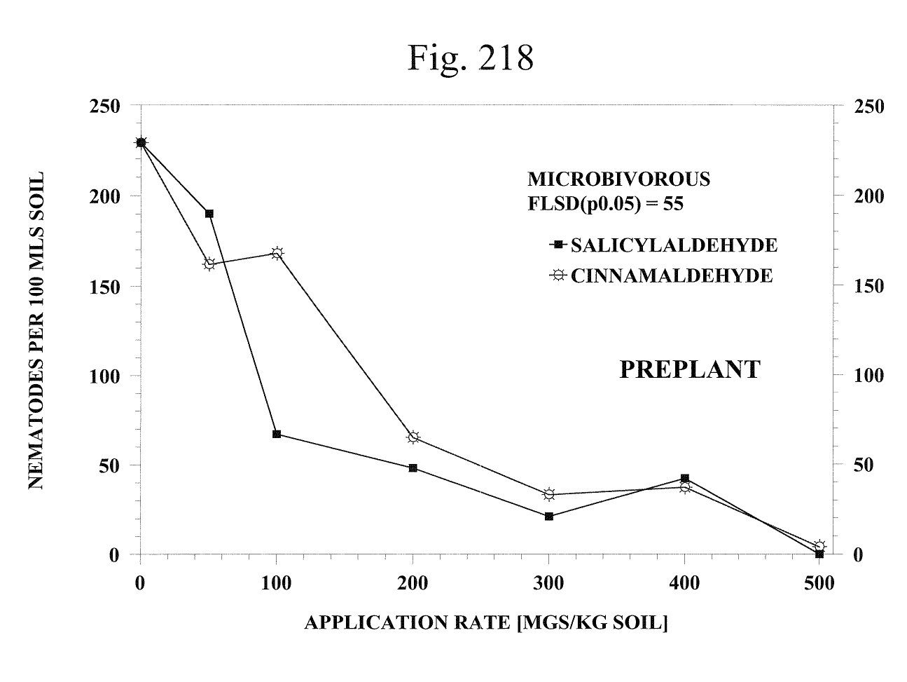

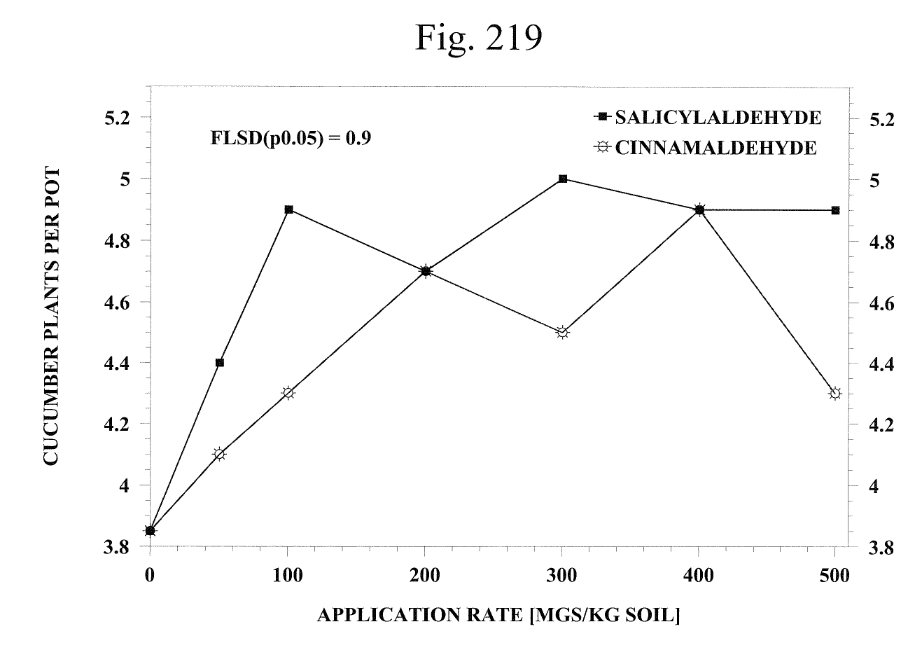

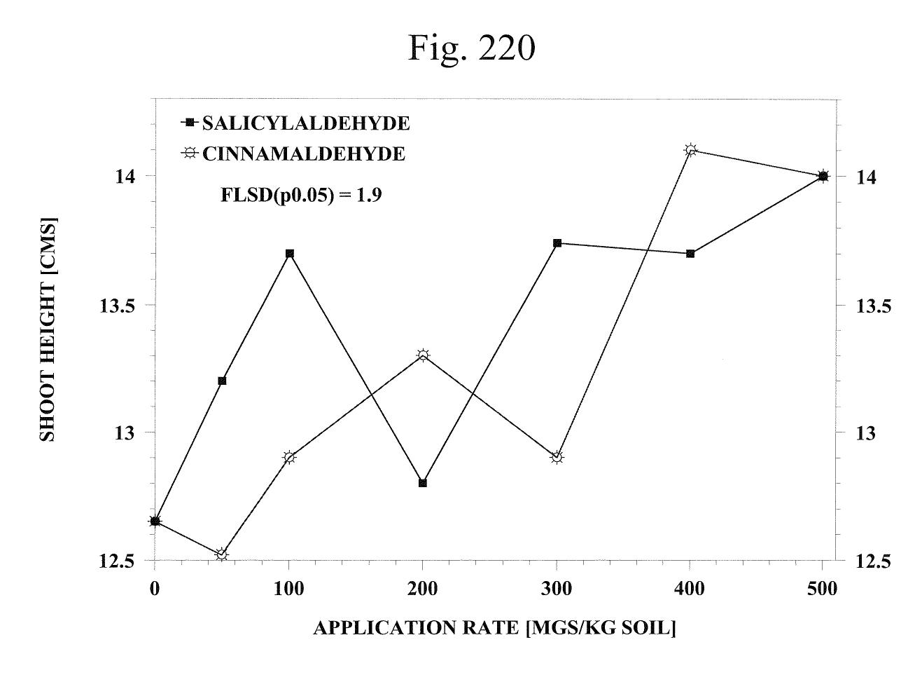

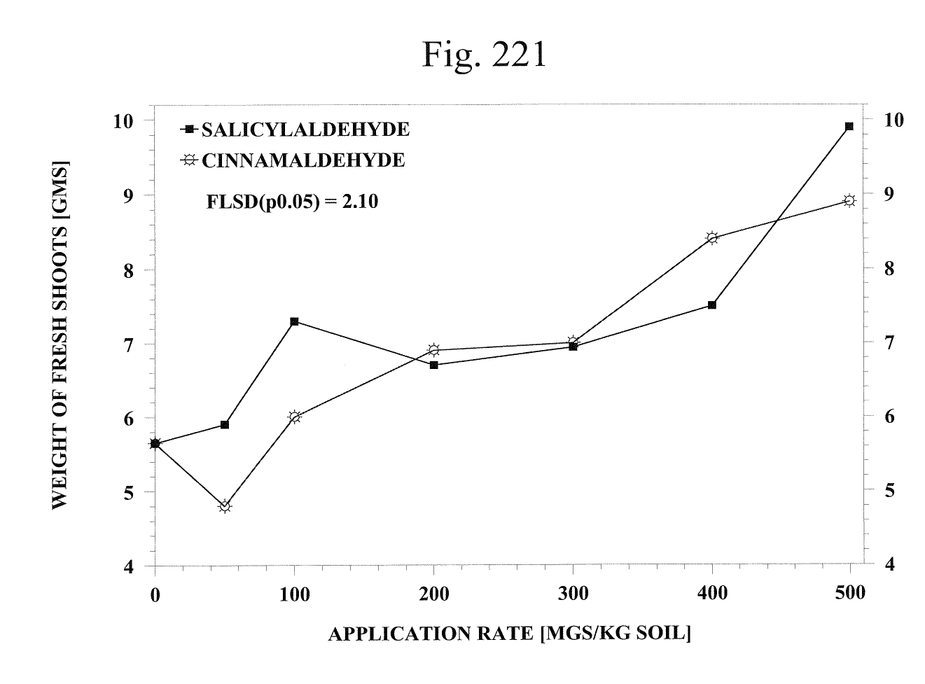

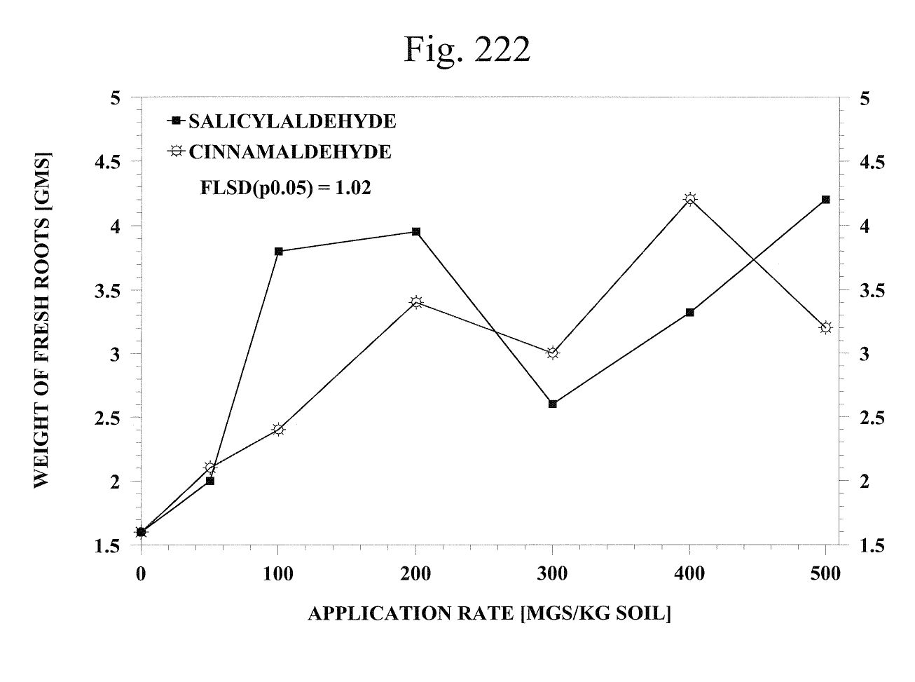

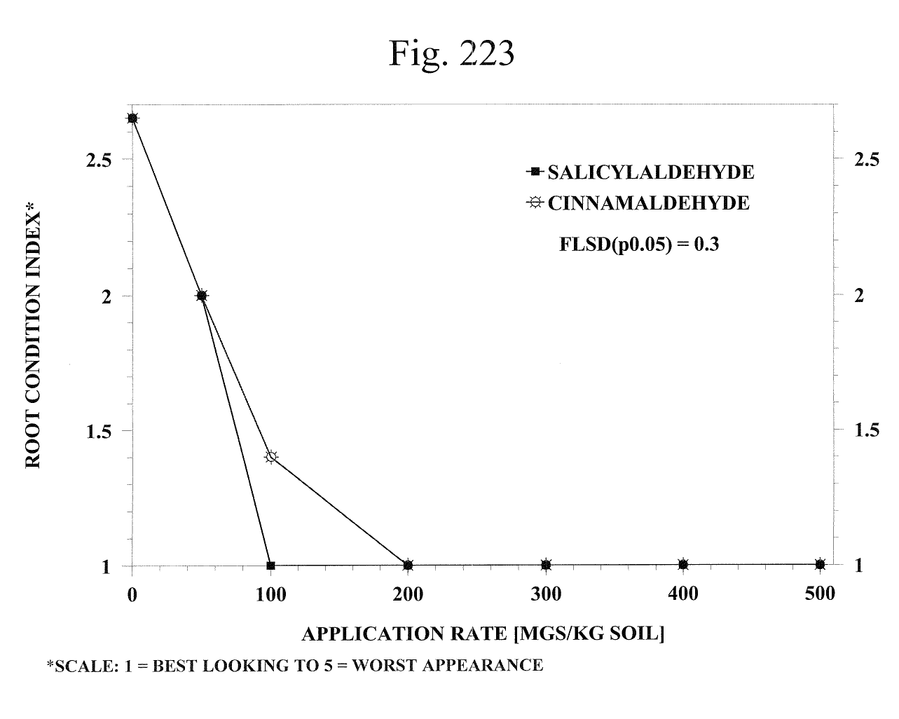

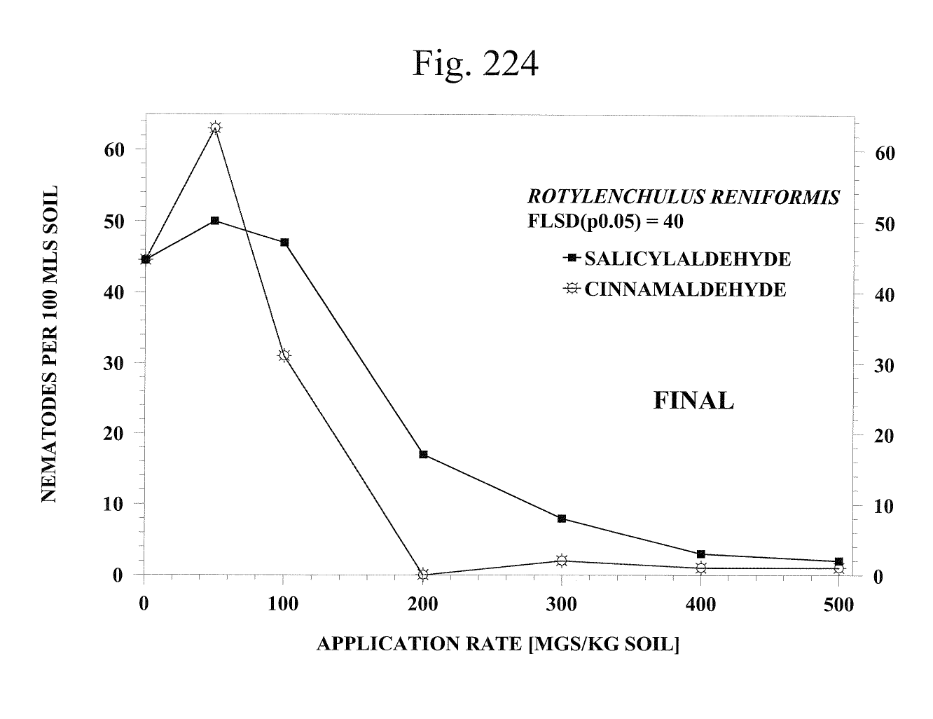

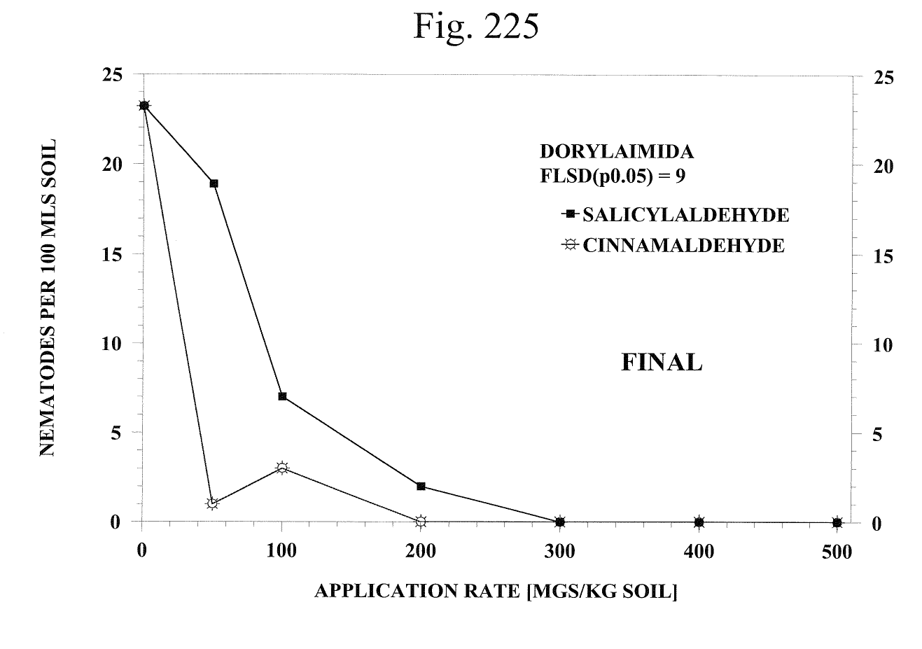

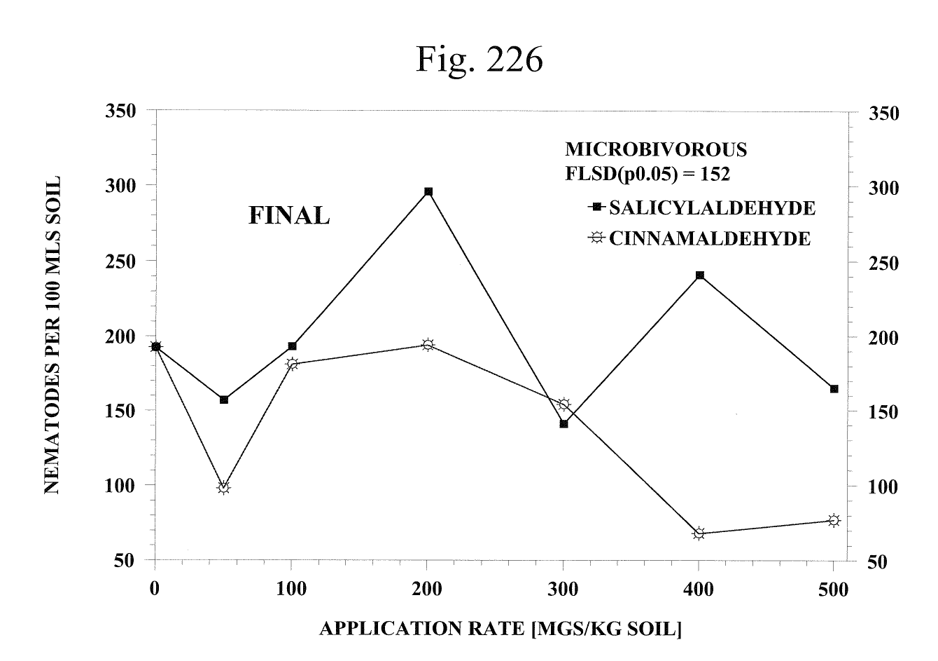

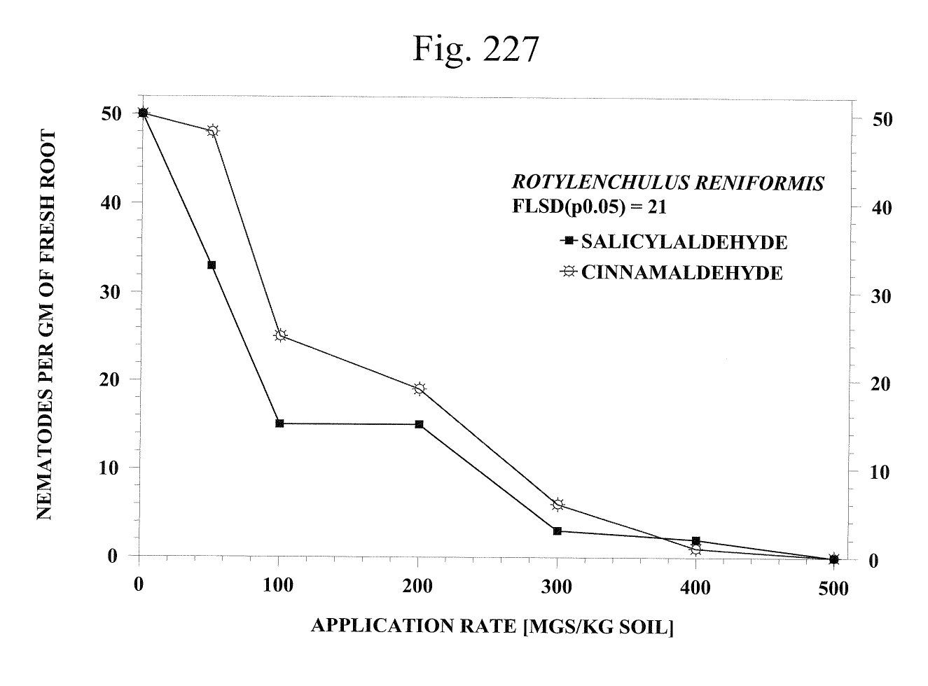

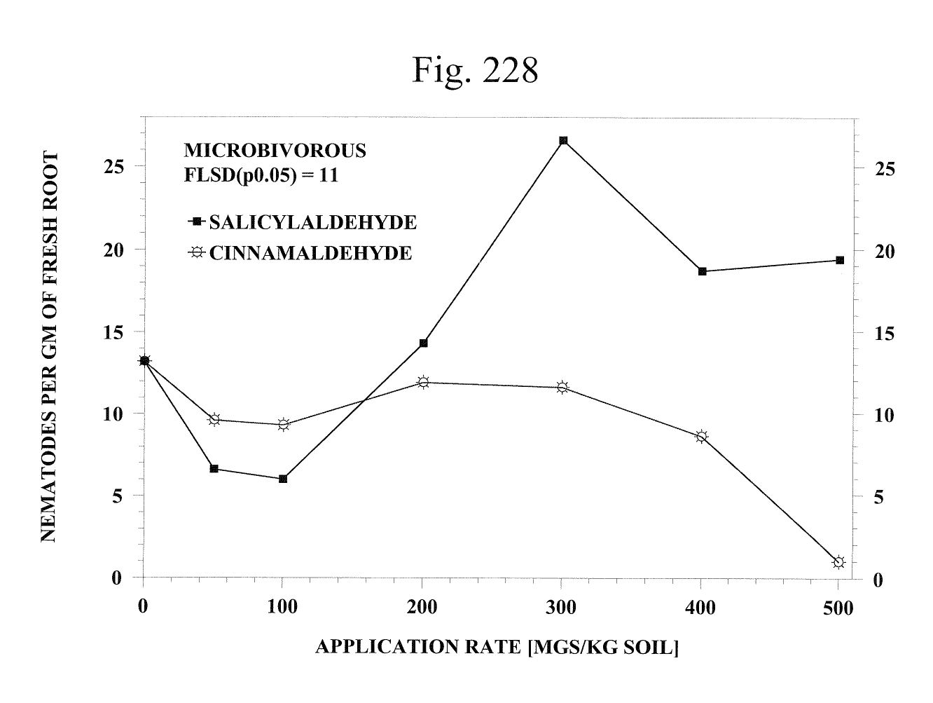

A pre-plant sample of soil was taken and nematodes per 100 mls of soil was determined (FIGS. 216-218). Cucumber seeds were planted in the pots, and the number of cucumber seedlings per pot was determined thirty-five (35) days later (FIG. 219). Shoot height (FIG. 220), shoot weight (FIG. 221), root weight (FIG. 222), root and condition index (FIG. 223) also were determined. The number of nematodes per 100 mls of soil and in the root system was determined (FIGS. 224-228).

Nematode Test 74

Menthol was tested as a pesticide active. A menthol-glycerin stock solution was prepared by adding 40 g of menthol (Aldrich Chemical Co.) to 40 g of phosphoric acid neutralized (pH 5.78) bioglycerin stripped of volatiles in a 300 ml beaker. The mixture was warmed in a microwave to about 55-60 C (1-2 minutes). Any menthol clumps were broken up. If needed, 2 ml of Illovo mix (emulsifier) or Polysorb 80 mix was added to homogenize the somewhat opaque solution. The mixture was stirred for 1-2 hours. Active ingredient content=50%. A menthol-biodiesel stock was prepared by adding 40 g of menthol (Aldrich Chemical Co.) and 40 g of biodiesel (AL Biodiesel, Moundville, Ala.) in a 300 ml beaker. The mixture was warmed in a microwave to about 55-60 C (1-2 minutes). Any menthol clumps were broken up. If needed, 2 ml of Illovo mix (emulsifier) or Polysorb 80 mix was added to homogenize the somewhat opaque solution. The mixture was stirred for 1-2 hours. Active ingredient content=50%. A 2% emulsion of each of the stock solutions was prepared by diluting 40 ml of the stock solution in demineralized water to 2 L.

Soil that was naturally infected with nematodes was combined with sand (1:1) to prepare a soil mixture for testing. One kilogram of the soil mixture was added to seven (7) pots for each test mixture. Testing was performed by drenching soil with 100 mls of test compositions as indicated in Table 14.

TABLE 14

| | ai | |
|---|---|---|
| | (mls 2% emulsion/ | ai |
| Test | kg soil) | (mg/kg soil) |
| Control | | |
| Menthol in | 10 | 200 |
| bioglycerin | | |
| “” | 20 | 400 |
| “” | 30 | 600 |
| “” | 40 | 800 |
| “” | 50 | 1000 |
| “” | 60 | 1200 |
| Menthol in | 10 | 200 |
| biodiesel | | |
| “” | 20 | 400 |
| “” | 30 | 600 |
| “” | 40 | 800 |
| “” | 50 | 1000 |
| “” | 60 | 1200 |
| Control | | |

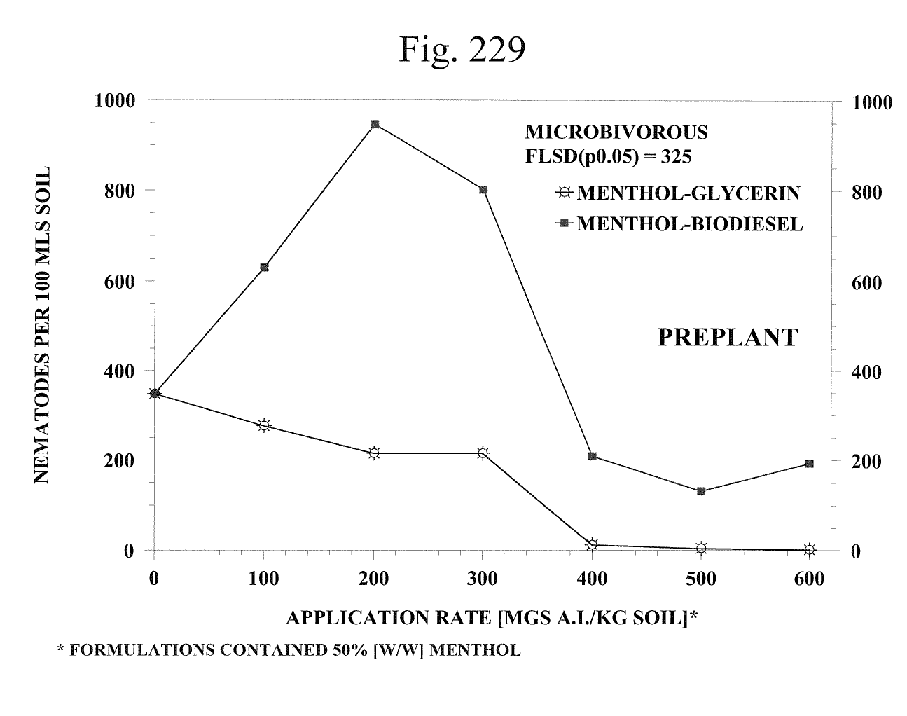

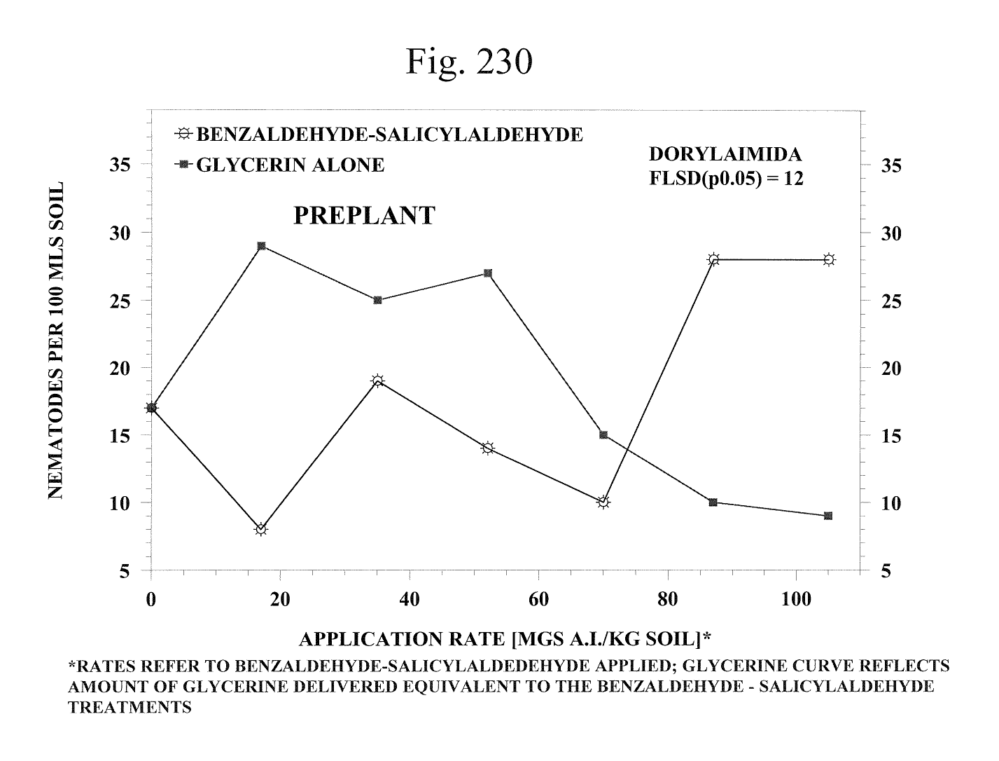

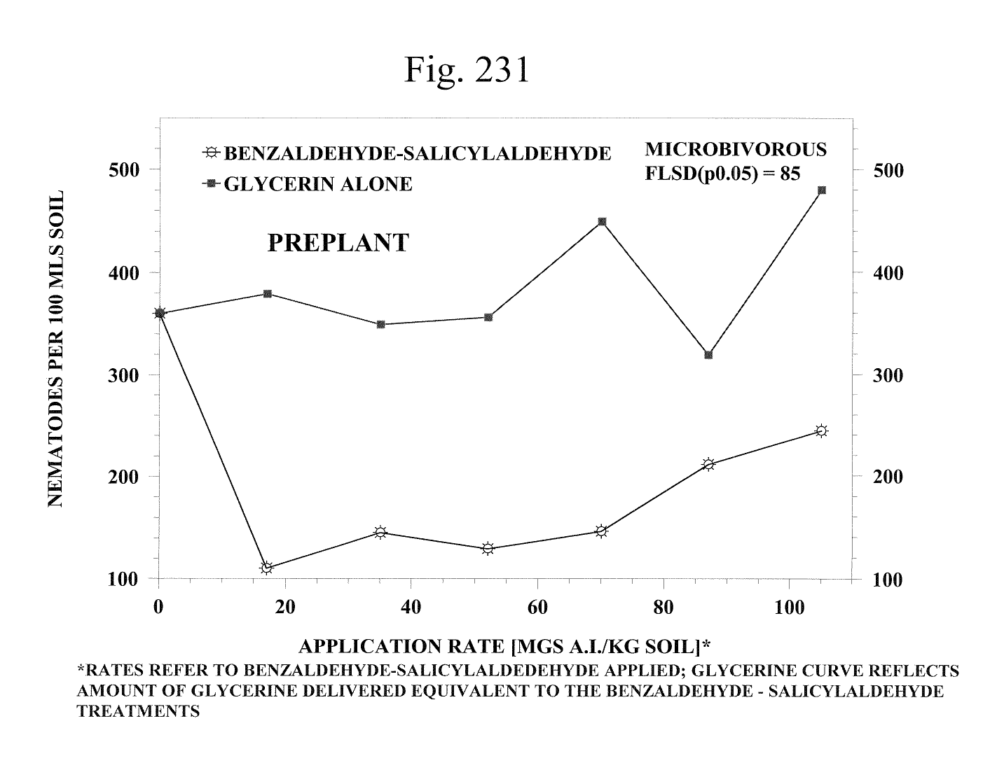

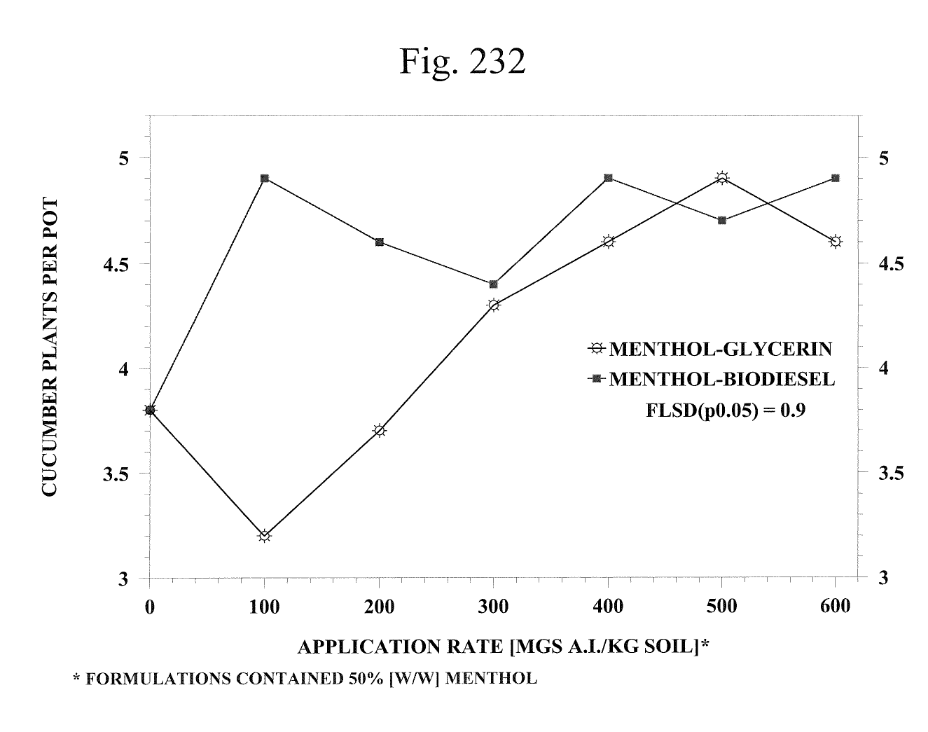

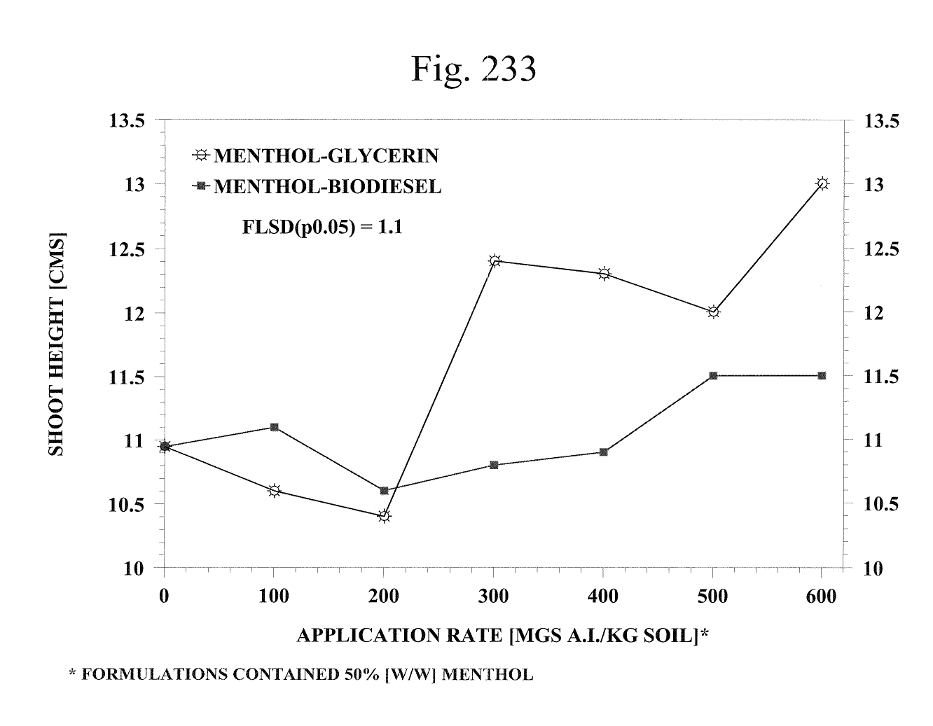

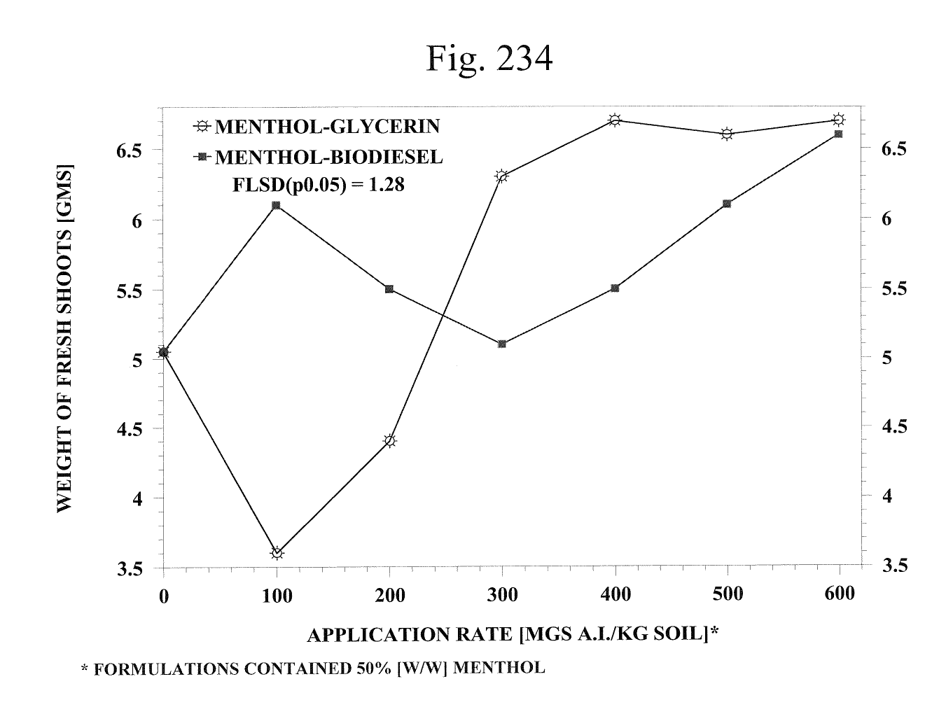

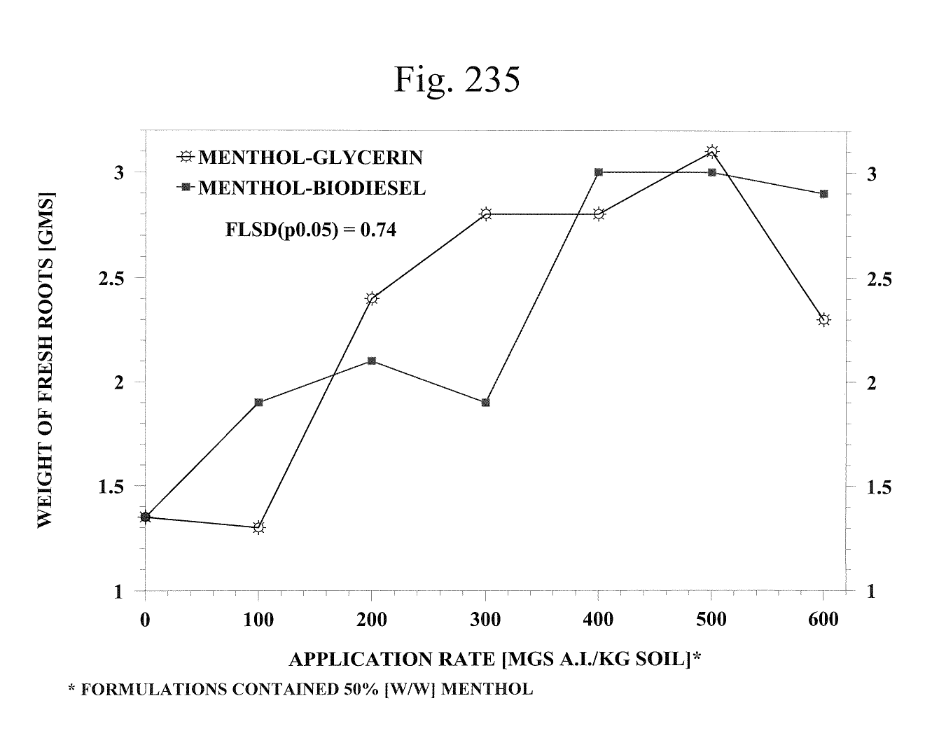

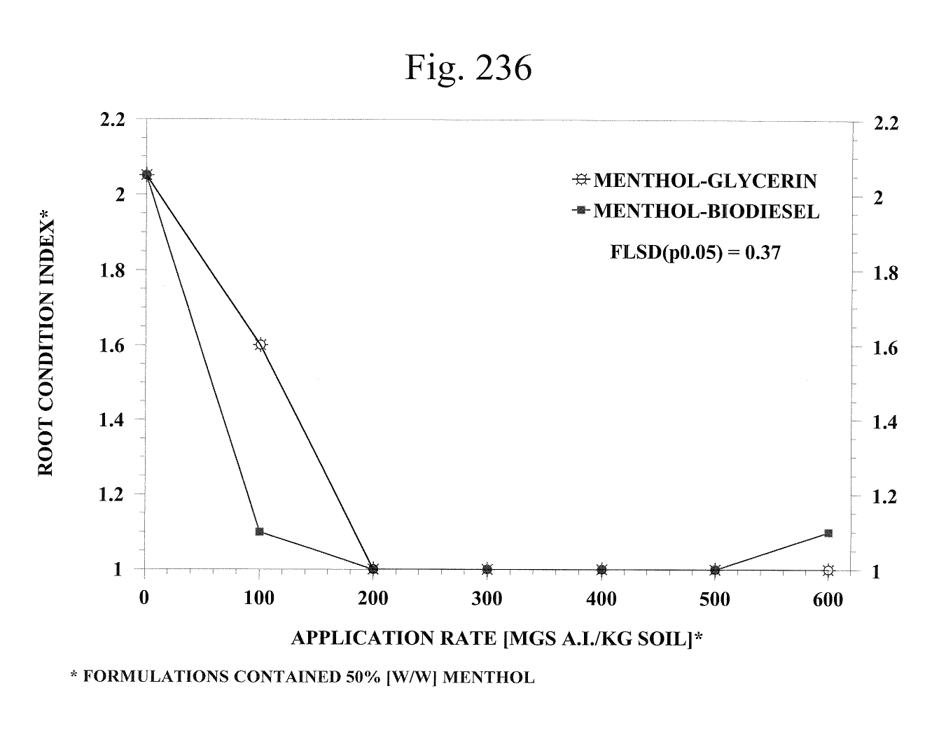

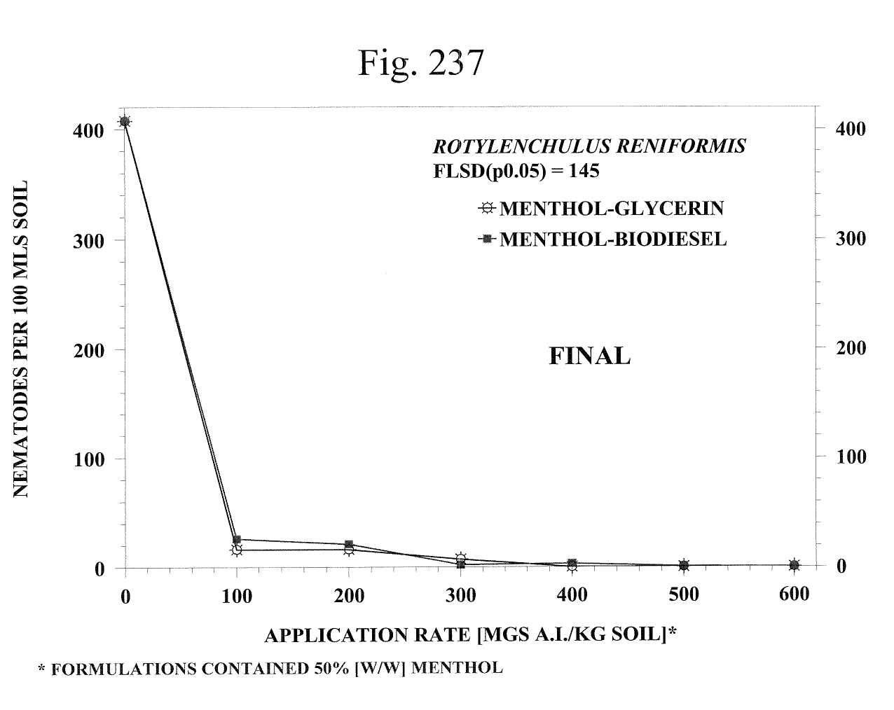

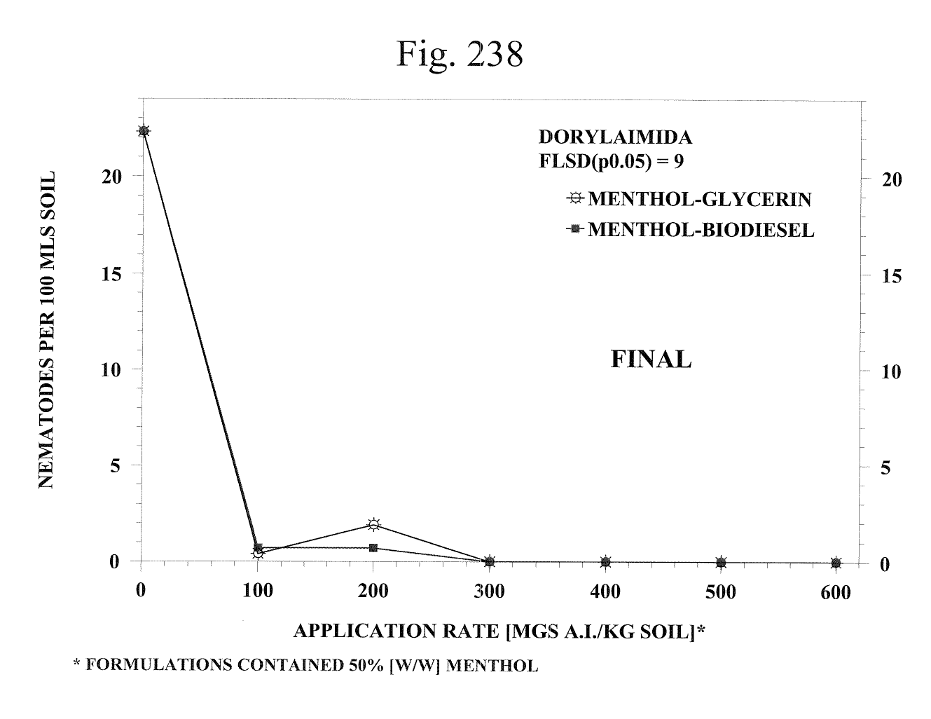

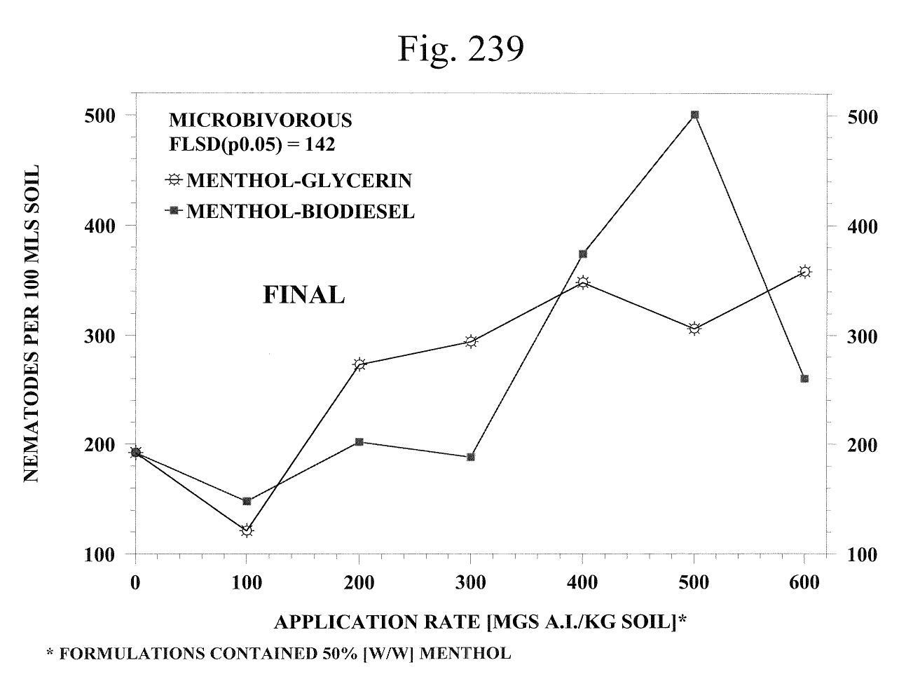

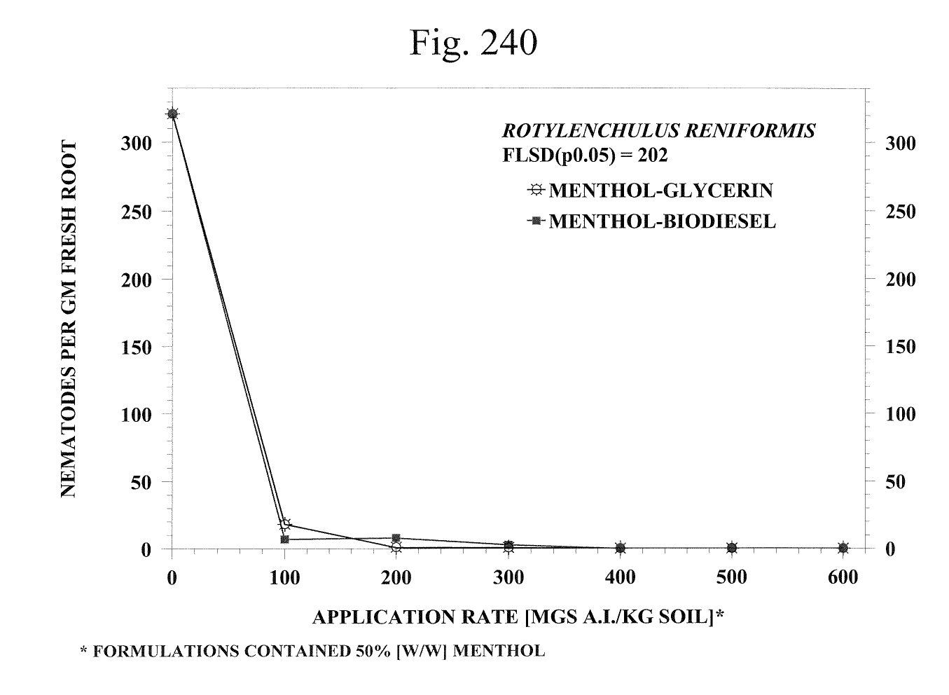

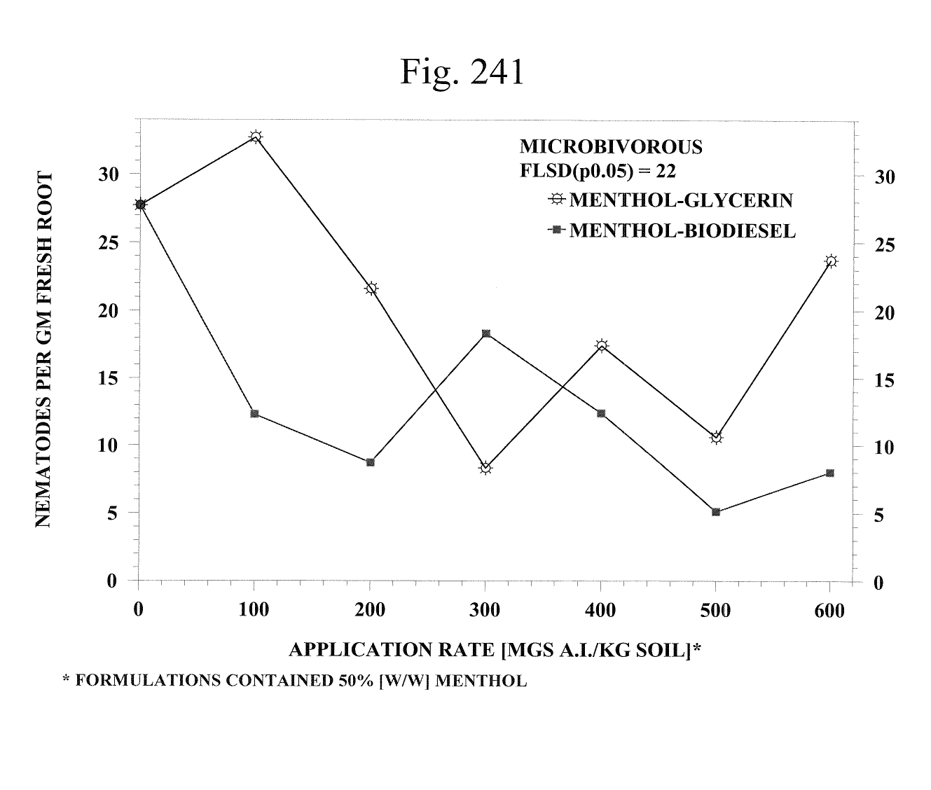

A pre-plant sample of soil was taken and nematodes per 100 mls of soil was determined (FIGS. 229-231). Cucumber seeds were planted in the pots, and the number of cucumber seedlings per pot was determined forty-two (42) days later (FIG. 232). Shoot height (FIG. 233), shoot weight (FIG. 234), root weight (FIG. 235), root and condition index (FIG. 236) also were determined. The number of nematodes per 100 mls of soil and in the root system was determined (FIGS. 237-241).

Nematode Test 75

Benzaldehyde and salicylaldehyde were tested as pesticide actives. A 2% benzaldehyde composition was prepared by adding 40 g of salicylaldehyde, 10 ml Poly80 mix emulsifier (Tween) to demineralized water and bringing the final volume to 2 L with stirring. A 2% salicylaldehyde composition was prepared by adding 20 g of salicylaldehyde, 10 ml Poly80 mix emulsifier (Tween) to demineralized water and bringing the final volume to 2 L with stirring.

Soil that was naturally infected with nematodes was combined with sand (1:1) to prepare a soil mixture for testing. One kilogram of the soil mixture was added to seven (7) pots for each test mixture. Testing was performed by drenching soil with 100 mls of test compositions as indicated in Table 15.

TABLE 15

| | ai | |
|---|---|---|
| | (mls 2% emulsion/ | ai |
| Test | kg soil) | (mg/kg soil) |
| Control | | |
| Benzaldehyde | 10 | 100 |
| “” | 20 | 200 |
| “” | 30 | 400 |
| “” | 40 | 600 |
| “” | 50 | 800 |
| “” | 60 | 1200 |
| Salicylaldehyde | 10 | 100 |
| “” | 20 | 200 |
| “” | 30 | 400 |
| “” | 40 | 600 |
| “” | 50 | 800 |
| “” | 60 | 1200 |
| Control | | |

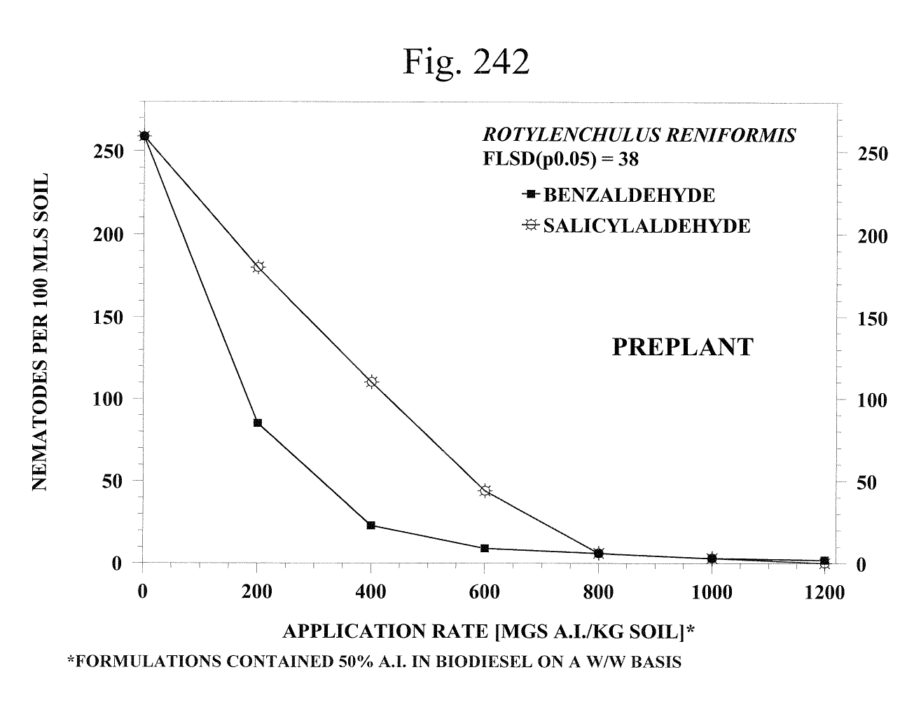

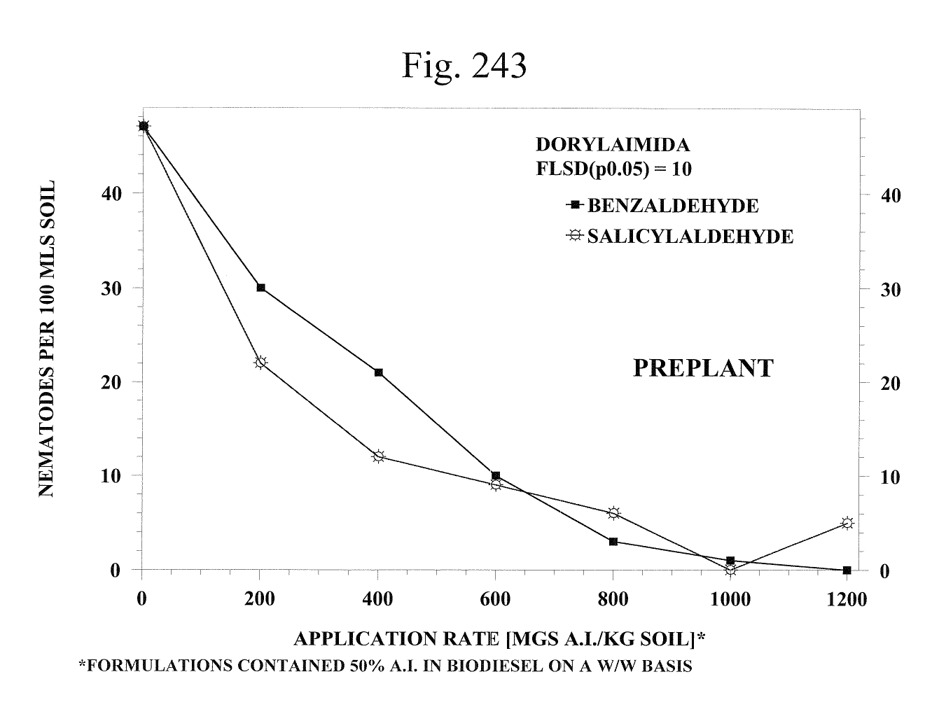

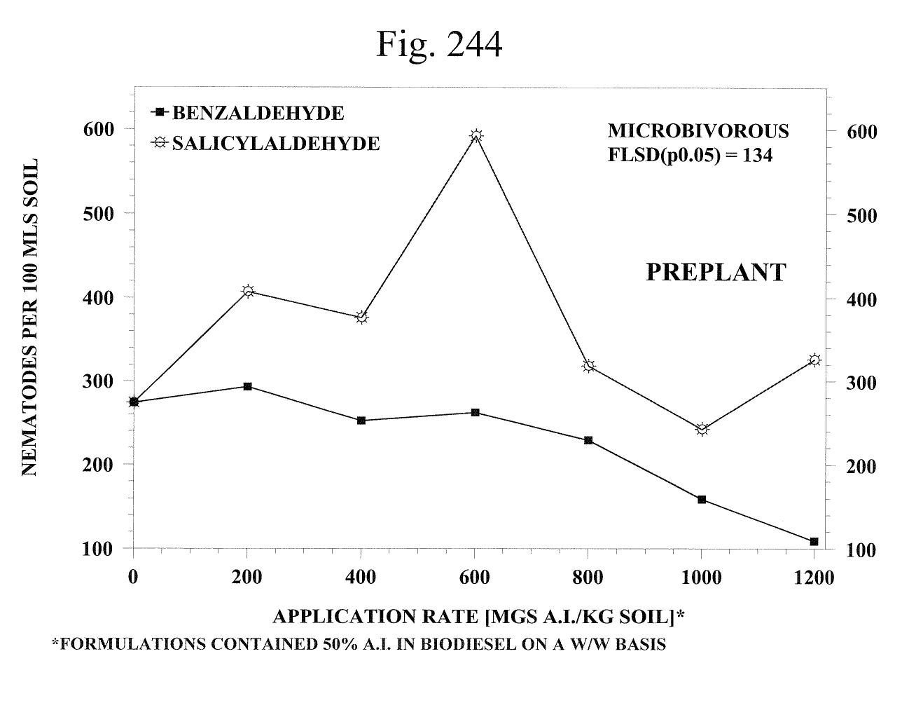

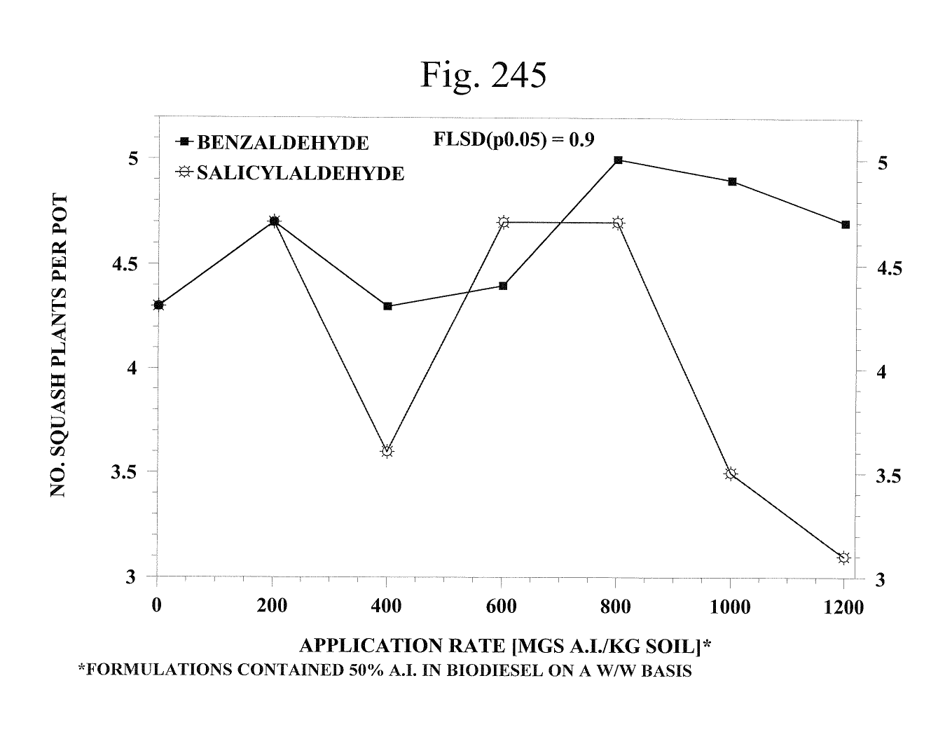

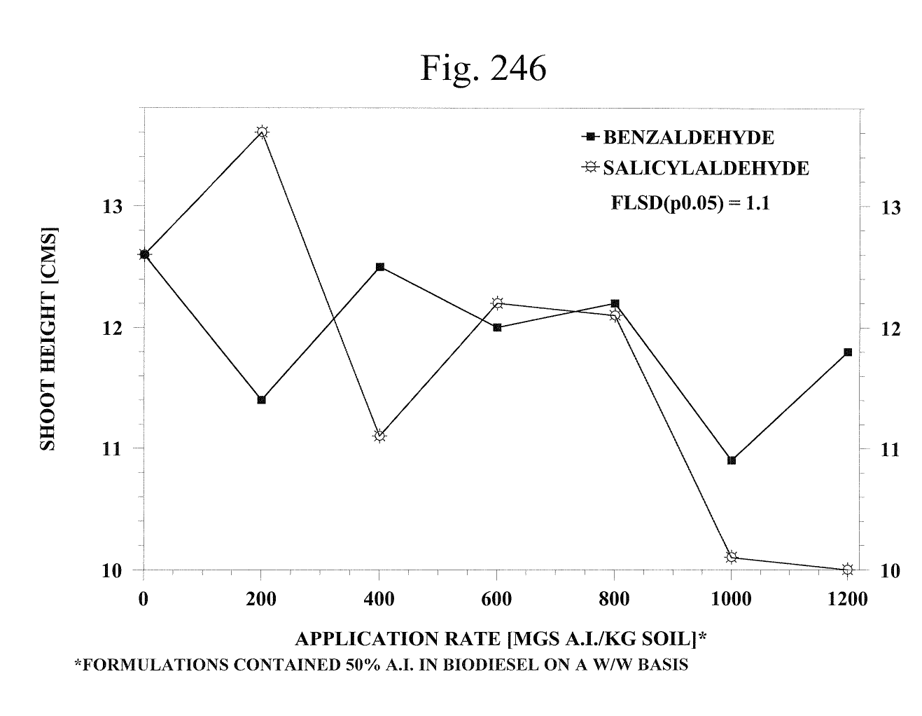

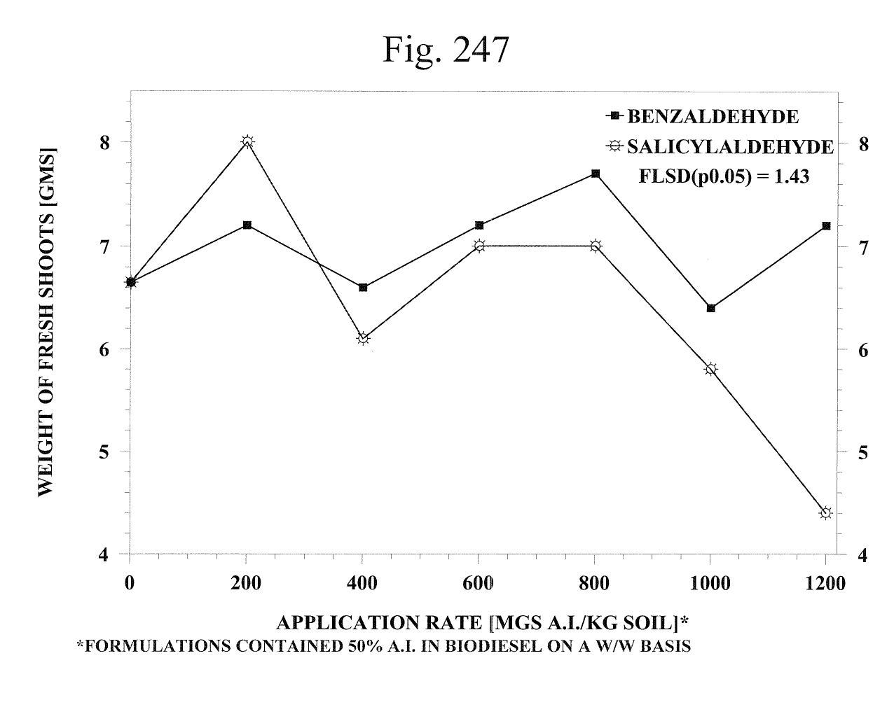

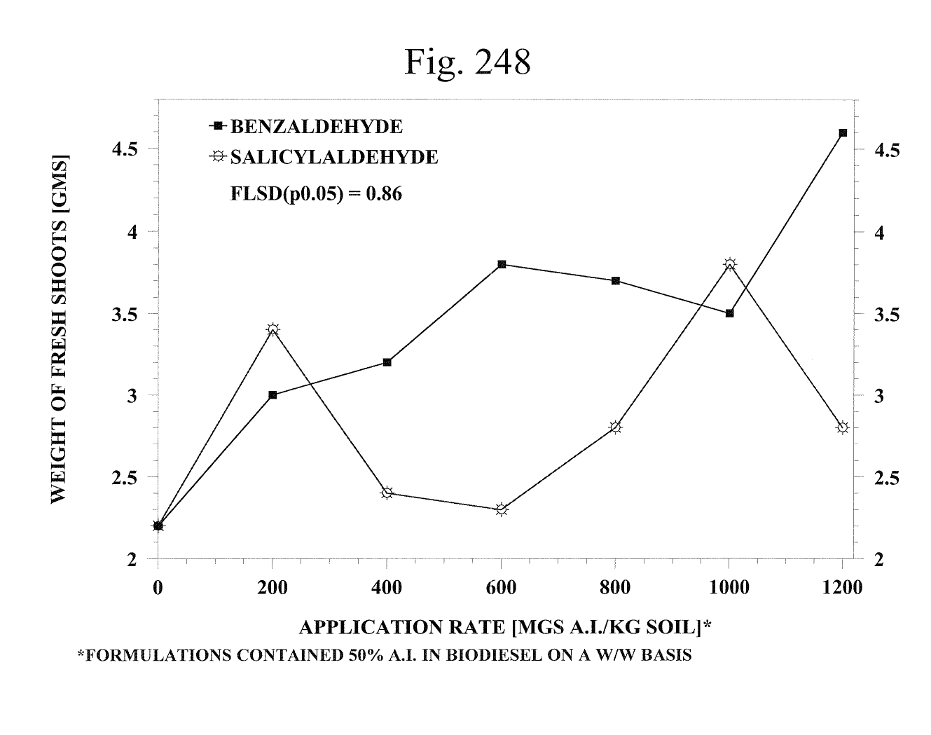

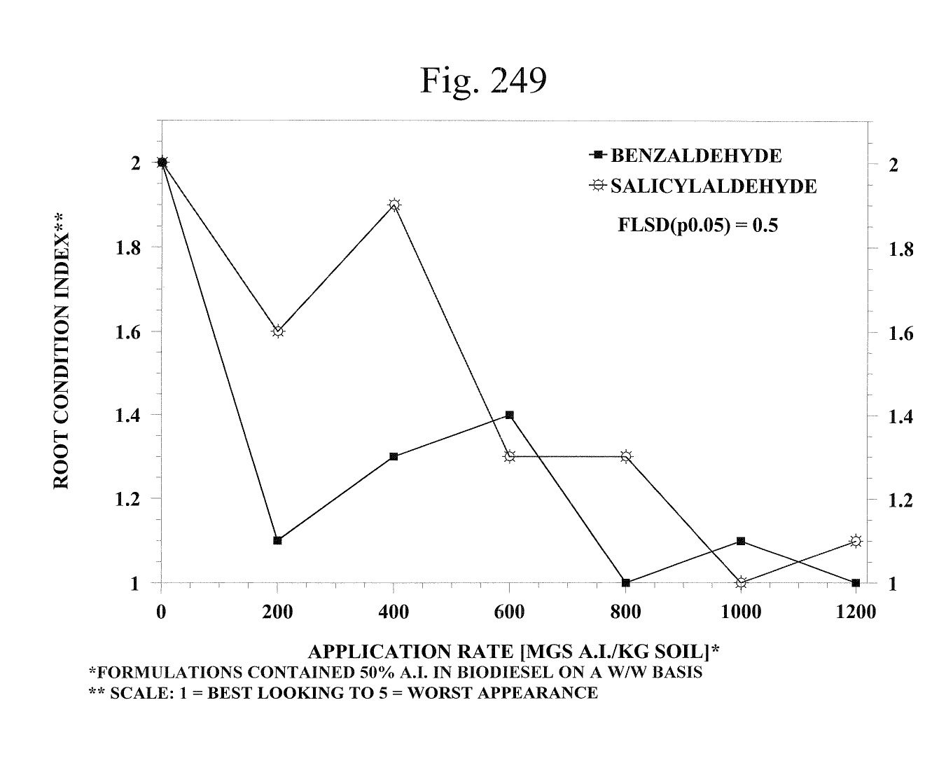

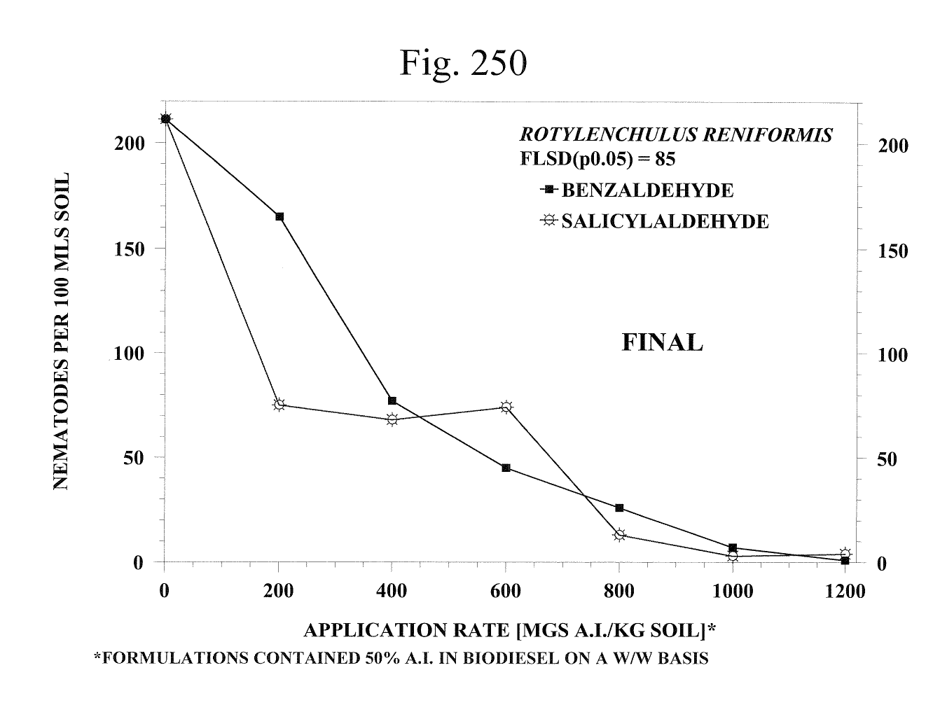

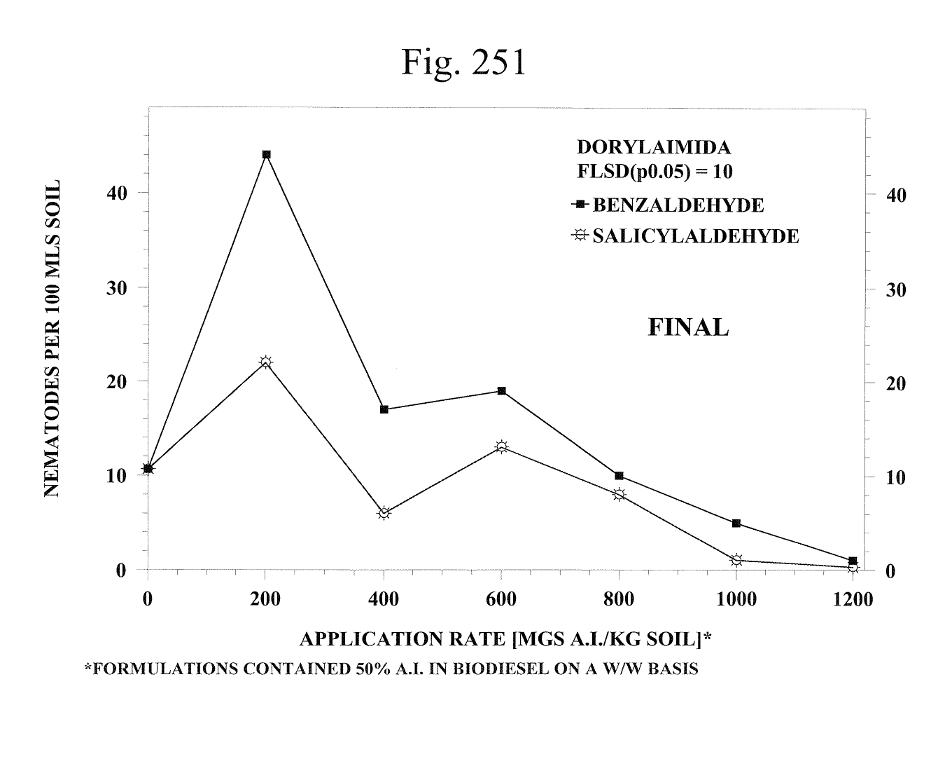

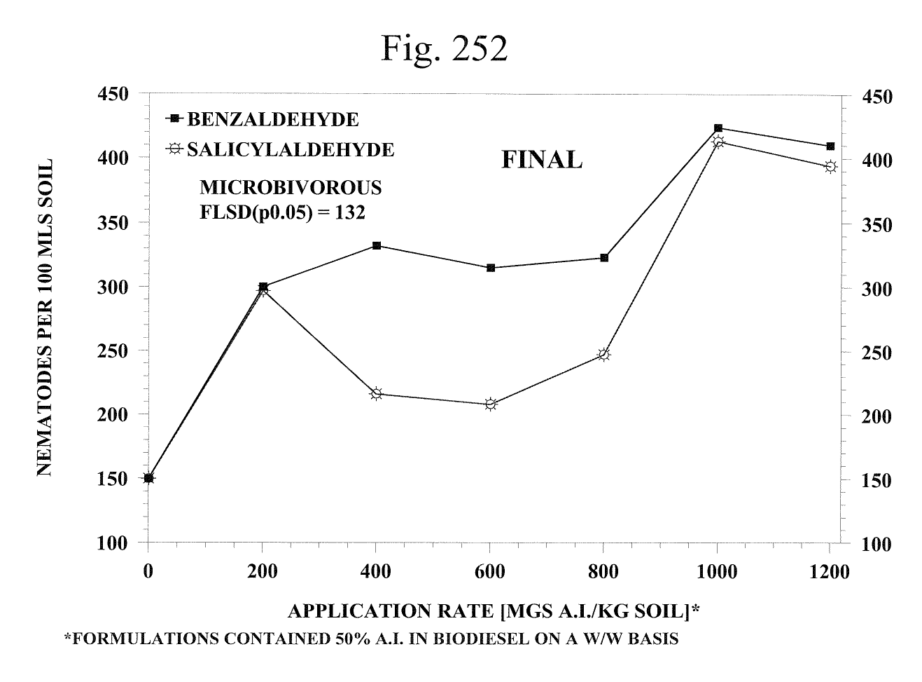

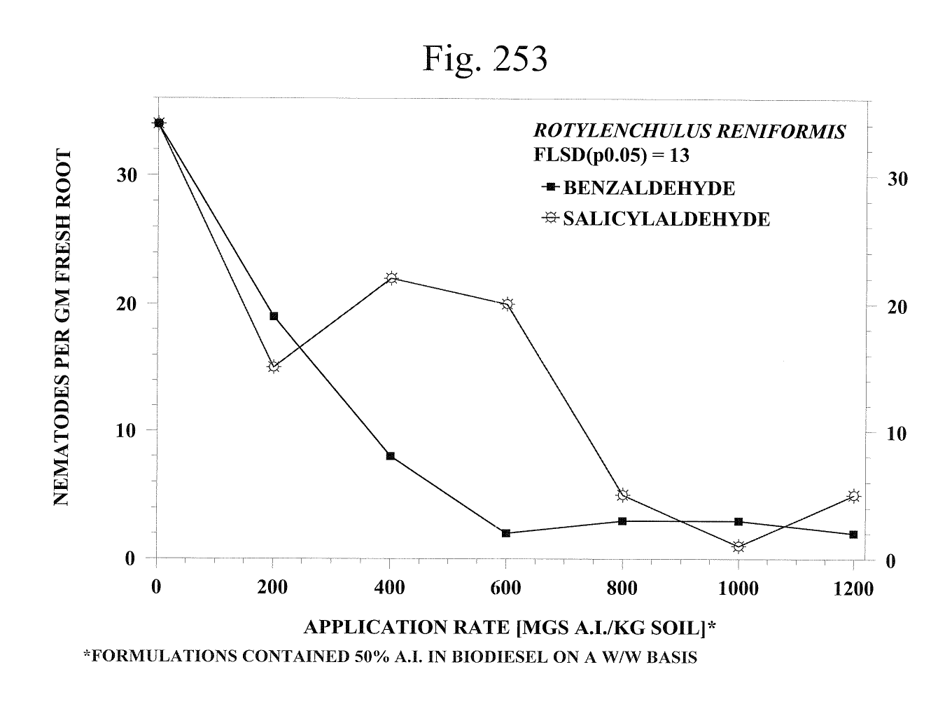

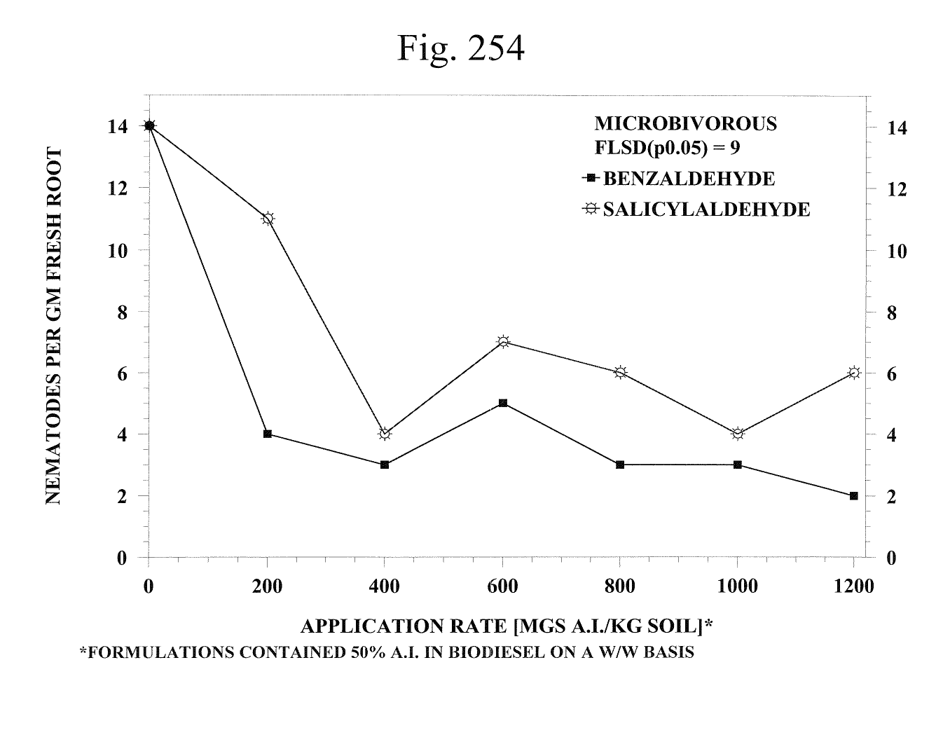

A pre-plant sample of soil was taken and nematodes per 100 mls of soil was determined (FIGS. 242-244). Squash seeds were planted in the pots, and the number of squash seedlings per pot was determined forty-eight (48) days later (FIG. 245). Shoot height (FIG. 246), shoot weight (FIG. 247), root weight (FIG. 248), and root and condition index (FIG. 249) also were determined. The number of nematodes per 100 mls of soil and in the root system was determined (FIGS. 250-254).

Nematode Test 77

Cinnamaldehyde and citral were tested as pesticide actives. Stock solutions were prepared by adding 50 g of cinnamaldehyde or citral (i.e., 50 g ai) and 50 g of biodiesel and mixing well. A 2% emulsion of each of the stock solutions were prepared by adding 40 g of the stock solution to 4 g Polysorb 80 (i.e., 1 g of Polysorb 80 for every 10 g of stock solution). The mixture was added to stirring demineralized water and the final volume was increased to 2 L.

Soil that was naturally infected with nematodes was combined with sand (1:1) to prepare a soil mixture for testing. One kilogram of the soil mixture was added to seven (7) pots for each test mixture. Testing was performed by drenching soil with 100 mls of test compositions as indicated in Table 16.

TABLE 16

| | ai | |
|---|---|---|
| | (mls 2% emulsion/ | ai |
| Test | kg soil) | (mg/kg soil) |
| Control | | |
| Cinnamaldehyde | 10 | 100 |
| “” | 20 | 200 |
| “” | 30 | 400 |
| “” | 40 | 600 |
| “” | 50 | 800 |
| “” | 60 | 1200 |
| Citral | 10 | 100 |
| “” | 20 | 200 |
| “” | 30 | 400 |
| “” | 40 | 600 |
| “” | 50 | 800 |
| “” | 60 | 1200 |
| Control | | |

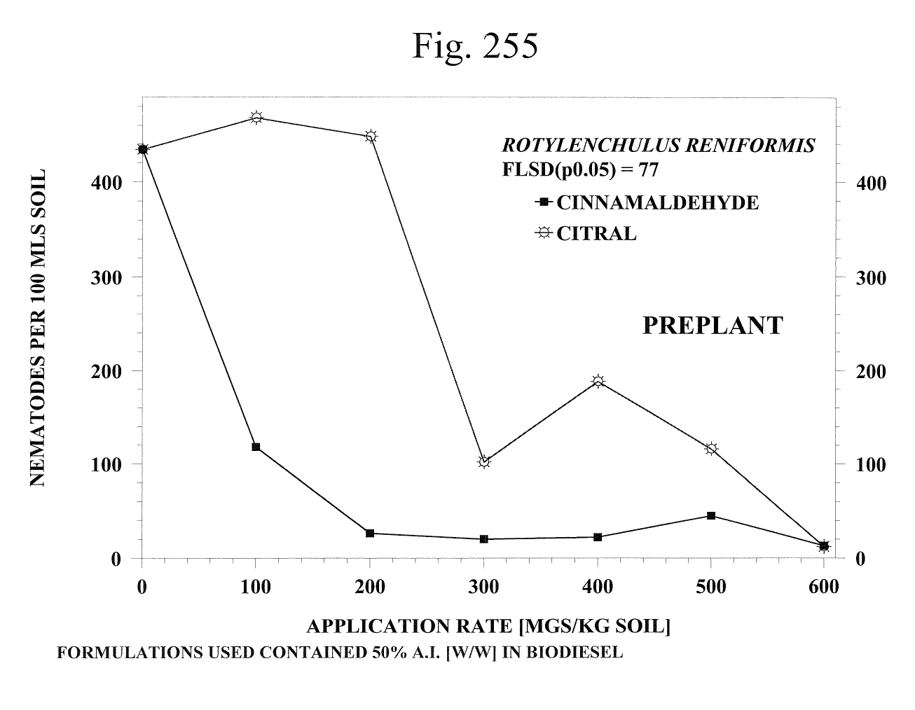

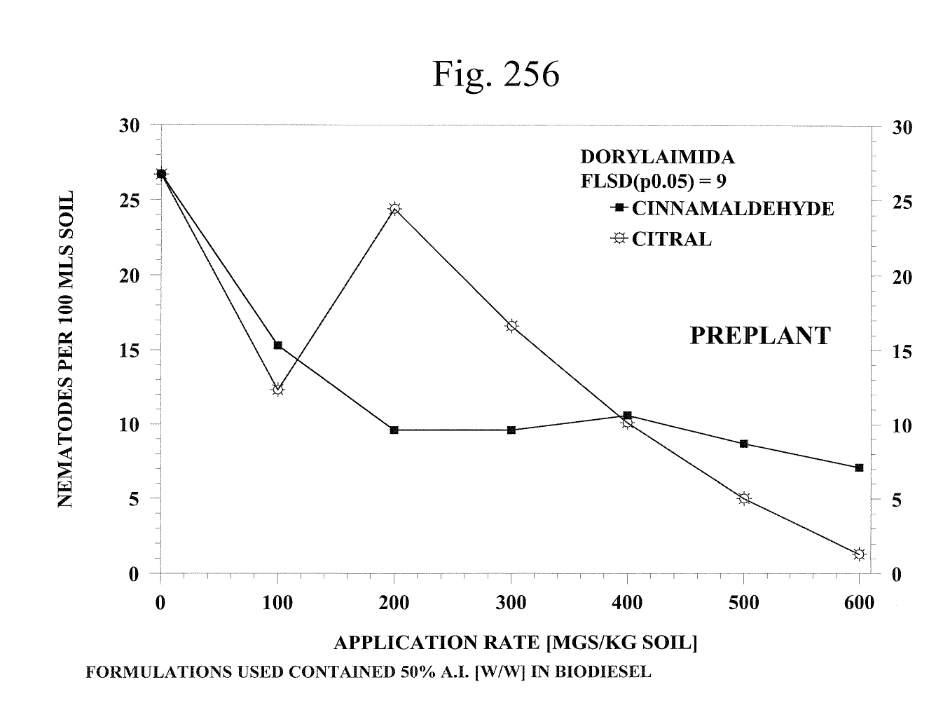

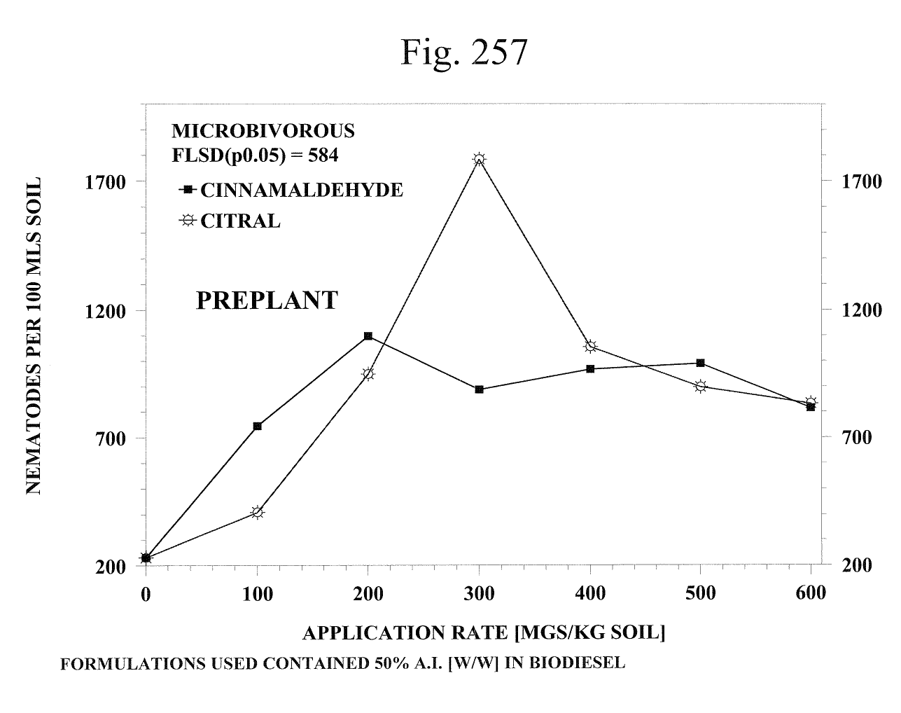

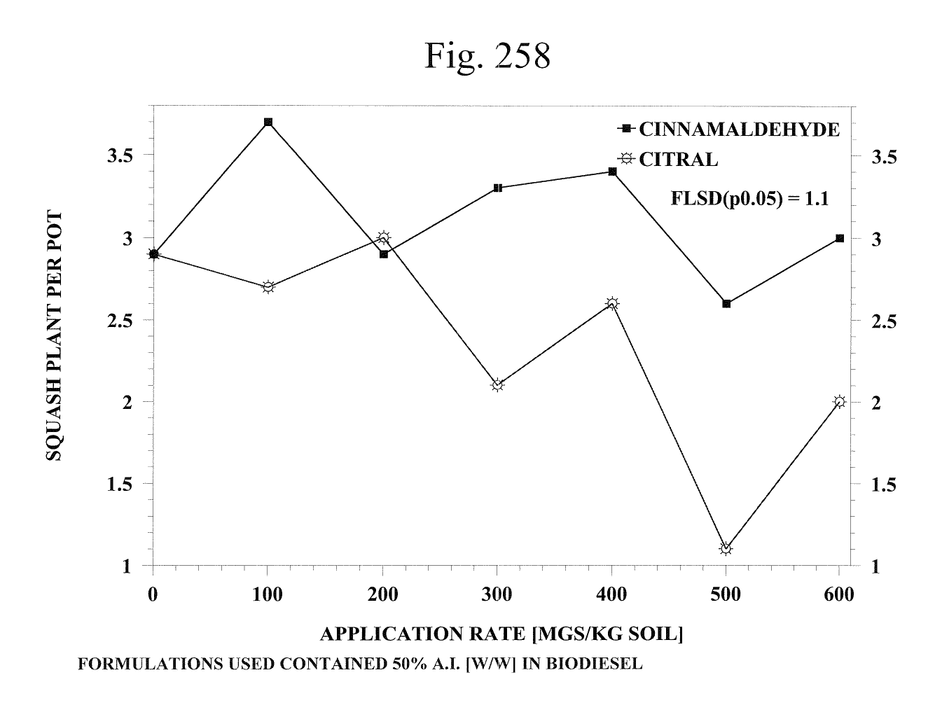

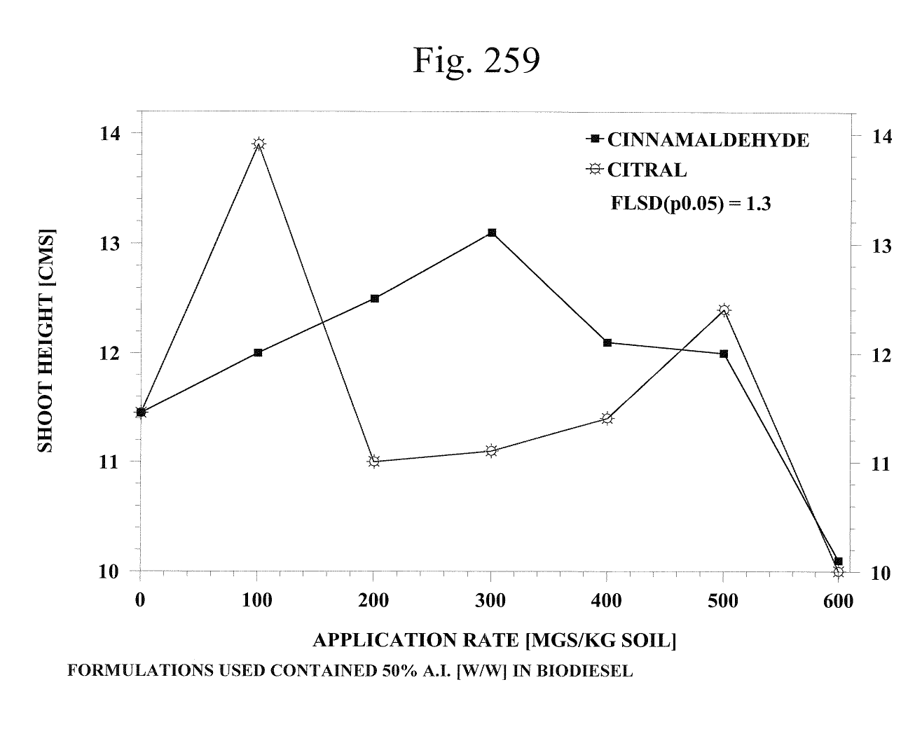

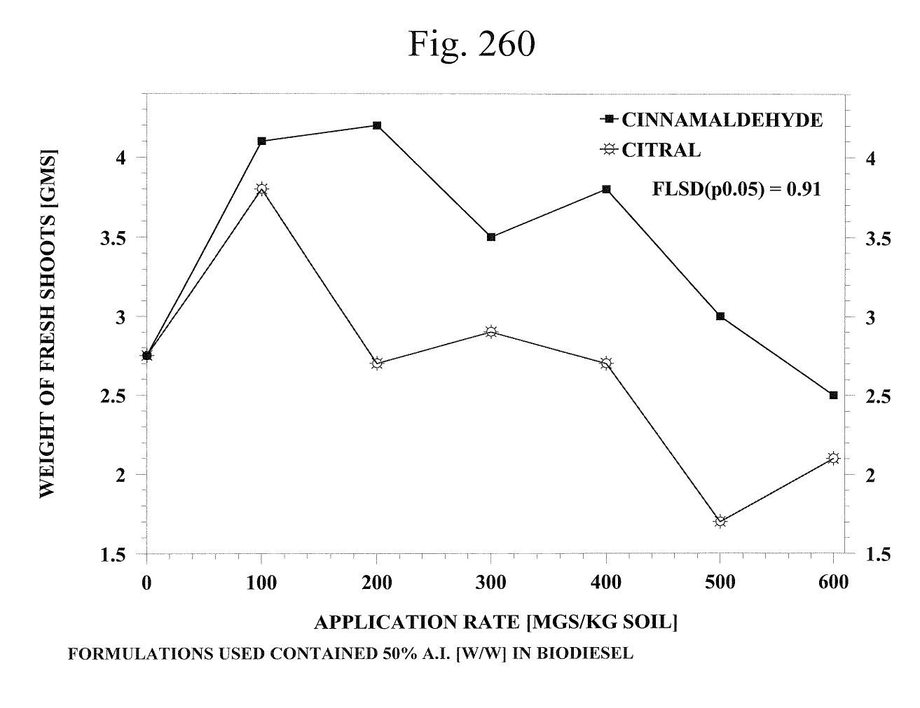

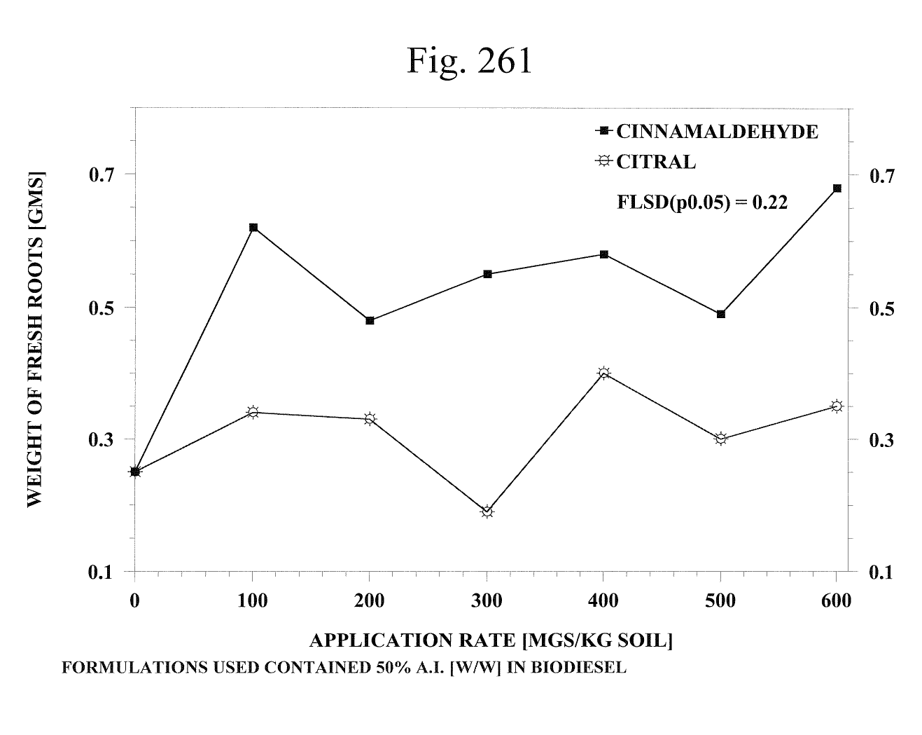

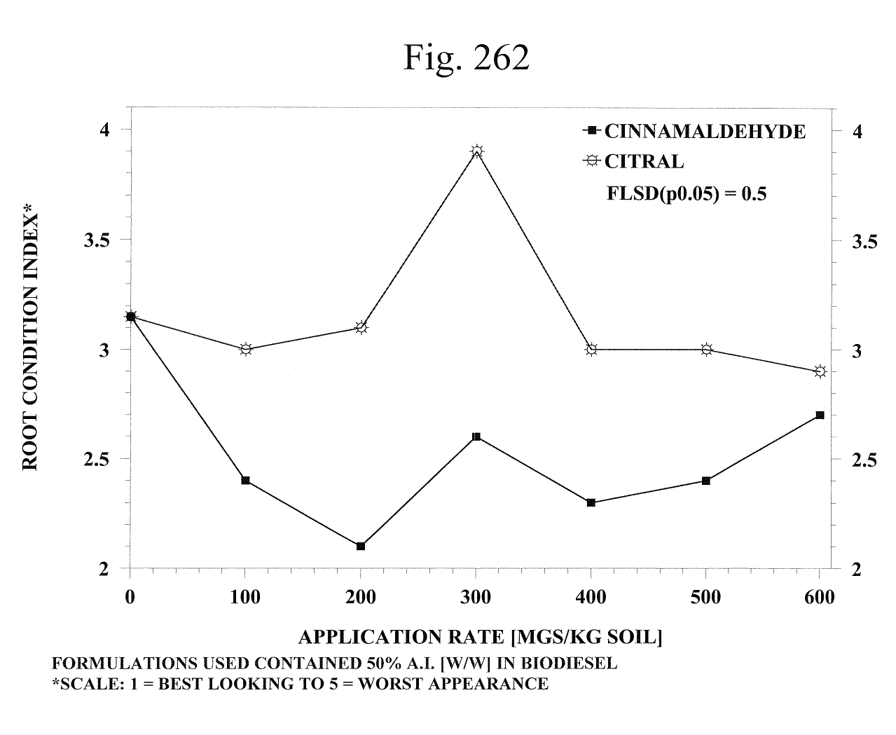

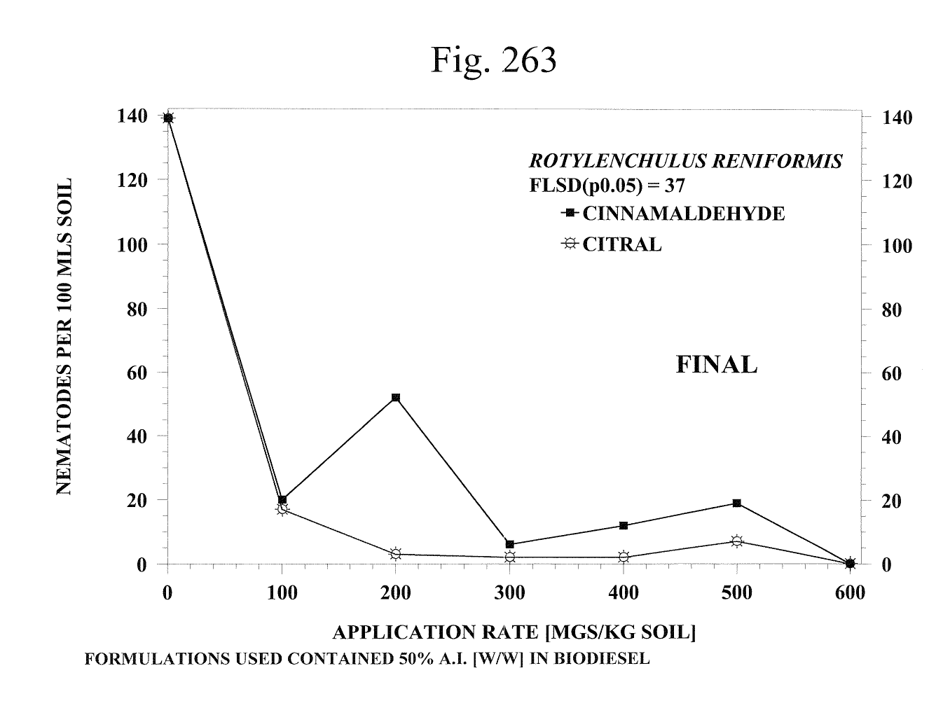

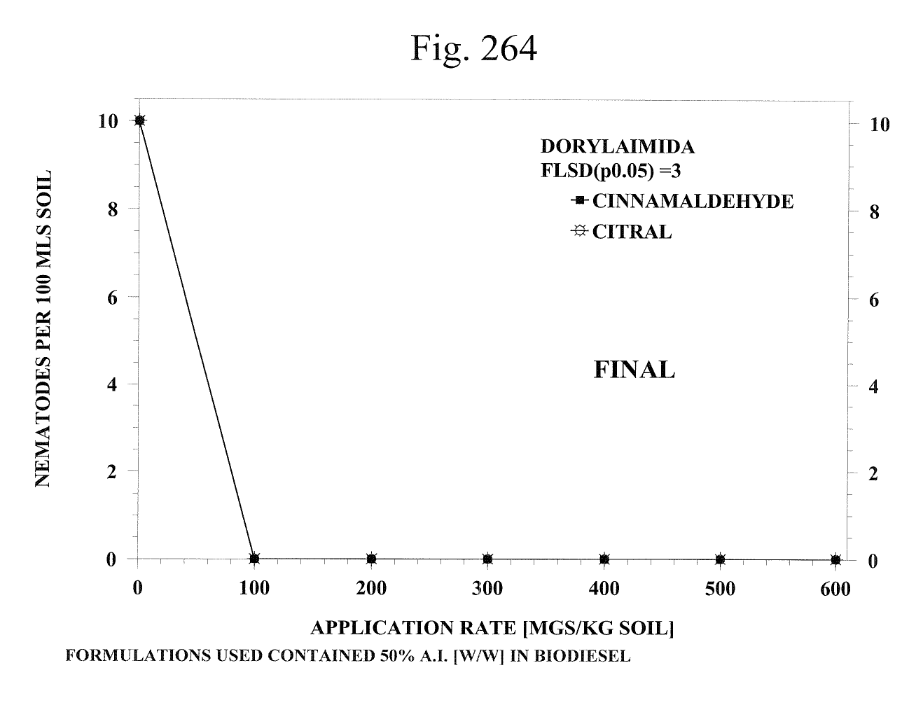

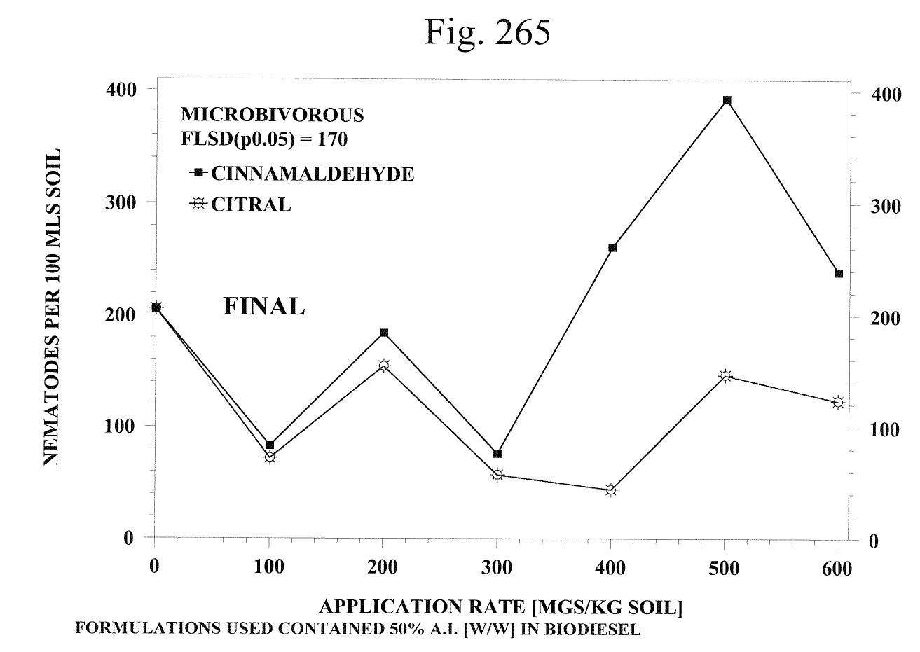

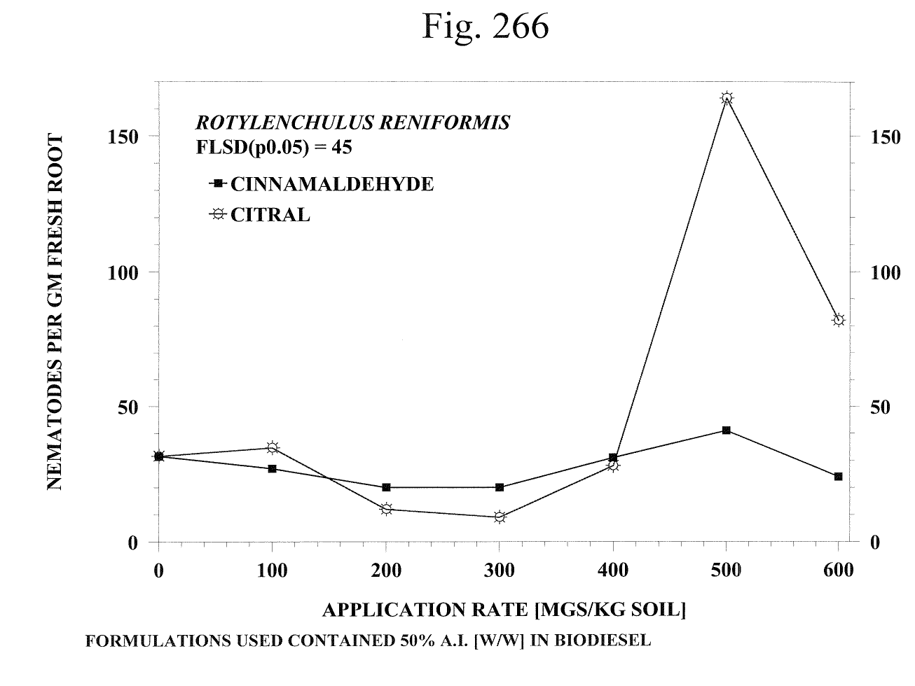

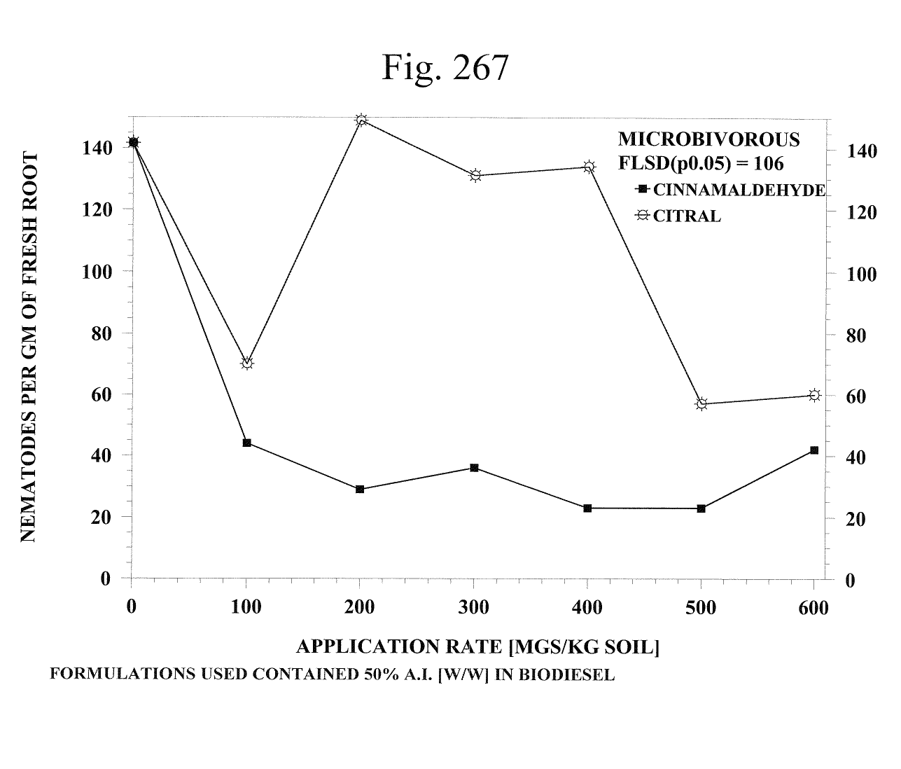

A pre-plant sample of soil was taken and nematodes per 100 mls of soil was determined (FIGS. 255-257). Squash seeds were planted in the pots, and the number of squash seedlings per pot was determined fifty-four (54) days later (FIG. 258). Shoot height (FIG. 259), shoot weight (FIG. 260), root weight (FIG. 261), and root and condition index (FIG. 262) also were determined. The number of nematodes per 100 mls of soil and in the root system was determined (FIGS. 263-267).

Nematode Test 78

Anisaldehyde and thymol were tested as pesticide actives. Stock solutions were prepared by adding 50 g of anisaldehyde and thymol (i.e., 50 g ai) and 50 g of biodiesel (AL Biodiesel, Moundville, Ala.) and mixing well. A 2% emulsion of each of the stock solutions was prepared by adding 40 g of the stock solution to 4 g Polysorb 80 (i.e., 1 g of Polysorb 80 for every 10 g of stock solution) or to Illovo Mix (emulsifier). The mixture was added to stirring demineralised water and the final volume was increased to 2 L.

Soil that was naturally infected with nematodes was combined with sand (1:1) to prepare a soil mixture for testing. One kilogram of the soil mixture was added to seven (7) pots for each test mixture. Testing was performed by drenching soil with 100 mls of test compositions as indicated in Table 17.

TABLE 17

| | ai | |
|---|---|---|
| | (mls 2% emulsion/ | ai |
| Test | kg soil) | (mg/kg soil) |
| Control | | |
| Anisaldehyde | 10 | 100 |
| “” | 20 | 200 |
| “” | 30 | 400 |
| “” | 40 | 600 |
| “” | 50 | 800 |
| “” | 60 | 1200 |
| Thymol | 10 | 100 |
| “” | 20 | 200 |
| “” | 30 | 400 |
| “” | 40 | 600 |
| “” | 50 | 800 |
| “” | 60 | 1200 |
| Control | | |

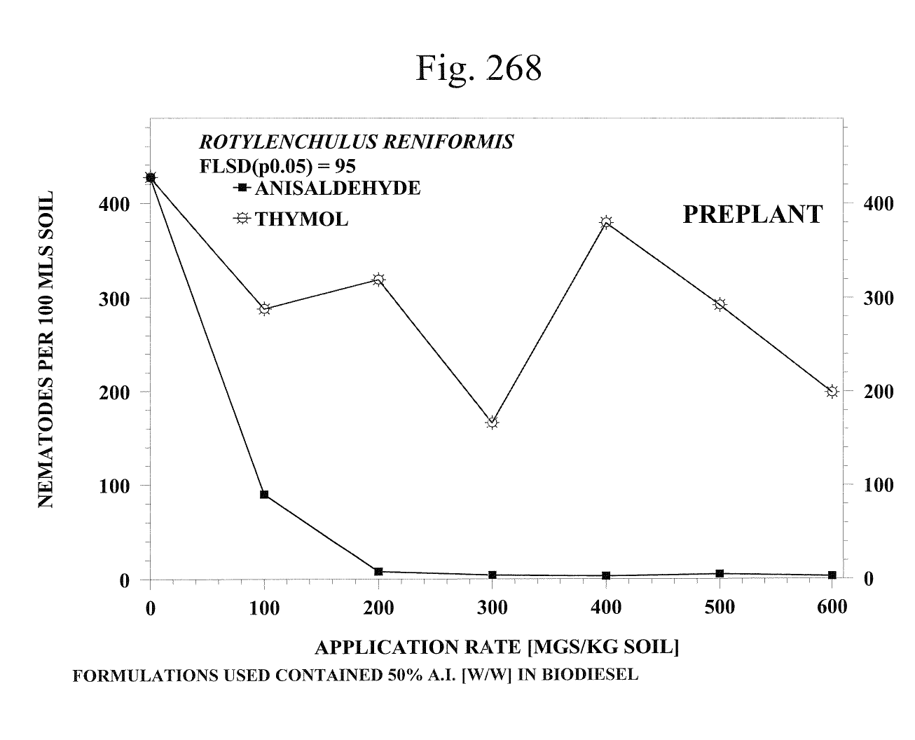

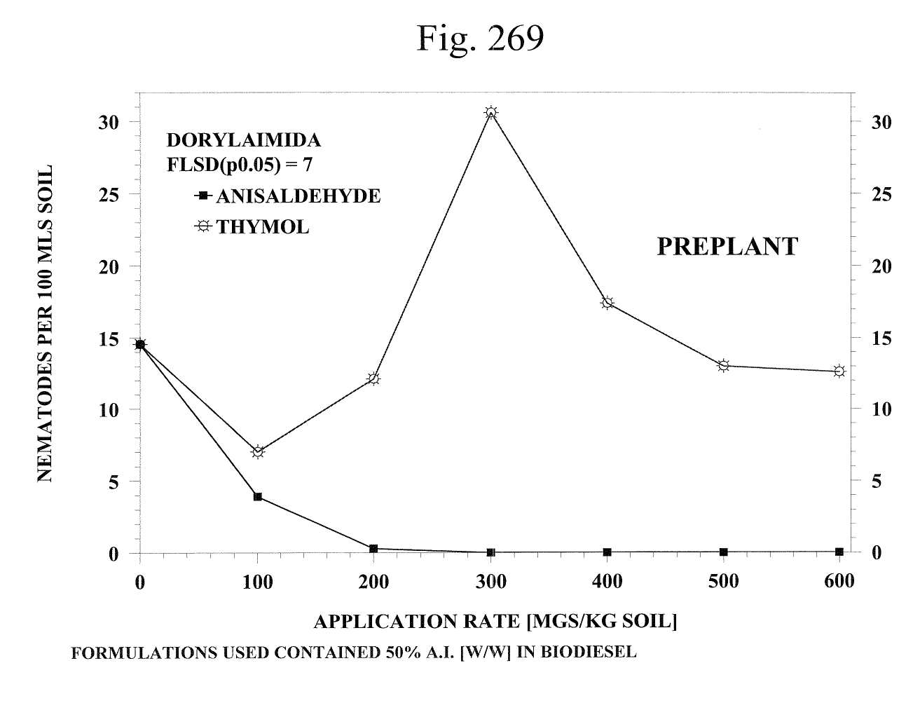

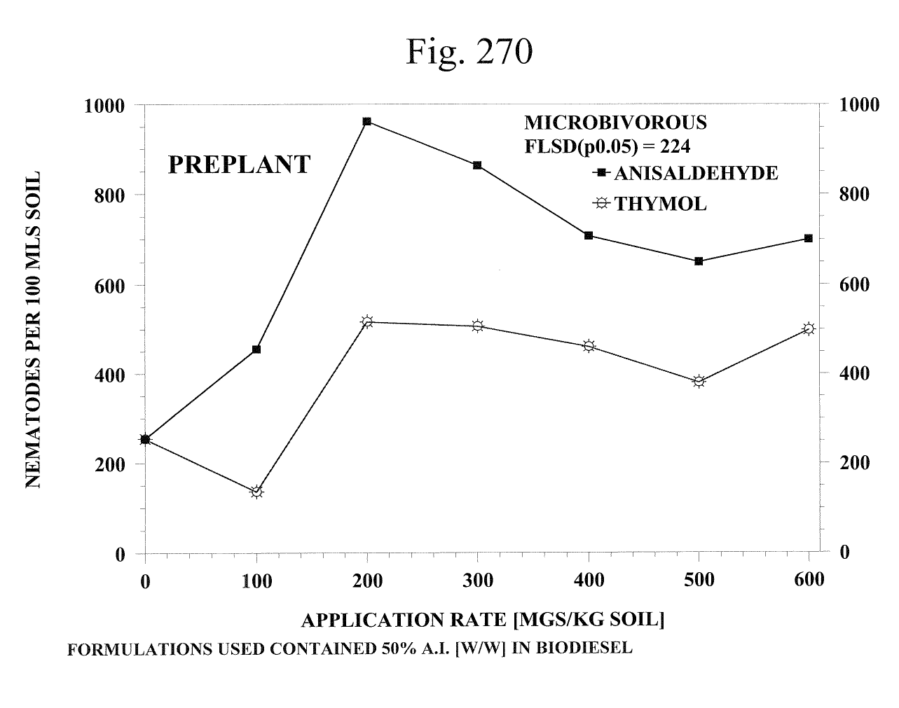

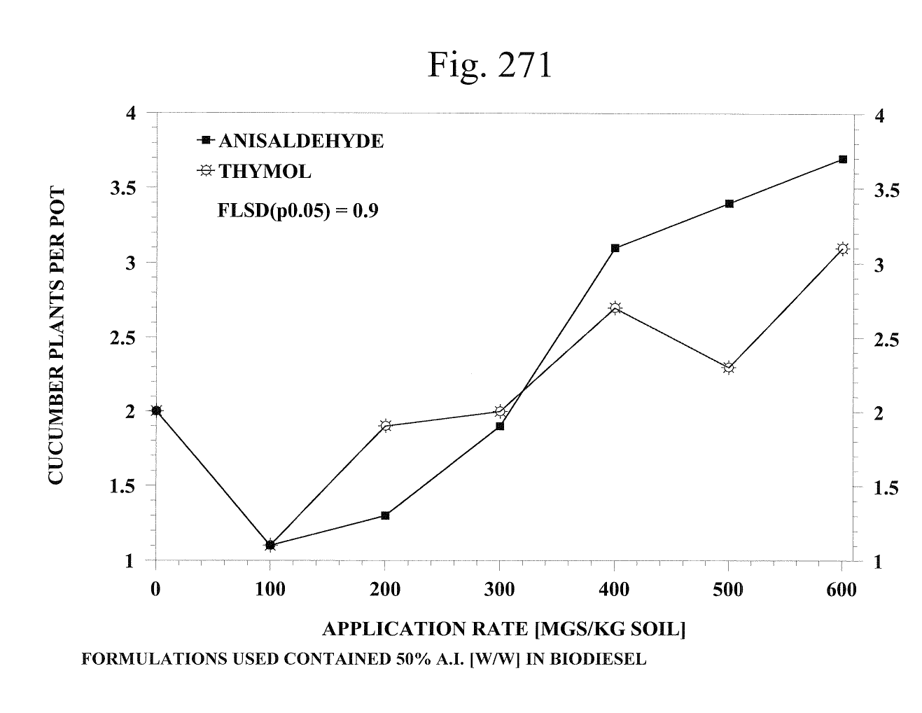

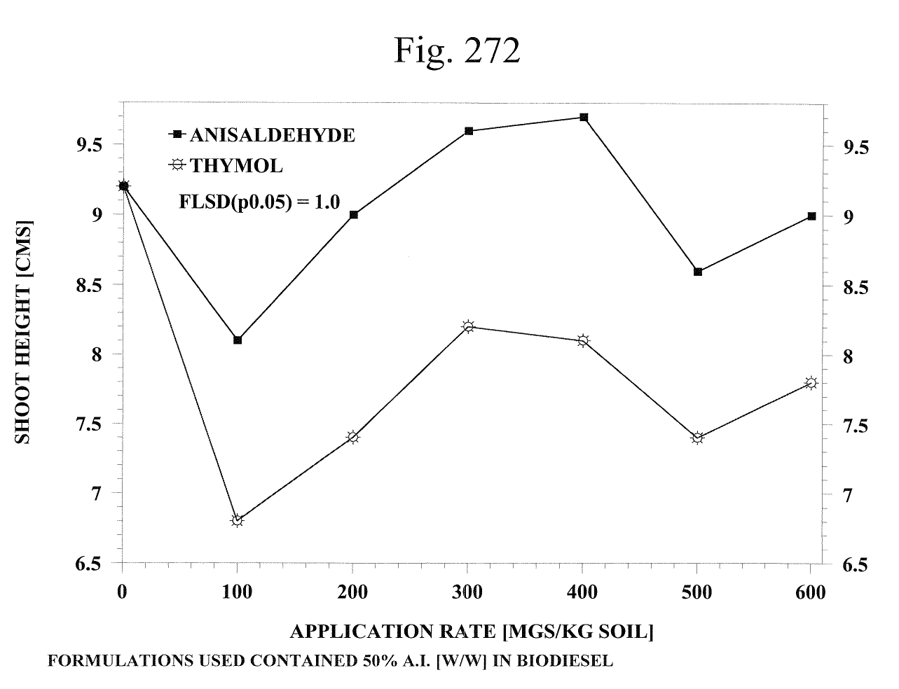

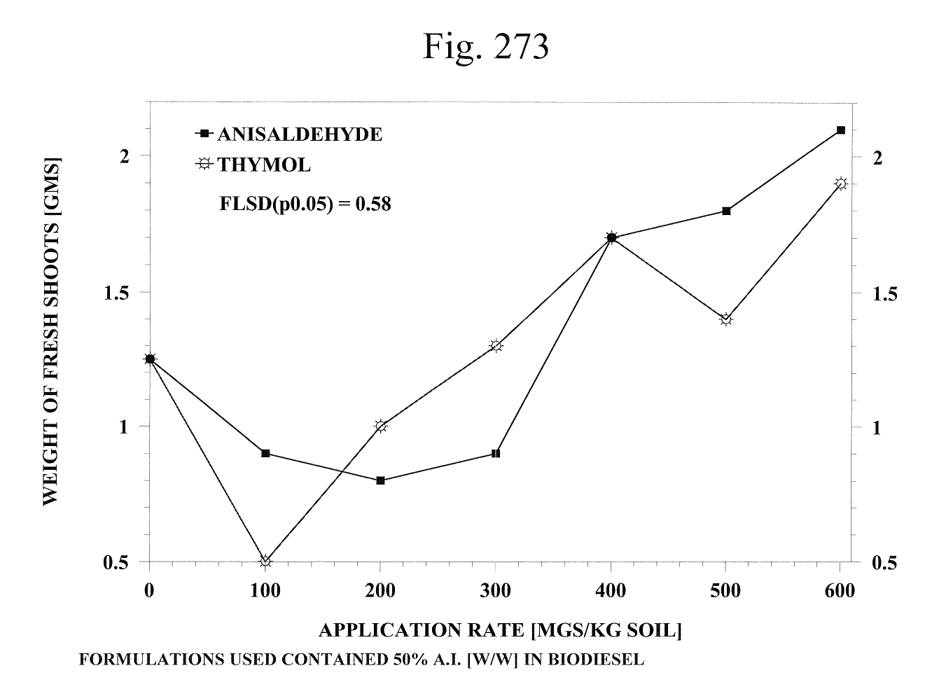

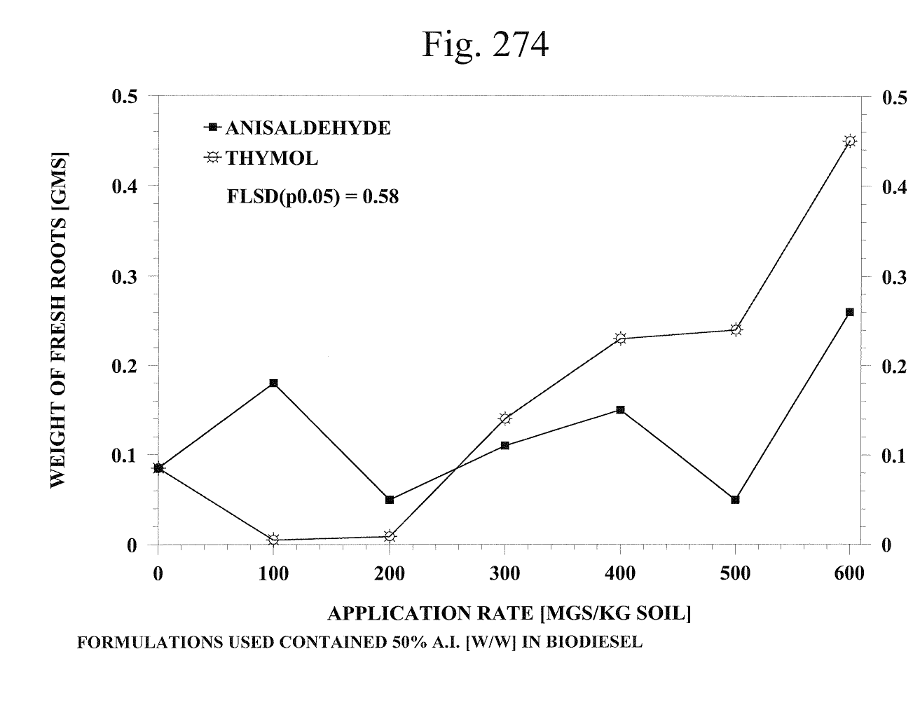

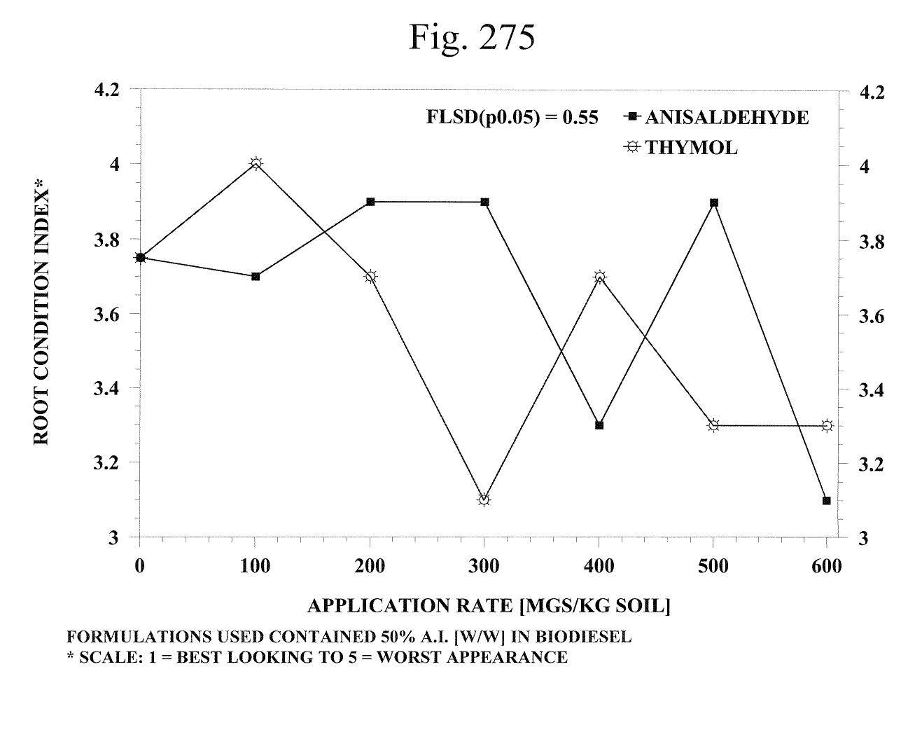

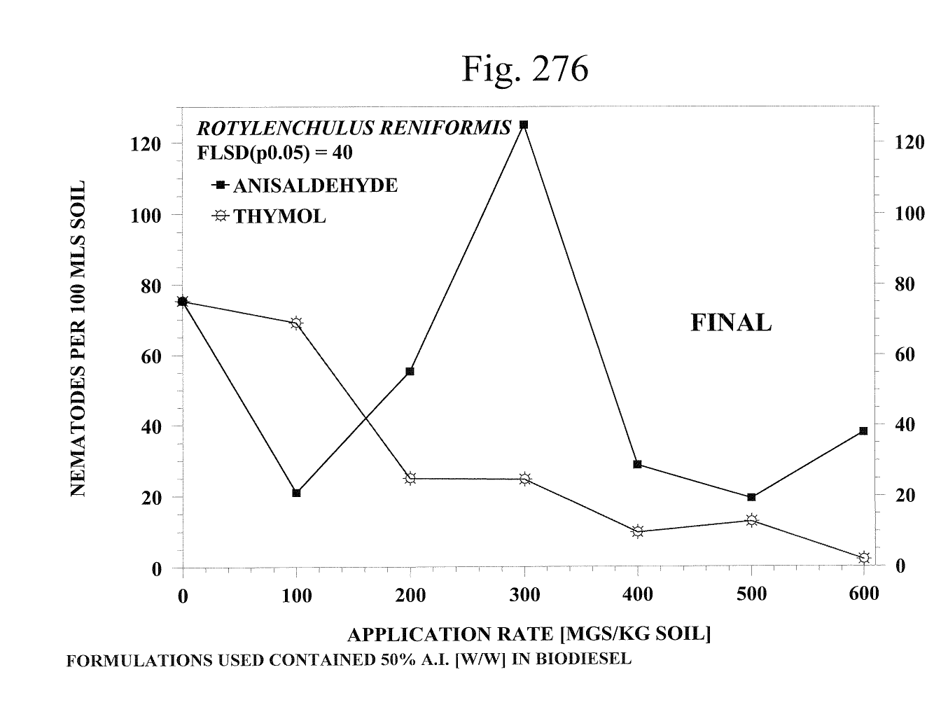

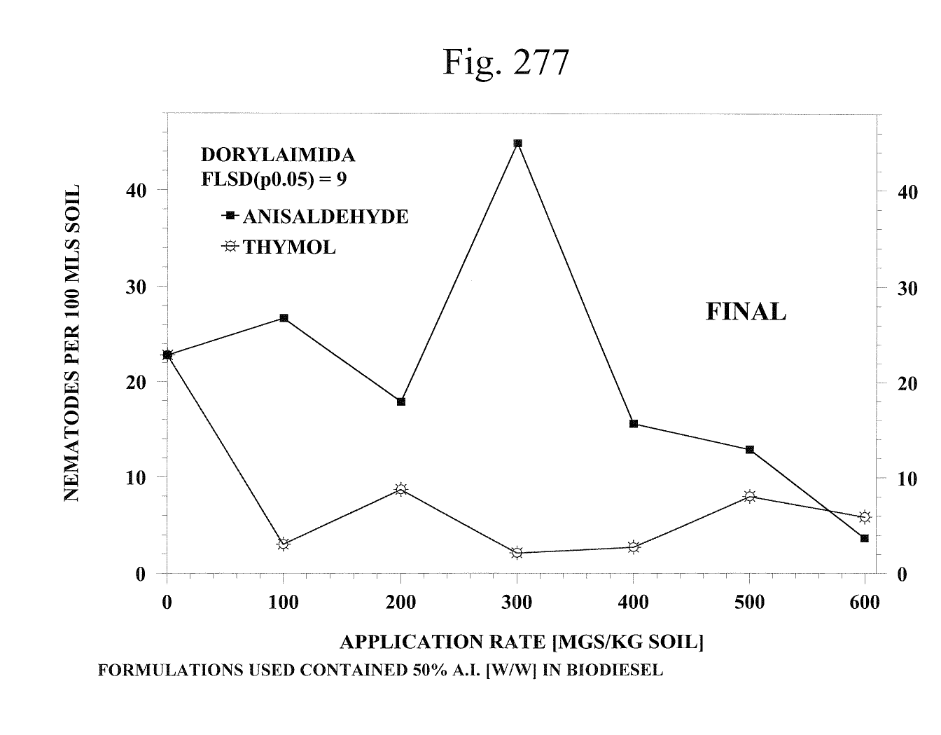

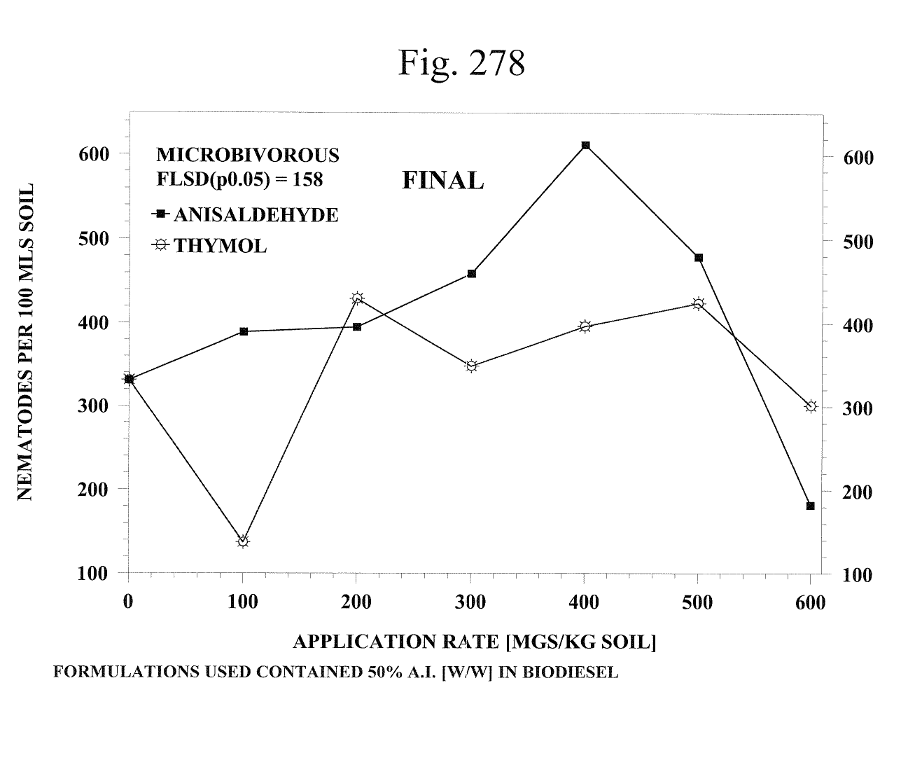

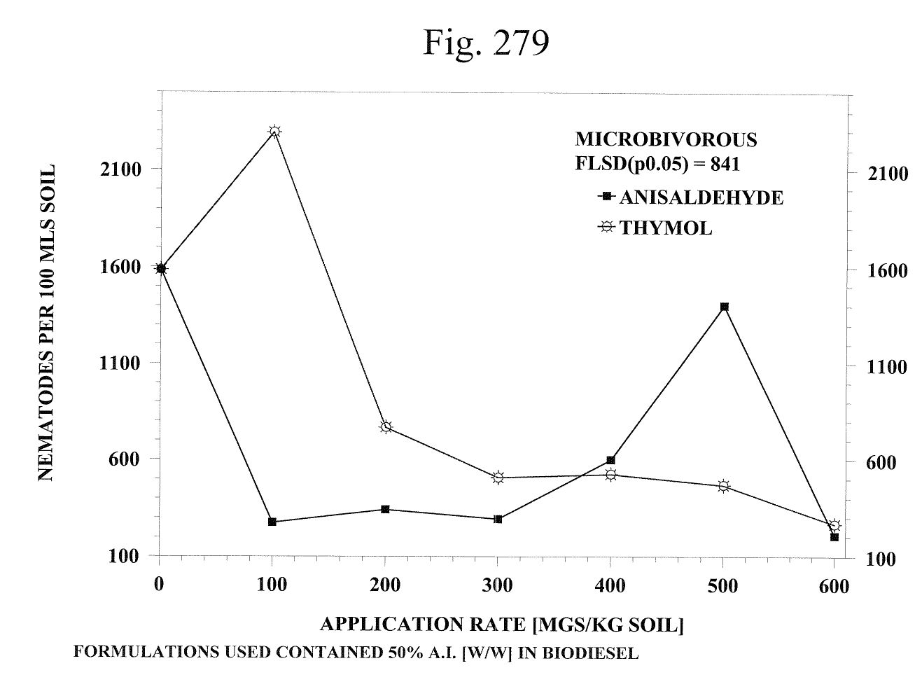

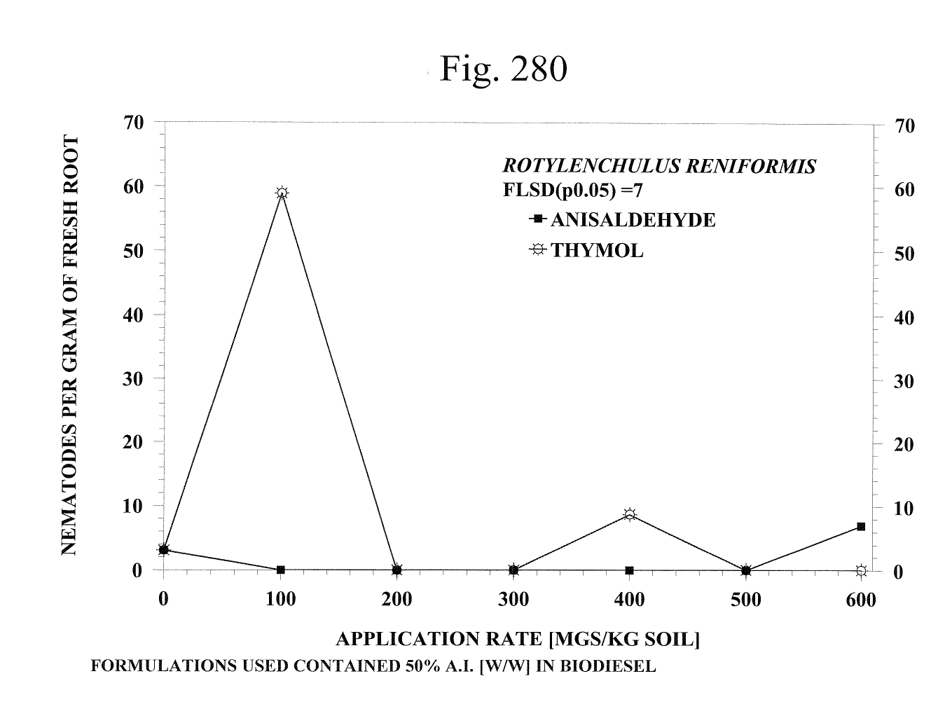

A pre-plant sample of soil was taken and nematodes per 100 mls of soil was determined (FIGS. 268-270). Cucumber seeds were planted in the pots, and the number of cucumber seedlings per pot was determined fifty-six (56) days later (FIG. 271). Shoot height (FIG. 272), shoot weight (FIG. 273), root weight (FIG. 274), and root and condition index (FIG. 275) also were determined. The number of nematodes per 100 mls of soil and in the root system was determined (FIGS. 276-280).

Nematode Test 79

A hot pepper extract comprising capsaicin was prepared by combining 80-100 ml biodiesel and dried pepper powders to form a 5% aqueous emulsion. The resulting solution was designated “hot pepper extract.” The pepper fruit kept shape and did not break or deliquesce. Extraction was evident based on the extract having a hot pepper smell. A 5% extract emulsion was prepared by combining 50 ml of the extract concentrate in demineralized water with stirring, and bringing the final volume to 1 L.

Soil that was naturally infected with nematodes was combined with sand (1:1) to prepare a soil mixture for testing. One kilogram of the soil mixture was added to seven (7) pots for each test mixture. Testing was performed by drenching soil with 100 mls of test compositions as indicated in Table 18.

TABLE 18

| | ai | |
|---|---|---|
| | (mls 5% emulsion/ | ai |
| Test | kg soil) | (mg/kg soil) |
| Control | | |
| Wild Pepper | 10 | 500 |
| “” | 20 | 1000 |
| “” | 30 | 1500 |
| “” | 40 | 2000 |
| Cayenne Pepper | 10 | 500 |
| “” | 20 | 1000 |
| “” | 30 | 1500 |
| “” | 40 | 2000 |
| Biodiesel | 10 | 500 |
| (Verdisol) | | |
| “” | 20 | 1000 |
| “” | 30 | 1500 |
| “” | 40 | 2000 |
| Control | | |

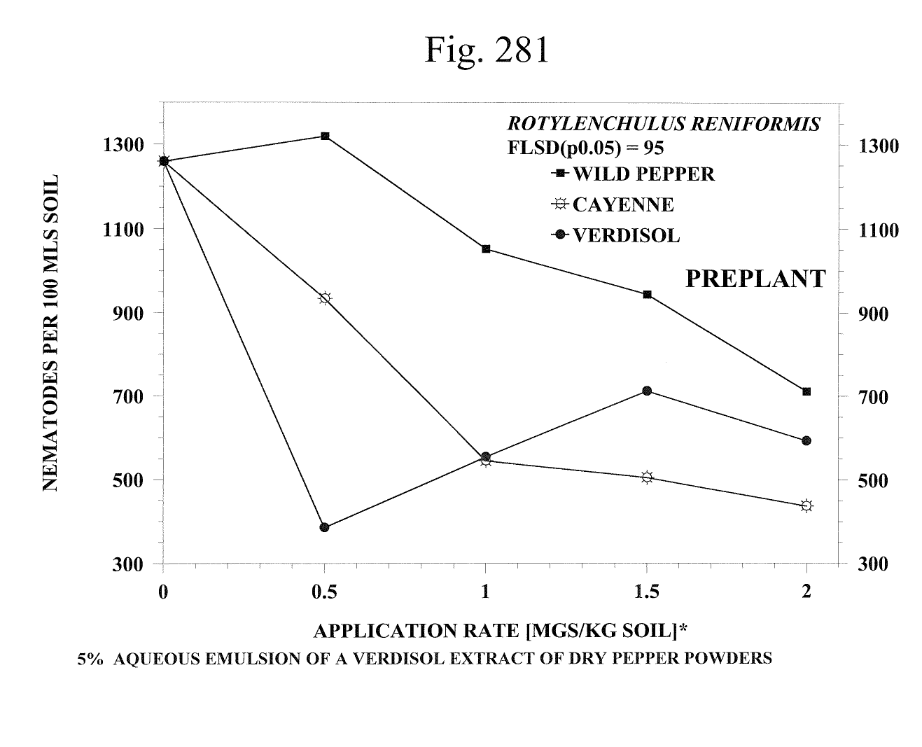

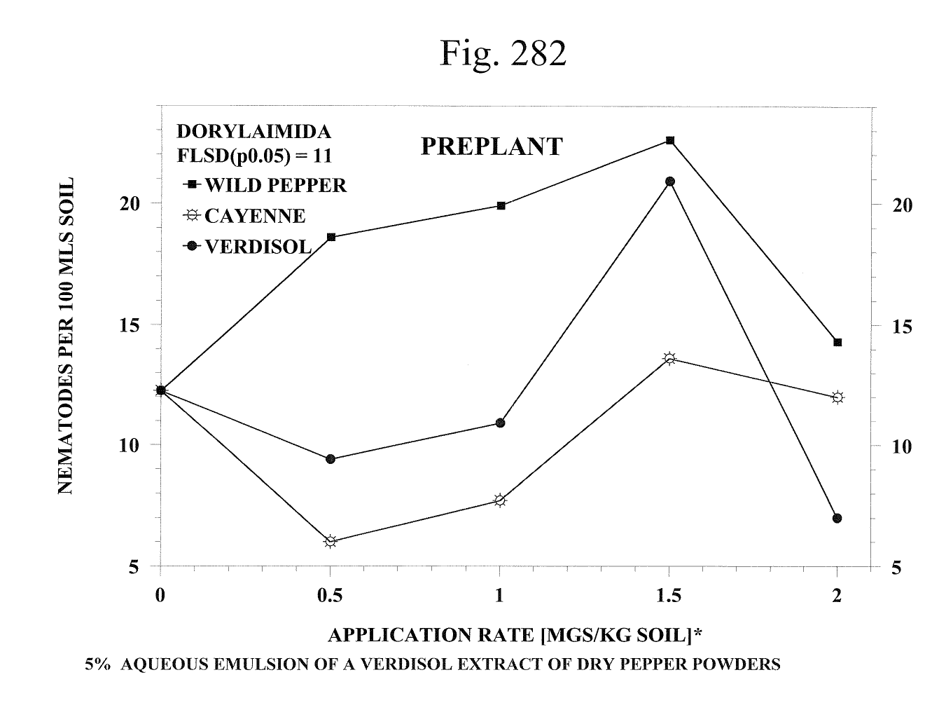

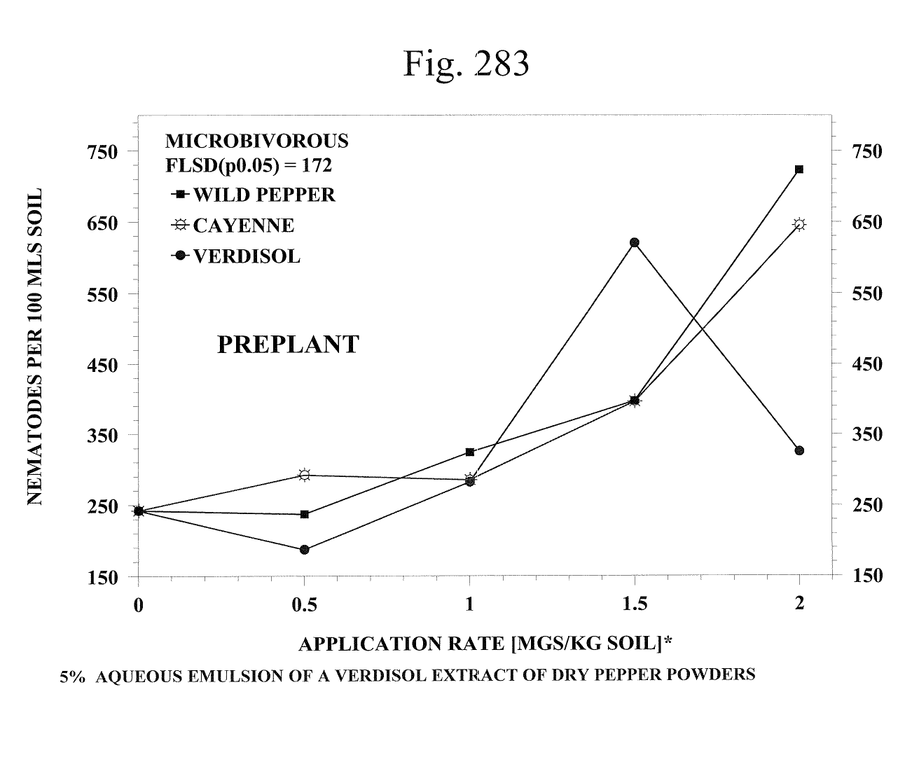

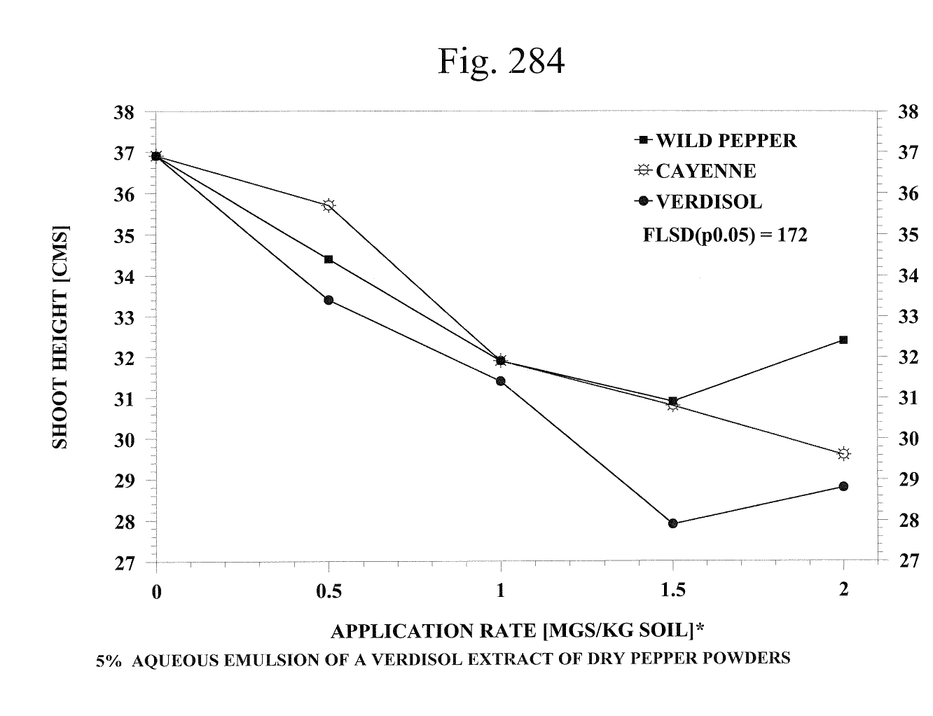

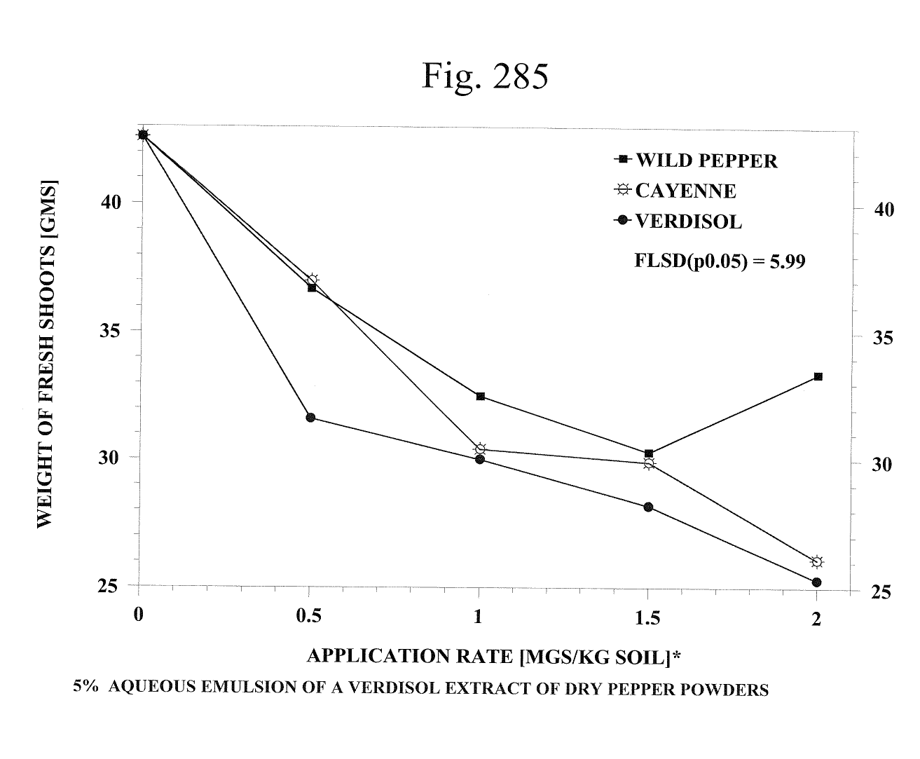

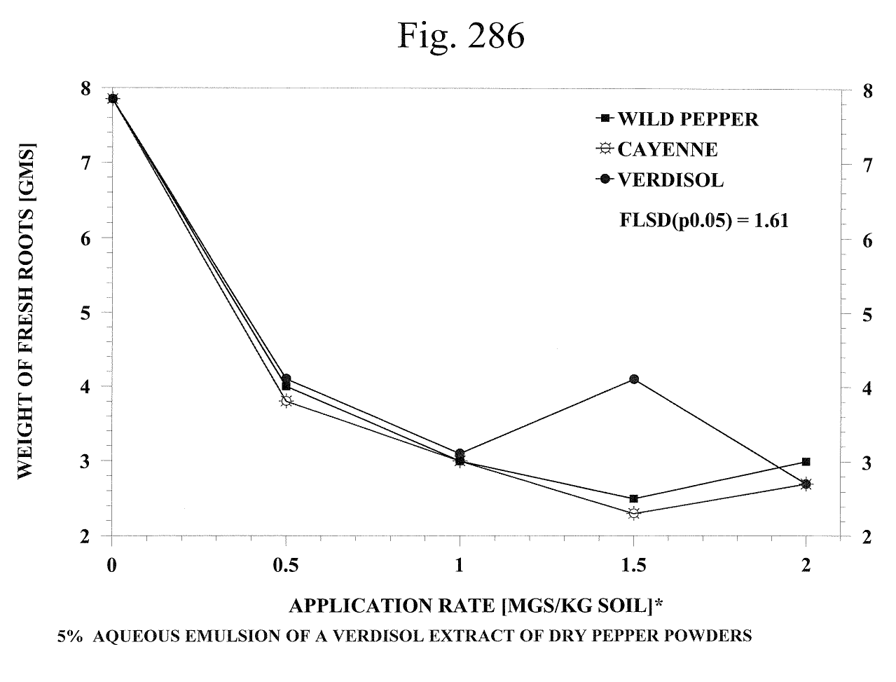

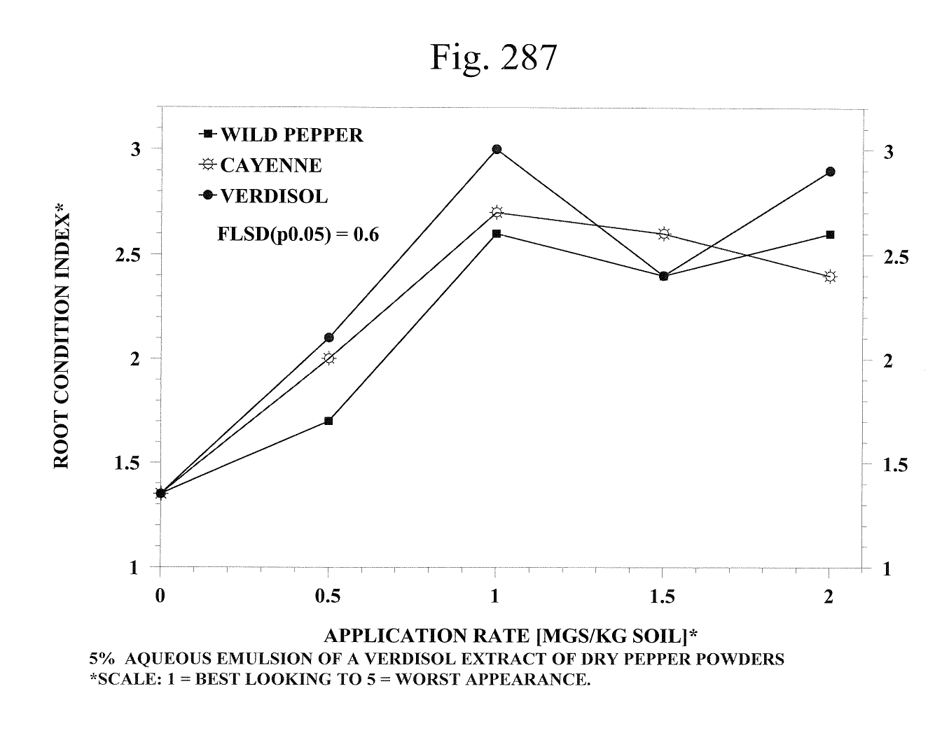

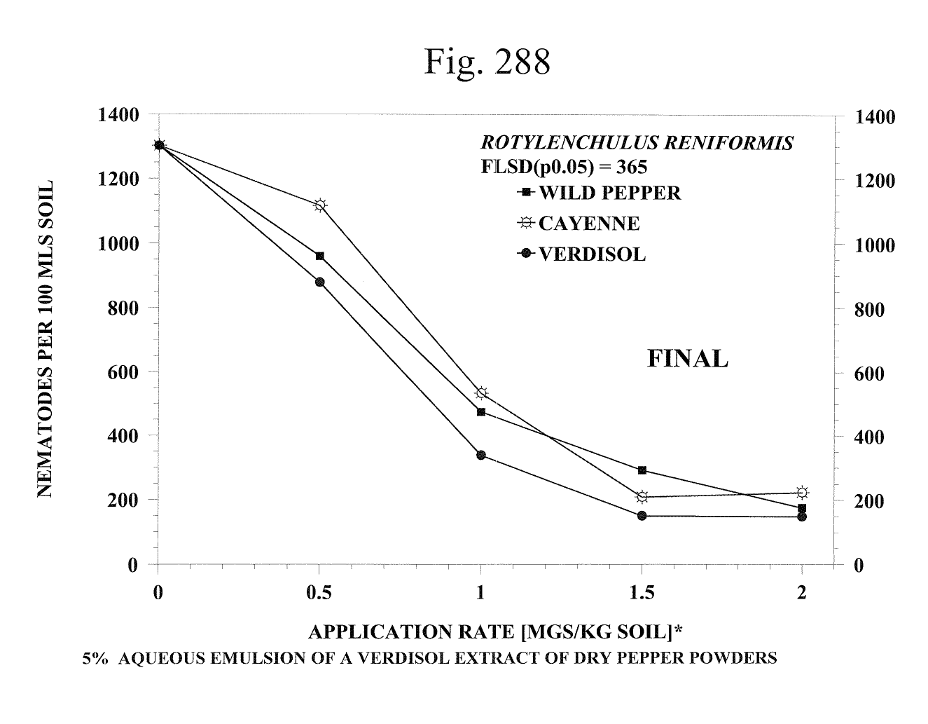

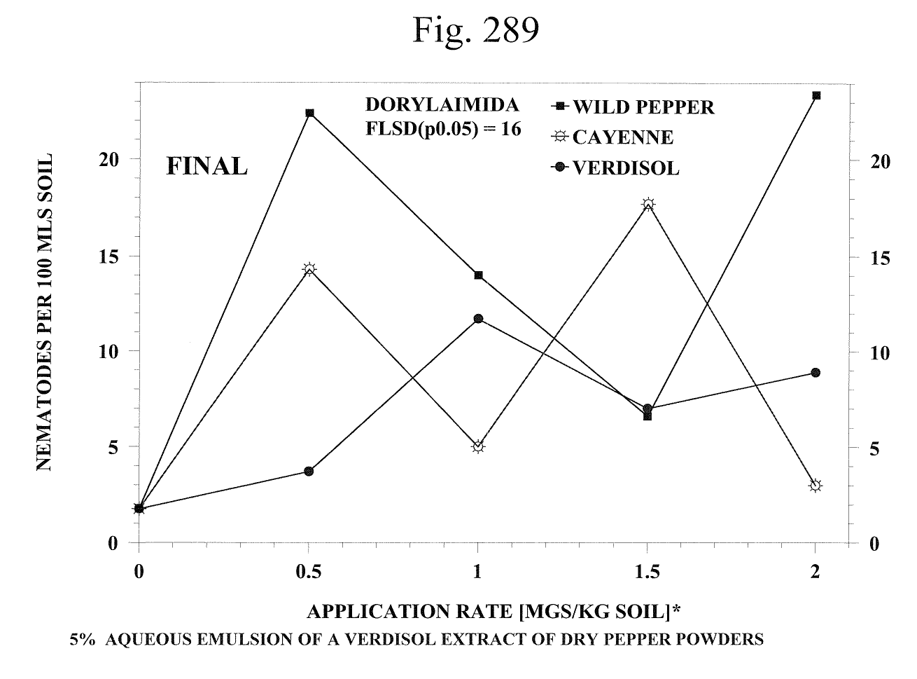

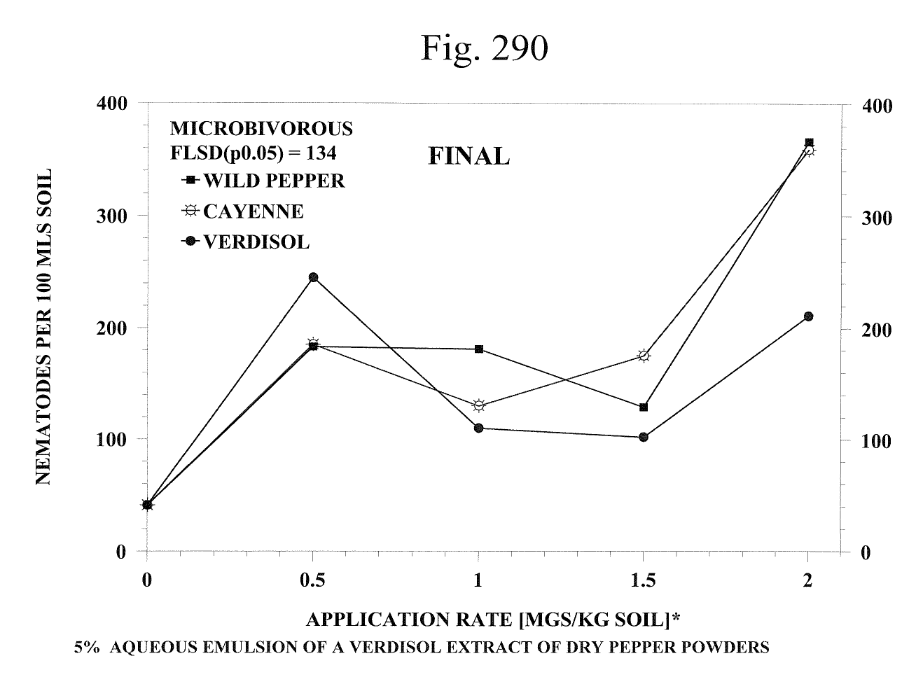

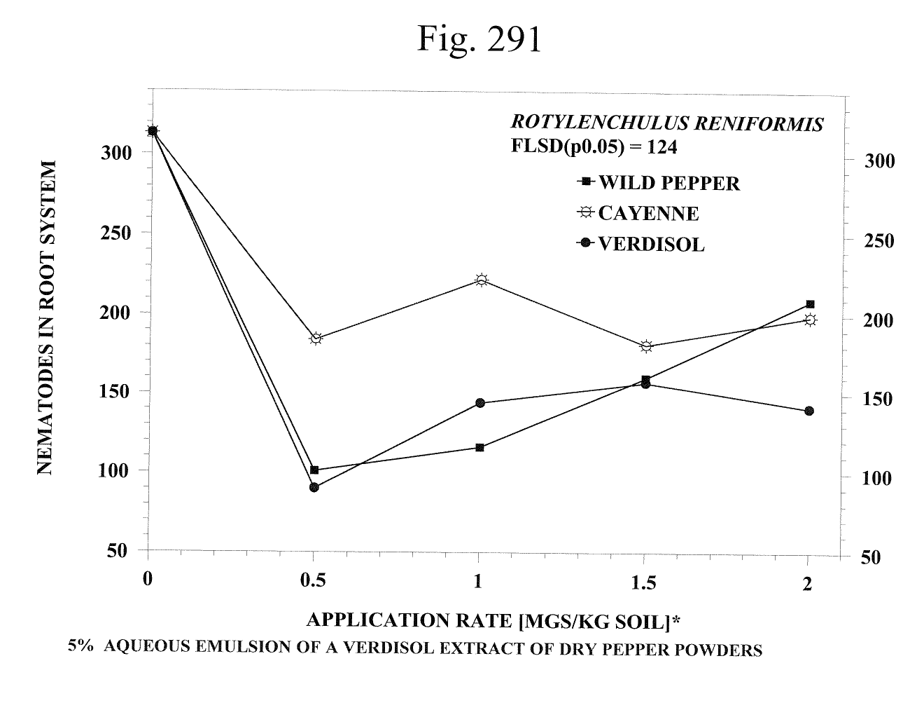

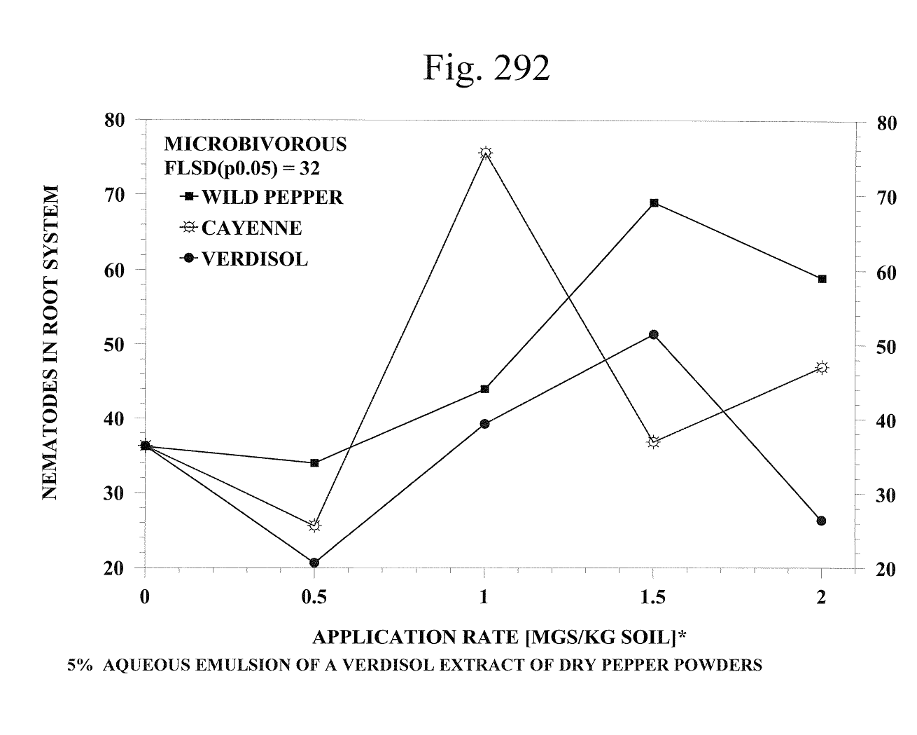

A pre-plant sample of soil was taken and nematodes per 100 mls of soil was determined (FIGS. 281-283). Cucumber seeds were planted in the pots, and sixty-one (61) days later, shoot height (FIG. 284), shoot weight (FIG. 285), root weight (FIG. 286), and root condition index (FIG. 287) were determined. The number of nematodes per 100 mls of soil and in the root system was determined (FIGS. 288-292).

Weed Test 195

Benzaldehyde and salicylaldehyde were tested as pesticide actives. Stock solutions were prepared by adding 50 ml benzaldehyde or salicylaldehyde (ai) to 50 ml biodiesel (AL Biodiesel, Moundville, Ala.). A 2% emulsion was prepared by adding 40 g of the stock solution, 4 mls of Polysorb 80 emulsifier (Tween), and diluting to 2 L with demineralized water. Emulsion was stirred well.

Soil that was combined with sand (1:1) to prepare a soil mixture for testing. One kilogram of the soil mixture was added to seven (7) pots for each test mixture. Testing was performed by adding a standard weed seed pack to the soil and drenching the soil with 100 mls of test compositions as indicated in Table 19.

TABLE 19

| | ai | |
|---|---|---|
| | (mls 2% emulsion/ | ai |
| Test | kg soil) | (mg/kg soil) |
| Control | | |
| Benzaldehyde | 10 | 100 |
| “” | 20 | 200 |
| “” | 30 | 400 |
| “” | 40 | 600 |
| “” | 50 | 800 |
| “” | 60 | 1200 |
| Salicylaldehyde | 10 | 100 |
| “” | 20 | 200 |
| “” | 30 | 400 |
| “” | 40 | 600 |
| “” | 50 | 800 |
| “” | 60 | 1200 |
| Control | | |

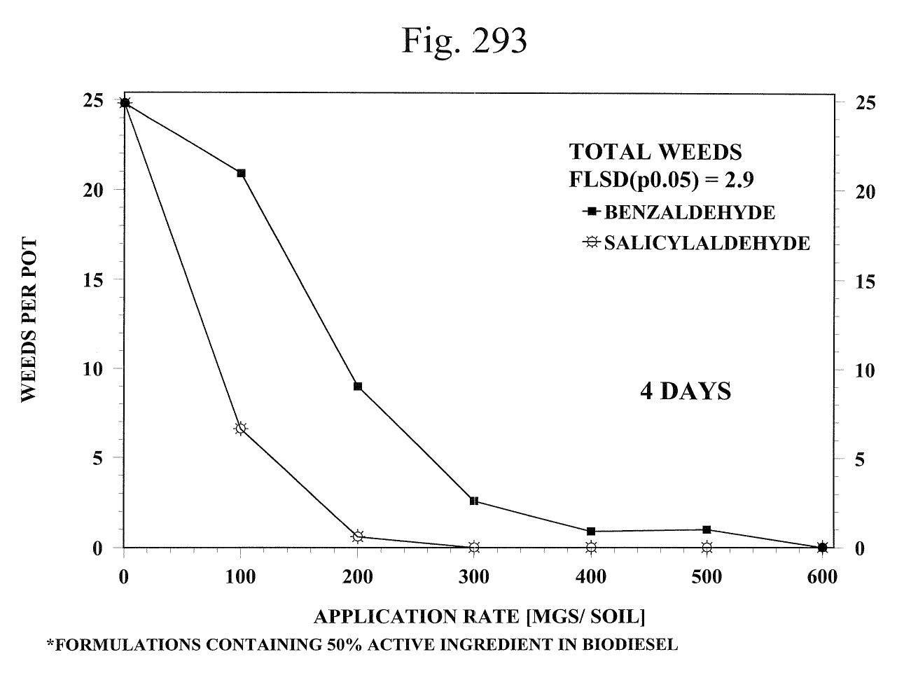

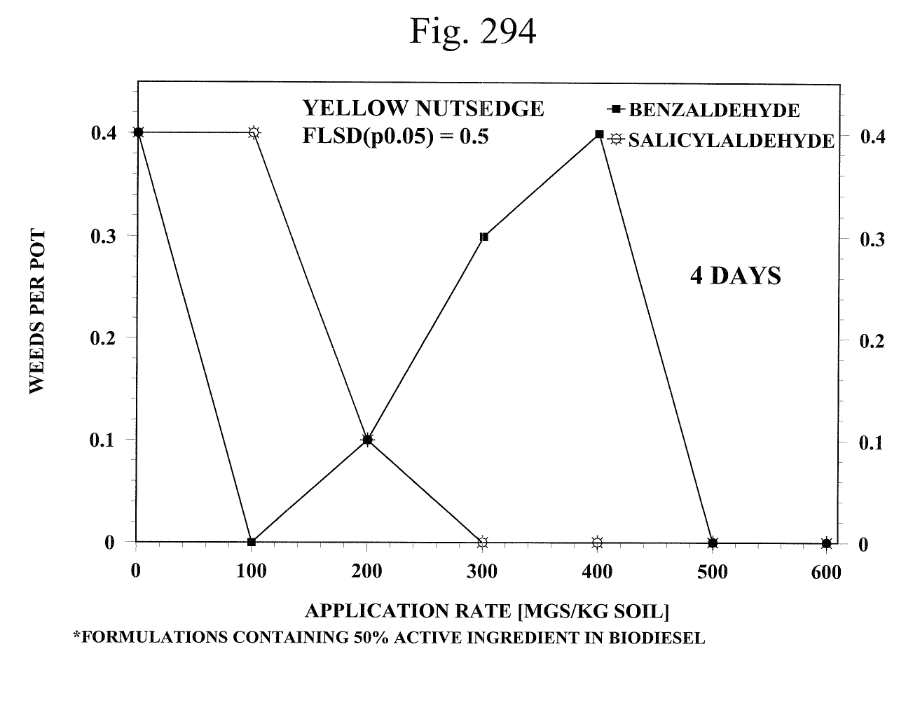

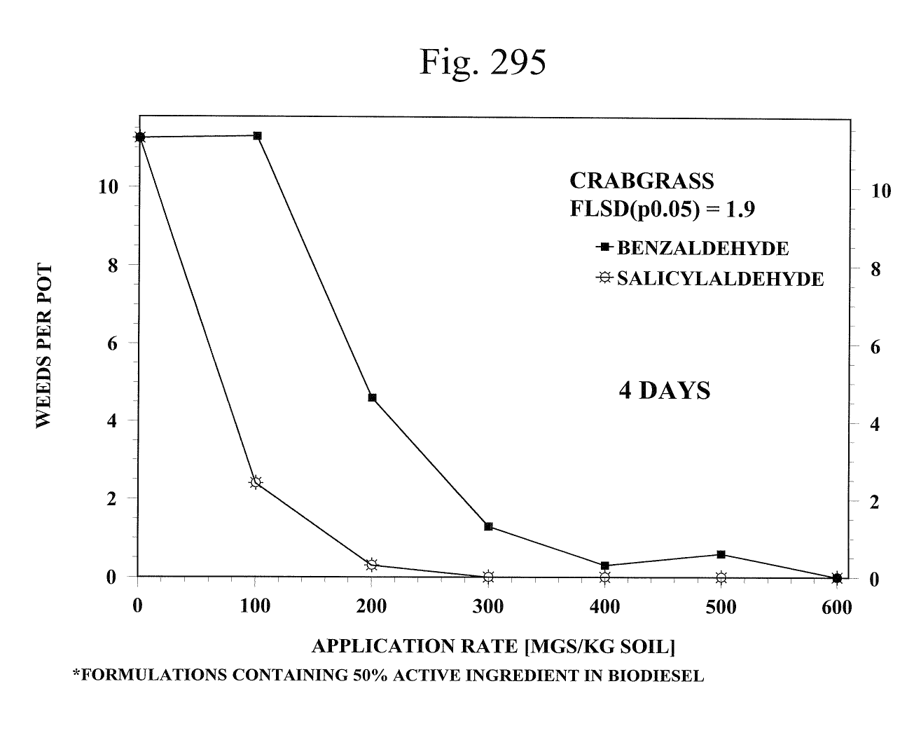

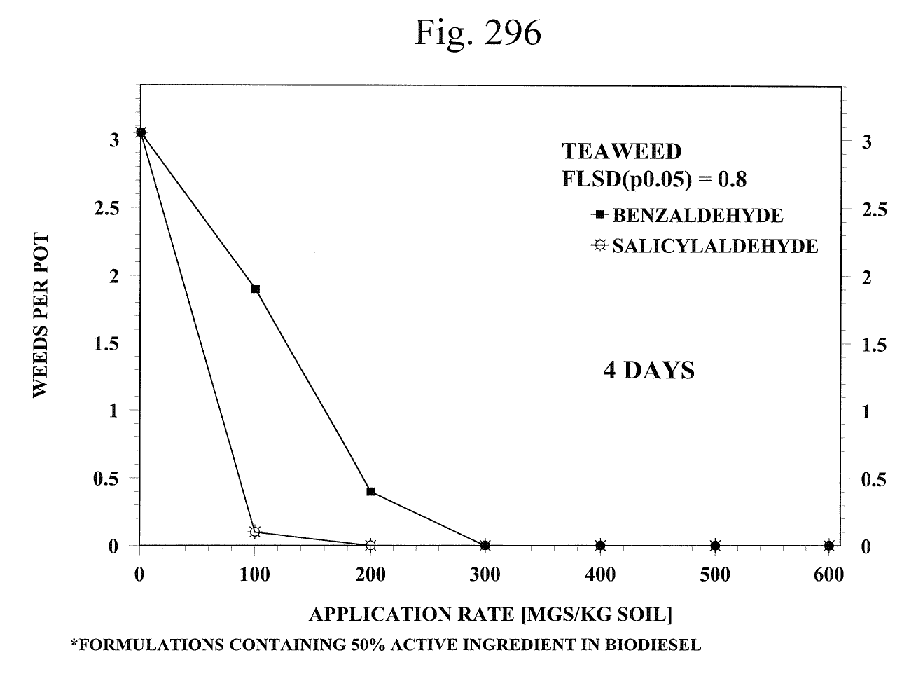

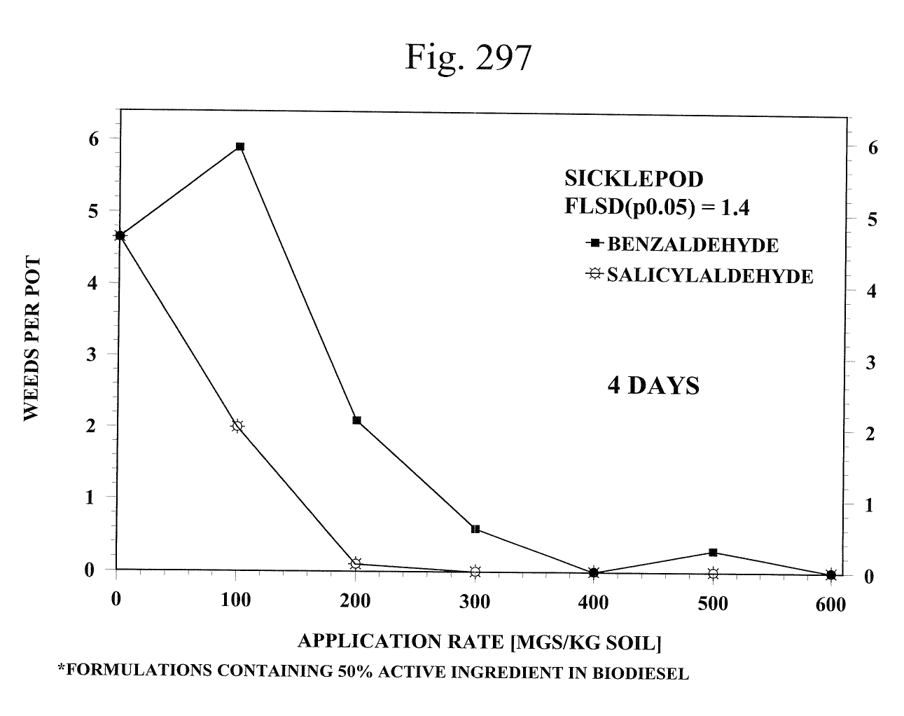

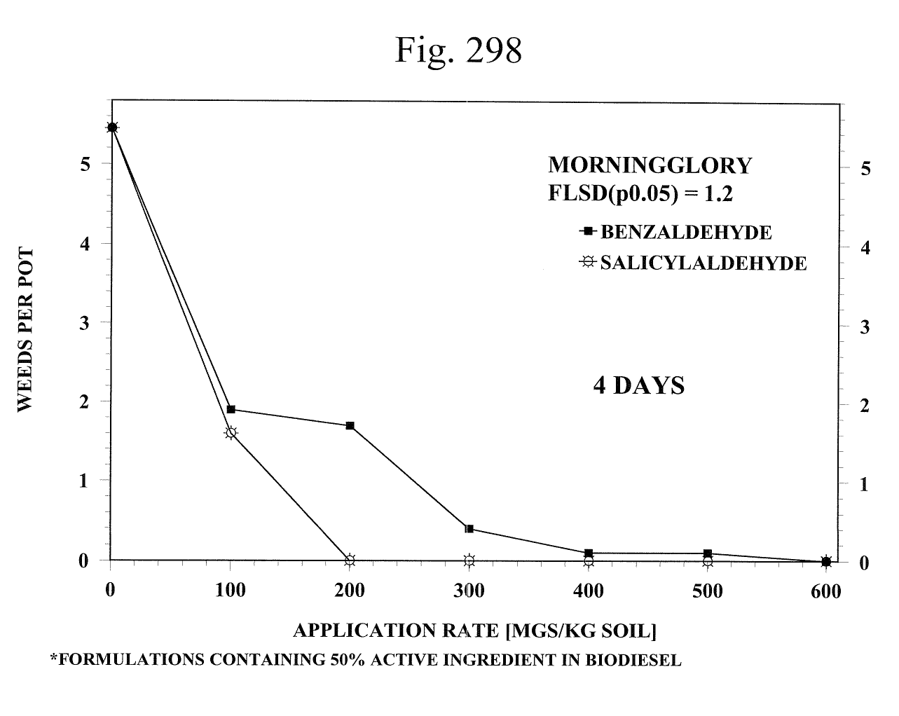

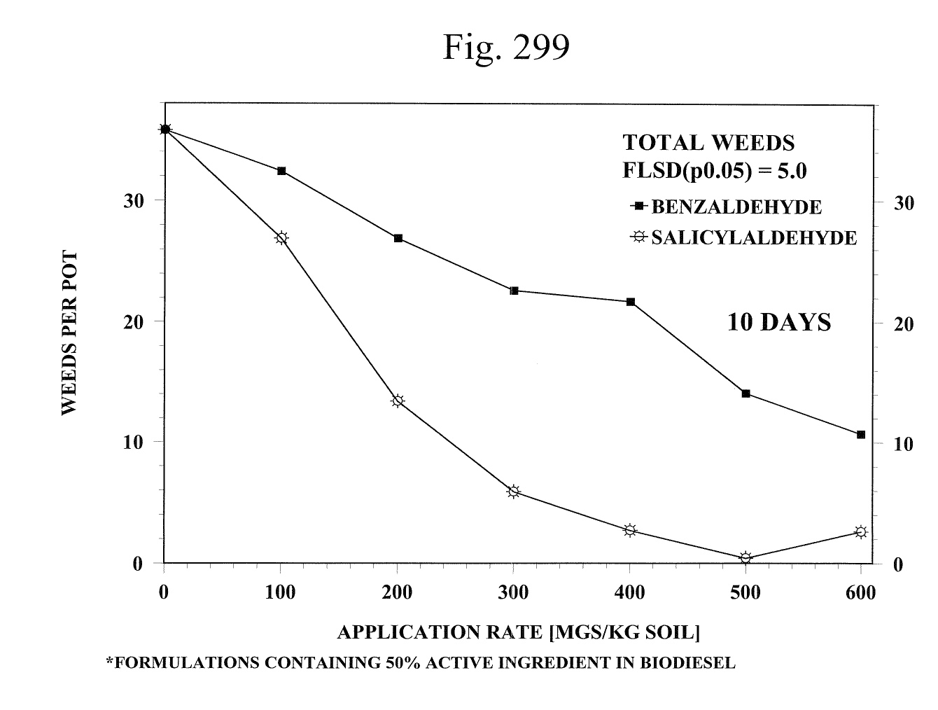

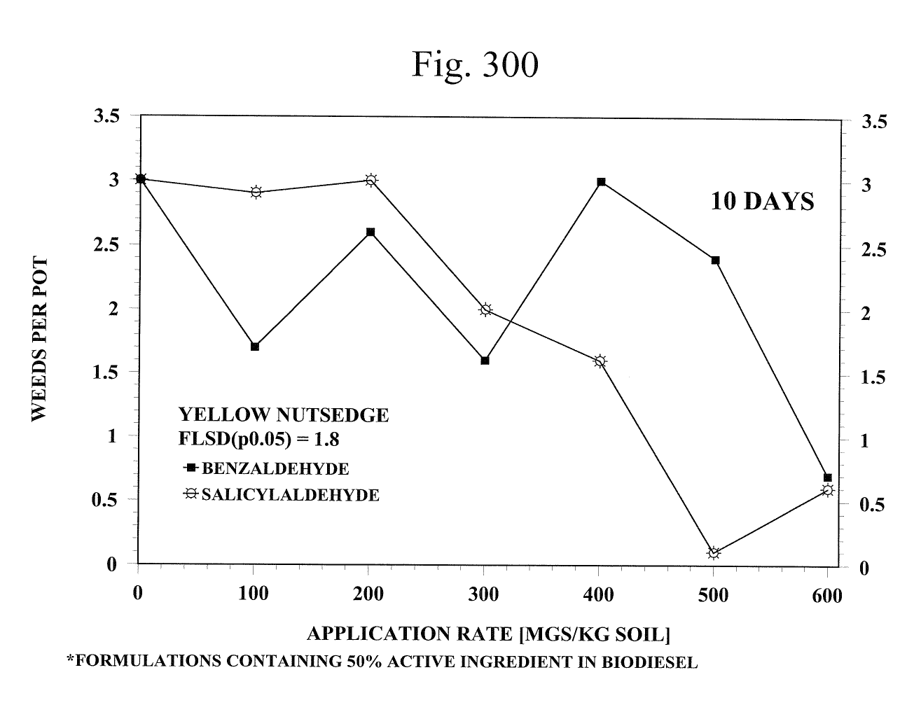

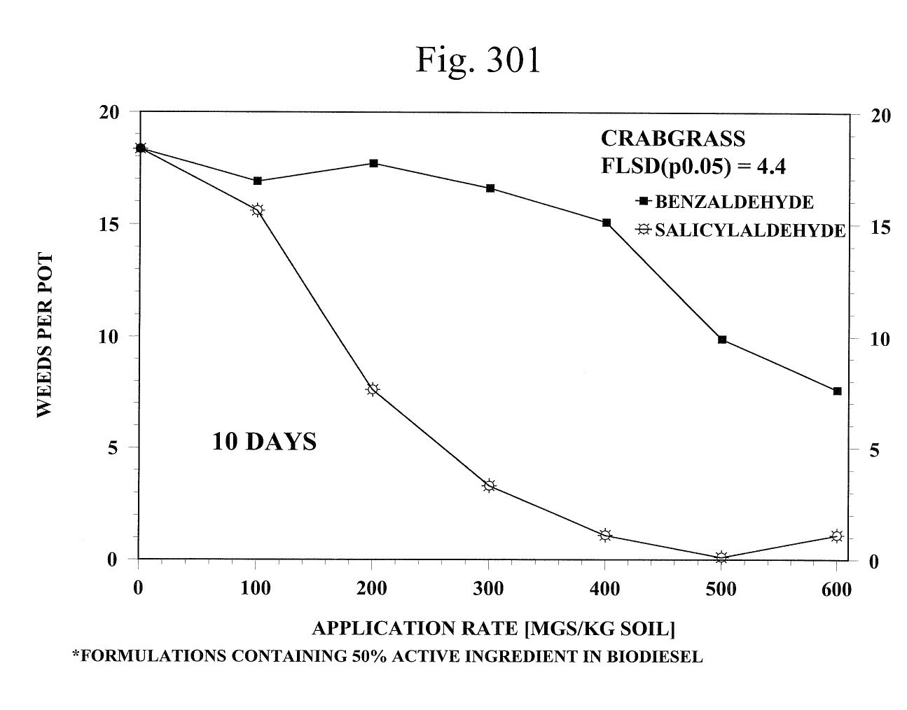

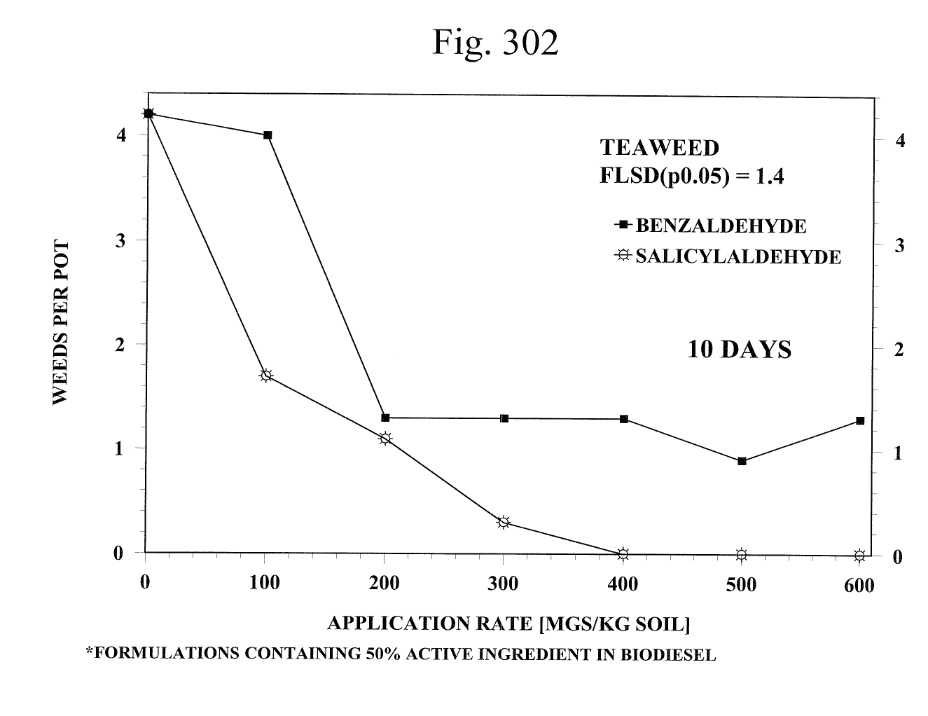

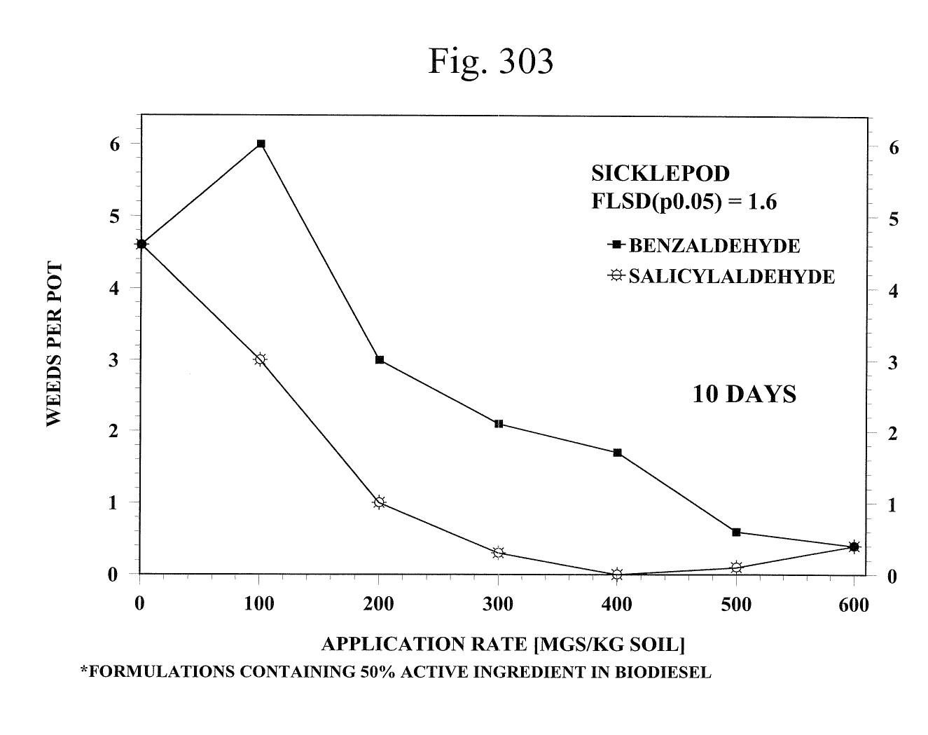

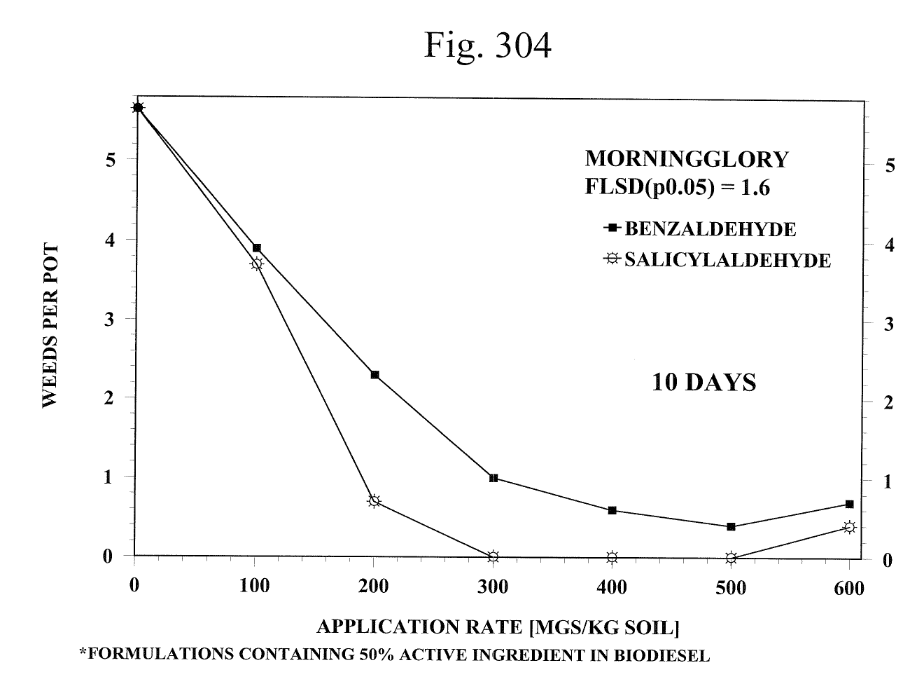

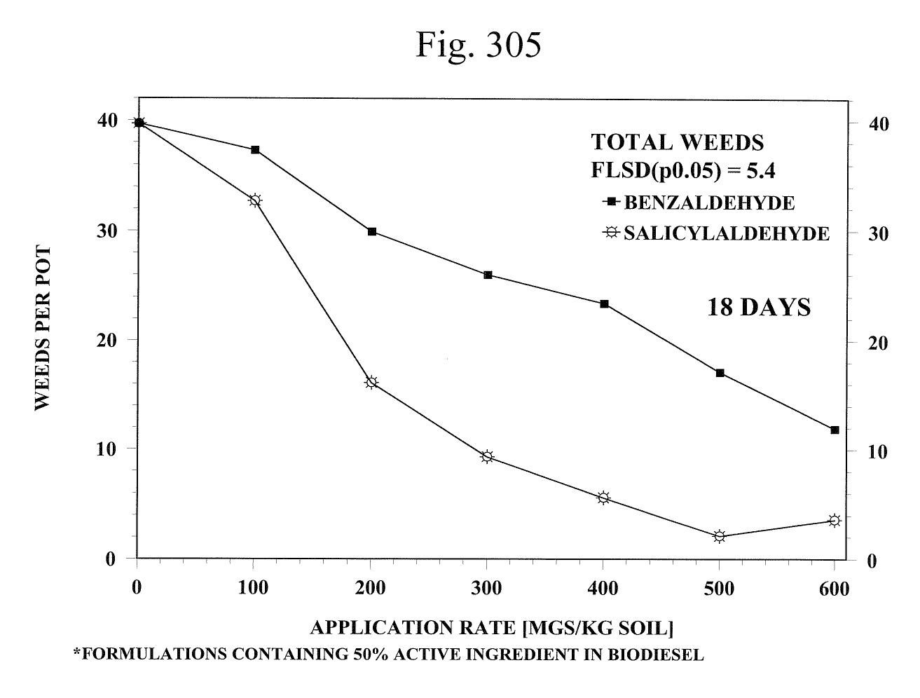

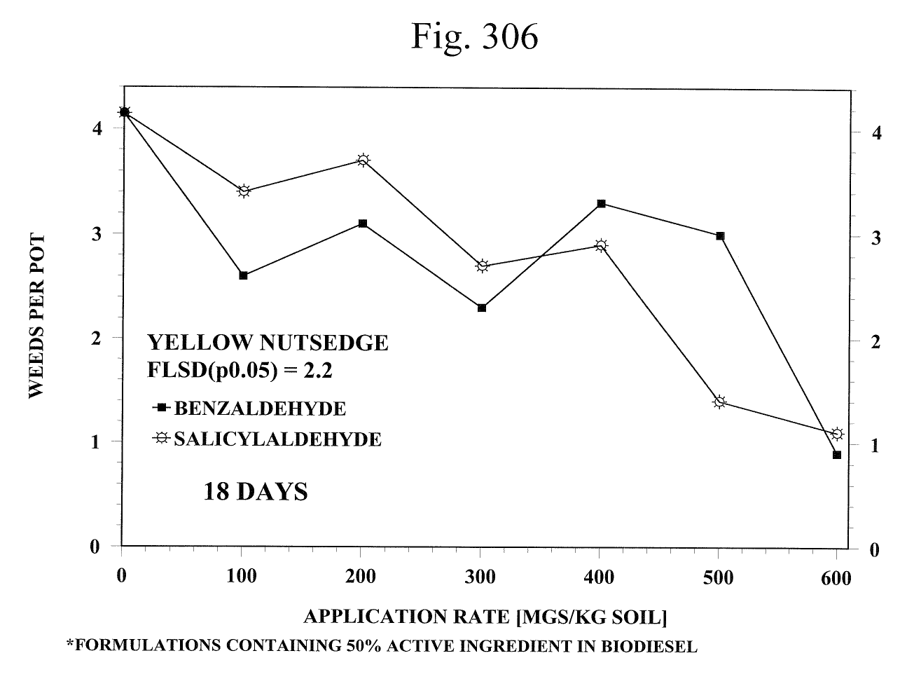

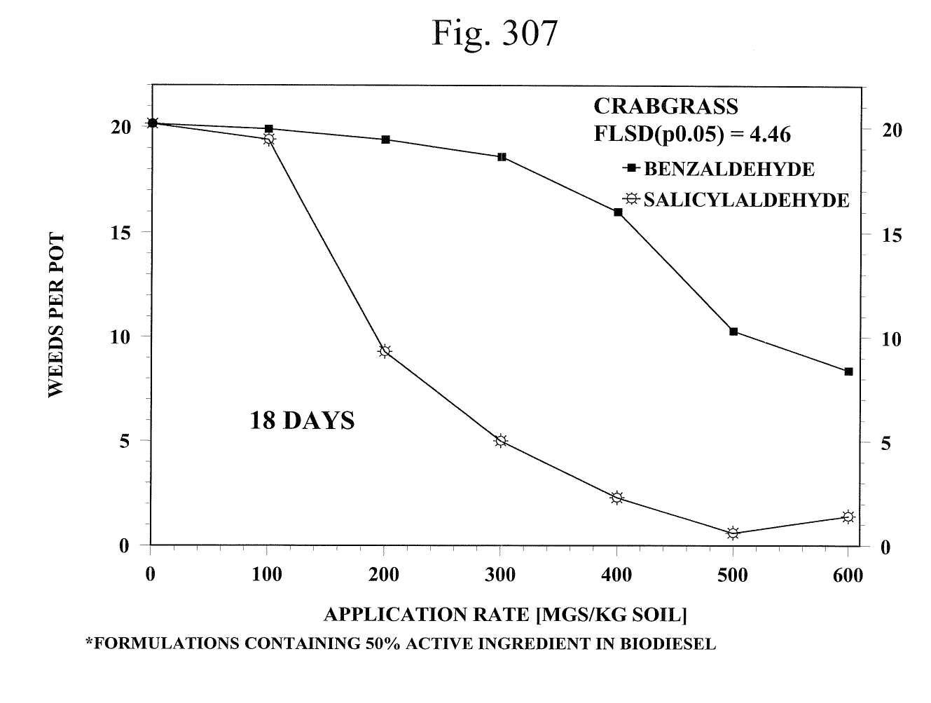

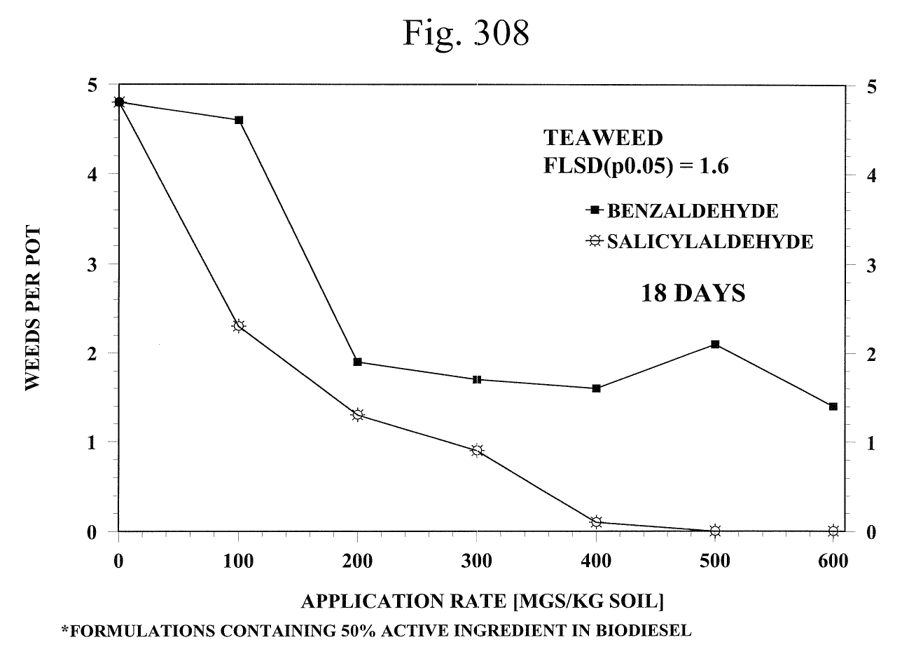

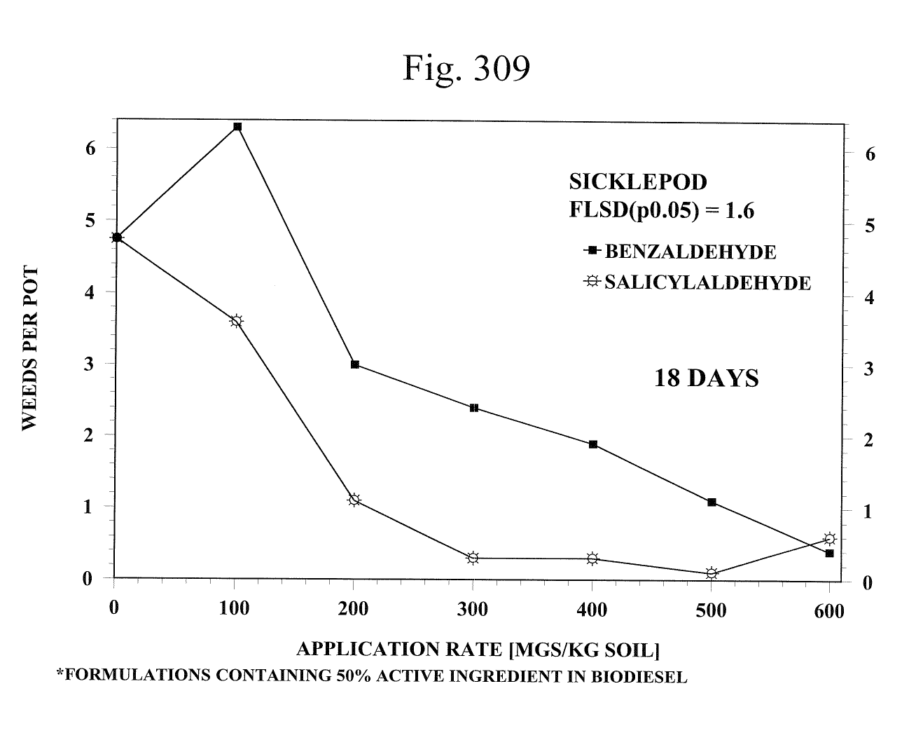

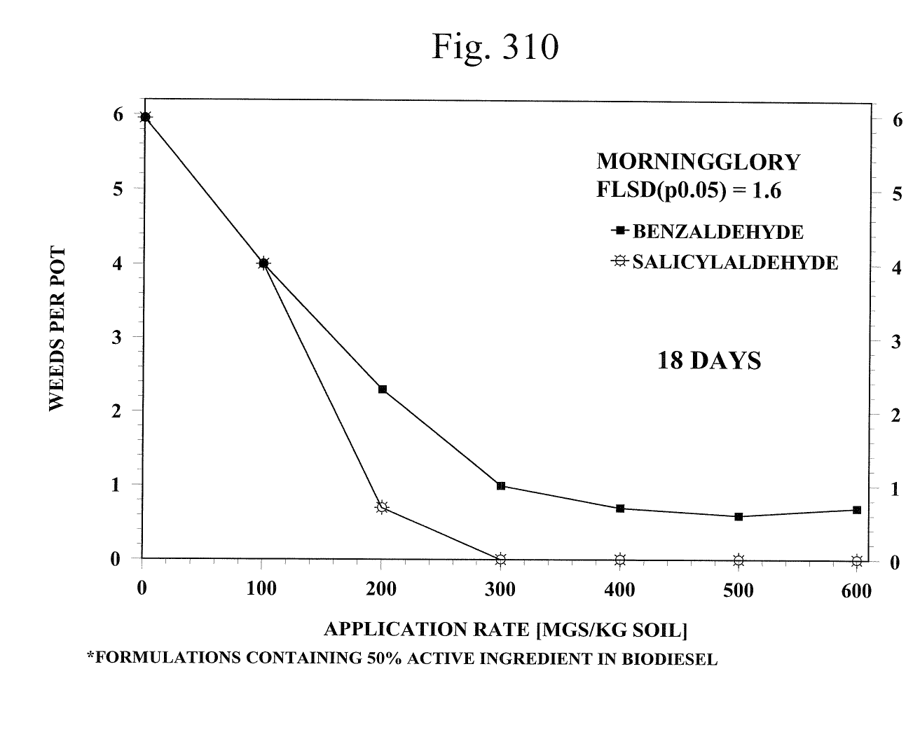

The standard weed seed pack comprised seeds of yellow nutsedge, crabgrass, teaweed, sicklepod, and morning glory. The number of total weeds and individual weeds was determined after four (4) days (FIGS. 293-298), ten (10) days (FIGS. 299-304), and eighteen (18) days (FIGS. 305-310).

Weed Test 196

A stock 10% dazomet solution was prepared by adding 10 g dazomet to 30 mls of warm (40° C.) benzaldehyde, 10 mls Polysorb 80 emulsifier (Tween), and 50 mls of biodiesel. Total volume was approximately 100 mls. The formulation exhibited instability. An 0.5% emulsion was prepared by bringing the final volume of the 100 mls formulation to 2 L with demineralized water.

A stock 15% diazirine solution was prepared by adding 15 g diazirine to 30 ms of n-pentyl alcohol, 10 mls Polysorb 80 emulsifier (Tween), and 45 mls of biodiesel. Total volume was approximately 100 mls. The formulation exhibited stability. An 0.5% emulsion was prepared by bringing the final volume of 66.67 mls of the formulation to 2 L with demineralized water.

Soil that was combined with sand (1:1) to prepare a soil mixture for testing. One kilogram of the soil mixture was added to seven (7) pots for each test mixture. Testing was performed by adding a standard weed seed pack to the soil and drenching the soil with 100 mls of test compositions as indicated in Table 20.

TABLE 20

| | ai | |
|---|---|---|
| | (mls 0.5% emulsion/ | ai |
| Test | kg soil) | (mg/kg soil) |
| Control | | |
| Dazomet + | 10 | 50 |
| Biodiesel | | |
| “” | 20 | 100 |
| “” | 30 | 150 |
| “” | 40 | 200 |
| “” | 50 | 250 |
| “” | 60 | 300 |
| Diazirine + | 10 | 50 |
| Biodiesel | | |
| “” | 20 | 100 |
| “” | 30 | 150 |
| “” | 40 | 200 |
| “” | 50 | 250 |
| “” | 60 | 300 |
| Control | | |

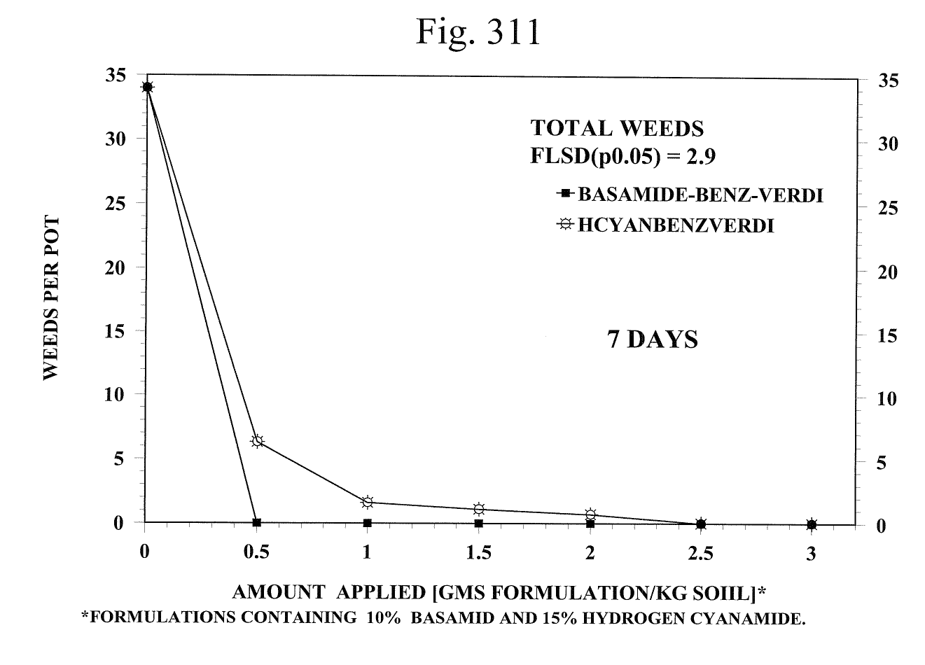

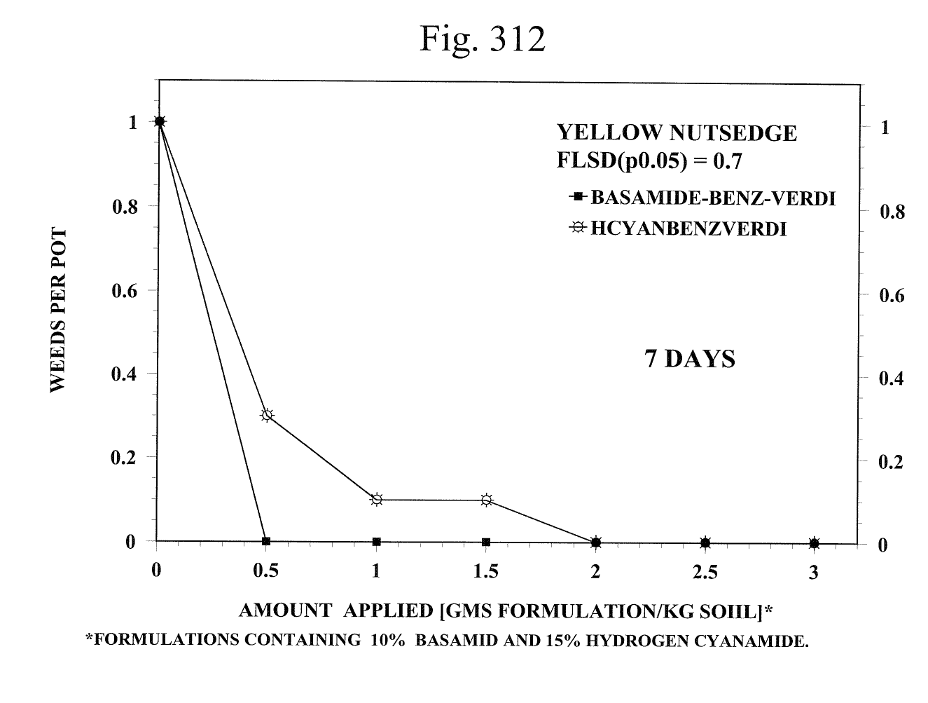

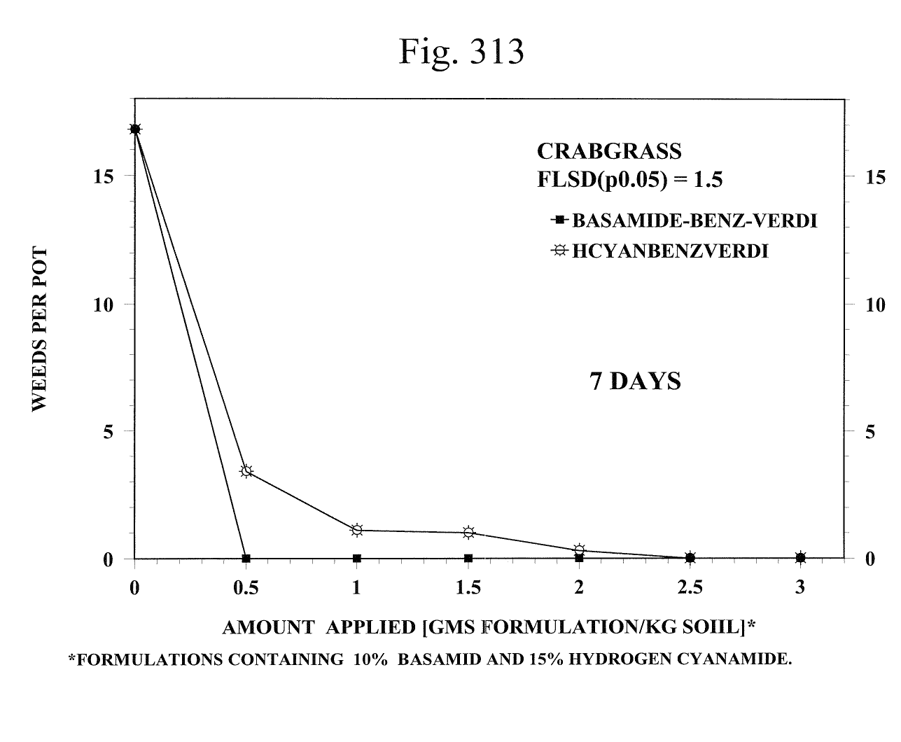

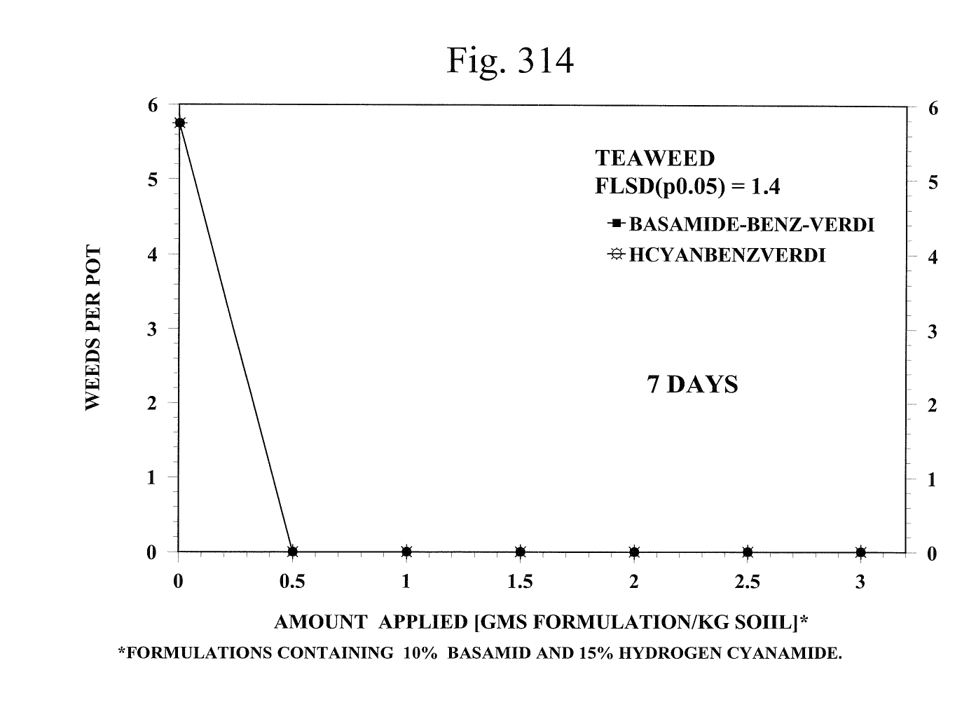

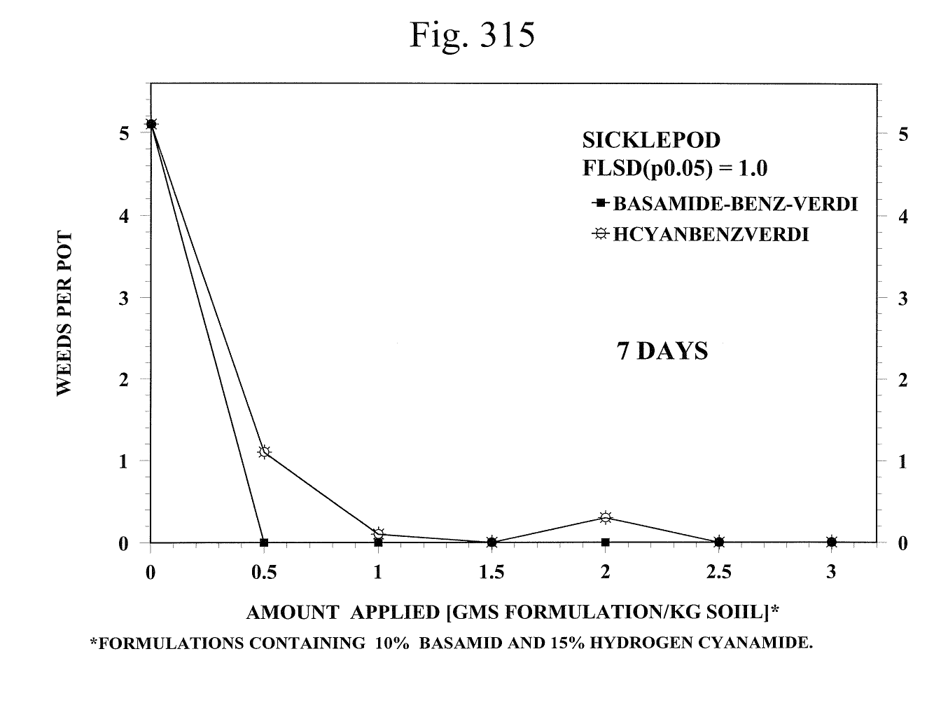

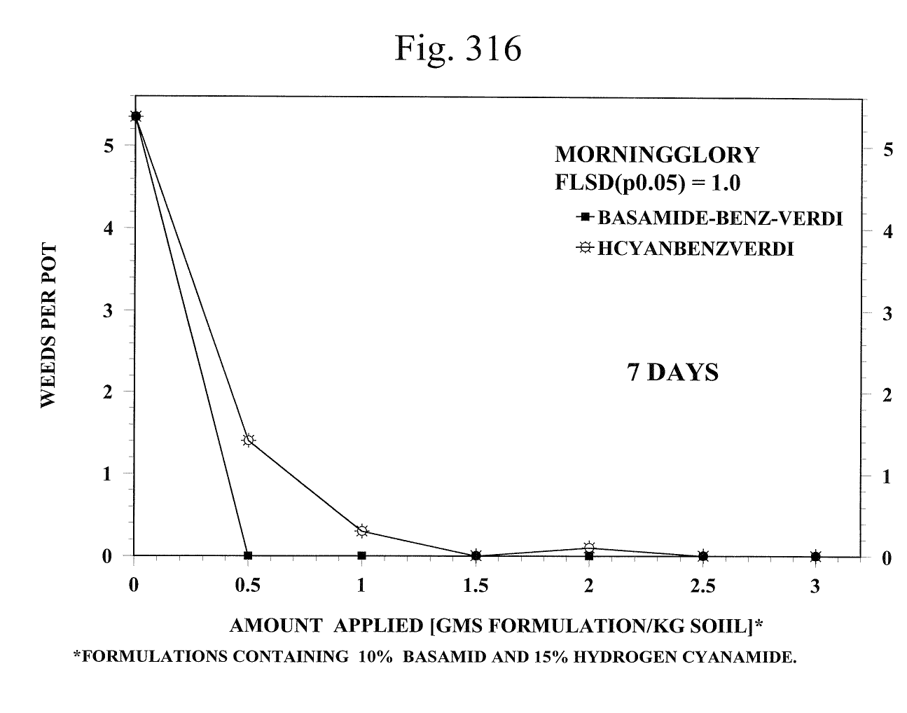

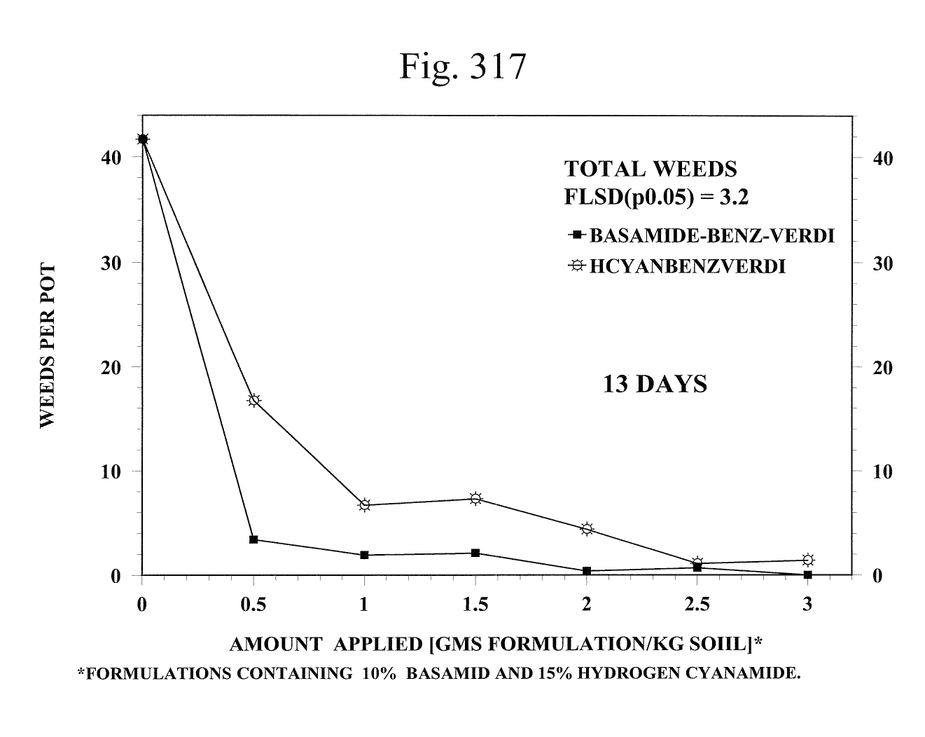

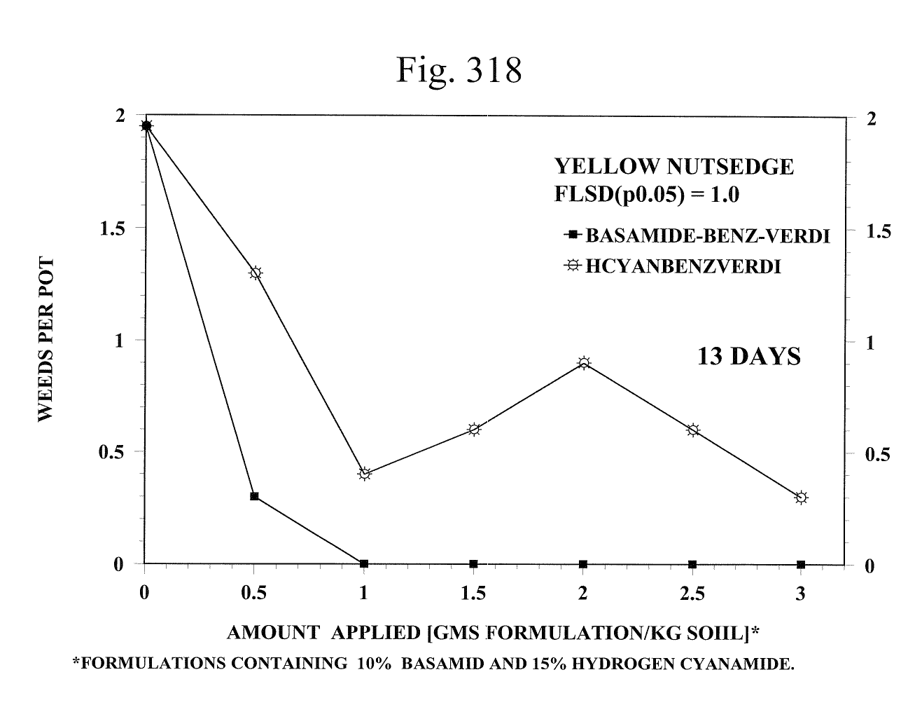

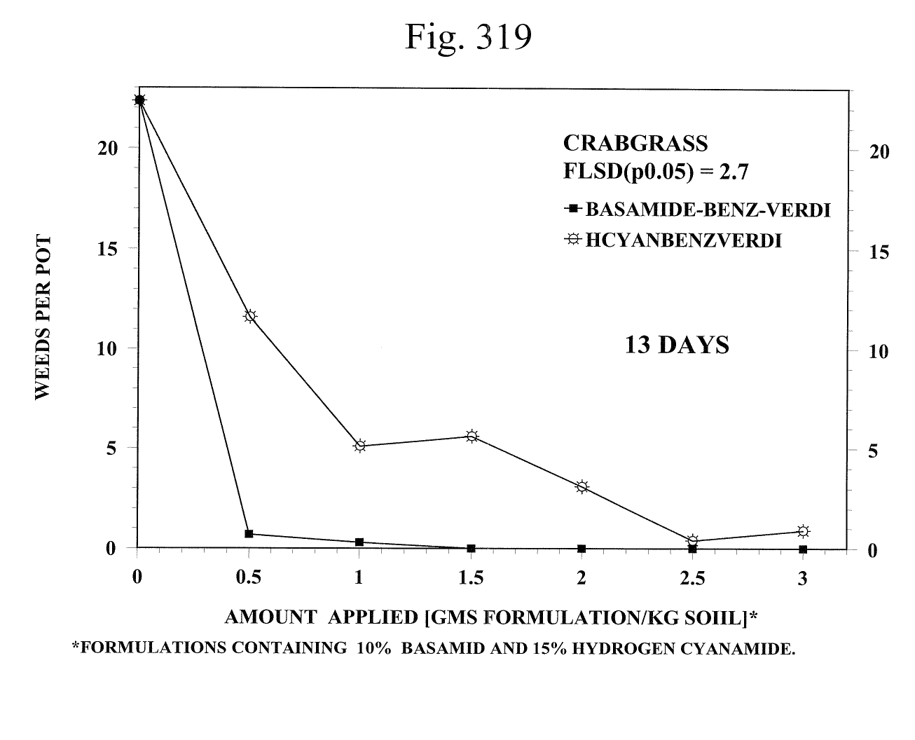

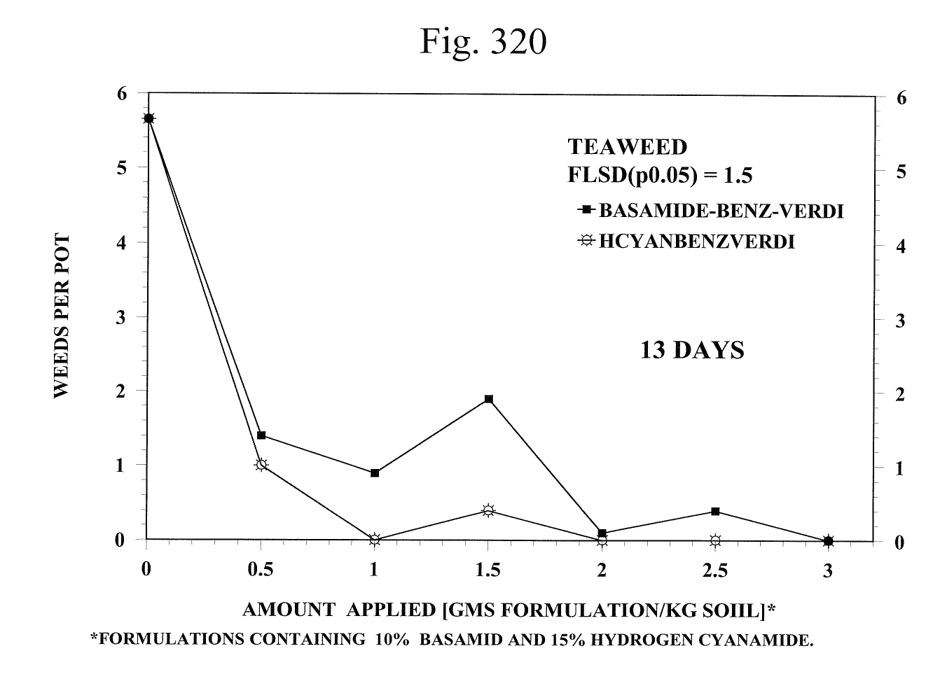

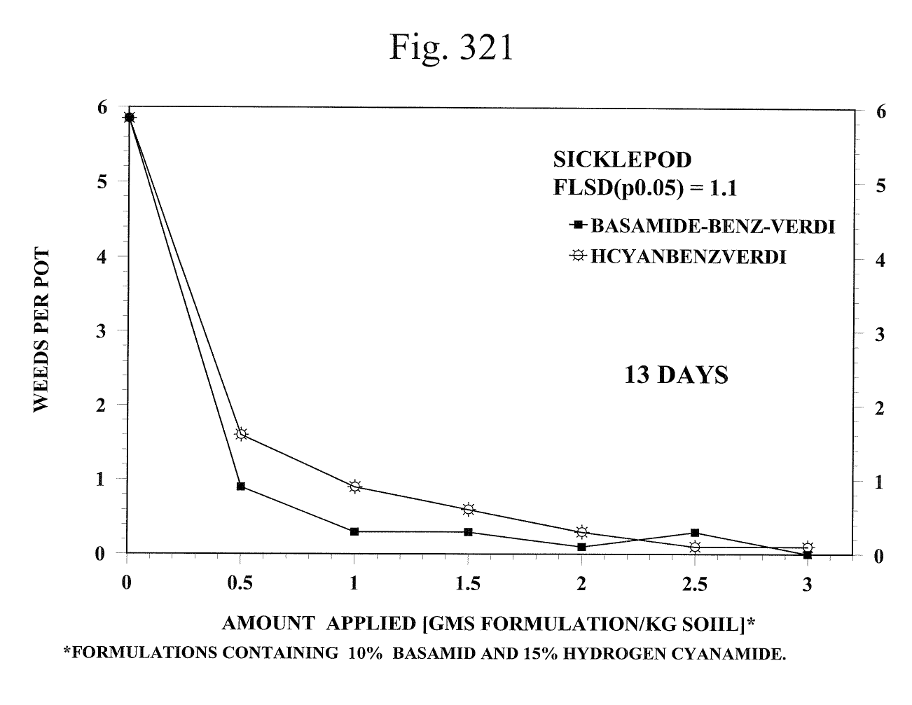

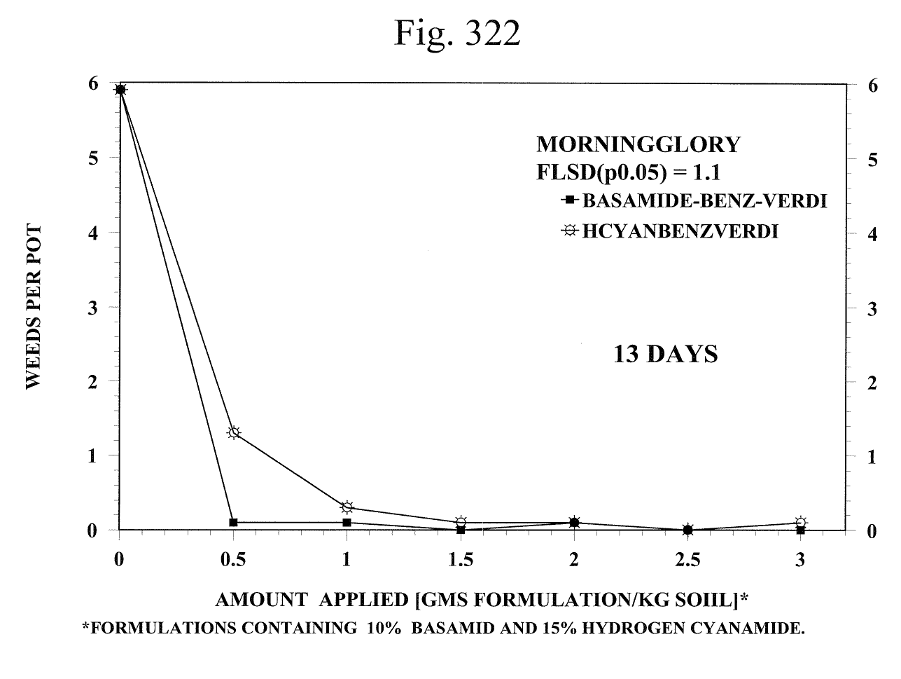

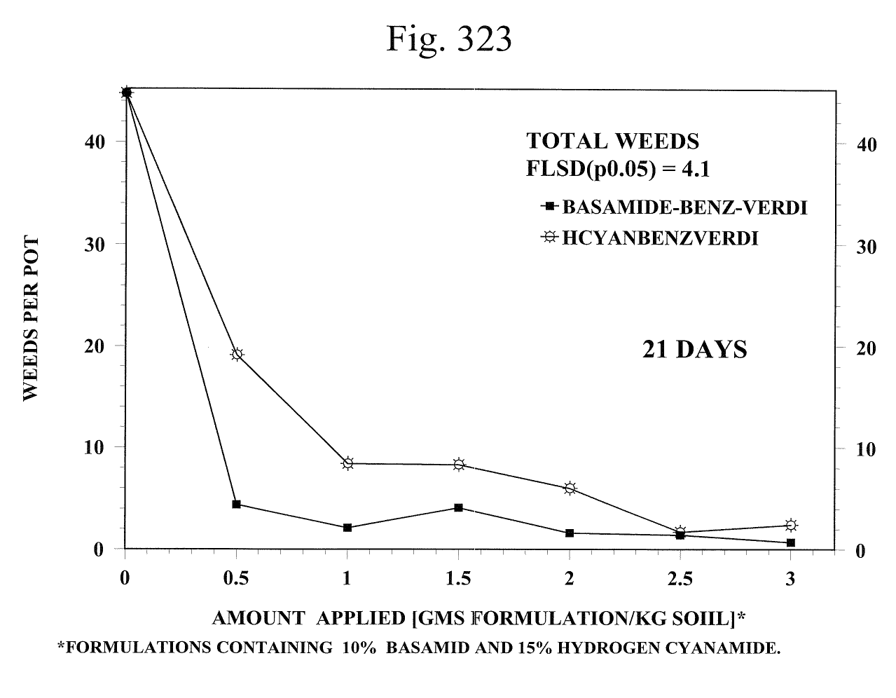

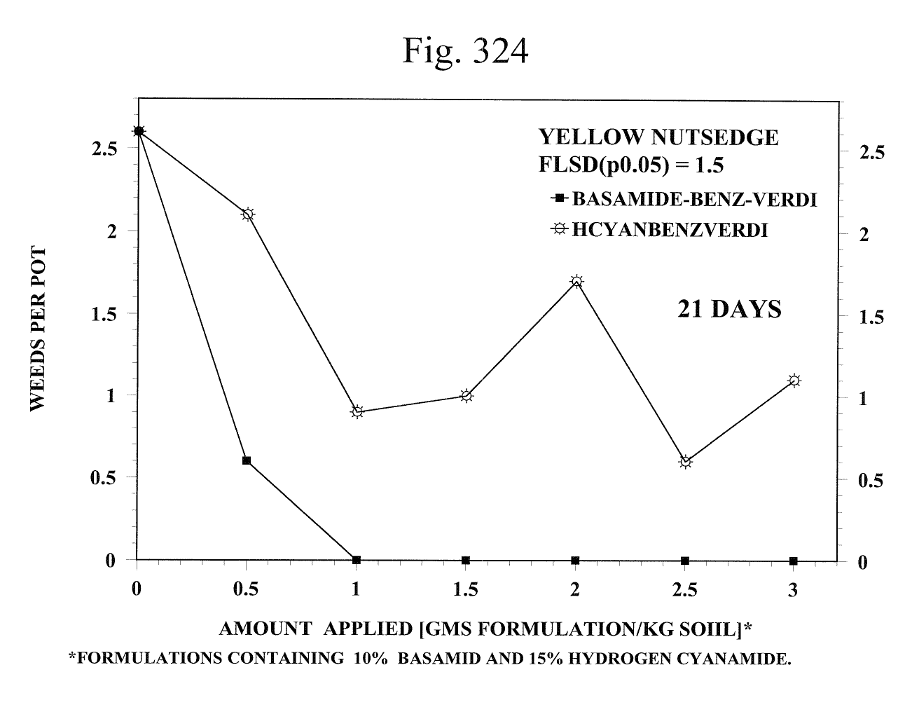

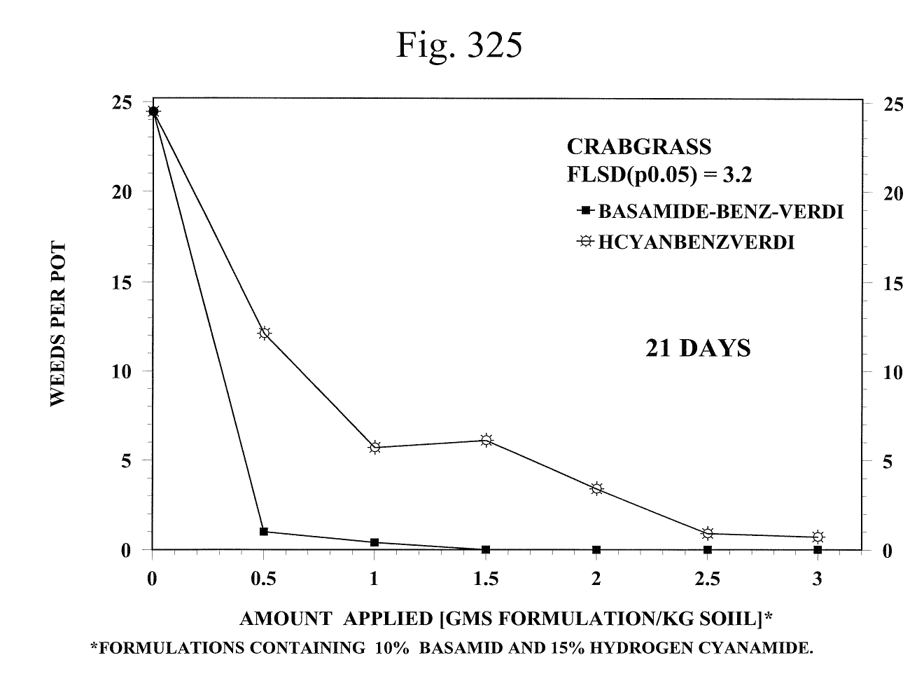

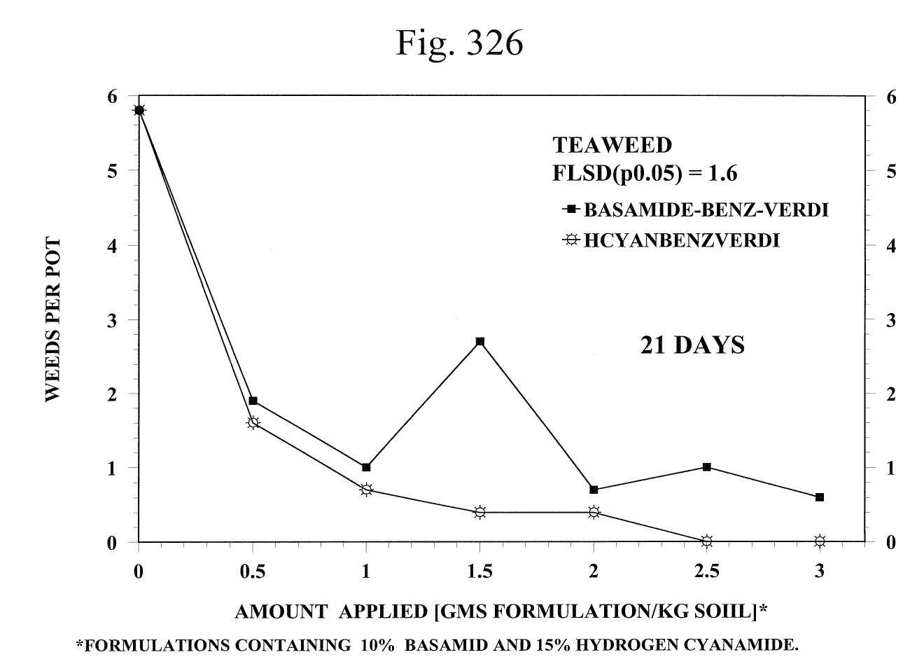

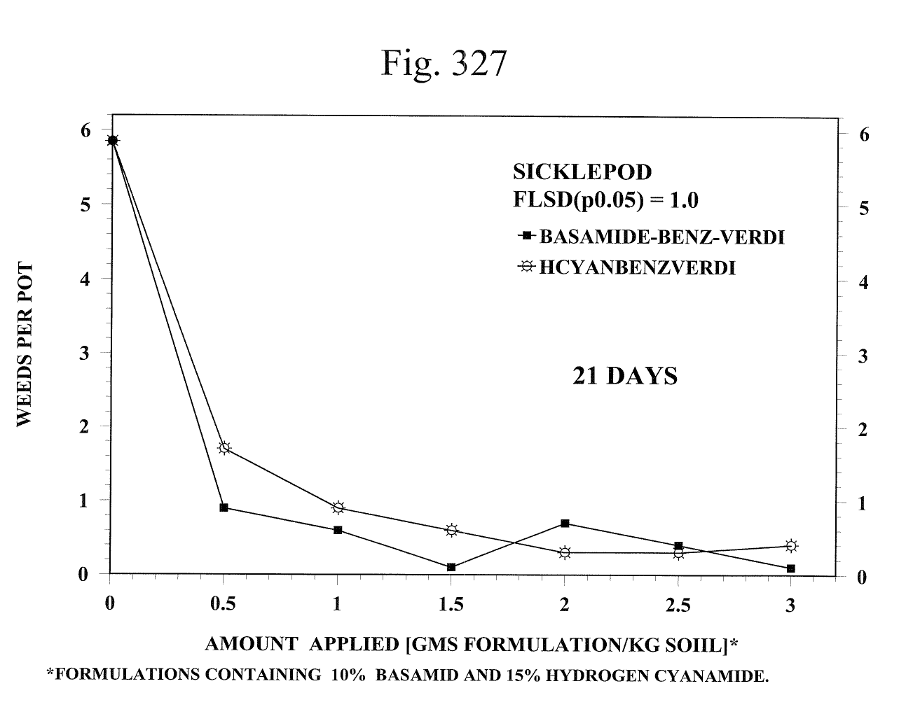

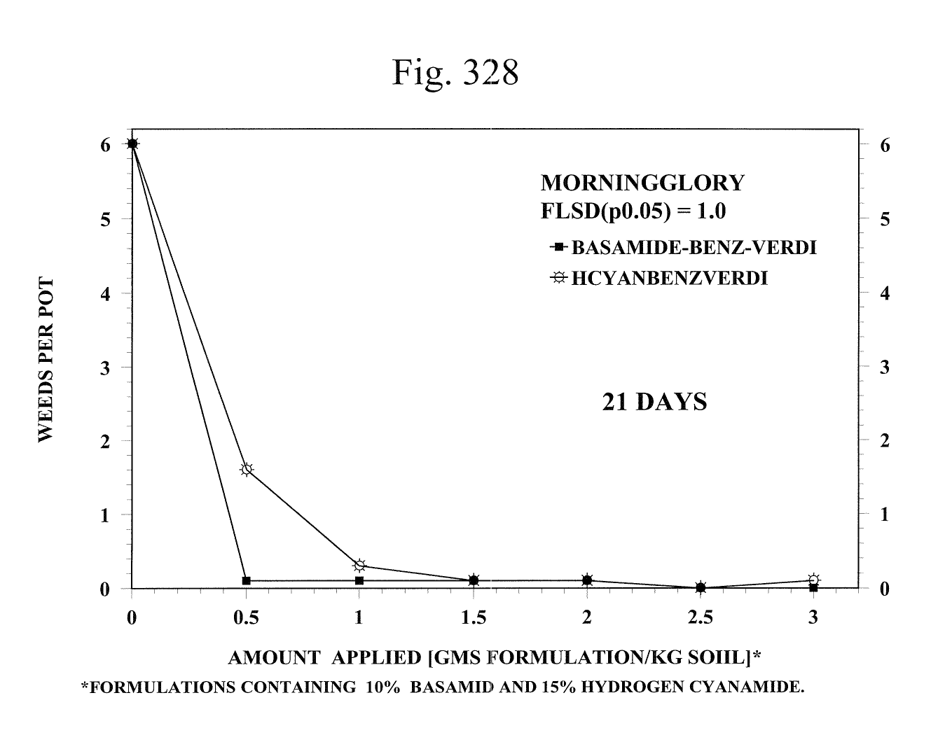

The standard weed seed pack comprised seeds of yellow nutsedge, crabgrass, teaweed, sicklepod, and morning glory. The number of total weeds and individual weeds was determined after seven (7) days (FIGS. 311-316), thirteen (13) days (FIGS. 317-322), and twenty-one (21) days (FIGS. 323-328).

Weed Test 197

A stock dazomet formulation was prepared by adding 15 g dazomet to 65 mls of warm (40° C.) benzaldehyde with stirring. Next, 5 mls Polysorb 80 emulsifier (Tween) was added followed by 15 mls of biodiesel. A working 1% emulsion was prepared by bringing the final volume of 35 mls of the stock formulation to 3.5 L with demineralized water.

Soil that was combined with sand (1:1) to prepare a soil mixture for testing. One kilogram of the soil mixture was added to seven (7) pots for each test mixture. Testing was performed by adding a standard weed seed pack to the soil and drenching the soil with 100 mls of test compositions as indicated in Table 20.

TABLE 20

| | Dazomet | |
|---|---|---|
| | (mls 0.15% | Dazomet |
| Test | emulsion/kg soil) | (mg/kg soil) |
| Control | | |
| Dazomet + | 10 | 15 |
| Biodiesel | | |
| “” | 15 | 22.5 |
| “” | 20 | 30 |
| “” | 25 | 37.5 |
| “” | 30 | 45 |
| “” | 35 | 52.5 |
| “” | 40 | 60 |
| “” | 45 | 67.5 |
| “” | 50 | 75 |
| “” | 55 | 82.5 |
| “” | 60 | 90 |
| “” | 70 | 105 |
| Control | | |

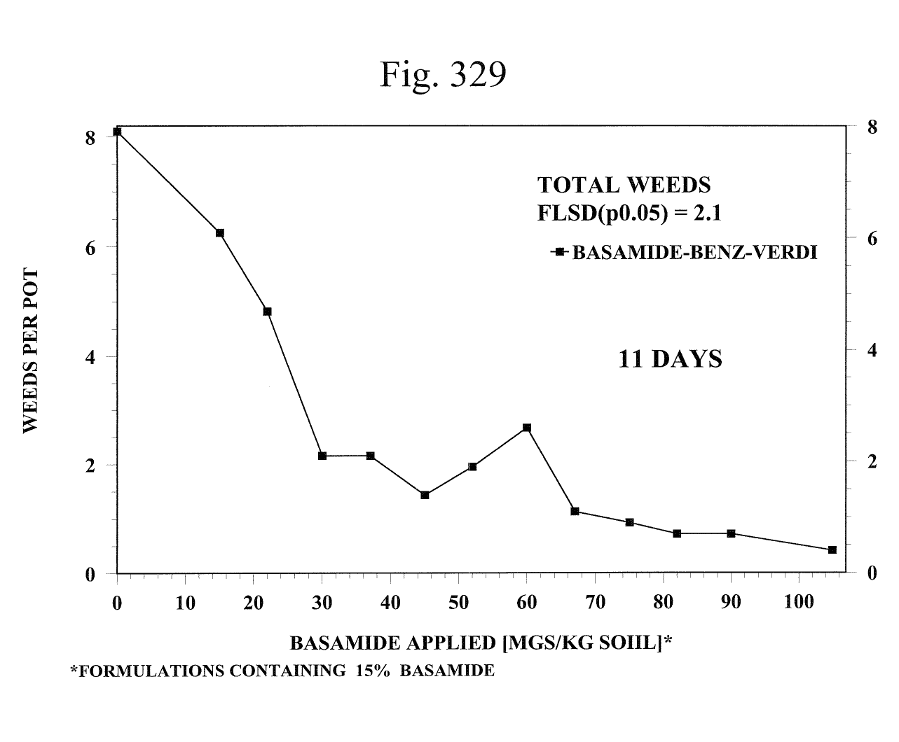

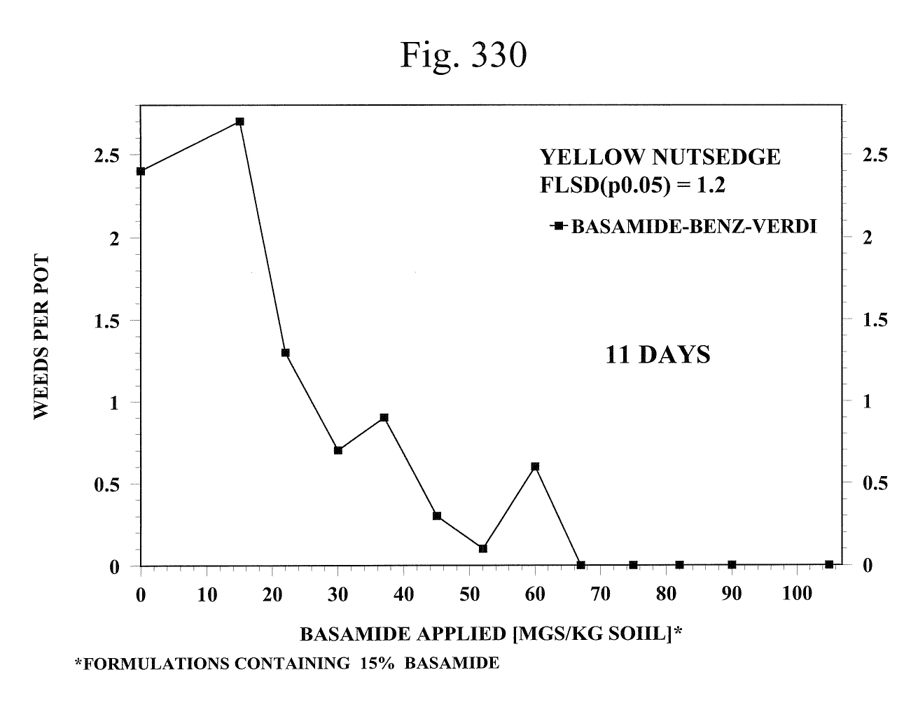

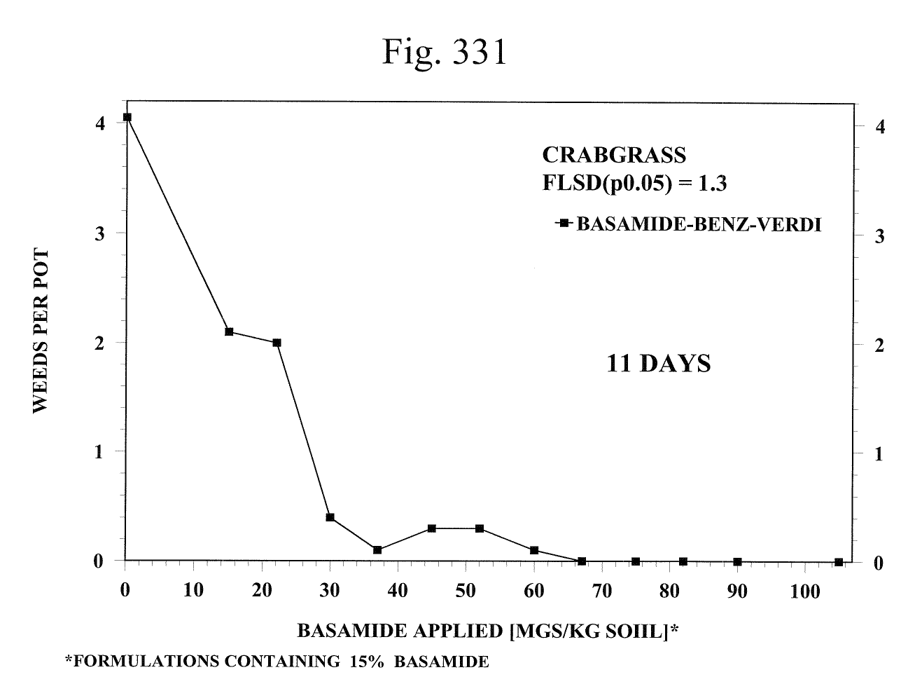

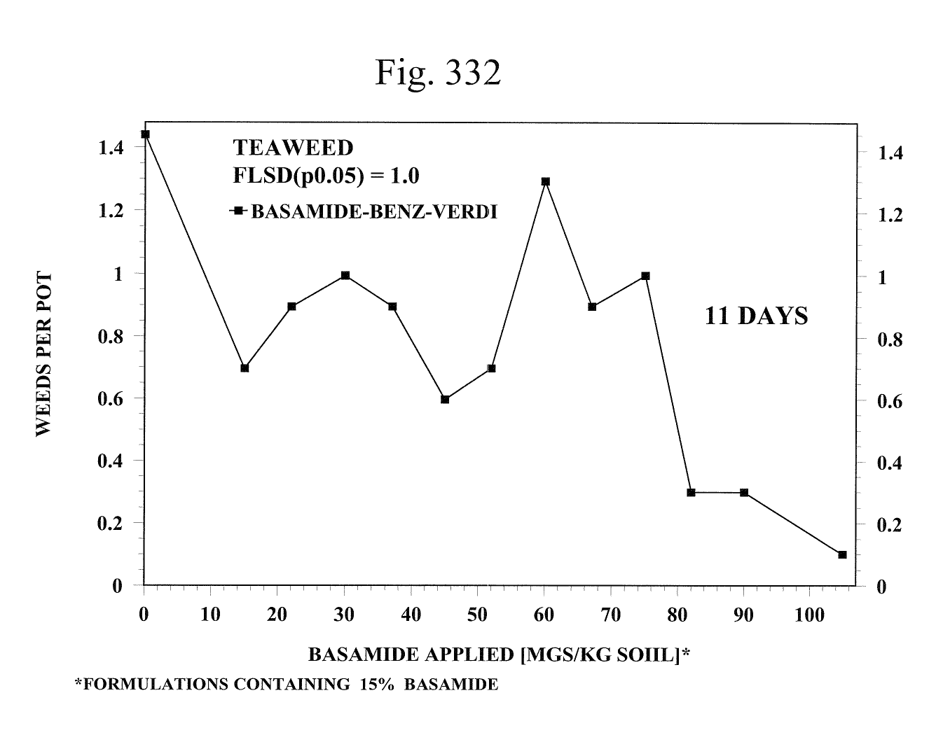

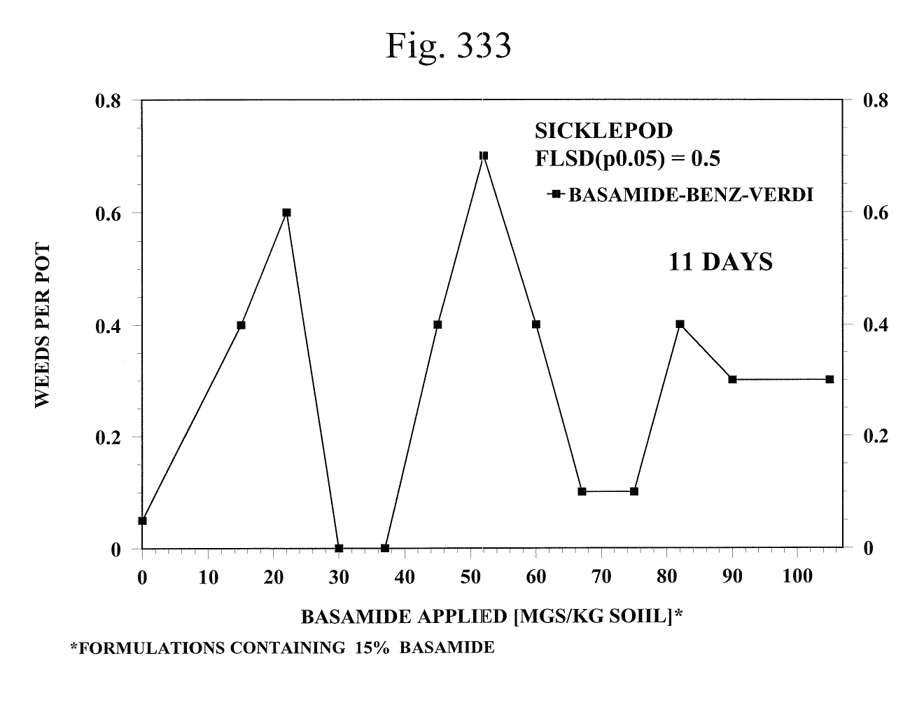

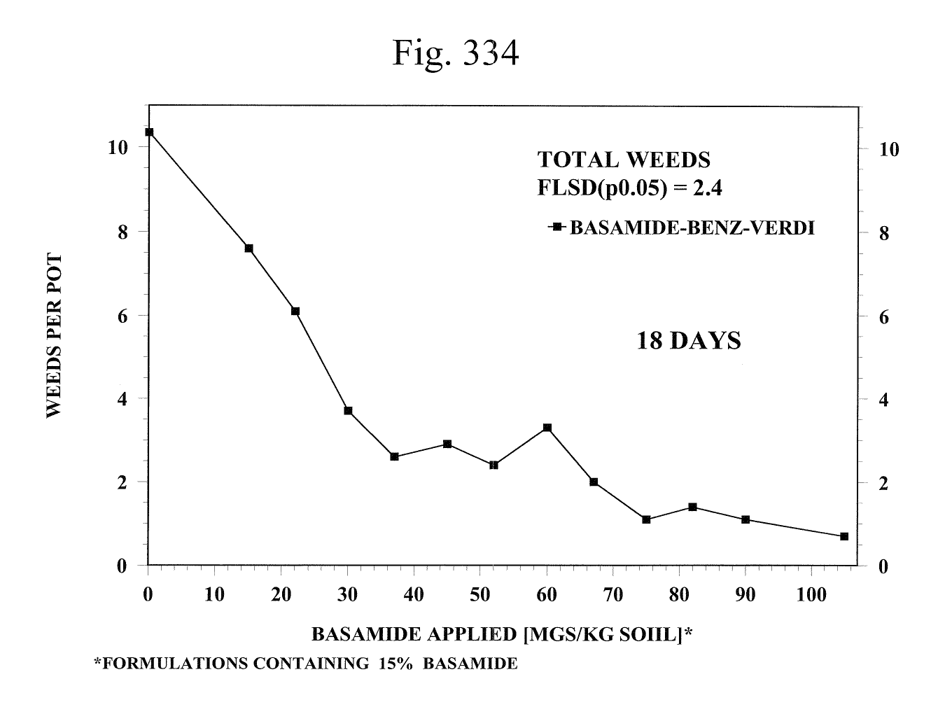

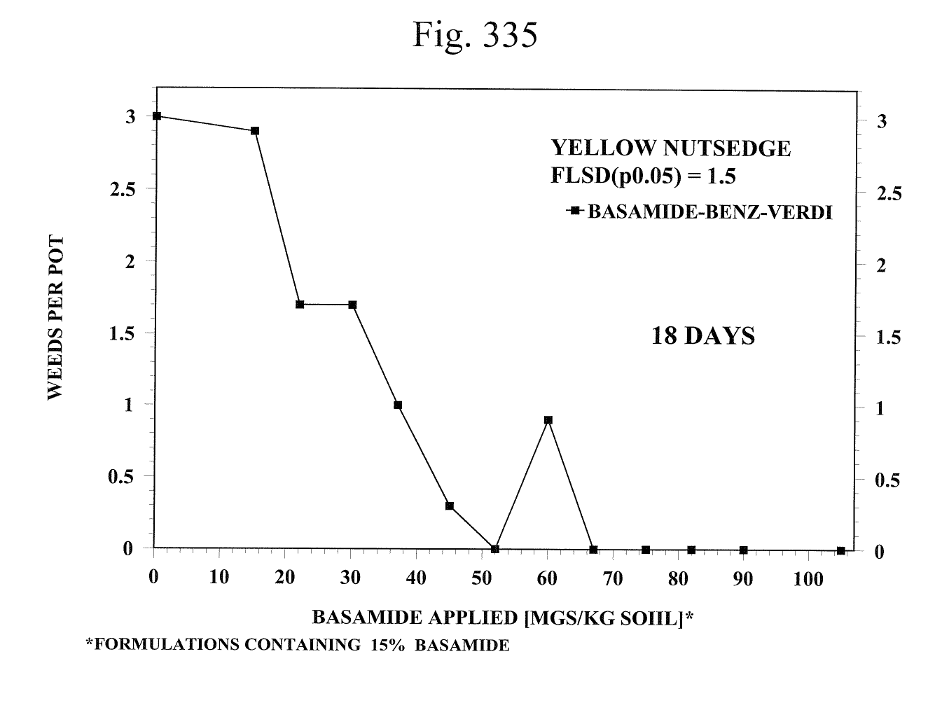

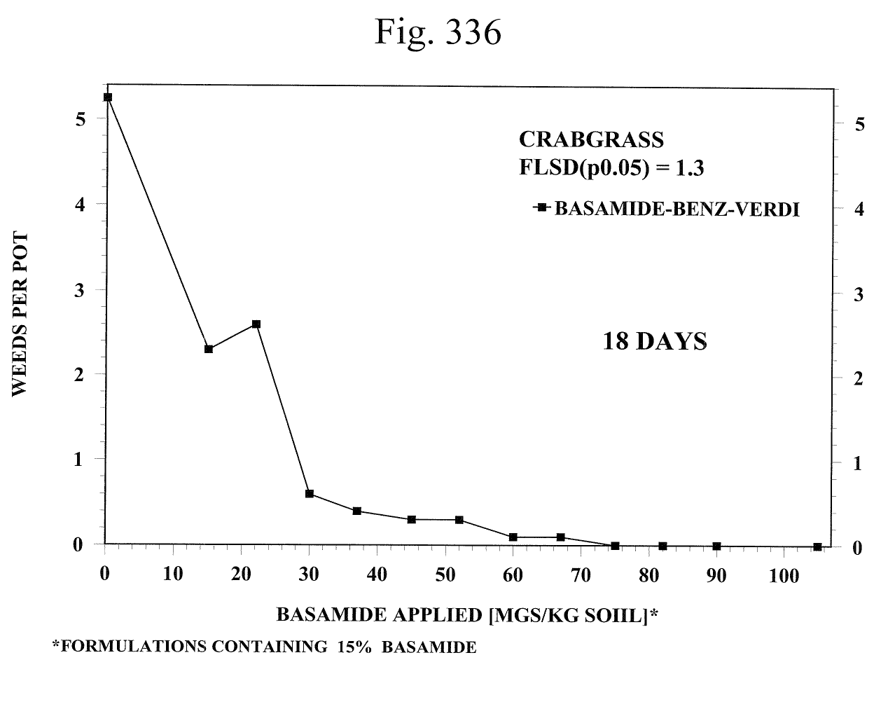

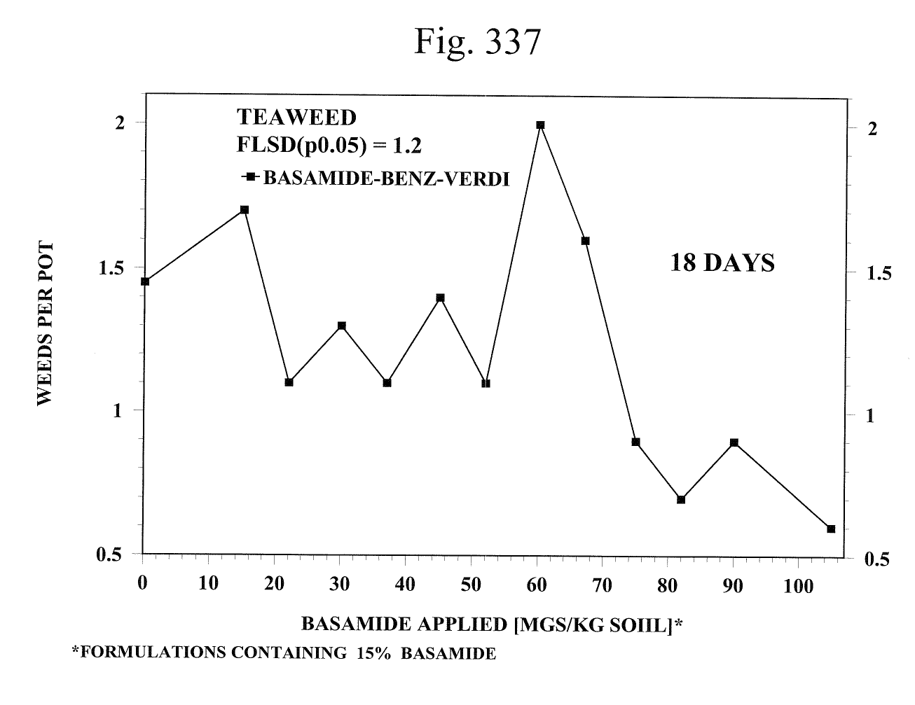

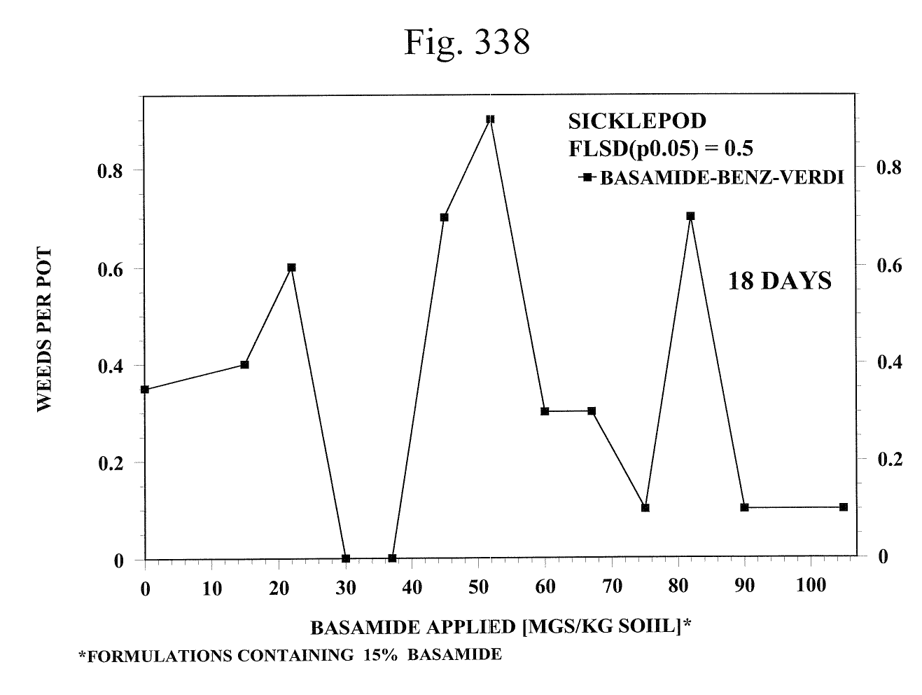

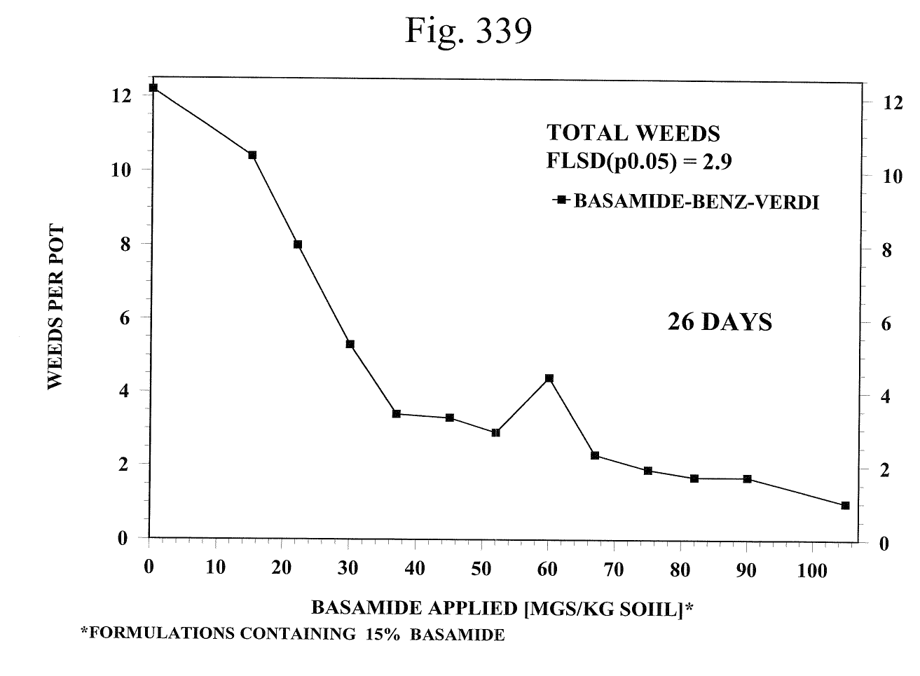

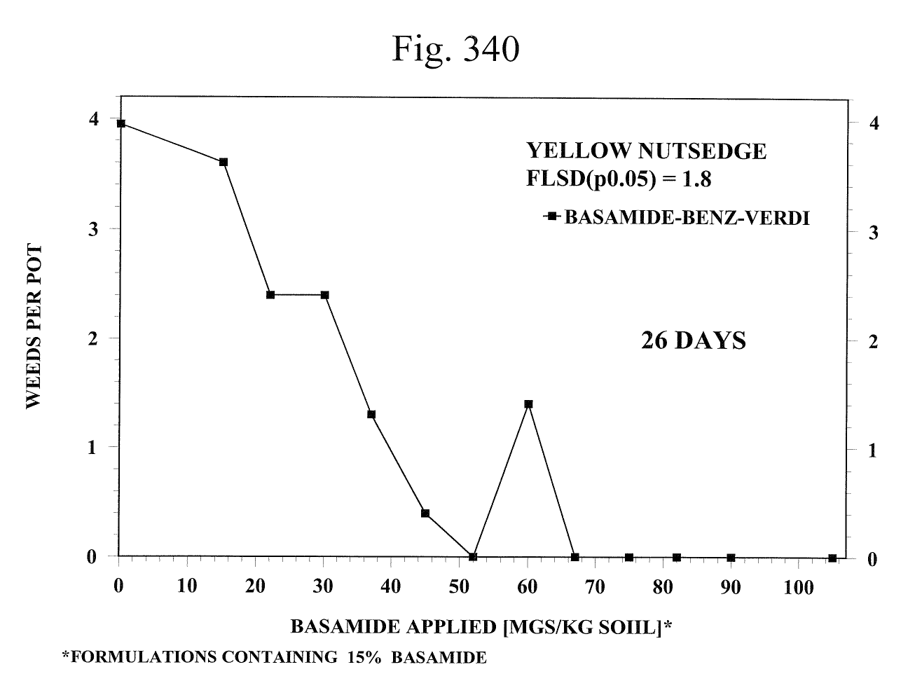

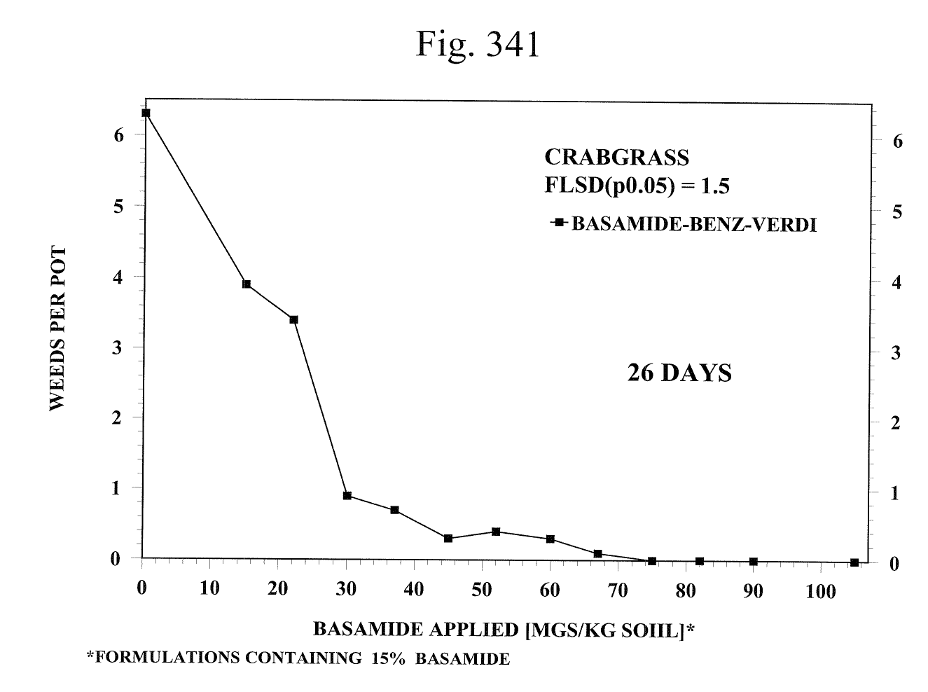

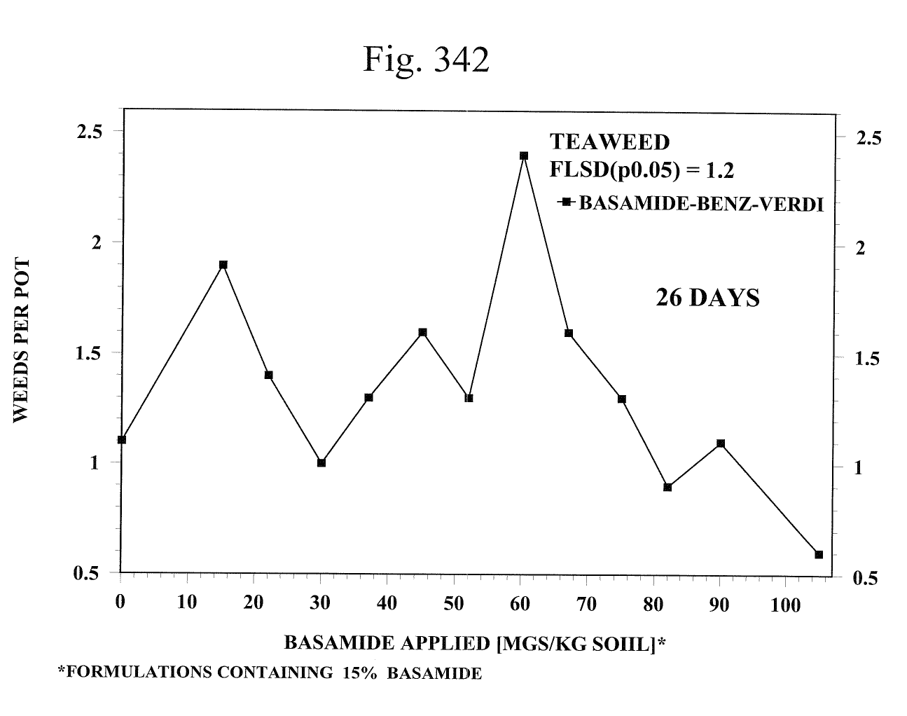

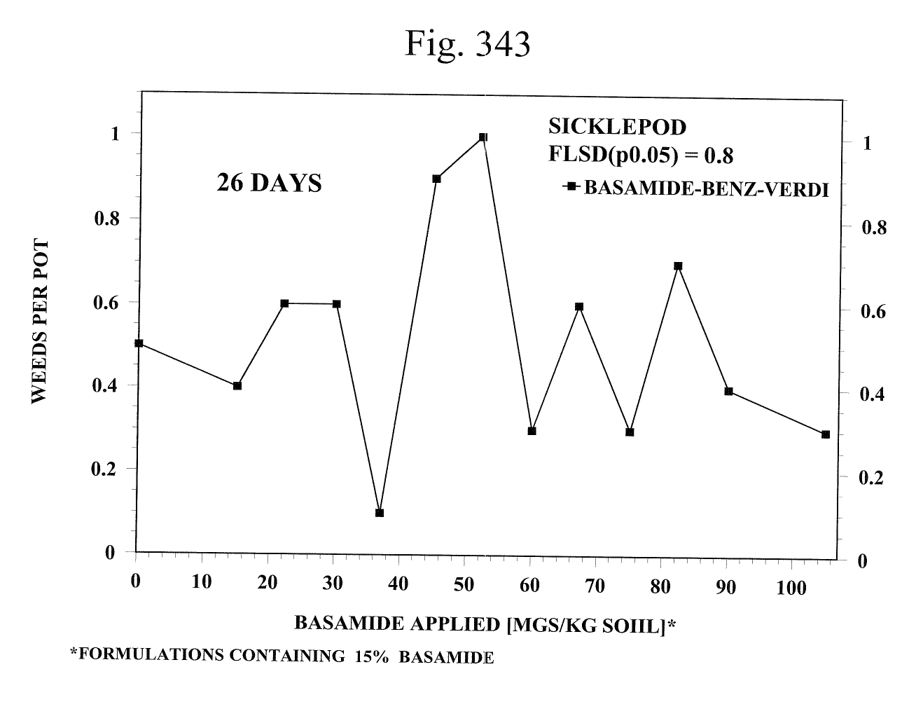

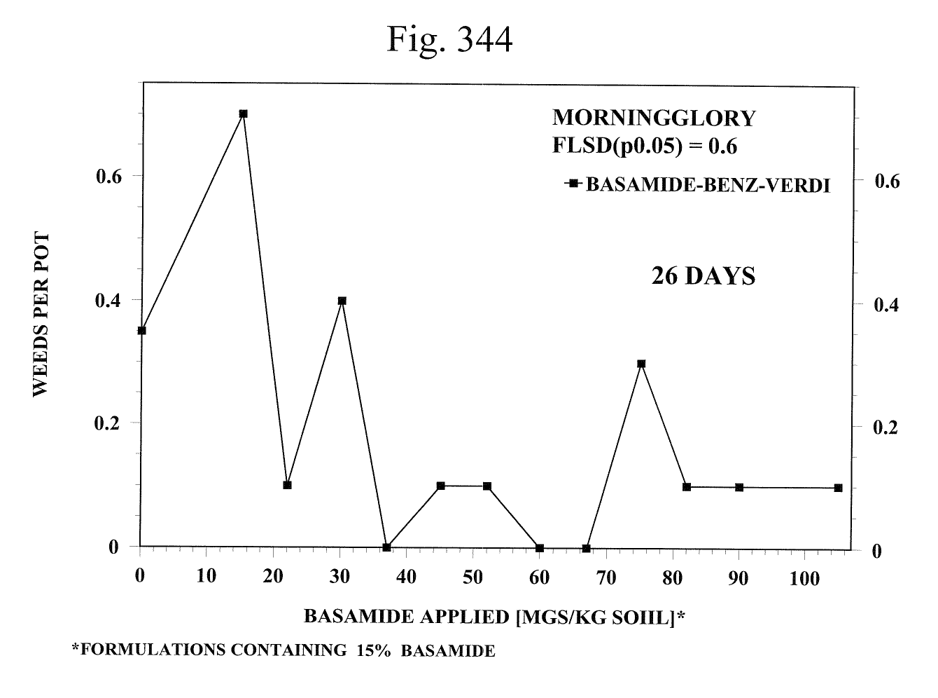

The standard weed seed pack comprised seeds of yellow nutsedge, crabgrass, teaweed, sicklepod, and morning glory. The number of total weeds and individual weeds was determined after eleven (11) days (FIGS. 329-333), eighteen (18) days (FIGS. 334-338), and twenty-six (26) days (FIGS. 339-344).

Weed Test 199

A stock dazomet formulation was prepared by adding 30 g dazomet to 130 mls of warm (40° C.) benzaldehyde with stirring. Next. 10 mls Polysorb 80 emulsifier (Tween) was added followed by 30 mls of biodiesel. A working 1% emulsion was prepared by bringing the final volume of 35 mls of the stock formulation to 3.5 L with demineralized water.

Soil that was combined with sand (1:1) to prepare a soil mixture for testing. One kilogram of the soil mixture was added to seven (7) pots for each test mixture. Testing was performed by adding a standard weed seed pack to the soil and drenching the soil with 100 mls of test compositions as indicated in Table 21.

TABLE 21

| | Dazomet | |
|---|---|---|
| | (mls 0.15% | Dazomet |
| Test | emulsion/kg soil) | (mg/kg soil) |
| Control | | |
| Dazomet + | 5 | 7.5 |
| Biodiesel | | |
| “” | 10 | 15 |
| “” | 15 | 22.5 |
| “” | 20 | 30 |
| “” | 25 | 37.5 |
| “” | 30 | 45 |
| “” | 35 | 52.5 |
| “” | 40 | 60 |
| “” | 45 | 67.5 |
| “” | 50 | 75 |
| “” | 55 | 82.5 |
| “” | 60 | 90 |
| Control | | |

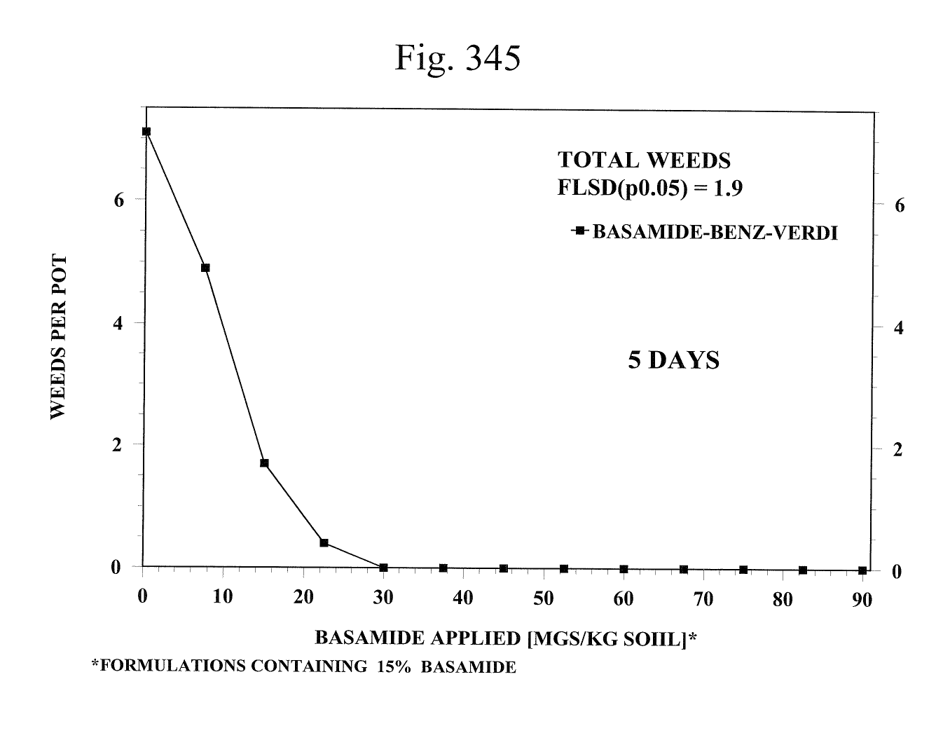

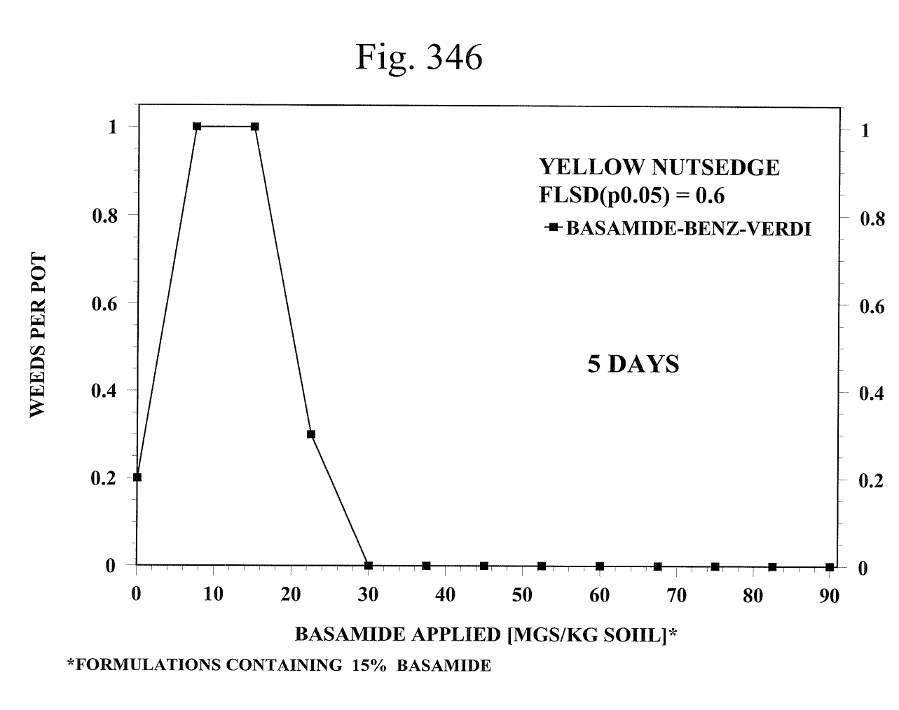

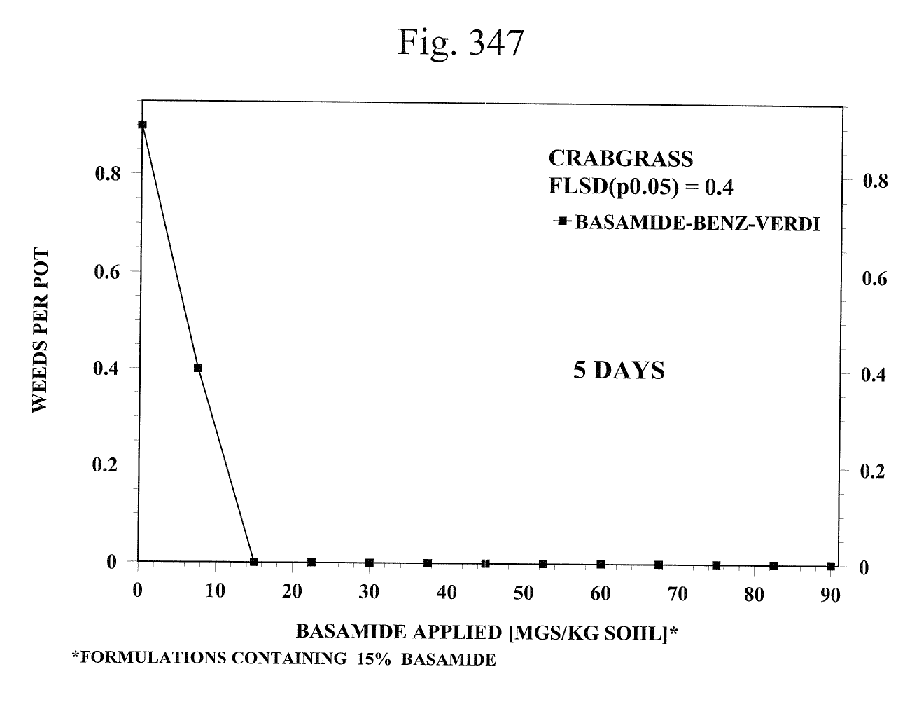

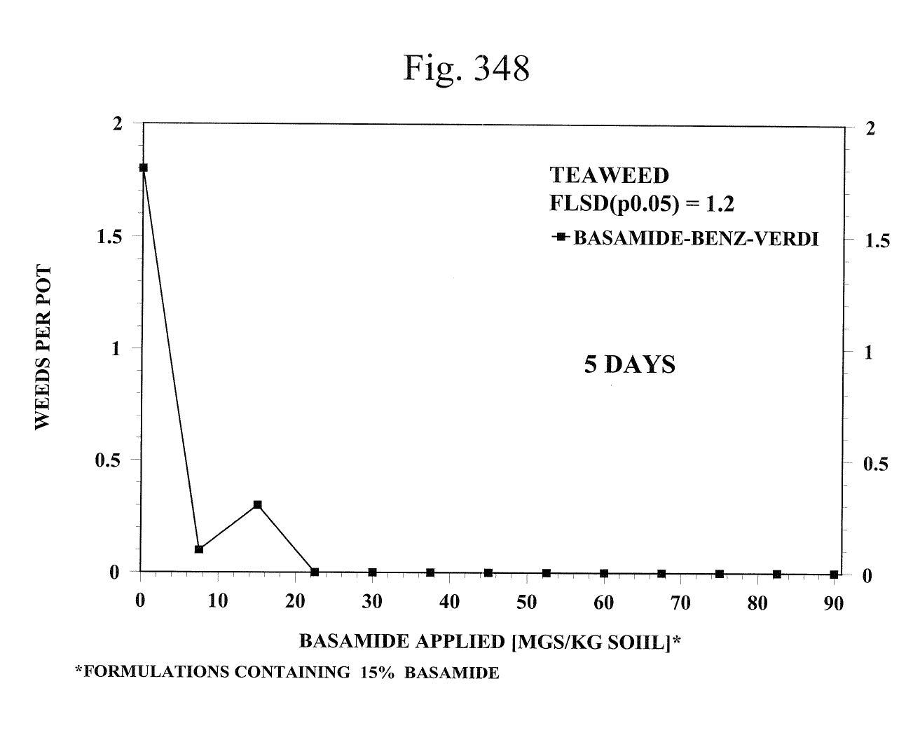

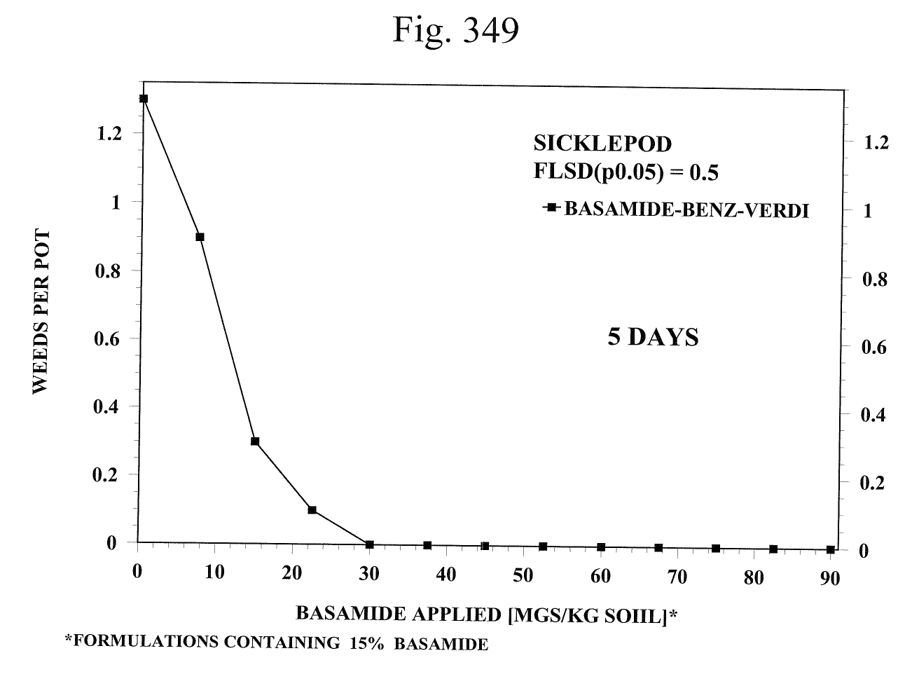

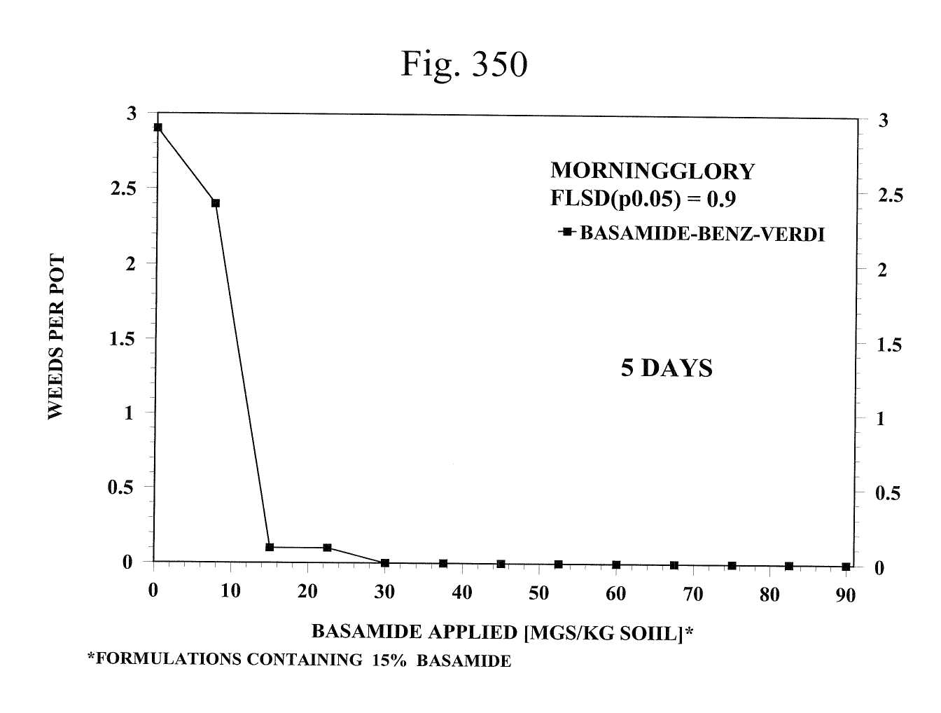

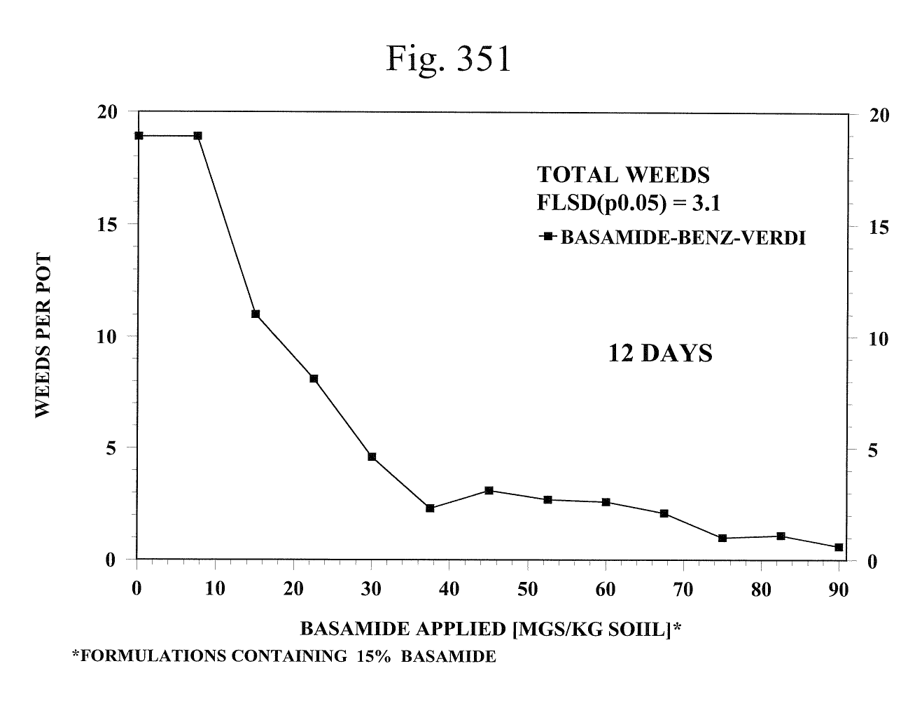

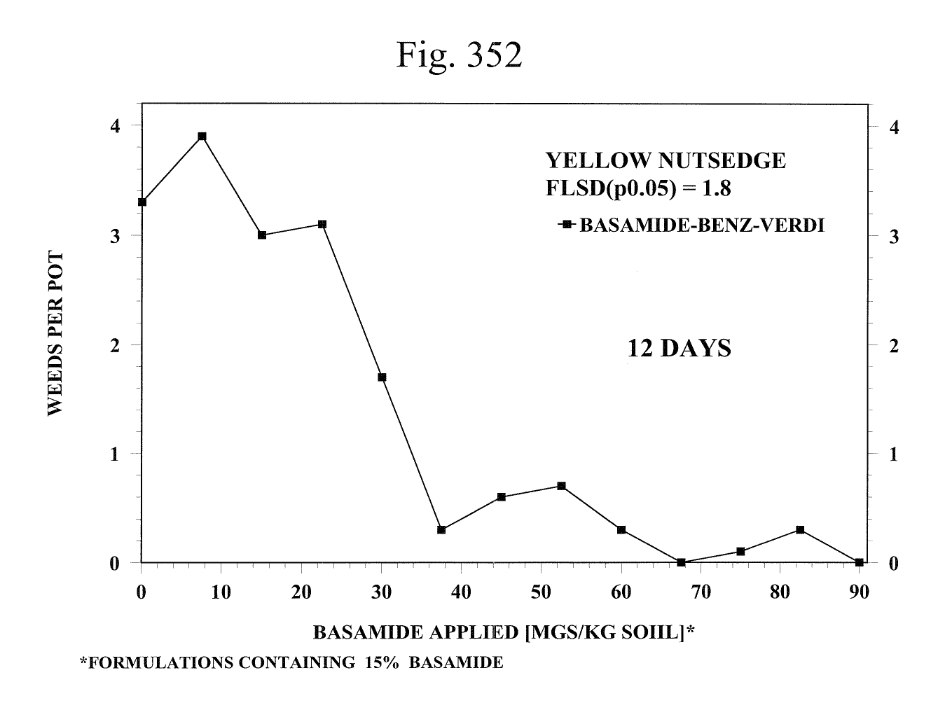

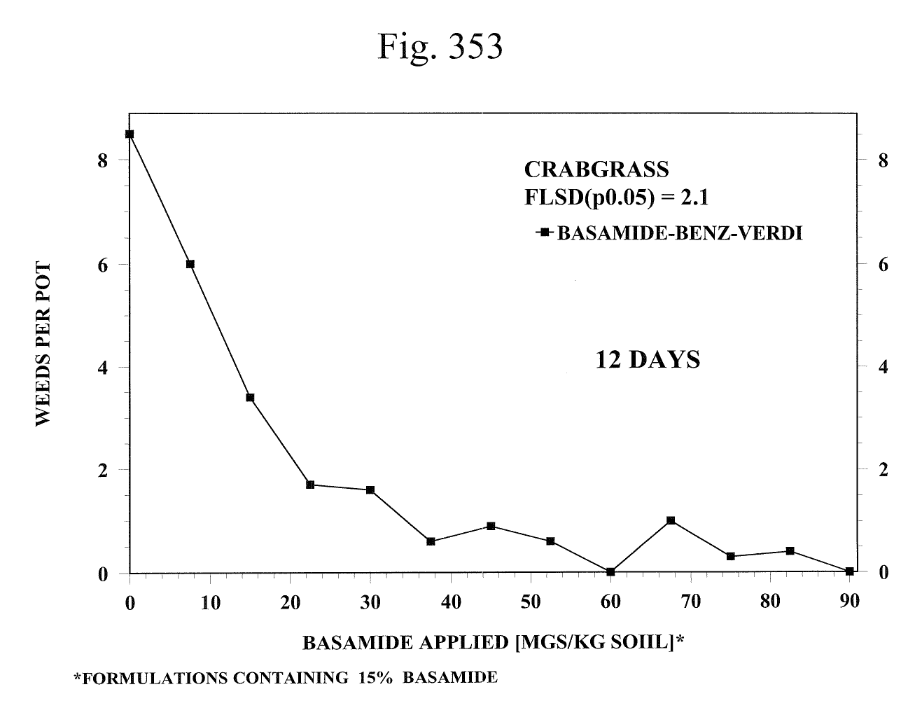

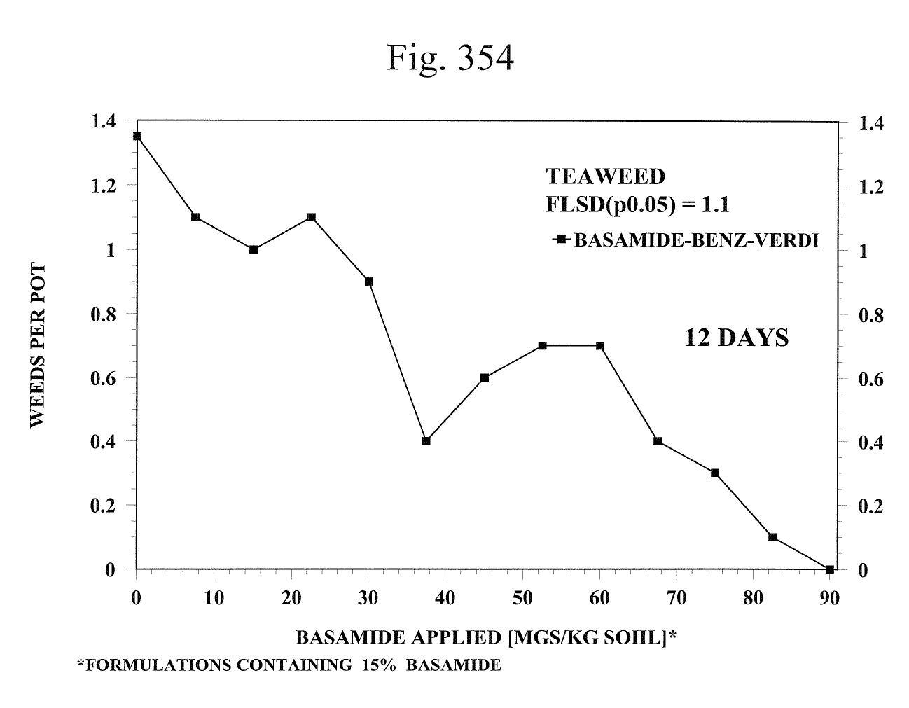

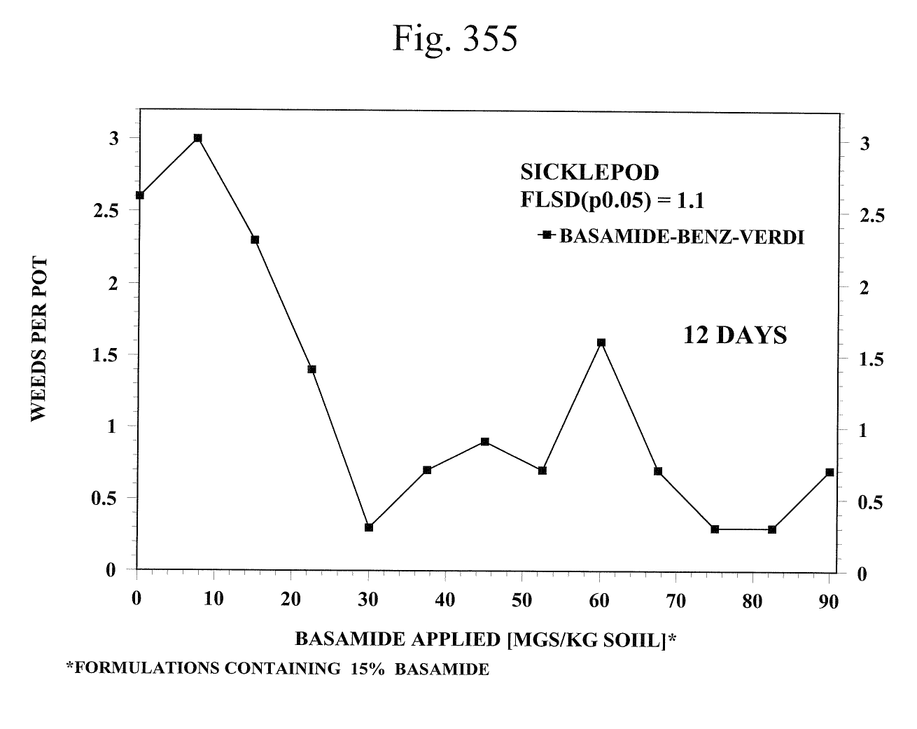

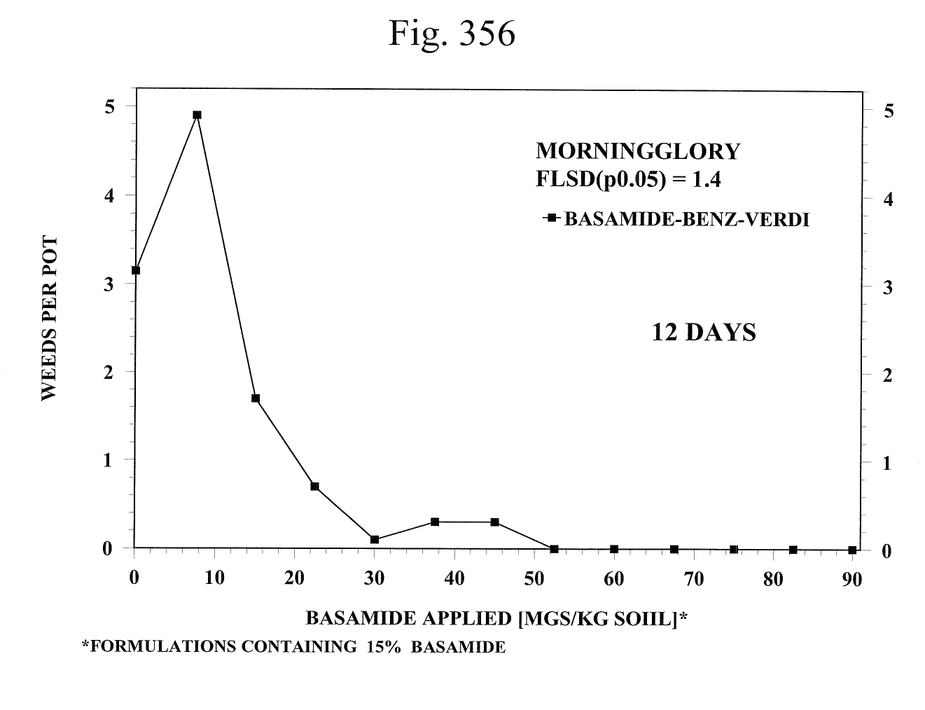

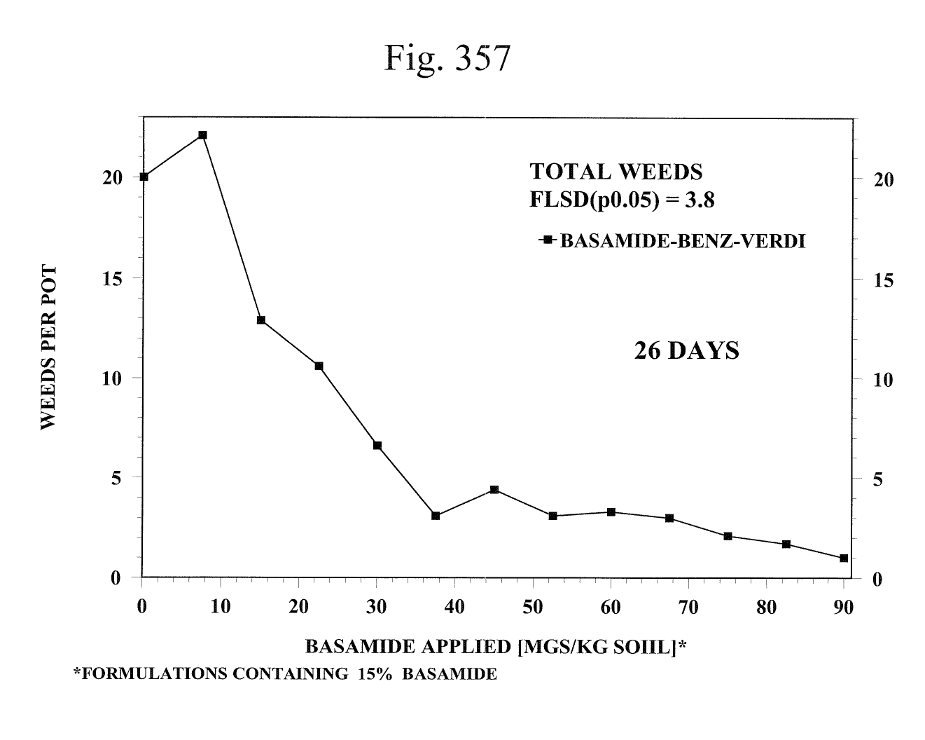

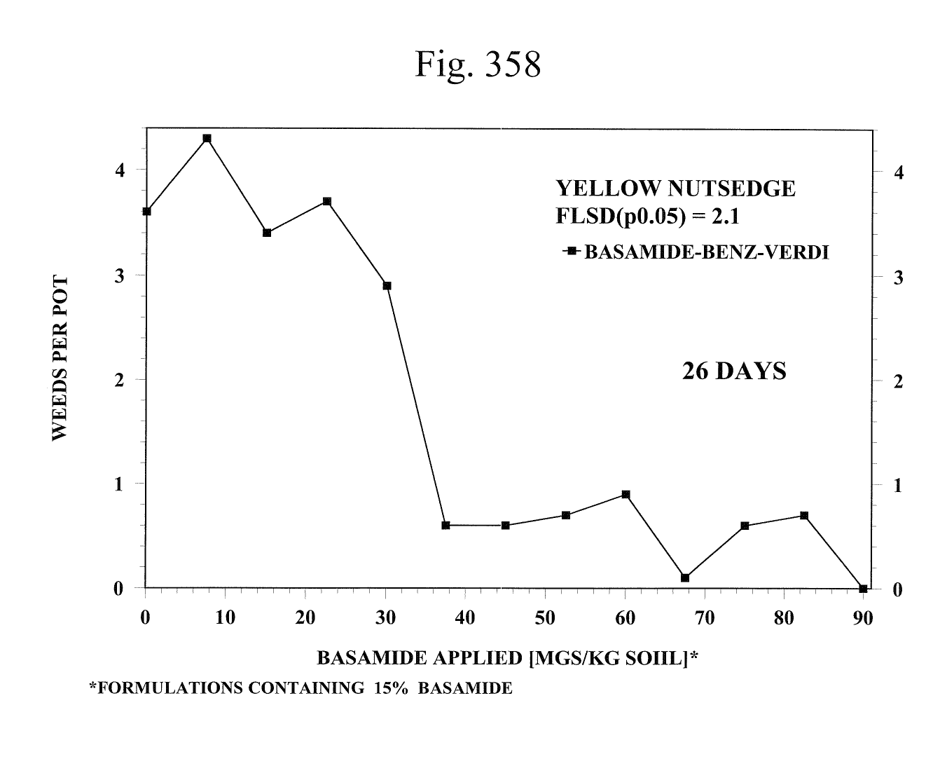

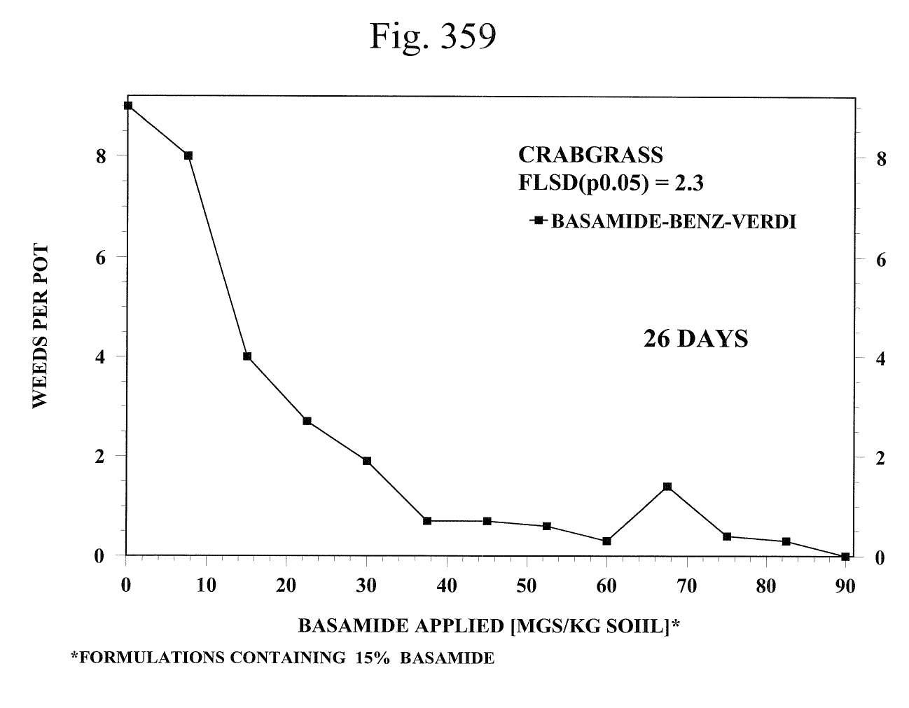

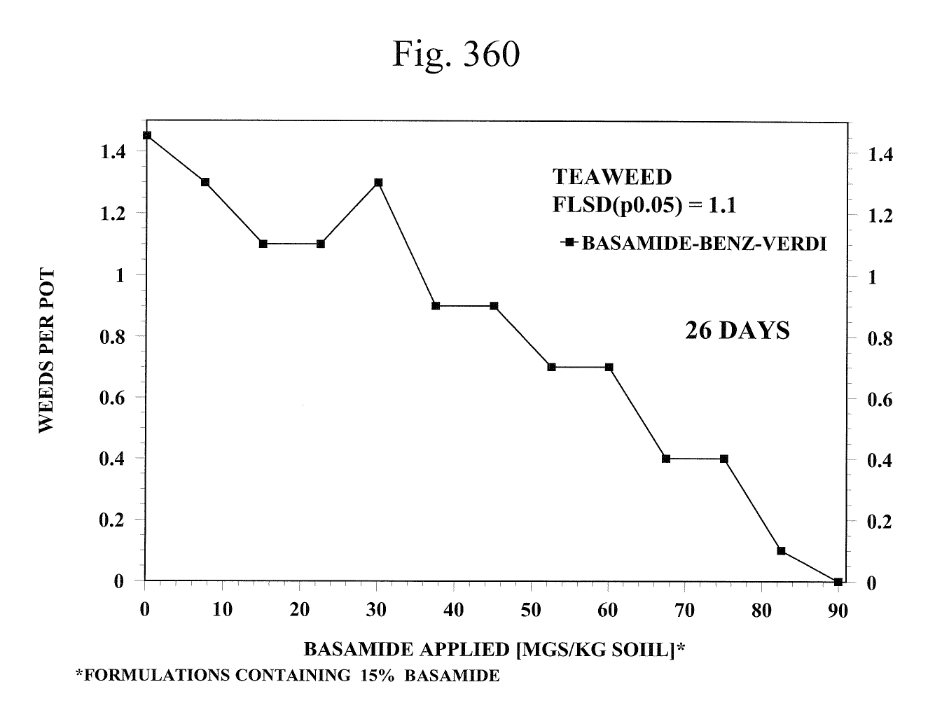

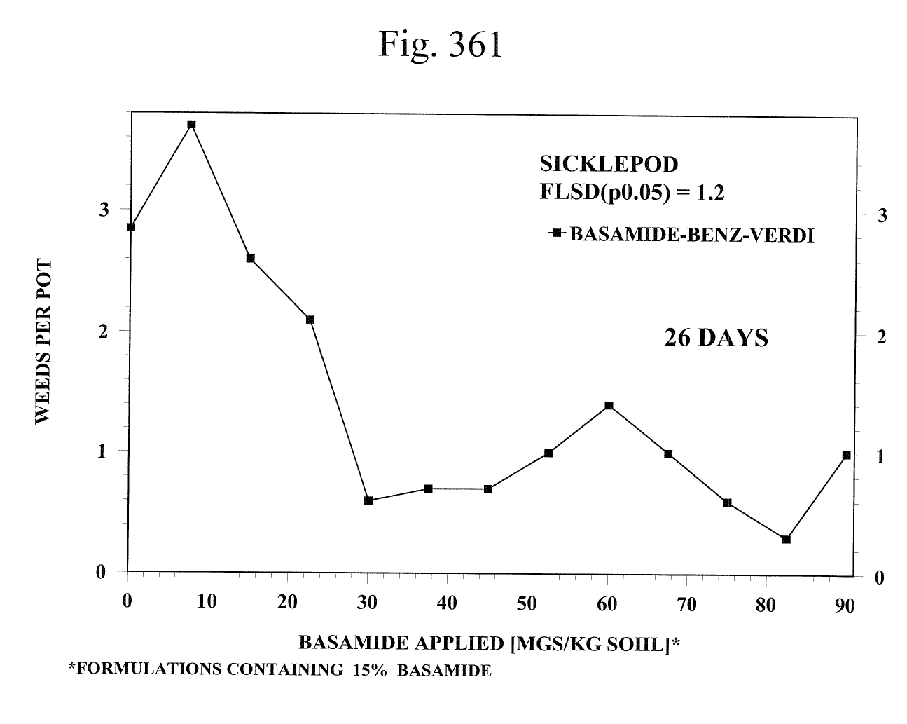

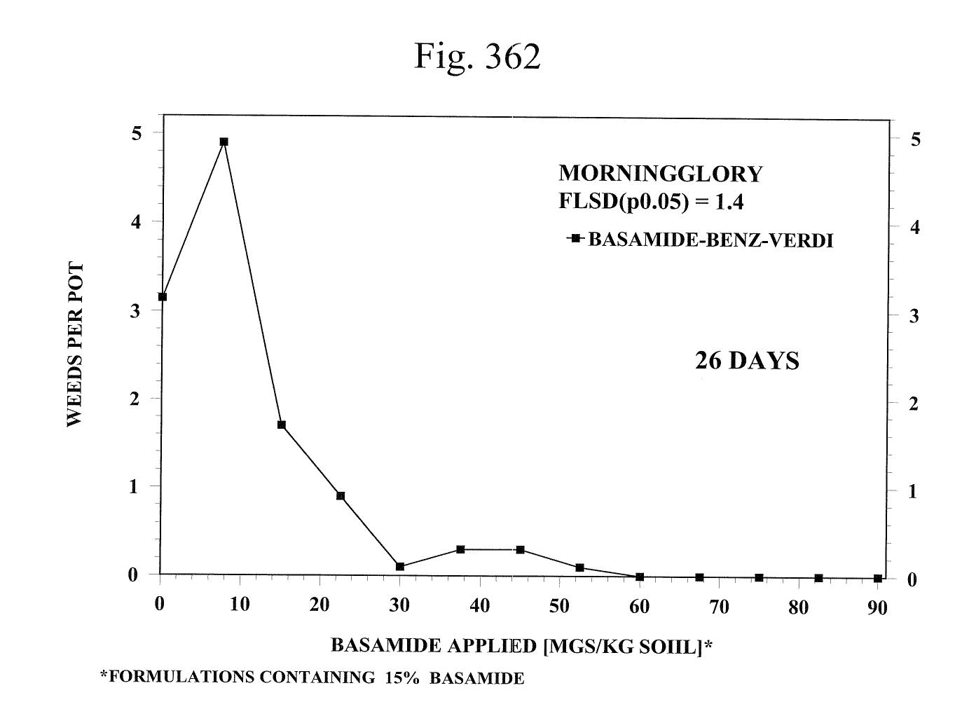

The standard weed seed pack comprising seeds of yellow nutsedge, crabgrass, teaweed, sicklepod, and morning glory. The number of total weeds and individual weeds was determined after five (5) days (FIGS. 345-350), twelve (12) days (FIGS. 351-356), and twenty-six (26) days (FIGS. 357-362).

Weed Test 200

A stock menthol formulation was prepared by adding 20 g menthol (Aldrich Chem. Co.) to 80 mls of benzaldehyde with stirring. Next, 10 mls Polysorb 80 emulsifier (Tween) was added followed by 90 mls of biodiesel. A working 3% emulsion was prepared by bringing the final volume of 90 g of the stock formulation to 3 L with demineralized water.

Soil that was combined with sand (1:1) to prepare a soil mixture for testing. One kilogram of the soil mixture was added to seven (7) pots for each test mixture. Testing was performed by adding a standard weed seed pack to the soil and drenching the soil with 100 mls of test compositions as indicated in Table 22.

TABLE 22

| | Menthol | |
|---|---|---|
| | (mls 3% emulsion/ | Menthol |
| Test | kg soil) | (mg/kg soil) |
| Control | | |
| Menthol + | 5 | 150 |
| Biodiesel | | |
| “” | 10 | 300 |
| “” | 15 | 450 |
| “” | 20 | 600 |
| “” | 25 | 750 |
| “” | 30 | 900 |
| “” | 35 | 1050 |
| “” | 40 | 1200 |
| “” | 45 | 1350 |
| “” | 50 | 1500 |
| “” | 55 | 1650 |
| “” | 60 | 1800 |
| Control | | |

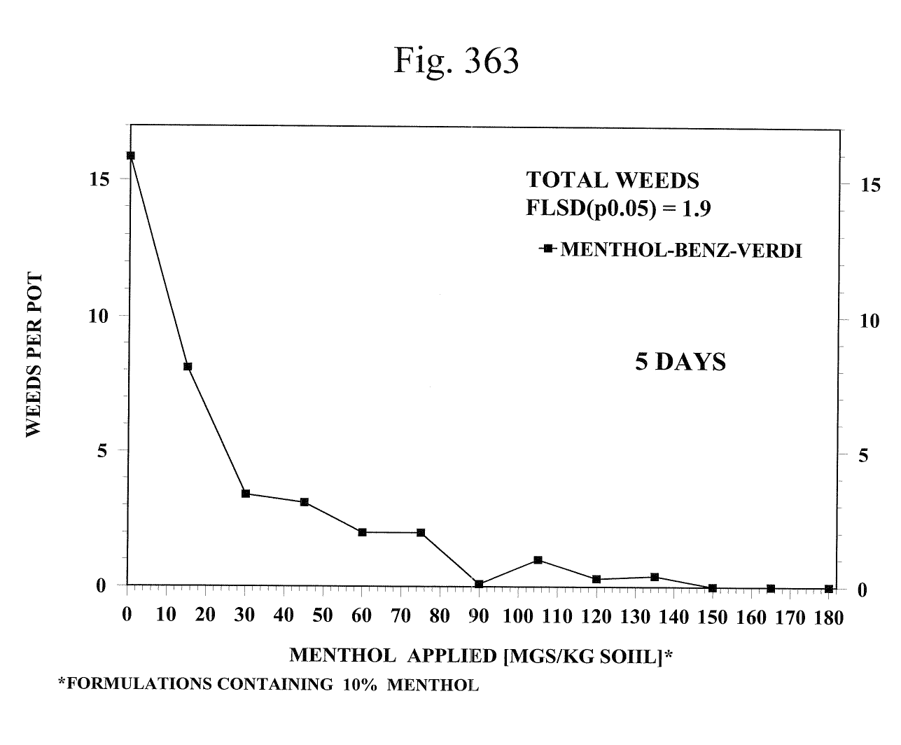

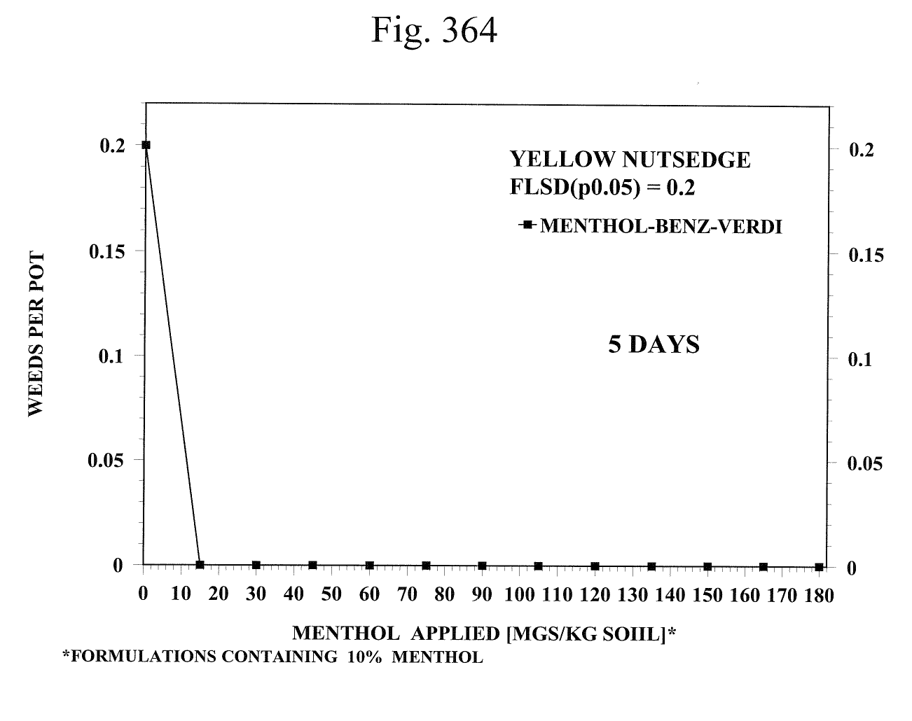

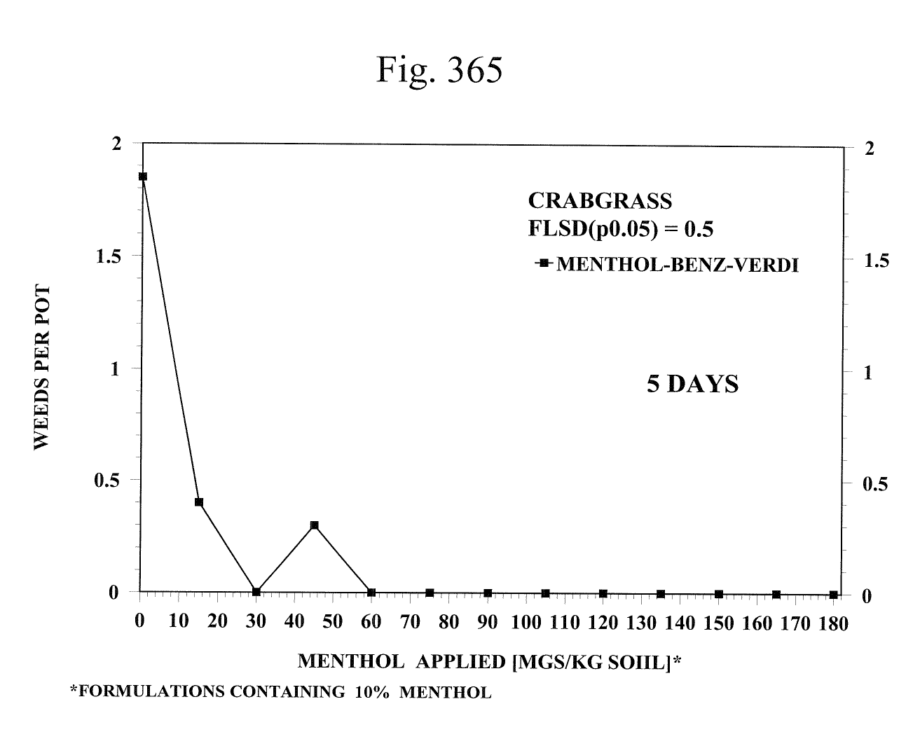

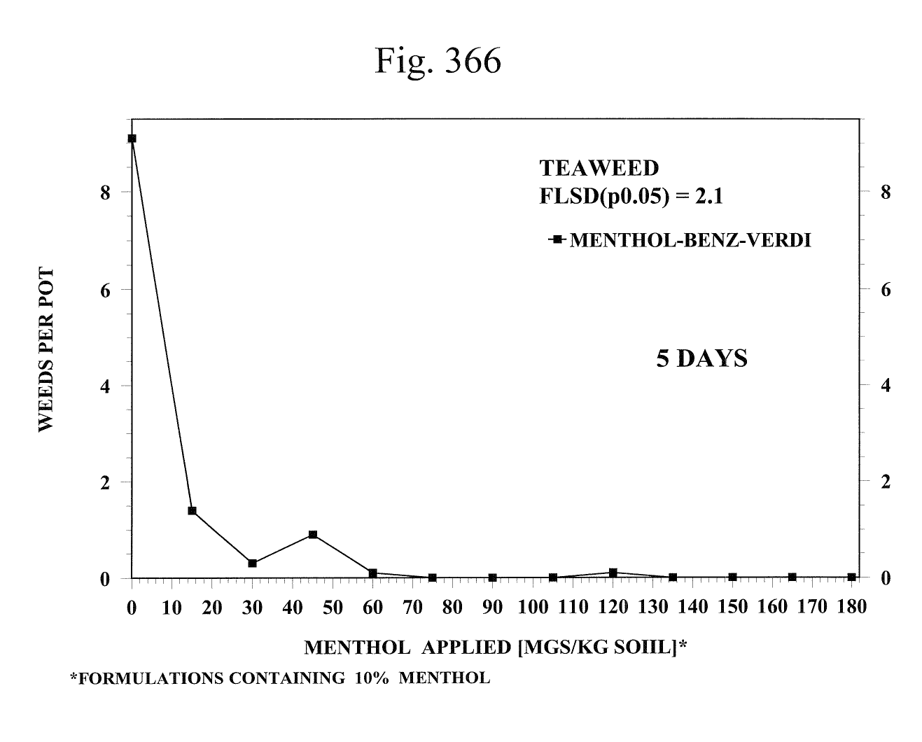

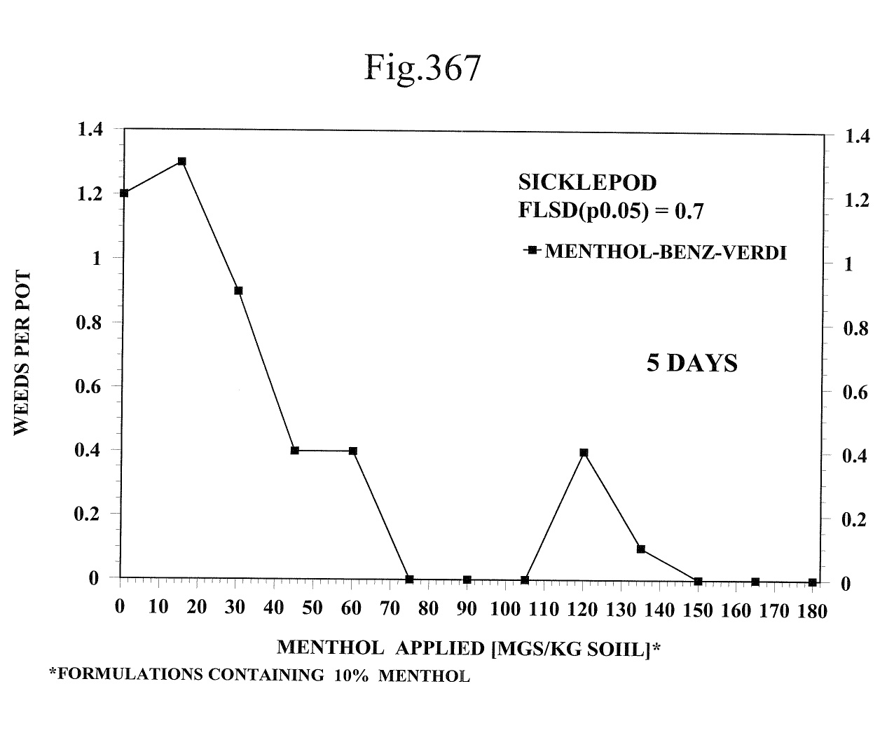

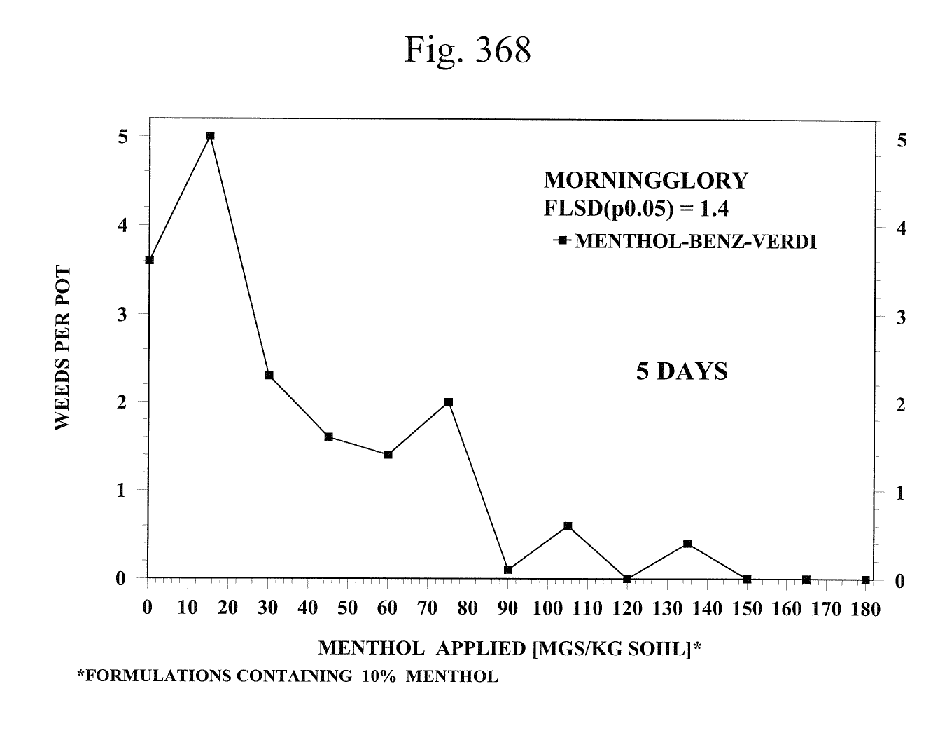

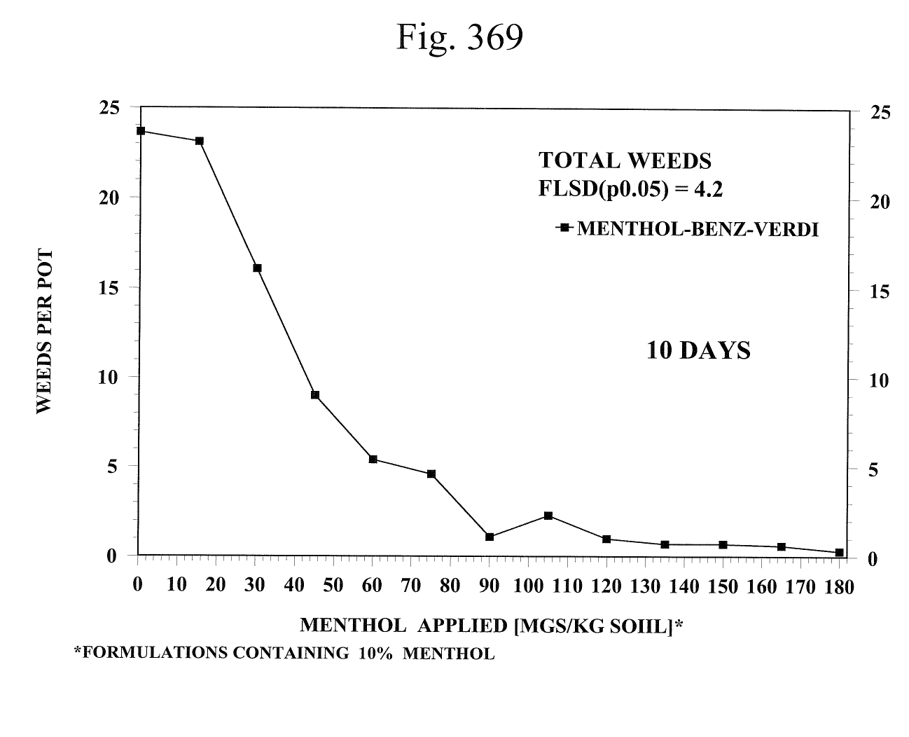

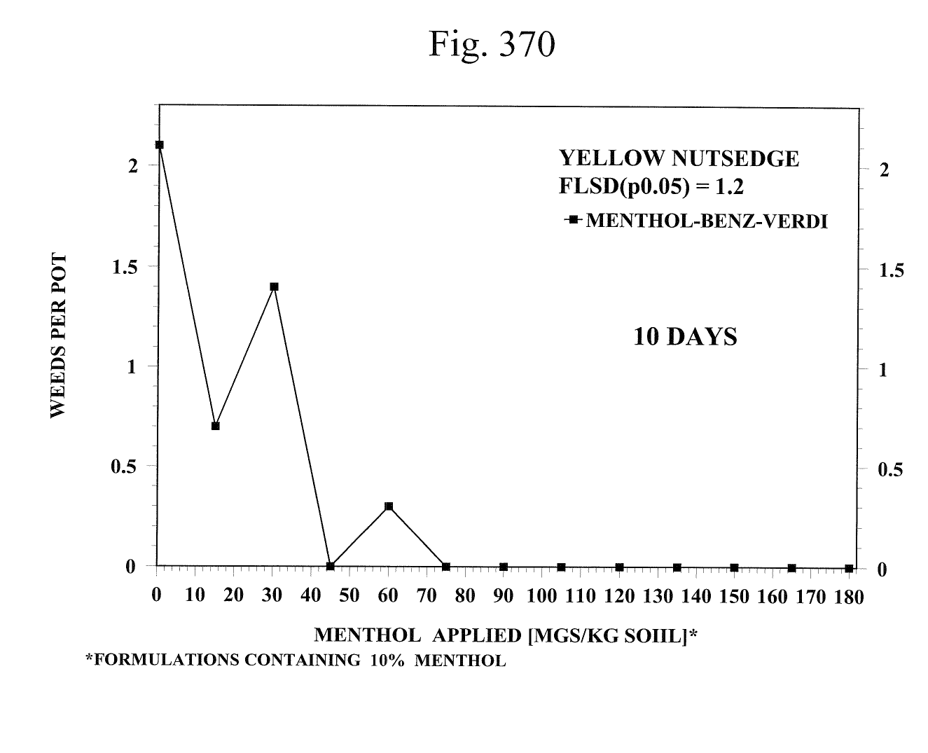

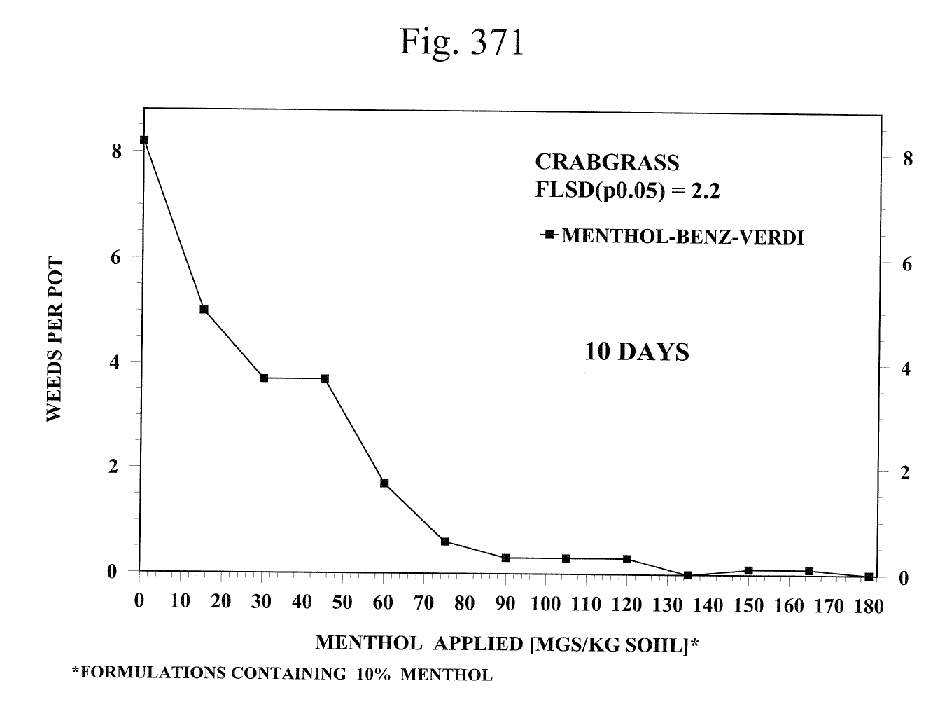

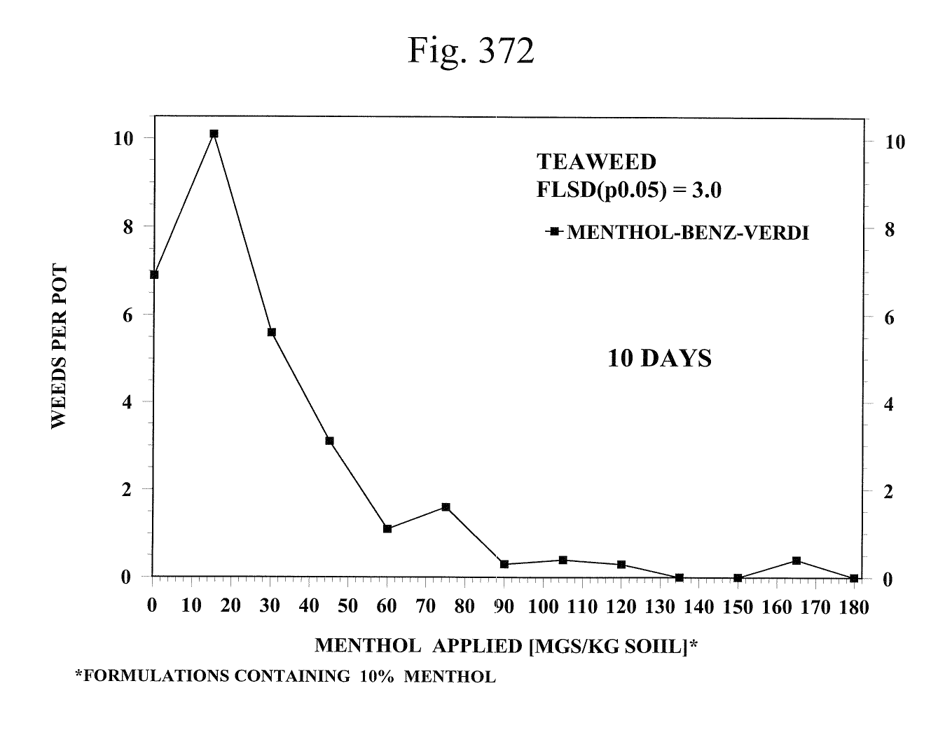

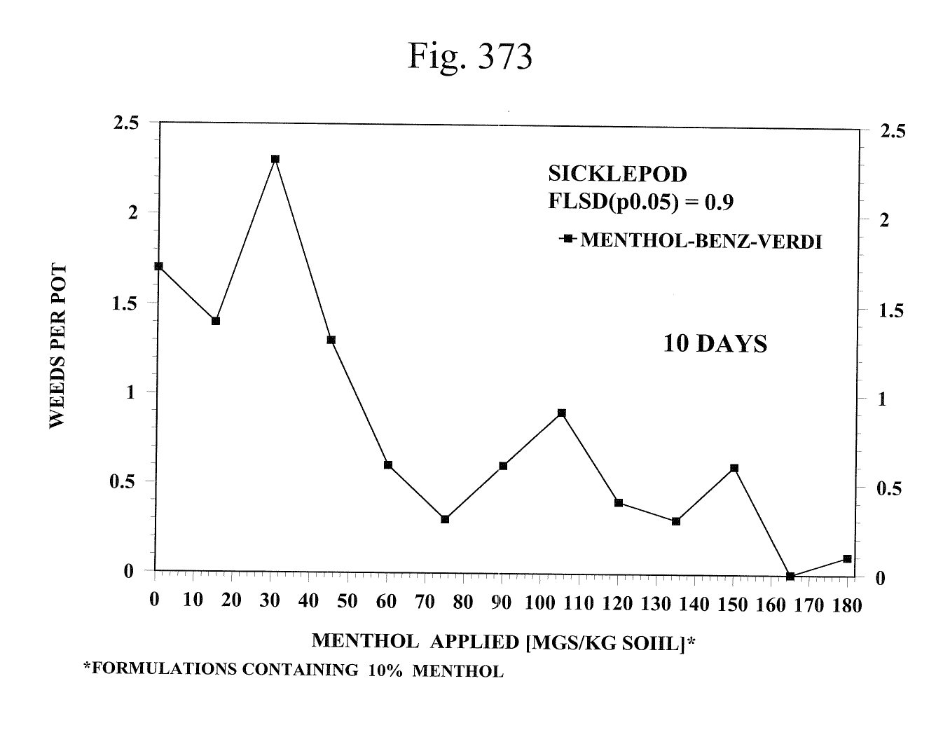

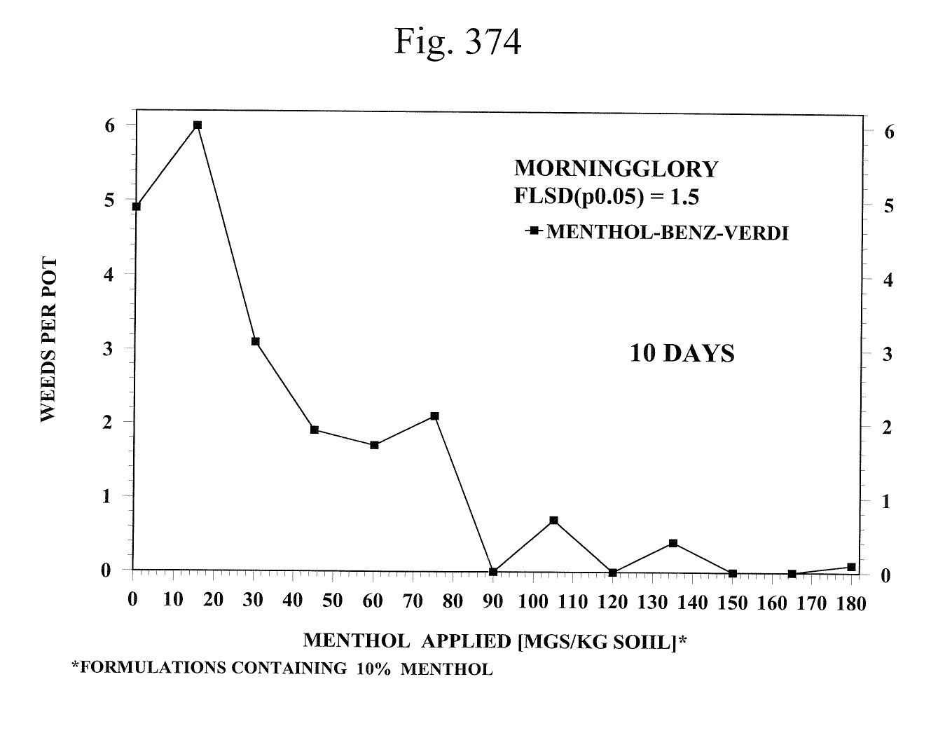

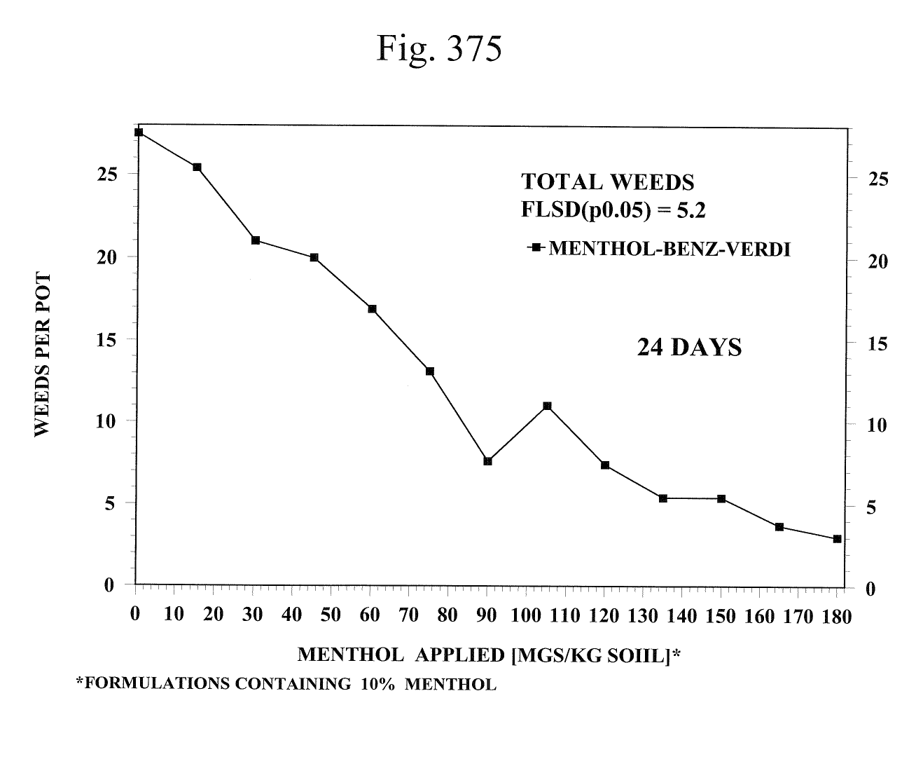

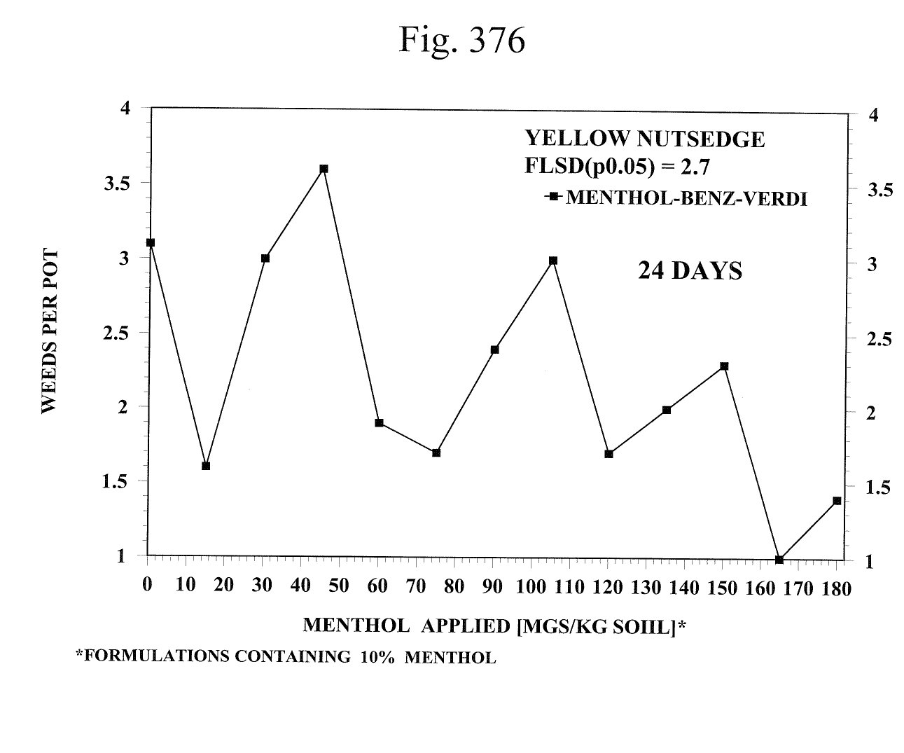

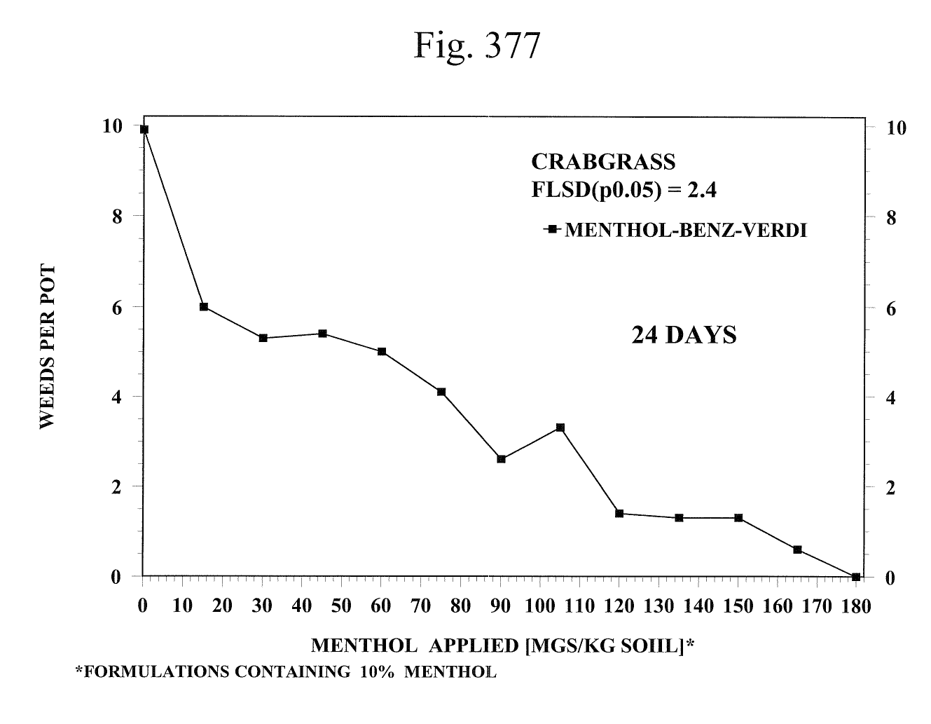

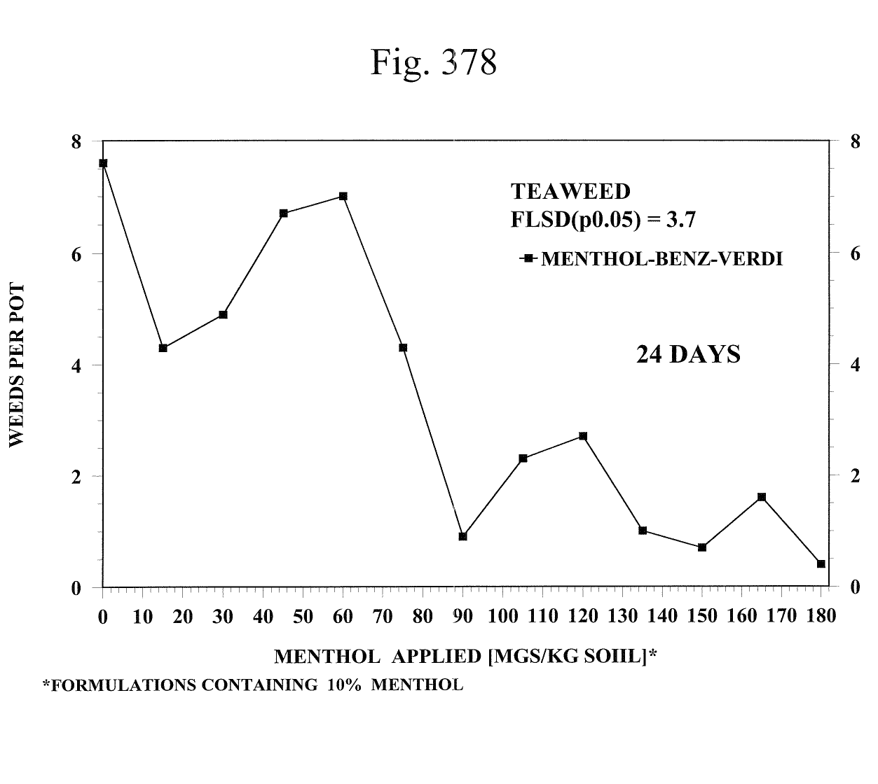

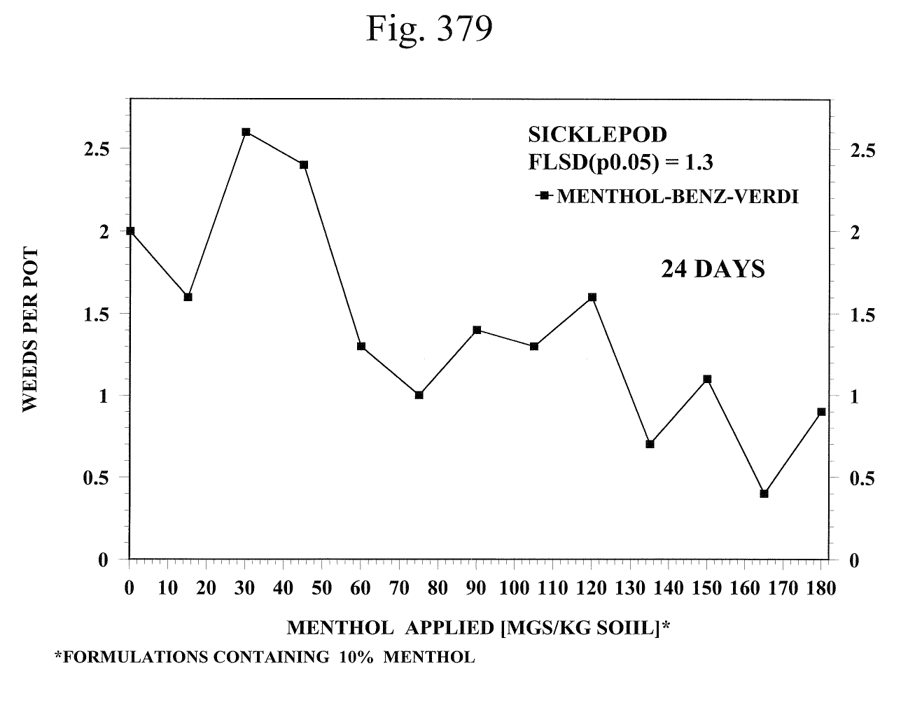

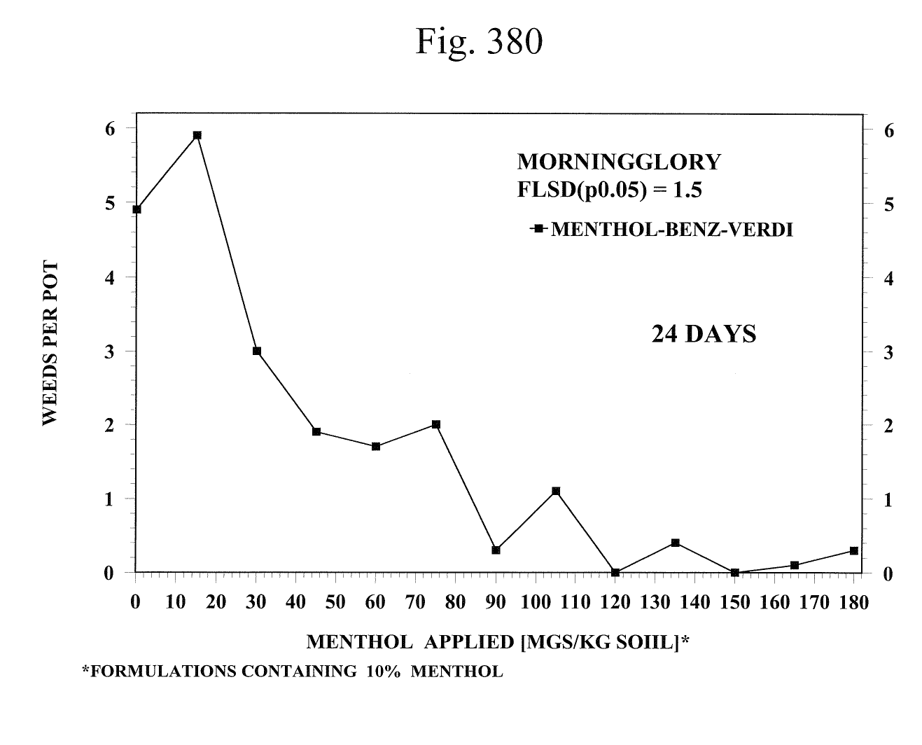

The standard weed seed pack comprised seeds of yellow nutsedge, crabgrass, teaweed, sicklepod, and morning glory. The number of total weeds and individual weeds was determined after five (5) days (FIGS. 363-368), ten (10) days (FIGS. 369-374), and twenty-four (24) days (FIGS. 375-380).

Weed Test 201

Stripped bioglycerin was prepared as described in U.S. published application number U.S. 2008-0214679, the content of which is incorporated herein by reference in its entirety. Bioglycerin, obtained from a biodiesel transesterification reaction, was neutralized with acid and stripped of volatiles by refluxing to obtain stripped bioglycerin. Sulfuric acid was added to the bioglycerin to reduce the pH to 0.6 to obtain a stripped bioglycerin-sulfuric acid. A 1% urea solution was prepared by adding 10 g urea to demineralized water, final volume 1 L.

A 10% stripped bioglycerin solution (v/v) was prepared by adding 155.50 g of stripped bioglycerin-sulfuric acid to demineralized water, final volume 1 L. A 10% stripped bioglycerin/1% urea solution to demineralized water, final volume 1 L.

Stripped bioglycerin-sulfuric acid contains 0.39052 mg Carbon/g bioglycerin. Urea contains 46.7% Nitrogen. From this the C:N ratio of the bioglycerin/urea solution (disregarding the Carbon contribution from urea) is 60.726/4.67=13.

Soil that was combined with sand (1:1) to prepare a soil mixture for testing. One kilogram of the soil mixture was added to seven (7) pots for each test mixture. Testing was performed by adding a standard weed seed pack to the soil and drenching the soil with 100 mls of test compositions as indicated in Table 23.

TABLE 23

| | Bioglycerin | Bioglycerin/Urea | Urea (mls 1%/ |
|---|---|---|---|
| Test | (mls 10%/kg soil) | (mls 10%/1%/kg soil) | kg soil) |
| Control | | | |
| Bioglycerin | 5 | 0 | 0 |
| w/o Urea | | | |
| “” | 10 | 0 | 0 |
| “” | 20 | 0 | 0 |
| “” | 30 | 0 | 0 |
| “” | 40 | 0 | 0 |
| Bioglycerin | 0 | 5 | 0 |
| w/ Urea | | | |
| “” | 0 | 10 | 0 |
| “” | 0 | 20 | 0 |
| “” | 0 | 30 | 0 |
| “” | 0 | 40 | 0 |
| Urea | 0 | 0 | 20 |
| Urea | 0 | 0 | 40 |
| Control | | | |

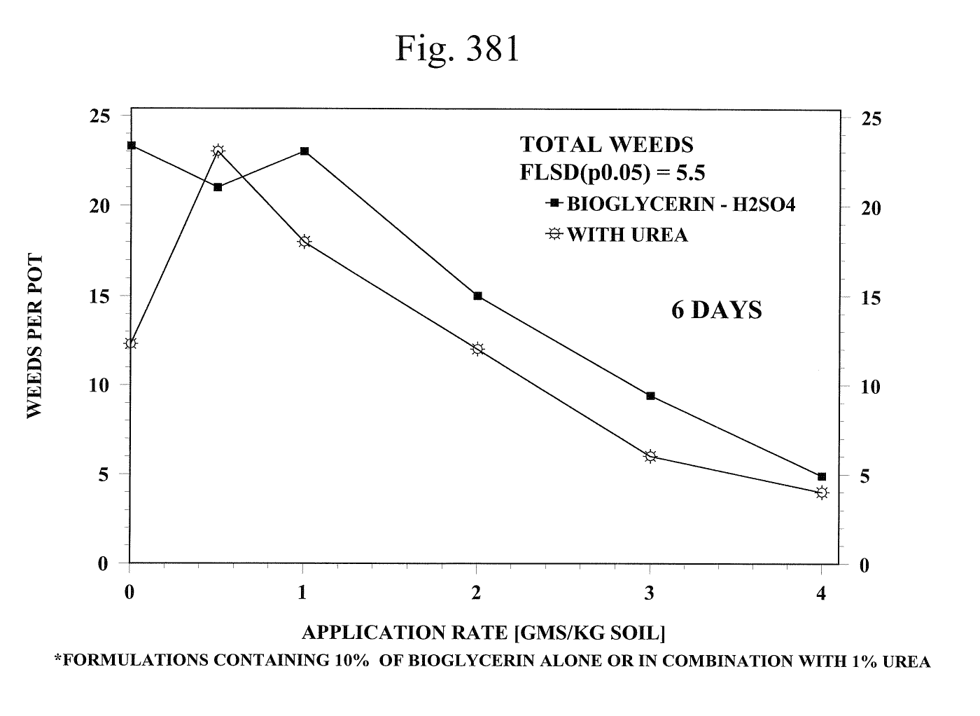

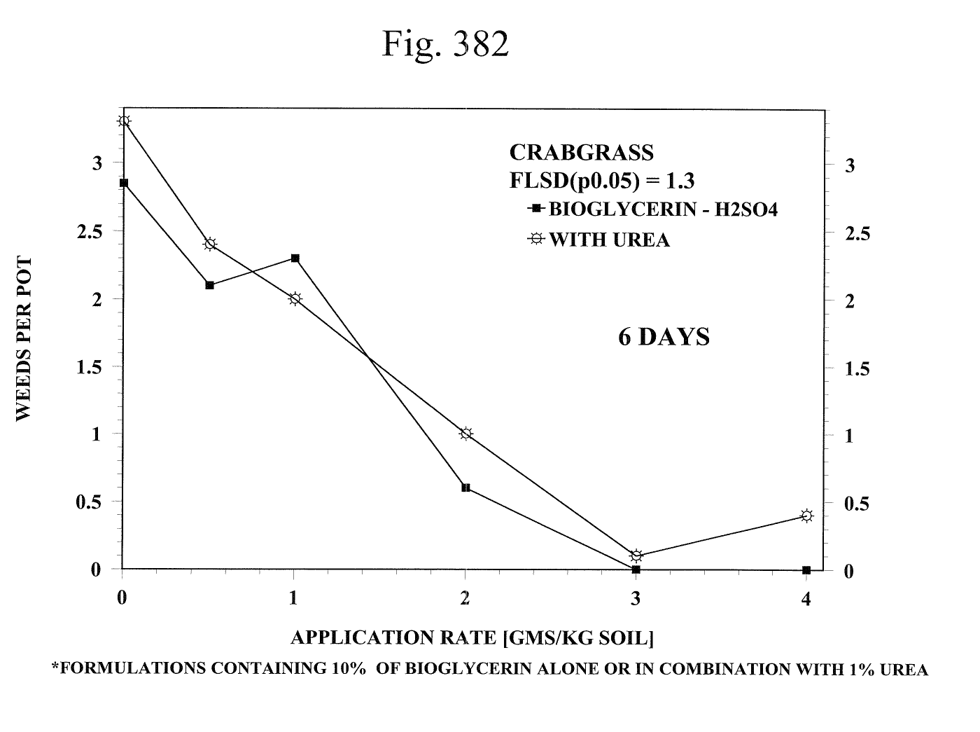

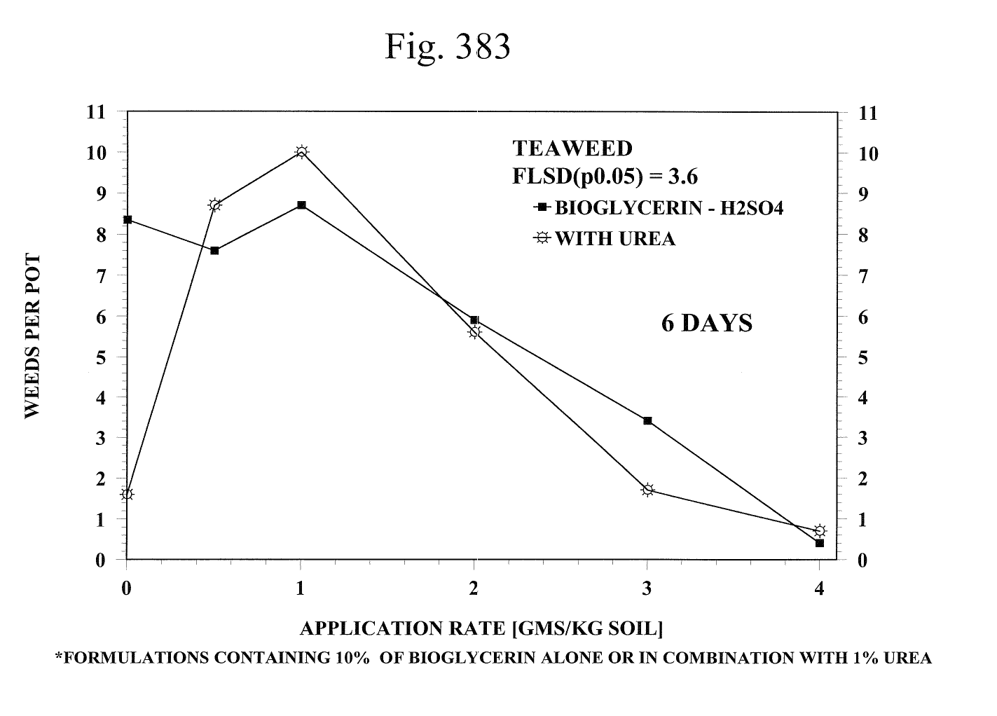

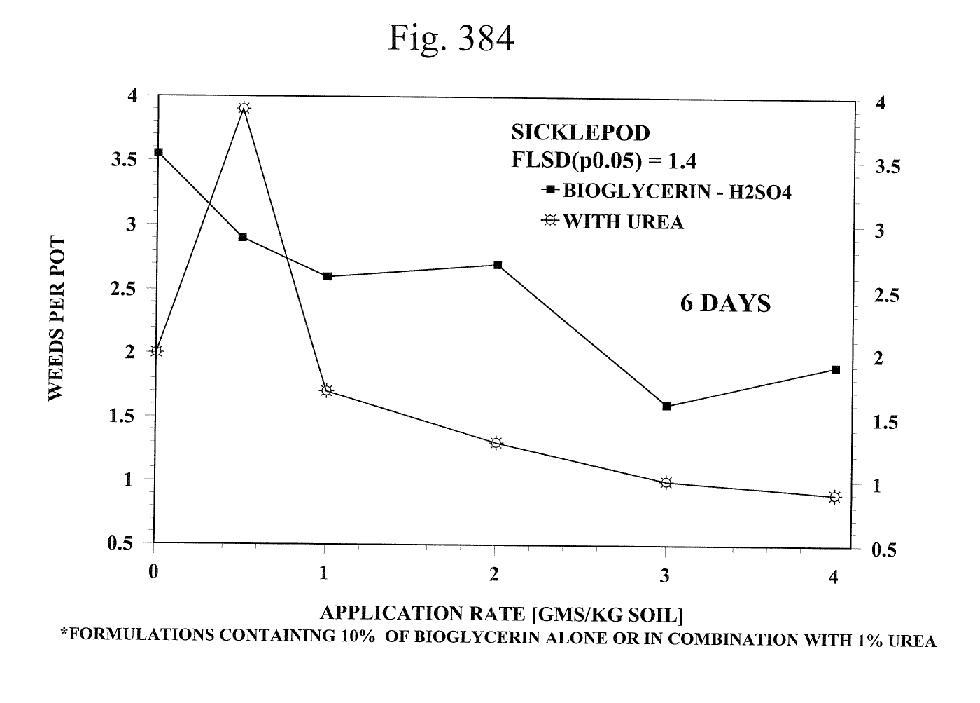

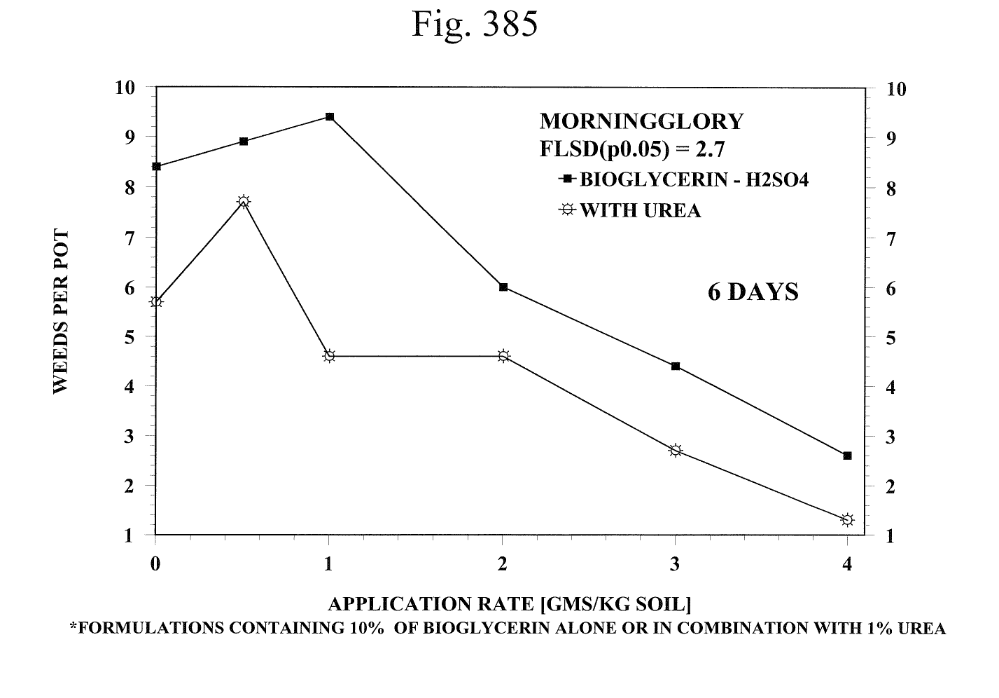

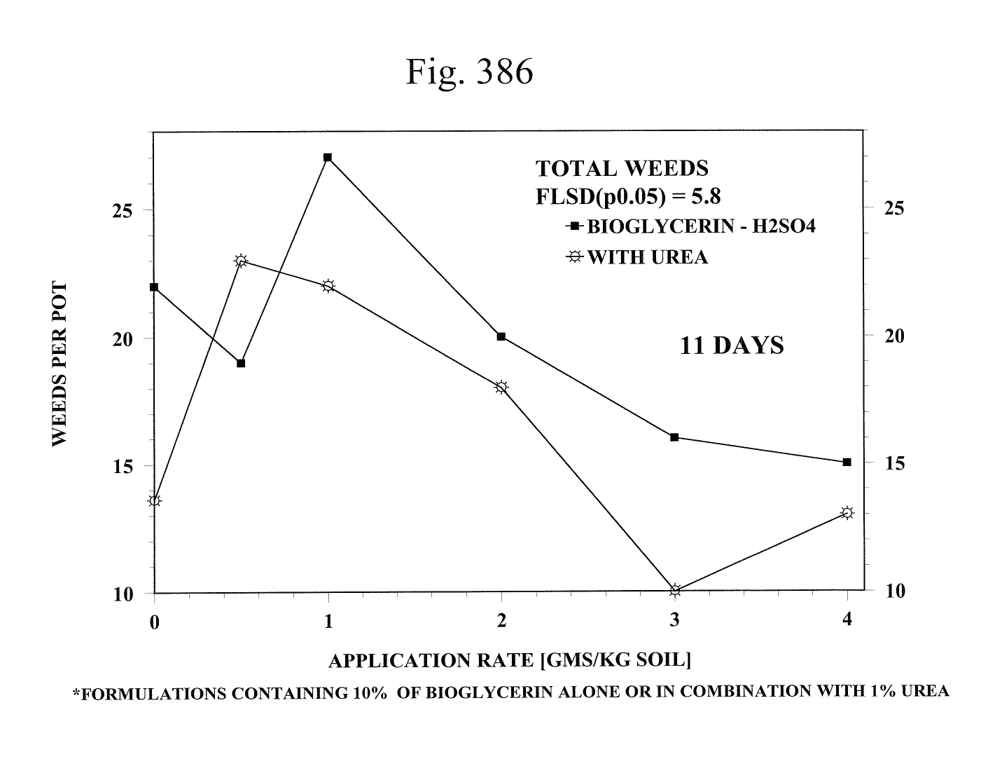

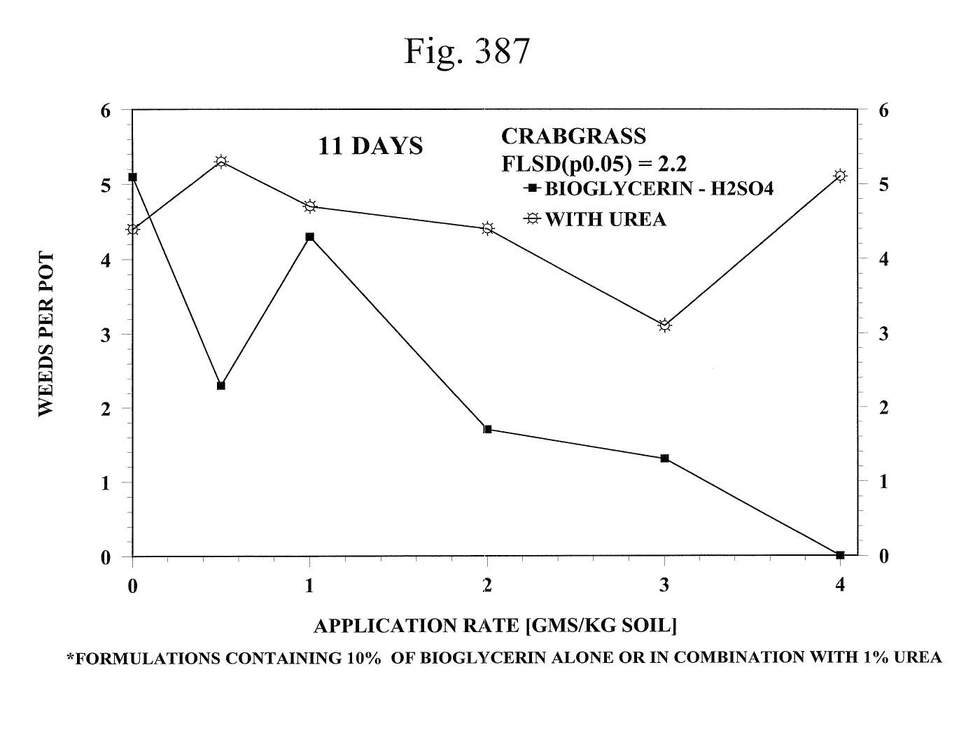

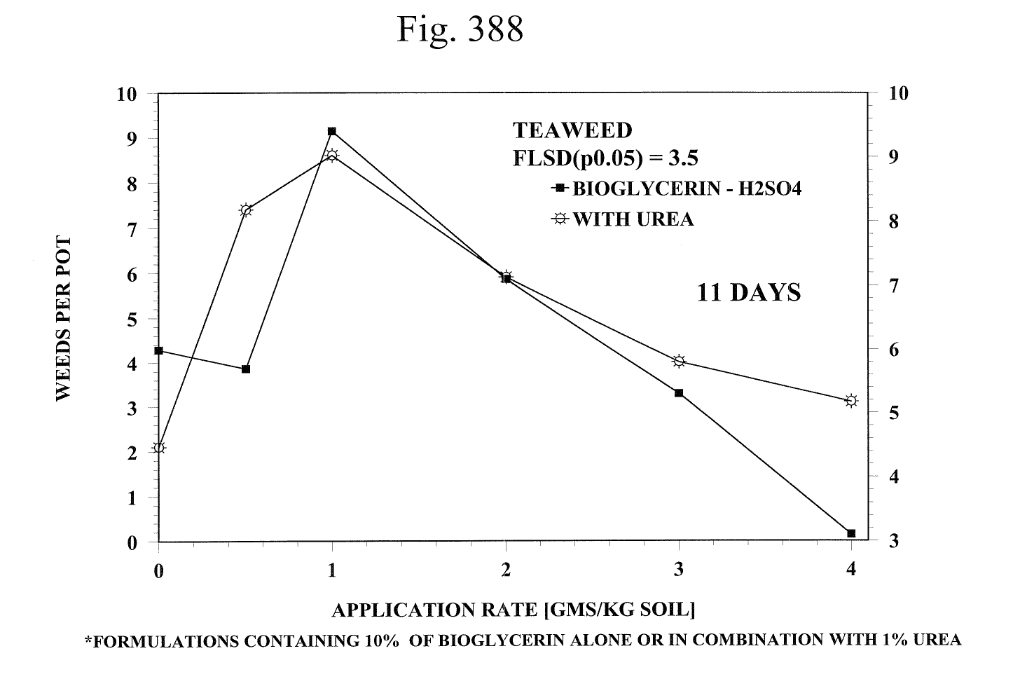

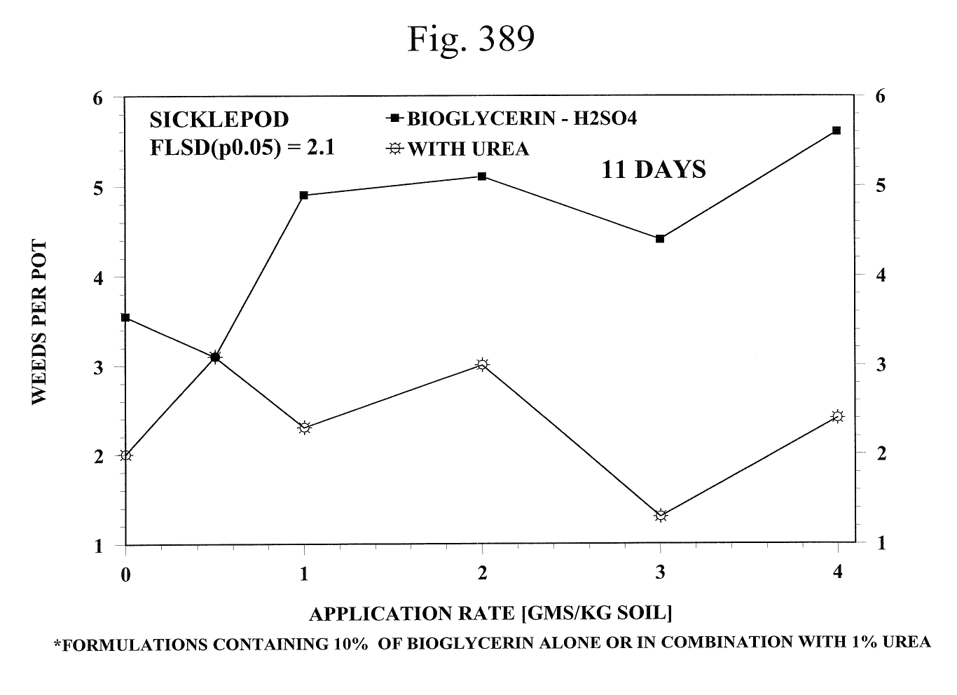

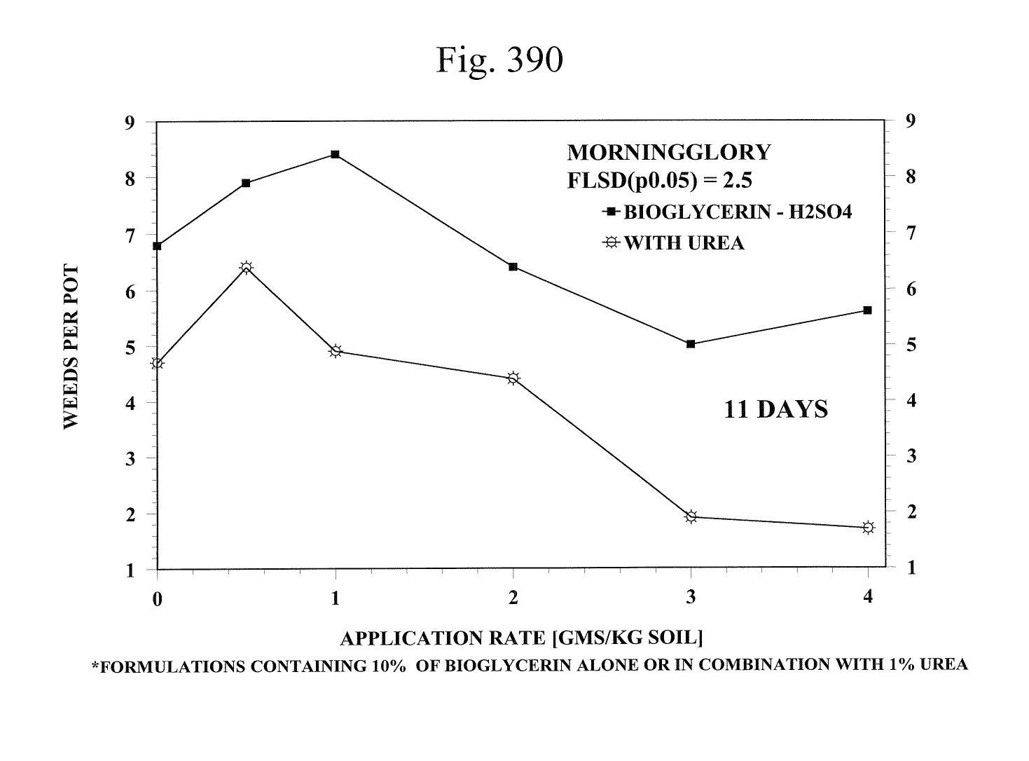

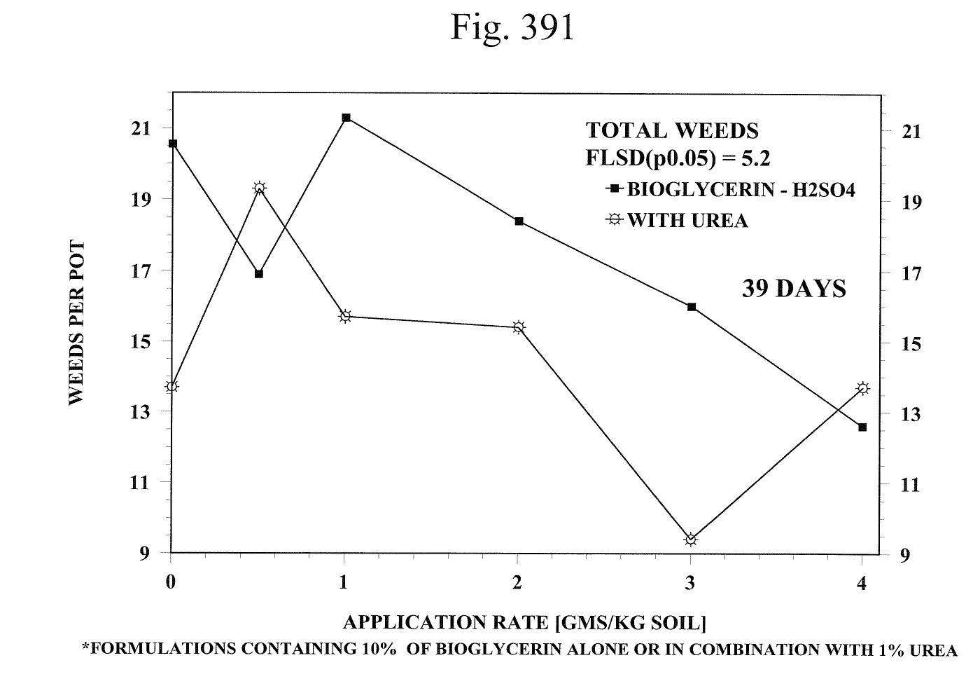

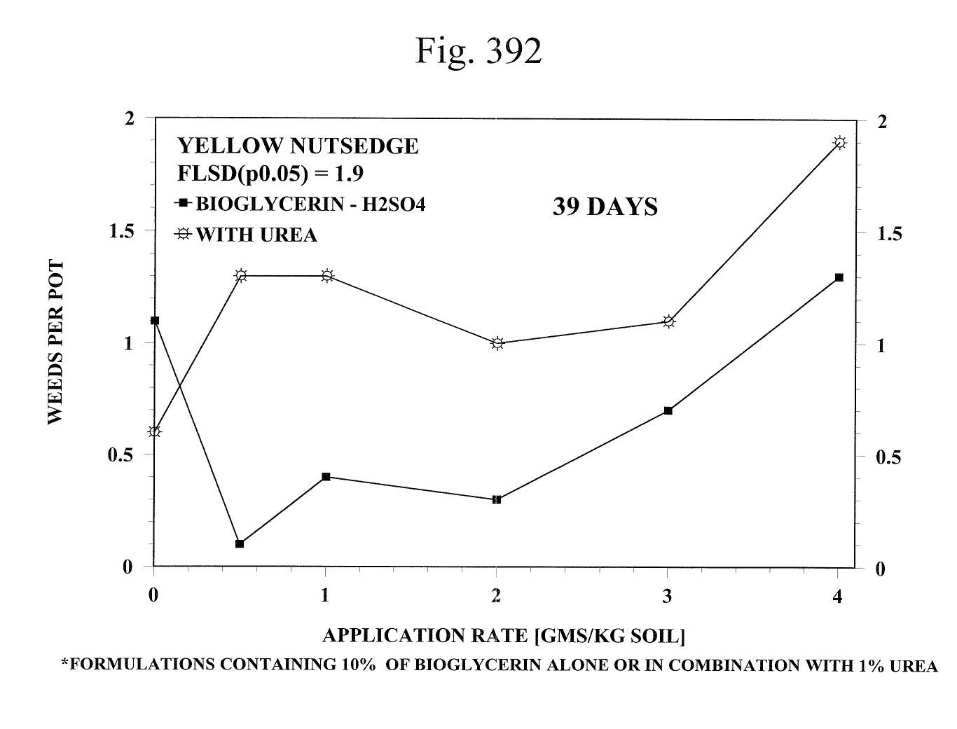

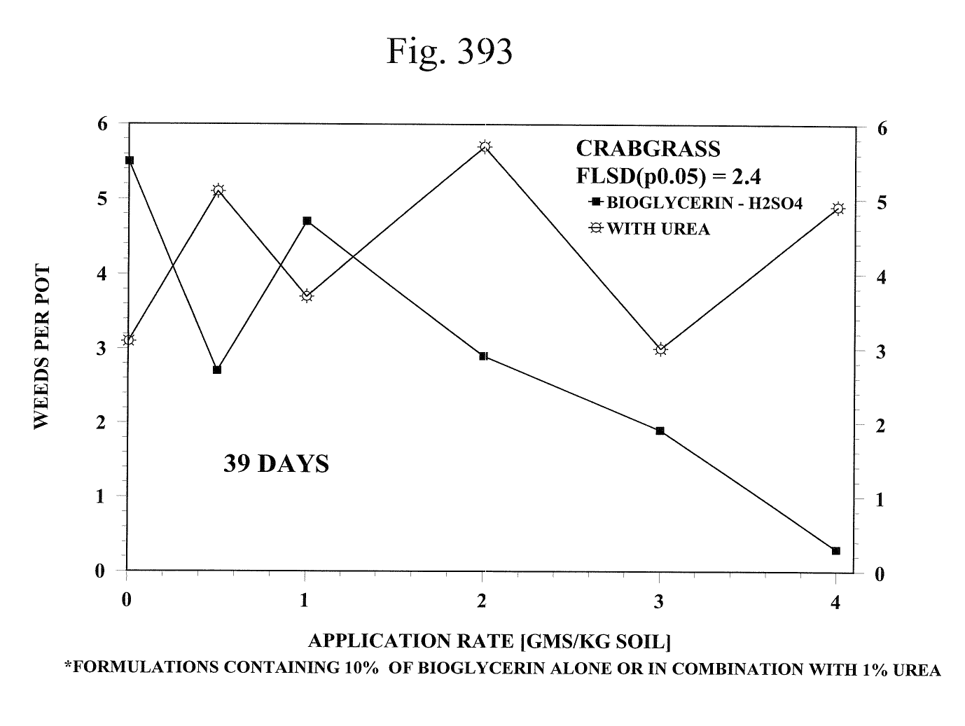

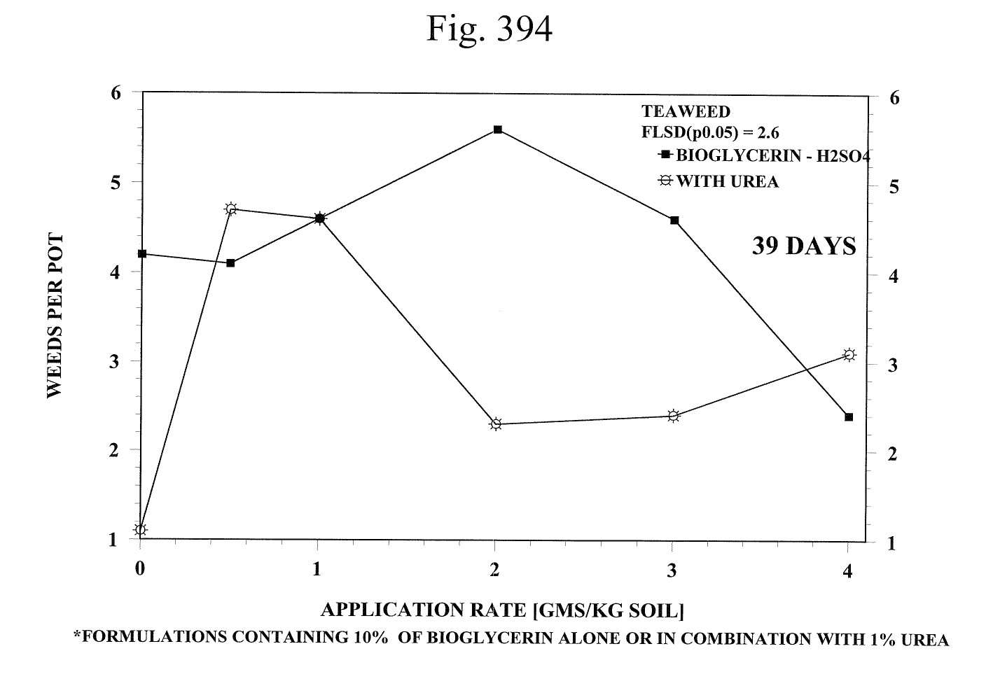

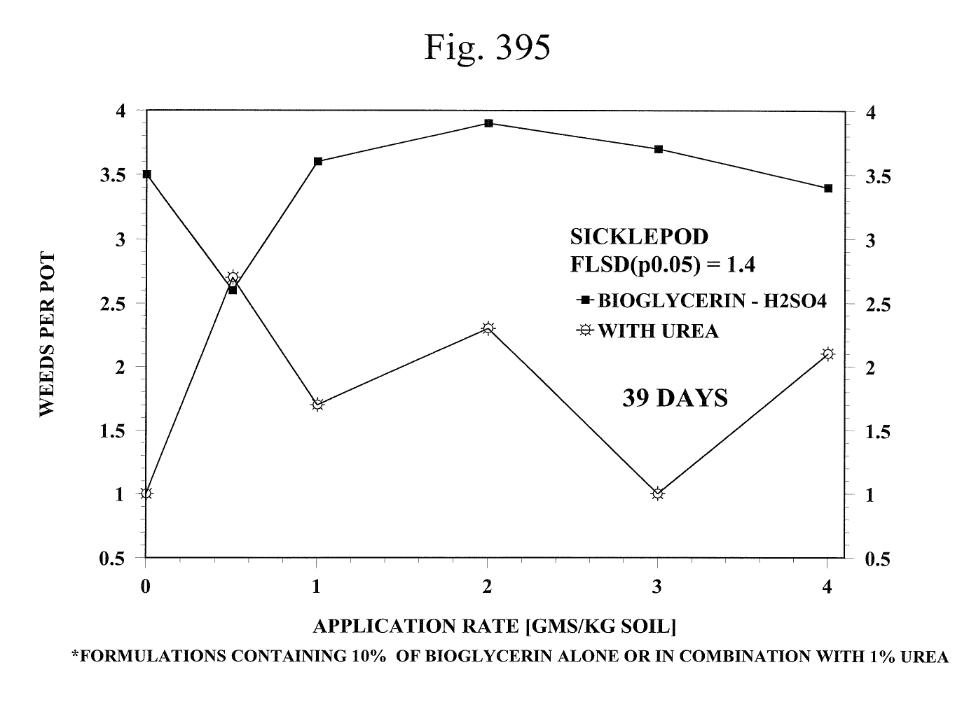

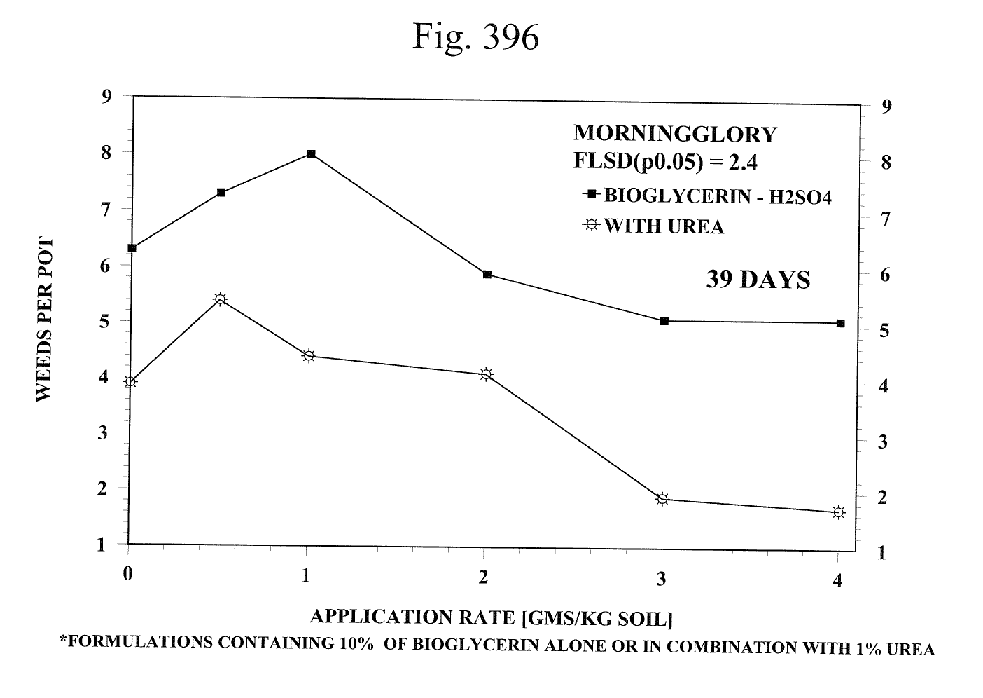

The standard weed seed pack comprised seeds of yellow nutsedge, crabgrass, teaweed, sicklepod, and morning glory. The number of total weeds and individual weeds was determined after six (6) days (FIGS. 381-385), eleven (11) days (FIGS. 386-390), and thirty-nine (39) days (FIGS. 391-396).

All publications and patent applications cited in this specification are herein incorporated by reference as if each individual publication or patent application were specifically and individually indicated to be incorporated by reference.

We claim:

1. A pesticide composition comprising:
(a) an effective amount of a pesticide for controlling a pest;
(b) biodiesel; and
(c) an effective amount of a nitrogen source;
wherein the composition has a molar ratio of total carbon to total nitrogen (C:N) of about (22.4-5.6):1.

2. The composition of claim 1, wherein the pesticide is a nematicide.

3. The composition of claim 2, wherein the nematicide is effective for controlling a nematode selected from a group consisting of Rotylenchulus reniformis, Dorylaimida spp., Meloidogyne incognita, Hoploaimus galeatus, Paratrichodorus minor, and combinations thereof.

4. The composition of claim 1, wherein the composition is effective for reducing nematodes by at least about 50% when applied at an application rate of about 1 ml/kg soil.

5. The composition of claim 1, wherein the composition does not reduce microbivorous nematodes by more than about 50% when applied at an application rate of about 1 ml/kg soil.

6. The composition of claim 1, wherein the pesticide is an herbicide.

7. The composition of claim 6, wherein the herbicide is effective for controlling a weed selected from a group consisting of Ipomoea spp., Digitaria sanguinalis, Senna obtusifolia, Datura stramonium, Setaria glauca, Amaranthus retroflexus, and combinations thereof.

8. The composition of claim 6, wherein the composition is effective for reducing weeds by at least about 50% when applied at an application rate of about 1 ml/kg soil.

9. The composition of claim 1, wherein the pesticide is a fungicide.

10. The composition of claim 9, wherein the fungicide is effective for controlling a fungus selected from a group consisting of Rhizoctonia solani. Pythium spp., and Fusarium spp. and a combination thereof.

11. The composition of claim 1, wherein the pesticide is selected from a group consisting of a menthol compound, an alkyl cyanamide compound, a 3,5-alkyltetrahydro-1,3,5-thiadiazine-2-thione compound, an aldehyde compound comprising a cyclic aromatic substituent, an isothiocyanate compound, a capsaicinoid compound, an unsaturated aldehyde compound, a phenol compound optionally substituted with alkyl, a halogenated propene, a diazarine compound, an orange terpene, and combinations thereof.

12. The composition of claim 1, wherein the nitrogen source is an organic nitrogen source.

13. The composition of claim 12, wherein the organic nitrogen source comprises urea, casein, or both.

14. A pesticide composition comprising:
(a) biodiesel;
(b) an effective amount of a pesticide for controlling a pest; the pesticide selected from a group consisting of a menthol compound, an alkyl cyanamide compound, a 3,5-alkyltetrahydro-1,3,5-thiadiazine-2-thione compound, an aldehyde compound comprising a cyclic aromatic substituent, an isothiocyanate compound, a capsaicinoid compound, an unsaturated aldehyde compound, a phenol compound optionally substituted with alkyl, a halogenated propene, and combinations thereof.

15. A method for preparing a pesticide composition, the method comprising combining:
(a) an effective amount of a pesticide for controlling a pest;
(b) biodiesel; and
(c) an effective amount of an nitrogen source;
wherein the composition has a molar ratio of total carbon to total nitrogen (C:N) of about (22.4-5.6):1.

16. A method for controlling soil-bourne pests and weeds comprising applying a liquid soil-amendment composition at an application rate of at least about 1 ml/kg soil, the soil-amendment composition comprising:
(a) an effective amount of a pesticide for controlling a pest; and
(b) biodiesel.

17. The method of claim 16, wherein the composition further comprises
(c) an effective amount of an nitrogen source;
wherein the composition has a molar ratio of total carbon to total nitrogen (C:N) of about (22.4-5.6):1.

18. The method of claim 16, further comprising applying another separate soil amendment composition comprising an effective amount of a nitrogen source in order to achieve a molar ratio of total carbon to total nitrogen (C:N) of about (22.4-5.6):1 in the soil to which the amendment compositions are applied.
